SEQUENCE LISTING (20 sequences)

SEQ ID NO: 1 - DNA, 24 bp, Artificial Sequence
  Description of Artificial Sequence Synthetic primer
tttatatttggtaggggagagtag

SEQ ID NO: 2 - DNA, 24 bp, Artificial Sequence
  Description of Artificial Sequence Synthetic primer
atctcattaatacctctcacctct

SEQ ID NO: 3 - DNA, 22 bp, Artificial Sequence
  Description of Artificial Sequence Synthetic primer
tgtttgggggtagaggatttag

SEQ ID NO: 4 - DNA, 22 bp, Artificial Sequence
  Description of Artificial Sequence Synthetic primer
tatcaccccacctaaaccaaac

SEQ ID NO: 5 - DNA, 19 bp, Artificial Sequence
  Description of Artificial Sequence Synthetic primer
atctggtaggggagagcag

SEQ ID NO: 6 - DNA, 22 bp, Artificial Sequence
  Description of Artificial Sequence Synthetic primer
ctcattgatacctctcacctct

SEQ ID NO: 7 - DNA, 20 bp, Artificial Sequence
  Description of Artificial Sequence Synthetic primer
tctgggggtagaggatccta

SEQ ID NO: 8 - DNA, 18 bp, Artificial Sequence
  Description of Artificial Sequence Synthetic primer
tcaccccacctgggccaa

SEQ ID NO: 9 - DNA, 26 bp, Artificial Sequence
  Description of Artificial Sequence Synthetic primer
tagtttggtttgtgggaaattgttat

SEQ ID NO: 10 - DNA, 26 bp, Artificial Sequence
  Description of Artificial Sequence Synthetic primer
ataattatcaacacacacactcatca

SEQ ID NO: 11 - DNA, 29 bp, Artificial Sequence
  Description of Artificial Sequence Synthetic probe
atctacaacttccacaccatacaacataa

SEQ ID NO: 12 - DNA, 24 bp, Artificial Sequence
  Description of Artificial Sequence Synthetic primer
gtttggtttgtgggaaattgttac

SEQ ID NO: 13 - DNA, 23 bp, Artificial Sequence
  Description of Artificial Sequence Synthetic primer
attatcaacgcacacactcatcg

SEQ ID NO: 14 - DNA, 25 bp, Artificial Sequence
  Description of Artificial Sequence Synthetic probe
acgacttccacaccgtacaacgtaa

SEQ ID NO: 15 - DNA, 28 bp, Artificial Sequence
  Description of Artificial Sequence Synthetic primer
atttgggttttgttgttatagtttttga

SEQ ID NO: 16 - DNA, 24 bp, Artificial Sequence
  Description of Artificial Sequence Synthetic primer
ctcttctcttcctccataatatca

SEQ ID NO: 17 - DNA, 28 bp, Artificial Sequence
  Description of Artificial Sequence Synthetic probe
aacccaacacatccaaccaccataacaa

SEQ ID NO: 18 - DNA, 26 bp, Artificial Sequence
  Description of Artificial Sequence Synthetic primer
ttgggttttgttgttatagttttcga

SEQ ID NO: 19 - DNA, 22 bp, Artificial Sequence
  Description of Artificial Sequence Synthetic primer
cttctcttcctccgtaatatcg

SEQ ID NO: 20 - DNA, 21 bp, Artificial Sequence
  Description of Artificial Sequence Synthetic probe
ccgacgcatccgaccgccata

(19) United States
(12) Patent Application Publication
(10) Pub. No.: US 2011/0028333 A1
(43) Pub. Date: Feb. 3, 2011

(54) DIAGNOSING, PROGNOSING, AND EARLY DETECTION OF CANCERS BY DNA METHYLATION PROFILING

(75) Inventors: Brock C. Christensen, Providence, RI (US); Karl T. Kelsey, Brookline, MA (US)

Correspondence Address: RISSMAN HENDRICKS & OLIVERIO, LLP, 100 Cambridge Street, Suite 2101, BOSTON, MA, 02114, US

(73) Assignee: BROWN UNIVERSITY, Providence, RI (US)

(21) Appl. No.: 12/771,036

(22) Filed: Apr. 30, 2010

Related U.S. Application Data
(60) Provisional application No. 61/174,670, filed on May 1, 2009.
(60) Provisional application No. 61/222,558, filed on Jul. 2, 2009.

(51) Int. Cl. C40B 30/02

(52) U.S. Cl. 506/8

(57) ABSTRACT

A method of employing DNA methylation analysis for the diagnosis, prognosis, and prediction of cancer.

GRANT SUPPORT Flight Attendants Medical Research Institute (C.J.M & M.D.M), NIH (R01CA078609, R01CA100679, R01CA52689, P50CA097257), National Cancer Institute (R01CA126939, R01CA105274); National Institutes of Environmental Health Sciences (T32ES007155, P42ES05947); NIEHS/NCI (ES/CA06409); International Mesothelioma Program at Brigham and Women's Hospital (Research grant); Mesothelioma Applied Research Foundation (Research grant). R01 ES006717-09A2 (PI: JKW) R01CA126831-01A2 (PI: JKW). National Cancer Institute (R01 CA126939) and NIEHS (T32ES007155, P42ES05947). NIHCA89032 (JLW). The is government has certain rights in this invention.

### FIELD OF THE INVENTION

A method of employing DNA methylation analysis for the diagnosis, prognosis, and early detection of cancer.

### BACKGROUND OF THE INVENTION

Without being bound by any particular theory, a widely accepted tenet of cancer biology states that cancer is clonal, with tumors arising as the result of expansion of increasingly dysregulated cells. This insight led to the paradigm that selective expansion of cells with a growth advantage occurs in an ordered fashion, driven primarily by genetic changes [1]. This model has expanded to now include the thesis that cancers also evolve a “mutator phenotype” and become malignant as a result of somatic genetic events [2]. While this is believed that some cancers are induced by mutagens (e.g. tobacco smoke and ionizing radiation), these carcinogens as well as those that are not mutagenic (or are very poor mutagens) may be also be acting to induce epigenetic alterations. In fact, it is well recognized that carcinogens may induce dysregulation of the somatic epigenome, and thereby crucially contribute to cancer development. The term epigenetics refers to changes in gene expression caused by mechanisms other than changes in the underlying DNA sequence. These changes may remain through cell divisions for the remainder of the cell's life and may also last for multiple generations.

Significant epigenetic events, including DNA hypermethylation-induced gene silencing, are believed to be contributors to carcinogenesis. Methylation associated gene silencing occurs when certain cytosines in specific clustered regions primarily located in gene promoters are hypermethylated. These regulatory CpG islands often occur in tumor suppressor genes and are thought to remain largely unmethylated in noncancerous cells. Approximately half of all human genes contain CpG islands. Three loci are subject to this type of aberrant silencing [3]. Recent technologic advances allow for the simultaneous resolution of hundreds of specific, phenotypically defined cancer-related methylation events, providing a platform for the rapid epigenetic profiling of gene silencing in human tumors [4].

Malignant pleural mesothelioma is a rapidly fatal malignancy. It is associated with asbestos exposure in approximately 80% of patients [5]. In the United States, Great Britain, and Japan, over 5000 cases occur annually and median survival of patients with pleural mesothelioma is less than one year [6,7,8]. The economic burden of treating this disease and the litigation associated with asbestos exposure is estimated to exceed $265 billion over the next four decades in the United States [9]. Despite the decline in asbestos use among industrialized nations, the incidence of mesothelioma continues to rise, and it is not expected to peak until 2020, as disease latency can be as long as fifty years [10]. Importantly, asbestos is currently mined and exported throughout the world, with heavy use evident in developing nations such as China, India, and Central America [11]. Asbestos-containing products are still imported to the U.S., and many asbestos exposure hazards remain from earlier applications; one well publicized example being dust from the World Trade Center towers collapse in New York City [12]. A more complete understanding the molecular-genetic consequences of asbestos exposure and the mechanism of action of these mineral fibers in inducing mesothelioma is critically needed to develop more effective approaches for identifying and treating this devastating disease.

The causal link between asbestos and pleural mesothelioma has been widely accepted since 1960 [13], and the carcinogenic mechanisms of asbestos have been investigated in earnest since that time; establishing a view that asbestos fibers are not point mutagens, but rather both clastogenic and cytotoxic in vitro [14,15]. Additionally, methylation-induced tumor suppressor gene silencing has been observed in recent studies of mesothelioma [16,17,18,19,20] leading to the hypothesis that asbestos fibers contribute to epigenetic silencing of tumor suppressor genes in this disease. Consistent with this, Tsou et al. observed a significant association between self-reported asbestos exposure and methylation at the MT1A, and MT2A gene loci in mesotheliomas [18]. Using quantitative asbestos body counts as a measure of asbestos exposure burden has revealed an association between cell cycle control tumor suppressor gene methylation and increased asbestos burden in mesothelioma [20].

Research indicates that somatic mutations [21] and alterations in gene expression [22] are a feature of this disease. Interestingly, relatively few pathologically important mutations arise in this cancer, and there is no currently identified characteristic somatic genetic change attributed to the action of asbestos [21]. Further, although there is consensus that gene expression (at the mRNA level) is significantly altered in mesothelioma, there is no currently identified gene expression signature representative of the action of asbestos in this disease. There remains a debate about the clinical significance of mRNA expression profiling [23,24,25].

Shared signs and symptoms of these diseases include malignant pleural effusion, dsypnea, chest-pain, and fatigue [26,27]. An enhanced description of the character of the underlying somatic alterations, and thereby a proper diagnosis, is of paramount importance, especially considering the disparate prognoses and treatment regimens for lung adenocarcinoma and mesothelioma [28,29].

Several techniques have been used or proposed for differential diagnosis. Cytologic approaches to differential diagnosis have historically had a wide margin of variability in sensitivity depending on sample preparation methods and feature sets analyzed [30,31]. Currently, the most common method employs an immunohistochemical panel containing both epithelial and mesothelial markers [32]. Despite recent improvements in antibody panels for differential diagnosis, there is no consensus immunohistochemical panel or evidence-based guidelines for panel selection [32,33]. Another method, using mRNA expression gene ratios has reported differential diagnosis accuracy of 95% and 99% for mesothelioma and adenocarcinoma respectively [34]. The instability of mRNA, though, may make wide-scale implementation of this technology challenging, particularly outside of major academic surgical centers.

It is well recognized that promoter DNA hypermethylation is a mechanism of stable control of transcription, and an important contributor to carcinogenesis. When certain cytosines in specific clustered regions primarily located in gene promoters are hypermethylated, aberrant, stable gene silencing can occur. Regulatory CpG clusters are common, often occur in tumor suppressor genes, and are thought to remain largely unmethylated in noncancerous cells. In fact, about half of all human genes contain CpG islands and are potentially subject to aberrant methylation silencing [3,35]. Recently, the simultaneous resolution of hundreds of specific, phenotypically defined cancer-related is CpG methylation marks has become technologically feasible, allowing for rapid, high-throughput epigenetic profiling of human tissue CpG methylation [4]. In examining DNA methylation cellular DNA, any source of cells from the tissue of interest will suffice. Biopsied cells of suspect masses is an option. For pleural cancers pleural fluid is a likely source. It will be clear to those of skill in the art that in particular instances cell samples may be obtained from, without limitation, blood or blood fractions, cerebrospinal fluid, stool, saliva, bone marrow, urine, perspiration, amniotic fluid, lymph, and excised tissue.

### SUMMARY OF THE INVENTION

The invention is an assay useful in the diagnosis, prognosis, and early detection of human cancers. Further, there is a use for this assay in predicting response to treatment for certain cancers. In conducting the assay of the invention, DNA methylation profiles are obtained from tumor DNA and from non-tumor DNA from patients and compared. The DNA methylation profiles obtained from tumor cells has been demonstrably distinct from DNA methylation profiles of non-tumor cells. Furthermore, differences between tumor types can be valuable for differential diagnosis, and differences within tumors of a given type can be informative of tumor etiology and or prognosis. Finally, early detection of cancers is possible.

The instant invention comprises a method for the diagnosis or prognosis of cancer in a subject comprising

(a) obtaining DNA methylation data from DNA of a subject's cells wherein said cells are suspected of being cancerous (Subject DNA methylation data);

(b) comparing said Subject DNA methylation data to a library of Tumor Control DNA methylation data and a library of Normal Control DNA methylation data (each representing same tissue of origin);

(c) fitting by mixture modeling P(Y,C) Subject DNA methylation data to said

Tumor and Normal Control DNA methylation data using recursively partitioned mixture modeling (RPMM) in conjunction with an empirical Bayes procedure generating a posterior probability distribution P(C|y*) of methylation class membership for Subject DNA y*,

Said Subject DNA methylation data's identity with Normal Control being indicated by posterior probability of membership P(C=k|y*) at least 90% in a class k comprised of at least 95% Normal Control samples [P(control|C=k)>95%];

(d) establishing a metric-based criterion for comparison by computing mean methylation average beta values μⱼ at each CpG locus j from said Normal Control DNA methylation samples data yᵢⱼ and fitting the distribution of squared weighted Euclidean distances dᵢ²=Σ{(yᵢⱼ−μⱼ)²/[μⱼ(1−μⱼ)]} to a gamma distribution G, and where said Subject DNA methylation data's squared weighted Euclidean distance d*²=Σ{(yⱼ*−μⱼ)²/[μⱼ(1−μⱼ)]} is less than the 95% quantile of G it is indicated with at least 95% certainty that the subject's sample is Normal and if the subject's squared weighted Euclidian distance d*² is greater than the 95% quantile of G it is indicated with at least 95% certainty that the subject's sample is a tumor.

In the practice of the instant method steps (c) and (d) above are non-limiting examples of methods for establishing metric-based criteria for data of this type. Empirical Bayes procedures and distance metrics based on distributions from libraries of Control DNA methylation data will yield the assignment of the identity of a subject's sample as cancerous or normal with at least about 70% accuracy, and particularly at least about 80% accuracy and more particularly at least about 90% accuracy.

The instant method is also applicable to prognosis. In cancer prognosis a subject's sample, if cancerous, is further studied by applying steps (c)/(d) above to the Tumor Control DNA methylation sample data only. The subjects' prognosis will be equivalent to the history of subjects from which Tumor Control DNA methylation data was derived having distribution of class membership greater than about 90%. Here, of course, it is understood that useful Tumor Control DNA methylation data for this aspect will include clinical follow-on histories of subjects diagnosed with cancer and particular to such cancers.

We note that mu is the mean of average betas across multiple samples at a given CpG. A metric-based criterion for comparison is made by computing the mean of average array methylation values (mean of average beta values at a CpG locus j to give μⱼ) and a distribution of u for all CpG loci j equivalent to G.

The invention is exemplified and supported below for several different tumor types and an immunologic application including without limitation:
1. Diagnosis and prognosis of pleural mesothelioma.
2. Differential diagnosis of mesothelioma and lung adenocarcinoma.
3. Diagnosis and prognosis of head and neck cancer.
4. Diagnosis and prognosis of bladder cancer.
5. Diagnosis and prognosis of lung cancer.
6. Differential diagnosis and early detection of childhood leukemia.
7. Enumerating the numbers and ratios of immune cells within peripheral blood and malignant and non-malignant tissues for early detection and diagnosis.

In addition to these applications, other cancers may be diagnosed and/or prognosed using the assay of the invention. Such cancers include malignant and benign tumors of the connective tissue, the endothelium, the mesothelium, blood, lymph cells, muscle, epithelial tissue, neural tissue, APUD (amine precursor uptake and decarboxylation) system and neural crest derived cell (pigment producing cells in the skin and eyes, Schwann cell, merkel cells) tumors. More specifically, such tumor related cancers include fibrosarcoma, myxoma, lipoma, chondroma, osteoma, myxosarcoma, liposarcoma, chondrosarcoma, osteosarcoma, chordoma, fibrous and malignant fibrous histiocytoma, hemangiosarcoma, angiosarcoma, lymphangioma, lymphangiosarcoma, myeloproliferative disorders, leukemias, plasmacytosis, plasmacytoma, multiple myeloma, Hodgkin and Non-hodgkin lymphoma, leiomyoma, leiomyosarcoma, rhabdomyoma, rhabdomyosarcoma, papilloma, seborrheic keratosis, squamous cell carcinoma, epidermoid carcinoma, benign and malignant skin adnexal tumors, adenomas and adenocarcinomas of the liver, kidney, or bile duct, choriocarcinoma, seminoma, embryonal cell carcinoma, anaplastic and multiforme gliomas, neuroblastoma, medulloblastoma, ganglioneuroma, benign and malignant meningioma, benign and malignant tumors of the nerve sheath, basophilic, eosinophilic, chromophobe and parathyroid adenomas and carcinomas, C cell hyperplasia, medullary carcinoma of the thyroid, benign and malignant tumors of the pancreas, stomach, intestines, carotid body and chemo-receptor system, Sertoli-Leydig cell tumors, germ cell tumors, cystosarcoma phylloides, Wilms tumor and fibroadenoma.

### BRIEF DESCRIPTION OF THE DRAWINGS

FIG. 1. Unsupervised clustering of average beta values in tumor and non-tumor pleura.

Using the R software package normal tissue sample average beta values were subjected to unsupervised hierarchical clustering based on Manhattan distance and average linkage. Each column represents a sample and each row represents a CpG locus (750 most variable autosomal loci). Above the heatmap black indicates a tumor sample, and white indicates a non-tumor pleural sample. In the heat map white=average beta of zero, or unmethylated, and black=average beta of one, or methylated.

FIG. 2. Beta mixture model of methylation profiles in mesothelioma and non-tumor pleura.

Methylation average β is white for unmethylated and black for methylated. Methylation profile classes are stacked in rows separated by horizontal lines, and class height corresponds to the number of samples in each class. Class methylation at each locus is a mean of methylation for all samples within a class. Bar charts display the proportion of tumors and non-tumor pleura samples in each class. Methylation profile classes differentiate tumor from non-tumor pleura (P<0.0001).

FIG. 3. Beta mixture model of methylation profiles in pleural mesothelioma. Methylation average β is white for unmethylated and black for methylated. Methylation profile classes are stacked in rows separated by horizontal lines, and class height corresponds to the number of samples in each class. Class methylation at each locus is a mean of methylation for all samples within a class. On the left, bar charts show proportions for gender and tumor histology among samples within each class. On the right, box plots of log asbestos body counts for each class. Controlling for gender, methylation class membership predicts asbestos burden (P<0.03).

FIG. 4. Unsupervised clustering heatmap of CpG loci in all samples and tumors only.

Unsupervised hierarchical clustering heat map based on Manhattan distance and average linkage of the 500 autosomal CpG loci with the highest variance. Columns are samples, rows are CpG loci. Black indicates methylated and white indicates unmethylated A) All samples, color coded bars indicate sample type B) Tumor samples only.

FIG. 5. Recursively partitioned mixture model of CpG methylation for lung adenocarcinomas, mesotheliomas, and non-malignant pulmonary tissues.

The figure depicts the results of RPMM. Columns represent CpG sites and rows represent methylation classes. The height of each row is proportional to the number of observations residing in the class, and the color of the columns within the row represents the average methylation of the CpG for that class. Black indicates methylated and white indicates unmethylated. Pie charts represent the composition of the group of classes indicated with respect to tissue type. Methylation profile classes differentiate sample types (permutation test P<0.0001).

FIG. 6. Recursively partitioned mixture model of CpG methylation for lung adenocarcinomas and mesotheliomas.

The figure depicts the results of RPMM. Columns represent CpG sites and rows represent methylation classes. The height of each row is proportional to the number of observations residing in the class, and the color of the columns within the row represents the average methylation of the CpG for that class. Black indicates methylated and white indicates unmethylated. Pie charts represent the composition of the group of classes indicated with respect to tissue type. Methylation profile classes significantly differentiate tumor types (permutation test P<0.0001).

FIG. 7. (A) Unsupervised hierarchical clustering and heatmap of methylation beta values for 1250 most variable loci across all samples. (B) Recursive partitioning mixture model classification of normal and tumor head and neck tissues using all methylation beta values resulting in 8 classes whose average methylation beta values are represented in the heat map. Distribution of normal and tumor samples within each class is depicted in pie charts on the right.

FIG. 8. Recursive partitioning mixture model classification of head and neck squamous cell carcinomas (A) resulting in 6 classes with average methylation beta values across loci depicted in the heatmap. (B) Average age of (C) lifetime average packs of cigarettes smoked per day by, (D) distribution of tumor location of, and (E) lifetime average alcoholic drinks per week consumed by patients whose samples are members of the distinct methylation classes depicted in (A).

FIG. 9. A) Recursively partitioned mixture model of normal bladder and bladder tumor tissues. Methylation class three is comprised exclusively of normal bladder tissues and bladder tumor samples are distributed among remaining classes. B) Venn diagram identifying 65 CpG loci in common across three separate approaches to analyzing the methylation profiles between bladder tumors and normal bladder tissues.

FIG. 10. A) Scatter plot indicating the propensity for increased methylation among invasive bladder tumors relative to non-invasive tumors in two separate case series studies of disease. B) Recursively partitioned mixture model of each series of bladder tumor samples. C) Genes and CpG loci identified which overlap between two separate approaches to ascertaining the most critical loci with differential methylation between invasive and non-invasive bladder cancer.

FIG. 11. Unsupervised hierarchical clustering of DNA methylation data from 1400 autosomal CpG loci in lung tumor and non-tumor lung tissues. On the heatmap, white corresponds to an average beta of zero (unmethylated), and black corresponds to an average beta of one (methylated). Above the heatmap black bars indicate tumor samples and white bars indicate non-tumor lung samples.

FIG. 12. Recursively partitioned mixture model of DNA methylation data from lung tumor and non-tumor lung tissue samples. Black indicates methylated and white indicates unmethylated. Methylation class height corresponds to the number of samples in a class and the mean of average beta values within each class are displayed in columns.

FIG. 13. Recursively partitioned mixture model of methylation data from autosomal CpG loci in squamous cell carcinomas of the lung.

FIG. 14. Clustering heatmap using linear models were fitted for each CpG site on the leukemia subtype to derive differences between all pairs of subtypes. Patient samples clustered vertically, and gene CpGs horizontally (gene names along the right hand site). Black are unmethylated, white, methylated, grey intermediate. Moderated t-statistics & the associated p-values were calculated, as well as B-statistics, the log posterior odds ratio that a gene is differentially methylated (DM) versus not DM. The 40 CpGs with FDR<0.05 were used for clustering analysis. Leukemia subtypes in grayscale above the clustering heatmap: note that TEL-AML1 (30% black) completely clusters independently, as do hyperdiploid, and hyperdiploid RAS+, separately (50%, 60% black respectively). E2A-PBX1 (black) is distinct from the others.

FIG. 15. A) Plot of locus-by-locus analysis of CpG methylation in infant bloods from controls compared to infant bloods from individuals who went on to develop leukemia; P-values versus linear regression coefficients where negative coefficients correspond to reduced methylation in cases relative to controls. B) The distributions of the sum of the top 19 most differentially methylated CpG loci between cases and controls, indicating significantly higher methylation in controls relative to cases (P=5.0×10⁻¹³).

### DETAILED DESCRIPTION OF THE INVENTION

### Example 1

The invention is useful for diagnosis and prognosis of malignant pleural mesothelioma. The present invention characterizes phenotypically significant alterations in the epigenome of mesothelioma. Enumerated is the epigenetic status of over 800 genes believed to be cancer-related, and wherein such genes are believed to stably control mRNA expression. The invention entails comparing normal pleura with mesothelioma pleural tissue. Data suggest that a large number of loci are epigenetically altered in mesothelioma, that asbestos exposure is associated with the degree of epigenetic alteration, and that profiles of gene silencing are associated with clinical outcome. This work demonstrates that the epigenome is a primary point of pathogenic effect of asbestos exposure in the genesis of mesothelioma.

To comprehensively investigate tumor-specific, phenotypically relevant methylation events in pleural mesothelioma, 158 tumors were profiled. Also 18 non-tumorigenic parietal pleura samples were profiled. Profiling was for methylation at 1505 CpG dinucleotides associated with 803 cancer-related genes. Profiling was done by methylation bead array (Illumina, Inc., GoldenGate Genotyping Assay®, San Diego Calif.). Data delineate the relationship between a comprehensive, phenotypically important CpG methylation profile and disease status. It also provides tumor methylation profiles which permit an association with patient clinical course and carcinogen (e.g., asbestos) exposure.

Choice of Study Population

In one example of tumor study population tumor material was obtained following surgical resection at Brigham and Women's Hospital through the support of the International Mesothelioma Program. Similarly, grossly non-tumorigenic parietal pleura samples were taken as residual tissue during extrapleural pneumonectomy from uninvolved anatomic sites. Patients were drawn in near equivalent numbers from a pilot study conducted in 2002 (n=70), and an incident case series beginning in 2005 (n=88). Among identified cases the participation rate was 85%. All patients underwent surgical resection prior to other treatments. Clinical information, including histologic diagnosis, was obtained from pathology reports. Each patient was assessed for history of exposure to asbestos as well as additional demographic and environmental data by obtaining their medical and occupational history with an in-person questionnaire or interview. Additionally, the study quantified asbestos bodies in samples of lung tissue from multiple sites in the resected lung [36] [37]. Each tumor was pathologically examined and the amount of tumor in every sample estimated by direct microscopic evaluation and recorded as the percent tumor for that specimen. Patients were followed for survival using the National death index and last known clinic visit.

Methylation Analysis (Applies to all Examples)

Tumor and non-tumor pleural DNA was extracted from frozen tissue using the QIAamp DNA mini kit according to the manufacturer's protocol (Qiagen, Valencia, Calif.). DNA was modified by sodium bisulfite to convert unmethylated cytosines to uracil using the EZ DNA Methylation Kit (Zymo Research, Orange, Calif.) according to the manufacturer's protocol. To characterize the epigenetic profile of mesothelioma and non-tumorigenic parietal pleura we used the Illumina GoldenGate® bead array that simultaneously interrogates 1505 CpG sites associated with 803 cancer-related genes to generate a methylation value based upon ˜30 replicate measurements for each locus in each sample. The Illumina array interrogates approximately two CpGs per gene and although sequencing methods would provide additional details, CpGs were cultivated from reports which have demonstrated the methylation-expression relationship in large is part through sequencing experiments. Bead arrays have a similar sensitivity as quantitative methylation-specific PCR and were run at the UCSF Institute for Human Genetics, Genomics Core Facility according to the manufacturer's protocol and as described by Bibikova et al [4].

Analysis of Tissue Sample Methylation

Exposure, demographic and tumor characteristic data for mesothelioma and non-tumor pleura are presented in Table 1 below.

TABLE 1
Subject gender, age, histology and exposure for mesothelioma
patients and non-tumor pleural samples.

| | Mesothelioma | Pleura |
|---|---|---|
| | patients | donors |
| Gender, n (%) | | |
| Female | 38 (24) | 4 (22) |
| Male | 120 (76) | 14 (78) |
| Age | | |
| Range | 30-80 | 38-77 |
| Mean (sd) | 62 (9.8) | 58 (11.3) |
| Histology, n (%) | | |
| Epithelioid | 116 (73) | — |
| Mixed | 37 (23) | — |
| Sarcomatoid | 5 (3) | — |
| Asbestos exposure, n (%) | | |
| Yes | 112 (74) | 13 (72) |
| No | 39 (26) | 5 (28) |
| Log Asbestos Body | | |
| Available n (%) | 108 (68) | — |
| Range | 0-5.5 | — |
| Mean (sd) | 2.16 (1.18) | — |

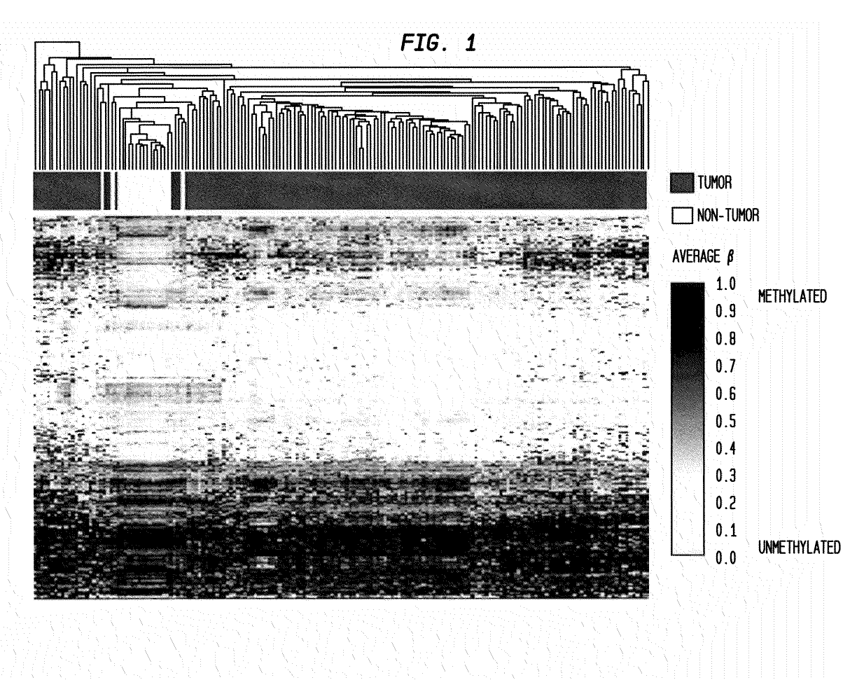

Array methylation data were first examined with unsupervised hierarchical clustering using Manhattan distance and average linkage for the 750 most variable autosomal CpG loci (FIG. 1). Striking differences between the epigenetic profiles of mesothelioma and non-tumor pleura are observed, with almost perfect clustering of epigenetic profiles based on disease status. Next, in a univariate approach, we tested all CpG loci individually for an association between methylation and disease status, and 969 CpG loci had methylation levels that differed (Q<0.05) comparing tumor and non-tumor pleura following FDR correction. Of these, 727 loci associated with 493 genes had enhanced methylation in non-tumor pleura, and 242 loci associated with 153 genes had more methylation in the tumors (Supplemental Table 1).

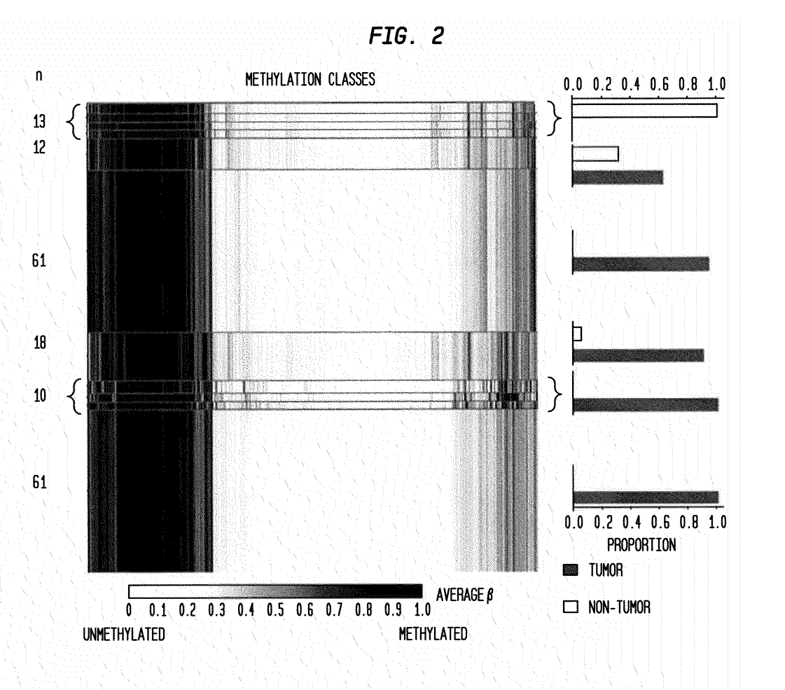

Since so many loci were differentially methylated between tumor and non-tumor pleura, we next applied a modified model-based form of unsupervised clustering known as mixture modeling. This approach built classes of samples based on profiles of methylation with data from all autosomal loci using a mixture of beta distributions to recursively split the tumors into parsimoniously differentiated classes [38,39,40]. All posterior class membership probabilities were numerically indistinct from 0 or 1. Applying a beta mixture model to methylation data from all autosomal loci in tumors and non-tumor pleura returned eleven methylation classes, their average methylation profiles, and their sample type distributions (FIG. 2). Methylation class membership was a highly significant predictor of diseased versus non-diseased tissue (permutation P<0.0001). Among the 11 classes in the model, 9 classes perfectly captured only tumor or only normal, and there were 2 methylation classes containing both tumor and normal samples. To follow up, a supervised random forest classification of non-tumor and tumor samples was performed. Only 1 tumor (<1%) was misclassified as a non-tumor sample, and 5 non-tumor samples (28%) were misclassified as tumors. The overall misclassification error rate was 3.4%, significantly lower than the expected error rate under the null hypothesis (P<0.0001).

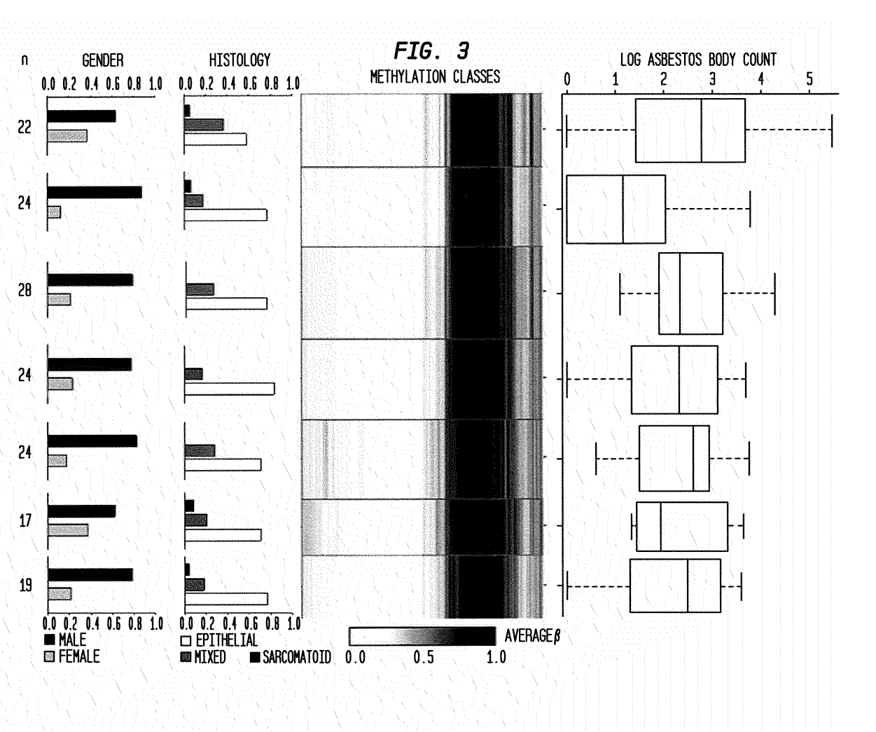

We next restricted our analyses to tumors, (n=158) first applying our beta mixture model approach. Seven methylation classes resulted. See FIG. 3. This figure also displays the distributions of gender, histology, and asbestos body counts by methylation class. Methylation class membership was not a significant predictor of patient gender or tumor histology (data not shown). Again, methylation profile class membership was not associated with the amount of tumor in the sample. However, methylation class membership significantly predicted lung asbestos body count (permutation P<0.04). Since men with pleural mesothelioma have higher asbestos body counts compared to women (P<0.0001) [41] we controlled for gender, and methylation class membership remained a significant predictor of asbestos burden tested for associations between methylation and asbestos body counts; consistent with our prior data,[20] tumor methylation average β values at CDKN2A (P<0.02), CDKN2B (P<0.02), and RASSF1 (P<0.03) were significantly and positively associated with asbestos body counts. In addition, methylation of MT1A (previously reported as asbestos exposure-associated by Tsou et al. [18]) was significantly positively associated with asbestos burden; promoter associated CpG49 (P<0.04), and exonic CpG13 (P<0.02). When testing all autosomal loci for an association between methylation and asbestos burden using the MTA1 promoter CpG 49 Q-value (Q=0.32) as a cutoff, there were 110 loci with an association between methylation status and asbestos burden (Supplemental Table 2). The vast majority of these 110 loci (94%) had a positive correlation between CpG methylation and asbestos body counts, indicating gene silencing was the dominant phenotype associated with asbestos associated epigenetic change.

Lastly, we examined the relationships between methylation profiles and patient outcome using Cox proportional hazards models of survival controlling for age, gender, and tumor histology. Median survival time of this population was 12.5 months with 67 months of follow-up time. In a proportional hazards model including all cases (n=158), women had half the risk of death of men (HR=0.5, 95% CI, 0.3-0.96), and patients with mixed histology tumors were at greater risk of death compared to those with epithelial tumors (HR=2.7, 95% CI, 1.7-4.4). Importantly, methylation class membership was also a significant predictor of patient outcome (P<0.01). In particular, membership in methylation classes four and seven were both independently associated with a significant 3-fold increased risk of death compared to the class with the lowest median asbestos count (95% CIs, class four: 1.4-7.0, class seven: 1.3-7.4) (Table 2). Where data were available (n=108), and after adjustment for methylation class membership, asbestos burden was associated with a significant 1.4-fold increased risk of death (95% CI, 1.1-1.8) (See Table 2 below). In this model, membership in methylation class four remained associated with a significant, nearly 3-fold increased risk of death (HR=2.8, 95% CI, 1.1-7.1). Again, in this model including asbestos exposure, likelihood ratio tests indicate that methylation classes were significant predictors of patient outcome (P<0.005).

TABLE 2
Gender, tumor histology, methylation profile class membership, and asbestos
burden are predictors of pleural mesothelioma patient survival.

| | All Cases | | | | Cases with asbestos burden data | | | |
|---|---|---|---|---|---|---|---|---|
| | n (%) | | | | n (%) | | | |
| Co-Variate | Total n = 158 | HR | 95% CI | P-value | Total n = 108 | HR | 95% CI | P-value |
| Age, mean (sd) | 62 (9.8) | 1.02 | 1.0-1.05 | 0.09 | 61 (9.5) | 1.03 | 1.0-1.1 | 0.18 |
| Gender | | | | | | | | |
| Male | 120 (76) | 1.0 | (reference) | — | 84 (78) | 1.0 | (reference) | — |
| Female | 38 (24) | 0.5 | 0.3-0.96 | <0.04 | 24 (22) | 1.5 | 0.6-3.5 | 0.38 |
| Histology | | | | | | | | |
| Epithelial | 109 (69) | 1.0 | (reference) | — | 74 (68) | 1.0 | (reference) | — |
| Mixed | 44 (28) | 2.7 | 1.7-4.4 | <0.0001 | 31 (29) | 2.1 | 1.2-3.8 | <0.02 |
| Sarcomatoid | 5 (3) | 2.8 | 0.95-8.2 | 0.06 | 3 (3) | 1.2 | 0.3-5.2 | 0.83 |
| Asbestos burden, mean (sd) | — | — | — | — | 2.2 (1.2) | 1.4 | 1.1-1.8 | <0.04 |
| Methylation Class | | | | | | | | |
| 2 | 24 (15) | 1.0 | (reference) | — | 17 (16) | 1.0 | (reference) | — |
| 1 | 22 (14) | 1.4 | 0.6-3.4 | 0.47 | 10 (9) | 0.5 | 0.1-2.2 | 0.37 |
| 3 | 28 (18) | 0.9 | 0.4-2.0 | 0.75 | 19 (18) | 0.4 | 0.1-1.2 | 0.11 |
| 4 | 24 (15) | 3.1 | 1.4-7.0 | <0.01 | 24 (22) | 2.8 | 1.1-7.1 | <0.03 |
| 5 | 24 (15) | 1.4 | 0.6-3.5 | 0.44 | 17 (16) | 0.9 | 0.3-2.8 | 0.89 |
| 6 | 17 (11) | 2.0 | 0.8-5.4 | 0.16 | 11 (10) | 1.2 | 0.3-4.8 | 0.79 |
| 7 | 19 (12) | 3.1 | 1.3-7.4 | <0.01 | 10 (9) | 1.7 | 0.6-5.0 | 0.36 |

| | |
|---|---|
| Controlled for all variables in table. model log liklihood P < 0.01 | Controlled for all variables in table. |
| Classes 1 to 7 corresppond top to bottom from FIG. 3 | model log liklihood P < 0.005 |

Statistical Analysis (Applies to all Examples)

BeadStudio Methylation software from the array manufacturer Illumina (SanDiego, Calif.) was used for dataset assembly. All array data points are represented by fluorescent signals from both M (methylated) and U (unmethylated) alleles, and methylation level is given by β=(max(M, 0))/(|U|+|M|+100), the average methylation (β) value is derived from the ˜30 replicate methylation measurements and a Cy3/Cy5 methylated/unmethylated ratio. At each locus for each sample the detection P-value was used to determine sample performance, three samples (2%) with >25% of loci having a detection P-value>1e−5 were dropped from analysis. Similarly, CpG loci with a median detection P-value>0.05 (n=8, 0.5%), were eliminated from analysis.

Subsequent analyses were carried out using the R software [42]. For exploratory and visualization purposes, hierarchical clustering was performed using R function hclust with Manhattan metric and average linkage. Associations between sample type, or covariates such as age or gender and methylation at individual CpG loci were tested with a generalized linear model (GLM). The beta-distribution of average beta values was accounted for with a quasi-binomial logit link with an estimated scale parameter constraining the mean between 0 and 1, in a manner similar to that described by Hsuing et al. [43]. CpG loci where an a priori hypothesis existed were tested independently. In contrast, array-wide scanning for CpG loci associations with sample type or covariate used false discovery rate correction and Q-values computed by the qvalue package in R [44].

For inference, data were clustered using a mixture model with a mixture of beta distributions, and the number of classes was determined by recursively splitting the data via 2-class models, with Bayesian information criterion (BIC) used at each potential split to decide whether the split was to be maintained or abandoned as described in [45]. Permutation tests (running 10,000 permutations) were used to test for association with methylation class by generating a distribution of the test statistic for the null distribution for comparison to the observed distribution. For continuous variables, the permutation test was run with the Kruskal-Wallis test statistic. For categorical variables we used a Chi Square test statistic. Significant associations from permutation tests were controlled for potential confounders where appropriate using logistic regression with methylation classes and potential confounders and a likelihood ratio test of the model with and without methylation classes. For survival analyses, Cox proportional hazards models were utilized, and likelihood ratio tests were used to examine the significance of inclusion of the methylation classes in the models.

The R Package was also used to build classifiers with the Random Forest (RF) approach. RF is a tree-based classification algorithm similar to Classification and Regression Tree (CART) [46] and was performed on CpG average beta values using RandomForest R package version 4.5-18 by Liaw and Wiener. RF builds each individual tree by taking a bootstrap sample (sampling with replacement) of the original data and on average about ⅓ of the original data are not sampled (out of bag or OOB). Those sampled are used as the training set to grow the trees, and the OOB data are used as the test set. At each node of the tree, a random sample of m out of the total M variables is chosen and the best split is found among the m variables. The default value for m in the Random Forest R package is √M. In this analysis we will test a range of m from half of √M to two times the √M and will use the m that gives the lowest prediction error. The OOB error rate is the percentage of time the RF prediction is incorrect.

### Example 2

Differential diagnosis of lung adenocarcinoma and pleural mesothelioma was performed using DNA methylation profiles in the context of non-malignant pulmonary tissues.

Our previous work has demonstrated hundreds of differentially methylated CpG loci in pleural mesothelioma compared to non-diseased pleura [47]. Other reports, using a small number of candidate loci, have demonstrated significant differences in gene-promoter methylation prevalences between lung adenocarcinoma and mesothelioma [19,48].

In this study we exploited the stability of the aberrant cytosine methylation mark and new array-based technology for high throughput measurement of DNA CpG methylation to investigate the methylation status of 1413 autosomal CpG loci associated with 773 cancer-related genes on Illumina's GoldenGate methylation bead-array platform as described above.

Choice of Study Population

Using one of the largest case series studies of these diseases and focusing on epigenetic alteration, we demonstrate that methylation profiling can differentiate lung adenocarcinoma, mesothelioma, and non-malignant tissues. Lung adenocarcinomas (n=57) and non-malignant pulmonary tissues (n=48) (and a subset of non-tumor tissues (n=22 (39%)) were from the adenocarcinoma patients) were from patients treated for NSCLC at the Massachusetts General Hospital from 1992-1996 [49]. Additional normal lung tissues were obtained from the National Disease Research Interchange from donors free of lung malignancy (n=4). Mesotheliomas (n=158) and grossly non-tumorigenic parietal pleura (n=18) were obtained following surgical resection at Brigham and Women's Hospital through the International Mesothelioma Program. Patients were drawn in near equivalent numbers from a pilot study conducted in 2002 (n=70), and an incident case series beginning in 2005 (n=88); among identified cases the participation rate was 85%. All patients provided informed consent under the approval of the appropriate Institutional Review Boards. Clinical information, including histologic diagnosis was obtained from pathology reports.

Analysis of Tissue Sample Methylation

Demographic and tumor characteristic data for these samples are presented in Table 3.

TABLE 3
Patient demographics, exposures, and tissue characteristics

| | Lung | | Pleura | |
|---|---|---|---|---|
| Co-variate | Non-tumor (n = 52)^{a} | Adenocarcinoma (n = 57)^{b} | Non-tumor (n = 18)^{c} | Mesothelioma (n = 158)^{d} |
| Age | | | | |
| Range | 47-89 | 35-89 | 38-77 | 30-84 |
| Mean (SD) | 68.8 (9.2) | 68.2 (11.4) | 58.3 (11.3) | 61.7 (9.8) |
| Gender (n) % | | | | |
| Male | 26 (55.4) | 23 (40.4) | 14 (77.8) | 120 (75.9) |
| Female | 21 (44.6) | 34 (59.6) | 4 (22.2) | 38 (24.1) |
| Histology (n) % | | | | |
| Adenocarcinoma | — | 57 (100) | — | — |
| Epithelioid | — | — | — | 109 (69.0) |
| Biphasic | — | — | — | 44 (27.8) |
| Sarcomatoid | — | — | — | 5 (3.2)^{e} |
| Smoking status | | | | |
| Current | 15 (28.8) | 18 (31.6) | — | 34 (27.2) |
| Former | 27 (51.9) | 27 (47.3) | — | 43 (34.4) |
| Never | 5 (9.6) | 12 (21.1) | — | 48 (38.4) |
| Asbestos^{f} | | | | |
| No | 41 (89.1) | 55 (98.2) | 5 (27.8) | 39 (25.9) |
| Yes | 5 (10.9) | 1 (1.8) | 13 (72.2) | 112 (74.1) |

^{a}Five samples missing age and gender data, 6 samples missing exposure data.
^{b}One sample missing asbestos exposure data
^{c}No smoking data available.
^{d}33 missing smoking data, 7 missing asbestos exposure data.
^{e}Excluded from tumor only analysis
^{f}Occupational exposure (lung), known exposure (pleura)

Mean age and gender distributions were similar between tumor and their non-tumor samples of origin. Lung adenocarcinomas and non-tumor lung samples had similar exposures to smoking, and did not have significantly different asbestos exposure history. Mesotheliomas had similar exposure to asbestos as non-tumor pleural samples.

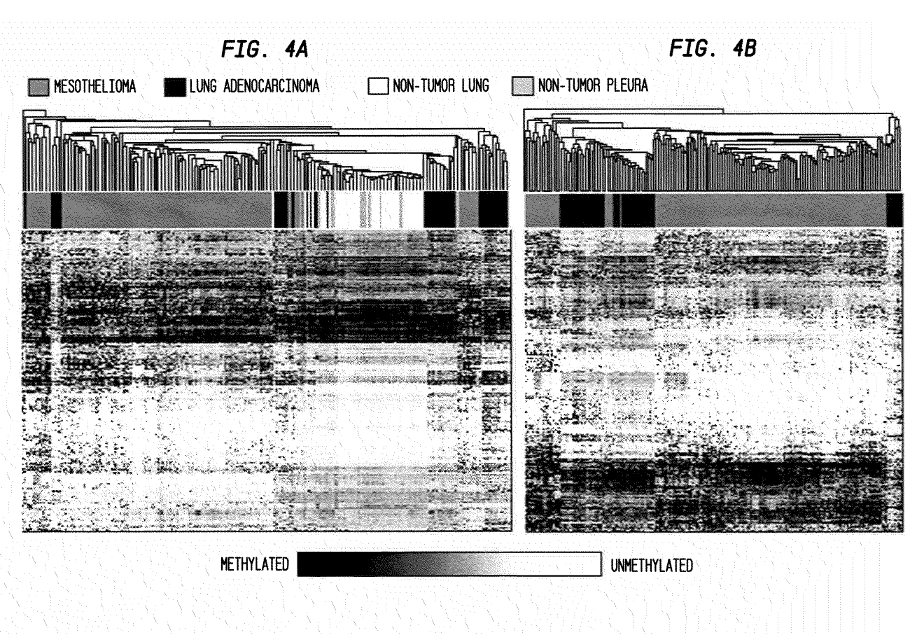

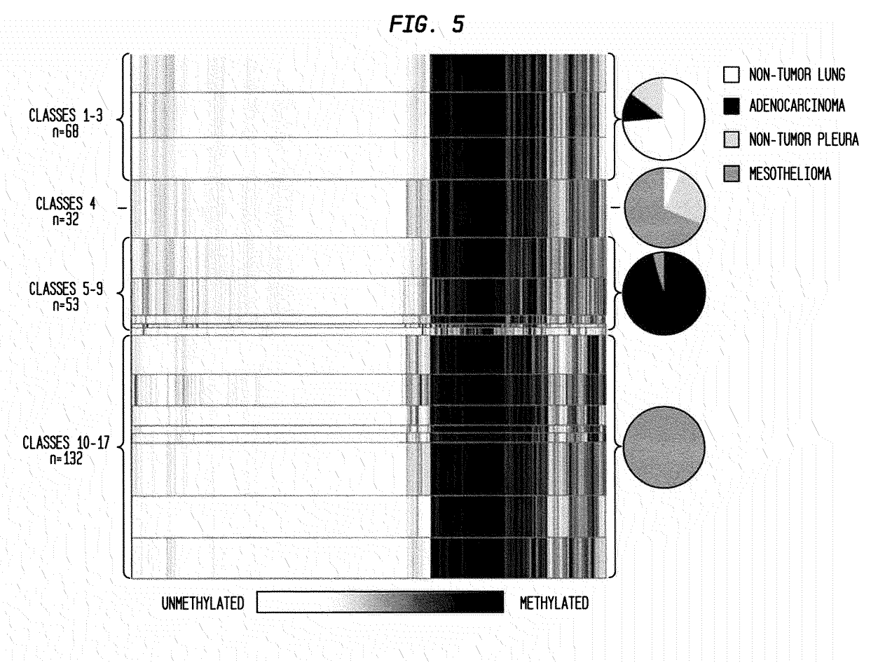

Unsupervised hierarchical clustering of the 500 most methylation-variable autosomal CpG loci revealed readily apparent differences in the epigenetic profiles among lung adenocarcinoma, mesothelioma and non-malignant tissues (FIG. 4A). However, non-malignant pleural and pulmonary tissues do not appear to segregate well from each other. An unsupervised hierarchical clustering of tumors only is shown in FIG. 4B. We next applied a modified model-based form of unsupervised clustering known as recursively partitioned mixture modeling (RPMM) [45]. The RPMM returned 17 methylation classes whose average methylation profiles are shown in FIG. 5; 11 of these classes (68%) perfectly captured a single sample type, and methylation profiles were a significant predictor of tissue sample type (P<0.0001). The 50 CpG loci whose methylation status most effectively discriminates among these 17 methylation classes are listed in Supplemental Table 3.

A supervised random forests (RF) classification of methylation data in all samples was used to follow up on results from the RPMM. RF classification was used because it allows for growing classification trees with a training set drawn from the whole dataset, leaving about one-third of samples out to serve as the test set for generating an unbiased estimate of classification error [50]. RF classification returned a confusion matrix showing which samples are correctly classified, those that are misclassified, and the misclassification error rate for each sample type (Table 4).

TABLE 4
Random forests analysis confusion matrices

| | Lung | | Pleura | | |
|---|---|---|---|---|---|
| | Non-tumor | Adenocarcinoma | Non-tumor | Mesothelioma | Classification error |
| Lung | | | | | |
| Non-tumor | 47 | 4 | 1 | — | 9.6% |
| Adenocarcinoma | 1 | 56 | — | — | 1.8% |
| Pleura | | | | | |
| Non-tumor | 7 | — | 5 | 6 | 66.7% |
| Mesothelioma | — | 2 | — | 156 | 1.3% |

Overall error estimate = 7.0% P < 0.0001

| | Adenocarcinoma | Mesothelioma | Classification error |
|---|---|---|---|
| Adenocarcinoma | 56 | 1 | 1.75% |
| Mesothelioma | 1 | 152 | 0.65% |

Overall error estimate = 0.95% P < 0.0001

Overall, 20 samples were misclassified based on CpG methylation data, an overall misclassification error rate of 7.0%, significantly lower than the expected error rate under the null hypothesis (P<0.0001). Consistent with the observed patterns from unsupervised clustering, non-malignant tissues were more often misclassified (non-tumor misclassification error=24.3%), than tumors (misclassification error=1.4%). Of 52 non-malignant pulmonary tissues, 4 were confused as lung adenocarcinoma, and 1 as a mesothelioma (misclassification error=9.6%). Among 18 non-malignant pleural tissues, 7 were confused as non-tumor lung, and 5 as mesothelioma (misclassification error=66.6%). On the other hand, only one lung adenocarcinoma was misclassified, as a non-tumor lung (misclassification error=1.8%); and only 2 mesotheliomas were misclassified, both as lung adenocarcinoma (misclassification error=1.3%). The 50 most discriminatory CpG loci from this RF analysis are given in Supplemental Table 4.

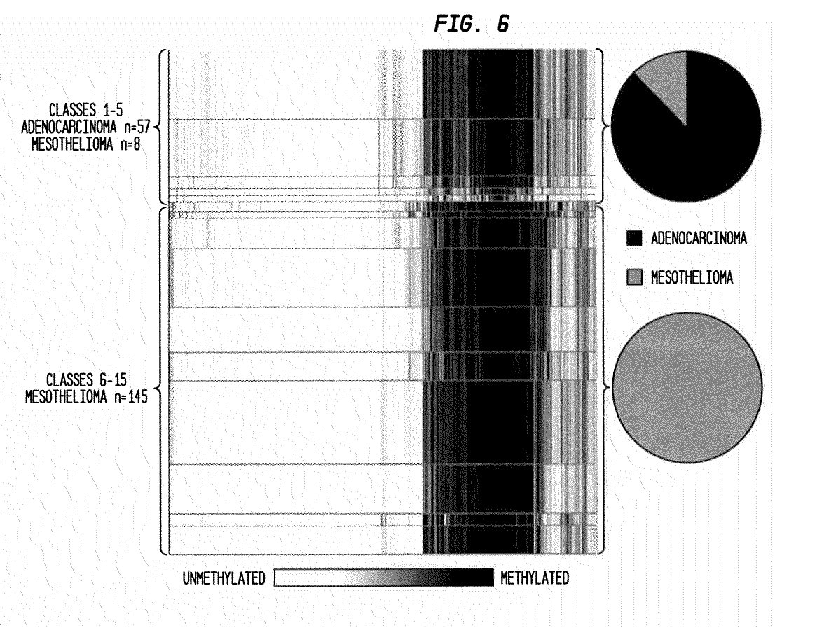

We next restricted our analysis to lung adenocarcinoma and non-sarcomatoid mesotheliomas (n=210) and applied the RPMM approach (FIG. 6). In this model 14 methylation classes result, 12 of which (86%) perfectly capture one tumor type. Methylation classes are significant predictors of tumor type (P<0.0001). The 50 most critical loci for differentiating the methylation classes in this model are listed in Supplemental Table 5. Results were again followed up with random forests classification resulting in a confusion matrix with an overall misclassification error of <1%, (P<0.0001) (Table 4). Only one of each tumor type was misclassified as the other, and the 50 most discriminatory CpG loci for RF classification are given in Supplemental Table 6.

In a univariate approach, we tested all CpG loci individually for an association between methylation and tumor type with generalized linear models, followed by correction for multiple comparisons. In this manner, 1266 CpG loci had methylation levels that differed between lung adenocarcinoma and mesothelioma (Q<0.05, Supplemental Table 7). Among these 1266 CpG loci, 61% exhibited increased methylation in lung adenocarcinoma compared to mesothelioma, and 39% had higher methylation in mesothelioma.

### Example 3

Diagnosis and prognosis of head and neck squamous cell carcinoma was investigated. Head and neck squamous cell carcinoma (HNSCC) is a physically, etiologically, and molecularly heterogeneous disease, with an annual incidence in the United States of over 40,000 cases. The majority of head and neck cancers are associated with tobacco and alcohol use, acting both independently and synergistically [51,52]. However, Human Papilloma Virus (HPV), particularly the high risk type 16, is associated with 20-25% of HNSCC, and individuals with HPV-positive disease compared to HPV-negative have better overall survival [53,54]. Given the established association of etiologic factors with clinical outcome, identifying the molecular character of tumors arising from varying exposures will aid in understanding the mechanisms influencing prognosis and provide novel targets for diagnosis and therapy of HNSCC.

Study of the contribution of epigenetic alterations to tumor biology is now a vast field, and it is widely accepted that epigenetic alterations in target tissues are part of the causal path to the development of malignancy[55,56]. DNA methylation-associated epigenetic silencing of tumor suppressor genes is an aberrant mark of cancer with considerable specificity. DNA hypermethylation in HNSCCs targets genes in pathways such as DNA repair, cell cycle control, apoptosis, angiogenesis, cell-cell interaction, and metastasis [57]. Associations among HPV16, smoking, betel nut use and methylation of specific genes have been identified [58,59,60]. These findings, though, have focused on single gene methylation alterations and their associations to exposures, but have not examined how exposures might be influencing the overall processes leading to epigenetic alteration. We have previously demonstrated that exposures and age, in bladder cancer, lead to an increased propensity for gene promoter hypermethylation in a panel of 16 tumor suppressor genes[61]. Using now available high-throughput technologies, we are better equipped to understand the process by which carcinogenic exposures act to alter the DNA methylation status of a developing tumor.

We aim to more completely understand the etiology of epigenetic alterations by examining the relationships between these alterations and carcinogen exposures. In this manner, we hope to define novel pathways through which HNSCC can arise, and aid in the development of diagnostic screening tools and targeted therapies. We characterized DNA methylation profiles of primary human HNSCC tumors by examining DNA methylation status of approximately 1400 CpG sites in about 800 cancer-related genes in a population-based case series of incident, primary HNSCC and non-diseased head and neck epithelium. Both the diagnostic and prognostic utility of these markers were defined; and uniquely, we also revealed how etiologic factors responsible for head and neck carcinogenesis are associated with the molecular character of these tumors.

Choice of Study Population

The study population has been previously described [58,62]. Briefly, incident cases of histologically confirmed HNSCC were identified from nine medical facilities in the Boston, Mass. metropolitan area. Diagnoses were confirmed by an independent study pathologist. All cases enrolled in the study provided written, informed consent as approved by the IRBs of the participating institutions. Archived pathology specimens were used for analysis of promoter hype rmethylation, and a total of 42 formalin-fixed paraffin embedded (FFPE) and 26 fresh frozen tumor samples were selected for analysis. Data on HPV16 tumor DNA status and serology from the parent case-control study [53] has been previously reported. Demographic and exposure information was collected through self-administered questionnaires, and clinical information through medical chart reviews.

Analysis of Tissue Sample Methylation

Table 5 shows the demographic characteristics of the final population studied. In addition to the case tumor tissues, non-malignant head and neck tissues from individuals without head and neck cancer were obtained from the National Disease Research Interchange (NDRI). Clinicopathologic information is limited by this is anonymous tissue bank, but all samples were obtained from patients who were not previously diagnosed with any cancer, and thus whose cause of death was not cancer related.

TABLE 5
Characteristics of the subjects with tissue
involved in methylation analysis

| | | Non-diseased |
|---|---|---|
| | HNSCC Cases | head and neck |
| Characteristic | (n = 68) | tissues (n = 11) |
| Age, mean (±SD) | 57.6 (11.4) | 66.2 (7.9) |
| Gender, n (%) | | |
| Female | 14 (21%) | 3 (27%) |
| Males | 54 (79%) | 8 (73%) |
| Sample Location, n (%) | | |
| Oral | 35 (52%) | 3 (28%) |
| Pharyngeal | 26 (38%) | 4 (36%) |
| Laryngeal | 7 (10%) | 4 (36%) |
| Cigarette Smoking¹, n (%) | | |
| Never | 16 (24%) | — |
| Former | 38 (56%) | — |
| Current | 13 (20%) | — |
| Lifetime Average Packs per | 1.3 (0.5) | — |
| Day, mean (±SD)¹ | | |
| Number of Years Smoking, | 32.2 (14.5) | — |
| mean (±SD)¹ | | |
| Lifetime Pack-years Smoked¹ | 41.1 (26.1) | — |
| Lifetime Average Alcoholic | 28.3 (35.5) | — |
| Drinks per Week | | |
| Tumor HPV16 DNA Status² | | |
| Negative | 56 (85%) | — |
| Positive | 10 (15%) | — |

¹Smoking data not available on 1 case and metrics of smoking (Average Packs Per Day, Years Smoked, and Pack-years smoked based only on

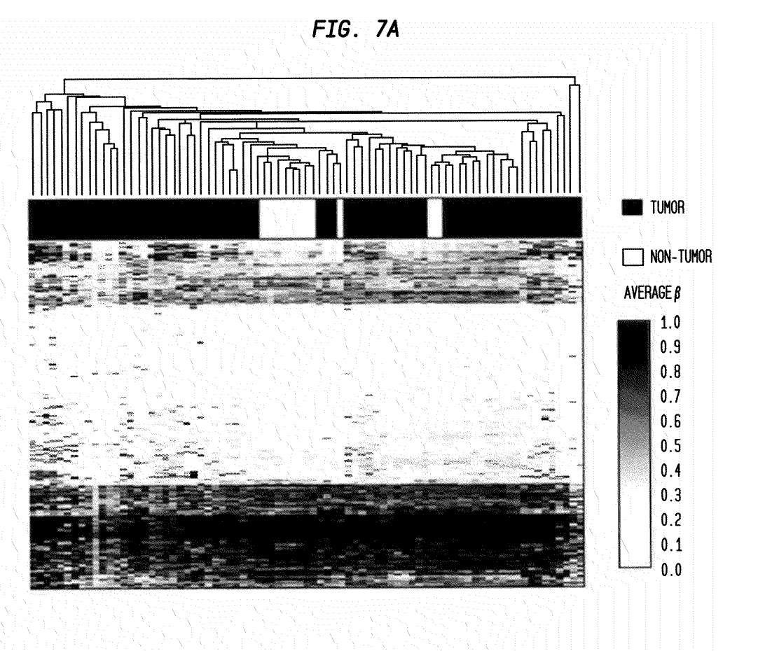

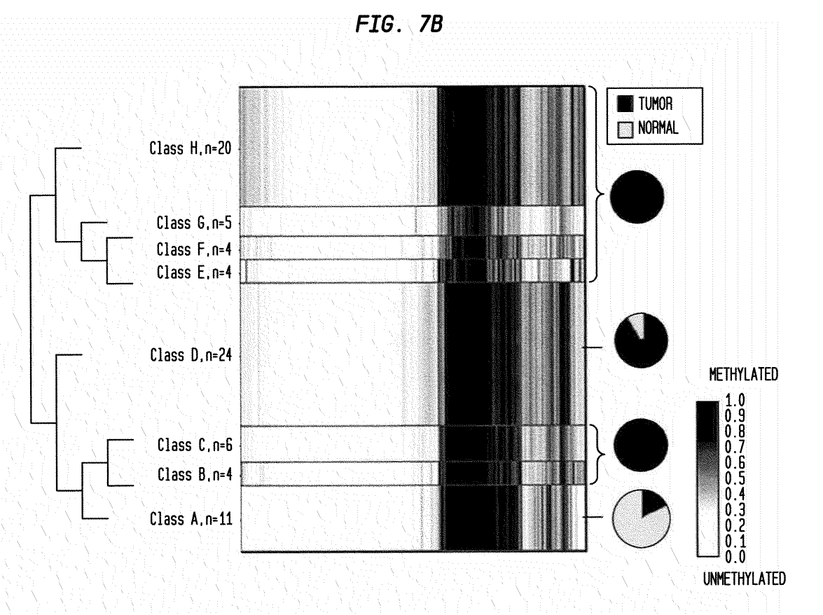

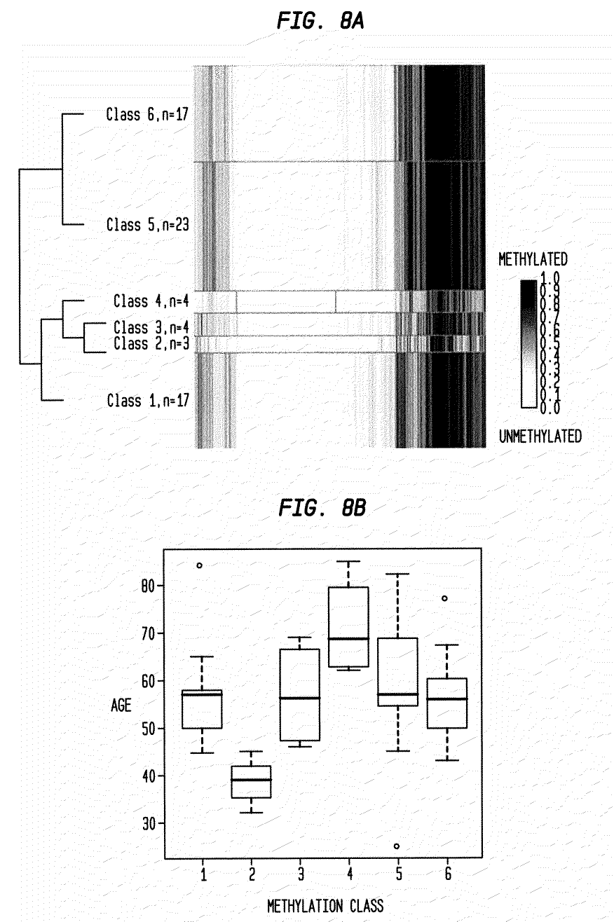

Characterization of the profile of DNA methylation alterations in non-malignant head and neck epithelial tissues compared to HNSCC tumor samples was completed using the IIlumina Goldengate Methylation BeadArray. Unsupervised hierarchical clustering of the DNA methylation data with Manhattan distance and average linkage as the metric across the 1250 most variable autosomal loci (FIG. 7 A) depicts relatively tight clustering of the non-malignant tissues compared to the tumors, as well as the extent of variability in the methylation β value across the loci. In a locus by locus analysis applying an FDR cut-off Q value of 0.05, we identified 261 loci with significantly differential methylation between tumors and normal (Supplemental Table 8). Of those, 125 loci showed greater methylation in tumors compared to normal, while 136 loci exhibited lower methylation levels in tumors compared to normal tissues. The confusion matrix (Table 6) resulting from random forest analysis shows which samples are correctly classified, those that are misclassified, and the misclassification error rate for each sample type.

TABLE 6
Random Forest Classification of Head and Neck Squamous
Cell Carcinoma Tumor Status Using DNA Methylation

| | Tumor Sample | Non-disease Sample | Error Rate |
|---|---|---|---|
| Tumor Sample | 66 | 2 | 2.90% |
| Non-diseased Sample | 5 | 6 | 45% |

Overall Out of the Box (OOB) Estimate of Error Rate = 8.86%, (Permutation test for association: P < 0.0001)

While 5 normal tissues (45%) were confused as tumors, only 2 tumors were misclassified as normal (3.0%), giving an overall error rate of (8.86%), a significant improvement in sample classification compared to the expected under the null hypothesis (P<0.0001). These results, consistent with our previous work, suggest that use of overall patterns of methylation alterations may have more utility in capturing the tumorigenic process than do individual alterations.

A recursive partitioning mixture model, applied to methylation data from all autosomal loci in tumors and non-tumor head and neck epithelial tissues delineated eleven distinct methylation classes (FIG. 7B). This model demonstrates that methylation class membership was a highly significant predictor of tumor status (permutation P<0.0001).

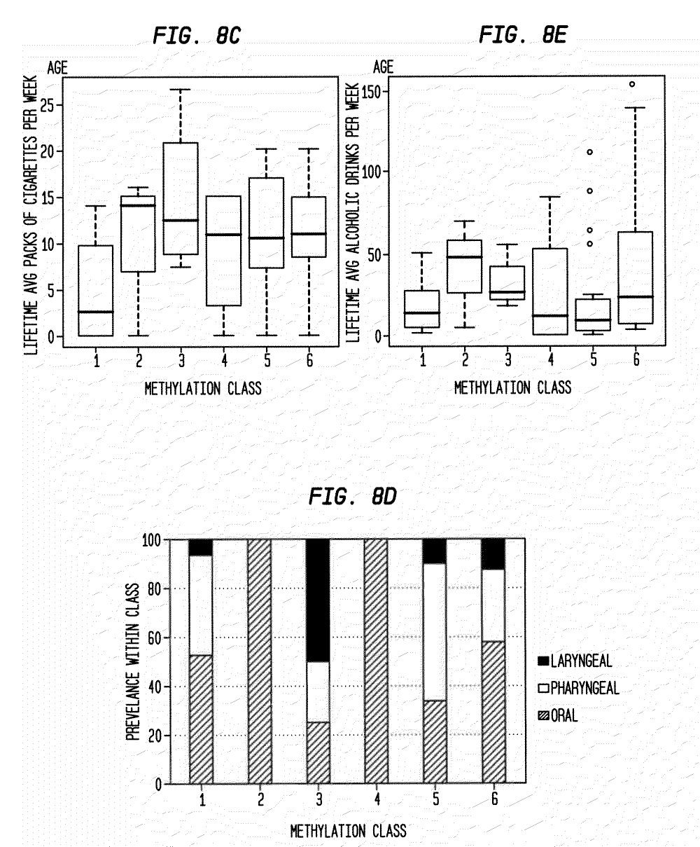

To examine how known risk factors for HNSCC are associated with these profiles, we utilized a case series approach, and re-constructed the recursive partitioning mixture models using only the tumor data (FIG. 8A), resulting in the delineation of six tumor specific classes. A permutation test with tumor stage, dichotomized as high (Stage III or IV) vs. low (Stage I or II) revealed a significant association between methylation Class membership and stage (P<0.01). A logistic regression model of stage (Supplemental Table 9) suggested that inclusion of methylation class is significant in predicting stage (likelihood ratio P<0.01), and that membership in Class 6 was associated with a significantly reduced risk of high stage disease (OR 0.1, 95% CI 0.01, 1.0). Membership in Class 2 showed a similar protective effect, while membership in Class 5 was associated with an increased risk of high stage disease, although the small numbers of tumors in these classes made these estimates unstable.

In order to identify if exposures leading to this disease are associated with these methylation classes, we examined the associations between individual risk factors for HNSCC and these classes. Methylation class was significantly associated with patient age as a continuous variable (Permutation Test P<0.01, FIG. 8B); methylation class 2 members had lower patient age, and class 4 higher age compared to other classes. Smoking intensity (packs per day) also significantly differed across methylation classes (P<0.04, FIG. 8C); Class 1 demonstrated lower smoking intensity, and 3 relatively high intensity. However, we did not observe a significant association of methylation class with smoking duration (years smoked) or pack-years smoked. A borderline significant association was observed with tumor site by methylation class (oral, pharyngeal, and laryngeal, P<0.1) (FIG. 8D). Tumor HPV16 DNA status also demonstrated an association with methylation class which approached statistical significance (P<0.1, FIG. 8E), patients in Class 4 had a greater prevalence of HPV positive tumors. Finally, lifetime average drinks per week also showed a strong differential trend by methylation class (P<0.1).

Multinomial logistic regression results are shown in Table 7, with the classes numbered as they were in FIG. 2A and with Class 5 serving as the referent class as this class had the largest membership. The overall Wald P-value indicates whether the covariate significantly differentiates class membership overall. Individual confidence intervals for each covariate within a class identify the magnitude of any association and significance of the association of a covariate on membership in that class compared to the referent class (Class 5), conditional on membership in either class.

TABLE 7
Multinomial Logistic Regression of Methylation Class Membership by Etiologic Factors

| | Class 1 OR | Class 2 OR | Class 3 OR | Class 4 OR | Class 6 OR | |
|---|---|---|---|---|---|---|
| | (95% CI) | (95% CI) | (95% CI) | (95% CI) | (95% CI) | |
| Covariate | n = 17 | n = 3 | n = 4 | n = 4 | n = 17 | Overall Wald P |
| Age, per year | [symbol] | [symbol] | [symbol] | [symbol] | [symbol] | [symbol] |
| Tumor Site | | | | | | [symbol] |
| Oral | Referent | Referent | Referent | Referent | Referent | |
| Pharyngeal | 1.07 (0.93, 1.22) | [symbol] | 0.98 (0.90, 1.06) | 0.94 (0.88, 1.01) | 0.90 (0.79, 1.01) | |
| Laryngeal | [symbol] | [symbol] | 1.06 (0.95, 1.19) | 0.98 (0.96, 1.01) | 1.01 (0.92, 1.12) | |
| Tumor HPV16 DNA Status | | | | | | 0.32 |
| Negative | Referent | Referent | Referent | Referent | Referent | |
| Positive | 1.00 (0.90, 1.11) | 1.01 (0.95, 1.07) | 0.98 (0.94, 1.01) | 1.09 (0.98, 1.20) | [symbol] | |
| Lifetime Avg. Packs of Cigarettes | [symbol] | 0.93 (0.85, 1.01) | 1.07 (0.94, 1.22) | 0.95 (0.85, 1.06) | 0.92 (0.81, 1.04) | 0.07 |
| Per Day Smoked | | | | | | |
| Lifetime Avg. Alcoholic Drinks Per | [symbol] | 1.00 (0.99, 1.01) | 1.01 (0.99, 1.02) | 1.01 (0.99, 1.02) | [symbol] | [symbol] |
| Week | | | | | | |

Note:
The Odds Ratio for each covariate in each class is conditional on membership in the given class compared to Class 5, the referent class (n = 23). The model is The model is controlled for all covariates listed in the table. Results in bold italics are considered statistically significant (P < 0.05).

Patient age, and average alcohol drinks per week each significantly differentiated membership across classes (Wald P<0.0001). Laryngeal tumors were less likely to be members of Class 1, and the odds of membership in Class 1 were significantly reduced with each year of age. In addition, the odds of membership in Class 1 compared to Class 5 were significantly decreased by almost 20% for each additional pack of cigarettes smoked per day on lifetime average. Each year of age reduced the odds of membership in Class 2 compared to Class 5 by greater than 10%, and tumors in this class were mostly likely to be oral tumors compared to pharyngeal or laryngeal. Only age demonstrated a significant effect on membership in Class 3 and Class 4, leading to a reduced odds of membership in Class 3 compared to Class 5, but an increased odds of membership in Class 4 compared to Class 5. Class 6 tumors were significantly less likely to be HPV positive tumors, but more likely to be from patients with greater lifetime alcohol exposures. These results overall suggest that differing etiologies of this disease influence the pattern of epigenetic alteration observed in the resulting tumors.

We examined if the DNA methylation profiles or methylation at specific loci were associated with patient survival. Amongst the 68 samples examined for methylation using the array, there were 22 deaths and a mean of 2.75 years of follow-up amongst surviving patients (range 0.75-5 years). We found no significant association between methylation classes derived from the RPMM procedure amongst tumors and overall patient survival, controlling for tumor stage and patient age.

Finally, we tested the hypothesis that biologic pathways, rather than overall profiles of methylation, are important in determining survival. To examine this hypothesis, we utilized Ingenuity Pathway Analysis to examine which specific pathways were over-represented amongst the top 500 loci having both positive and negative correlation with survival as determined by loci-specific Cox proportional hazards analysis [63]. The pathways identified to be significantly over-represented are listed in Table 8, as well as correlation between the increase in methylation beta value of the genes represented by that pathways and patient survival, such that those with a positive correlation would represent loci whose increasing methylation level is associated with improved patient survival (i.e. Hazard Ratio<1) while those with a negative correlation are loci where increasing methylation is associated with poorer survival or a risk hazard ratio (>1).

TABLE 8
Pathways significantly over-represented in analysis of loci-specific associations with patient survival

| | Direction of | | |
|---|---|---|---|
| | Correlation with | | |
| Pathway | Survival | P-value | Genes on Array in Pathway |
| Ephrin Receptor Signaling | + | 0.009 | SRC, EGF, CRK, EPHA2, GNG7, PDGFB, FGF1 |
| SAPK/JNK Signaling | + | 0.012 | LCK, GADD45A, CRK, GNG7 |
| PDGF Signaling | + | 0.02 | SRC, PDGFRA, CRK, JAK3, PDGFB |
| Cell Cycle: G2/M DNA Damage | + | 0.03 | CDKN2A, GADD45A, CDKN1A, SFN |
| Checkpoint Regulation | | | |
| NF-_{K}B Signaling | + | 0.039 | LCK, BMP4, IL1RN, LTA, ZAP70, PDGFRA, |
| | | | EGF, IRAK3 |
| p53 Signaling | + | 0.04 | CDKN2A, GADD45A, CDKN1A, SERPINB5, |
| | | | BAX, SFN |
| Acute Phase Response Signaling | + | 0.043 | IL1RN, IL6, RBP1 |
| Hepatic Fibrosis/Hepatic Stellate Cell | + | 0.045 | IFNG, IFNGR2, EGF, MYH11, MMP2, BAX, IL6, |
| Activation | | | PDGFB, FGF1, COL1A1, CYP2E1, PDGFRA, |
| | | | TGFB3 |
| Synaptic Long Term Depression | − | 0.045 | IGF1, GUCY2D, PLA2G2A, NOS2A, NOS3, |
| | | | NPR2 |
| Purine Metabolism | − | 0.049 | TJP2, GUCY2D, PDE1B, NPR2 |

We also identified 18 loci with a false discovery rate less than 20% in their association with overall patient survival in models stratified by tumor stage and controlled for patient age, and those loci are shown in Supplemental Table 10. Of note, only 2 of these 18 loci (ZAP70 and GP1BB) are associated with a hazard ratio>1, while 16 demonstrate a protective HR<1. Such a negative association with risk could indicate, in fact, that loss of methylation at these loci may be associated with increased risk, as one might expect from oncogene activation.

### Example 4

DNA methylation profiles were used to identify genes associated with invasive bladder cancer. In the United States in 2009, an estimated 71,000 cancers of the urinary bladder will be diagnosed and will result in greater than 14,000 deaths[64]. The vast majority of this mortality is attributed to high stage, invasive tumors that infiltrate the muscular layers of the bladder[65]. Lower stage, non-invasive disease, on the other hand, can be successfully treated, though this success comes at great economic burden to the healthcare system. Approximately 500,000 patients require monitoring in the U.S. leading to estimated diagnosis to death per patient costs ranging from $96,000 to $187,000, thereby resulting in $2.2 billion in annual expenditures, making bladder cancer the most expensive of all cancers[66,67]. Thus, cost-effective and prognostic strategies for disease detection and determination of recurrence or progression would be of significant clinical utility.

There is potential for the use of epigenetic alterations and particularly DNA CpG methylation as diagnostic markers for a variety of human cancers, including bladder cancers[68,69]. Hypermethylation of specific genes or families of genes including LAMA3 and the SFRP genes have been associated with invasive disease [70,71,72,73]. Additionally, using a panel of 16 genes, a propensity for hypermethylation in bladder cancers was associated with poorer patient survival[61]. Microarray-based approaches also have attempted to identify novel genes associated with invasive disease but with limited sample sizes due to the array strategy employed[74]. Array technologies which can examine specific CpG site methylation using sodium bisulfite modification strategies, considered the gold-standard of DNA methylation detection, allow for the rapid, cost-effective, and high-throughput determination of methylation status at greater than 1500 CpG sites across greater than 800 genes. Thereby, array approaches can be applied to population-based epidemiologic studies of utilizing large numbers of samples. This approach has established the DNA methylation status in diseases such as head and neck squamous cell carcinoma, malignant pleural mesothelioma, and lymphoma[47,75,76]. We have utilized this array-based approach to identify clinically and biologically informative patterns and novel targets of DNA CpG methylation in a population-based series of bladder transitional cell carcinoma.

Choice of Study Population

We utilized two, independent, non-consecutive population-based series of bladder cancer cases. The first, consisting of tumors from 73 individuals involved in a case-control study of incident bladder cancer in New Hampshire, enrolled between July 1994 and June 1998, has been previously described [77]. The second, consisting of tumors from 264 individuals enrolled between 2000 and 2004 in the New Hampshire portion of the New England Bladder Cancer Study, a population-based case-control study of incident bladder cancer in Maine, Connecticut, and New Hampshire, aimed at identifying the risk factors associated with an increased mortality from bladder cancer in New England. In both studies, all study participants provided written informed consent under the approval of the appropriate institutional review boards. Although separate in time and scope, these two studies utilized identical recruitment procedures, as well as identical protocols for the ascertainment of pathology materials for molecular examinations. Pathology reports and paraffin-embedded tumor specimens were requested from the treating physician/pathology laboratories. Bladder tumors were reviewed by the study pathology (A.R.S.) and classified according to the 1973 and 2004 World Health Organization guidelines for bladder tumors. The study pathologist identified the appropriate block from which the tumor samples used in these analyses were obtained, and the proportion of malignant cells in each sample was recorded. In addition, 5 samples of fresh-frozen, normal bladder epithelium from non-diseased individuals were obtained from the National Disease Research Interchange.

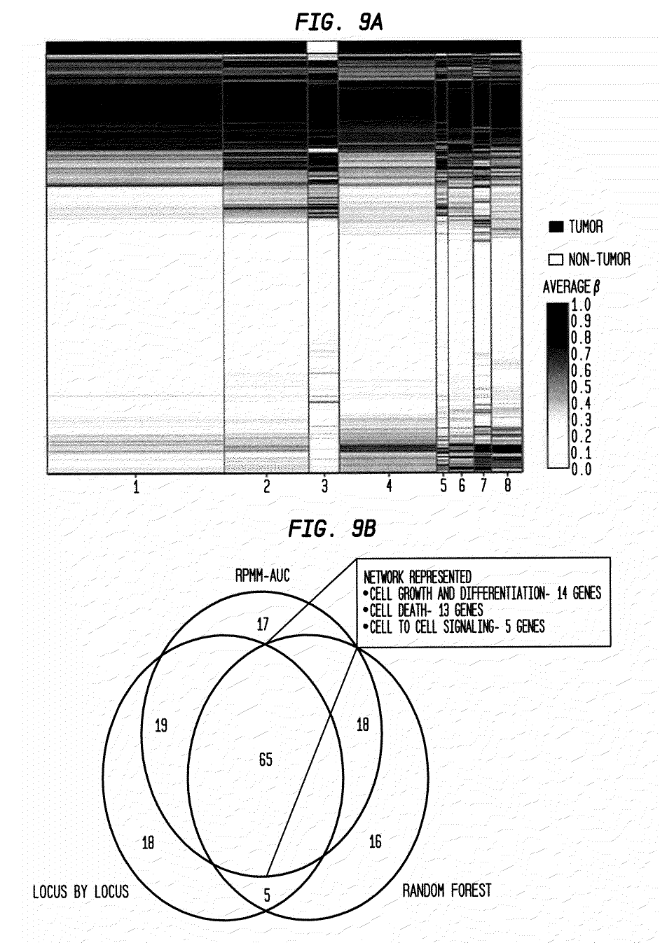

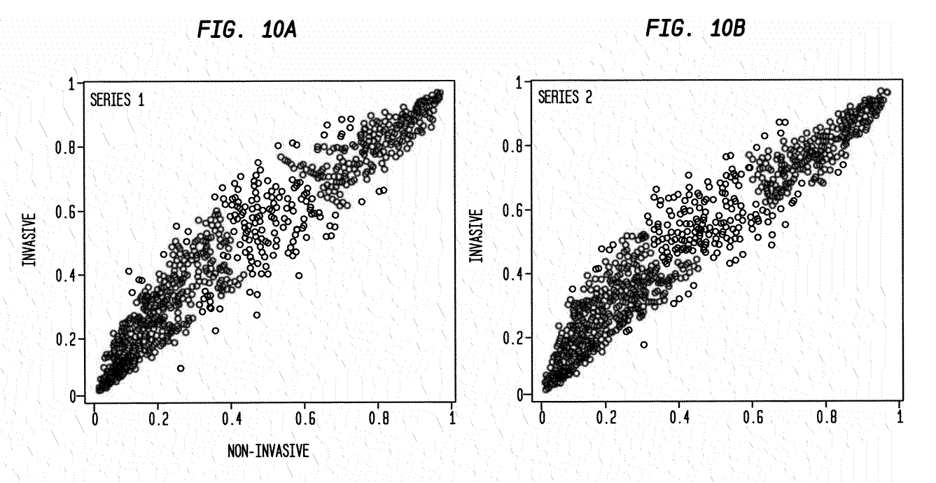

Analysis of Tissue Sample Methylation RPMM resulted in the clustering of these samples into 8 distinct classes (FIG. 9A) with a single class, class 3, containing all non-malignant bladder samples, and thus a significant difference in class membership by sample type (P<0.00001). We next determined the CpG loci which best differentiate methylation class 3 (containing the normal bladder tissues) from the other classes with AUG analysis (Supplemental Table 11). The confusion matrix resulting from the RF analysis (Table 9) demonstrates perfect classification of bladder tumor from non-malignant bladder epithelium (OOB error 0%).

TABLE 9
Confusion Matrix Resulting From Random Forest
Classification of Bladder Tumor and Non-malignant
Bladder Epithelium by DNA Methylation Profile

| | Non-Malignant | Bladder | |
|---|---|---|---|
| | Tissue | Tumor | Classification Error |
| Non-Malignant | 5 | 0 | 0 |
| Bladder Tumor | 0 | 73 | 0 |

Note:
Overall Out of the Box Error = 0%

Prominent loci for differentiating normal and tumorigenic bladder tissues in RF analysis (greatest percent change to the MSE;>5%) are listed in Supplemental Table 12. A locus by locus analysis of bladder tumor CpG methylation versus normal demonstrated that the average β values of 563 loci were significantly associated with tissue type at an FDR of <0.05 (listed in Supplemental Table 13). Of those 141 demonstrated higher average β values in tumors compared to non-malignant tissue, and 422 lower average β values in tumors. Loci with a q-value<1×10⁻⁶ (n=107), an AUC of ≧0.98, and a percent change to the RF MSE≧5% were compared and 65 loci were identified to overlap between these 3 approaches (FIG. 9B and Supplemental Table 14). Bisulfite pyrosequencing confirmed the methylation status of 3 of these loci in a subset of bladder tumors and all normal bladder epithelium samples (data not shown).

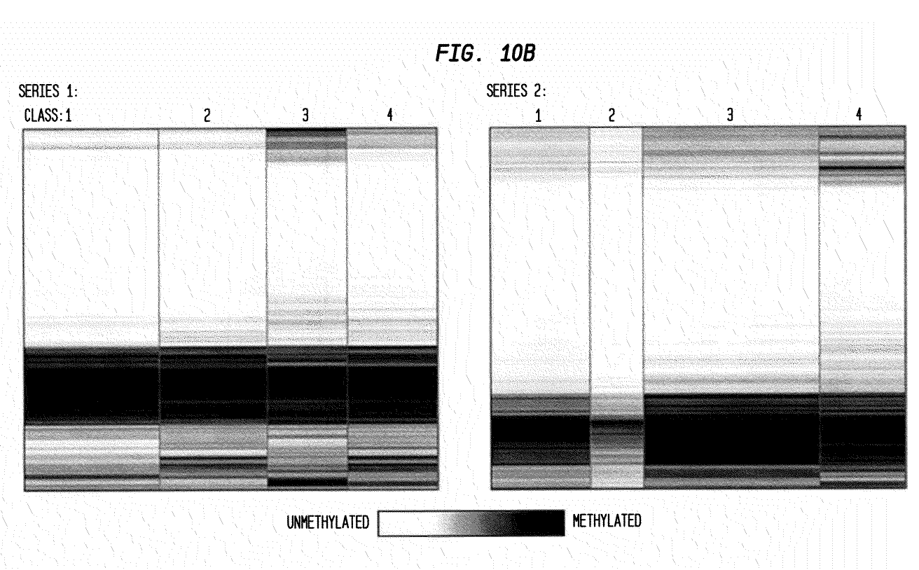

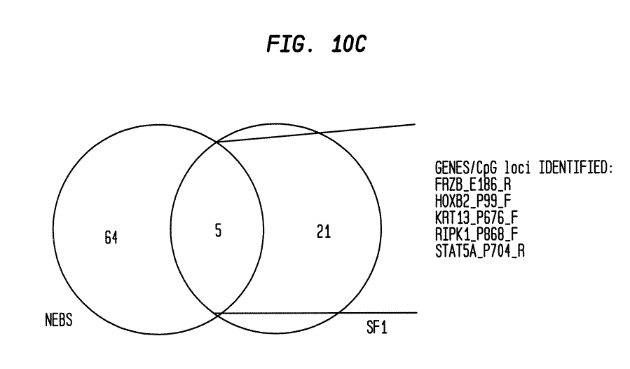

The status of DNA methylation average beta was compared between non-invasive and invasive bladder tumors in each of the 2 series of bladder cases independently and the average methylation beta values in each of these series comparing non-invasive to invasive tumors is depicted in FIG. 10A. These plots show highly similar patterns in both series, and both demonstrate general increased in methylation at numerous loci in invasive compared to non-invasive tumors. These results are confirmed in generalized linear models of examining the association of methylation beta with invasive tumor status in a locus by locus fashion, which demonstrated that 445 loci had significantly increased (FDR q<0.05) methylation and only 68 significantly decreased methylation in invasive compared to non-invasive tumors in series 1 and that 606 loci had significantly increased methylation and 41 significantly decreased methylation in invasive compared to non-invasive tumors in series 2. A list of these loci is provided as Supplemental Table 15.

RPMM revealed for each series, four classes (FIG. 10B) and the prevalence of invasive tumors in these classes was significantly different in each of the series (P<0.00001, permutation chi-square), with large proportions of invasive tumors in the class labeled 4 in each of the series. Using the AUC approach as before, we identified those loci, in each of the series that are most informative at distinguishing class 4 from the other 3 classes, and provide a table of those loci as Supplemental Table 16. A random forest approach at classification of invasive tumors, utilizing series 1 as a training set of methylation data and series 2 as an independent test set demonstrated an out of the bag error rate of 18% based on the training set. Using the classifiers developed from the training set on the test set resulted in overall error rate of 21% (Table 10).

TABLE 10
Confusion Matrices Resulting From Random Forest Classification of Invasive Bladder
Tumors by DNA Methylation Profile with Series 1 as a Training Set and Series 2 as a Test Set

| | | |
|---|---|---|
| | Invasive Bladder | Classification |
| Non-Invasive Bladder Tumor | Tumor | Error |

Series 1-Training Set

| | | | |
|---|---|---|---|
| Non-Invasive Bladder | 37 | 5 | 0.12 |
| Tumor | | | |
| Invasive Bladder Tumor | 8 | 23 | 0.26 |

Series 2-Test Set

| | | | |
|---|---|---|---|
| Non-Invasive Bladder | 172 | 17 | 0.09 |
| Tumor | | | |
| Invasive Bladder Tumor | 38 | 37 | 0.51 |

Note:
Overall Out of the Box Error on Training Set = 17.8%
Test Set Overall Error Rate = 20.1%

Loci contributing a more significant percent change to the MSE (>5%) are listed in Supplemental Table 17. In series 1 and series 2, of loci with a locus by locus analysis q-value<0.001 (n=93 and 327, respectively), an RPMM AUG of >75% (n=103 and 122, respectively), and a percent change to the RF MSE≧6% (n=97 and 189, respectively), 5 loci were identified as overlapping across the 3 approaches and in both series of tumors (FIG. 10C; FRZB_E186_R, HOXB2_P99_F, KRT13_P676_F, RIPK1_P868_F, STAT5A_P704_JR).

Pyrosequencing assays for FRZB, STAT5A, KRT13, and HOXB2 were designed to examine the CpG examined on the array as well as 6 additional neighboring CpG sites for FRZB or 1 additional neighboring CpG sites for STAT5A and KRT13. There is were no neighboring CpG sites within the sequencing range of a pyrosequencing reaction for HOXB2. A subset of non-invasive (n=12) and invasive (n=11) bladder tumors examined on the array were sequenced for each of these loci. For all CpG sites examined, as well as the mean across sites for FRZB, KRT13, and HOXB2 we observed significantly greater methylation extent in invasive compared to non-invasive tumors, consistent with the array results. For STAT5A, we could confirm the significantly greater extent of methylation at the CpG site measured by the array in invasive compared to non-invasive tumors, but did not observe this association in the neighboring CpG sites.

In order to validate these results, we performed pyrosequencing for FRZB, KRT13, and HOXB2 in an independent series of bladder tumors (n=263) which were not examined in the array analysis and further evaluate patient survival as data for >10 years of follow-up was available in this series. Pyrosequencing results were successfully obtained for 248 samples at FRZB, 242 samples at HOXB2, and for 244 samples at KRT13. There was significant correlation between methylation extent at each of the individual loci examined in FRZB (P<0.0001, R²>0.8 for each CpG site compared to the other 6) and KRT13 (P<0.0001, R²=0.85) and thus we used the mean of the methylation across the sites for the subsequent analyses. The mean extent of methylation across all sites ranged from 0.98 to 97.8 (median 24.0) at FRZB, 14.5 to 92.0 (median 59.8) at KRT13, and for the single position examined at HOXB2 ranged from 0.0 to 91.5 (median 32.8).

Logistic regression models were used to examine the association between methylation extent at each of the loci, dichotomized at the median and invasive bladder cancer, controlled for patient age, gender, and TP53 immunohistochemical staining intensity, which has been previously associated with invasive disease[78,79]. Greater methylation extent of HOXB2 was strongly associated with invasive bladder cancer, independent of TP53 staining intensity (OR 7.7, 95% CI 3.3, 18.2), while greater methylation extent of neither KRT13 nor FRZB demonstrated a significant association. Further, in a logistic regression model including the methylation extent of all three of these loci and controlled for patient age, gender, and TP53 immunohistochemical staining intensity, HOXB2 was a significant risk factor for invasive disease (OR 8.6 95% CI 3.4, 21.7) adjusted for FRZB and KRT13 methylation and TP53 IHC staining intensity (Table 11).

TABLE 11
Associations Between Methylation of HOXB2, KRT13 and FRZB and
Invasive Bladder Cancer

| | | | Invasive Disease OR |
|---|---|---|---|
| | Noninvasive, n (%) | Invasive, n (%) | (95% CI) |
| Total N | 162 | 57 | |
| HOXB2 Methylation | | | |
| Negative (≦ median) | 104 (93.7) | 7 (6.3) | 1.0 (referent) |
| Positive (> median) | 58 (53.7) | 50 (46.3) | 8.6 (3.4, 21.7) |
| KRT13 Methylation | | | |
| Negative (≦ median) | 86 (81.9) | 19 (18.1) | 1.0 (referent) |
| Positive (> median) | 76 (66.7) | 38 (33.3) | 1.0 (0.4, 2.3) |
| FRZB Methylation | | | |
| Negative (≦ median) | 84 (78.5) | 23 (21.5) | 1.0 (referent) |
| Positive (> median) | 78 (69.6) | 34 (30.4) | 0.9 (0.4, 2.0) |
| TP53 IHC Staining Intensity | | | |
| Low (<3) | 146 (84.9) | 26 (15.1) | 1.0 (referent) |
| High (3+) | 16 (34.0) | 31 (66.0) | 6.1 (2.7, 13.8) |

Note:
Model is controlled for all variables in table as well as patient age and gender and includes
all subjects with data on all 3 genes and TP53 IHC.

We also examined combinations of methylation extent of these genes and found that having greater than the median methylation extent of both HOXB2 and KRT13 was associated with a statistically significant 8.5 fold (95% CI 2.6, 27.8) increased risk of invasive bladder cancer, compared to having neither methylation, and that methylation of either gene imparted an intermediate risk of invasive disease of 5.4 fold (95% CI 1.6, 17.8; P for trend<0.0003, Table 12).

TABLE 12
Methylation of Both KRT13 and HOXB2 is Independently Associated with Invasive
Bladder Cancer

| | Noninvasive, n (%) | Invasive, n (%) | Invasive Disease OR (95% CI) |
|---|---|---|---|
| Total N | 164 | 60 | |
| HOXB2 & KRT13 Methylation | | | |
| Neither Methylated | 67 (94.4) | 4 (5.6) | 1.0 (referent) |
| One Methylated | 59 (74.7) | 20 (25.3) | 5.4 (1.6, 17.8) |
| Both Methylated | 38 (51.4) | 36 (48.6) | 8.5 (2.6, 27.8) |
| TP53 IHC Staining Intensity | | | |
| Low (<3) | 148 (85.1) | 26 (14.9) | 1.0 (referent) |
| High (3+) | 16 (32.0) | 31 (68.0) | 8.1 (3.7, 18.0) |

Note:
Model is controlled for all variables in table as well as patient age and gender and includes all subjects with data
on HOXB2 and KRT13 methylation and TP53 IHC. Trend test P < 0.0003.

There appeared to be dose-dependently poorer survival in those with either HOXB2 or KRT13 methylation extent>median and those individuals having both HOXB2 and KRT13 methylation extent>median, compared to those with both methylation extents≦median; Cox proportional hazards model (P for trend<0.03), with a 2.2 fold increased risk of death (95% CI 1.1, 4.6) among those having >median methylation extent at both of these loci, adjusted for patient age, gender, and TP53 IHC staining intensity (Table 13).

TABLE 13
Proportional Hazards Model of Survival in Bladder
Cancer by Both HOXB2 and KRT13 Methylation

| | n (%) | HR (95% CI) |
|---|---|---|
| HOXB2 & KRT13 Methylation | | |
| Neither Methylated | 73 (31.3) | 1.0 (referent) |
| One Methylated | 85 (36.5) | 1.5 (0.8, 3.1) |
| Both Methylated | 75 (32.3) | 2.2 (1.1, 4.6) |
| TP53 IHC Staining Intensity | | |
| Low (<3) | 177 (76.0) | 1.0 (referent) |
| High (3+) | 56 (24.0) | 1.0 (0.5, 1.9) |

Note:
Model is controlled for all variables in table as well as patient age, gender,
and tumor stage and includes all subjects with data on HOXB2 and KRT13
methylation and TP53 IHC. Trend test P < 0.03.

### Example 5

DNA methylation profiles were used for differentiate lung tumors from normal lung tissue and predicting patient survival.

Choice of Study Population

Non-small cell lung tumors (n=114) and non-malignant lung tissues (n=48, matched to tumors) were from patients treated for NSCLC at the Massachusetts General Hospital from 1992-1996 [49]. Additional normal lung tissues were obtained from the National Disease Research Interchange from donors free of lung malignancy (n=4). All patients provided informed consent under the approval of the appropriate Institutional Review Boards. Clinical information, including histologic diagnosis was obtained from pathology reports.

Analysis of Tissue Sample Methylation

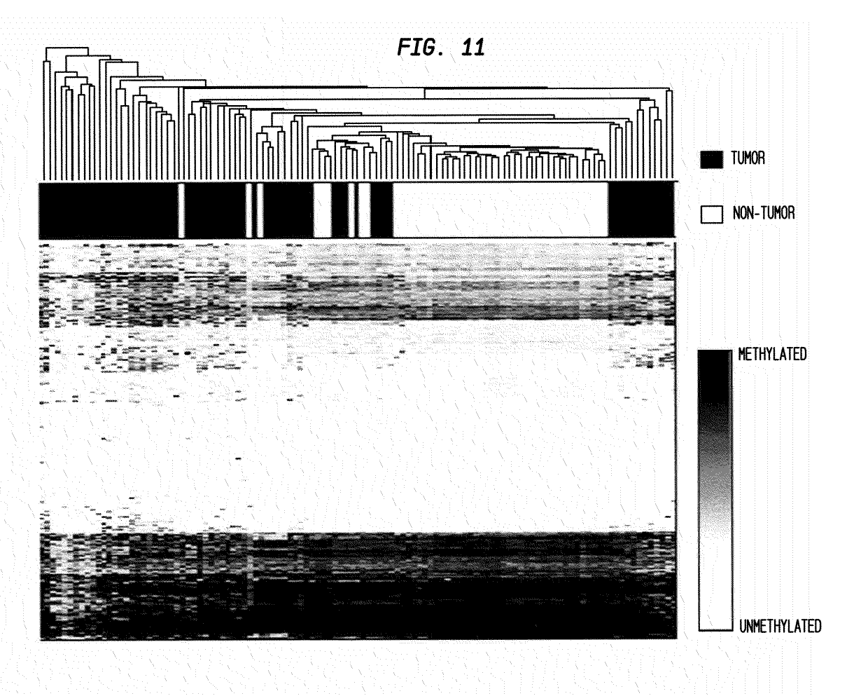

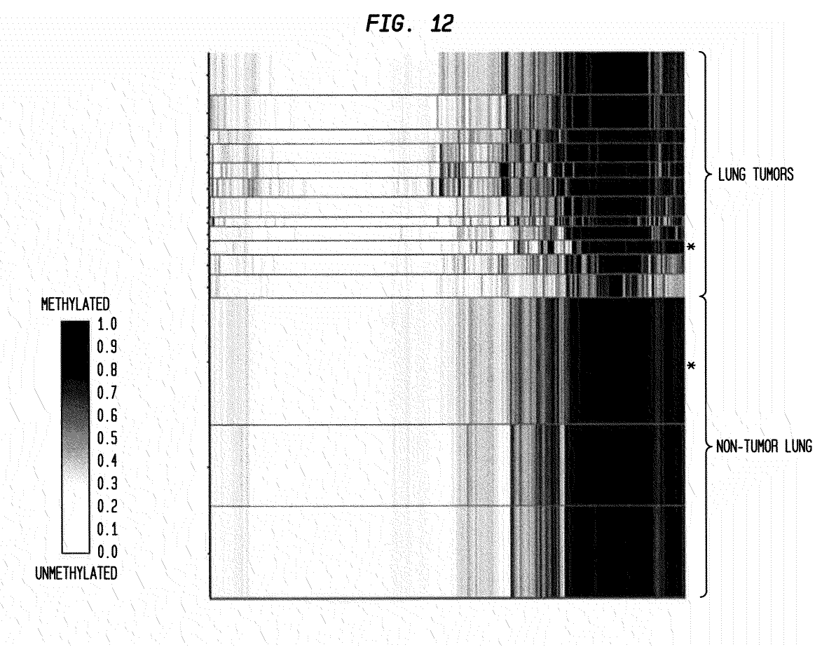

Unsupervised hierarchical clustering of all lung tumor and non-tumor lung tissues is presented in FIG. 11. The DNA methylation data at autosomal CpG loci for lung tumors (n=114) and non-tumor lungs (n=52) were modeled with a recursively partitioned mixture model (RPMM) and the resulting methylation profiles are displayed in FIG. 12. Lung tumors are distributed among 12 main classes, and non-tumor lung samples are distributed among three main classes. Only one lung tumor was present in one of the three main non-tumor lung methylation classes; and only one non-tumor lung sample was present in one of the lung tumor methylation classes. The DNA methylation profiles from RPMM significantly predict disease (P<0.0001). In a locus by locus comparison of CpG methylation in lung tumors versus non-tumor lung tissues (with patient-matched tumor/normal pairs removed) 1047 CpG loci were differentially methylated (Q<0.05; Supplemental Table 18). Among these 1047 CpG loci, 540 CpGs had increased methylation in tumors relative to normal lung samples and 507 CpG loci had increased methylation in normal lung tissue samples.

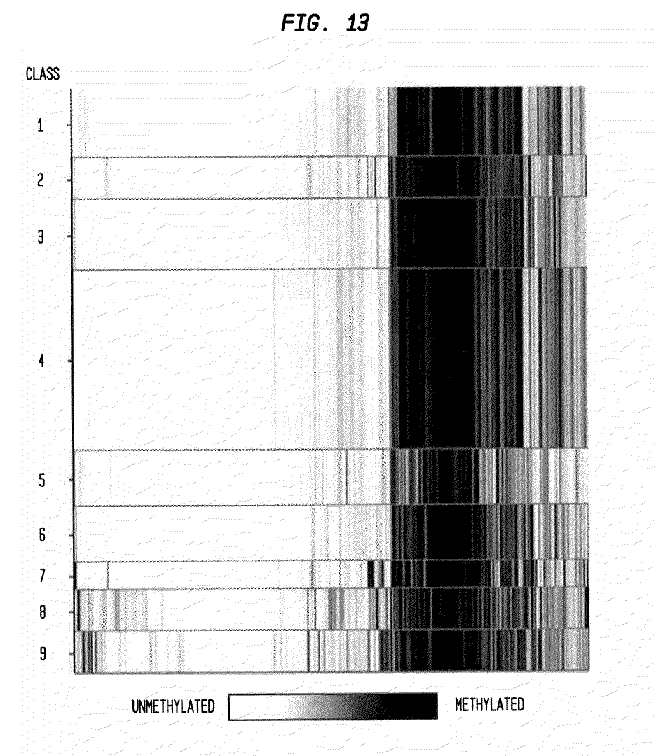

Next, squamous cell lung cancers were independently modeled with RPMM and nine methylation classes resulted (FIG. 13). Using a cox proportional hazards model of survival and controlling for patient age, gender and smoking status patients in methylation class 1 had significantly increased risk of death relative to patients in all other methylation classes (Table 14).

TABLE 14
Cox proportional hazards model of survival for squamous cell
carcinoma of the lung RPMM methylation class membership
(controlled for age, gender, stage, and smoking status).

| Methylation class | Hazard Ratio | P-value |
|---|---|---|
| 1 | 1.0 | referent |
| 2 | 0.19 | 0.04 |
| 3 | 0.20 | 0.03 |
| 4 | 0.09 | 0.0002 |
| 5 | 0.19 | 0.02 |
| 6 | 0.10 | 0.01 |
| 7 | 0.09 | 0.04 |
| 8 | 0.03 | 0.002 |
| 9 | 0.10 | 0.01 |

### Example 6

DNA methylation profiles were used in newborn infants to predict risk of developing leukemia and predicting both disease subtype and prognosis among cases.

The most common subtypes of childhood leukemia include proB-cell, cALL, and preB-cell. The most common molecular abnormality among pre-B cell leukemia is the t(1;19) E2A-PBX1 translocation which comprises about 25% of the subtype and about 5% of all pediatric ALL. The extent and timing of epigenetic alterations which contribute to the development of childhood leukemia are unknown. However, with readily available tumor cells from circulating blood, and the fact that these cancers develop early in life presents a unique opportunity for examining the potential of DNA methylation profiling in diagnosis, prognosis, risk assessment, and monitoring for disease.

We aimed to explore the potential for DNA methylation profiles to differentially diagnose specific leukemia subtypes, discover DNA methylation profiles which complement t(1;19) and other non-epigenetic molecular abnormalities with prognostic indications. Furthermore, in an examination of DNA methylation profiles from infant blood samples from individuals who went on to develop leukemia (n=30) and individuals who did not develop disease (n=20) we aimed to determine the ability of DNA methylation profiling in infants to inform risk of developing leukemia.

Choice of Study Population

Patients and Guthrie card infant blood samples were derived from the Northern California Childhood Cancer Study, an epidemiology study, and from the Children's Oncology DNA bank. Conventional karyotyping identified patients as t(1;19), and molecular cloning of the translocation provided confirmation [80]. All patient's parents provided informed consent, and the research was reviewed by the Institutional Review Board at UCSF.

Analysis of Sample Methylation/Analysis of Leukemias

Leukemia samples (n=53) were subjected to methylation analysis as described above in Example 1. Using recursively partitioned mixture modeling of DNA methylation data resulted in seven distinct methylation classes and leukemia subtype (cAAL/preB-cell) was significantly associated with methylation profile class membership (P<0.0001; Table 15).

TABLE 15
RPMM methylation classes in leukemia samples by disease
type demonstrates a significant association between
methylation profile and leukemia subtype (P < 0.0001).

| Methylation class | cALL | preB |
|---|---|---|
| 1 | 0 | 10 |
| 2 | 1 | 2 |
| 3 | 0 | 4 |
| 4 | 6 | 18 |
| 5 | 3 | 1 |
| 6 | 4 | 0 |
| 7 | 4 | 0 |

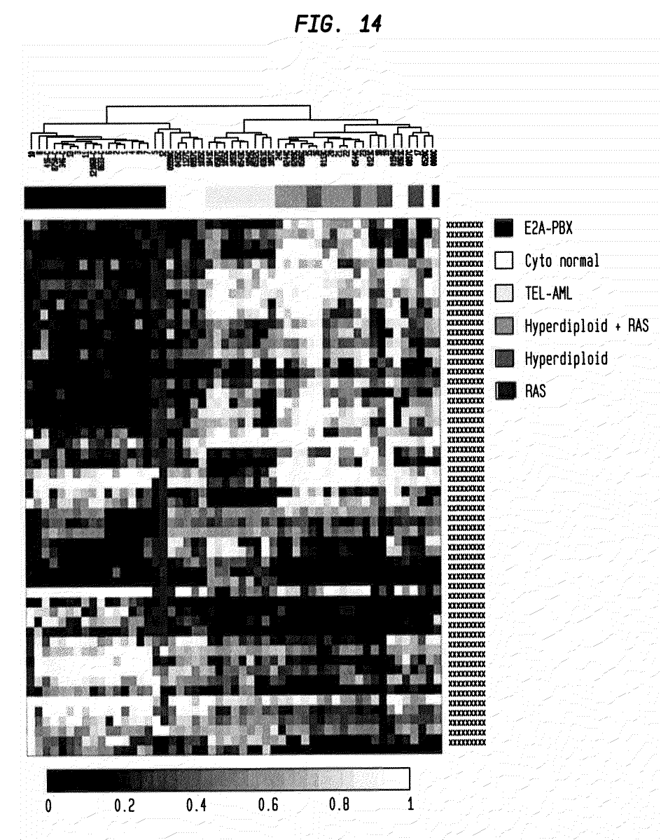

Next, the association between specific molecular abnormalities and methylation profiles in these cases were explored by generating a clustering heatmap using linear models were fitted for each CpG site on the leukemia subtype to derive differences between all pairs of subtypes (FIG. 14). Moderated t-statistics & the associated p-values were calculated, as well as B-statistics, the log posterior odds ratio that a gene is differentially methylated (DM) versus not DM across distinct molecular abnormalities. The 40 CpGs with FDR<0.05 were used for clustering analysis. Leukemia subtypes in grayscale above the clustering heatmap: note that TEL-AML1 (30% black) completely clusters independently, as do hyperdiploid, and hyperdiploid RAS+, separately (50%, 60% black respectively). E2A-PBX1 (black) is distinct from the others.

Analysis of Infant Blood Samples

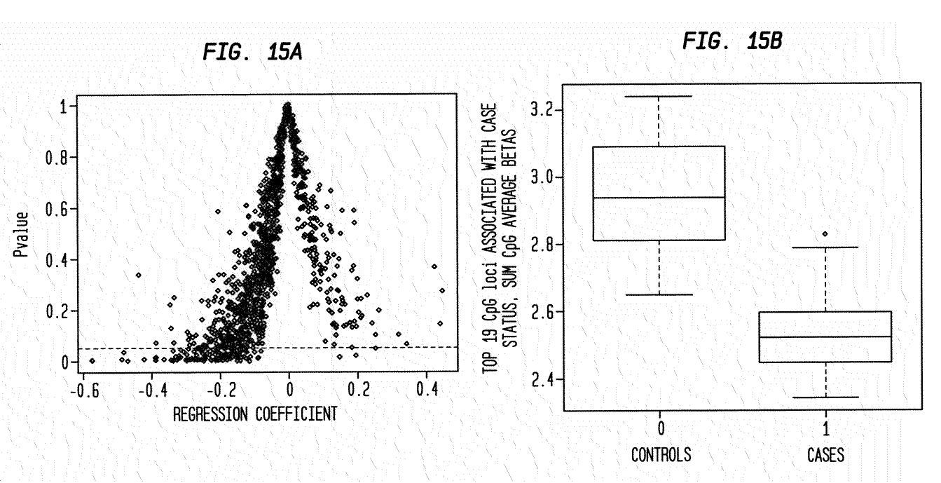

Next, infant blood samples from 30 patients who went on to develop leukemia and 20 infant blood samples from healthy individuals were subjected to methylation analysis as described above in example 1. In a locus-by-locus analysis of CpG methylation comparing infant bloods from cases to controls we found significantly reduced methylation in cases relative to controls (Supplemental Table 19; FIG. 15A). The strong trend for decreased methylation in infant blood DNA from cases relative to controls is further exemplified in FIG. 15B which plots the distributions of the sum of the top 19 most differentially methylated CpG loci between cases and controls, indicating significantly higher methylation in controls relative to cases (P=5.0×10⁻¹³).

### Example 7

A DNA methylation based test is used for enumerating the numbers and ratios of immune cells within peripheral blood and malignant and non-malignant tissues.

Using the unique epigenetic signature of differentiated immune cells the assay allows for quantitation of immune cells by quantitative methylation specific PCR. Applications.
1. A measure of cancer susceptibility in oncology.
2. A measure of immune status
3. A measure of immunosuppression in transplantation medicine
4. A measure of immunosuppression in autoimmune disorders
5. A measure of immunosuppression within tumor tissues as a prognostic indicator in oncology

The role of the immune system in human cancer occurrence and survival has been the subject of extensive clinical and epidemiological study. The immune system is an extraordinarily complex network of differentiated cell types, immunoglobulin, surface receptors and cytokine/chemokines factors. The central role of cell mediated immunity in tumor surveillance has been argued forcefully. Our own studies in brain tumors have pointed to atopic immune responses as being associated both with glioma occurrence and survival. Recently a specialized subset of T-cells termed T regulatory cells has been implicated in human cancer as well as a host of autoimmune and infections pathologies.

The study of cellular immune factors in cancer epidemiology both etiologic and clinical has been severely limited by need to employ cell surface markers to identify and enumerate cells in readily available specimens such as peripheral blood. The most widely accepted methods utilize fresh cells isolated from whole blood and subjected to flow cytometry using highly specific antibodies to membrane associated proteins. For example T-reg cells are sorted and counted by virtue of their expression of membrane CD4 and CD25 proteins. Many thousands of blood specimens have been archived from case control and cohort populations that are not suitable for immune cell evaluation. This patent application covers the development of epigenetic markers that will overcome these limitations and open the door to existing and future studies to utilize archival blood DNA to characterize immunologic parameters in human cancer.

Materials and Methods.

Blood Cells and Glioma Tissues

Peripheral blood cells from normal donors (granulocytes, neutrophils, monocytes, pan T cells, B cells and CD4+/CD25+ regulatory T cells) were purchased from ALLCELLS, LLC (Emeryville, Calif.) with FACScan Analysis Report attached. Fresh frozen glioma tissues were from University of California San Francisco, Brain Tumor Tissue Bank.

DNA and RNA Co-Extractions

DNA and RNA was isolated using Qiagen AllPrep Mini Kit (Qiagen, CA) according to manufacturer's protocol. Briefly, the frozen cells was quickly thawed in 37° C. water bath, washed with warm media containing 10% FBS, and then went through the protocol for cultured cells.

DNA Bisulfite Conversion

Bisulfite treatment of genomic DNA was performed using ZYMO EZ DNA Methylation Kit (Zymo Research Corp., CA) based on Zymo's instructions. About 1-2 ug of genomic DNA was used, and the reaction was incubated overnight at 50° C. Converted DNA was then column purified, and eluted twice in total of 40-60 ul buffer.

Plasmid Standard Constructs

Plasmid constructs corresponding to reported differentially methylated regions of FOXP3 gene promoter were created: transcription start site (TSS) region (region 1 [81]), and conserved region (region 2 [82]), about 4 kb down stream from region 1, 2 kb before the translation start site.

PCR products (see Table 16 for primer sequences) were generated, purified and cloned into pCR2.1-TOPO vector, using TOPO TA cloning kit (Invitrogen) according to the manufacturer's instructions and verified by sequencing. Plasmids were purified with Qiagen Plasmid Mini Kit, the concentration was determined by Nanodrop (NanoDrop ND-1000. NanoDrop Technologies, Inc. DE) and diluted to obtain final concentrations of 100, 10, 1, and 0.1 fg representing 20,000, 2,000, 200, and 20 plasmid copies as standard for quantitative PCR (qPCR) reactions.

Quantitative MSP

Real-time PCR was performed in a final reaction volume of 20 μL using ABI 7900HT Real Time PCR System. Each reaction contained 15 pmol each of methylation or non-methylation-specific forward and reverse primer (see Table 17 for primer and probe sequences), 5 pmol of hydrolysis probe, and 30 ng of bisulfite-treated genomic DNA template or a respective amount of plasmid standard. Each sample was analyzed in triplicate. Cycling conditions consisted of a 95° C. preheating step for 10 min and 50 cycles of 95° C. for 15 s followed by 1 min at 61° C.

TABLE 16
Primer sequences for plasmid standard preparation.

| Primer Name | 5′---------3′ | Size | Comments | FOXP3 Insert |
|---|---|---|---|---|
| FoxSeq1F | TTT ATA TTT GGT AGG GGA GAG TAG | 389 bp | Region 1 | Bisulfite Specific |
| FoxSeq1R | ATC TCA TTA ATA CCT CTC ACC TCT | | | |
| FoxSeq2F | TGT TTG GGG GTA GAG GAT TTA G | 336 bp | Region 2 | Bisulfite Specific |
| FoxSeq2R | TAT CAC CCC ACC TAA ACC AAA C | | | |
| FoxWT1F | A TCT GGT AGG GGA GAG CAG | 382 bp | Region 1 | Wildtype/Unmethyl |
| FoxWT1R | C TCA TTG ATA CCT CTC ACC TCT | | | |
| FoxWT2F | T CTG GGG GTA GAG GATCCTA | 332 bp | Region 2 | Wildtype/Unmethyl |
| FoxWT2R | TCA CCC CAC CTG GGC CAA | | | |

TABLE 17
Methylight Primer and probe sequences for quantitative MSP.

| Name | 5′-3′ sequence | Size | Comments |
|---|---|---|---|
| FoxReg1U5 | TAG TTT GGT TTG TGG GAA ATT GTT AT | 149 bp | USP for region 1 |
| FoxReg1U3 | ATA ATT ATC AAC ACA CAC ACT CAT CA | | |
| FoxReg1USPprobe | ATC TAC AAC TTC CAC ACC ATA CAA CAT AA | | |
| FoxReg1M5 | GTT TGG TTT GTG GGA AAT TGT TAC | 144 bp | MSP for region 1 |
| FoxReg1M3 | ATT ATC AAC GCA CAC ACT CAT CG | | |
| FoxReg1MSPprobe | ACG ACT TCC ACA CCG TAC AAC GTA A | | |
| FoxReg2U5 | ATT TGG GTT TTG TTG TTA TAG TTT TTG A | 108 bp | USP for region 2 |
| FoxReg2U3 | CTC TTC TCT TCC TCC ATA ATA TCA | | |
| FoxReg2USPprobe | AAC CCA ACA CAT CCA ACC ACC ATA ACA A | | |
| FoxReg2M5 | TTG GGT TTT GTT GTT ATA GTT TTC GA | 104 bp | MSP for region 2 |
| FoxReg2M3 | CTT CTC TTC CTC CGT AAT ATC G | | |
| FoxReg2MSPprobe | CCG ACG CAT CCG ACC GCC ATA | | |

### Pleural Mesothelioma/Lung Adenocarcinoma Scenarios:

### Example 8

A 72 year old retired male shipyard worker presents with a pleural mass. The subject's DNA methylation data is obtained from cells taken from pleural fluid and the data derived by the methods described herein. This data is compared with pleural DNA methylation data obtained from Tumor Control and Normal Control pleural samples at all autosomal CpG loci by comparing the Subject DNA methylation data to a library of Tumor Control DNA methylation data and a library of Normal Control DNA methylation data (each representing same tissue of origin); and fitting by mixture modeling P(Y,C) Subject DNA methylation data to said Tumor and Normal Control DNA methylation data using recursively partitioned mixture modeling (RPMM) in conjunction with an empirical Bayes procedure generating a posterior probability distribution P(C|y*) of methylation class membership for Subject DNA y*. In this example the Subject DNA methylation data's identity with Normal Control is indicated by posterior probability of membership P(C=k|y*) at least 90% in a class k comprised of at least 95% Normal Control samples [P(control|C=k)>95%]; and establishing a metric-based criterion for comparison by computing mean methylation average beta values μⱼ at each CpG locus j from said Normal Control DNA methylation samples data yᵢⱼ and fitting the distribution of squared weighted Euclidean distances dᵢ²=Σ{(yᵢⱼ−μⱼ)²/[μⱼ(1−μⱼ)]} to a gamma distribution G, and where said Subject DNA methylation data's squared weighted Euclidean distance d*²={(yⱼ*−μⱼ)²/[μⱼ(1−μⱼ)]} is less than the 95% quantile of G it is indicated with at least 95% certainty that the subject's sample is Normal. Here the subject's squared weighted Euclidian distance d*² is greater than the 95% quantile of G indicating with at least 95% certainty that the subject's sample is cancer.

### Example 9

In another example, a 70 year old man presents with chest pain and dyspnea secondary to pleural effusion. Pleural fluid is collected, spun and DNA from cell precipitate is extracted and bisulfite modified for DNA methylation profiling as in the preceding example and comparison is made to Tumor and Normal Control samples from reference tissues of origin for suspected cancer type (pleura and lung) with the method descried in the preceding example. The pleural fluid sample methylation profile indicates that the man suffers from lung adenocarcinoma.

### Example 10

A 70 year old female is diagnosed with pleural mesothelioma. Prior to elective (and major) surgery to excise the tumor, a biopsy is obtained and sent for DNA methylation profiling and compared to Tumor Control samples of the same tissue origin (i.e. mesotheliomas) by applying the diagnostic steps of the preceding examples, but utilizing the Tumor Control DNA methylation sample data and not the Normal data. The subjects' prognosis is then made on the basis that it is generally equivalent to the history of subjects from which Tumor Control DNA methylation data was derived having distribution of class membership greater than about 90%. In this example, subjects with similar tumor methylation survived about 30 to 50 weeks, which is the prognosis for this subject and were refractory to cisplatin treatment.

### Example 11

### Non-Melanoma Squamous Cell Carcinoma of the Skin Prognosis

An individual is diagnosed with squamous cell carcinoma of the skin to be treated with surgical resection. The DNA from the resected tumor is evaluated for methylation changes as described herein. It is determined that additional therapies (chemotherapy) and enhanced screening during patient follow-up will improve patient outcome.

### Example 12

### Lung Cancer Example

An individual with a 30 year history of smoking is screened for early detection of cancer. Sputum samples are collected, DNA extracted followed by methylation analysis and profiles of methylation are compared as disclosed herein to a Tumor Control library of lung cancers. It is determined that presence of malignancy is probable and surgery is scheduled. At the time of surgical resection for lung cancer, the subject's surgical margins are swabbed for detection of residual disease. DNA is extracted from these surgical swabs, and methylation profiles determined. The swab sample methylation profile is compared to the resected specimen and the subject's swab sample profile is identified as having poor clinical outcome, suggesting palliative care only.

### Example 13

### Head and Neck Cancer

A 50 year old female has an oral cavity biopsy of an unknown mass taken and sent for DNA methylation profiling. Based on the DNA methylation profile of the tissue sample it is determined that she has oral cancer which is of a type associated with a poor prognosis.

### Example 14

### Bladder Cancer

A 70 year Asian male presents with pain and bleeding in his urine. A bladder mass is discovered and biopsied. DNA methylation of the mass tissue is profiled and compared to normal and tumor methylation patterns. It is determined that the tumor is invasive and the patient is assigned for aggressive therapy and enhanced screening for recurrent disease.

### Example 15

A 68 year old man previously diagnosed with non-invasive stage bladder cancer and successfully removed is now undergoing screening for recurrence of the disease or progression of the disease to invasive bladder cancer. A urine sample is taken every 6 months, cells are isolated from the urine sample through centrifugation, and the DNA methylation profile is assayed and compared to a Tumor Control library from bladder tumors as well as to the patient's own, previously resected tumor profile. It is determined that the tumor has not progressed and the individual is scheduled for another screening in 6 months.

### Example 16

### Leukemia

A blood sample drawn from a subject at birth is sent for DNA methylation profiling and compared to a Control library of infant blood samples from individuals who are healthy and individuals who went on to develop leukemia. It is determined that the infant is at a high-risk of developing leukemia, and assigned for additional diagnostics and enhanced screening practices.

All documents referred to herein including the following publications are incorporated herein by reference in their entirety.
1. Fearon E R, Vogelstein B (1990) A genetic model for colorectal tumorigenesis. Cell 61: 759-767.
2. Loeb L A (1991) Mutator phenotype may be required for multistage carcinogenesis. Cancer Res 51: 3075-3079.
3. Jones P A, Baylin S B (2002) The fundamental role of epigenetic events in cancer. Nat Rev Genet 3: 415-428.
4. Bibikova M, Lin Z, Zhou L, Chudin E, Garcia E W, et al. (2006) High-throughput DNA methylation profiling using universal bead arrays. Genome Res 16: 383-393.
5. Robinson B W, Lake R A (2005) Advances in malignant mesothelioma. N Engl J Med 353: 1591-1603.
6. Morinaga K, Kishimoto T, Sakatani M, Akira M, Yokoyama K, et al. (2001) Asbestos-related lung cancer and mesothelioma in Japan. Ind Health 39: 65-74.
7. Price B, Ware A (2004) Mesothelioma trends in the United States: an update based on Surveillance, Epidemiology, and End Results Program data for 1973 through 2003. Am J Epidemiol 159: 107-112.
8. Roushdy-Hammady I, Siegel J, Emri S, Testa J R, Carbone M (2001) Genetic-susceptibility factor and malignant mesothelioma in the Cappadocian region of Turkey. Lancet 357: 444-445.
9. Bhagavatula R, Moody R, Russ J (2001) Asbestos: a moving target. Best's Review 102: 85-90.
10. Peto J, Decarli A, La Vecchia C, Levi F, Negri E (1999) The European mesothelioma epidemic. Br J Cancer 79: 666-672.
11. Joshi T K, Gupta R K (2004) Asbestos in developing countries: magnitude of risk and its practical implications. Int J Occup Med Environ Health 17: 179-185.
12. Landrigan P J, Lioy P J, Thurston G, Berkowitz G, Chen L C, et al. (2004) Health and environmental consequences of the world trade center disaster. Environ Health Perspect 112: 731-739.
13. Wagner J C, Sleggs C A, Marchand P (1960) Diffuse pleural mesothelioma and asbestos exposure in the North Western Cape Province. Br J Ind Med 17: 260-271.
14. Jaurand M C (1997) Mechanisms of fiber-induced genotoxicity. Environ Health Perspect 105 Suppl 5: 1073-1084.
15. Kelsey K T, Yano E, Liber H L, Little 1B (1986) The in vitro genetic effects of fibrous erionite and crocidolite asbestos. Br J Cancer 54: 107-114.
16. He B, Lee A Y, Dadfarmay S, You L, Xu Z, et al. (2005) Secreted frizzled-related protein 4 is silenced by hypermethylation and induces apoptosis in beta-catenin-deficient human mesothelioma cells. Cancer Res 65: 743-748.
17. Hirao T, Bueno R, Chen C J, Gordon G J, Heilig E, et al. (2002) Alterations of the p16(INK4) locus in human malignant mesothelial tumors. Carcinogenesis 23: 1127-1130.
18. Tsou J A, Galler J S, Wali A, Ye W, Siegmund K D, et al. (2007) DNA methylation profile of 28 potential marker loci in malignant mesothelioma. Lung Cancer.
19. Tsou J A, Shen L Y, Siegmund K D, Long T I, Laird P W, et al. (2005) Distinct DNA methylation profiles in malignant mesothelioma, lung adenocarcinoma, and non-tumor lung. Lung Cancer 47: 193-204.
20. Christensen B C, Godleski J J, Marsit C J, Houseman E A, Lopez-Fagundo C Y, et al. (2008) Asbestos exposure predicts cell cycle control gene promoter methylation in pleural mesothelioma. Carcinogenesis 29: 1555-1559.
21. Sugarbaker D J, Richards W G, Gordon G J, Dong L, De Rienzo A, et al. (2008) Transcriptome sequencing of malignant pleural mesothelioma tumors. Proc Nati Acad Sci USA 105: 3521-3526.
22. Gordon G J, Rockwell G N, Jensen R V, Rheinwald J G, Glickman J N, et al. (2005) Identification of novel candidate oncogenes and tumor suppressors in malignant pleural mesothelioma using large-scale transcriptional profiling. Am J Pathol 166: 1827-1840.
23. Gordon G J, Jensen R V, Hsiao L L, Gullans S R, Blumenstock J E, et al. (2003) Using gene expression ratios to predict outcome among patients with mesothelioma J Nati Cancer Inst 95: 598-605.
24. Gordon G J, Rockwell G N, Godfrey P A, Jensen R V, Glickman J N, et al. (2005) Validation of genomics-based prognostic tests in malignant pleural mesothelioma. Clin Cancer Res 11: 4406-4414.
25. Lopez-Rios F, Chuai S, Flores R, Shimizu S, Ohno T, et al. (2006) Global gene expression profiling of pleural mesotheliomas: overexpression of aurora kinases and P16/CDKN2A deletion as prognostic factors and critical evaluation of microarray-based prognostic prediction. Cancer Res 66: 2970-2979.
26. Nguyen G K, Akin M R, Villanueva R R, Slatnik J (1999) Cytopathology of malignant mesothelioma of the pleura in fine-needle aspiration biopsy. Diagn Cytopathol 21: 253-259.
27. Antman K H (1980) Current concepts: malignant mesothelioma. N Engl J Med 303: 200-202.
28. Chang M Y, Sugarbaker D J (2004) Extrapleural pneumonectomy for diffuse malignant pleural mesothelioma: techniques and complications. Thorac Surg Clin 14: 523-530.
29. Molina J R, Yang P, Cassivi S D, Schild S E, Adjei A A (2008) Non-small cell lung cancer: epidemiology, risk factors, treatment, and survivorship. Mayo Clin Proc 83: 584-594.
30. Renshaw A A, Dean B R, Antman K H, Sugarbaker D J, Cibas E S (1997) The role of cytologic evaluation of pleural fluid in the diagnosis of malignant mesothelioma. Chest 111: 106-109.
31. Ylagan L R, Zhai J (2005) The value of ThinPrep and cytospin preparation in pleural effusion cytological diagnosis of mesothelioma and adenocarcinoma. Diagn Cytopathol 32: 137-144.
32. Marchevsky A M (2008) Application of immunohistochemistry to the diagnosis of malignant mesothelioma. Arch Pathol Lab Med 132: 397-401.
33. Marchevsky A M, Wick M R (2007) Evidence-based guidelines for the utilization of immunostains in diagnostic pathology: pulmonary adenocarcinoma versus mesothelioma. Appl Immunohistochem Mol Morphol 15: 140-144.
34. Gordon G J, Jensen R V, Hsiao L L, Gullans S R, Blumenstock J E, et al. (2002) Translation of microarray data into clinically relevant cancer diagnostic tests using gene expression ratios in lung cancer and mesothelioma. Cancer Res 62: 4963-4967.
35. Bird A (2002) DNA methylation patterns and epigenetic memory. Genes Dev 16: 6-21.
36. De Vuyst P, Karjalainen A, Dumortier P, Pairon J-C, Monso E, et al. (1998) 1998 ERS Task Force Report Guidelines for mineral fibre analyses in biological samples: report of the ERS working group. Eur Respir J 11: 1416-1426.
37. Churg A, Warnock M L (1977) Correlation of quantitative asbestos body counts and occupation in urban patients. Arch Pathol Lab Med 101: 629-634.
38. Shen L, Toyota M, Kondo Y, Lin E, Zhang L, et al. (2007) Integrated genetic and epigenetic analysis identifies three different subclasses of colon cancer. Proc Natl Aced Sci USA 104: 18654-18659.
39. Siegmund K D, Connor C M, Campan M, Long T I, Weisenberger D J, et al. (2007) DNA methylation in the human cerebral cortex is dynamically regulated throughout the life span and involves differentiated neurons. PLoS ONE 2: e895.
40. Siegmund K D, Laird P W, Laird-Offring a I A (2004) A comparison of cluster analysis methods using DNA methylation data. Bioinformatics 20: 1896-1904.
41. Christensen B C, Godleski J J, Roelofs C R, Longacker J L, Bueno R, et al. (2008) Asbestos burden predicts survival in pleural mesothelioma. Environ Health Perspect 116: 723-726.
42. R Development C T (2007) R: A Language and Environment for Statistical Computing. Vienna, Austria: R Foundation for Statistical Computing.
43. Hsiung D T, Marsit C J, Houseman E A, Eddy K, Furniss C S, et al. (2007) Global DNA methylation level in whole blood as a biomarker in head and neck squamous cell carcinoma. Cancer Epidemiol Biomarkers Prey 16: 108-114.
44. Storey J, Taylor J, Siegmund D (2004) Strong control, conservative point estimation, and simultaneous conservative consistency of false discovery rates: A unified approach. J Royal Stat Soc Series B: 187-205.
45. Houseman E A, Christensen B C, Marsit C J, Karagas M R, Wrensch M R, et al. (2008) Model-based clustering of DNA methylation array data: a recursive-partitioning algorithm for high-dimensional data arising as a mixture of beta distributions. BMC Bioinformatics 9.
46. Breiman L (2001) Random Forests. Machine Learning 45: 5-32.
47. Christensen B C, Houseman E A, Godleski J J, Marsit C J, Longacker J L, et al. (2009) Epigenetic profiles distinguish pleural mesothelioma from normal pleura and predict lung asbestos burden and clinical outcome. Cancer Res 69: 227-234.
48. Toyooka 5, Pass H I, Shivapurkar N, Fukuyama Y, Maruyama R, et al. (2001) Aberrant methylation and simian virus 40 tag sequences in malignant mesothelioma. Cancer Res 61: 5727-5730.
49. Wiencke J K, Kelsey K T, Varkonyi A, Semey K, Wain J C, et al. (1995) Correlation of DNA adducts in blood mononuclear cells with tobacco carcinogen-induced damage in human lung. Cancer Res 55:4910-4914.
50. Brieman L (2001) Random Forests. Machine Learning 45: 5-32.
51. Blot W J, McLaughlin J K, Winn D M, Austin D F, Greenberg R S, et al. (1988) Smoking and drinking in relation to oral and pharyngeal cancer. Cancer Res 48: 3282-3287.
52. Hashibe M, Brennan P, Benhamou S, Castellsague X, Chen C, et al. (2007) Alcohol drinking in never users of tobacco, cigarette smoking in never drinkers, and the risk of head and neck cancer: pooled analysis in the International Head and Neck Cancer Epidemiology Consortium. J Natl Cancer Inst 99: 777-789.
53. Furniss C S, McClean M D, Smith J F, Bryan J, Nelson H H, et al. (2007) Human papillomavirus 16 and head and neck squamous cell carcinoma. Int J Cancer 120: 2386-2392.
54. Loning T, Ikenberg H, Becker J, Gissmann L, Hoepfer I, et al. (1985) Analysis of oral papillomas, leukoplakias, and invasive carcinomas for human papillomavirus type related DNA. J Invest Dermatol 84: 417-420.
55. Jones P A, Laird P W (1999) Cancer epigenetics comes of age. Nat Genet 21: 163-167.
56. Gaudet F, Hodgson J G, Eden A, Jackson-Grusby L, Dausman J, et al. (2003) Induction of tumors in mice by genomic hypomethylation. Science 300: 489-492.
57. Fan C Y (2004) Epigenetic alterations in head and neck cancer: prevalence, clinical significance, and implications. Curr Oncol Rep 6: 152-161.
58. Marsit C J, McClean M D, Furniss C S, Kelsey K T (2006) Epigenetic inactivation of the SFRP genes is associated with drinking, smoking and HPV in head and neck squamous cell carcinoma. Int Cancer 119: 1761-1766.
59. Marsit C J, Liu M, Nelson H H, Posner M, Suzuki M, et al. (2004) Inactivation of the Fanconi anemia/BRCA pathway in lung and oral cancers: implications for treatment and survival. Oncogene 23: 1000-1004.
60. Tran T N, Liu Y, Takagi M, Yamaguchi A, Fujii H (2005) Frequent promoter hypermethylation of RASSF1A and p161NK4a and infrequent allelic loss other than 9p21 in betel-associated oral carcinoma in a Vietnamese non-smoking/non-drinking female population. J Oral Pathol Med 34: 150-156.
61. Marsit C J, Houseman E A, Schned A R, Karagas M R, Kelsey K T (2007) Promoter hypermethylation is associated with current smoking, age, gender and survival in bladder cancer. Carcinogenesis 28: 1745-1751.
62. Ting Hsiung D, Marsit C J, Houseman E A, Eddy K, Furniss C S, et al. (2007) Global DNA methylation level in whole blood as a biomarker in head and neck squamous cell carcinoma. Cancer Epidemiol Biomarkers Prey 16: 108-114.
63. (2008) Ingenuity Pathways Analysis application. 6.3, build 54960 ed: Ingenuity Systems.
64. Jemal A, Siegel R, Ward E, Hao Y, Xu J, et al. (2009) Cancer statistics, 2009. CA Cancer J. Clin.
65. Surveillance E, and End Results (SEER) Program (2008) SEER*Stat Database: Mortality—All COD, Aggregated With State, Total U.S. (1969-2005)<Katrina/Rita Population Adjustment>. National Cancer Institute, DCCPS, Surveillance Research Program, Cancer Statistics Branch.
66. Botteman M F, Pashos C L, Redaelli A, Laskin B, Hauser R (2003) The health economics of bladder cancer—A comprehensive review of the published literature. Pharmacoeconomics 21: 1315-1330.
67. Waxman J (2007) Urological cancers in clinical practice. London: Springer. xii, 275 p. p.
68. Yu I, Zhu T, Wang Z, Zhang H, Qian Z, et al. (2007) A novel set of DNA methylation markers in urine sediments for sensitive/specific detection of bladder cancer. Clin Cancer Res 13: 7296-7304.
69. Hogue M O, Begum S, Topaloglu O, Chatterjee A, Rosenbaum E, et al. (2006) Quantitation of promoter methylation of multiple genes in urine DNA and bladder cancer detection. J Natl Cancer Inst 98: 996-1004.
70. Marsit C J, Karagas M R, Andrew A, Liu M, Danaee H, et al. (2005) Epigenetic inactivation of SFRP genes and TP53 alteration act jointly as markers of invasive bladder cancer. Cancer Res 65: 7081-7085.
71. Sathyanarayana U G, Maruyama R, Padar A, Suzuki M, Bondaruk I, et al. (2004) Molecular detection of noninvasive and invasive bladder tumor tissues and exfoliated cells by aberrant promoter methylation of laminin-5 encoding genes. Cancer Res 64: 1425-1430.
72. Stoehr R, Wissmann C, Suzuki H, Knuechel R, Krieg R C, et al. (2004) Deletions of chromosome 8p and loss of sFRP1 expression are progression markers of papillary bladder cancer. Lab Invest 84: 465-478.
73. Urakami S, Shiina H, Enokida H, Kawakami T, Kawamoto K, et al. (2006) Combination analysis of hypermethylated Wnt-antagonist family genes as a novel epigenetic biomarker panel for bladder cancer detection. Clin Cancer Res 12: 2109-2116.
74. Aleman A, Adrien L, Lopez-Serra L, Cordon-Cardo C, Esteller M, et al. (2008) Identification of DNA hypermethylation of SOX9 in association with bladder cancer progression using CpG microarrays. Br J Cancer 98: 466-473.
75. Killian J K, Bilke S, Davis S, Walker R L, Killian M S, et al. (2009) Large-scale profiling of archival lymph nodes reveals pervasive remodeling of the follicular lymphoma methylome. Cancer Res 69: 758-764.
76. Marsit C J, Christensen B C, Houseman E A, Karagas M R, Wrensch M R, et al. (2009) Epigenetic Profiling Reveals Etiologically Distinct Patterns of DNA Methylation in Head and Neck Squamous Cell Carcinoma. Carcinogenesis.
77. Karagas M R, Tosteson T D, Blum J, Morris J S, Baron J A, et al. (1998) Design of an epidemiologic study of drinking water arsenic exposure and skin and bladder cancer risk in a U.S. population. Environ Health Perspect 106 Suppl 4: 1047-1050.
78. Kelsey K T, Hirao T, Hirao S, Devi-Ashok T, Nelson H H, et al. (2005) TP53 alterations and patterns of carcinogen exposure in a U.S. population-based study of bladder cancer. Int J Cancer 117: 370-375.
79. Malats N, Bustos A, Nascimento C M, Fernandez F, Rivas M, et al. (2005) P53 as a prognostic marker for bladder cancer: a meta-analysis and review. Lancet Oncol 6: 678-686.
80. Wiemels J L, Leonard B C, Wang Y, Segal M R, Hunger S P, et al. (2002) Site-specific translocation and evidence of postnatal origin of the t(1;19) E2A-PBX1 fusion in childhood acute lymphoblastic leukemia. Proc Natl Acad Sci USA 99: 15101-15106.
81. Janson P C, Winerdal M E, Marits P, Thorn M, Ohlsson R, et al. (2008) FOXP3 promoter demethylation reveals the committed Treg population in humans. PLoS One 3: e1612.
82. Baron U, Floess S, Wieczorek G, Baumann K, Grutzkau A, et al. (2007) DNA demethylation in the human FOXP3 locus discriminates regulatory T cells from activated FOXP3(+) conventional T cells. Eur J Immunol 37: 2378-2389.

SUPPLEMENTAL TABLE 1
CpG loci with differential methylation in tumor versus non-tumor pleura

| CpG locus | Regression coefficient* | Δβ** | P-value | Q-value | Rank |
|---|---|---|---|---|---|
| ADAMTS12_E52_R | −1.814 | 0.338 | 0 | 0 | 1 |
| APC_P280_R | −0.940 | 0.040 | 0 | 0 | 2 |
| APP_E8_F | −0.943 | 0.033 | 0 | 0 | 3 |
| BCAM_E100_R | −0.588 | 0.017 | 0 | 0 | 4 |
| CARD15_P302_R | −1.355 | 0.221 | 0 | 0 | 5 |
| CCND3_P435_F | −0.926 | 0.049 | 0 | 0 | 6 |
| CCNE1_P683_F | −0.500 | 0.045 | 0 | 0 | 7 |
| CSF3_E242_R | 0.651 | −0.057 | 0 | 0 | 8 |
| CTNNA1_P382_R | −0.844 | 0.053 | 0 | 0 | 9 |
| EPHB4_E476_R | −1.711 | 0.350 | 0 | 0 | 10 |
| EPS8_E231_F | −1.117 | 0.190 | 0 | 0 | 11 |
| EPS8_P437_F | −0.941 | 0.127 | 0 | 0 | 12 |
| FANCG_E207_R | −1.110 | 0.074 | 0 | 0 | 13 |
| FER_E119_F | −1.776 | 0.310 | 0 | 0 | 14 |
| GAS1_E22_F | −0.841 | 0.027 | 0 | 0 | 15 |
| HIC1_P565_R | −1.004 | 0.050 | 0 | 0 | 16 |
| HPSE_P29_F | −1.451 | 0.115 | 0 | 0 | 17 |
| ID1_P880_F | −1.106 | 0.147 | 0 | 0 | 18 |
| IL18BP_E285_F | 0.750 | −0.112 | 0 | 0 | 19 |
| IL8_P83_F | −1.515 | 0.342 | 0 | 0 | 20 |
| ITGA2_P26_R | −0.968 | 0.067 | 0 | 0 | 21 |
| JAG1_P66_F | −1.169 | 0.115 | 0 | 0 | 22 |
| LAMB1_E144_R | −1.371 | 0.174 | 0 | 0 | 23 |
| MCM2_P241_R | −0.889 | 0.048 | 0 | 0 | 24 |
| MCM2_P260_F | −1.369 | 0.226 | 0 | 0 | 25 |
| MLH3_P25_F | −1.617 | 0.156 | 0 | 0 | 26 |
| MUC1_P191_F | −1.395 | 0.222 | 0 | 0 | 27 |
| PCDH1_E22_F | −0.857 | 0.037 | 0 | 0 | 28 |
| PCGF4_P760_R | −1.507 | 0.181 | 0 | 0 | 29 |
| PDE1B_E141_F | −0.833 | 0.084 | 0 | 0 | 30 |
| PDGFA_P841_R | −0.788 | 0.024 | 0 | 0 | 31 |
| PRKCDBP_E206_F | −0.746 | 0.032 | 0 | 0 | 32 |
| PRKCDBP_P352_R | −1.141 | 0.130 | 0 | 0 | 33 |
| RARB_P60_F | −1.635 | 0.246 | 0 | 0 | 34 |
| RARRES1_P57_R | −1.708 | 0.391 | 0 | 0 | 35 |
| RIPK2_E123_F | −0.618 | 0.041 | 0 | 0 | 36 |
| SFN_P248_F | −0.965 | 0.127 | 0 | 0 | 37 |
| SHB_P473_R | −1.239 | 0.037 | 0 | 0 | 38 |
| SKI_E465_R | −0.818 | 0.034 | 0 | 0 | 39 |
| SMARCA3_P109_R | −1.134 | 0.053 | 0 | 0 | 40 |
| SPARC_E50_R | −0.844 | 0.103 | 0 | 0 | 41 |
| SRC_E100_R | 1.325 | −0.200 | 0 | 0 | 42 |
| TGFA_P558_F | −1.046 | 0.043 | 0 | 0 | 43 |
| TGFB2_P632_F | −0.662 | 0.029 | 0 | 0 | 44 |
| TGFBR3_E188_R | −0.855 | 0.031 | 0 | 0 | 45 |
| TJP2_P330_R | −1.404 | 0.066 | 0 | 0 | 46 |
| TJP2_P518_F | −1.815 | 0.266 | 0 | 0 | 47 |
| TNFRSF10B_E198_R | −1.145 | 0.082 | 0 | 0 | 48 |
| TRAF4_P372_F | −1.493 | 0.280 | 0 | 0 | 49 |
| TRIP6_E33_F | −0.739 | 0.076 | 0 | 0 | 50 |
| TUBB3_P721_R | −1.293 | 0.127 | 0 | 0 | 51 |
| WNT5A_E43_F | −0.951 | 0.063 | 0 | 0 | 52 |
| YES1_P600_F | −0.654 | 0.022 | 0 | 0 | 53 |
| ACVR2B_E27_R | −0.838 | 0.030 | 0 | 0 | 54 |
| BCL3_E71_F | −1.197 | 0.249 | 0 | 0 | 55 |
| CASP8_E474_F | −1.355 | 0.317 | 0 | 0 | 56 |
| CPA4_P961_R | 1.071 | −0.122 | 0 | 0 | 57 |
| FES_E34_R | −1.187 | 0.109 | 0 | 0 | 58 |
| GATA6_P21_R | −1.435 | 0.127 | 0 | 0 | 59 |
| ISL1_E87_R | −1.869 | 0.363 | 0 | 0 | 60 |
| ITGB4_E144_F | −0.928 | 0.048 | 0 | 0 | 61 |
| PPARD_P846_F | −1.245 | 0.141 | 0 | 0 | 62 |
| PTCH_E42_F | −0.776 | 0.026 | 0 | 0 | 63 |
| TJP1_P326_R | −0.843 | 0.054 | 0 | 0 | 64 |
| WNT2B_P1185_R | −1.081 | 0.090 | 0 | 0 | 65 |
| APP_P179_R | −1.224 | 0.086 | 0 | 0 | 66 |
| ITGB1_P451_F | −1.349 | 0.172 | 0 | 0 | 67 |
| PDGFRB_P273_F | −1.205 | 0.276 | 0 | 0 | 68 |
| IGSF4C_E65_F | −1.467 | 0.351 | 0 | 0 | 69 |
| TIMP2_P267_F | −1.413 | 0.187 | 0 | 0 | 70 |
| CDK10_E74_F | −1.227 | 0.072 | 0 | 0 | 71 |
| INHA_P1189_F | −1.077 | 0.090 | 0 | 0 | 72 |
| PHLDA2_E159_R | −0.847 | 0.065 | 0 | 0 | 73 |
| PLAU_P11_F | −1.121 | 0.111 | 0 | 0 | 74 |
| DHCR24_P406_R | −1.210 | 0.053 | 0 | 0 | 75 |
| ITGA6_P298_R | −1.967 | 0.334 | 0 | 0 | 76 |
| PDGFB_E25_R | −0.823 | 0.161 | 0 | 0 | 77 |
| ERCC1_P354_F | −0.506 | 0.014 | 0 | 0 | 78 |
| RAD54B_P227_F | −1.208 | 0.146 | 0 | 0 | 79 |
| CD9_E14_R | −0.797 | 0.041 | 0 | 0 | 80 |
| GNMT_E126_F | −0.835 | 0.041 | 0 | 0 | 81 |
| HPSE_P93_F | −1.612 | 0.171 | 0 | 0 | 82 |
| CAV1_P130_R | −1.096 | 0.109 | 0 | 0 | 83 |
| INHA_P1144_R | −1.074 | 0.084 | 0 | 0 | 84 |
| EPHB2_P165_R | −1.310 | 0.115 | 0 | 0 | 85 |
| CCR5_P630_R | −0.998 | 0.245 | 0 | 0 | 86 |
| GSTP1_seq_38_S153_R | −0.811 | 0.032 | 0 | 0 | 87 |
| DSP_P36_F | −1.674 | 0.246 | 0 | 0 | 88 |
| LIG4_P194_F | −0.733 | 0.028 | 0 | 0 | 89 |
| MYCN_E77_R | −0.797 | 0.047 | 0 | 0 | 90 |
| CDK6_P291_R | −1.029 | 0.052 | 0 | 0 | 91 |
| HOXB13_E21_F | −1.727 | 0.330 | 0 | 0 | 92 |
| IGF2R_P396_R | −0.913 | 0.083 | 0 | 0 | 93 |
| ENC1_P484_R | −0.738 | 0.043 | 0 | 0 | 94 |
| ACVR1C_P115_R | −1.300 | 0.109 | 0 | 0 | 95 |
| SMO_E57_F | −0.987 | 0.046 | 0 | 0 | 96 |
| ZMYND10_P329_F | −1.304 | 0.245 | 0 | 0 | 97 |
| EIF2AK2_E103_R | −0.949 | 0.067 | 0 | 0 | 98 |
| TGFBI_P31_R | −0.651 | 0.064 | 0 | 0 | 99 |
| CYP1B1_P212_F | −1.247 | 0.240 | 0 | 0 | 100 |
| PDGFRB_E195_R | −0.744 | 0.072 | 0 | 0 | 101 |
| P2RX7_E323_R | −1.107 | 0.137 | 0 | 0 | 102 |
| FGFR2_P460_R | −1.360 | 0.303 | 0 | 0 | 103 |
| TSG101_P257_R | −1.051 | 0.195 | 0 | 0 | 104 |
| CD34_E20_R | −0.820 | 0.147 | 0 | 0 | 105 |
| MCC_E23_R | −0.764 | 0.053 | 0 | 0 | 106 |
| PTEN_P438_F | −0.540 | 0.015 | 0 | 0 | 107 |
| NTRK3_P636_R | −0.893 | 0.054 | 0 | 0 | 108 |
| FHIT_P93_R | −0.937 | 0.042 | 0 | 0 | 109 |
| GAS1_P754_R | −0.789 | 0.025 | 0 | 0 | 110 |
| EPHB1_E202_R | −1.128 | 0.203 | 0 | 0 | 111 |
| IL1B_P829_F | 1.117 | −0.270 | 0 | 0 | 112 |
| TIAM1_P117_F | −0.935 | 0.046 | 0 | 0 | 113 |
| IGF1R_P325_R | −0.544 | 0.019 | 0 | 0 | 114 |
| TMEFF1_E180_R | −0.574 | 0.019 | 0 | 0 | 115 |
| DAB2IP_E18_R | −1.065 | 0.116 | 0 | 0 | 116 |
| APC_E117_R | −0.813 | 0.153 | 0 | 0 | 117 |
| EXT1_E197_F | −0.923 | 0.109 | 0 | 0 | 118 |
| CTGF_E156_F | −0.740 | 0.037 | 0 | 0 | 119 |
| RARRES1_E235_F | −1.146 | 0.060 | 0 | 0 | 120 |
| CCND1_E280_R | −0.978 | 0.062 | 0 | 0 | 121 |
| PTPN6_E171_R | −1.790 | 0.378 | 0 | 0 | 122 |
| MUSK_P308_F | 0.686 | −0.074 | 0 | 0 | 123 |
| GRB10_E85_R | −0.818 | 0.059 | 0 | 0 | 124 |
| ABL2_P459_R | −1.312 | 0.213 | 0 | 0 | 125 |
| ROR2_E112_F | −0.866 | 0.062 | 0 | 0 | 126 |
| DDIT3_P1313_R | 1.353 | −0.299 | 0 | 0 | 127 |
| IRF5_P123_F | −0.527 | 0.046 | 0 | 0 | 128 |
| EPHB6_E342_F | −1.156 | 0.092 | 0 | 0 | 129 |
| FLT4_E206_F | −1.043 | 0.110 | 0 | 0 | 130 |
| DST_P262_R | −0.859 | 0.046 | 0 | 0 | 131 |
| FASTK_P257_F | −1.062 | 0.126 | 0 | 0 | 132 |
| PSIP1_P163_R | −1.210 | 0.074 | 0 | 0 | 133 |
| IGFBP5_E144_F | −0.912 | 0.064 | 0 | 0 | 134 |
| CASP6_P230_R | −0.988 | 0.045 | 0 | 0 | 135 |
| SLC22A2_P109_F | 0.676 | −0.091 | 0 | 0 | 136 |
| SEMA3B_P110_R | −0.783 | 0.091 | 0 | 0 | 137 |
| PKD2_P287_R | −0.721 | 0.043 | 0 | 0 | 138 |
| TESK2_P252_R | −0.455 | 0.014 | 0 | 0 | 139 |
| ASB4_E89_F | 0.574 | −0.038 | 0 | 0 | 140 |
| ADAMTS12_P250_R | −0.795 | 0.027 | 0 | 0 | 141 |
| ITGB4_P517_F | −0.852 | 0.137 | 0 | 0 | 142 |
| GADD45A_P737_R | −0.988 | 0.211 | 0 | 0 | 143 |
| CDH3_E100_R | −1.299 | 0.200 | 0 | 0 | 144 |
| ROR2_P317_R | −1.012 | 0.061 | 0 | 0 | 145 |
| CASP6_P201_F | −0.991 | 0.065 | 0 | 0 | 146 |
| COL6A1_P425_F | −1.181 | 0.178 | 0 | 0 | 147 |
| PSCA_P135_F | 0.674 | −0.105 | 0 | 0 | 148 |
| S100A4_P887_R | 0.643 | −0.059 | 0 | 0 | 149 |
| THBS1_P500_F | −0.956 | 0.067 | 0 | 0 | 150 |
| FGFR1_E317_F | −0.629 | 0.062 | 0 | 0 | 151 |
| NOTCH2_P312_R | −0.417 | 0.009 | 0 | 0 | 152 |
| XRCC2_P1077_F | 0.602 | −0.020 | 0 | 0 | 153 |
| BMP4_P123_R | −1.150 | 0.140 | 0 | 0 | 154 |
| COPG2_P298_F | 0.969 | −0.049 | 0 | 0 | 155 |
| SLIT2_E111_R | −1.417 | 0.286 | 0 | 0 | 156 |
| MCM6_E136_F | −0.876 | 0.053 | 0 | 0 | 157 |
| ITGA2_E120_F | −0.969 | 0.045 | 0 | 0 | 158 |
| EPHB3_E0_F | −1.189 | 0.082 | 0 | 0 | 159 |
| VEGFB_P658_F | −0.814 | 0.033 | 0 | 0 | 160 |
| FGFR2_P266_R | −0.842 | 0.046 | 0 | 0 | 161 |
| CPA4_E20_F | −0.934 | 0.224 | 0 | 0 | 162 |
| GNMT_P197_F | −0.820 | 0.137 | 0 | 0 | 163 |
| RASA1_E107_F | −0.872 | 0.028 | 0 | 0 | 164 |
| FYN_P352_R | −0.809 | 0.049 | 0 | 0 | 165 |
| PTGS1_P2_F | −0.930 | 0.050 | 0 | 0 | 166 |
| CDKN1A_E101_F | −0.763 | 0.039 | 0 | 0 | 167 |
| TGFA_P642_R | −0.689 | 0.036 | 0 | 0 | 168 |
| THPO_P585_R | 0.696 | −0.054 | 0 | 0 | 169 |
| PTPNS1_E433_R | −0.575 | 0.011 | 0 | 0 | 170 |
| FHIT_E19_R | −0.637 | 0.020 | 0 | 0 | 171 |
| PLAUR_E123_F | −0.437 | 0.034 | 0 | 0 | 172 |
| ST6GAL1_P164_R | −1.326 | 0.176 | 0 | 0 | 173 |
| SPARC_P195_F | −0.866 | 0.133 | 0 | 0 | 174 |
| PTK7_E317_F | −1.401 | 0.332 | 0 | 0 | 175 |
| MLH3_E72_F | 0.724 | −0.039 | 0 | 0 | 176 |
| BCAM_P205_F | −1.234 | 0.233 | 0 | 0 | 177 |
| EFNB3_P442_R | −0.731 | 0.086 | 0 | 0 | 178 |
| BCL3_P1038_R | −0.345 | 0.012 | 0 | 0 | 179 |
| SEMA3B_E96_F | −0.647 | 0.078 | 0 | 0 | 180 |
| PDGFA_P78_F | −0.503 | 0.084 | 0 | 0 | 181 |
| FLI20712_P984_R | 0.650 | −0.123 | 0 | 0 | 182 |
| SRC_P164_F | 0.450 | −0.031 | 0 | 0 | 183 |
| HTR1B_P107_F | −1.286 | 0.261 | 0 | 0 | 184 |
| ABCG2_P178_R | −0.782 | 0.066 | 0 | 0 | 185 |
| TNFRSF10C_P7_F | 1.610 | −0.379 | 0 | 0 | 186 |
| FVT1_P225_F | −0.778 | 0.054 | 0 | 0 | 187 |
| KLF5_E190_R | −1.055 | 0.070 | 0 | 0 | 188 |
| HBEGF_P32_R | −1.122 | 0.060 | 0 | 0 | 189 |
| TNC_P57_F | −0.772 | 0.054 | 0 | 0 | 190 |
| MT1A_P600_F | 1.071 | −0.214 | 0 | 0 | 191 |
| CDH1_P45_F | −0.967 | 0.140 | 0 | 0 | 192 |
| MAF_E77_R | −0.943 | 0.083 | 0 | 0 | 193 |
| GPX1_E46_R | −0.485 | 0.014 | 0 | 0 | 194 |
| PYCARD_P150_F | 0.783 | −0.193 | 0 | 0 | 195 |
| MLH1_P381_F | −0.705 | 0.020 | 0 | 0 | 196 |
| CSF3_P309_R | 0.897 | −0.197 | 0 | 0 | 197 |
| STK11_P295_R | −0.946 | 0.197 | 0 | 0 | 198 |
| FANCF_P13_F | −0.662 | 0.025 | 0 | 0 | 199 |
| IGFBP6_P328_R | −0.829 | 0.088 | 0 | 0 | 200 |
| IFNGR2_E164_F | −0.687 | 0.066 | 0 | 0 | 201 |
| PLXDC1_E71_F | −0.737 | 0.068 | 0 | 0 | 202 |
| PTCH2_P568_R | −1.098 | 0.223 | 0 | 0 | 203 |
| IL16_P93_R | −1.185 | 0.284 | 0 | 0 | 204 |
| WNT2B_P1195_F | −0.745 | 0.026 | 0 | 0 | 205 |
| E2F5_P516_R | −0.914 | 0.225 | 0 | 0 | 206 |
| HDAC5_E298_F | −0.703 | 0.154 | 0 | 0 | 207 |
| YES1_P216_F | −1.015 | 0.043 | 0 | 0 | 208 |
| LAMC1_P808_F | −0.590 | 0.042 | 0 | 0 | 209 |
| TRPM5_P979_F | 0.832 | −0.092 | 0 | 0 | 210 |
| ERCC6_P698_R | −1.512 | 0.361 | 0 | 0 | 211 |
| NGFB_E353_F | −1.444 | 0.181 | 0 | 0 | 212 |
| TGFBI_P173_F | −0.726 | 0.124 | 0 | 0 | 213 |
| DAPK1_E46_R | −0.591 | 0.096 | 0 | 0 | 214 |
| WNT5A_P655_F | −0.668 | 0.025 | 0 | 0 | 215 |
| TP73_P496_F | −0.827 | 0.043 | 0 | 0 | 216 |
| DIO3_P90_F | −1.264 | 0.288 | 0 | 0 | 217 |
| CDH3_P87_R | 0.736 | −0.043 | 0 | 0 | 218 |
| WRN_E57_F | −0.685 | 0.072 | 0 | 0 | 219 |
| INSR_E97_F | −0.758 | 0.094 | 0 | 0 | 220 |
| SFTPB_P689_R | 0.530 | −0.075 | 0 | 0 | 221 |
| CDK2_P330_R | −0.556 | 0.029 | 0 | 0 | 222 |
| LIF_P383_R | −0.842 | 0.185 | 0 | 0 | 223 |
| GPR116_P850_F | 0.477 | −0.030 | 0 | 0 | 224 |
| CD34_P339_R | 0.688 | −0.127 | 0 | 0 | 225 |
| CDKN1C_P6_R | −0.942 | 0.107 | 0 | 0 | 226 |
| MLF1_P97_F | −1.743 | 0.278 | 0 | 0 | 227 |
| HLA-DOA_P191_R | −1.352 | 0.319 | 0 | 0 | 228 |
| BAX_E281_R | −0.845 | 0.188 | 0 | 0 | 229 |
| MALT1_P406_R | −0.927 | 0.061 | 0 | 0 | 230 |
| RUNX1T1_P103_F | −1.237 | 0.237 | 0 | 0 | 231 |
| DST_E31_F | −0.480 | 0.029 | 0 | 0 | 232 |
| LAMC1_E466_R | −0.711 | 0.019 | 0 | 0 | 233 |
| KLF5_P13_F | −0.761 | 0.050 | 0 | 0 | 234 |
| PLAT_P80_F | −0.882 | 0.100 | 0 | 0 | 235 |
| EPO_P162_R | −1.169 | 0.243 | 0 | 0 | 236 |
| SMAD4_P474_R | −0.588 | 0.013 | 0 | 0 | 237 |
| ALK_E183_R | −0.847 | 0.073 | 0 | 0 | 238 |
| ETS1_E253_R | −0.604 | 0.107 | 0 | 0 | 239 |
| PLAGL1_P334_F | 0.855 | −0.130 | 0 | 0 | 240 |
| DDR1_E23_R | −0.776 | 0.072 | 0 | 0 | 241 |
| IGFBP3_E65_R | 0.882 | −0.070 | 0 | 0 | 242 |
| LMTK2_P1034_F | 0.448 | −0.102 | 0 | 0 | 243 |
| OAT_P465_F | −1.197 | 0.209 | 0 | 0 | 244 |
| CAV1_P169_F | −0.651 | 0.100 | 0 | 0 | 245 |
| APC_P14_F | −0.789 | 0.114 | 0 | 0 | 246 |
| TSG101_P139_R | −0.528 | 0.032 | 0 | 0 | 247 |
| IL8_E118_R | −0.819 | 0.121 | 0 | 0 | 248 |
| TCF7L2_P193_R | −0.792 | 0.029 | 0 | 0 | 249 |
| CTSH_E157_R | 0.642 | −0.047 | 0 | 0 | 250 |
| SMARCA3_P17_R | −0.891 | 0.071 | 0 | 0 | 251 |
| COL1A1_P117_R | −0.826 | 0.146 | 0 | 0 | 252 |
| BMP3_P56_R | −0.484 | 0.015 | 0 | 0 | 253 |
| TRIP6_P1090_F | −1.136 | 0.276 | 0 | 0 | 254 |
| MGMT_P272_R | −1.098 | 0.091 | 0 | 0 | 255 |
| GAS7_E148_F | −0.845 | 0.050 | 0 | 0 | 256 |
| PKD2_P336_R | −0.655 | 0.052 | 0 | 0 | 257 |
| MMP14_P208_R | −0.944 | 0.182 | 0 | 0 | 258 |
| ICAM1_P119_R | −1.114 | 0.073 | 0 | 0 | 259 |
| COL18A1_P494_R | −1.314 | 0.234 | 0 | 0 | 260 |
| MCC_P196_R | 0.601 | −0.017 | 0 | 0 | 261 |
| PCGF4_P92_R | −0.788 | 0.058 | 0 | 0 | 262 |
| JAG2_E54_F | −0.528 | 0.016 | 0 | 0 | 263 |
| LRP2_E20_F | −0.394 | 0.017 | 0 | 0 | 264 |
| NFKB2_P709_R | −0.606 | 0.035 | 0 | 0 | 265 |
| IL18BP_P51_R | 0.854 | −0.197 | 0 | 0 | 266 |
| EPHB2_E297_F | −0.800 | 0.029 | 0 | 0 | 267 |
| ABCA1_P45_F | −0.675 | 0.026 | 0 | 0 | 268 |
| THY1_P20_R | −1.088 | 0.212 | 0 | 0 | 269 |
| HIC-1_seq_48_S103_R | 0.656 | −0.072 | 0 | 0 | 270 |
| CTTN_E29_R | −0.817 | 0.064 | 0 | 0 | 271 |
| FGFR1_P204_F | −0.650 | 0.054 | 0 | 0 | 272 |
| MLF1_E243_F | −1.077 | 0.230 | 0 | 0 | 273 |
| JAG2_P264_F | −0.539 | 0.023 | 0 | 0 | 274 |
| PTPN6_P282_R | −1.576 | 0.298 | 0 | 0 | 275 |
| CDC25B_E83_F | −1.303 | 0.086 | 0 | 0 | 276 |
| CEACAM1_P44_R | 0.930 | −0.211 | 0 | 0 | 277 |
| SEMA3F_P692_R | −0.664 | 0.029 | 0 | 0 | 278 |
| TIMP2_E394_R | −0.406 | 0.013 | 0 | 0 | 279 |
| DUSP4_P925_R | −0.687 | 0.023 | 0 | 0 | 280 |
| NEO1_P1067_F | −0.784 | 0.080 | 0 | 0 | 281 |
| SMARCB1_P220_R | −0.671 | 0.138 | 0 | 0 | 282 |
| NOTCH3_P198_R | −1.192 | 0.275 | 0 | 0 | 283 |
| IFNGR1_P307_F | 0.546 | −0.033 | 0 | 0 | 284 |
| E2F3_P840_R | −0.431 | 0.026 | 0 | 0 | 285 |
| CASP10_P186_F | −0.895 | 0.072 | 0 | 0 | 286 |
| MCAM_P169_R | −0.564 | 0.033 | 0 | 0 | 287 |
| DAB2IP_P9_F | −0.404 | 0.017 | 0 | 0 | 288 |
| P2RX7_P597_F | 0.704 | −0.038 | 0 | 0 | 289 |
| ABO_E110_F | −0.983 | 0.092 | 0 | 0 | 290 |
| NBL1_P24_F | −0.911 | 0.223 | 0 | 0 | 291 |
| DLL1_P386_F | −0.705 | 0.031 | 0 | 0 | 292 |
| DAPK1_P10_F | −0.689 | 0.049 | 0 | 0 | 293 |
| EPHB4_P313_R | −0.565 | 0.044 | 0 | 0 | 294 |
| CLDN4_P1120_R | 0.506 | −0.064 | 0 | 0 | 295 |
| EPHA5_E158_R | −0.828 | 0.039 | 0 | 0 | 296 |
| ITGA6_P718_R | 0.437 | −0.020 | 0 | 0 | 297 |
| DHCR24_P652_R | −0.644 | 0.154 | 0 | 0 | 298 |
| MTA1_P478_F | −0.842 | 0.078 | 0 | 0 | 299 |
| DDB2_P407_F | −0.780 | 0.107 | 0 | 0 | 300 |
| SMARCA4_P362_R | −0.427 | 0.014 | 0 | 0 | 301 |
| SNURF_P78_F | −0.921 | 0.151 | 0 | 0 | 302 |
| IRF7_E236_R | −0.854 | 0.137 | 0 | 0 | 303 |
| NKX3-1_P146_F | −0.454 | 0.024 | 0 | 0 | 304 |
| ABO_P312_F | −0.757 | 0.066 | 0 | 0 | 305 |
| p16_seq_47_S85_F | −0.841 | 0.198 | 0 | 0 | 306 |
| KRT13_P341_R | 0.405 | −0.038 | 0 | 0 | 307 |
| TYK2_P494_F | −0.615 | 0.082 | 0 | 0 | 308 |
| PTPRG_P476_F | −0.446 | 0.012 | 0 | 0 | 309 |
| VAMP8_E7_F | −0.810 | 0.200 | 0 | 0 | 310 |
| FOSL2_E384_R | −1.035 | 0.056 | 0 | 0 | 311 |
| LYN_E353_F | −0.570 | 0.079 | 0 | 0 | 312 |
| VIM_P343_R | −0.657 | 0.022 | 0 | 0 | 313 |
| HLA-DOB_E432_R | −0.669 | 0.083 | 0 | 0 | 314 |
| BMP4_P199_R | −0.822 | 0.193 | 0 | 0 | 315 |
| CTSH_P238_F | −0.577 | 0.032 | 0 | 0 | 316 |
| FGF9_P862_R | −0.528 | 0.107 | 0 | 0 | 317 |
| NEU1_P745_F | −0.479 | 0.029 | 0 | 0 | 318 |
| BMPR2_P1271_F | −0.549 | 0.033 | 0 | 0 | 319 |
| TIMP3_seq_7_S38_F | −0.824 | 0.052 | 0 | 0 | 320 |
| CRIP1_P274_F | −0.526 | 0.129 | 0 | 0 | 321 |
| GRB10_P496_R | 1.040 | −0.251 | 0 | 0 | 322 |
| NRAS_P103_R | −0.532 | 0.020 | 0 | 0 | 323 |
| IL6_E168_F | −0.845 | 0.141 | 0 | 0 | 324 |
| TFPI2_P9_F | −0.523 | 0.023 | 0 | 0 | 325 |
| SLC22A3_P634_F | 0.597 | −0.122 | 0 | 0 | 326 |
| SMAD2_P708_R | −0.335 | 0.011 | 0 | 0 | 327 |
| PTHLH_P757_F | 0.424 | −0.049 | 0 | 0 | 328 |
| CAPG_E228_F | −0.828 | 0.163 | 0 | 0 | 329 |
| BMPR2_E435_F | 0.703 | −0.028 | 0 | 0 | 330 |
| CSTB_E410_F | −1.071 | 0.061 | 0 | 0 | 331 |
| ASB4_P52_R | 0.759 | −0.056 | 0 | 0 | 332 |
| ABCA1_E120_R | −0.439 | 0.012 | 0 | 0 | 333 |
| HHIP_E94_F | −0.757 | 0.083 | 0 | 0 | 334 |
| CSK_P740_R | −0.855 | 0.120 | 0 | 0 | 335 |
| PTK2B_P673_R | −0.373 | 0.015 | 0 | 0 | 336 |
| JAK2_P772_R | −0.963 | 0.065 | 0 | 0 | 337 |
| MAP3K9_E17_R | −0.844 | 0.054 | 1.00E−06 | 1.00E−06 | 338 |
| TNFRSF10B_P108_R | −0.702 | 0.073 | 1.00E−06 | 1.00E−06 | 339 |
| WT1_P853_F | −0.747 | 0.050 | 1.00E−06 | 1.00E−06 | 340 |
| PTPRF_E178_R | −0.541 | 0.064 | 1.00E−06 | 1.00E−06 | 341 |
| S100A12_P1221_R | 0.380 | −0.049 | 1.00E−06 | 1.00E−06 | 342 |
| CHI3L2_E10_F | −0.819 | 0.180 | 1.00E−06 | 1.00E−06 | 343 |
| FGF12_E61_R | −0.606 | 0.074 | 1.00E−06 | 1.00E−06 | 344 |
| DMP1_E194_F | 0.385 | −0.028 | 1.00E−06 | 1.00E−06 | 345 |
| DMP1_P134_F | 0.391 | −0.042 | 1.00E−06 | 1.00E−06 | 346 |
| TRIM29_P261_F | −1.593 | 0.266 | 1.00E−06 | 1.00E−06 | 347 |
| TNFRSF10C_E109_F | 1.504 | −0.316 | 1.00E−06 | 1.00E−06 | 348 |
| COMT_E401_F | −1.157 | 0.220 | 1.00E−06 | 1.00E−06 | 349 |
| EPHA7_P205_R | −0.652 | 0.045 | 1.00E−06 | 1.00E−06 | 350 |
| CCND1_P343_R | −0.730 | 0.060 | 1.00E−06 | 1.00E−06 | 351 |
| PGR_P790_F | 0.668 | −0.132 | 1.00E−06 | 1.00E−06 | 352 |
| TUBB3_P364_F | −0.413 | 0.008 | 1.00E−06 | 1.00E−06 | 353 |
| TAL1_P594_F | 1.400 | −0.330 | 1.00E−06 | 1.00E−06 | 354 |
| HDAC11_P556_F | −0.304 | 0.010 | 1.00E−06 | 1.00E−06 | 355 |
| GABRA5_P1016_F | −1.469 | 0.175 | 1.00E−06 | 1.00E−06 | 356 |
| DAPK1_P345_R | −0.650 | 0.034 | 1.00E−06 | 1.00E−06 | 357 |
| PPP2R1B_P268_R | −0.444 | 0.017 | 1.00E−06 | 1.00E−06 | 358 |
| FAT_P279_R | −0.670 | 0.089 | 1.00E−06 | 1.00E−06 | 359 |
| PCDH1_P264_F | −0.785 | 0.102 | 1.00E−06 | 1.00E−06 | 360 |
| CHFR_P501_F | −0.967 | 0.126 | 1.00E−06 | 1.00E−06 | 361 |
| CSPG2_E38_F | −1.102 | 0.168 | 2.00E−06 | 2.00E−06 | 362 |
| AHR_P166_R | −0.981 | 0.054 | 2.00E−06 | 2.00E−06 | 363 |
| SFTPC_E13_F | 0.654 | −0.111 | 2.00E−06 | 2.00E−06 | 364 |
| IL1RN_E42_F | −1.039 | 0.192 | 2.00E−06 | 2.00E−06 | 365 |
| FGF9_P1404_F | −0.324 | 0.051 | 2.00E−06 | 2.00E−06 | 366 |
| JAK3_P156_R | 1.185 | −0.287 | 2.00E−06 | 2.00E−06 | 367 |
| NGFB_P13_F | −0.668 | 0.108 | 2.00E−06 | 2.00E−06 | 368 |
| BMP3_E147_F | −0.911 | 0.115 | 2.00E−06 | 2.00E−06 | 369 |
| ITK_P114_F | −1.187 | 0.163 | 3.00E−06 | 3.00E−06 | 370 |
| MAS1_P469_R | 0.344 | −0.020 | 3.00E−06 | 3.00E−06 | 371 |
| ACVR2B_P676_F | −0.594 | 0.056 | 3.00E−06 | 3.00E−06 | 372 |
| SEMA3F_E333_R | −0.514 | 0.060 | 3.00E−06 | 3.00E−06 | 373 |
| RARB_E114_F | −0.487 | 0.030 | 3.00E−06 | 3.00E−06 | 374 |
| SNRPN_seq_12_S127_F | −0.661 | 0.147 | 3.00E−06 | 3.00E−06 | 375 |
| EFNA1_P7_F | −0.334 | 0.008 | 3.00E−06 | 4.00E−06 | 376 |
| PTHLH_E251_F | 0.634 | −0.137 | 4.00E−06 | 4.00E−06 | 377 |
| CRIP1_P874_R | −0.644 | 0.081 | 4.00E−06 | 4.00E−06 | 378 |
| C4B_P191_F | −1.041 | 0.107 | 4.00E−06 | 4.00E−06 | 379 |
| SHH_P104_R | −0.737 | 0.049 | 4.00E−06 | 4.00E−06 | 380 |
| EDN1_E50_R | 1.448 | −0.081 | 4.00E−06 | 4.00E−06 | 381 |
| SFTPD_E169_F | 0.421 | −0.046 | 4.00E−06 | 4.00E−06 | 382 |
| ZMYND10_E77_R | −0.604 | 0.061 | 5.00E−06 | 5.00E−06 | 383 |
| DDR2_P743_R | −1.032 | 0.210 | 5.00E−06 | 5.00E−06 | 384 |
| SEPT9_P374_F | 1.211 | −0.293 | 5.00E−06 | 5.00E−06 | 385 |
| EGR4_E70_F | −0.680 | 0.154 | 5.00E−06 | 5.00E−06 | 386 |
| ABL1_P53_F | −0.551 | 0.049 | 5.00E−06 | 5.00E−06 | 387 |
| GFAP_P1214_F | 0.425 | −0.035 | 5.00E−06 | 5.00E−06 | 388 |
| WEE1_P924_R | 0.608 | −0.039 | 5.00E−06 | 5.00E−06 | 389 |
| BIRC5_E89_F | −0.900 | 0.041 | 6.00E−06 | 6.00E−06 | 390 |
| BMPR1A_P956_F | −0.438 | 0.017 | 6.00E−06 | 6.00E−06 | 391 |
| PTPNS1_P301_R | −0.527 | 0.016 | 6.00E−06 | 6.00E−06 | 392 |
| EGFR_P260_R | −0.620 | 0.039 | 6.00E−06 | 6.00E−06 | 393 |
| CDK6_E256_F | −0.338 | 0.041 | 6.00E−06 | 6.00E−06 | 394 |
| PLXDC2_P914_R | −0.693 | 0.059 | 7.00E−06 | 7.00E−06 | 395 |
| ERG_E28_F | −1.060 | 0.198 | 7.00E−06 | 7.00E−06 | 396 |
| EPHA7_E6_F | −0.632 | 0.035 | 8.00E−06 | 8.00E−06 | 397 |
| DDR2_E331_F | −1.116 | 0.147 | 8.00E−06 | 8.00E−06 | 398 |
| LOX_P313_R | −0.660 | 0.076 | 8.00E−06 | 8.00E−06 | 399 |
| CASP3_P420_R | −0.455 | 0.024 | 8.00E−06 | 8.00E−06 | 400 |
| EPM2A_P113_F | −0.610 | 0.070 | 8.00E−06 | 8.00E−06 | 401 |
| BMP2_E48_R | −0.527 | 0.023 | 9.00E−06 | 8.00E−06 | 402 |
| EYA4_P794_F | 0.866 | −0.211 | 9.00E−06 | 9.00E−06 | 403 |
| TNK1_P221_F | −0.644 | 0.140 | 9.00E−06 | 9.00E−06 | 404 |
| HOXA9_E252_R | 1.328 | −0.313 | 1.00E−05 | 9.00E−06 | 405 |
| SERPINA5_P156_F | 0.706 | −0.174 | 1.00E−05 | 9.00E−06 | 406 |
| GLI3_P453_R | −0.648 | 0.091 | 1.00E−05 | 1.00E−05 | 407 |
| TRIM29_P135_F | −0.868 | 0.128 | 1.00E−05 | 1.00E−05 | 408 |
| AREG_E25_F | −0.347 | 0.014 | 1.00E−05 | 1.00E−05 | 409 |
| GPX3_E178_F | −0.556 | 0.074 | 1.10E−05 | 1.00E−05 | 410 |
| LEFTY2_P719_F | 0.416 | −0.048 | 1.10E−05 | 1.10E−05 | 411 |
| NTRK1_E74_F | 1.424 | −0.336 | 1.20E−05 | 1.10E−05 | 412 |
| BCR_P422_F | 0.607 | −0.141 | 1.30E−05 | 1.20E−05 | 413 |
| MUC1_E18_R | −0.685 | 0.163 | 1.30E−05 | 1.20E−05 | 414 |
| F2R_P88_F | −0.627 | 0.069 | 1.30E−05 | 1.20E−05 | 415 |
| CTNNA1_P185_R | −0.598 | 0.017 | 1.30E−05 | 1.20E−05 | 416 |
| GALR1_P80_F | −0.802 | 0.047 | 1.40E−05 | 1.30E−05 | 417 |
| RAD50_P191_F | −0.738 | 0.169 | 1.40E−05 | 1.30E−05 | 418 |
| ESR2_P162_F | −0.948 | 0.141 | 1.40E−05 | 1.40E−05 | 419 |
| MMP9_P237_R | −0.624 | 0.053 | 1.50E−05 | 1.40E−05 | 420 |
| MLLT3_E93_R | −0.313 | 0.008 | 1.60E−05 | 1.50E−05 | 421 |
| ETS1_P559_R | −0.246 | 0.007 | 1.80E−05 | 1.70E−05 | 422 |
| LOX_P71_F | −0.534 | 0.029 | 1.90E−05 | 1.80E−05 | 423 |
| ODC1_P424_F | −0.450 | 0.012 | 2.00E−05 | 1.80E−05 | 424 |
| PTCH2_E173_F | −0.844 | 0.195 | 2.00E−05 | 1.90E−05 | 425 |
| FLI1_E29_F | −0.833 | 0.096 | 2.10E−05 | 1.90E−05 | 426 |
| AHR_E103_F | −0.244 | 0.007 | 2.10E−05 | 1.90E−05 | 427 |
| CSF1_P217_F | 0.471 | −0.034 | 2.10E−05 | 1.90E−05 | 428 |
| FAS_P322_R | −0.506 | 0.038 | 2.10E−05 | 1.90E−05 | 429 |
| C4B_E171_F | −0.619 | 0.152 | 2.30E−05 | 2.10E−05 | 430 |
| DAB2_P35_F | −0.534 | 0.019 | 2.30E−05 | 2.10E−05 | 431 |
| PALM2-AKAP2_P183_R | −0.511 | 0.042 | 2.40E−05 | 2.20E−05 | 432 |
| S100A2_P1186_F | −0.918 | 0.179 | 2.60E−05 | 2.30E−05 | 433 |
| EFNB3_E17_R | −0.358 | 0.089 | 2.70E−05 | 2.40E−05 | 434 |
| RARRES1_P426_R | −0.677 | 0.165 | 2.70E−05 | 2.40E−05 | 435 |
| JUNB_P1149_R | −0.378 | 0.031 | 2.70E−05 | 2.50E−05 | 436 |
| FOLR1_E368_R | 0.311 | −0.018 | 2.80E−05 | 2.50E−05 | 437 |
| GLI2_P295_F | 0.631 | −0.082 | 2.90E−05 | 2.60E−05 | 438 |
| MYCN_P464_R | −0.519 | 0.016 | 2.90E−05 | 2.60E−05 | 439 |
| FGF5_E16_F | −0.648 | 0.048 | 3.00E−05 | 2.70E−05 | 440 |
| NAT2_P11_F | 0.506 | −0.085 | 3.10E−05 | 2.70E−05 | 441 |
| NDN_E131_R | 0.402 | −0.067 | 3.20E−05 | 2.80E−05 | 442 |
| TNFSF10_E53_F | 1.395 | −0.320 | 3.20E−05 | 2.90E−05 | 443 |
| HIC1_E151_F | −0.445 | 0.026 | 3.50E−05 | 3.10E−05 | 444 |
| APOC1_P406_R | −0.401 | 0.052 | 3.70E−05 | 3.20E−05 | 445 |
| PLAGL1_P236_R | 0.494 | −0.084 | 4.00E−05 | 3.50E−05 | 446 |
| APBA1_E99_R | 0.485 | −0.034 | 5.20E−05 | 4.50E−05 | 447 |
| HPN_P374_R | 0.506 | −0.122 | 5.20E−05 | 4.60E−05 | 448 |
| HS3ST2_E145_R | 1.233 | −0.268 | 5.20E−05 | 4.60E−05 | 449 |
| KRT13_P676_F | 0.368 | −0.047 | 5.30E−05 | 4.70E−05 | 450 |
| IGF2AS_E4_F | −0.663 | 0.129 | 5.40E−05 | 4.70E−05 | 451 |
| GABRG3_P75_F | −0.870 | 0.172 | 5.50E−05 | 4.80E−05 | 452 |
| PEG3_E496_F | 0.487 | −0.119 | 5.80E−05 | 5.10E−05 | 453 |
| TBX1_P520_F | −0.711 | 0.117 | 6.50E−05 | 5.70E−05 | 454 |
| RIPK3_P124_F | −0.837 | 0.195 | 6.70E−05 | 5.80E−05 | 455 |
| NQO1_E74_R | −0.287 | 0.012 | 6.80E−05 | 5.80E−05 | 456 |
| SNCG_P98_R | −0.585 | 0.142 | 6.80E−05 | 5.90E−05 | 457 |
| PROM1_P44_R | −0.896 | 0.101 | 6.90E−05 | 5.90E−05 | 458 |
| ICAM1_E242_F | −0.920 | 0.075 | 7.70E−05 | 6.60E−05 | 459 |
| PTGS1_E80_F | −0.894 | 0.099 | 7.90E−05 | 6.80E−05 | 460 |
| MYLK_E132_R | −0.946 | 0.191 | 8.10E−05 | 7.00E−05 | 461 |
| DLC1_P695_F | −0.876 | 0.157 | 9.00E−05 | 7.70E−05 | 462 |
| ALK_P28_F | −0.973 | 0.076 | 9.50E−05 | 8.10E−05 | 463 |
| ACVR1B_P572_R | −0.692 | 0.098 | 9.90E−05 | 8.40E−05 | 464 |
| COL4A3_P545_F | −0.536 | 0.023 | 0.000102 | 8.60E−05 | 465 |
| SH3BP2_E18_F | −0.565 | 0.100 | 0.000103 | 8.70E−05 | 466 |
| TRIM29_E189_F | −0.876 | 0.154 | 0.000109 | 9.20E−05 | 467 |
| IL12B_P1453_F | −0.497 | 0.086 | 0.000109 | 9.20E−05 | 468 |
| MXI1_P75_R | −0.763 | 0.061 | 0.000113 | 9.50E−05 | 469 |
| CHD2_P667_F | 0.323 | −0.028 | 0.000116 | 9.70E−05 | 470 |
| IL1B_P582_R | −0.932 | 0.140 | 0.000117 | 9.80E−05 | 471 |
| HBII-13_E48_F | −0.580 | 0.055 | 0.000118 | 9.80E−05 | 472 |
| RRAS_P100_R | −0.548 | 0.021 | 0.000132 | 0.00011 | 473 |
| CHFR_P635_R | −0.356 | 0.017 | 0.000136 | 0.000113 | 474 |
| EGFR_E295_R | −0.438 | 0.015 | 0.000136 | 0.000113 | 475 |
| IL12B_E25_F | −0.653 | 0.070 | 0.000139 | 0.000115 | 476 |
| GLI3_E148_R | 0.411 | −0.026 | 0.000146 | 0.000121 | 477 |
| RAB32_P493_R | 0.845 | −0.197 | 0.000155 | 0.000128 | 478 |
| TYRO3_P366_F | −0.443 | 0.048 | 0.000164 | 0.000135 | 479 |
| TMEFF1_P626_R | −0.582 | 0.136 | 0.000169 | 0.000139 | 480 |
| SLC22A3_P528_F | 0.565 | −0.132 | 0.00017 | 0.000139 | 481 |
| DNAJC15_P65_F | −0.461 | 0.036 | 0.000172 | 0.000141 | 482 |
| ABCC5_P444_F | −0.306 | 0.011 | 0.000174 | 0.000142 | 483 |
| EMR3_P1297_R | −1.007 | 0.127 | 0.000181 | 0.000148 | 484 |
| TNFRSF10C_P612_R | −0.453 | 0.024 | 0.000184 | 0.000149 | 485 |
| HOXA5_P1324_F | 0.858 | −0.188 | 0.00019 | 0.000154 | 486 |
| MGMT_P281_F | −0.599 | 0.028 | 0.000203 | 0.000164 | 487 |
| NRG1_E74_F | −0.452 | 0.031 | 0.000211 | 0.000171 | 488 |
| SLC22A18_P472_R | 0.411 | −0.041 | 0.000217 | 0.000175 | 489 |
| EFNA1_P591_R | −0.262 | 0.009 | 0.000218 | 0.000175 | 490 |
| SMO_P455_R | −0.527 | 0.033 | 0.000224 | 0.00018 | 491 |
| HRASLS_E72_R | −0.687 | 0.034 | 0.000228 | 0.000182 | 492 |
| TAL1_E122_F | 1.433 | −0.212 | 0.000228 | 0.000182 | 493 |
| PTHR1_P258_F | −0.541 | 0.125 | 0.000232 | 0.000185 | 494 |
| MMP7_E59_F | −0.519 | 0.112 | 0.00024 | 0.000191 | 495 |
| THBS2_P605_R | 0.864 | −0.213 | 0.000241 | 0.000191 | 496 |
| COL1A1_P5_F | −0.639 | 0.129 | 0.000254 | 0.000202 | 497 |
| DSG1_E292_F | −0.388 | 0.035 | 0.000266 | 0.00021 | 498 |
| TMPRSS4_E83_F | 0.490 | −0.027 | 0.000267 | 0.000211 | 499 |
| GSTP1_P74_F | −0.318 | 0.033 | 0.000295 | 0.000232 | 500 |
| TSP50_E21_R | 0.484 | −0.070 | 3.00E−04 | 0.000236 | 501 |
| ASB4_P391_F | 0.434 | −0.044 | 0.000307 | 0.000241 | 502 |
| TP73_E155_F | −0.700 | 0.036 | 0.000358 | 0.00028 | 503 |
| LMO2_P794_R | −1.057 | 0.183 | 0.000362 | 0.000283 | 504 |
| PLA2G2A_E268_F | −0.432 | 0.078 | 0.000368 | 0.000287 | 505 |
| FAS_P65_F | −0.334 | 0.020 | 0.000379 | 0.000295 | 506 |
| CD81_P211_F | 0.911 | −0.203 | 0.00039 | 0.000303 | 507 |
| DES_E228_R | 0.863 | −0.156 | 0.000398 | 0.000308 | 508 |
| GABRA5_P862_R | −0.978 | 0.122 | 0.000408 | 0.000316 | 509 |
| CPA4_P1265_R | −0.293 | 0.015 | 0.000416 | 0.000321 | 510 |
| NTSR1_E109_F | −0.829 | 0.058 | 0.000421 | 0.000325 | 511 |
| DSC2_E90_F | −0.588 | 0.121 | 0.000435 | 0.000335 | 512 |
| PTGS2_P308_F | −0.396 | 0.032 | 0.000446 | 0.000343 | 513 |
| PHLDA2_P622_F | −0.531 | 0.106 | 0.000457 | 0.00035 | 514 |
| CTLA4_P1128_F | −0.371 | 0.041 | 0.000475 | 0.000363 | 515 |
| CPNE1_P138_F | −0.967 | 0.071 | 0.000485 | 0.00037 | 516 |
| NCL_P1102_F | 0.459 | −0.026 | 0.00049 | 0.000374 | 517 |
| HOXA11_P698_F | 0.947 | −0.229 | 0.00051 | 0.000388 | 518 |
| CDH11_P354_R | −0.393 | 0.077 | 0.00052 | 0.000395 | 519 |
| MBD2_P233_F | −0.534 | 0.124 | 0.000522 | 0.000395 | 520 |
| IGFBP7_P297_F | −0.814 | 0.194 | 0.000535 | 0.000405 | 521 |
| TCF4_P175_R | −0.748 | 0.049 | 0.000538 | 0.000406 | 522 |
| PADI4_P1011_R | −0.429 | 0.103 | 0.000547 | 0.000412 | 523 |
| S100A2_E36_R | −0.587 | 0.134 | 0.000548 | 0.000412 | 524 |
| RIPK3_P24_F | −0.933 | 0.170 | 0.000561 | 0.000421 | 525 |
| CHI3L2_P226_F | −0.697 | 0.137 | 0.000566 | 0.000424 | 526 |
| GRB10_P260_F | −0.537 | 0.024 | 0.000569 | 0.000425 | 527 |
| HIF1A_P488_F | −0.456 | 0.029 | 0.000612 | 0.000456 | 528 |
| BLK_P668_R | −0.485 | 0.027 | 0.000663 | 0.000494 | 529 |
| AXL_P223_R | 0.734 | −0.150 | 0.000666 | 0.000494 | 530 |
| SMAD2_P848_R | −0.515 | 0.087 | 0.000666 | 0.000494 | 531 |
| FLI1_P620_R | −0.579 | 0.046 | 0.000682 | 0.000505 | 532 |
| MAS1_P657_R | 0.397 | −0.022 | 0.000721 | 0.000533 | 533 |
| RAF1_P330_F | −0.808 | 0.071 | 0.000726 | 0.000536 | 534 |
| EMR3_E61_F | −0.718 | 0.175 | 0.000759 | 0.000558 | 535 |
| IAPP_E280_F | −0.701 | 0.061 | 0.00076 | 0.000558 | 536 |
| MAPK4_E273_R | −0.534 | 0.093 | 0.000767 | 0.000563 | 537 |
| IHH_P246_R | −0.585 | 0.069 | 0.00078 | 0.000571 | 538 |
| RIPK4_P172_F | −0.591 | 0.057 | 0.000784 | 0.000573 | 539 |
| ERBB2_P59_R | 0.483 | −0.020 | 0.000795 | 0.00058 | 540 |
| EMR3_P39_R | −0.799 | 0.156 | 0.000805 | 0.000586 | 541 |
| EPM2A_P64_R | −0.175 | 0.006 | 0.00085 | 0.000617 | 542 |
| TUSC3_P85_R | −0.652 | 0.069 | 0.000852 | 0.000617 | 543 |
| CDKN2B_seq_50_S294_F | −0.531 | 0.045 | 0.000852 | 0.000617 | 544 |
| PPARG_E178_R | −0.411 | 0.019 | 0.000856 | 0.000619 | 545 |
| CD34_P780_R | 0.410 | −0.095 | 0.000869 | 0.000627 | 546 |
| TES_E172_F | −1.000 | 0.197 | 0.00087 | 0.000627 | 547 |
| CDKN1B_P1161_F | 1.524 | −0.210 | 0.000872 | 0.000627 | 548 |
| KDR_E79_F | −0.421 | 0.027 | 0.000889 | 0.000638 | 549 |
| SH3BP2_P771_R | −0.501 | 0.079 | 0.000918 | 0.000657 | 550 |
| MATK_P190_R | −0.753 | 0.186 | 0.000926 | 0.000662 | 551 |
| SEPT9_P58_R | 0.741 | −0.130 | 0.00095 | 0.000678 | 552 |
| HOXA9_P1141_R | 0.961 | −0.236 | 0.000959 | 0.000682 | 553 |
| MPO_P883_R | −0.693 | 0.146 | 0.000959 | 0.000682 | 554 |
| VAV2_E58_F | −0.324 | 0.015 | 0.000969 | 0.000688 | 555 |
| MAGEL2_E166_R | −0.450 | 0.043 | 0.001038 | 0.000735 | 556 |
| COL18A1_P365_R | −0.546 | 0.043 | 0.001047 | 0.000741 | 557 |
| IL1RN_P93_R | −0.581 | 0.139 | 0.001054 | 0.000744 | 558 |
| RAN_P581_R | −0.554 | 0.127 | 0.001094 | 0.000771 | 559 |
| TGFB2_E226_R | −0.408 | 0.062 | 0.001131 | 0.000795 | 560 |
| CDH11_E102_R | −0.300 | 0.018 | 0.001151 | 0.000808 | 561 |
| FRK_P258_F | −0.597 | 0.129 | 0.001167 | 0.000818 | 562 |
| DDB2_P613_R | −0.564 | 0.084 | 0.001183 | 0.000828 | 563 |
| PLAGL1_E68_R | −0.676 | 0.114 | 0.001272 | 0.000889 | 564 |
| HLA-F_E402_F | −0.206 | 0.004 | 0.001276 | 0.00089 | 565 |
| TNF_P1084_F | 0.247 | −0.010 | 0.001294 | 9.00E−04 | 566 |
| POMC_P400_R | 0.716 | −0.176 | 0.001336 | 0.000928 | 567 |
| LRRK1_P39_F | −0.295 | 0.019 | 0.001338 | 0.000928 | 568 |
| WNT10B_P993_F | 0.859 | −0.149 | 0.00134 | 0.000928 | 569 |
| CCKBR_P361_R | −0.577 | 0.021 | 0.001354 | 0.000936 | 570 |
| NNAT_P544_R | 0.299 | −0.022 | 0.001374 | 0.000948 | 571 |
| HSPA2_P162_R | 0.444 | −0.038 | 0.00139 | 0.000957 | 572 |
| SLC22A18_P216_R | 0.491 | −0.074 | 0.001502 | 0.001033 | 573 |
| COL6A1_P283_F | −0.228 | 0.004 | 0.00152 | 0.001042 | 574 |
| HBII-13_P991_R | 0.512 | −0.055 | 0.001521 | 0.001042 | 575 |
| HOXB13_P17_R | −0.823 | 0.115 | 0.00157 | 0.001074 | 576 |
| CYP1B1_E83_R | −0.933 | 0.169 | 0.001593 | 0.001088 | 577 |
| EGF_E339_F | −1.108 | 0.121 | 0.00164 | 0.001118 | 578 |
| FGF7_P44_F | −0.609 | 0.073 | 0.001662 | 0.001131 | 579 |
| LCN2_P141_R | −0.610 | 0.071 | 0.001707 | 0.001159 | 580 |
| B3GALT5_E246_R | −0.680 | 0.132 | 0.001747 | 0.001184 | 581 |
| ABCB4_E429_F | −0.379 | 0.018 | 0.001781 | 0.001205 | 582 |
| ARHGAP9_P260_F | 0.394 | −0.034 | 0.001797 | 0.001214 | 583 |
| ACTG2_P346_F | 0.462 | −0.080 | 0.001825 | 0.001231 | 584 |
| VAMP8_P114_F | −0.667 | 0.136 | 0.001844 | 0.001242 | 585 |
| HLA-DQA2_P282_R | 0.443 | −0.075 | 0.00191 | 0.001284 | 586 |
| LMO1_P169_F | −0.329 | 0.012 | 0.001926 | 0.001293 | 587 |
| GDF10_E39_F | −0.489 | 0.096 | 0.001941 | 0.001301 | 588 |
| CCL3_P543_R | −0.636 | 0.070 | 0.00196 | 0.001309 | 589 |
| SPI1_P929_F | 0.350 | −0.052 | 0.001961 | 0.001309 | 590 |
| MYB_P673_R | −0.648 | 0.058 | 0.001989 | 0.001326 | 591 |
| ZIM3_P718_R | −0.843 | 0.069 | 0.002 | 0.001331 | 592 |
| TNFRSF10D_P70_F | 1.178 | −0.241 | 0.002037 | 0.001353 | 593 |
| SNRPN_seq_18_S99_F | 0.417 | −0.074 | 0.002082 | 0.001381 | 594 |
| HLA-DPA1_P28_R | 0.725 | −0.171 | 0.002104 | 0.001393 | 595 |
| ASCL2_E76_R | 0.793 | −0.173 | 0.002116 | 0.001399 | 596 |
| PDGFRA_E125_F | 0.690 | −0.166 | 0.002138 | 0.001411 | 597 |
| FN1_P229_R | 0.467 | −0.043 | 0.002179 | 0.001435 | 598 |
| MMP9_P189_F | −0.542 | 0.133 | 0.002264 | 0.001489 | 599 |
| PI3_P274_R | −0.677 | 0.058 | 0.002291 | 0.001504 | 600 |
| HOXC6_P585_R | 0.630 | −0.103 | 0.002619 | 0.001717 | 601 |
| EGF_P413_F | −0.684 | 0.082 | 0.002641 | 0.001728 | 602 |
| PYCARD_P393_F | −0.469 | 0.084 | 0.002654 | 0.001734 | 603 |
| NQO1_P345_R | −0.369 | 0.018 | 0.002668 | 0.001739 | 604 |
| CTSD_P726_F | −0.457 | 0.105 | 0.002671 | 0.001739 | 605 |
| KCNQ1_P546_R | 0.574 | −0.110 | 0.0027 | 0.001755 | 606 |
| NOTCH4_P938_F | −0.567 | 0.098 | 0.002802 | 0.001819 | 607 |
| ICAM1_P386_R | −0.876 | 0.068 | 0.00294 | 0.001905 | 608 |
| HGF_E102_R | −0.685 | 0.121 | 0.00298 | 0.001926 | 609 |
| DNAJC15_E26_R | 0.547 | −0.081 | 0.002982 | 0.001926 | 610 |
| HDAC9_P137_R | 0.820 | −0.187 | 0.003019 | 0.001946 | 611 |
| TEK_P479_R | −0.499 | 0.078 | 0.003102 | 0.001996 | 612 |
| SPDEF_P6_R | −0.484 | 0.120 | 0.003106 | 0.001996 | 613 |
| IGF1_E394_F | −0.551 | 0.135 | 0.003147 | 0.002016 | 614 |
| MMP3_P16_R | −0.801 | 0.114 | 0.003148 | 0.002016 | 615 |
| HOXB2_P99_F | 0.535 | −0.127 | 0.003191 | 0.002041 | 616 |
| HPN_P823_F | 0.334 | −0.030 | 0.003232 | 0.002064 | 617 |
| OPCML_P71_F | −0.552 | 0.099 | 0.003322 | 0.002118 | 618 |
| KRT5_E196_R | −0.880 | 0.091 | 0.003333 | 0.002121 | 619 |
| CALCA_P171_F | 0.452 | −0.112 | 0.003382 | 0.002146 | 620 |
| TYRO3_P501_F | −0.338 | 0.010 | 0.003384 | 0.002146 | 621 |
| ALPL_P433_F | 0.562 | −0.131 | 0.003391 | 0.002146 | 622 |
| ITPR2_P804_F | −0.410 | 0.033 | 0.003394 | 0.002146 | 623 |
| KIT_P405_F | −0.681 | 0.062 | 0.003439 | 0.002171 | 624 |
| MAP2K6_E297_F | −0.592 | 0.042 | 0.003494 | 0.002203 | 625 |
| MEG3_P235_F | −0.547 | 0.068 | 0.003528 | 0.00222 | 626 |
| SERPINA5_E69_F | 0.250 | −0.042 | 0.003585 | 0.002253 | 627 |
| NRG1_P558_R | −0.391 | 0.025 | 0.003593 | 0.002254 | 628 |
| RET_seq_54_S260_F | −0.811 | 0.052 | 0.003675 | 0.0023 | 629 |
| ETV1_P515_F | −0.590 | 0.055 | 0.003679 | 0.0023 | 630 |
| TNFRSF10D_E27_F | 1.437 | −0.268 | 0.003818 | 0.002382 | 631 |
| ZNF215_P71_R | −0.587 | 0.140 | 0.003822 | 0.002382 | 632 |
| ERBB4_P255_F | −0.396 | 0.013 | 0.003847 | 0.002394 | 633 |
| NOTCH1_P1198_F | −0.419 | 0.030 | 0.003924 | 0.002438 | 634 |
| DNMT3B_P352_R | −0.393 | 0.056 | 0.003937 | 0.002442 | 635 |
| ER_seq_a1_S60_F | −0.605 | 0.067 | 0.003953 | 0.002449 | 636 |
| GFAP_P56_R | 0.443 | −0.073 | 0.003977 | 0.00246 | 637 |
| LCN2_P86_R | −0.587 | 0.113 | 0.003988 | 0.002462 | 638 |
| IL12A_E287_R | −0.438 | 0.016 | 0.004044 | 0.002493 | 639 |
| APBA1_P644_F | −0.278 | 0.015 | 0.004078 | 0.00251 | 640 |
| AGXT_P180_F | −0.870 | 0.091 | 0.004106 | 0.002523 | 641 |
| PPAT_E170_R | 0.295 | −0.072 | 0.004119 | 0.002528 | 642 |
| CCL3_E53_R | −0.630 | 0.134 | 0.00413 | 0.00253 | 643 |
| DUSP4_E61_F | −0.298 | 0.036 | 0.00457 | 0.002796 | 644 |
| ABCG2_P310_R | 1.428 | −0.161 | 0.004666 | 0.00285 | 645 |
| JAK3_P1075_R | 0.349 | −0.051 | 0.004692 | 0.002861 | 646 |
| BCL6_P248_R | −0.292 | 0.019 | 0.004719 | 0.002873 | 647 |
| DLC1_P88_R | 0.471 | −0.094 | 0.004763 | 0.002895 | 648 |
| EPHA8_P256_F | −0.452 | 0.068 | 0.004783 | 0.0029 | 649 |
| WNT2_P217_F | −0.453 | 0.048 | 0.004785 | 0.0029 | 650 |
| SOD3_P460_R | −0.490 | 0.067 | 0.00486 | 0.002941 | 651 |
| PROK2_E0_F | −0.372 | 0.014 | 0.004873 | 0.002944 | 652 |
| BSG_P211_R | 1.264 | −0.236 | 0.005046 | 0.003044 | 653 |
| AKT1_P310_R | −0.322 | 0.023 | 0.005143 | 0.003098 | 654 |
| MFAP4_P10_R | −0.442 | 0.094 | 0.00531 | 0.003193 | 655 |
| HOXA9_P303_F | 0.660 | −0.129 | 0.005352 | 0.003211 | 656 |
| NFKB1_P336_R | −0.697 | 0.067 | 0.005355 | 0.003211 | 657 |
| EPHX1_P1358_R | 0.394 | −0.082 | 0.005386 | 0.003224 | 658 |
| ACVR1B_E497_R | −0.510 | 0.019 | 0.005443 | 0.003252 | 659 |
| ATP10A_P524_R | −0.553 | 0.133 | 0.005448 | 0.003252 | 660 |
| RUNX1T1_E145_R | −0.507 | 0.113 | 0.005695 | 0.003394 | 661 |
| TNFRSF1B_P167_F | −0.697 | 0.044 | 0.005749 | 0.003421 | 662 |
| GABRG3_E123_R | −0.761 | 0.083 | 0.005951 | 0.003536 | 663 |
| NBL1_E205_R | −0.459 | 0.084 | 0.006052 | 0.003591 | 664 |
| SLC5A8_P38_R | 0.955 | −0.169 | 0.006217 | 0.003678 | 665 |
| CTSL_P264_R | −0.465 | 0.103 | 0.006218 | 0.003678 | 666 |
| UGT1A1_P564_R | 0.303 | −0.015 | 0.006251 | 0.003688 | 667 |
| TGFB1_P833_R | 0.266 | −0.012 | 0.006261 | 0.003688 | 668 |
| IGF2_P1036_R | −0.575 | 0.046 | 0.006271 | 0.003688 | 669 |
| HDAC9_E38_F | 0.846 | −0.170 | 0.006272 | 0.003688 | 670 |
| PENK_P447_R | 0.806 | −0.149 | 0.00633 | 0.003716 | 671 |
| GALR1_E52_F | −0.648 | 0.061 | 0.006372 | 0.003735 | 672 |
| INS_P804_R | −0.403 | 0.024 | 0.006475 | 0.00379 | 673 |
| DDR1_P332_R | −0.592 | 0.135 | 0.006587 | 0.00385 | 674 |
| IGF2AS_P203_F | 0.637 | −0.155 | 0.0066 | 0.003852 | 675 |
| OGG1_E400_F | −0.479 | 0.105 | 0.006635 | 0.003867 | 676 |
| CSF2_P605_F | 0.338 | −0.034 | 0.006654 | 0.003872 | 677 |
| IL6_P611_F | −0.728 | 0.068 | 0.006764 | 0.00393 | 678 |
| IGF2_P36_R | −0.472 | 0.060 | 0.006953 | 0.004034 | 679 |
| LRRC32_E157_F | −0.314 | 0.016 | 0.007297 | 0.004227 | 680 |
| OSM_P188_F | −0.665 | 0.090 | 0.00777 | 0.004495 | 681 |
| ITK_E166_R | −0.723 | 0.054 | 0.007783 | 0.004496 | 682 |
| MAPK12_E165_R | −0.371 | 0.020 | 0.007828 | 0.004515 | 683 |
| ABCC2_E16_R | 0.803 | −0.093 | 0.007844 | 0.004518 | 684 |
| KRT1_P798_R | 0.330 | −0.051 | 0.007976 | 0.004587 | 685 |
| FGF5_P238_R | −0.361 | 0.015 | 0.008149 | 0.004679 | 686 |
| TMEFF1_P234_F | −0.438 | 0.025 | 0.008186 | 0.004694 | 687 |
| UNG_P170_F | −0.625 | 0.038 | 0.008373 | 0.004791 | 688 |
| PWCR1_P357_F | −0.455 | 0.059 | 0.008386 | 0.004791 | 689 |
| MMP8_E89_R | −0.369 | 0.029 | 0.008399 | 0.004791 | 690 |
| PECAM1_P135_F | 0.358 | −0.057 | 0.008404 | 0.004791 | 691 |
| MAF_P826_R | −0.460 | 0.021 | 0.008468 | 0.004821 | 692 |
| SEMA3C_P642_F | 0.497 | −0.124 | 0.008709 | 0.004951 | 693 |
| KLK10_P268_R | −0.306 | 0.036 | 0.009027 | 0.005124 | 694 |
| TIAM1_P188_R | −0.294 | 0.015 | 0.009098 | 0.005157 | 695 |
| FES_P223_R | −0.434 | 0.037 | 0.009708 | 0.005493 | 696 |
| TUBB3_E91_F | −0.545 | 0.093 | 0.009718 | 0.005493 | 697 |
| RAB32_E314_R | −0.373 | 0.024 | 0.009747 | 0.005501 | 698 |
| CASP10_E139_F | −0.363 | 0.027 | 0.009808 | 0.005527 | 699 |
| PTPRH_E173_F | −0.507 | 0.113 | 0.009851 | 0.005544 | 700 |
| ERBB4_P541_F | −0.390 | 0.014 | 0.009971 | 0.005603 | 701 |
| FZD9_E458_F | 0.566 | −0.141 | 0.009993 | 0.005608 | 702 |
| EPHA5_P66_F | −0.337 | 0.083 | 0.010065 | 0.00564 | 703 |
| PLAUR_P82_F | −0.214 | 0.007 | 0.010308 | 0.005768 | 704 |
| TDGF1_P428_R | −0.360 | 0.090 | 0.010545 | 0.005892 | 705 |
| PEG10_P978_R | −0.508 | 0.080 | 0.010569 | 0.005897 | 706 |
| HLA-DRA_P77_R | −0.487 | 0.066 | 0.010923 | 0.006086 | 707 |
| HSD17B12_E145_R | −0.686 | 0.028 | 0.010999 | 0.00612 | 708 |
| IGF1_P933_F | 0.394 | −0.086 | 0.011019 | 0.006122 | 709 |
| CSPG2_P82_R | −0.460 | 0.062 | 0.011064 | 0.006137 | 710 |
| PTHR1_E36_R | −0.303 | 0.017 | 0.011085 | 0.006137 | 711 |
| PRSS1_P1249_R | −0.450 | 0.093 | 0.011092 | 0.006137 | 712 |
| BCL2L2_E172_F | −0.386 | 0.022 | 0.011159 | 0.006166 | 713 |
| SIN3B_P607_F | −0.305 | 0.027 | 0.011611 | 0.006406 | 714 |
| IGSF4_P454_F | −0.312 | 0.009 | 0.011662 | 0.006421 | 715 |
| MMP2_E21_R | −0.521 | 0.039 | 0.01167 | 0.006421 | 716 |
| RIPK1_P744_R | 0.520 | −0.060 | 0.011744 | 0.006448 | 717 |
| FGF1_E5_F | 0.371 | −0.060 | 0.011753 | 0.006448 | 718 |
| ETV6_E430_F | 0.261 | −0.034 | 0.011889 | 0.006514 | 719 |
| FANCE_P356_R | 0.947 | −0.147 | 0.012052 | 0.006594 | 720 |
| MMP1_P460_F | −0.373 | 0.011 | 0.012646 | 0.00691 | 721 |
| PECAM1_E32_R | 0.327 | −0.059 | 0.012808 | 0.006988 | 722 |
| MYOD1_E156_F | 0.765 | −0.121 | 0.01301 | 0.007089 | 723 |
| CD9_P504_F | 0.683 | −0.161 | 0.013064 | 0.007104 | 724 |
| PALM2-AKAP2_P420_R | −0.436 | 0.039 | 0.013074 | 0.007104 | 725 |
| IGF2_E134_R | −0.571 | 0.072 | 0.013222 | 0.007175 | 726 |
| ZIM2_P22_F | −0.376 | 0.079 | 0.013291 | 0.007202 | 727 |
| WNT1_E157_F | −0.590 | 0.071 | 0.013686 | 0.007406 | 728 |
| NKX3-1_P871_R | −0.261 | 0.010 | 0.013715 | 0.007412 | 729 |
| MSH3_E3_F | −0.730 | 0.079 | 0.01376 | 0.007425 | 730 |
| MSH2_P1008_F | 0.337 | −0.062 | 0.013999 | 0.007544 | 731 |
| MT1A_E13_R | 0.847 | −0.169 | 0.014051 | 0.007562 | 732 |
| PRSS8_E134_R | 0.344 | −0.036 | 0.014123 | 0.00759 | 733 |
| TFDP1_P543_R | 0.223 | −0.032 | 0.014296 | 0.007673 | 734 |
| CSF1R_E26_F | −0.467 | 0.033 | 0.014569 | 0.007809 | 735 |
| EDN1_P39_R | −0.561 | 0.016 | 0.014655 | 0.007834 | 736 |
| PWCR1_E81_R | −0.611 | 0.020 | 0.014656 | 0.007834 | 737 |
| LTA_E28_R | −0.804 | 0.099 | 0.014913 | 0.007961 | 738 |
| SRC_P297_F | 0.170 | −0.006 | 0.014934 | 0.007961 | 739 |
| IHH_P529_F | −0.518 | 0.038 | 0.015002 | 0.007986 | 740 |
| CDH17_E31_F | 0.317 | −0.021 | 0.015349 | 0.00816 | 741 |
| GJB2_P791_R | −0.573 | 0.061 | 0.015514 | 0.008237 | 742 |
| ABCB4_P51_F | −0.283 | 0.014 | 0.015945 | 0.008454 | 743 |
| THBS1_E207_R | 1.165 | −0.099 | 0.016173 | 0.008564 | 744 |
| PDE1B_P263_R | −0.630 | 0.031 | 0.016375 | 0.008659 | 745 |
| GPX1_P194_F | −0.476 | 0.041 | 0.016466 | 0.008695 | 746 |
| CSF1_P339_F | −0.206 | 0.006 | 0.016595 | 0.008752 | 747 |
| DNMT2_P199_F | 0.260 | −0.033 | 0.016828 | 0.008862 | 748 |
| TGFB3_E58_R | −0.584 | 0.110 | 0.016861 | 0.008868 | 749 |
| MT1A_P49_R | 1.260 | −0.161 | 0.016896 | 0.008875 | 750 |
| NR2F6_E375_R | −0.142 | 0.011 | 0.016929 | 0.00888 | 751 |
| IL4_P262_R | −0.195 | 0.023 | 0.017192 | 0.009006 | 752 |
| TFPI2_P152_R | −0.177 | 0.020 | 0.017236 | 0.009012 | 753 |
| FABP3_P598_F | −0.438 | 0.048 | 0.017249 | 0.009012 | 754 |
| SPI1_E205_F | 0.224 | −0.055 | 0.01728 | 0.009016 | 755 |
| FGFR4_P610_F | 0.255 | −0.026 | 0.017413 | 0.009074 | 756 |
| HIC2_P498_F | 0.719 | −0.073 | 0.017529 | 0.009122 | 757 |
| MMP19_P306_F | −0.392 | 0.056 | 0.017897 | 0.009301 | 758 |
| IFNG_P188_F | −0.474 | 0.062 | 0.018057 | 0.009372 | 759 |
| TNFRSF10A_P91_F | −0.646 | 0.094 | 0.018751 | 0.00972 | 760 |
| HHIP_P307_R | −0.584 | 0.061 | 0.019229 | 0.009954 | 761 |
| KRAS_E82_F | −0.282 | 0.064 | 0.019631 | 0.010149 | 762 |
| GSTM2_E153_F | 0.857 | −0.163 | 0.019677 | 0.010159 | 763 |
| ERCC3_P1210_R | −0.282 | 0.021 | 0.020003 | 0.010307 | 764 |
| CDKN2A_E121_R | −0.302 | 0.019 | 0.020016 | 0.010307 | 765 |
| SFN_E118_F | −0.521 | 0.053 | 0.02017 | 0.010373 | 766 |
| SOX17_P303_F | 0.648 | −0.150 | 0.020251 | 0.010401 | 767 |
| CD86_P3_F | −0.627 | 0.130 | 0.020595 | 0.010564 | 768 |
| AREG_P217_R | −0.239 | 0.034 | 0.020741 | 0.010625 | 769 |
| AATK_E63_R | −0.449 | 0.028 | 0.021087 | 0.010789 | 770 |
| SIN3B_P514_R | −0.564 | 0.050 | 0.021142 | 0.010803 | 771 |
| TMEFF2_P210_R | −0.516 | 0.089 | 0.02142 | 0.01093 | 772 |
| SHB_P691_R | −0.569 | 0.047 | 0.021477 | 0.010945 | 773 |
| WNT10B_P823_R | 0.579 | −0.130 | 0.021649 | 0.011019 | 774 |
| RBL2_P250_R | −0.385 | 0.027 | 0.021702 | 0.011031 | 775 |
| MYCL1_P502_R | −0.447 | 0.037 | 0.021919 | 0.011128 | 776 |
| TNFRSF1B_E5_F | −0.248 | 0.026 | 0.021974 | 0.011141 | 777 |
| CD81_P272_R | 0.359 | −0.070 | 0.022429 | 0.011357 | 778 |
| PLXDC1_P236_F | −0.479 | 0.023 | 0.022671 | 0.011465 | 779 |
| HCK_P858_F | 0.492 | −0.120 | 0.02286 | 0.011546 | 780 |
| SOX1_P294_F | 0.872 | −0.114 | 0.023098 | 0.011651 | 781 |
| MMP7_P613_F | 0.150 | −0.018 | 0.023319 | 0.011747 | 782 |
| LEFTY2_P561_F | 0.312 | −0.078 | 0.023379 | 0.011763 | 783 |
| FGF6_P139_R | 0.311 | −0.026 | 0.023912 | 0.012001 | 784 |
| MAP2K6_P297_R | −0.309 | 0.040 | 0.023914 | 0.012001 | 785 |
| APBA2_P305_R | −0.316 | 0.030 | 0.024019 | 0.012038 | 786 |
| RUNX3_E27_R | −0.538 | 0.068 | 0.024418 | 0.012223 | 787 |
| SLC14A1_E295_F | −0.388 | 0.050 | 0.024774 | 0.012385 | 788 |
| SEMA3A_P343_F | −0.394 | 0.042 | 0.02524 | 0.012602 | 789 |
| HOXC6_P456_R | 0.548 | −0.087 | 0.025293 | 0.012613 | 790 |
| MOS_E60_R | 0.720 | −0.158 | 0.025721 | 0.01281 | 791 |
| LMO1_E265_R | −0.406 | 0.048 | 0.025964 | 0.012914 | 792 |
| HOXA11_E35_F | 0.669 | −0.137 | 0.02643 | 0.01313 | 793 |
| DES_P1006_R | −0.342 | 0.053 | 0.026518 | 0.013157 | 794 |
| SLC5A5_E60_F | 0.393 | −0.072 | 0.026586 | 0.013167 | 795 |
| ASCL2_P360_F | 0.621 | −0.132 | 0.026604 | 0.013167 | 796 |
| USP29_P205_R | 0.198 | −0.022 | 0.026979 | 0.013335 | 797 |
| CCNA1_P216_F | −0.654 | 0.059 | 0.027392 | 0.013523 | 798 |
| LRRK1_P834_F | −0.279 | 0.059 | 0.027561 | 0.013589 | 799 |
| TJP1_P390_F | −0.332 | 0.013 | 0.02764 | 0.013611 | 800 |
| TIMP3_P690_R | 0.176 | −0.007 | 0.027838 | 0.013691 | 801 |
| ERN1_P809_R | 0.501 | −0.125 | 0.02796 | 0.013734 | 802 |
| MMP2_P303_R | 0.742 | −0.136 | 0.02849 | 0.013977 | 803 |
| TPEF_seq_44_S36_F | −0.354 | 0.016 | 0.028727 | 0.014075 | 804 |
| CDH1_P52_R | −0.437 | 0.042 | 0.029493 | 0.014433 | 805 |
| SLC22A2_E271_R | 0.184 | −0.007 | 0.029882 | 0.014606 | 806 |
| OSM_P34_F | −0.442 | 0.092 | 0.029956 | 0.014623 | 807 |
| WNT8B_E487_F | 0.253 | −0.032 | 0.030208 | 0.014728 | 808 |
| MST1R_E42_R | −0.410 | 0.102 | 0.030858 | 0.015027 | 809 |
| PTPRG_E40_R | −0.201 | 0.012 | 0.031117 | 0.015134 | 810 |
| FN1_E469_F | 0.864 | −0.084 | 0.031651 | 0.015374 | 811 |
| COL1A2_P48_R | 0.979 | −0.157 | 0.032437 | 0.015737 | 812 |
| SEMA3C_E49_R | −0.337 | 0.024 | 0.032568 | 0.015781 | 813 |
| UGT1A7_P751_R | −0.214 | 0.006 | 0.032646 | 0.015799 | 814 |
| SERPINE1_E189_R | −0.283 | 0.049 | 0.032937 | 0.015921 | 815 |
| IL17RB_P788_R | −0.481 | 0.023 | 0.033167 | 0.016012 | 816 |
| MAPK14_P327_R | −0.379 | 0.060 | 0.033957 | 0.016373 | 817 |
| GJB2_P931_R | 0.440 | −0.110 | 0.034011 | 0.016379 | 818 |
| NFKB1_P496_F | −0.247 | 0.038 | 0.034165 | 0.016434 | 819 |
| CDKN2B_E220_F | −0.254 | 0.017 | 0.034666 | 0.016654 | 820 |
| GNG7_P903_F | 0.146 | −0.012 | 0.035472 | 0.017004 | 821 |
| DIRAS3_E55_R | −0.325 | 0.030 | 0.03548 | 0.017004 | 822 |
| CEACAM1_E57_R | 0.664 | −0.112 | 0.036093 | 0.017257 | 823 |
| MMP9_E88_R | −0.336 | 0.029 | 0.036096 | 0.017257 | 824 |
| IL10_P85_F | −0.384 | 0.073 | 0.036347 | 0.017356 | 825 |
| POMC_E254_F | −0.465 | 0.037 | 0.036853 | 0.017556 | 826 |
| RARA_E128_R | −0.350 | 0.038 | 0.036854 | 0.017556 | 827 |
| CXCL9_E268_R | −0.353 | 0.046 | 0.037344 | 0.017767 | 828 |
| ZIM3_E203_F | −0.374 | 0.013 | 0.037495 | 0.017818 | 829 |
| EIF2AK2_P313_F | 1.011 | −0.102 | 0.039147 | 0.018581 | 830 |
| CDH11_P203_R | −0.341 | 0.015 | 0.039445 | 0.01869 | 831 |
| TFAP2C_P765_F | −0.684 | 0.067 | 0.039473 | 0.01869 | 832 |
| MDS1_E45_F | 0.310 | −0.018 | 0.03962 | 0.018737 | 833 |
| GJB2_E43_F | −0.421 | 0.027 | 0.039939 | 0.018865 | 834 |
| PAX6_P1121_F | 0.591 | −0.059 | 0.040216 | 0.018974 | 835 |
| EDNRB_P709_R | −0.333 | 0.014 | 0.04071 | 0.019164 | 836 |
| FZD9_P15_R | −0.515 | 0.035 | 0.040718 | 0.019164 | 837 |
| TAL1_P817_F | 0.374 | −0.080 | 0.042726 | 0.020086 | 838 |
| CD40_P372_R | 0.615 | −0.134 | 0.042778 | 0.020086 | 839 |
| SPDEF_E116_R | 0.313 | −0.077 | 0.044138 | 0.020668 | 840 |
| NOS3_P38_F | −0.357 | 0.053 | 0.04415 | 0.020668 | 841 |
| FZD9_P175_F | −0.482 | 0.105 | 0.044175 | 0.020668 | 842 |
| ESR2_E66_F | −0.716 | 0.059 | 0.04446 | 0.020777 | 843 |
| HTR2A_P853_F | −0.531 | 0.045 | 0.044674 | 0.020852 | 844 |
| MCAM_P265_R | −0.304 | 0.053 | 0.044861 | 0.020915 | 845 |
| IPF1_P750_F | 0.461 | −0.110 | 0.045301 | 0.021095 | 846 |
| MC2R_E455_F | −0.652 | 0.051 | 0.045565 | 0.021193 | 847 |
| DCC_E53_R | 0.376 | −0.092 | 0.04598 | 0.021353 | 848 |
| NEFL_P209_R | 0.500 | −0.099 | 0.046018 | 0.021353 | 849 |
| NTRK2_P395_R | −0.594 | 0.039 | 0.046298 | 0.021434 | 850 |
| DSP_P440_R | 0.650 | −0.033 | 0.046303 | 0.021434 | 851 |
| SERPINB5_P19_R | −0.713 | 0.057 | 0.046667 | 0.021578 | 852 |
| MAD2L1_E93_F | 0.187 | −0.033 | 0.047288 | 0.021839 | 853 |
| CD40_E58_R | 0.815 | −0.098 | 0.047981 | 0.022133 | 854 |
| TFF2_P178_F | −0.372 | 0.059 | 0.048165 | 0.022192 | 855 |
| EPHA3_E156_R | −0.441 | 0.035 | 0.04835 | 0.022251 | 856 |
| FRK_P36_F | −0.356 | 0.086 | 0.049007 | 0.022527 | 857 |
| LTB4R_P163_F | 0.210 | −0.024 | 0.050568 | 0.023202 | 858 |
| EPHA2_P340_R | −0.267 | 0.052 | 0.050593 | 0.023202 | 859 |
| FGFR3_P1152_R | −0.385 | 0.095 | 0.050794 | 0.023267 | 860 |
| GP1BB_E23_F | −0.480 | 0.086 | 0.051543 | 0.023583 | 861 |
| HRASLS_P353_R | 0.294 | −0.072 | 0.051962 | 0.023747 | 862 |
| LTB4R_E64_R | 0.267 | −0.038 | 0.052575 | 0.023999 | 863 |
| MET_E333_F | −0.305 | 0.057 | 0.053256 | 0.024282 | 864 |
| RUNX3_P247_F | −0.505 | 0.076 | 0.053831 | 0.024516 | 865 |
| TFF2_P557_R | −0.381 | 0.019 | 0.054146 | 0.024631 | 866 |
| TNC_P198_F | −0.232 | 0.030 | 0.05488 | 0.024936 | 867 |
| GUCY2D_P48_R | −0.414 | 0.071 | 0.055703 | 0.025281 | 868 |
| ALOX12_P223_R | −0.470 | 0.109 | 0.056236 | 0.025493 | 869 |
| UGT1A1_E11_F | −0.156 | 0.004 | 0.056522 | 0.025594 | 870 |
| TFF1_P180_R | −0.290 | 0.044 | 0.056598 | 0.025599 | 871 |
| DSC2_P407_R | −0.194 | 0.012 | 0.056877 | 0.025695 | 872 |
| CFTR_P372_R | −0.427 | 0.100 | 0.058061 | 0.0262 | 873 |
| NTRK3_P752_F | −0.245 | 0.010 | 0.05815 | 0.02621 | 874 |
| TFAP2C_E260_F | 0.269 | −0.016 | 0.058225 | 0.026211 | 875 |
| NPY_E31_R | −0.431 | 0.103 | 0.058283 | 0.026211 | 876 |
| APOA1_P75_F | −0.530 | 0.070 | 0.05848 | 0.026269 | 877 |
| CYP2E1_P416_F | −0.540 | 0.039 | 0.058814 | 0.026389 | 878 |
| SNURF_E256_R | −0.246 | 0.036 | 0.059449 | 0.026643 | 879 |
| NGFR_E328_F | −0.460 | 0.055 | 0.060121 | 0.026887 | 880 |
| GPATC3_P410_R | −0.489 | 0.075 | 0.060129 | 0.026887 | 881 |
| NOTCH1_E452_R | 0.168 | −0.007 | 0.060549 | 0.027044 | 882 |
| ERBB3_E331_F | −0.420 | 0.042 | 0.061126 | 0.027271 | 883 |
| NOTCH4_E4_F | 0.467 | −0.116 | 0.061305 | 0.02732 | 884 |
| MLLT6_P957_F | −0.505 | 0.050 | 0.061746 | 0.027485 | 885 |
| NGFR_P355_F | 0.403 | −0.097 | 0.061901 | 0.027523 | 886 |
| ZP3_E90_F | 0.931 | −0.097 | 0.063114 | 0.028031 | 887 |
| APBA2_P227_F | −0.274 | 0.017 | 0.063607 | 0.028218 | 888 |
| IFNGR2_P377_R | −0.388 | 0.096 | 0.063763 | 0.028256 | 889 |
| ISL1_P379_F | −0.524 | 0.051 | 0.063877 | 0.028274 | 890 |
| SGCE_E149_F | −0.466 | 0.054 | 0.064076 | 0.02833 | 891 |
| ISL1_P554_F | −0.509 | 0.069 | 0.06416 | 0.028336 | 892 |
| GABRB3_E42_F | −0.488 | 0.055 | 0.064369 | 0.028396 | 893 |
| FLT1_E444_F | −0.341 | 0.015 | 0.065339 | 0.028792 | 894 |
| H19_P1411_R | 0.228 | −0.029 | 0.065614 | 0.028881 | 895 |
| EVI1_E47_R | 0.731 | −0.122 | 0.066825 | 0.029381 | 896 |
| PTCH2_P37_F | −0.159 | 0.011 | 0.066912 | 0.029387 | 897 |
| SYK_E372_F | 0.699 | −0.050 | 0.070817 | 0.031067 | 898 |
| ZP3_P220_F | −0.348 | 0.046 | 0.071584 | 0.031368 | 899 |
| EGF_P242_R | −0.315 | 0.038 | 0.071805 | 0.03143 | 900 |
| LTA_P214_R | −0.301 | 0.028 | 0.072635 | 0.031758 | 901 |
| TCF4_P317_F | 0.556 | −0.067 | 0.073168 | 0.031956 | 902 |
| CSF1R_P73_F | −0.227 | 0.056 | 0.073518 | 0.032073 | 903 |
| COL1A2_P407_R | 0.376 | −0.092 | 0.073886 | 0.032198 | 904 |
| JAK3_E64_F | 0.658 | −0.100 | 0.074311 | 0.032347 | 905 |
| GAS7_P622_R | 0.378 | −0.082 | 0.075309 | 0.032746 | 906 |
| EDNRB_P148_R | −0.319 | 0.014 | 0.076191 | 0.033093 | 907 |
| SNCG_P53_F | −0.329 | 0.082 | 0.076311 | 0.033108 | 908 |
| FLT1_P615_R | 0.772 | −0.103 | 0.076508 | 0.033157 | 909 |
| INS_P248_F | −0.254 | 0.028 | 0.077583 | 0.033586 | 910 |
| GML_E144_F | 0.494 | −0.060 | 0.079366 | 0.03432 | 911 |
| SCGB3A1_E55_R | 0.548 | −0.104 | 0.080353 | 0.034709 | 912 |
| APOC2_P377_F | −0.211 | 0.032 | 0.080858 | 0.034889 | 913 |
| HTR1B_E232_R | 0.488 | −0.103 | 0.081073 | 0.034927 | 914 |
| MYBL2_P354_F | −0.509 | 0.075 | 0.081123 | 0.034927 | 915 |
| EPHA3_P106_R | −0.504 | 0.064 | 0.081474 | 0.035039 | 916 |
| FGF8_E183_F | −0.444 | 0.024 | 0.082005 | 0.035229 | 917 |
| SFRP1_P157_F | −0.613 | 0.050 | 0.085171 | 0.03655 | 918 |
| GNAS_E58_F | −0.188 | 0.021 | 0.085517 | 0.036658 | 919 |
| DBC1_P351_R | 0.590 | −0.079 | 0.085707 | 0.0367 | 920 |
| NPR2_P1093_F | −0.282 | 0.038 | 0.085826 | 0.036711 | 921 |
| MKRN3_E144_F | −0.478 | 0.035 | 0.086212 | 0.036836 | 922 |
| WT1_E32_F | −0.300 | 0.015 | 0.087346 | 0.03728 | 923 |
| TMPRSS4_P552_F | 0.270 | −0.023 | 0.088315 | 0.037653 | 924 |
| CHGA_P243_F | −0.300 | 0.065 | 0.088782 | 0.037811 | 925 |
| HS3ST2_P546_F | −0.348 | 0.069 | 0.089142 | 0.037913 | 926 |
| RIPK4_E166_F | −0.296 | 0.020 | 0.089213 | 0.037913 | 927 |
| EPHA1_E46_R | −0.377 | 0.021 | 0.090715 | 0.03851 | 928 |
| NTRK2_P10_F | −0.447 | 0.021 | 0.090851 | 0.038526 | 929 |
| SNURF_P2_R | 0.175 | −0.043 | 0.092269 | 0.039085 | 930 |
| DSG1_P159_R | −0.206 | 0.021 | 0.092761 | 0.039251 | 931 |
| CHGA_E52_F | 0.522 | −0.101 | 0.093864 | 0.039673 | 932 |
| FGF1_P357_R | −0.375 | 0.063 | 0.093959 | 0.039673 | 933 |
| HLA-DRA_P132_R | 0.457 | −0.044 | 0.094128 | 0.039702 | 934 |
| PROK2_P390_F | 0.951 | −0.080 | 0.094401 | 0.039774 | 935 |
| CCNC_P132_R | −0.408 | 0.013 | 0.096541 | 0.040632 | 936 |
| PARP1_P610_R | 0.272 | −0.038 | 0.097318 | 0.04087 | 937 |
| HOXA5_E187_F | −0.350 | 0.069 | 0.097339 | 0.04087 | 938 |
| DBC1_E204_F | −0.284 | 0.047 | 0.097416 | 0.04087 | 939 |
| EPO_E244_R | 0.702 | −0.102 | 0.101289 | 0.042449 | 940 |
| GSTM1_P266_F | 0.327 | −0.081 | 0.105957 | 0.044318 | 941 |
| SLIT2_P208_F | −0.317 | 0.031 | 0.105974 | 0.044318 | 942 |
| RASSF1_P244_F | 1.017 | −0.070 | 0.106421 | 0.044458 | 943 |
| ZNFN1A1_P179_F | −0.246 | 0.007 | 0.107221 | 0.044745 | 944 |
| TK1_P62_R | −0.627 | 0.020 | 0.107905 | 0.044944 | 945 |
| IL6_P213_R | −0.344 | 0.036 | 0.107927 | 0.044944 | 946 |
| ESR1_P151_R | 0.487 | −0.110 | 0.108424 | 0.045104 | 947 |
| MOS_P27_R | 0.486 | −0.043 | 0.108953 | 0.045276 | 948 |
| GNG7_E310_R | 0.138 | −0.004 | 0.109796 | 0.045578 | 949 |
| PPARG_P693_F | 0.213 | −0.034 | 0.110297 | 0.045738 | 950 |
| NID1_P677_F | −0.389 | 0.033 | 0.110847 | 0.045917 | 951 |
| ROR1_P6_F | −0.138 | 0.007 | 0.110966 | 0.045918 | 952 |
| GSTM2_P109_R | 0.601 | −0.078 | 0.111643 | 0.04615 | 953 |
| BMPR1A_E88_F | −0.134 | 0.024 | 0.112336 | 0.046388 | 954 |
| BCR_P346_F | 0.274 | −0.061 | 0.112923 | 0.046582 | 955 |
| NEFL_E23_R | −0.388 | 0.078 | 0.113224 | 0.046648 | 956 |
| LRRC32_P865_R | −0.415 | 0.018 | 0.113378 | 0.046648 | 957 |
| FANCA_P1006_R | 0.115 | −0.013 | 0.11344 | 0.046648 | 958 |
| TRIP6_P1274_R | −0.294 | 0.073 | 0.115795 | 0.047567 | 959 |
| PLXDC2_E337_F | −0.311 | 0.013 | 0.116116 | 0.047622 | 960 |
| PRDM2_P1340_R | −0.145 | 0.009 | 0.11617 | 0.047622 | 961 |
| IL13_E75_R | −0.151 | 0.007 | 0.117271 | 0.047971 | 962 |
| USP29_E274_F | 0.257 | −0.016 | 0.117359 | 0.047971 | 963 |
| TDG_E129_F | −0.136 | 0.020 | 0.117387 | 0.047971 | 964 |
| IGFBP2_P306_F | 0.543 | −0.075 | 0.117787 | 0.048085 | 965 |
| TMEFF2_E94_R | −0.175 | 0.020 | 0.119139 | 0.048586 | 966 |
| SPP1_P647_F | −0.305 | 0.053 | 0.119587 | 0.048718 | 967 |
| PSCA_E359_F | −0.285 | 0.064 | 0.120323 | 0.048967 | 968 |
| COL1A2_E299_F | 0.680 | −0.104 | 0.122839 | 0.04994 | 969 |

*Negative coefficient indicates decreased methylation in tumor relative to non-tumor pleur;
**Delta average beta non-tumor pleura less tumor

SUPPLEMENTAL TABLE 2
Locus-by-locus analysis of CpG methyaltion in
tumors from asbestos exposed versus unexposed mesothelioma patients

| | Regression | | | |
|---|---|---|---|---|
| Label | coefficient* | P-value | Q-value | RANK |
| CASP10_E139_F | 0.232 | 0.000 | 0.011 | 1 |
| TDGF1_P428_R | 0.190 | 0.000 | 0.038 | 2 |
| DES_E228_R | 0.254 | 0.000 | 0.038 | 3 |
| BSG_P211_R | 0.449 | 0.000 | 0.061 | 4 |
| GP1BB_P278_R | 0.276 | 0.000 | 0.064 | 5 |
| FZD9_E458_F | 0.276 | 0.000 | 0.064 | 6 |
| SHB_P691_R | 0.284 | 0.001 | 0.072 | 7 |
| ASCL2_P609_R | 0.266 | 0.001 | 0.072 | 8 |
| PAX6_P50_R | 0.408 | 0.001 | 0.077 | 9 |
| GP1BB_E23_F | 0.291 | 0.001 | 0.086 | 10 |
| IGF2AS_E4_F | 0.217 | 0.001 | 0.086 | 11 |
| CD40_P372_R | 0.306 | 0.001 | 0.104 | 12 |
| ALOX12_E85_R | 0.271 | 0.002 | 0.104 | 13 |
| ASCL2_P360_F | 0.257 | 0.002 | 0.104 | 14 |
| ALOX12_P223_R | 0.251 | 0.002 | 0.104 | 15 |
| ID1_P659_R | 0.092 | 0.002 | 0.104 | 16 |
| HOXA9_E252_R | 0.290 | 0.002 | 0.104 | 17 |
| DLC1_E276_F | 0.251 | 0.002 | 0.108 | 18 |
| PTPN6_P282_R | 0.195 | 0.002 | 0.108 | 19 |
| IRF5_E101_F | 0.166 | 0.002 | 0.117 | 20 |
| AATK_P519_R | 0.167 | 0.003 | 0.132 | 21 |
| VAMP8_E7_F | 0.154 | 0.003 | 0.132 | 22 |
| EPO_E244_R | 0.360 | 0.003 | 0.132 | 23 |
| CHGA_E52_F | 0.278 | 0.003 | 0.132 | 24 |
| PENK_E26_F | 0.233 | 0.003 | 0.132 | 25 |
| TAL1_E122_F | 0.255 | 0.003 | 0.132 | 26 |
| JAK3_E64_F | 0.313 | 0.004 | 0.133 | 27 |
| IGF2AS_P203_F | 0.218 | 0.004 | 0.137 | 28 |
| TAL1_P817_F | 0.183 | 0.005 | 0.161 | 29 |
| HOXA11_P698_F | 0.238 | 0.005 | 0.161 | 30 |
| CDKN1C_P626_F | 0.273 | 0.005 | 0.161 | 31 |
| EPM2A_P64_R | 0.048 | 0.006 | 0.175 | 32 |
| VAMP8_P114_F | 0.215 | 0.006 | 0.175 | 33 |
| HOXB2_P99_F | 0.178 | 0.006 | 0.175 | 34 |
| PAX6_P1121_F | 0.214 | 0.006 | 0.175 | 35 |
| PYCARD_P150_F | 0.117 | 0.007 | 0.179 | 36 |
| SLC5A8_P38_R | 0.259 | 0.007 | 0.179 | 37 |
| ASCL2_E76_R | 0.200 | 0.007 | 0.179 | 38 |
| ABL1_P53_F | 0.133 | 0.007 | 0.179 | 39 |
| CD81_P272_R | 0.158 | 0.007 | 0.179 | 40 |
| PAX6_E129_F | 0.332 | 0.007 | 0.179 | 41 |
| TAL1_P594_F | 0.242 | 0.008 | 0.199 | 42 |
| NOS3_P38_F | 0.138 | 0.009 | 0.200 | 43 |
| SLC5A8_E60_R | 0.206 | 0.009 | 0.200 | 44 |
| SOX17_P303_F | 0.237 | 0.010 | 0.200 | 45 |
| DIO3_E230_R | 0.152 | 0.010 | 0.200 | 46 |
| TNFSF10_P2_R | 0.304 | 0.010 | 0.200 | 47 |
| HOXA11_E35_F | 0.237 | 0.010 | 0.200 | 48 |
| ZIM2_P22_F | 0.128 | 0.010 | 0.200 | 49 |
| AATK_P709_R | 0.173 | 0.010 | 0.200 | 50 |
| SEMA3F_P692_R | 0.114 | 0.010 | 0.200 | 51 |
| HS3ST2_E145_R | 0.213 | 0.011 | 0.200 | 52 |
| MYBL2_P354_F | 0.290 | 0.011 | 0.200 | 53 |
| CYP1B1_E83_R | 0.292 | 0.011 | 0.200 | 54 |
| LMO2_E148_F | 0.159 | 0.011 | 0.200 | 55 |
| E2F3_P840_R | 0.079 | 0.011 | 0.200 | 56 |
| CDKN2A_E121_R | 0.130 | 0.011 | 0.200 | 57 |
| SOX17_P287_R | 0.210 | 0.012 | 0.200 | 58 |
| SOX1_P1018_R | 0.296 | 0.012 | 0.200 | 59 |
| SCGB3A1_E55_R | 0.234 | 0.012 | 0.204 | 60 |
| MYLK_E132_R | 0.230 | 0.013 | 0.215 | 61 |
| SFTPB_P689_R | −0.074 | 0.013 | 0.215 | 62 |
| ASCL1_P747_F | 0.176 | 0.014 | 0.215 | 63 |
| MEST_P4_F | 0.241 | 0.014 | 0.215 | 64 |
| IRAK3_P185_F | 0.265 | 0.015 | 0.225 | 65 |
| MT1A_E13_R | 0.248 | 0.015 | 0.225 | 66 |
| CCL3_E53_R | 0.163 | 0.016 | 0.237 | 67 |
| ZNFN1A1_E102_F | 0.126 | 0.016 | 0.237 | 68 |
| CD81_P211_F | 0.182 | 0.016 | 0.237 | 69 |
| CSK_P740_R | 0.169 | 0.017 | 0.237 | 70 |
| MAPK12_E165_R | 0.132 | 0.017 | 0.237 | 71 |
| LIMK1_P709_R | 0.170 | 0.017 | 0.237 | 72 |
| CDKN2B_E220_F | 0.112 | 0.018 | 0.241 | 73 |
| TIMP3_P690_R | −0.059 | 0.018 | 0.241 | 74 |
| MMP9_P189_F | 0.127 | 0.018 | 0.243 | 75 |
| TSP50_P137_F | 0.196 | 0.019 | 0.243 | 76 |
| CHI3L2_P226_F | 0.135 | 0.019 | 0.243 | 77 |
| MBD2_P233_F | 0.102 | 0.019 | 0.243 | 78 |
| THY1_P20_R | 0.191 | 0.019 | 0.246 | 79 |
| ACVR1_E328_R | −0.193 | 0.020 | 0.255 | 80 |
| EPO_P162_R | 0.189 | 0.021 | 0.257 | 81 |
| APOC1_P406_R | 0.072 | 0.021 | 0.259 | 82 |
| MYBL2_P211_F | 0.374 | 0.022 | 0.262 | 83 |
| MSH3_E3_F | 0.174 | 0.023 | 0.269 | 84 |
| CD40_E58_R | 0.236 | 0.023 | 0.274 | 85 |
| JAK3_P156_R | 0.199 | 0.024 | 0.274 | 86 |
| EPHB6_P827_R | −0.055 | 0.025 | 0.280 | 87 |
| CASP10_P186_F | 0.170 | 0.025 | 0.280 | 88 |
| TYRO3_P366_F | 0.093 | 0.025 | 0.280 | 89 |
| ZIM2_E110_F | 0.102 | 0.026 | 0.290 | 90 |
| RASSF1_E116_F | 0.364 | 0.027 | 0.291 | 91 |
| EFNB3_E17_R | 0.068 | 0.027 | 0.291 | 92 |
| MYH11_P236_R | −0.269 | 0.027 | 0.291 | 93 |
| ZNF215_P129_R | 0.275 | 0.027 | 0.291 | 94 |
| PARP1_P610_R | 0.128 | 0.028 | 0.291 | 95 |
| IGF2_P1036_R | 0.188 | 0.028 | 0.296 | 96 |
| CRIP1_P874_R | 0.110 | 0.029 | 0.297 | 97 |
| ETS2_P684_F | 0.294 | 0.029 | 0.297 | 98 |
| NPY_P295_F | 0.227 | 0.031 | 0.317 | 99 |
| HLA-DPB1_E2_R | −0.158 | 0.032 | 0.317 | 100 |
| TNFSF10_E53_F | 0.216 | 0.032 | 0.317 | 101 |
| IRF5_P123_F | 0.063 | 0.032 | 0.317 | 102 |
| IGFBP7_P297_F | 0.194 | 0.033 | 0.317 | 103 |
| TFF1_P180_R | 0.094 | 0.033 | 0.317 | 104 |
| GUCY2D_E419_R | 0.283 | 0.034 | 0.318 | 105 |
| TNFRSF10C_E109_F | 0.168 | 0.034 | 0.318 | 106 |
| FZD9_P175_F | 0.187 | 0.034 | 0.319 | 107 |
| CASP2_P192_F | 0.244 | 0.035 | 0.320 | 108 |
| ASB4_P52_R | −0.081 | 0.035 | 0.320 | 109 |
| MT1A_P49_R | 0.249 | 0.036 | 0.324 | 110 |

*Positive coefficient indicates increased methylation in asbestos exposed individuals

SUPPLEMENTAL TABLE 3
Top CpG loci for discriminating RPMM classes, (lung adenocarcinoma,
mesothelioma, non-tumor lung, and non-tumor pleura)

| GENE | CpG | AUC Value |
|---|---|---|
| RARRES1 | P57 | 1.000 |
| MLH3 | P25 | 1.000 |
| ITGA6 | P298 | 0.999 |
| IGSF4C | E65 | 0.999 |
| DSP | P36 | 0.999 |
| TRAF4 | P372 | 0.998 |
| INHA | P1144 | 0.998 |
| BCL3 | E71 | 0.998 |
| MLF1 | P97 | 0.998 |
| LAMB1 | E144 | 0.997 |
| CDK10 | E74 | 0.997 |
| ITGB1 | P451 | 0.997 |
| FER | E119 | 0.997 |
| ADAMTS12 | E52 | 0.996 |
| ABL2 | P459 | 0.996 |
| NGFB | E353 | 0.996 |
| GATA6 | P21 | 0.996 |
| ACVR1C | P115 | 0.996 |
| HPSE | P93 | 0.996 |
| EPHB4 | E476 | 0.995 |
| DHCR24 | P406 | 0.995 |
| JAG1 | P66 | 0.995 |
| HPSE | P29 | 0.994 |
| PTCH | E42 | 0.994 |
| TGFA | P558 | 0.994 |
| EPS8 | E231 | 0.994 |
| MCM2 | P260 | 0.994 |
| COL6A1 | P425 | 0.993 |
| EPHB3 | E0 | 0.993 |
| ENC1 | P484 | 0.993 |
| APP | E8 | 0.992 |
| INHA | P1189 | 0.992 |
| APP | P179 | 0.992 |
| TIMP2 | P267 | 0.991 |
| CCND1 | E280 | 0.991 |
| GSTP1 | seq | 0.991 |
| SLIT2 | E111 | 0.991 |
| FGFR2 | P460 | 0.991 |
| LIG4 | P194 | 0.990 |
| PHLDA2 | E159 | 0.990 |
| BCAM | P205 | 0.990 |
| CYP1B1 | P212 | 0.989 |
| TSG101 | P257 | 0.988 |
| THBS1 | P500 | 0.988 |
| TUBB3 | P721 | 0.988 |
| CAV1 | P130 | 0.987 |
| PLAU | P11 | 0.987 |
| FHIT | E19 | 0.986 |
| GNMT | E126 | 0.986 |
| PSIP1 | P163 | 0.986 |

SUPPLEMENTAL TABLE 4
Top sample type discriminatory CpG loci from
random forests analysis, all samples (lung adenocarcinoma,
mesothelioma, non-tumor lung, and non-tumor pleura).

| GENE | CpG | % Inc MSE* |
|---|---|---|
| TNFSF10 | P2 | 33.0 |
| CEACAM1 | P44 | 31.9 |
| DDR2 | E331 | 29.4 |
| RARRES1 | P57 | 29.4 |
| TNFSF10 | E53 | 28.5 |
| TJP2 | P518 | 27.6 |
| TNFRSF10C | P7 | 27.4 |
| CLDN4 | P1120 | 26.8 |
| BSG | P211 | 26.7 |
| PRKCDBP | P352 | 26.2 |
| TNFRSF10C | E109 | 26.0 |
| TJP2 | P330 | 25.7 |
| WNT10B | P993 | 25.5 |
| IGF2R | P396 | 24.2 |
| XRCC2 | P1077 | 24.1 |
| HDAC1 | P414 | 24.0 |
| SRC | E100 | 24.0 |
| DDIT3 | P1313 | 23.6 |
| FLJ20712 | P984 | 22.7 |
| ERBB2 | P59 | 21.0 |
| CSF3 | E242 | 20.8 |
| CSF3 | P309 | 20.5 |
| TMPRSS4 | E83 | 19.9 |
| PSCA | P135 | 19.8 |
| SPARC | P195 | 19.7 |
| SRC | P164 | 19.7 |
| IGSF4C | E65 | 18.7 |
| IFNGR1 | P307 | 18.7 |
| HCK | P858 | 18.6 |
| ERN1 | P809 | 18.5 |
| SPARC | E50 | 18.0 |
| SFTPB | P689 | 17.9 |
| COPG2 | P298 | 17.9 |
| PLA2G2A | P528 | 17.7 |
| HPSE | P93 | 17.7 |
| CSF2 | P605 | 17.4 |
| HLA-DPA1 | P28 | 17.3 |
| KIAA1804 | P689 | 17.2 |
| EYA4 | P794 | 17.1 |
| FGF2 | P229 | 17.1 |
| HTR1B | P107 | 16.8 |
| ZNF215 | P71 | 16.8 |
| IL18BP | E285 | 16.7 |
| SLC22A18 | P216 | 16.5 |
| SHB | P473 | 16.5 |
| WT1 | P853 | 16.4 |
| MAP3K1 | P7 | 16.0 |
| MAS1 | P469 | 16.0 |
| ID1 | P880 | 15.9 |
| IL1B | P582 | 15.7 |

*MSE is computed on the out-of-bag data for each tree and computed again after permuting sample type, differences are

SUPPLEMENTAL TABLE 5
Top CpG loci for discriminating RPMM classes, lung adenocarcinoma
versus mesothelioma

| GENE | CpG | AUC Value |
|---|---|---|
| ITGA6 | P298 | 1.000 |
| CDK10 | E74 | 0.998 |
| HTR1B | P107 | 0.997 |
| PTCH | E42 | 0.997 |
| INHA | P1144 | 0.997 |
| LAMB1 | E144 | 0.995 |
| IGF2R | P396 | 0.995 |
| RARRES1 | P57 | 0.995 |
| IGSF4C | E65 | 0.994 |
| APP | P179 | 0.994 |
| PCDH1 | E22 | 0.994 |
| MLH3 | P25 | 0.994 |
| ENC1 | P484 | 0.994 |
| SLIT2 | E111 | 0.993 |
| RARB | P60 | 0.992 |
| NGFB | E353 | 0.992 |
| MLF1 | P97 | 0.992 |
| DSP | P36 | 0.992 |
| ADAMTS12 | E52 | 0.992 |
| GATA6 | P21 | 0.992 |
| GSTP1 | S153 | 0.992 |
| TGFA | P558 | 0.992 |
| DHCR24 | P406 | 0.991 |
| BCAM | P205 | 0.991 |
| HPSE | P29 | 0.990 |
| ITGB1 | P451 | 0.990 |
| CPA4 | P961 | 0.990 |
| APP | E8 | 0.989 |
| WNT2B | P1185 | 0.989 |
| TGFB2 | P632 | 0.988 |
| INHA | P1189 | 0.988 |
| LIG4 | P194 | 0.988 |
| ABL2 | P459 | 0.987 |
| EPHB4 | E476 | 0.986 |
| COL18A1 | P494 | 0.985 |
| ABO | E110 | 0.985 |
| GNMT | E126 | 0.984 |
| FHIT | E19 | 0.984 |
| EPS8 | E231 | 0.984 |
| TRAF4 | P372 | 0.984 |
| SHB | P473 | 0.983 |
| EPHB3 | E0 | 0.983 |
| BCL3 | E71 | 0.982 |
| CYP1B1 | P212 | 0.980 |
| PLAU | P11 | 0.980 |
| TNFRSF10B | E198 | 0.980 |
| HPSE | P93 | 0.980 |
| JAG1 | P66 | 0.979 |
| ACVR1C | P115 | 0.978 |
| KLF5 | E190 | 0.978 |

SUPPLEMENTAL TABLE 6
Top sample type discriminatory CpG loci from random forests
analysis, lung adenocarcinoma and mesothelioma

| GENE | CpG | % Inc MSE* |
|---|---|---|
| CLDN4 | P1120 | 33.7 |
| TJP2 | P518 | 31.7 |
| TMPRSS4 | E83 | 30.3 |
| DDR2 | E331 | 29.7 |
| SPARC | P195 | 29.3 |
| DDIT3 | P1313 | 28.4 |
| SFTPB | P689 | 28.3 |
| CEACAM1 | P44 | 27.5 |
| TNFRSF10C | P7 | 27.1 |
| WEE1 | P924 | 26.9 |
| SRC | E100 | 26.3 |
| XRCC2 | P1077 | 25.5 |
| TNFRSF10C | E109 | 25.3 |
| SRC | P164 | 25.2 |
| BSG | P211 | 24.7 |
| PSCA | P135 | 23.6 |
| CSF3 | P309 | 23.5 |
| WT1 | E32 | 22.7 |
| TJP2 | P330 | 21.9 |
| WT1 | P853 | 21.5 |
| FGF2 | P229 | 21.3 |
| IGF2R | P396 | 21.0 |
| SPARC | E50 | 20.3 |
| TNFSF10 | E53 | 19.6 |
| FLJ20712 | P984 | 19.0 |
| TNFSF10 | P2 | 18.9 |
| SPDEF | E116 | 17.8 |
| PTCH | E42 | 17.4 |
| MAS1 | P469 | 17.1 |
| HTR1B | P107 | 16.7 |
| HGF | P1293 | 16.6 |
| MT1A | P600 | 16.6 |
| HTR1B | P222 | 16.2 |
| HIC-1 | S103 | 16.2 |
| EPHA5 | E158 | 16.2 |
| TMPRSS4 | P552 | 16.1 |
| ASB4 | E89 | 16.0 |
| PAX6 | P1121 | 16.0 |
| FES | E34 | 15.7 |
| CDK10 | E74 | 15.3 |
| CSF2 | P605 | 15.3 |
| GNMT | E126 | 15.2 |
| TGFBI | P173 | 15.1 |
| ABO | E110 | 14.9 |
| PRKCDBP | P352 | 14.8 |
| CPA4 | P961 | 14.6 |
| SMO | E57 | 14.6 |
| HPSE | P29 | 14.6 |
| DHCR24 | P406 | 14.6 |
| PLAT | P80 | 14.5 |

*MSE is computed on the out-of-bag data for each tree and computed again after permuting sample type, differences are

SUPPLEMENTAL TABLE 7
CpG loci with differential methylation between lung adenocarcinoma
and mesothelioma (Q - value ranked)
Higher methylation in: lung adenocarcinoma, mesothelioma

| | Regression | | | |
|---|---|---|---|---|
| GENE_CpG | coefficient | P-value | Q-value | Rank |
| ABL2_P459_R | −1.23 | 0 | 0 | 1 |
| ABO_E110_F | −1.11 | 0 | 0 | 2 |
| ABO_P312_F | −0.87 | 0 | 0 | 3 |
| ACVR2B_E27_R | −0.65 | 0 | 0 | 4 |
| ADAMTS12_E52_R | −1.74 | 0 | 0 | 5 |
| ADAMTS12_P250_R | −1.40 | 0 | 0 | 6 |
| AGTR1_P154_F | −1.83 | 0 | 0 | 7 |
| AGTR1_P41_F | −1.92 | 0 | 0 | 8 |
| AIM2_P624_F | 0.98 | 0 | 0 | 9 |
| ALK_E183_R | −0.81 | 0 | 0 | 10 |
| APC_E117_R | −1.40 | 0 | 0 | 11 |
| APC_P14_F | −1.51 | 0 | 0 | 12 |
| APC_P280_R | −1.76 | 0 | 0 | 13 |
| APP_E8_F | −0.84 | 0 | 0 | 14 |
| APP_P179_R | −1.00 | 0 | 0 | 15 |
| ASB4_E89_F | 0.85 | 0 | 0 | 16 |
| ASB4_P391_F | 0.96 | 0 | 0 | 17 |
| BCAM_E100_R | −0.57 | 0 | 0 | 18 |
| BCAM_P205_F | −1.18 | 0 | 0 | 19 |
| BCL2L2_E172_F | −0.64 | 0 | 0 | 20 |
| BCL3_E71_F | −0.91 | 0 | 0 | 21 |
| BCL3_P1038_R | −0.29 | 0 | 0 | 22 |
| BMP2_E48_R | −0.65 | 0 | 0 | 23 |
| BMP3_P56_R | −0.49 | 0 | 0 | 24 |
| BMP4_P123_R | −1.20 | 0 | 0 | 25 |
| CARD15_P302_R | −1.02 | 0 | 0 | 26 |
| CD34_E20_R | −0.61 | 0 | 0 | 27 |
| CD9_E14_R | −0.76 | 0 | 0 | 28 |
| CDH1_P52_R | −0.73 | 0 | 0 | 29 |
| CDH11_P203_R | −1.08 | 0 | 0 | 30 |
| CDH11_P354_R | −0.74 | 0 | 0 | 31 |
| CDH13_E102_F | −1.34 | 0 | 0 | 32 |
| CDH13_P88_F | −1.49 | 0 | 0 | 33 |
| CDH17_E31_F | 1.00 | 0 | 0 | 34 |
| CDH3_P87_R | 0.77 | 0 | 0 | 35 |
| CDK10_E74_F | −0.89 | 0 | 0 | 36 |
| CEACAM1_P44_R | 1.81 | 0 | 0 | 37 |
| CHD2_P451_F | 0.63 | 0 | 0 | 38 |
| CHD2_P667_F | 0.61 | 0 | 0 | 39 |
| CLDN4_P1120_R | 1.74 | 0 | 0 | 40 |
| COL18A1_P494_R | −1.50 | 0 | 0 | 41 |
| COL1A1_P117_R | −1.16 | 0 | 0 | 42 |
| COL1A1_P5_F | −1.44 | 0 | 0 | 43 |
| COL6A1_P283_F | −0.43 | 0 | 0 | 44 |
| COPG2_P298_F | 0.96 | 0 | 0 | 45 |
| CPA4_P961_R | 1.04 | 0 | 0 | 46 |
| CRIP1_P874_R | −1.02 | 0 | 0 | 47 |
| CSF2_E248_R | 0.92 | 0 | 0 | 48 |
| CSF2_P605_F | 1.23 | 0 | 0 | 49 |
| CSF3_E242_R | 0.71 | 0 | 0 | 50 |
| CSF3_P309_R | 1.48 | 0 | 0 | 51 |
| CTNNA1_P382_R | −0.69 | 0 | 0 | 52 |
| CTSH_E157_R | 0.77 | 0 | 0 | 53 |
| CYP1B1_P212_F | −0.87 | 0 | 0 | 54 |
| DAB2_P35_F | −1.10 | 0 | 0 | 55 |
| DAPK1_E46_R | −0.57 | 0 | 0 | 56 |
| DAPK1_P10_F | −0.86 | 0 | 0 | 57 |
| DAPK1_P345_R | −0.97 | 0 | 0 | 58 |
| DBC1_E204_F | −1.15 | 0 | 0 | 59 |
| DDIT3_P1313_R | 1.91 | 0 | 0 | 60 |
| DDR2_E331_F | −1.60 | 0 | 0 | 61 |
| DDR2_P743_R | −1.31 | 0 | 0 | 62 |
| DIO3_P90_F | −1.11 | 0 | 0 | 63 |
| DLC1_P88_R | 1.02 | 0 | 0 | 64 |
| DLK1_E227_R | −1.31 | 0 | 0 | 65 |
| EFNA1_P7_F | −0.44 | 0 | 0 | 66 |
| EGFR_E295_R | −0.63 | 0 | 0 | 67 |
| ENC1_P484_R | −0.58 | 0 | 0 | 68 |
| EPHA5_E158_R | −1.46 | 0 | 0 | 69 |
| EPHA5_P66_F | −0.91 | 0 | 0 | 70 |
| EPHA7_E6_F | −1.08 | 0 | 0 | 71 |
| EPHA7_P205_R | −0.98 | 0 | 0 | 72 |
| EPHB1_E202_R | −0.71 | 0 | 0 | 73 |
| EPHB3_E0_F | −0.98 | 0 | 0 | 74 |
| EPHB4_E476_R | −1.37 | 0 | 0 | 75 |
| EPHB6_E342_F | −1.36 | 0 | 0 | 76 |
| EPO_P162_R | −1.11 | 0 | 0 | 77 |
| EPS8_E231_F | −0.80 | 0 | 0 | 78 |
| EPS8_P437_F | −0.72 | 0 | 0 | 79 |
| ERBB4_P541_F | −0.91 | 0 | 0 | 80 |
| ERCC1_P354_F | −0.55 | 0 | 0 | 81 |
| ERCC6_P698_R | −1.11 | 0 | 0 | 82 |
| FANCG_E207_R | −0.70 | 0 | 0 | 83 |
| FAT_P279_R | −0.79 | 0 | 0 | 84 |
| FER_E119_F | −1.26 | 0 | 0 | 85 |
| FES_E34_R | −1.40 | 0 | 0 | 86 |
| FES_P223_R | −1.17 | 0 | 0 | 87 |
| FGF12_E61_R | −0.89 | 0 | 0 | 88 |
| FGF2_P229_F | −1.74 | 0 | 0 | 89 |
| FGF5_E16_F | −1.02 | 0 | 0 | 90 |
| FGFR1_P204_F | −1.16 | 0 | 0 | 91 |
| FGFR2_P266_R | −0.69 | 0 | 0 | 92 |
| FGFR4_P610_F | 0.66 | 0 | 0 | 93 |
| FHIT_E19_R | −0.57 | 0 | 0 | 94 |
| FLI1_E29_F | −1.27 | 0 | 0 | 95 |
| FLJ20712_P984_R | 1.27 | 0 | 0 | 96 |
| FOLR1_E368_R | 1.07 | 0 | 0 | 97 |
| FRZB_E186_R | −1.60 | 0 | 0 | 98 |
| GALR1_E52_F | −1.52 | 0 | 0 | 99 |
| GALR1_P80_F | −1.33 | 0 | 0 | 100 |
| GAS7_E148_F | −1.89 | 0 | 0 | 101 |
| GFAP_P1214_F | 0.59 | 0 | 0 | 102 |
| GNG7_E310_R | 0.54 | 0 | 0 | 103 |
| GNG7_P903_F | 0.58 | 0 | 0 | 104 |
| GNMT_E126_F | −0.90 | 0 | 0 | 105 |
| GRB10_E85_R | −0.68 | 0 | 0 | 106 |
| GSTP1_seq_38_S153_R | −0.67 | 0 | 0 | 107 |
| H19_P1411_R | 0.98 | 0 | 0 | 108 |
| HDAC1_P414_R | 1.38 | 0 | 0 | 109 |
| HGF_E102_R | −1.37 | 0 | 0 | 110 |
| HIC1_P565_R | −0.99 | 0 | 0 | 111 |
| HIC-1_seq_48_S103_R | 1.49 | 0 | 0 | 112 |
| HLA-DOA_P191_R | −1.06 | 0 | 0 | 113 |
| HLA-DPA1_P28_R | 1.48 | 0 | 0 | 114 |
| HOXB13_P17_R | −1.48 | 0 | 0 | 115 |
| HSPA2_P162_R | 0.80 | 0 | 0 | 116 |
| HTR1B_P107_F | −1.64 | 0 | 0 | 117 |
| HTR1B_P222_F | −2.03 | 0 | 0 | 118 |
| HTR2A_P853_F | −1.98 | 0 | 0 | 119 |
| IFNGR1_P307_F | 0.66 | 0 | 0 | 120 |
| IGF1_P933_F | 0.84 | 0 | 0 | 121 |
| IGF1R_P325_R | −0.46 | 0 | 0 | 122 |
| IGF2R_P396_R | −1.09 | 0 | 0 | 123 |
| IGFBP5_E144_F | −0.80 | 0 | 0 | 124 |
| IGSF4C_E65_F | −1.36 | 0 | 0 | 125 |
| IL18BP_E285_F | 0.88 | 0 | 0 | 126 |
| IL1B_P829_F | 0.89 | 0 | 0 | 127 |
| INHA_P1144_R | −0.92 | 0 | 0 | 128 |
| INHA_P1189_F | −0.77 | 0 | 0 | 129 |
| ISL1_E87_R | −1.29 | 0 | 0 | 130 |
| ISL1_P554_F | −1.40 | 0 | 0 | 131 |
| ITGA2_E120_F | −0.84 | 0 | 0 | 132 |
| ITGA2_P26_R | −0.71 | 0 | 0 | 133 |
| ITGA6_P298_R | −1.41 | 0 | 0 | 134 |
| JAG2_E54_F | −0.52 | 0 | 0 | 135 |
| KRT1_P798_R | 0.68 | 0 | 0 | 136 |
| KRT13_P341_R | 0.85 | 0 | 0 | 137 |
| LAMB1_E144_R | −0.93 | 0 | 0 | 138 |
| LIG4_P194_F | −0.59 | 0 | 0 | 139 |
| LMTK2_P1034_F | 0.56 | 0 | 0 | 140 |
| LRP2_E20_F | −0.47 | 0 | 0 | 141 |
| MAF_P826_R | −1.05 | 0 | 0 | 142 |
| MAS1_P469_R | 0.88 | 0 | 0 | 143 |
| MCAM_P169_R | −0.71 | 0 | 0 | 144 |
| MCC_P196_R | 0.48 | 0 | 0 | 145 |
| MCM2_P260_F | −0.97 | 0 | 0 | 146 |
| MLH3_E72_F | 0.70 | 0 | 0 | 147 |
| MMP14_P208_R | −1.05 | 0 | 0 | 148 |
| MMP2_E21_R | −1.30 | 0 | 0 | 149 |
| MT1A_P600_F | 1.24 | 0 | 0 | 150 |
| MUSK_P308_F | 0.94 | 0 | 0 | 151 |
| NCL_P1102_F | 1.05 | 0 | 0 | 152 |
| NGFB_E353_F | −1.40 | 0 | 0 | 153 |
| NID1_P677_F | 1.31 | 0 | 0 | 154 |
| NID1_P714_R | 1.02 | 0 | 0 | 155 |
| NOS3_P38_F | 0.97 | 0 | 0 | 156 |
| NOTCH2_P312_R | −0.41 | 0 | 0 | 157 |
| NOTCH3_P198_R | −1.05 | 0 | 0 | 158 |
| NPR2_P618_F | −1.19 | 0 | 0 | 159 |
| NTRK3_E131_F | −1.93 | 0 | 0 | 160 |
| NTRK3_P636_R | −1.70 | 0 | 0 | 161 |
| NTRK3_P752_F | −1.56 | 0 | 0 | 162 |
| p16_seq_47_S85_F | −0.79 | 0 | 0 | 163 |
| PCDH1_E22_F | −0.63 | 0 | 0 | 164 |
| PDGFA_P841_R | −0.54 | 0 | 0 | 165 |
| PDGFRB_E195_R | −1.38 | 0 | 0 | 166 |
| PDGFRB_P273_F | −1.10 | 0 | 0 | 167 |
| PGR_P790_F | 0.95 | 0 | 0 | 168 |
| PI3_P1394_R | 0.85 | 0 | 0 | 169 |
| PLA2G2A_P528_F | 0.98 | 0 | 0 | 170 |
| PLAGL1_P334_F | 1.09 | 0 | 0 | 171 |
| PLAT_P80_F | −1.54 | 0 | 0 | 172 |
| PLG_E406_F | 0.80 | 0 | 0 | 173 |
| PLXDC2_P914_R | −1.02 | 0 | 0 | 174 |
| PMP22_P975_F | 1.17 | 0 | 0 | 175 |
| PRKCDBP_E206_F | −1.11 | 0 | 0 | 176 |
| PRKCDBP_P352_R | −1.47 | 0 | 0 | 177 |
| PRSS8_E134_R | 0.95 | 0 | 0 | 178 |
| PSCA_P135_F | 1.17 | 0 | 0 | 179 |
| PTCH_E42_F | −0.68 | 0 | 0 | 180 |
| PTCH2_P568_R | −1.21 | 0 | 0 | 181 |
| PTEN_P438_F | −0.51 | 0 | 0 | 182 |
| PTHLH_E251_F | 0.83 | 0 | 0 | 183 |
| PTHLH_P15_R | 0.84 | 0 | 0 | 184 |
| PTK6_E50_F | 1.09 | 0 | 0 | 185 |
| PTPRG_P476_F | −0.46 | 0 | 0 | 186 |
| RARB_E114_F | −1.70 | 0 | 0 | 187 |
| RARB_P60_F | −1.31 | 0 | 0 | 188 |
| RARRES1_P57_R | −1.30 | 0 | 0 | 189 |
| ROR2_E112_F | −0.93 | 0 | 0 | 190 |
| RUNX1T1_P103_F | −1.22 | 0 | 0 | 191 |
| S100A12_P1221_R | 0.67 | 0 | 0 | 192 |
| SEMA3C_P642_F | 1.18 | 0 | 0 | 193 |
| SEPT9_P374_F | 1.43 | 0 | 0 | 194 |
| SEPT9_P58_R | 1.20 | 0 | 0 | 195 |
| SERPINA5_E69_F | 0.59 | 0 | 0 | 196 |
| SFTPA1_E340_R | 1.16 | 0 | 0 | 197 |
| SFTPA1_P421_F | 1.01 | 0 | 0 | 198 |
| SFTPB_P689_R | 1.32 | 0 | 0 | 199 |
| SFTPC_E13_F | 1.00 | 0 | 0 | 200 |
| SFTPD_E169_F | 0.78 | 0 | 0 | 201 |
| SHH_P104_R | −1.07 | 0 | 0 | 202 |
| SLC22A18_P216_R | 0.87 | 0 | 0 | 203 |
| SLC22A2_P109_F | 0.67 | 0 | 0 | 204 |
| SLC22A3_P634_F | 0.95 | 0 | 0 | 205 |
| SLIT2_E111_R | −1.41 | 0 | 0 | 206 |
| SLIT2_P208_F | −1.35 | 0 | 0 | 207 |
| SMAD2_P708_R | −0.37 | 0 | 0 | 208 |
| SMAD4_P474_R | −0.61 | 0 | 0 | 209 |
| SMO_E57_F | −1.41 | 0 | 0 | 210 |
| SMO_P455_R | −1.60 | 0 | 0 | 211 |
| SPARC_E50_R | −1.22 | 0 | 0 | 212 |
| SPARC_P195_F | −1.90 | 0 | 0 | 213 |
| SPDEF_E116_R | 1.22 | 0 | 0 | 214 |
| SPI1_E205_F | 0.49 | 0 | 0 | 215 |
| SRC_E100_R | 2.00 | 0 | 0 | 216 |
| SRC_P164_F | 1.17 | 0 | 0 | 217 |
| SRC_P297_F | 0.83 | 0 | 0 | 218 |
| STAT5A_E42_F | −1.36 | 0 | 0 | 219 |
| STK11_P295_R | −0.88 | 0 | 0 | 220 |
| TGFA_P558_F | −0.76 | 0 | 0 | 221 |
| TGFB2_P632_F | −0.59 | 0 | 0 | 222 |
| TGFBI_P173_F | −0.91 | 0 | 0 | 223 |
| TGFBR3_E188_R | −0.62 | 0 | 0 | 224 |
| THPO_E483_F | 0.94 | 0 | 0 | 225 |
| THPO_P585_R | 0.82 | 0 | 0 | 226 |
| THY1_P20_R | −1.07 | 0 | 0 | 227 |
| TIAM1_P117_F | −1.21 | 0 | 0 | 228 |
| TIMP2_E394_R | −0.46 | 0 | 0 | 229 |
| TIMP2_P267_F | −1.46 | 0 | 0 | 230 |
| TIMP3_seq_7_S38_{—} | −1.24 | 0 | 0 | 231 |
| TJP2_P330_R | −2.76 | 0 | 0 | 232 |
| TJP2_P518_F | −2.46 | 0 | 0 | 233 |
| TMEFF1_E180_R | −0.46 | 0 | 0 | 234 |
| TMPRSS4_E83_F | 2.02 | 0 | 0 | 235 |
| TMPRSS4_P552_F | 1.09 | 0 | 0 | 236 |
| TNF_P1084_F | 0.70 | 0 | 0 | 237 |
| TNFRSF10C_E109_I | 2.01 | 0 | 0 | 238 |
| TNFRSF10C_P7_F | 2.11 | 0 | 0 | 239 |
| TNFSF10_E53_F | 2.56 | 0 | 0 | 240 |
| TNFSF10_P2_R | 1.85 | 0 | 0 | 241 |
| TPEF_seq_44_S36_{—} | −1.13 | 0 | 0 | 242 |
| TRPM5_P979_F | 0.93 | 0 | 0 | 243 |
| TSG101_P257_R | −0.83 | 0 | 0 | 244 |
| TUBB3_P364_F | −0.63 | 0 | 0 | 245 |
| TUBB3_P721_R | −0.96 | 0 | 0 | 246 |
| TWIST1_E117_R | −2.42 | 0 | 0 | 247 |
| UGT1A1_P564_R | 0.66 | 0 | 0 | 248 |
| USP29_E274_F | 1.10 | 0 | 0 | 249 |
| USP29_P205_R | 0.63 | 0 | 0 | 250 |
| WEE1_P924_R | 1.32 | 0 | 0 | 251 |
| WNT2B_P1185_R | −0.90 | 0 | 0 | 252 |
| WNT5A_E43_F | −0.68 | 0 | 0 | 253 |
| WNT8B_E487_F | 0.93 | 0 | 0 | 254 |
| WT1_E32_F | −2.17 | 0 | 0 | 255 |
| WT1_P853_F | −2.42 | 0 | 0 | 256 |
| XRCC2_P1077_F | 1.51 | 0 | 0 | 257 |
| YES1_P600_F | −0.50 | 0 | 0 | 258 |
| ASB4_P52_R | 1.22 | 0 | 0 | 259 |
| BMPR2_E435_F | 0.61 | 0 | 0 | 260 |
| CDH17_P376_F | 0.85 | 0 | 0 | 261 |
| DCC_P471_R | −1.13 | 0 | 0 | 262 |
| EDN1_E50_R | 1.30 | 0 | 0 | 263 |
| FLI1_P620_R | −1.04 | 0 | 0 | 264 |
| GLI2_P295_F | 0.91 | 0 | 0 | 265 |
| HGF_P1293_R | 1.00 | 0 | 0 | 266 |
| MFAP4_P197_F | −1.00 | 0 | 0 | 267 |
| NRG1_P558_R | −0.79 | 0 | 0 | 268 |
| TGFBI_P31_R | −0.56 | 0 | 0 | 269 |
| TPEF_seq_44_S88_{—} | −1.44 | 0 | 0 | 270 |
| TRAF4_P372_F | −0.92 | 0 | 0 | 271 |
| FGF5_P238_R | −1.18 | 0 | 0 | 272 |
| IFNG_E293_F | 0.85 | 0 | 0 | 273 |
| SLC22A3_P528_F | 0.83 | 0 | 0 | 274 |
| CASP6_P201_F | −0.79 | 0 | 0 | 275 |
| DHCR24_P406_R | −0.87 | 0 | 0 | 276 |
| CDH1_P45_F | −0.79 | 0 | 0 | 277 |
| GADD45A_P737_R | −0.77 | 0 | 0 | 278 |
| HLA-DPA1_E35_R | 0.85 | 0 | 0 | 279 |
| ISL1_P379_F | −1.35 | 0 | 0 | 280 |
| SERPINB2_P939_F | 0.69 | 0 | 0 | 281 |
| LAMC1_P808_F | −0.48 | 0 | 0 | 282 |
| TFDP1_P543_R | 0.49 | 0 | 0 | 283 |
| EIF2AK2_E103_R | −0.68 | 0 | 0 | 284 |
| PKD2_P287_R | −0.55 | 0 | 0 | 285 |
| ABCA1_E120_R | −0.42 | 0 | 0 | 286 |
| ACTG2_P455_R | 0.57 | 0 | 0 | 287 |
| NOS2A_E117_R | 0.72 | 0 | 0 | 288 |
| HPN_P823_F | 0.64 | 0 | 0 | 289 |
| IGF2_E134_R | −1.11 | 0 | 0 | 290 |
| SMARCA3_P109_R | −0.90 | 0 | 0 | 291 |
| ITGB1_P451_F | −0.89 | 0 | 0 | 292 |
| IGSF4_P454_F | −0.65 | 0 | 0 | 293 |
| PPARG_P693_F | 0.60 | 0 | 0 | 294 |
| DAB2IP_E18_R | −0.95 | 0 | 0 | 295 |
| CASP6_P230_R | −0.67 | 0 | 0 | 296 |
| LOX_P313_R | −0.81 | 0 | 0 | 297 |
| PRSS1_E45_R | 0.72 | 0 | 0 | 298 |
| ROR2_P317_R | −0.79 | 0 | 0 | 299 |
| LAMC1_E466_R | −0.59 | 0 | 0 | 300 |
| CD81_P211_F | 1.26 | 0 | 0 | 301 |
| SLC22A18_P472_R | 0.60 | 0 | 0 | 302 |
| ITGA6_P718_R | 0.78 | 0 | 0 | 303 |
| PCGF4_P760_R | −0.99 | 0 | 0 | 304 |
| VAV1_E9_F | 1.08 | 0 | 0 | 305 |
| GJB2_P791_R | −0.96 | 0 | 0 | 306 |
| MLH3_P25_F | −1.09 | 0 | 0 | 307 |
| PHLDA2_E159_R | −0.55 | 0 | 0 | 308 |
| PLXDC2_E337_F | −1.12 | 0 | 0 | 309 |
| EGFR_P260_R | −0.67 | 0 | 0 | 310 |
| AIM2_E208_F | 0.64 | 0 | 0 | 311 |
| FLT4_E206_F | −0.74 | 0 | 0 | 312 |
| PGR_E183_R | 0.72 | 0 | 0 | 313 |
| GPX1_E46_R | −0.70 | 0 | 0 | 314 |
| JAG1_P66_F | −0.68 | 0 | 0 | 315 |
| NEFL_E23_R | −1.18 | 0 | 0 | 316 |
| PDGFRA_P1429_F | −1.31 | 0 | 0 | 317 |
| RAB32_E314_R | −0.72 | 0 | 0 | 318 |
| MAF_E77_R | −0.77 | 0 | 0 | 319 |
| NGFB_P13_F | −0.74 | 0 | 0 | 320 |
| PTGS1_P2_F | −0.71 | 0 | 0 | 321 |
| SKI_E465_R | −0.54 | 0 | 0 | 322 |
| GRB10_P496_R | 0.91 | 0 | 0 | 323 |
| TNC_P57_F | −0.67 | 0 | 0 | 324 |
| PTHLH_P757_F | 0.53 | 0 | 0 | 325 |
| TDGF1_E53_R | 0.58 | 0 | 0 | 326 |
| PLAU_P11_F | −0.75 | 0 | 0 | 327 |
| MGMT_P272_R | −1.00 | 0 | 0 | 328 |
| SEMA3F_E333_R | −0.61 | 0 | 0 | 329 |
| CTNNA1_P185_R | −0.70 | 0 | 0 | 330 |
| TNFRSF10B_E198_I | −0.70 | 0 | 0 | 331 |
| P2RX7_E323_R | −0.98 | 0 | 0 | 332 |
| TJP1_P326_R | −0.54 | 0 | 0 | 333 |
| CSF1_P217_F | 0.49 | 0 | 0 | 334 |
| COL6A1_P425_F | −0.82 | 0 | 0 | 335 |
| HOXB13_E21_F | −1.12 | 0 | 0 | 336 |
| BMP4_P199_R | −0.83 | 0 | 0 | 337 |
| SEMA3B_E96_F | −0.55 | 0 | 0 | 338 |
| RASA1_E107_F | −0.64 | 0 | 0 | 339 |
| FGFR2_P460_R | −0.83 | 0 | 0 | 340 |
| P2RX7_P119_R | −0.88 | 0 | 0 | 341 |
| PALM2-AKAP2_P42 | −0.80 | 0 | 0 | 342 |
| VEGFB_P658_F | −0.59 | 0 | 0 | 343 |
| PLG_P370_F | 0.45 | 0 | 0 | 344 |
| CAV1_P130_R | −0.72 | 0 | 0 | 345 |
| MFAP4_P10_R | −0.74 | 0 | 0 | 346 |
| TP73_P496_F | −0.66 | 0 | 0 | 347 |
| SNRPN_seq_18_S9 | 0.66 | 0 | 0 | 348 |
| FGF9_P862_R | −0.48 | 0 | 0 | 349 |
| CTSH_P238_F | −0.53 | 0 | 0 | 350 |
| THBS2_P605_R | 1.13 | 0 | 0 | 351 |
| DMP1_E194_F | 0.54 | 0 | 0 | 352 |
| NTRK2_P10_F | −1.48 | 0 | 0 | 353 |
| INSR_E97_F | −0.57 | 0 | 0 | 354 |
| CCKAR_P270_F | 0.60 | 0 | 0 | 355 |
| CAV1_P169_F | −0.60 | 0 | 0 | 356 |
| CSPG2_E38_F | −1.11 | 0 | 0 | 357 |
| TGFA_P642_R | −0.53 | 0 | 0 | 358 |
| PLAGL1_P236_R | 0.63 | 0 | 0 | 359 |
| PCGF4_P92_R | −0.88 | 0 | 0 | 360 |
| TWIST1_P44_R | −1.32 | 0 | 0 | 361 |
| ID1_P880_F | −0.61 | 0 | 0 | 362 |
| TFPI2_P9_F | −0.83 | 0 | 0 | 363 |
| GDF10_E39_F | −0.67 | 0 | 0 | 364 |
| MALT1_P406_R | −0.74 | 0 | 0 | 365 |
| NKX3-1_P146_F | −0.43 | 0 | 0 | 366 |
| MAS1_P657_R | 0.64 | 0 | 0 | 367 |
| APBA2_P305_R | 0.65 | 0 | 0 | 368 |
| TUSC3_E29_R | −0.95 | 0 | 0 | 369 |
| CXCL9_E268_R | 0.73 | 0 | 0 | 370 |
| MME_P388_F | −1.08 | 0 | 0 | 371 |
| HDAC11_P556_F | −0.28 | 0 | 0 | 372 |
| OAT_P465_F | −0.93 | 0 | 0 | 373 |
| IL2_P607_R | 0.59 | 0 | 0 | 374 |
| WNT2_P217_F | −0.86 | 0 | 0 | 375 |
| DSG1_P159_R | 0.61 | 0 | 0 | 376 |
| MLF1_P97_F | −1.35 | 0 | 0 | 377 |
| ITGB4_E144_F | −0.57 | 0 | 0 | 378 |
| HOXA5_E187_F | −1.15 | 0 | 0 | 379 |
| GABRB3_E42_F | −1.16 | 0 | 0 | 380 |
| DMP1_P134_F | 0.59 | 0 | 0 | 381 |
| MAP2K6_E297_F | −0.90 | 0 | 0 | 382 |
| PTPNS1_P301_R | −0.52 | 0 | 0 | 383 |
| ABCC5_P444_F | −0.39 | 0 | 0 | 384 |
| PSIP1_P163_R | −0.85 | 0 | 0 | 385 |
| TYRO3_P366_F | −0.56 | 0 | 0 | 386 |
| NRAS_P103_R | −0.49 | 0 | 0 | 387 |
| RUNX1T1_E145_R | −0.92 | 0 | 0 | 388 |
| SPP1_P647_F | 0.76 | 0 | 0 | 389 |
| KLK11_P103_R | 0.64 | 0 | 0 | 390 |
| WNT5A_P655_F | −0.51 | 0 | 0 | 391 |
| KDR_E79_F | −0.66 | 0 | 0 | 392 |
| SLC14A1_E295_F | 0.69 | 0 | 0 | 393 |
| PTK7_E317_F | −0.81 | 0 | 0 | 394 |
| EPHA3_E156_R | −0.78 | 0 | 0 | 395 |
| TEK_P479_R | −0.73 | 0 | 0 | 396 |
| BLK_P14_F | 0.60 | 0 | 0 | 397 |
| RARRES1_E235_F | −1.18 | 0 | 0 | 398 |
| EFNB3_P442_R | −0.55 | 0 | 0 | 399 |
| TGFB1_P833_R | 0.64 | 0 | 0 | 400 |
| MEST_P62_R | 1.26 | 0 | 0 | 401 |
| TNFRSF10D_P70_F | 1.78 | 0 | 0 | 402 |
| NAT2_P11_F | 0.59 | 0 | 0 | 403 |
| SPI1_P48_F | 0.83 | 0 | 0 | 404 |
| CSPG2_P82_R | −0.91 | 0 | 0 | 405 |
| KLF5_P13_F | −0.57 | 0 | 0 | 406 |
| PDE1B_E141_F | −0.40 | 0 | 0 | 407 |
| GLI3_P453_R | −0.67 | 0 | 0 | 408 |
| VAMP8_E7_F | −0.62 | 0 | 0 | 409 |
| DSP_P36_F | −1.04 | 0 | 0 | 410 |
| TYK2_P494_F | −0.58 | 0 | 0 | 411 |
| FLT3_P302_F | −1.15 | 0 | 0 | 412 |
| SFRP1_E398_R | −1.05 | 0 | 0 | 413 |
| DAB2IP_P9_F | −0.76 | 0 | 0 | 414 |
| GML_P281_R | 0.99 | 0 | 0 | 415 |
| LMO2_P794_R | −1.18 | 0 | 0 | 416 |
| CTGF_E156_F | −0.51 | 0 | 0 | 417 |
| KDR_P445_R | −1.05 | 0 | 0 | 418 |
| AHR_E103_F | −0.29 | 0 | 0 | 419 |
| ABCG2_P178_R | −0.56 | 0 | 0 | 420 |
| CD81_P272_R | 0.77 | 0 | 0 | 421 |
| HPSE_P29_F | −0.85 | 0 | 0 | 422 |
| PDGFB_E25_R | −0.48 | 0 | 0 | 423 |
| CCR5_P630_R | −0.54 | 0 | 0 | 424 |
| PKD2_P336_R | −0.50 | 0 | 0 | 425 |
| CCND3_P435_F | −0.50 | 0 | 0 | 426 |
| HDAC5_E298_F | −0.46 | 0 | 0 | 427 |
| NDN_P1110_F | 0.65 | 0 | 0 | 428 |
| GATA6_P21_R | −0.87 | 0 | 0 | 429 |
| IL1B_P582_R | −1.01 | 0 | 0 | 430 |
| TRIP6_P1090_F | −0.88 | 0 | 0 | 431 |
| BSG_P211_R | 2.78 | 0 | 0 | 432 |
| JUNB_P1149_R | −0.38 | 0 | 0 | 433 |
| IGFBP6_P328_R | −0.63 | 0 | 0 | 434 |
| GAS1_P754_R | −1.08 | 0 | 0 | 435 |
| EFNB3_E17_R | −0.36 | 0 | 0 | 436 |
| IL18BP_P51_R | 0.68 | 0 | 0 | 437 |
| MAP3K1_P7_F | 1.53 | 0 | 0 | 438 |
| CD1A_P414_R | 0.64 | 0 | 0 | 439 |
| PDGFRB_P343_F | −0.99 | 0 | 0 | 440 |
| CD34_P339_R | 0.55 | 0 | 0 | 441 |
| CDKN1C_P6_R | −0.67 | 0 | 0 | 442 |
| SMARCA3_P17_R | −0.69 | 0 | 0 | 443 |
| BCR_P422_F | 0.65 | 0 | 0 | 444 |
| NTSR1_P318_F | −1.13 | 0 | 0 | 445 |
| SEMA3F_P692_R | −0.51 | 0 | 0 | 446 |
| MYCN_E77_R | −0.79 | 0 | 0 | 447 |
| GFAP_P56_R | 0.67 | 0 | 0 | 448 |
| MCM6_E136_F | −0.56 | 0 | 0 | 449 |
| PTPRH_E173_F | 0.72 | 0 | 0 | 450 |
| GAS1_E22_F | −1.01 | 0 | 0 | 451 |
| ABCC2_P88_F | 0.65 | 0 | 0 | 452 |
| TJP1_P390_F | −0.59 | 0 | 0 | 453 |
| CDH11_E102_R | −0.43 | 0 | 0 | 454 |
| BCL2A1_P1127_R | 0.69 | 0 | 0 | 455 |
| CD9_P504_F | 1.17 | 0 | 0 | 456 |
| ICAM1_P119_R | −0.87 | 0 | 0 | 457 |
| CEACAM1_E57_R | 1.48 | 0 | 0 | 458 |
| VAMP8_P241_F | 0.72 | 0 | 0 | 459 |
| YES1_P216_F | −0.73 | 0 | 0 | 460 |
| GPR116_P850_F | 0.47 | 0 | 0 | 461 |
| THBS1_P500_F | −0.60 | 0 | 0 | 462 |
| HHIP_E94_F | −0.64 | 0 | 0 | 463 |
| SEMA3B_P110_R | −0.48 | 0 | 0 | 464 |
| ADCYAP1_E163_R | −0.79 | 0 | 0 | 465 |
| CTLA4_E176_R | 0.55 | 0 | 0 | 466 |
| PTPNS1_E433_R | −0.71 | 0 | 0 | 467 |
| PRDM2_P1340_R | 0.47 | 0 | 0 | 468 |
| p16_seq_47_S188_R | −1.41 | 0 | 0 | 469 |
| HBII-13_P991_R | 0.65 | 0 | 0 | 470 |
| MLH1_P381_F | −0.91 | 0 | 0 | 471 |
| HBII-52_P659_F | 0.71 | 0 | 0 | 472 |
| KLF5_E190_R | −0.70 | 0 | 0 | 473 |
| PODXL_P1341_R | −1.12 | 0 | 0 | 474 |
| SEMA3C_E49_R | −0.63 | 0 | 0 | 475 |
| SHB_P473_R | −0.62 | 0 | 0 | 476 |
| SNCG_P98_R | −0.60 | 0 | 0 | 477 |
| LOX_P71_F | −0.59 | 0 | 0 | 478 |
| HLA-DPB1_P540_F | 0.55 | 0 | 0 | 479 |
| AOC3_P890_R | 0.60 | 0 | 0 | 480 |
| IRF5_E101_F | −0.57 | 0 | 0 | 481 |
| MCM2_P241_R | −0.46 | 0 | 0 | 482 |
| TRIM29_P261_F | −1.07 | 0 | 0 | 483 |
| HS3ST2_P546_F | −0.75 | 0 | 0 | 484 |
| PDGFB_P719_F | 0.54 | 0 | 0 | 485 |
| FVT1_P225_F | −0.60 | 0 | 0 | 486 |
| JAK3_P1075_R | 0.61 | 0 | 0 | 487 |
| MTA1_P478_F | −0.68 | 0 | 0 | 488 |
| TRPM5_E87_F | 0.59 | 0 | 0 | 489 |
| MAP3K9_E17_R | −0.90 | 0 | 0 | 490 |
| FANCA_P1006_R | 0.61 | 0 | 0 | 491 |
| AREG_E25_F | −0.33 | 0 | 0 | 492 |
| EDNRB_P709_R | 0.84 | 0 | 0 | 493 |
| WNT10B_P993_F | 1.00 | 0 | 0 | 494 |
| ZMYND10_P329_F | −0.71 | 0 | 0 | 495 |
| ARHGAP9_P260_F | 0.69 | 0 | 0 | 496 |
| NRG1_E74_F | −0.50 | 0 | 0 | 497 |
| KLK11_P1290_F | 0.49 | 0 | 0 | 498 |
| IGF2AS_E4_F | −0.62 | 0 | 0 | 499 |
| PTPRH_P255_F | 0.86 | 0 | 0 | 500 |
| SEMA3A_P343_F | −0.74 | 0 | 0 | 501 |
| PIK3R1_P307_F | 0.38 | 0 | 0 | 502 |
| EYA4_E277_F | −1.04 | 0 | 0 | 503 |
| SERPINA5_P156_F | 0.61 | 0 | 0 | 504 |
| HPN_P374_R | 0.51 | 0 | 0 | 505 |
| ABL1_P53_F | −0.50 | 0 | 0 | 506 |
| CTSL_P81_F | −0.60 | 0 | 0 | 507 |
| VIM_P343_R | −0.58 | 0 | 0 | 508 |
| SFRP1_P157_F | −1.34 | 0 | 0 | 509 |
| CCND1_E280_R | −0.57 | 0 | 0 | 510 |
| ZIM2_P22_F | −0.64 | 0 | 0 | 511 |
| CHI3L2_E10_F | −0.58 | 0 | 0 | 512 |
| HBII-52_E142_F | 0.70 | 0 | 0 | 513 |
| GATA6_P726_F | −0.78 | 0 | 0 | 514 |
| IRF5_P123_F | −0.30 | 0 | 0 | 515 |
| PPP2R1B_P268_R | −0.37 | 0 | 0 | 516 |
| ALPL_P433_F | 0.68 | 0 | 0 | 517 |
| CDK10_P199_R | 0.61 | 0 | 0 | 518 |
| MMP8_E89_R | 0.57 | 0 | 0 | 519 |
| GLI3_E148_R | 0.58 | 0 | 0 | 520 |
| TNFRSF10D_E27_F | 2.02 | 0 | 0 | 521 |
| SERPINE1_P519_F | −0.63 | 0 | 0 | 522 |
| ACTG2_P346_F | 0.57 | 0 | 0 | 523 |
| DAB2_P468_F | −0.87 | 0 | 0 | 524 |
| GRB10_P260_F | −0.62 | 0 | 0 | 525 |
| VAV2_P1182_F | 0.26 | 0 | 0 | 526 |
| SMARCA4_P362_R | −0.31 | 0 | 0 | 527 |
| MGMT_P281_F | −1.04 | 0 | 0 | 528 |
| EPHB2_E297_F | −0.57 | 0 | 0 | 529 |
| PARP1_P610_R | 0.63 | 0 | 0 | 530 |
| NEO1_P1067_F | −0.60 | 0 | 0 | 531 |
| JAG2_P264_F | −0.37 | 0 | 0 | 532 |
| FGF12_P210_R | −0.96 | 0 | 0 | 533 |
| GABRB3_P92_F | −0.57 | 0 | 0 | 534 |
| IRF7_E236_R | −0.61 | 0 | 0 | 535 |
| PYCARD_P393_F | −0.59 | 0 | 0 | 536 |
| P2RX7_P597_F | 0.79 | 0 | 0 | 537 |
| CDKN1A_E101_F | −0.45 | 0 | 0 | 538 |
| NTSR1_E109_F | −0.92 | 0 | 0 | 539 |
| MEST_P4_F | 1.10 | 0 | 0 | 540 |
| PAX6_P1121_F | 1.05 | 0 | 0 | 541 |
| PTPRO_E56_F | −1.16 | 0 | 0 | 542 |
| VAV1_P317_F | 0.65 | 0 | 0 | 543 |
| RHOH_P953_R | 0.37 | 0 | 0 | 544 |
| PTPRF_E178_R | −0.44 | 0 | 0 | 545 |
| WNT2B_P1195_F | −0.46 | 0 | 0 | 546 |
| BMP3_E147_F | −0.66 | 0 | 0 | 547 |
| SOX1_P1018_R | −1.05 | 0 | 0 | 548 |
| DST_P262_R | −0.47 | 0 | 0 | 549 |
| HLA-DPA1_P205_R | 0.82 | 0 | 0 | 550 |
| CRIP1_P274_F | −0.39 | 0 | 0 | 551 |
| LCK_E28_F | 0.47 | 0 | 0 | 552 |
| FANCF_P13_F | −0.42 | 0 | 0 | 553 |
| MLLT3_E93_R | −0.25 | 0 | 0 | 554 |
| DCC_P177_F | −0.94 | 0 | 0 | 555 |
| S100A4_P887_R | 0.42 | 0 | 0 | 556 |
| MEST_E150_F | 1.01 | 0 | 0 | 557 |
| PLXDC1_E71_F | −0.44 | 0 | 0 | 558 |
| ONECUT2_E96_F | −0.70 | 0 | 0 | 559 |
| CYP2E1_P416_F | 0.84 | 0 | 0 | 560 |
| MLF1_E243_F | −0.67 | 0 | 0 | 561 |
| ADCYAP1_P398_F | −0.95 | 0 | 0 | 562 |
| ABCC2_E16_R | 1.13 | 0 | 0 | 563 |
| PROK2_E0_F | −0.58 | 0 | 0 | 564 |
| ABCA1_P45_F | −0.49 | 0 | 0 | 565 |
| MCC_E23_R | −0.41 | 0 | 0 | 566 |
| ACVR1C_P115_R | −0.71 | 0 | 0 | 567 |
| KCNQ1_P546_R | 0.66 | 0 | 0 | 568 |
| HBII-52_P563_F | 0.63 | 0 | 0 | 569 |
| TMEFF2_P210_R | −0.79 | 0 | 0 | 570 |
| UGT1A1_P315_R | 0.48 | 0 | 0 | 571 |
| KRT13_P676_F | 0.34 | 0 | 0 | 572 |
| GPX1_P194_F | −0.81 | 0 | 0 | 573 |
| APBA1_P644_F | −0.33 | 0 | 0 | 574 |
| GML_E144_F | 1.05 | 0 | 0 | 575 |
| TNK1_P221_F | −0.57 | 0 | 0 | 576 |
| APOC1_P406_R | 0.40 | 0 | 0 | 577 |
| CCKBR_P361_R | −0.64 | 0 | 0 | 578 |
| TYRO3_P501_F | −0.43 | 0 | 0 | 579 |
| RET_seq_54_S260_F | −1.08 | 0 | 0 | 580 |
| TESK2_P252_R | −0.32 | 0 | 0 | 581 |
| SLC22A3_E122_R | −0.85 | 0 | 0 | 582 |
| MXI1_P75_R | −0.76 | 0 | 0 | 583 |
| EPHB2_P165_R | −0.72 | 0 | 0 | 584 |
| CDH17_P532_F | 0.39 | 0 | 0 | 585 |
| EFNA1_P591_R | −0.29 | 0 | 0 | 586 |
| TUSC3_P85_R | −0.70 | 0 | 0 | 587 |
| TCF4_P175_R | −0.90 | 0 | 0 | 588 |
| ERG_E28_F | −0.90 | 0 | 0 | 589 |
| ETS2_P835_F | 1.44 | 0 | 0 | 590 |
| FRZB_P406_F | −1.17 | 0 | 0 | 591 |
| FYN_P352_R | −0.55 | 0 | 0 | 592 |
| SPI1_P929_F | 0.44 | 0 | 0 | 593 |
| NFKB2_P709_R | −0.41 | 0 | 0 | 594 |
| FOSL2_E384_R | −0.56 | 0 | 0 | 595 |
| CSF1_P339_F | −0.34 | 0 | 0 | 596 |
| COL18A1_P365_R | −0.59 | 0 | 0 | 597 |
| ELL_P693_F | 0.64 | 0 | 0 | 598 |
| GAS7_P622_R | −0.76 | 0 | 0 | 599 |
| HLA-DPB1_E2_R | 0.72 | 0 | 0 | 600 |
| MMP14_P13_F | −0.70 | 0 | 0 | 601 |
| FGF6_P139_R | 0.57 | 0 | 0 | 602 |
| DNMT1_P100_R | 0.43 | 0 | 0 | 603 |
| MOS_E60_R | −1.02 | 0 | 0 | 604 |
| ZNFN1A1_E102_F | 0.55 | 0 | 0 | 605 |
| RBP1_E158_F | −0.89 | 0 | 0 | 606 |
| NOS2A_P288_R | 0.51 | 0 | 0 | 607 |
| DIO3_P674_F | −0.83 | 0 | 0 | 608 |
| GNAS_P86_F | 0.39 | 0 | 0 | 609 |
| SLC5A8_P38_R | 1.06 | 0 | 0 | 610 |
| MKRN3_P108_F | 0.61 | 0 | 0 | 611 |
| TM7SF3_P1068_R | 0.61 | 0 | 0 | 612 |
| DLL1_P832_F | −0.68 | 0 | 0 | 613 |
| HPSE_P93_F | −0.83 | 0 | 0 | 614 |
| CHFR_P501_F | −0.74 | 0 | 0 | 615 |
| RARA_P1076_R | −0.62 | 0 | 0 | 616 |
| GJB2_E43_F | −0.68 | 0 | 0 | 617 |
| SEZ6L_P299_F | −1.03 | 0 | 0 | 618 |
| MSH2_P1008_F | 0.49 | 0 | 0 | 619 |
| ETV6_E430_F | 0.41 | 0 | 0 | 620 |
| ITPR3_P1112_F | 0.22 | 0 | 0 | 621 |
| NDN_E131_R | 0.39 | 0 | 0 | 622 |
| APOC2_P377_F | 0.39 | 0 | 0 | 623 |
| FLT1_E444_F | −0.69 | 0 | 0 | 624 |
| DUSP4_P925_R | −0.55 | 0 | 0 | 625 |
| GUCY2D_P48_R | −0.66 | 0 | 0 | 626 |
| EDNRB_P148_R | 0.57 | 0 | 0 | 627 |
| KIAA1804_P689_R | 1.23 | 0 | 0 | 628 |
| AATK_E63_R | 0.63 | 0 | 0 | 629 |
| ETS1_E253_R | −0.37 | 0 | 0 | 630 |
| MPO_P883_R | −0.71 | 0 | 0 | 631 |
| TGFB2_E226_R | −0.50 | 0 | 0 | 632 |
| INS_P248_F | 0.49 | 0 | 0 | 633 |
| MME_E29_F | −0.57 | 0 | 0 | 634 |
| SMARCB1_P220_R | −0.44 | 0 | 0 | 635 |
| CTSL_P264_R | −0.55 | 0 | 0 | 636 |
| FHIT_P93_R | −0.45 | 0 | 0 | 637 |
| CD1A_P6_F | 0.63 | 0 | 0 | 638 |
| RAB32_P493_R | 0.71 | 0 | 0 | 639 |
| CRK_P721_F | 0.57 | 0 | 0 | 640 |
| JAK2_P772_R | −0.67 | 0 | 0 | 641 |
| SFN_E118_F | 0.63 | 0 | 0 | 642 |
| IL12B_P392_R | 0.65 | 0 | 0 | 643 |
| PLAUR_P82_F | −0.29 | 0 | 0 | 644 |
| ERBB4_P255_F | −0.43 | 0 | 0 | 645 |
| MMP9_P237_R | −0.59 | 0 | 0 | 646 |
| IL16_P93_R | −0.55 | 0 | 0 | 647 |
| WRN_P969_F | 0.57 | 0 | 0 | 648 |
| IFNGR2_P377_R | −0.65 | 0 | 0 | 649 |
| FGF8_P473_F | −0.75 | 0 | 0 | 650 |
| PGR_P456_R | 0.53 | 0 | 0 | 651 |
| TMEM63A_E63_F | 0.28 | 0 | 0 | 652 |
| PALM2-AKAP2_P183_R | −0.39 | 0 | 0 | 653 |
| IFNGR2_E164_F | −0.35 | 0 | 0 | 654 |
| PI3_E107_F | 0.84 | 0 | 0 | 655 |
| NTRK2_P395_R | −1.05 | 0 | 0 | 656 |
| FAS_P322_R | −0.40 | 0 | 0 | 657 |
| XRCC1_P681_R | 0.48 | 0 | 0 | 658 |
| PITX2_E24_R | −0.74 | 1.00E−06 | 0 | 659 |
| IGFBP3_E65_R | 0.53 | 1.00E−06 | 0 | 660 |
| MYCN_P464_R | −0.21 | 1.00E−06 | 0 | 661 |
| MAPK9_P1175_F | 0.46 | 1.00E−06 | 0 | 662 |
| TCF7L2_P193_R | −0.46 | 1.00E−06 | 0 | 663 |
| DDR1_E23_R | −0.40 | 1.00E−06 | 0 | 664 |
| FANCE_P356_R | 1.10 | 1.00E−06 | 0 | 665 |
| SOD3_P460_R | −0.50 | 1.00E−06 | 0 | 666 |
| SYK_P584_F | 0.55 | 1.00E−06 | 0 | 667 |
| GNMT_P197_F | −0.39 | 1.00E−06 | 0 | 668 |
| NQO1_E74_R | −0.23 | 1.00E−06 | 0 | 669 |
| MYOD1_P50_F | −0.67 | 1.00E−06 | 0 | 670 |
| FGF1_E5_F | 0.52 | 1.00E−06 | 0 | 671 |
| ERN1_P809_R | 0.70 | 1.00E−06 | 0 | 672 |
| MPL_P657_F | 0.39 | 1.00E−06 | 0 | 673 |
| NEU1_P745_F | −0.60 | 1.00E−06 | 0 | 674 |
| MDR1_seq_42_S300_R | −1.23 | 1.00E−06 | 0 | 675 |
| UGT1A1_E11_F | 0.46 | 1.00E−06 | 0 | 676 |
| NQO1_P345_R | −0.40 | 1.00E−06 | 0 | 677 |
| SEZ6L_P249_F | −1.00 | 1.00E−06 | 0 | 678 |
| FGF3_P171_R | −1.01 | 1.00E−06 | 0 | 679 |
| TP73_E155_F | −0.49 | 1.00E−06 | 0 | 680 |
| FLT1_P302_F | −0.85 | 1.00E−06 | 0 | 681 |
| TDG_E129_F | 0.37 | 1.00E−06 | 0 | 682 |
| ADCYAP1_P455_R | −0.80 | 1.00E−06 | 0 | 683 |
| PTCH2_P37_F | −0.43 | 1.00E−06 | 0 | 684 |
| IGSF4_P86_R | −0.71 | 1.00E−06 | 0 | 685 |
| MMP1_P397_R | 0.57 | 1.00E−06 | 0 | 686 |
| CD9_P585_R | 0.67 | 1.00E−06 | 0 | 687 |
| MAP3K1_E81_F | 1.12 | 1.00E−06 | 0 | 688 |
| DSC2_P407_R | 0.40 | 1.00E−06 | 0 | 689 |
| ETV1_P515_F | −0.66 | 1.00E−06 | 0 | 690 |
| TEK_E75_F | −0.67 | 1.00E−06 | 0 | 691 |
| PRSS1_P1249_R | 0.49 | 1.00E−06 | 0 | 692 |
| TMEFF2_P152_R | −0.72 | 1.00E−06 | 0 | 693 |
| EPM2A_P64_R | −0.16 | 1.00E−06 | 0 | 694 |
| IL13_E75_R | 0.37 | 1.00E−06 | 0 | 695 |
| BRCA1_P835_R | 0.58 | 1.00E−06 | 0 | 696 |
| ABCG2_P310_R | 1.38 | 1.00E−06 | 0 | 697 |
| TMEFF1_P234_F | −0.53 | 1.00E−06 | 0 | 698 |
| ZIM3_P451_R | 0.54 | 2.00E−06 | 0 | 699 |
| IHH_P246_R | −0.52 | 2.00E−06 | 0 | 700 |
| F2R_P88_F | −0.55 | 2.00E−06 | 0 | 701 |
| IGF2_P1036_R | −0.61 | 2.00E−06 | 0 | 702 |
| GDF10_P95_R | −0.68 | 2.00E−06 | 0 | 703 |
| BMPR2_P1271_F | −0.34 | 2.00E−06 | 0 | 704 |
| TNFRSF1B_E5_F | −0.31 | 2.00E−06 | 0 | 705 |
| EVI1_E47_R | 1.19 | 2.00E−06 | 0 | 706 |
| SLC22A2_E271_R | 0.44 | 2.00E−06 | 1.00E−06 | 707 |
| INS_P804_R | 0.54 | 2.00E−06 | 1.00E−06 | 708 |
| DIO3_E230_R | −0.57 | 2.00E−06 | 1.00E−06 | 709 |
| CDKN1B_P1161_F | 1.10 | 2.00E−06 | 1.00E−06 | 710 |
| DDR1_P332_R | 0.60 | 2.00E−06 | 1.00E−06 | 711 |
| TWIST1_P355_R | −0.68 | 3.00E−06 | 1.00E−06 | 712 |
| AFF3_P122_F | 0.64 | 3.00E−06 | 1.00E−06 | 713 |
| ITGB4_P517_F | −0.38 | 3.00E−06 | 1.00E−06 | 714 |
| ST6GAL1_P164_R | −0.66 | 3.00E−06 | 1.00E−06 | 715 |
| TNK1_P41_R | −0.51 | 3.00E−06 | 1.00E−06 | 716 |
| ODC1_P424_F | −0.31 | 3.00E−06 | 1.00E−06 | 717 |
| ROR1_P6_F | −0.32 | 3.00E−06 | 1.00E−06 | 718 |
| MAPK12_E165_R | −0.40 | 3.00E−06 | 1.00E−06 | 719 |
| CTNNB1_P757_F | 0.72 | 4.00E−06 | 1.00E−06 | 720 |
| IL17RB_P788_R | −0.38 | 4.00E−06 | 1.00E−06 | 721 |
| PEG10_P978_R | −0.59 | 4.00E−06 | 1.00E−06 | 722 |
| RET_seq_53_S374_{—} | −0.99 | 4.00E−06 | 1.00E−06 | 723 |
| DES_E228_R | 0.64 | 4.00E−06 | 1.00E−06 | 724 |
| THBS1_E207_R | 1.19 | 4.00E−06 | 1.00E−06 | 725 |
| IL6_E168_F | −0.53 | 4.00E−06 | 1.00E−06 | 726 |
| CD34_P780_R | 0.37 | 5.00E−06 | 1.00E−06 | 727 |
| SNRPN_P230_R | 0.36 | 5.00E−06 | 1.00E−06 | 728 |
| DCN_P1320_R | 0.62 | 5.00E−06 | 1.00E−06 | 729 |
| IGFBP7_P297_F | −0.63 | 5.00E−06 | 1.00E−06 | 730 |
| FABP3_P598_F | −0.52 | 5.00E−06 | 1.00E−06 | 731 |
| DNAJC15_E26_R | 0.52 | 6.00E−06 | 1.00E−06 | 732 |
| CSF3R_P472_F | 0.39 | 6.00E−06 | 1.00E−06 | 733 |
| CYP2E1_E53_R | 0.50 | 6.00E−06 | 1.00E−06 | 734 |
| CCNE1_P683_F | −0.19 | 6.00E−06 | 1.00E−06 | 735 |
| GPR116_E328_R | 0.56 | 6.00E−06 | 1.00E−06 | 736 |
| CCNA1_P216_F | −0.86 | 6.00E−06 | 1.00E−06 | 737 |
| NPY_E31_R | −0.61 | 6.00E−06 | 1.00E−06 | 738 |
| CPNE1_P138_F | −0.81 | 6.00E−06 | 1.00E−06 | 739 |
| FGF7_P44_F | −0.57 | 6.00E−06 | 1.00E−06 | 740 |
| GSTM2_E153_F | 0.97 | 7.00E−06 | 1.00E−06 | 741 |
| FGR_P39_F | 0.49 | 7.00E−06 | 2.00E−06 | 742 |
| FN1_P229_R | 0.43 | 7.00E−06 | 2.00E−06 | 743 |
| EXT1_E197_F | −0.39 | 7.00E−06 | 2.00E−06 | 744 |
| CTTN_E29_R | −0.44 | 7.00E−06 | 2.00E−06 | 745 |
| TBX1_P520_F | −0.45 | 7.00E−06 | 2.00E−06 | 746 |
| CSK_P740_R | −0.47 | 8.00E−06 | 2.00E−06 | 747 |
| POMC_P400_R | 0.66 | 8.00E−06 | 2.00E−06 | 748 |
| PLAT_E158_F | −0.55 | 8.00E−06 | 2.00E−06 | 749 |
| OGG1_E400_F | −0.52 | 9.00E−06 | 2.00E−06 | 750 |
| HRASLS_P353_R | 0.41 | 1.00E−05 | 2.00E−06 | 751 |
| ACVR1B_E497_R | −0.54 | 1.00E−05 | 2.00E−06 | 752 |
| TES_P182_F | 0.77 | 1.10E−05 | 2.00E−06 | 753 |
| NOTCH1_P1198_F | −0.40 | 1.10E−05 | 2.00E−06 | 754 |
| CAPG_E228_F | −0.48 | 1.10E−05 | 2.00E−06 | 755 |
| MAP3K8_P1036_F | 0.48 | 1.10E−05 | 2.00E−06 | 756 |
| TIAM1_P188_R | −0.55 | 1.10E−05 | 3.00E−06 | 757 |
| HLA-DQA2_P282_R | 0.41 | 1.30E−05 | 3.00E−06 | 758 |
| COL4A3_P545_F | −0.38 | 1.30E−05 | 3.00E−06 | 759 |
| CCND2_P887_F | −1.07 | 1.30E−05 | 3.00E−06 | 760 |
| AXL_P223_R | 0.54 | 1.50E−05 | 3.00E−06 | 761 |
| MDS1_E45_F | 0.39 | 1.50E−05 | 3.00E−06 | 762 |
| MMP9_E88_R | 0.43 | 1.50E−05 | 3.00E−06 | 763 |
| HIC1_E151_F | −0.30 | 1.50E−05 | 3.00E−06 | 764 |
| CARD15_P665_F | 0.44 | 1.50E−05 | 3.00E−06 | 765 |
| PTHR1_E36_R | 0.32 | 1.60E−05 | 3.00E−06 | 766 |
| EGF_P413_F | 0.47 | 1.60E−05 | 4.00E−06 | 767 |
| PPAT_E170_R | 0.32 | 1.60E−05 | 4.00E−06 | 768 |
| ACVR1B_P572_R | −0.52 | 1.70E−05 | 4.00E−06 | 769 |
| CD86_P3_F | −0.68 | 1.80E−05 | 4.00E−06 | 770 |
| LIF_P383_R | −0.37 | 1.90E−05 | 4.00E−06 | 771 |
| HBEGF_P32_R | −0.54 | 2.00E−05 | 4.00E−06 | 772 |
| MUC1_E18_R | 0.42 | 2.00E−05 | 4.00E−06 | 773 |
| MAGEL2_P170_R | 0.43 | 2.00E−05 | 4.00E−06 | 774 |
| HHIP_P307_R | −0.59 | 2.10E−05 | 5.00E−06 | 775 |
| TNF_P158_F | 0.56 | 2.20E−05 | 5.00E−06 | 776 |
| CFTR_P372_R | −0.57 | 2.20E−05 | 5.00E−06 | 777 |
| LTA_P214_R | 0.38 | 2.30E−05 | 5.00E−06 | 778 |
| CCL3_P543_R | −0.50 | 2.30E−05 | 5.00E−06 | 779 |
| NEFL_P209_R | −0.59 | 2.30E−05 | 5.00E−06 | 780 |
| EYA4_P794_F | 0.53 | 2.30E−05 | 5.00E−06 | 781 |
| TERT_P360_R | −0.70 | 2.30E−05 | 5.00E−06 | 782 |
| HOXA5_P1324_F | 0.54 | 2.50E−05 | 6.00E−06 | 783 |
| EIF2AK2_P313_F | 1.22 | 2.50E−05 | 6.00E−06 | 784 |
| TFF1_P180_R | 0.41 | 2.70E−05 | 6.00E−06 | 785 |
| AFF3_P808_F | 0.53 | 2.80E−05 | 6.00E−06 | 786 |
| NPR2_P1093_F | −0.53 | 2.90E−05 | 6.00E−06 | 787 |
| IGFBP6_E47_F | 0.20 | 3.00E−05 | 6.00E−06 | 788 |
| TMEFF2_E94_R | −0.49 | 3.00E−05 | 6.00E−06 | 789 |
| UGT1A7_P751_R | 0.28 | 3.20E−05 | 7.00E−06 | 790 |
| CTLA4_P1128_F | 0.31 | 3.20E−05 | 7.00E−06 | 791 |
| TBX1_P885_R | −0.77 | 3.20E−05 | 7.00E−06 | 792 |
| DNAJC15_P65_F | 0.40 | 3.60E−05 | 8.00E−06 | 793 |
| FGF3_E198_R | −0.93 | 3.70E−05 | 8.00E−06 | 794 |
| PTGS2_P308_F | −0.34 | 3.70E−05 | 8.00E−06 | 795 |
| MMP1_P460_F | 0.40 | 3.80E−05 | 8.00E−06 | 796 |
| MOS_P27_R | −0.57 | 3.90E−05 | 8.00E−06 | 797 |
| GPX3_E178_F | −0.33 | 4.20E−05 | 9.00E−06 | 798 |
| EGR4_E70_F | −0.37 | 4.30E−05 | 9.00E−06 | 799 |
| RAD54B_P227_F | −0.45 | 4.50E−05 | 9.00E−06 | 800 |
| USP29_P282_R | 0.24 | 4.50E−05 | 9.00E−06 | 801 |
| IL8_P83_F | −0.48 | 4.70E−05 | 1.00E−05 | 802 |
| SYK_E372_F | 0.95 | 4.90E−05 | 1.00E−05 | 803 |
| CASP8_E474_F | −0.41 | 5.30E−05 | 1.10E−05 | 804 |
| NGFR_E328_F | −0.62 | 5.30E−05 | 1.10E−05 | 805 |
| HLA-F_E402_F | −0.65 | 5.50E−05 | 1.20E−05 | 806 |
| FGF9_P1404_F | −0.18 | 6.10E−05 | 1.30E−05 | 807 |
| CSTB_E410_F | −0.60 | 6.20E−05 | 1.30E−05 | 808 |
| FAT_P973_R | −0.44 | 6.20E−05 | 1.30E−05 | 809 |
| MYH11_P22_F | −0.87 | 6.40E−05 | 1.30E−05 | 810 |
| FN1_E469_F | 0.85 | 6.40E−05 | 1.30E−05 | 811 |
| ESR2_P162_F | −0.54 | 6.60E−05 | 1.40E−05 | 812 |
| CLX1_P538_F | 0.40 | 6.70E−05 | 1.40E−05 | 813 |
| BMPR1A_P956_F | −0.25 | 6.90E−05 | 1.50E−05 | 814 |
| FASTK_P257_F | −0.42 | 7.00E−05 | 1.50E−05 | 815 |
| IL1A_E113_R | 0.27 | 7.90E−05 | 1.70E−05 | 816 |
| PTCH2_E173_F | −0.43 | 8.10E−05 | 1.70E−05 | 817 |
| ETS2_P684_F | 1.23 | 8.40E−05 | 1.70E−05 | 818 |
| RARRES1_P426_R | −0.42 | 8.40E−05 | 1.80E−05 | 819 |
| EPHX1_P1358_R | 0.35 | 8.50E−05 | 1.80E−05 | 820 |
| IGF1_E394_F | −0.46 | 8.60E−05 | 1.80E−05 | 821 |
| LIG3_P622_R | 0.43 | 9.20E−05 | 1.90E−05 | 822 |
| TRIP6_P1274_R | −0.48 | 9.40E−05 | 1.90E−05 | 823 |
| FGFR1_E317_F | −0.25 | 9.60E−05 | 2.00E−05 | 824 |
| DST_E31_F | −0.22 | 0.000102 | 2.10E−05 | 825 |
| BDNF_P259_R | −0.49 | 0.000105 | 2.20E−05 | 826 |
| PWCR1_P811_F | 0.40 | 0.000112 | 2.30E−05 | 827 |
| SEMA3A_P658_R | −0.34 | 0.000113 | 2.30E−05 | 828 |
| CSF1R_E26_F | 0.47 | 0.000114 | 2.30E−05 | 829 |
| HS3ST2_P171_F | −0.59 | 0.00012 | 2.50E−05 | 830 |
| ERBB3_P870_R | −0.33 | 0.000122 | 2.50E−05 | 831 |
| TRPM5_P721_F | 0.40 | 0.000123 | 2.50E−05 | 832 |
| CASP10_P186_F | −0.45 | 0.000128 | 2.60E−05 | 833 |
| CDKN1A_P242_F | −0.80 | 0.000131 | 2.70E−05 | 834 |
| CASP3_P420_R | −0.27 | 0.000132 | 2.70E−05 | 835 |
| SNCG_P53_F | −0.46 | 0.000147 | 3.00E−05 | 836 |
| OPCML_P71_F | −0.45 | 0.000149 | 3.00E−05 | 837 |
| DSP_P440_R | 0.67 | 0.000158 | 3.20E−05 | 838 |
| PLXDC1_P236_F | −0.49 | 0.00016 | 3.20E−05 | 839 |
| ACVR2B_P676_F | −0.32 | 0.000161 | 3.30E−05 | 840 |
| SLC5A8_E60_R | 0.54 | 0.00017 | 3.40E−05 | 841 |
| DCC_E53_R | −0.44 | 0.000178 | 3.60E−05 | 842 |
| IL3_P556_F | 0.21 | 0.000181 | 3.70E−05 | 843 |
| TSG101_P139_R | −0.22 | 0.000183 | 3.70E−05 | 844 |
| MPL_P62_F | 0.27 | 0.000187 | 3.80E−05 | 845 |
| SERPINE1_E189_R | −0.33 | 0.000189 | 3.80E−05 | 846 |
| TCF4_P317_F | −0.58 | 0.000197 | 4.00E−05 | 847 |
| KRT5_E196_R | −0.61 | 0.000205 | 4.10E−05 | 848 |
| BCL2L2_P280_F | −0.33 | 0.000206 | 4.10E−05 | 849 |
| NNAT_P544_R | 0.26 | 0.000207 | 4.10E−05 | 850 |
| PTGS1_E80_F | −0.57 | 0.000207 | 4.10E−05 | 851 |
| PCDH1_P264_F | −0.43 | 0.000233 | 4.60E−05 | 852 |
| PDE1B_P263_R | −0.62 | 0.000244 | 4.90E−05 | 853 |
| EVI1_P30_R | 0.93 | 0.000261 | 5.20E−05 | 854 |
| SNCG_E119_F | −0.37 | 0.000268 | 5.30E−05 | 855 |
| CASP10_E139_F | −0.36 | 0.000303 | 6.00E−05 | 856 |
| ETS1_P559_R | −0.23 | 0.000305 | 6.00E−05 | 857 |
| CTSD_P726_F | 0.33 | 0.000313 | 6.20E−05 | 858 |
| HOXB2_P488_R | −0.52 | 0.000313 | 6.20E−05 | 859 |
| LEFTY2_P719_F | 0.27 | 0.000324 | 6.40E−05 | 860 |
| HDAC9_P137_R | 0.59 | 0.000327 | 6.50E−05 | 861 |
| WNT8B_P216_R | 0.23 | 0.000366 | 7.20E−05 | 862 |
| PDGFA_P78_F | −0.18 | 0.000379 | 7.50E−05 | 863 |
| DLL1_P386_F | −0.46 | 0.000382 | 7.50E−05 | 864 |
| CCND2_P898_R | −0.78 | 0.000389 | 7.70E−05 | 865 |
| NES_P239_R | −0.36 | 0.00039 | 7.70E−05 | 866 |
| SH3BP2_E18_F | −0.32 | 0.000408 | 8.00E−05 | 867 |
| MMP10_E136_R | 0.39 | 0.000422 | 8.30E−05 | 868 |
| OPCML_E219_R | −0.64 | 0.000435 | 8.50E−05 | 869 |
| CCKBR_P480_F | −0.72 | 0.000436 | 8.50E−05 | 870 |
| F2R_P839_F | 0.31 | 0.000436 | 8.50E−05 | 871 |
| LAT_E46_F | 0.39 | 0.000452 | 8.80E−05 | 872 |
| CDK2_P330_R | −0.23 | 0.000453 | 8.80E−05 | 873 |
| ZNFN1A1_P179_F | 0.35 | 0.00046 | 8.90E−05 | 874 |
| FLT3_E326_R | −0.68 | 0.000485 | 9.40E−05 | 875 |
| DSC2_E90_F | −0.38 | 0.000487 | 9.50E−05 | 876 |
| E2F5_P516_R | −0.32 | 0.000507 | 9.80E−05 | 877 |
| RRAS_P100_R | −0.34 | 0.000521 | 0.000101 | 878 |
| TSC2_E140_F | 0.43 | 0.000531 | 0.000103 | 879 |
| PPARG_E178_R | −0.44 | 0.000565 | 0.000109 | 880 |
| FABP3_E113_F | −0.56 | 0.000577 | 0.000111 | 881 |
| NKX3-1_P871_R | 0.34 | 0.000583 | 0.000112 | 882 |
| IGF2_P36_R | −0.39 | 6.00E−04 | 0.000116 | 883 |
| RARA_E128_R | −0.36 | 0.000608 | 0.000117 | 884 |
| CHFR_P635_R | −0.22 | 0.000612 | 0.000118 | 885 |
| EPHA3_P106_R | −0.59 | 0.000617 | 0.000118 | 886 |
| AHR_P166_R | −0.52 | 0.000618 | 0.000118 | 887 |
| TK1_E47_F | 0.26 | 0.000626 | 0.00012 | 888 |
| DHCR24_P652_R | −0.25 | 0.000671 | 0.000128 | 889 |
| RIPK1_P744_R | 0.48 | 0.000676 | 0.000129 | 890 |
| SOX17_P303_F | −0.52 | 0.000693 | 0.000132 | 891 |
| IGFBP5_P9_R | −0.42 | 0.00071 | 0.000135 | 892 |
| EPHA8_P256_F | −0.34 | 0.000723 | 0.000138 | 893 |
| CDK6_P291_R | −0.33 | 0.000734 | 0.00014 | 894 |
| TRIP6_E33_F | −0.31 | 0.000748 | 0.000142 | 895 |
| SERPINB5_P19_R | 0.53 | 0.000754 | 0.000143 | 896 |
| MYOD1_E156_F | −0.49 | 0.000763 | 0.000145 | 897 |
| PYCARD_E87_F | −0.53 | 0.000778 | 0.000147 | 898 |
| TIMP3_P690_R | 0.19 | 0.000798 | 0.000151 | 899 |
| UNG_P170_F | −0.50 | 0.000824 | 0.000156 | 900 |
| BCR_P346_F | 0.38 | 0.000844 | 0.000159 | 901 |
| AGXT_E115_R | 0.38 | 0.00089 | 0.000168 | 902 |
| KIT_P405_F | −0.52 | 0.000922 | 0.000174 | 903 |
| CHGA_P243_F | −0.38 | 0.000939 | 0.000177 | 904 |
| BMP6_P398_F | −0.55 | 0.000966 | 0.000181 | 905 |
| PLAGL1_E68_R | −0.39 | 0.001001 | 0.000188 | 906 |
| EPHB4_P313_R | −0.24 | 0.001022 | 0.000191 | 907 |
| MMP7_P613_F | 0.16 | 0.001022 | 0.000191 | 908 |
| RHOC_P536_F | −0.41 | 0.001074 | 0.000201 | 909 |
| RBP1_P150_F | −0.62 | 0.001094 | 0.000204 | 910 |
| CFTR_P115_F | −0.65 | 0.001105 | 0.000206 | 911 |
| SNURF_P2_R | 0.23 | 0.001129 | 0.000211 | 912 |
| TSP50_E21_R | 0.31 | 0.001207 | 0.000225 | 913 |
| RAF1_P330_F | −0.50 | 0.001293 | 0.000241 | 914 |
| PAX6_E129_F | −0.65 | 0.001332 | 0.000247 | 915 |
| LRRK1_P39_F | −0.20 | 0.001332 | 0.000247 | 916 |
| IPF1_P750_F | −0.48 | 0.001343 | 0.000249 | 917 |
| PEG3_E496_F | 0.24 | 0.00138 | 0.000256 | 918 |
| FLT4_P180_R | −0.63 | 0.001382 | 0.000256 | 919 |
| COL1A2_P407_R | 0.40 | 0.001398 | 0.000258 | 920 |
| PPARD_P846_F | −0.36 | 0.001406 | 0.00026 | 921 |
| DBC1_P351_R | −0.52 | 0.001464 | 0.00027 | 922 |
| ST6GAL1_P226_F | −0.63 | 0.001498 | 0.000276 | 923 |
| CHI3L2_P226_F | −0.36 | 0.001605 | 0.000296 | 924 |
| MEG3_P235_F | −0.35 | 0.001649 | 0.000303 | 925 |
| DLC1_E276_F | 0.45 | 0.001745 | 0.000321 | 926 |
| RARA_P176_R | −0.36 | 0.001819 | 0.000334 | 927 |
| CDKN2B_seq_50_S | −0.34 | 0.001832 | 0.000336 | 928 |
| ZMYND10_E77_R | −0.31 | 0.001937 | 0.000355 | 929 |
| PGF_P320_F | −0.37 | 0.002057 | 0.000376 | 930 |
| B3GALT5_P330_F | 0.27 | 0.002067 | 0.000378 | 931 |
| TMEFF1_P626_R | −0.28 | 0.002075 | 0.000379 | 932 |
| BAX_E281_R | −0.25 | 0.002091 | 0.000381 | 933 |
| NPY_P295_F | −0.58 | 0.00217 | 0.000395 | 934 |
| VAV2_E58_F | −0.19 | 0.002202 | 0.000401 | 935 |
| LMO1_E265_R | −0.39 | 0.002353 | 0.000427 | 936 |
| C4B_E171_F | −0.29 | 0.002372 | 0.00043 | 937 |
| EPHA8_P456_R | 0.34 | 0.002429 | 0.00044 | 938 |
| JAK3_P156_R | 0.47 | 0.002443 | 0.000443 | 939 |
| EPHX1_E152_F | 0.32 | 0.002492 | 0.000451 | 940 |
| SGCE_P250_R | 0.22 | 0.00251 | 0.000454 | 941 |
| HLA-DOB_P1114_R | 0.21 | 0.002513 | 0.000454 | 942 |
| LY6G6E_P45_R | 0.47 | 0.002607 | 0.00047 | 943 |
| AREG_P217_R | 0.21 | 0.002642 | 0.000476 | 944 |
| MAD2L1_E93_F | 0.18 | 0.002966 | 0.000534 | 945 |
| ICAM1_E242_F | −0.47 | 0.003073 | 0.000553 | 946 |
| IGSF4C_P533_R | −0.19 | 0.003087 | 0.000554 | 947 |
| APBA2_P227_F | 0.32 | 0.003154 | 0.000566 | 948 |
| CALCA_P171_F | 0.28 | 0.003207 | 0.000575 | 949 |
| ER_seq_a1_S60_F | −0.42 | 0.003211 | 0.000575 | 950 |
| IL6_P213_R | −0.39 | 0.003248 | 0.000581 | 951 |
| KIAA0125_E29_F | 0.30 | 0.00329 | 0.000588 | 952 |
| GABRA5_P1016_F | −0.41 | 0.003319 | 0.000592 | 953 |
| HLA-DRA_P132_R | 0.43 | 0.003359 | 0.000599 | 954 |
| PTGS2_P524_R | −0.33 | 0.003363 | 0.000599 | 955 |
| IL12A_E287_R | −0.29 | 0.00346 | 0.000616 | 956 |
| PADI4_E24_F | 0.39 | 0.003488 | 0.00062 | 957 |
| TIMP3_P1114_R | 0.29 | 0.003578 | 0.000635 | 958 |
| AFP_P824_F | 0.23 | 0.003608 | 0.00064 | 959 |
| IRAK3_P185_F | −0.52 | 0.003627 | 0.000643 | 960 |
| ETV1_P235_F | −0.42 | 0.003651 | 0.000646 | 961 |
| INSR_P1063_R | 0.48 | 0.00367 | 0.000649 | 962 |
| TNFRSF1A_P678_F | 0.25 | 0.003821 | 0.000675 | 963 |
| HTR1B_E232_R | −0.44 | 0.003924 | 0.000692 | 964 |
| SH3BP2_P771_R | −0.26 | 0.003943 | 0.000695 | 965 |
| S100A4_E315_F | 0.46 | 0.003982 | 0.000701 | 966 |
| COL1A2_P48_R | 0.70 | 0.00402 | 0.000707 | 967 |
| CDC25B_E83_F | −0.51 | 0.004109 | 0.000722 | 968 |
| FGF6_E294_F | 0.21 | 0.004247 | 0.000745 | 969 |
| IFNG_P459_R | 0.30 | 0.004346 | 0.000762 | 970 |
| LIMK1_P709_R | 0.37 | 0.004364 | 0.000764 | 971 |
| IGFBP7_P371_F | 0.98 | 0.004508 | 0.000789 | 972 |
| EPHA2_P340_R | −0.26 | 0.004572 | 0.000799 | 973 |
| HRASLS_E72_R | −0.36 | 0.004649 | 0.000812 | 974 |
| MYH11_P236_R | −0.60 | 0.004771 | 0.000832 | 975 |
| TNFRSF10A_P171_F | 0.67 | 0.004859 | 0.000847 | 976 |
| PAX6_P50_R | −0.55 | 0.005298 | 0.000922 | 977 |
| TFRC_P414_R | 0.15 | 0.00541 | 0.000941 | 978 |
| SOX17_P287_R | −0.42 | 0.005558 | 0.000966 | 979 |
| ARHGAP9_P518_R | 0.25 | 0.005616 | 0.000974 | 980 |
| CD40_E58_R | 0.63 | 0.005617 | 0.000974 | 981 |
| MT1A_E13_R | 0.52 | 0.005865 | 0.001016 | 982 |
| HSD17B12_E145_R | −0.47 | 0.005973 | 0.001034 | 983 |
| GSTM2_P109_R | 0.60 | 0.006015 | 0.00104 | 984 |
| MSH3_P13_R | 0.26 | 0.006321 | 0.001091 | 985 |
| HIF1A_P488_F | −0.24 | 0.006404 | 0.001105 | 986 |
| TAL1_E122_F | 0.47 | 0.006628 | 0.001142 | 987 |
| SCGB3A1_E55_R | 0.49 | 0.006879 | 0.001184 | 988 |
| GFI1_P45_R | −0.47 | 0.006915 | 0.001189 | 989 |
| WNT10B_P823_R | 0.43 | 0.007334 | 0.00126 | 990 |
| MUC1_P191_F | −0.25 | 0.007565 | 0.001298 | 991 |
| MMP3_P16_R | −0.42 | 0.008058 | 0.001382 | 992 |
| ABCB4_P51_F | 0.17 | 0.008165 | 0.001399 | 993 |
| IGF2AS_P203_F | −0.38 | 0.00842 | 0.001441 | 994 |
| MAPK12_P416_F | −0.38 | 0.008442 | 0.001443 | 995 |
| WRN_E57_F | −0.21 | 0.008455 | 0.001444 | 996 |
| CDH3_E100_R | −0.35 | 0.008529 | 0.001455 | 997 |
| MMP2_P197_F | −0.44 | 0.008857 | 0.001509 | 998 |
| SNRPN_E14_F | 0.26 | 0.009036 | 0.001538 | 999 |
| CYP1B1_E83_R | −0.49 | 0.009412 | 0.001601 | 1000 |
| PROM1_P44_R | −0.30 | 0.00964 | 0.001638 | 1001 |
| THY1_P149_R | −0.47 | 0.009649 | 0.001638 | 1002 |
| IL8_E118_R | −0.25 | 0.009856 | 0.001671 | 1003 |
| DUSP4_E61_F | −0.17 | 0.01003 | 0.001699 | 1004 |
| FZD9_E458_F | 0.36 | 0.010176 | 0.001722 | 1005 |
| CALCA_E174_R | −0.41 | 0.011 | 0.00186 | 1006 |
| IL1RN_E42_F | −0.30 | 0.011457 | 0.001935 | 1007 |
| IHH_P529_F | −0.32 | 0.011545 | 0.001948 | 1008 |
| ZIM3_E203_F | 0.27 | 0.011986 | 0.00202 | 1009 |
| LRRC32_P865_R | −0.41 | 0.012888 | 0.00217 | 1010 |
| FGF8_E183_F | −0.40 | 0.013124 | 0.002206 | 1011 |
| MAGEL2_E166_R | 0.25 | 0.013127 | 0.002206 | 1012 |
| IL11_P11_R | −0.40 | 0.013259 | 0.002226 | 1013 |
| LYN_P241_F | 0.57 | 0.013487 | 0.002262 | 1014 |
| GABRG3_P75_F | −0.30 | 0.013536 | 0.002268 | 1015 |
| ASCL2_P360_F | −0.40 | 0.01355 | 0.002268 | 1016 |
| EGR4_P479_F | 0.58 | 0.014415 | 0.002411 | 1017 |
| HOXC6_P456_R | −0.33 | 0.014442 | 0.002413 | 1018 |
| ONECUT2_P315_R | −0.44 | 0.014785 | 0.002468 | 1019 |
| IMPACT_P186_F | 0.26 | 0.014841 | 0.002475 | 1020 |
| FZD9_P15_R | −0.39 | 0.015 | 0.002499 | 1021 |
| MCAM_P265_R | −0.23 | 0.015581 | 0.002593 | 1022 |
| CTGF_P693_R | −0.29 | 0.015598 | 0.002593 | 1023 |
| MMP9_P189_F | −0.27 | 0.015637 | 0.002597 | 1024 |
| TNFRSF10B_P108_I | −0.23 | 0.016829 | 0.002792 | 1025 |
| HLA-DQA2_E93_F | 0.23 | 0.017077 | 0.002831 | 1026 |
| HS3ST2_E145_R | −0.38 | 0.017106 | 0.002833 | 1027 |
| LMO1_P169_F | −0.17 | 0.017372 | 0.002874 | 1028 |
| C4B_P191_F | −0.27 | 0.017475 | 0.002888 | 1029 |
| EPHA2_P203_F | −0.26 | 0.018068 | 0.002984 | 1030 |
| LIF_E208_F | −0.72 | 0.018828 | 0.003106 | 1031 |
| EPHB6_P827_R | 0.11 | 0.019304 | 0.003181 | 1032 |
| CSF3R_P8_F | −0.28 | 0.019369 | 0.003189 | 1033 |
| PTK2B_P673_R | −0.11 | 0.019498 | 0.003207 | 1034 |
| TNC_P198_F | 0.19 | 0.019684 | 0.003235 | 1035 |
| ERCC3_P1210_R | −0.18 | 0.019773 | 0.003246 | 1036 |
| FLT1_P615_R | 0.53 | 0.020368 | 0.003341 | 1037 |
| OSM_P34_F | 0.25 | 0.020403 | 0.003343 | 1038 |
| EDN1_P39_R | −0.34 | 0.020531 | 0.003361 | 1039 |
| MT1A_P49_R | 0.58 | 0.020731 | 0.00339 | 1040 |
| MYLK_E132_R | −0.35 | 0.02106 | 0.003441 | 1041 |
| IGF1R_E186_R | −0.25 | 0.021121 | 0.003448 | 1042 |
| ACVR1_P983_F | 0.33 | 0.021882 | 0.003568 | 1043 |
| CREBBP_P712_R | 0.27 | 0.022723 | 0.003702 | 1044 |
| DSG1_E292_F | 0.15 | 0.023665 | 0.003852 | 1045 |
| GFI1_E136_F | −0.41 | 0.024198 | 0.003935 | 1046 |
| AKT1_P310_R | −0.16 | 0.025402 | 0.004126 | 1047 |
| ASCL2_P609_R | −0.31 | 0.026658 | 0.004326 | 1048 |
| SNRPN_seq_12_S127_F | −0.19 | 0.027215 | 0.004412 | 1049 |
| TRIM29_E189_F | −0.27 | 0.027564 | 0.004465 | 1050 |
| AATK_P709_R | −0.27 | 0.027753 | 0.004491 | 1051 |
| DIRAS3_P745_F | −0.22 | 0.028093 | 0.004542 | 1052 |
| ZNF215_P71_R | −0.27 | 0.028487 | 0.004601 | 1053 |
| ARHGDIB_P148_R | 0.17 | 0.02921 | 0.004714 | 1054 |
| ELK3_P514_F | −0.31 | 0.029343 | 0.00473 | 1055 |
| TAL1_P817_F | −0.29 | 0.029392 | 0.004734 | 1056 |
| MAP2K6_P297_R | −0.19 | 0.030268 | 0.00487 | 1057 |
| HLA-DOB_E432_R | 0.18 | 0.031387 | 0.005046 | 1058 |
| ALOX12_P223_R | −0.33 | 0.031823 | 0.005111 | 1059 |
| SNURF_P78_F | −0.21 | 0.032883 | 0.005276 | 1060 |
| CDKN2A_E121_R | −0.17 | 0.033582 | 0.005383 | 1061 |
| NBL1_E205_R | 0.22 | 0.033754 | 0.005406 | 1062 |
| CD2_P68_F | 0.29 | 0.034391 | 0.005503 | 1063 |
| NTRK1_E74_F | 0.45 | 0.035783 | 0.00572 | 1064 |
| ALK_P28_F | −0.38 | 0.036172 | 0.005777 | 1065 |
| IAPP_E280_F | −0.23 | 0.037399 | 0.005967 | 1066 |
| DES_P1006_R | 0.19 | 0.037972 | 0.006053 | 1067 |
| PTHR1_P258_F | 0.19 | 0.038025 | 0.006055 | 1068 |
| MC2R_E455_F | 0.35 | 0.038539 | 0.006132 | 1069 |
| MC2R_P1025_F | 0.21 | 0.039187 | 0.006229 | 1070 |
| CREB1_P819_F | 0.28 | 0.039628 | 0.006293 | 1071 |
| RASSF1_E116_F | −0.54 | 0.039939 | 0.006337 | 1072 |
| MST1R_E42_R | −0.25 | 0.04008 | 0.006353 | 1073 |
| FER_P581_F | 0.29 | 0.041253 | 0.006533 | 1074 |
| PTPRG_E40_R | −0.12 | 0.041291 | 0.006533 | 1075 |
| HTR2A_E10_R | 0.23 | 0.041553 | 0.006568 | 1076 |
| SOX1_P294_F | −0.35 | 0.042294 | 0.006679 | 1077 |
| SEPT5_P441_F | −0.23 | 0.042713 | 0.006739 | 1078 |
| TNFSF8_E258_R | 0.22 | 0.043312 | 0.006823 | 1079 |
| ARNT_P238_R | 0.13 | 0.043326 | 0.006823 | 1080 |
| ASCL1_P747_F | −0.25 | 0.044458 | 0.006995 | 1081 |
| CCND1_P343_R | −0.22 | 0.045351 | 0.007129 | 1082 |
| EPO_E244_R | 0.46 | 0.046692 | 0.007329 | 1083 |
| MKRN3_E144_F | 0.30 | 0.046712 | 0.007329 | 1084 |
| DDB2_P407_F | −0.20 | 0.047876 | 0.007505 | 1085 |
| TK1_P62_R | −0.48 | 0.048811 | 0.007644 | 1086 |
| GRB7_P160_R | 0.21 | 0.051145 | 0.008002 | 1087 |
| HOXA9_P303_F | −0.24 | 0.051271 | 0.008015 | 1088 |
| WNT1_E157_F | −0.34 | 0.052136 | 0.008143 | 1089 |
| GPATC3_P410_R | 0.27 | 0.052585 | 0.008205 | 1090 |
| PECAM1_P135_F | 0.18 | 0.052643 | 0.008207 | 1091 |
| PTHR1_P170_R | 0.19 | 0.053221 | 0.008289 | 1092 |
| LTB4R_E64_R | 0.18 | 0.054156 | 0.008427 | 1093 |
| DLC1_P695_F | 0.22 | 0.054933 | 0.00854 | 1094 |
| RIPK1_P868_F | 0.24 | 0.055279 | 0.008586 | 1095 |
| EGF_E339_F | −0.31 | 0.055534 | 0.008618 | 1096 |
| PWCR1_E81_R | 0.24 | 0.055583 | 0.008618 | 1097 |
| KRT5_P308_F | −0.18 | 0.055904 | 0.008659 | 1098 |
| EMR3_P39_R | 0.23 | 0.055984 | 0.008664 | 1099 |
| ATP10A_P147_F | −0.24 | 0.056118 | 0.008677 | 1100 |
| NOTCH4_P938_F | 0.21 | 0.056309 | 0.008699 | 1101 |
| DNMT2_P199_F | 0.13 | 0.05786 | 0.00893 | 1102 |
| LMO2_E148_F | 0.24 | 0.057914 | 0.00893 | 1103 |
| HOXA9_E252_R | −0.32 | 0.059186 | 0.009118 | 1104 |
| TGFB3_E58_R | −0.28 | 0.060391 | 0.009295 | 1105 |
| HIC2_P498_F | 0.29 | 0.061098 | 0.009396 | 1106 |
| SHH_E328_F | −0.22 | 0.06232 | 0.009575 | 1107 |
| CD40_P372_R | 0.34 | 0.062768 | 0.009635 | 1108 |
| CDKN1C_P626_F | 0.33 | 0.06543 | 0.010035 | 1109 |
| IL12B_E25_F | −0.21 | 0.06578 | 0.010079 | 1110 |
| ITK_E166_R | 0.24 | 0.072329 | 0.011073 | 1111 |
| BCL6_P248_R | −0.13 | 0.072425 | 0.011077 | 1112 |
| MYB_P673_R | −0.25 | 0.073709 | 0.011264 | 1113 |
| ITPR3_E86_R | 0.10 | 0.082578 | 0.012608 | 1114 |
| B3GALT5_E246_R | −0.21 | 0.086458 | 0.013188 | 1115 |
| MATK_P64_F | −0.30 | 0.086916 | 0.013246 | 1116 |
| VAMP8_P114_F | 0.26 | 0.087659 | 0.013336 | 1117 |
| TFAP2C_P765_F | −0.37 | 0.087659 | 0.013336 | 1118 |
| PSCA_E359_F | 0.19 | 0.092195 | 0.014013 | 1119 |
| MEG3_E91_F | −0.15 | 0.093166 | 0.014148 | 1120 |
| RIPK3_P124_F | 0.24 | 0.093679 | 0.014213 | 1121 |
| RYK_P493_F | 0.15 | 0.096451 | 0.014621 | 1122 |
| HLA-DOA_P594_F | −0.13 | 0.097533 | 0.014771 | 1123 |
| PYCARD_P150_F | 0.14 | 0.099792 | 0.0151 | 1124 |
| TAL1_P594_F | −0.27 | 0.100215 | 0.015151 | 1125 |
| CYP1A1_P382_F | −0.16 | 0.100332 | 0.015155 | 1126 |
| POMC_E254_F | −0.24 | 0.100589 | 0.01518 | 1127 |
| COL1A2_E299_F | 0.40 | 0.100752 | 0.015191 | 1128 |
| PLSCR3_P751_R | 0.16 | 0.100899 | 0.0152 | 1129 |
| ZP3_E90_F | 0.40 | 0.102223 | 0.015386 | 1130 |
| TIE1_E66_R | −0.17 | 0.103277 | 0.015531 | 1131 |
| EVI2A_E420_F | 0.19 | 0.105022 | 0.015779 | 1132 |
| S100A2_P1186_F | 0.20 | 0.105563 | 0.015847 | 1133 |
| TEK_P526_F | −0.14 | 0.106105 | 0.015914 | 1134 |
| NR2F6_E375_R | 0.06 | 0.113337 | 0.016984 | 1135 |
| HDAC7A_P344_F | 0.21 | 0.11431 | 0.017114 | 1136 |
| IHH_E186_F | −0.30 | 0.114459 | 0.017121 | 1137 |
| HLA-DRA_P77_R | 0.22 | 0.115053 | 0.017181 | 1138 |
| PADI4_P1158_R | 0.18 | 0.115057 | 0.017181 | 1139 |
| FGFR3_P1152_R | −0.19 | 0.115865 | 0.017286 | 1140 |
| DNMT3B_P352_R | −0.16 | 0.116786 | 0.017408 | 1141 |
| GNAS_E58_F | 0.14 | 0.117162 | 0.017449 | 1142 |
| C20orf47_P225_R | −0.07 | 0.117316 | 0.017457 | 1143 |
| SIN3B_P514_R | −0.20 | 0.117758 | 0.017507 | 1144 |
| PI3_P274_R | 0.18 | 0.118691 | 0.01763 | 1145 |
| HDAC9_E38_F | 0.26 | 0.120161 | 0.017833 | 1146 |
| TNFRSF1B_P167_F | −0.27 | 0.120373 | 0.017849 | 1147 |
| ACTG2_E98_R | 0.17 | 0.120626 | 0.017871 | 1148 |
| PGF_E33_F | 0.27 | 0.120855 | 0.017889 | 1149 |
| SMAD2_P848_R | −0.15 | 0.123708 | 0.018296 | 1150 |
| COL4A3_E205_R | −0.14 | 0.124659 | 0.01842 | 1151 |
| PENK_E26_F | 0.22 | 0.124919 | 0.018443 | 1152 |
| ITPR2_P804_F | −0.14 | 0.133578 | 0.019704 | 1153 |
| SMARCA3_E20_F | −0.14 | 0.13379 | 0.019718 | 1154 |
| SLC14A1_P369_R | 0.20 | 0.135114 | 0.019896 | 1155 |
| SGCE_E149_F | −0.24 | 0.136794 | 0.020126 | 1156 |
| LTA_E28_R | 0.23 | 0.138226 | 0.020319 | 1157 |
| CPA4_E20_F | −0.13 | 0.138926 | 0.020405 | 1158 |
| EVI2A_P94_R | −0.23 | 0.142096 | 0.020852 | 1159 |
| MAPK4_E273_R | −0.15 | 0.14225 | 0.020857 | 1160 |
| PTK2_P735_R | 0.22 | 0.142813 | 0.020921 | 1161 |
| TSP50_P137_F | −0.22 | 0.143467 | 0.020999 | 1162 |
| STAT5A_P704_R | 0.15 | 0.144191 | 0.021087 | 1163 |
| IFNG_P188_F | 0.17 | 0.148996 | 0.021771 | 1164 |
| IL4_P262_R | 0.09 | 0.149813 | 0.021871 | 1165 |
| CCNC_P132_R | −0.22 | 0.152705 | 0.022275 | 1166 |
| CSF1R_P73_F | 0.11 | 0.155802 | 0.022707 | 1167 |
| MMP3_P55_F | 0.15 | 0.15834 | 0.023057 | 1168 |
| CHGA_E52_F | −0.23 | 0.160067 | 0.02328 | 1169 |
| RHOH_P121_F | 0.17 | 0.160143 | 0.02328 | 1170 |
| MYBL2_P211_F | 0.47 | 0.162983 | 0.023672 | 1171 |
| TDGF1_P428_R | −0.12 | 0.163849 | 0.023778 | 1172 |
| GLI2_E90_F | 0.21 | 0.165669 | 0.024021 | 1173 |
| MMP2_P303_R | −0.24 | 0.165915 | 0.024037 | 1174 |
| GSTM2_P453_R | 0.16 | 0.167055 | 0.024181 | 1175 |
| SNURF_E256_R | 0.11 | 0.167483 | 0.024222 | 1176 |
| RAD50_P191_F | −0.14 | 0.170197 | 0.024569 | 1177 |
| SIN3B_P607_F | −0.09 | 0.170286 | 0.024569 | 1178 |
| RBP1_P426_R | 0.26 | 0.170312 | 0.024569 | 1179 |
| TFF2_P178_F | −0.17 | 0.171813 | 0.024764 | 1180 |
| ZIM2_E110_F | −0.11 | 0.17351 | 0.024988 | 1181 |
| SLC5A5_E60_F | 0.17 | 0.174137 | 0.025057 | 1182 |
| RUNX3_P393_R | 0.17 | 0.177486 | 0.025517 | 1183 |
| IL10_P348_F | 0.09 | 0.180037 | 0.025862 | 1184 |
| LRRC32_E157_F | −0.11 | 0.180634 | 0.025926 | 1185 |
| FAS_P65_F | −0.08 | 0.181466 | 0.026023 | 1186 |
| XPC_P226_R | 0.07 | 0.182697 | 0.026178 | 1187 |
| EMR3_E61_F | 0.17 | 0.18425 | 0.026378 | 1188 |
| APOA1_P75_F | −0.22 | 0.18576 | 0.026572 | 1189 |
| PITX2_P183_R | 0.14 | 0.186706 | 0.026685 | 1190 |
| ATP10A_P524_R | −0.15 | 0.18736 | 0.026756 | 1191 |
| MPO_E302_R | 0.15 | 0.188557 | 0.026904 | 1192 |
| TNFRSF10C_P612_I | 0.08 | 0.189503 | 0.027016 | 1193 |
| MLLT4_P1400_F | 0.31 | 0.190011 | 0.027066 | 1194 |
| TES_E172_F | −0.25 | 0.191889 | 0.027311 | 1195 |
| IGFBP1_P12_R | 0.19 | 0.193424 | 0.027506 | 1196 |
| H19_P541_F | 0.21 | 0.194485 | 0.027634 | 1197 |
| ICAM1_P386_R | −0.28 | 0.208835 | 0.029648 | 1198 |
| IGFBP2_P353_R | −0.16 | 0.212437 | 0.030135 | 1199 |
| APBA1_E99_R | 0.11 | 0.214037 | 0.030336 | 1200 |
| RET_P717_F | −0.14 | 0.216943 | 0.030722 | 1201 |
| MATK_P190_R | −0.17 | 0.21791 | 0.030834 | 1202 |
| KCNK4_E3_F | −0.14 | 0.218833 | 0.030916 | 1203 |
| EYA4_P508_F | 0.19 | 0.218881 | 0.030916 | 1204 |
| RIPK4_E166_F | −0.14 | 0.21904 | 0.030916 | 1205 |
| NFKB1_P336_R | −0.21 | 0.225726 | 0.031834 | 1206 |
| PTPN6_E171_R | −0.19 | 0.227674 | 0.032082 | 1207 |
| PMP22_P1254_F | 0.08 | 0.228272 | 0.032126 | 1208 |
| TFPI2_E141_F | 0.09 | 0.228363 | 0.032126 | 1209 |
| RASGRF1_P768_F | 0.19 | 0.229233 | 0.032221 | 1210 |
| SEPT5_P464_R | −0.13 | 0.229456 | 0.032226 | 1211 |
| AXL_E61_F | −0.15 | 0.230742 | 0.03238 | 1212 |
| MSH3_E3_F | −0.18 | 0.234379 | 0.032857 | 1213 |
| CDKN2B_E220_F | −0.09 | 0.234527 | 0.032857 | 1214 |
| EGF_P242_R | 0.13 | 0.235829 | 0.033012 | 1215 |
| ZIM3_P718_R | −0.16 | 0.237428 | 0.033209 | 1216 |
| NOTCH4_E4_F | 0.18 | 0.24965 | 0.034889 | 1217 |
| TFPI2_P152_R | −0.08 | 0.251819 | 0.035164 | 1218 |
| TERT_E20_F | 0.15 | 0.25534 | 0.035626 | 1219 |
| AATK_P519_R | −0.14 | 0.257898 | 0.035953 | 1220 |
| PDGFRA_E125_F | 0.16 | 0.263562 | 0.036713 | 1221 |
| IGFBP1_E48_R | 0.17 | 0.263808 | 0.036717 | 1222 |
| ZAP70_P220_R | 0.11 | 0.265491 | 0.036921 | 1223 |
| SHB_P691_R | −0.18 | 0.265958 | 0.036956 | 1224 |
| BLK_P668_R | 0.09 | 0.273799 | 0.038014 | 1225 |
| MYBL2_P354_F | −0.20 | 0.274753 | 0.038116 | 1226 |
| DIRAS3_E55_R | 0.11 | 0.27786 | 0.038515 | 1227 |
| MET_E333_F | −0.12 | 0.278411 | 0.03856 | 1228 |
| ABCB4_P892_F | 0.17 | 0.281453 | 0.03895 | 1229 |
| TFAP2C_E260_F | 0.09 | 0.294381 | 0.040706 | 1230 |
| GP1BB_P278_R | 0.15 | 0.294853 | 0.040738 | 1231 |
| CDK6_E256_F | 0.05 | 0.296769 | 0.040942 | 1232 |
| ESR1_E298_R | 0.22 | 0.296812 | 0.040942 | 1233 |
| IRAK3_P13_F | −0.34 | 0.2972 | 0.040963 | 1234 |
| HOXA11_E35_F | −0.17 | 0.298247 | 0.041073 | 1235 |
| JAK3_E64_F | 0.20 | 0.300751 | 0.041385 | 1236 |
| RAP1A_P285_R | −0.11 | 0.301149 | 0.041406 | 1237 |
| ABCB4_E429_F | 0.07 | 0.3021 | 0.041503 | 1238 |
| CPA4_P1265_R | 0.05 | 0.302375 | 0.041508 | 1239 |
| SPDEF_P6_R | 0.11 | 0.302668 | 0.041514 | 1240 |
| FGF1_P357_R | −0.14 | 0.306003 | 0.041938 | 1241 |
| HIC2_P528_R | 0.16 | 0.306432 | 0.041953 | 1242 |
| GFI1_P208_R | 0.17 | 0.306605 | 0.041953 | 1243 |
| TRIM29_P135_F | −0.11 | 0.309249 | 0.042281 | 1244 |
| PTPRO_P371_F | −0.13 | 0.315795 | 0.043141 | 1245 |
| PTPN6_P282_R | −0.12 | 0.319551 | 0.043619 | 1246 |
| MAPK10_E26_F | −0.15 | 0.322553 | 0.043993 | 1247 |
| EPHX1_P22_F | 0.12 | 0.323301 | 0.04406 | 1248 |
| CASP2_P192_F | −0.20 | 0.330236 | 0.044969 | 1249 |
| SOX2_P546_F | 0.20 | 0.332391 | 0.045226 | 1250 |
| GSTM1_P266_F | −0.12 | 0.332764 | 0.045241 | 1251 |
| HOXA5_P479_F | −0.11 | 0.334259 | 0.045408 | 1252 |
| NRAS_P12_R | −0.06 | 0.334557 | 0.045412 | 1253 |
| BMP2_P1201_F | −0.09 | 0.339666 | 0.046069 | 1254 |
| GUCY2D_E419_R | −0.24 | 0.345755 | 0.046857 | 1255 |
| CCL3_E53_R | −0.12 | 0.346989 | 0.04698 | 1256 |
| ACVR1_E328_R | 0.15 | 0.34721 | 0.04698 | 1257 |
| ERBB2_P59_R | 0.07 | 0.349446 | 0.047209 | 1258 |
| LTB4R_P163_F | −0.07 | 0.349461 | 0.047209 | 1259 |
| ALOX12_E85_R | −0.15 | 0.349808 | 0.047218 | 1260 |
| NPY_P91_F | −0.18 | 0.351668 | 0.047432 | 1261 |
| MST1R_P392_F | −0.19 | 0.356138 | 0.047997 | 1262 |
| ASCL1_E24_F | −0.12 | 0.361401 | 0.048668 | 1263 |
| GP1BB_E23_F | −0.14 | 0.365483 | 0.049178 | 1264 |
| NGFR_P355_F | 0.12 | 0.366627 | 0.049293 | 1265 |
| CD44_E26_F | −0.19 | 0.371126 | 0.049859 | 1266 |

SUPPLEMENTAL TABLE 8
CpG loci with differential methylation between normal and
tumorigenic head and neck tissues.

| | Regression | | | |
|---|---|---|---|---|
| GENE_CpG | coefficient* | P-value | Q-value | Rank |
| ERBB2_P59_R | 0.96 | 0 | 0 | 1 |
| HOXA9_P1141_R | −2.06 | 0 | 3.00E−06 | 2 |
| CASP8_E474_F | 1.21 | 0 | 1.60E−05 | 3 |
| ERN1_P809_R | 1.14 | 0 | 2.80E−05 | 4 |
| ICAM1_P386_R | 1.48 | 0 | 4.00E−05 | 5 |
| RIPK1_P744_R | −0.89 | 2.00E−06 | 0.000196 | 6 |
| HOXA5_P1324_F | −1.28 | 1.10E−05 | 0.000822 | 7 |
| RAB32_P493_R | 1.08 | 1.90E−05 | 0.001206 | 8 |
| DLC1_P695_F | 1.08 | 2.70E−05 | 0.001307 | 9 |
| HBII-52_E142_F | 0.98 | 2.90E−05 | 0.001307 | 10 |
| HTR1B_E232_R | −1.35 | 2.90E−05 | 0.001307 | 11 |
| CCL3_E53_R | 1.07 | 3.30E−05 | 0.001391 | 12 |
| HOXA9_E252_R | −1.51 | 4.20E−05 | 0.001609 | 13 |
| HOXA11_P698_F | −1.44 | 4.50E−05 | 0.001609 | 14 |
| HS3ST2_E145_R | −1.63 | 5.00E−05 | 0.001666 | 15 |
| PENK_E26_F | −1.58 | 5.60E−05 | 0.001668 | 16 |
| RUNX3_E27_R | 1.44 | 5.60E−05 | 0.001668 | 17 |
| GP1BB_P278_R | 1.21 | 8.90E−05 | 0.002361 | 18 |
| HLA-DPB1_E2_R | 1.00 | 9.10E−05 | 0.002361 | 19 |
| TERT_P360_R | −1.90 | 9.40E−05 | 0.002361 | 20 |
| VAMP8_E7_F | 0.78 | 0.000108 | 0.002473 | 21 |
| PTPRH_E173_F | 1.00 | 0.000108 | 0.002473 | 22 |
| ADCYAP1_P398_F | −1.80 | 0.000115 | 0.002473 | 23 |
| MME_P388_F | −1.68 | 0.00012 | 0.002473 | 24 |
| GP1BB_E23_F | 1.13 | 0.000123 | 0.002473 | 25 |
| ITK_P114_F | 1.31 | 0.000135 | 0.002614 | 26 |
| AIM2_P624_F | 1.57 | 0.000155 | 0.00289 | 27 |
| HTR1B_P107_F | −1.45 | 0.000167 | 0.002994 | 28 |
| NPY_E31_R | −1.36 | 0.000177 | 0.003005 | 29 |
| SEMA3C_P642_F | 1.11 | 0.000184 | 0.003005 | 30 |
| PRSS1_P1249_R | 1.03 | 0.000185 | 0.003005 | 31 |
| HTR1B_P222_F | −1.92 | 0.000201 | 0.003159 | 32 |
| GDF10_E39_F | −0.87 | 0.000208 | 0.003173 | 33 |
| VAMP8_P114_F | 1.02 | 0.00022 | 0.003197 | 34 |
| CCL3_P543_R | 0.84 | 0.000223 | 0.003197 | 35 |
| MOS_E60_R | −1.49 | 0.000229 | 0.003197 | 36 |
| SHH_E328_F | −1.10 | 0.000244 | 0.003325 | 37 |
| RIPK1_P868_F | −1.03 | 0.000288 | 0.003797 | 38 |
| DCC_P471_R | −1.61 | 0.000294 | 0.003797 | 39 |
| MLF1_E243_F | −1.43 | 0.000303 | 0.003814 | 40 |
| WNT8B_E487_F | 0.90 | 0.000317 | 0.003888 | 41 |
| IFNG_E293_F | 0.81 | 0.000366 | 0.004387 | 42 |
| IL10_P85_F | 1.04 | 0.000386 | 0.004517 | 43 |
| DLK1_E227_R | −1.75 | 0.000398 | 0.004553 | 44 |
| CEACAM1_E57_R | 0.72 | 0.000458 | 0.005123 | 45 |
| TNFSF8_P184_F | 1.05 | 0.000521 | 0.0057 | 46 |
| OSM_P34_F | 1.18 | 0.000577 | 0.006187 | 47 |
| HS3ST2_P171_F | −2.04 | 0.000591 | 0.006202 | 48 |
| EPHA5_P66_F | −0.89 | 0.000658 | 0.006764 | 49 |
| PLA2G2A_P528_F | 0.98 | 0.000689 | 0.006913 | 50 |
| ABL2_P459_R | 0.40 | 7.00E−04 | 0.006913 | 51 |
| ADCYAP1_P455_R | −2.12 | 0.000743 | 0.007197 | 52 |
| AOC3_P890_R | 0.78 | 0.000785 | 0.007371 | 53 |
| MT1A_E13_R | −1.50 | 0.000791 | 0.007371 | 54 |
| HS3ST2_P546_F | −1.24 | 0.000828 | 0.007577 | 55 |
| MYOD1_E156_F | −1.56 | 0.000844 | 0.007586 | 56 |
| EMR3_P39_R | 0.88 | 0.000905 | 0.007996 | 57 |
| CDH1_P45_F | 0.59 | 0.000936 | 0.008126 | 58 |
| OSM_P188_F | 1.41 | 0.000958 | 0.00816 | 59 |
| HOXB2_P99_F | −0.69 | 0.000972 | 0.00816 | 60 |
| H19_P1411_R | 0.96 | 0.00103 | 0.008504 | 61 |
| NPY_P295_F | −1.62 | 0.001062 | 0.008626 | 62 |
| RUNX3_P393_R | 1.21 | 0.001106 | 0.008839 | 63 |
| PENK_P447_R | −1.41 | 0.001161 | 0.009137 | 64 |
| ATP10A_P524_R | 0.80 | 0.001244 | 0.009633 | 65 |
| EYA4_E277_F | −1.49 | 0.001278 | 0.009749 | 66 |
| TIAM1_P188_R | 0.61 | 0.001303 | 0.00979 | 67 |
| SOX1_P1018_R | −1.67 | 0.00136 | 0.010069 | 68 |
| TAL1_P594_F | −0.96 | 0.001414 | 0.010318 | 69 |
| MPO_P883_R | 0.85 | 0.001615 | 0.011246 | 70 |
| ICAM1_P119_R | 0.30 | 0.00162 | 0.011246 | 71 |
| CALCA_E174_R | −1.15 | 0.001644 | 0.011246 | 72 |
| DBC1_P351_R | −1.52 | 0.001649 | 0.011246 | 73 |
| CD2_P68_F | 1.03 | 0.001653 | 0.011246 | 74 |
| TNFSF8_E258_R | 1.26 | 0.001701 | 0.011418 | 75 |
| GABRA5_P862_R | 1.25 | 0.00173 | 0.01146 | 76 |
| EMR3_E61_F | 0.67 | 0.00178 | 0.011553 | 77 |
| CHGA_E52_F | −1.40 | 0.001805 | 0.011553 | 78 |
| CDKN1B_P1161_F | −1.82 | 0.001839 | 0.011553 | 79 |
| HHIP_P578_R | −1.26 | 0.00187 | 0.011553 | 80 |
| TGFB3_E58_R | −0.85 | 0.001884 | 0.011553 | 81 |
| HDAC1_P414_R | 0.71 | 0.001911 | 0.011553 | 82 |
| HLA-DPA1_P205_R | 0.81 | 0.001922 | 0.011553 | 83 |
| EPHA3_P106_R | −1.72 | 0.001927 | 0.011553 | 84 |
| CTLA4_P1128_F | 0.58 | 0.002182 | 0.012925 | 85 |
| SOX17_P303_F | −1.18 | 0.002267 | 0.013196 | 86 |
| BLK_P14_F | 0.92 | 0.00228 | 0.013196 | 87 |
| BDNF_P259_R | −0.95 | 0.0024 | 0.013731 | 88 |
| CASP10_E139_F | 0.79 | 0.002455 | 0.013891 | 89 |
| SOX1_P294_F | −1.48 | 0.002489 | 0.013926 | 90 |
| MPO_E302_R | 1.05 | 0.002592 | 0.014341 | 91 |
| ELL_P693_F | 0.60 | 0.002627 | 0.014377 | 92 |
| VAV1_P317_F | 0.82 | 0.002704 | 0.014638 | 93 |
| MAP3K1_E81_F | −1.39 | 0.002923 | 0.015564 | 94 |
| DIO3_E230_R | −0.72 | 0.002936 | 0.015564 | 95 |
| EYA4_P508_F | −1.41 | 0.003028 | 0.01588 | 96 |
| COL1A1_P5_F | −1.00 | 0.003067 | 0.015923 | 97 |
| PTHLH_E251_F | 0.77 | 0.003204 | 0.01646 | 98 |
| IGF2AS_P203_F | −0.94 | 0.003274 | 0.01665 | 99 |
| GFI1_P208_R | 0.92 | 0.003346 | 0.016847 | 100 |
| USP29_E274_F | 1.05 | 0.003388 | 0.016892 | 101 |
| GSTM1_P266_F | −0.78 | 0.003491 | 0.017112 | 102 |
| DCC_E53_R | −0.74 | 0.0035 | 0.017112 | 103 |
| OGG1_E400_F | −0.93 | 0.003616 | 0.017507 | 104 |
| DBC1_E204_F | −1.08 | 0.003712 | 0.017802 | 105 |
| AFF3_P122_F | 1.11 | 0.003798 | 0.018041 | 106 |
| MMP8_E89_R | 0.58 | 0.003951 | 0.018591 | 107 |
| GABRB3_P92_F | −0.87 | 0.004188 | 0.019523 | 108 |
| CD34_E20_R | −0.55 | 0.004257 | 0.019666 | 109 |
| AGXT_P180_F | 1.30 | 0.004441 | 0.020301 | 110 |
| SLC5A8_E60_R | −0.95 | 0.004509 | 0.020301 | 111 |
| CD9_P585_R | −0.76 | 0.004531 | 0.020301 | 112 |
| TRPM5_E87_F | 1.05 | 0.004556 | 0.020301 | 113 |
| GNAS_P86_F | 0.58 | 0.004862 | 0.021475 | 114 |
| RUNX3_P247_F | 1.21 | 0.00507 | 0.021849 | 115 |
| APBA2_P305_R | 0.78 | 0.005077 | 0.021849 | 116 |
| KLK10_P268_R | 0.37 | 0.005118 | 0.021849 | 117 |
| NTRK3_P636_R | −1.91 | 0.00512 | 0.021849 | 118 |
| GML_P281_R | 1.36 | 0.005266 | 0.022282 | 119 |
| CALCA_P75_F | −1.26 | 0.005315 | 0.022303 | 120 |
| TNFRSF10A_P171_F | 0.62 | 0.005497 | 0.022877 | 121 |
| CD9_P504_F | −0.88 | 0.005552 | 0.022914 | 122 |
| AGTR1_P41_F | −2.07 | 0.005695 | 0.023312 | 123 |
| MAPK4_E273_R | 0.77 | 0.005816 | 0.023609 | 124 |
| PI3_P1394_R | 0.67 | 0.005861 | 0.023609 | 125 |
| ITGA6_P298_R | −1.59 | 0.005981 | 0.023903 | 126 |
| GABRA5_P1016_F | 0.96 | 0.006101 | 0.024188 | 127 |
| LTA_P214_R | 1.04 | 0.0062 | 0.024391 | 128 |
| CDKN2B_seq_50_S29 | −1.37 | 0.0063 | 0.024484 | 129 |
| TPEF_seq_44_S88_R | −1.46 | 0.006385 | 0.024484 | 130 |
| SEMA3B_E96_F | −0.75 | 0.006461 | 0.024484 | 131 |
| MEST_P62_R | 0.66 | 0.006482 | 0.024484 | 132 |
| FLJ20712_P984_R | 0.84 | 0.0066 | 0.024484 | 133 |
| PROM1_P44_R | 1.05 | 0.006681 | 0.024484 | 134 |
| SPP1_P647_F | 0.82 | 0.006685 | 0.024484 | 135 |
| SPI1_E205_F | 0.52 | 0.006739 | 0.024484 | 136 |
| WT1_E32_F | −1.56 | 0.006756 | 0.024484 | 137 |
| WNT10B_P823_R | 0.75 | 0.006793 | 0.024484 | 138 |
| PMP22_P975_F | 1.04 | 0.006805 | 0.024484 | 139 |
| PWCR1_P357_F | 0.72 | 0.006808 | 0.024484 | 140 |
| HOXB13_E21_F | −1.18 | 0.006919 | 0.02455 | 141 |
| IFNG_P459_R | 0.69 | 0.006968 | 0.02455 | 142 |
| CALCA_P171_F | −0.58 | 0.006986 | 0.02455 | 143 |
| NEFL_E23_R | −1.07 | 0.007061 | 0.02455 | 144 |
| EPHA5_E158_R | −1.82 | 0.00707 | 0.02455 | 145 |
| ABCB4_P892_F | 0.83 | 0.007241 | 0.024639 | 146 |
| SPARC_P195_F | −1.13 | 0.00725 | 0.024639 | 147 |
| EMR3_P1297_R | 0.97 | 0.007252 | 0.024639 | 148 |
| SERPINE1_E189_R | −0.71 | 0.007295 | 0.024639 | 149 |
| PGR_P790_F | 0.77 | 0.00734 | 0.024639 | 150 |
| ADCYAP1_E163_R | −1.27 | 0.007843 | 0.026014 | 151 |
| GALR1_E52_F | −1.81 | 0.007853 | 0.026014 | 152 |
| PI3_E107_F | 1.12 | 0.008082 | 0.026436 | 153 |
| CYP1B1_E83_R | −1.61 | 0.008171 | 0.026436 | 154 |
| CDK10_E74_F | −0.88 | 0.008172 | 0.026436 | 155 |
| DCC_P177_F | −1.18 | 0.008233 | 0.026436 | 156 |
| FN1_P229_R | −0.49 | 0.008251 | 0.026436 | 157 |
| EVI2A_P94_R | 1.12 | 0.008295 | 0.026436 | 158 |
| NFKB2_P709_R | −1.41 | 0.008398 | 0.026596 | 159 |
| INS_P248_F | 0.81 | 0.008522 | 0.026805 | 160 |
| MT1A_P49_R | −1.82 | 0.008571 | 0.026805 | 161 |
| WNT5A_P655_F | −1.67 | 0.008659 | 0.026913 | 162 |
| HLA-DPA1_E35_R | 0.59 | 0.008948 | 0.02764 | 163 |
| EDNRB_P709_R | 1.09 | 0.009033 | 0.027734 | 164 |
| TFRC_P414_R | −0.73 | 0.009208 | 0.028101 | 165 |
| MKRN3_E144_F | 1.14 | 0.009282 | 0.028154 | 166 |
| NTRK2_P395_R | −1.74 | 0.009463 | 0.028474 | 167 |
| EGF_P413_F | 0.87 | 0.0095 | 0.028474 | 168 |
| ITK_E166_R | 1.41 | 0.009727 | 0.028981 | 169 |
| GPR116_P850_F | 0.55 | 0.009826 | 0.029104 | 170 |
| CD1A_P414_R | 0.46 | 0.009926 | 0.029227 | 171 |
| CSF2_E248_R | 0.86 | 0.010229 | 0.029944 | 172 |
| CEACAM1_P44_R | 0.62 | 0.010357 | 0.030144 | 173 |
| TBX1_P885_R | 0.93 | 0.010431 | 0.030184 | 174 |
| SLC14A1_E295_F | 0.74 | 0.010888 | 0.031003 | 175 |
| H19_P541_F | 0.74 | 0.010888 | 0.031003 | 176 |
| FRZB_E186_R | −0.94 | 0.010916 | 0.031003 | 177 |
| THPO_E483_F | 0.67 | 0.010994 | 0.031003 | 178 |
| TCF7L2_P193_R | −1.06 | 0.011021 | 0.031003 | 179 |
| CRIP1_P874_R | 0.55 | 0.011111 | 0.031082 | 180 |
| APOC1_P406_R | 0.52 | 0.011298 | 0.031403 | 181 |
| SFTPB_P689_R | 0.74 | 0.011351 | 0.031403 | 182 |
| LAT_E46_F | 0.90 | 0.01151 | 0.03167 | 183 |
| HOXA5_P479_F | −0.62 | 0.011821 | 0.032348 | 184 |
| SLC22A18_P216_R | −0.59 | 0.011895 | 0.032376 | 185 |
| INS_P804_R | 1.27 | 0.012126 | 0.032827 | 186 |
| HIF1A_P488_F | −1.18 | 0.012326 | 0.033189 | 187 |
| TIE1_E66_R | 0.76 | 0.012568 | 0.033483 | 188 |
| IGFBP5_E144_F | −0.90 | 0.012568 | 0.033483 | 189 |
| AGTR1_P154_F | −1.23 | 0.012721 | 0.033713 | 190 |
| TMEM63A_E63_F | 0.31 | 0.012952 | 0.034048 | 191 |
| TMEFF2_P152_R | −0.98 | 0.013015 | 0.034048 | 192 |
| SFTPA1_E340_R | 1.45 | 0.013083 | 0.034048 | 193 |
| SLC22A3_P634_F | 0.67 | 0.013177 | 0.034048 | 194 |
| ABCB4_P51_F | 0.67 | 0.013186 | 0.034048 | 195 |
| PWCR1_P811_F | 0.83 | 0.01357 | 0.034861 | 196 |
| MYBL2_P211_F | 0.31 | 0.013796 | 0.035261 | 197 |
| PWCR1_E81_R | 0.90 | 0.013967 | 0.035518 | 198 |
| CARD15_P665_F | 0.75 | 0.014317 | 0.036018 | 199 |
| MMP1_P460_F | 0.44 | 0.014322 | 0.036018 | 200 |
| SPARC_E50_R | −0.81 | 0.014387 | 0.036018 | 201 |
| EDNRB_P148_R | 0.96 | 0.014449 | 0.036018 | 202 |
| LCK_E28_F | 1.04 | 0.014627 | 0.036263 | 203 |
| ABCB4_E429_F | 0.70 | 0.014746 | 0.036263 | 204 |
| GDF10_P95_R | −1.05 | 0.014939 | 0.036263 | 205 |
| TSG101_P257_R | −0.72 | 0.014947 | 0.036263 | 206 |
| IPF1_P750_F | −0.71 | 0.015082 | 0.036263 | 207 |
| VAV1_E9_F | 0.68 | 0.015124 | 0.036263 | 208 |
| FLT4_E206_F | −0.63 | 0.015129 | 0.036263 | 209 |
| APBA2_P227_F | 0.61 | 0.015185 | 0.036263 | 210 |
| HLA-DQA2_E93_F | 0.59 | 0.015285 | 0.036263 | 211 |
| MPL_P657_F | 0.65 | 0.015319 | 0.036263 | 212 |
| NQO1_P345_R | −1.14 | 0.01534 | 0.036263 | 213 |
| RYK_P493_F | −1.13 | 0.015654 | 0.036834 | 214 |
| PPAT_E170_R | 0.44 | 0.016381 | 0.03835 | 215 |
| TNFRSF1B_E5_F | 0.59 | 0.016451 | 0.03835 | 216 |
| NOTCH4_P938_F | 0.60 | 0.016857 | 0.03895 | 217 |
| TESK2_P252_R | −0.96 | 0.016863 | 0.03895 | 218 |
| NQO1_E74_R | −0.80 | 0.017109 | 0.039337 | 219 |
| LAMC1_P808_F | −0.93 | 0.017265 | 0.039515 | 220 |
| NTRK3_P752_F | −1.64 | 0.017478 | 0.039755 | 221 |
| SFN_P248_F | 0.43 | 0.017528 | 0.039755 | 222 |
| NPY_P91_F | −1.58 | 0.017619 | 0.03977 | 223 |
| YES1_P600_F | −1.01 | 0.017692 | 0.03977 | 224 |
| PADI4_E24_F | 1.04 | 0.017883 | 0.040019 | 225 |
| FGF12_P210_R | −1.41 | 0.018052 | 0.040052 | 226 |
| ST6GAL1_P528_F | −1.36 | 0.018056 | 0.040052 | 227 |
| BLK_P668_R | 1.02 | 0.018209 | 0.040164 | 228 |
| PSCA_E359_F | 0.66 | 0.018267 | 0.040164 | 229 |
| ZAP70_P220_R | 0.72 | 0.018518 | 0.040539 | 230 |
| SLC5A8_P38_R | −1.16 | 0.018618 | 0.040583 | 231 |
| IL13_E75_R | 0.67 | 0.01881 | 0.040825 | 232 |
| PGR_P456_R | 0.82 | 0.019038 | 0.040989 | 233 |
| CCR5_P630_R | 0.48 | 0.019049 | 0.040989 | 234 |
| NOTCH3_E403_F | −0.96 | 0.019465 | 0.041707 | 235 |
| CFTR_P372_R | −0.79 | 0.020007 | 0.042685 | 236 |
| DDIT3_P1313_R | −0.68 | 0.020161 | 0.042833 | 237 |
| FGF12_E61_R | −1.14 | 0.020559 | 0.043496 | 238 |
| FGF9_P862_R | −0.20 | 0.020778 | 0.043776 | 239 |
| IL12B_P392_R | 0.86 | 0.021269 | 0.044623 | 240 |
| KRT1_P798_R | 0.56 | 0.021667 | 0.045029 | 241 |
| THBS2_E129_F | −1.17 | 0.021713 | 0.045029 | 242 |
| SNRPN_seq_18_S99_F | 0.49 | 0.021731 | 0.045029 | 243 |
| PLXDC2_P914_R | −1.05 | 0.022106 | 0.045437 | 244 |
| MOS_P27_R | −1.06 | 0.022122 | 0.045437 | 245 |
| IRF5_E101_F | −0.56 | 0.022199 | 0.045437 | 246 |
| ACVR1B_P572_R | −0.59 | 0.02248 | 0.045712 | 247 |
| HGF_E102_R | −0.89 | 0.022558 | 0.045712 | 248 |
| RASGRF1_E16_F | −2.36 | 0.022605 | 0.045712 | 249 |
| MAP2K6_E297_F | −0.99 | 0.022876 | 0.046075 | 250 |
| KDR_P445_R | −1.55 | 0.023314 | 0.04677 | 251 |
| TBX1_P520_F | 0.57 | 0.023494 | 0.046943 | 252 |
| GJB2_P931_R | 0.60 | 0.023718 | 0.047172 | 253 |
| VAMP8_P241_F | 0.54 | 0.023796 | 0.047172 | 254 |
| HOXA9_P303_F | −0.83 | 0.023962 | 0.047315 | 255 |
| HLA-DPB1_P540_F | 0.43 | 0.02463 | 0.048063 | 256 |
| IHH_E186_F | −1.34 | 0.024632 | 0.048063 | 257 |
| SEPT9_P58_R | −0.64 | 0.024653 | 0.048063 | 258 |
| SOX17_P287_R | −0.76 | 0.024722 | 0.048063 | 259 |
| NES_P239_R | −0.62 | 0.024919 | 0.048259 | 260 |
| FANCG_E207_R | −0.77 | 0.025799 | 0.049771 | 261 |

*Positive value indicates increased methylation in normal head and neck tissues relative to tumors

SUPPLEMENTAL TABLE 9
Logistic regression model of tumor stage by methylation class
membership; Head and neck squamous cell carcinoma.

| | Stage 1 or | Stage 3 or | | |
|---|---|---|---|---|
| Methylation Class | 2, n (%) | 4, n (%) | OR (95% CI) | P |
| Class 1 | 2 (17%) | 10 (83%) | Referent | |
| Class 2 | l (50%) | 1 (50%) | 0.05 (0.001, 2.9) | 0.15 |
| Class 3 | 0 (0%) | 1 (100%) | ND | ND |
| Class 4 | 3 (100%) | 0 (0%) | ND | ND |
| Class 5 | 2 (12%) | 15 (88%) | 3.0 (0.2, 57.9) | 0.4 |
| Class 6 | 6 (50%) | 6 (50%) | 0.1 (0.01, 1.0) | 0.05 |

Note:
Logistic regression for high stage (III or IV) compared to low stage (I or II) controlled for age and gender.

SUPPLEMENTAL TABLE 10
Loci with methylation beta values significantly
associated with patient survival in head and neck
squamous cell carcinoma (FDR Q-value < 0.2)

| | Hazard | | |
|---|---|---|---|
| Gene Locus | Ratio | P-value | Q-value |
| HGF-E102 | 4.01E−04 | 2.10E−04 | 0.08 |
| ATP10A-P524 | 3.91E−04 | 4.00E−04 | 0.08 |
| SEMA3A-P343 | 1.23E−03 | 1.60E−03 | 0.15 |
| NTRK3-E131 | 7.48E−06 | 1.80E−03 | 0.15 |
| ZAP7O-P220 | 5.98E+02 | 2.20E−03 | 0.15 |
| GP1BB-P278 | 5.51E+01 | 2.70E−03 | 0.15 |
| OPCML-E219 | 3.68E−03 | 2.80E−03 | 0.15 |
| MME-P388 | 2.71E−02 | 3.50E−03 | 0.15 |
| FGF5-P238 | 1.89E−04 | 3.70E−03 | 0.15 |
| UBA52-P293 | 6.29E−03 | 4.10E−03 | 0.15 |
| MC2R-P1025 | 6.39E−03 | 4.10E−03 | 0.15 |
| CDH11-P354 | 1.22E−02 | 4.50E−03 | 0.16 |
| TMEFF2-P152 | 7.38E−03 | 4.90E−03 | 0.16 |
| FLI1-E29 | 2.33E−04 | 6.10E−03 | 0.18 |
| NES-P239 | 2.83E−03 | 6.90E−03 | 0.18 |
| DAPK1-P10 | 8.43E−04 | 7.10E−03 | 0.18 |
| NEFL-P209 | 5.78E−03 | 8.20E−03 | 0.2 |
| ASCL1-P747 | 1.72E−02 | 8.60E−03 | 0.2 |

SUPPLEMENTAL TABLE 11
CpG loci which best differentiate RPMM
methylation class 3 (exclusively normal bladder samples) relative
to other RPMM classes (comprised of bladder tumors).

| GENE_CpG | AUC - Class 3 compared to Others |
|---|---|
| CEACAM1_E57_R | 1.000 |
| IGF2R_P396_R | 1.000 |
| HPSE_P29_F | 1.000 |
| MLH3_P25_F | 1.000 |
| MLF1_P97_F | 1.000 |
| COL6A1_P425_F | 1.000 |
| CASP8_E474_F | 1.000 |
| NPR2_P1093_F | 1.000 |
| EPHB4_E476_R | 1.000 |
| FGFR2_P460_R | 1.000 |
| LAMB1_E144_R | 1.000 |
| TJP2_P518_F | 1.000 |
| VAMP8_P114_F | 1.000 |
| TRAF4_P372_F | 1.000 |
| IGSF4C_E65_F | 1.000 |
| SFN_P248_F | 1.000 |
| IGF1R_P325_R | 1.000 |
| KCNQ1_E349_R | 1.000 |
| INSR_E97_F | 1.000 |
| DST_P262_R | 1.000 |
| HPSE_P93_F | 1.000 |
| ABCG2_P178_R | 1.000 |
| MUC1_E18_R | 1.000 |
| MCM2_P260_F | 1.000 |
| ERCC6_P698_R | 1.000 |
| CEACAM1_P44_R | 0.999 |
| NOTCH3_P198_R | 0.999 |
| ABL2_P459_R | 0.999 |
| INHA_P1144_R | 0.999 |
| EPHA3_P106_R | 0.999 |
| TNFRSF10A_P91_F | 0.999 |
| PTPRH_E173_F | 0.999 |
| HDAC1_P414_R | 0.999 |
| ACVR1C_P115_R | 0.999 |
| FER_P581_F | 0.999 |
| TK1_P62_R | 0.999 |
| NBL1_P24_F | 0.999 |
| PTK6_E50_F | 0.999 |
| PCDH1_E22_F | 0.999 |
| TRIM29_P261_F | 0.998 |
| DHCR24_P406_R | 0.998 |
| PTHR1_P258_F | 0.998 |
| RARRES1_P57_R | 0.998 |
| FER_E119_F | 0.998 |
| MYCN_E77_R | 0.998 |
| PHLDA2_P622_F | 0.998 |
| KRAS_P651_F | 0.998 |
| TJP2_P330_R | 0.998 |
| PPARD_P846_F | 0.998 |
| RIPK3_P124_F | 0.998 |
| IGFBP1_P12_R | 0.997 |
| NOS3_P38_F | 0.997 |
| MMP7_E59_F | 0.997 |
| ENC1_P484_R | 0.997 |
| ITGB4_E144_F | 0.997 |
| S100A2_P1186_F | 0.996 |
| PAX6_E129_F | 0.996 |
| COPG2_P298_F | 0.996 |
| MLF1_E243_F | 0.996 |
| TNFSF10_E53_F | 0.996 |
| CTNNA1_P382_R | 0.996 |
| TGFB2_P632_F | 0.995 |
| IL1B_P829_F | 0.995 |
| PTPN6_P282_R | 0.995 |
| VAMP8_E7_F | 0.995 |
| RASA1_E107_F | 0.995 |
| MCM2_P241_R | 0.995 |
| WNT2B_P1185_R | 0.994 |
| EIF2AK2_E103_R | 0.994 |
| IL1RN_E42_F | 0.994 |
| PLXDC1_E71_F | 0.993 |
| ID1_P880_F | 0.993 |
| MATK_P190_R | 0.993 |
| BCAM_P205_F | 0.993 |
| BAX_E281_R | 0.992 |
| SHB_P691_R | 0.992 |
| PCGF4_P760_R | 0.992 |
| MYLK_E132_R | 0.992 |
| TRIM29_E189_F | 0.991 |
| EMR3_P39_R | 0.991 |
| TFAP2C_P765_F | 0.991 |
| PENK_P447_R | 0.991 |
| NPR2_P618_F | 0.991 |
| DDR1_P332_R | 0.990 |
| TNFRSF10A_P171_F | 0.990 |
| CPA4_P961_R | 0.990 |
| STK11_P295_R | 0.990 |
| ICAM1_P119_R | 0.989 |
| DDB2_P407_F | 0.989 |
| TAL1_P594_F | 0.989 |
| SERPINB5_P19_R | 0.989 |
| TUBB3_E91_F | 0.989 |
| EMR3_E61_F | 0.989 |
| NTRK2_P395_R | 0.988 |
| SPDEF_P6_R | 0.988 |
| COL4A3_P545_F | 0.988 |
| IL8_P83_F | 0.987 |
| MAP3K1_P7_F | 0.987 |
| DSP_P36_F | 0.987 |
| AIM2_E208_F | 0.986 |
| CASP6_P230_R | 0.986 |
| GNMT_E126_F | 0.986 |
| THY1_P20_R | 0.986 |
| CSF3_P309_R | 0.986 |
| TFF2_P178_F | 0.986 |
| MMP10_E136_R | 0.985 |
| GSTM1_P266_F | 0.984 |
| EPS8_E231_F | 0.984 |
| DDR1_E23_R | 0.983 |
| NBL1_E205_R | 0.983 |
| APP_E8_F | 0.983 |
| SPDEF_E116_R | 0.983 |
| CAPG_E228_F | 0.982 |
| IPF1_P750_F | 0.982 |
| EPHB2_E297_F | 0.982 |
| CDH3_P87_R | 0.981 |
| MGMT_P272_R | 0.981 |
| EPHA2_P340_R | 0.980 |
| DLK1_E227_R | 0.980 |
| CYP1B1_E83_R | 0.980 |
| CDKN2B_seq_50_S294_F | 0.980 |
| SOX1_P1018_R | 0.980 |
| HLA-DPA1_P205_R | 0.980 |
| HBII-13_P991_R | 0.979 |
| SYK_E372_F | 0.979 |
| MME_P388_F | 0.979 |
| SRC_E100_R | 0.978 |
| VAMP8_P241_F | 0.978 |
| RYK_P493_F | 0.978 |
| IGF2AS_P203_F | 0.978 |
| RHOH_P121_F | 0.978 |
| CXCL9_E268_R | 0.978 |
| IFNG_E293_F | 0.978 |
| TFAP2C_E260_F | 0.977 |
| PTGS1_E80_F | 0.977 |
| WNT2B_P1195_F | 0.976 |
| VAV1_E9_F | 0.976 |
| TRIM29_P135_F | 0.975 |
| HOXA9_E252_R | 0.975 |
| FGFR3_E297_R | 0.974 |
| PDGFB_E25_R | 0.974 |
| P2RX7_P597_F | 0.974 |
| PSCA_E359_F | 0.973 |
| HDAC5_E298_F | 0.973 |
| CLDN4_P1120_R | 0.973 |
| ITGA2_E120_F | 0.973 |
| HOXA9_P1141_R | 0.972 |
| HIC-1_seq_48_S103_R | 0.972 |
| SLC14A1_E295_F | 0.972 |
| HOXA9_P303_F | 0.972 |
| BCL3_E71_F | 0.971 |
| PTCH_E42_F | 0.971 |
| APOC1_P406_R | 0.971 |
| NID1_P677_F | 0.971 |
| CRK_P721_F | 0.969 |
| MMP9_P237_R | 0.969 |
| HLA-DOB_E432_R | 0.969 |
| JAG1_P66_F | 0.969 |
| ITGB1_P451_F | 0.968 |
| FN1_P229_R | 0.968 |
| PI3_E107_F | 0.968 |
| FGFR2_P266_R | 0.967 |
| TMPRSS4_E83_F | 0.967 |
| PTPN6_E171_R | 0.966 |
| MMP14_P208_R | 0.966 |
| CCR5_P630_R | 0.966 |
| FRK_P258_F | 0.965 |
| ER_seq_a1_S60_F | 0.964 |
| IL18BP_E285_F | 0.964 |
| SFN_E118_F | 0.964 |
| INHA_P1189_F | 0.964 |
| NOS2A_E117_R | 0.964 |
| IFNGR1_P307_F | 0.962 |
| PTK7_E317_F | 0.962 |
| CDH17_P376_F | 0.961 |
| PRKAR1A_P337_R | 0.961 |
| MCC_P196_R | 0.961 |
| CDKN1B_P1161_F | 0.961 |
| HS3ST2_E145_R | 0.960 |
| CD9_E14_R | 0.960 |
| FRK_P36_F | 0.959 |
| RBP1_P426_R | 0.959 |
| CARD15_P302_R | 0.959 |
| TRIP6_P1090_F | 0.959 |
| SPP1_P647_F | 0.959 |
| RARB_P60_F | 0.959 |
| MYCN_P464_R | 0.958 |
| JAK3_P1075_R | 0.958 |
| FGFR3_P1152_R | 0.958 |
| B3GALT5_P330_F | 0.957 |
| FLJ20712_P984_R | 0.957 |
| MYBL2_P354_F | 0.957 |
| BMPR2_E435_F | 0.957 |
| PI3_P274_R | 0.956 |
| LIG3_P622_R | 0.956 |
| MBD2_P233_F | 0.956 |
| ITGB4_P517_F | 0.956 |
| CDH3_E100_R | 0.955 |
| INSR_P1063_R | 0.955 |
| SNCG_P98_R | 0.955 |
| MLH3_E72_F | 0.954 |
| BCR_P422_F | 0.954 |
| PYCARD_P150_F | 0.954 |
| EGR4_E70_F | 0.954 |
| TFDP1_P543_R | 0.953 |
| SFTPA1_E340_R | 0.953 |
| CTSH_P238_F | 0.952 |
| CTSD_P726_F | 0.951 |
| IL1RN_P93_R | 0.951 |
| ACVR1B_E497_R | 0.951 |
| PTPRH_P255_F | 0.951 |
| CPNE1_P138_F | 0.951 |
| ICA1_P61_F | 0.951 |
| IGFBP3_E65_R | 0.950 |
| SEMA3F_P692_R | 0.948 |
| KIAA1804_P689_R | 0.948 |
| AATK_E63_R | 0.948 |
| TUSC3_P85_R | 0.947 |
| EGF_P413_F | 0.947 |
| TIAM1_P117_F | 0.946 |
| RIPK4_E166_F | 0.946 |
| PHLDA2_E159_R | 0.946 |
| GABRA5_P1016_F | 0.946 |
| TJP1_P326_R | 0.945 |
| GAS1_P754_R | 0.944 |
| BMP3_P56_R | 0.944 |
| MST1R_E42_R | 0.944 |
| GATA6_P21_R | 0.944 |
| TFF1_P180_R | 0.943 |
| GSTM1_P363_F | 0.943 |
| APBA2_P305_R | 0.943 |
| THBS2_P605_R | 0.942 |
| WNT5A_P655_F | 0.942 |
| TWIST1_P355_R | 0.942 |
| PLAU_P11_F | 0.941 |
| PDE1B_E141_F | 0.941 |
| CCKAR_E79_F | 0.940 |
| p16_seq_47_S85_F | 0.940 |
| BCR_P346_F | 0.939 |
| CTLA4_P1128_F | 0.938 |
| PRSS8_E134_R | 0.938 |
| ATP10A_P147_F | 0.938 |
| CTSH_E157_R | 0.938 |
| BMP3_E147_F | 0.937 |
| PENK_E26_F | 0.936 |
| TSC2_E140_F | 0.936 |
| EPHA2_P203_F | 0.936 |
| KRT13_P341_R | 0.936 |
| CDKN1C_P6_R | 0.935 |
| EFNB3_P442_R | 0.935 |
| CASP10_E139_F | 0.935 |
| RIPK3_P24_F | 0.934 |
| S100A12_P1221_R | 0.934 |
| EVI2A_E420_F | 0.933 |
| CREBBP_P712_R | 0.933 |
| DLC1_P695_F | 0.932 |
| ZP3_P220_F | 0.931 |
| EPHB6_E342_F | 0.931 |
| SRC_P164_F | 0.930 |
| APP_P179_R | 0.930 |
| AXL_E61_F | 0.930 |
| HOXC6_P585_R | 0.930 |
| WNT5A_E43_F | 0.929 |
| TNFRSF10B_E198_R | 0.929 |
| CDH1_P45_F | 0.929 |
| IGF1_P933_F | 0.928 |
| AHR_P166_R | 0.928 |
| CCNA1_E7_F | 0.928 |
| CPA4_E20_F | 0.927 |
| WRN_E57_F | 0.927 |
| PSCA_P135_F | 0.926 |
| CDH17_E31_F | 0.926 |
| LRRK1_P39_F | 0.925 |
| GABRA5_P862_R | 0.925 |
| MAPK10_E26_F | 0.924 |
| SHB_P473_R | 0.923 |
| SEMA3F_E333_R | 0.923 |
| S100A2_E36_R | 0.923 |
| P2RX7_E323_R | 0.922 |
| IGFBP1_E48_R | 0.922 |
| NEU1_P745_F | 0.922 |
| NID1_P714_R | 0.921 |
| EPHB3_P569_R | 0.921 |
| UGT1A1_P315_R | 0.921 |
| ZIM2_E110_F | 0.921 |
| CASP10_P186_F | 0.921 |
| BCAM_E100_R | 0.920 |
| YES1_P600_F | 0.920 |
| IL12A_E287_R | 0.918 |
| NNAT_P544_R | 0.918 |
| COL1A1_P5_F | 0.917 |
| PITX2_P183_R | 0.916 |
| BMP4_P199_R | 0.916 |
| WNT10B_P823_R | 0.915 |
| SNCG_P53_F | 0.915 |
| PDGFA_P841_R | 0.914 |
| SOX17_P287_R | 0.914 |
| CDKN1A_E101_F | 0.914 |
| ABCA1_E120_R | 0.914 |
| ITK_P114_F | 0.914 |
| CD9_P504_F | 0.913 |
| PADI4_P1158_R | 0.913 |
| NPY_P295_F | 0.913 |
| DAPK1_E46_R | 0.913 |
| AIM2_P624_F | 0.911 |
| GPR116_E328_R | 0.911 |
| MYOD1_E156_F | 0.910 |
| SPI1_P929_F | 0.910 |
| GPX1_E46_R | 0.910 |
| SNCG_E119_F | 0.909 |
| HOXC6_P456_R | 0.909 |
| SOX1_P294_F | 0.909 |
| PITX2_E24_R | 0.909 |
| TYRO3_P501_F | 0.909 |
| HLA-DOA_P191_R | 0.909 |
| TFF2_P557_R | 0.907 |
| ESR1_P151_R | 0.907 |
| HLA-DPB1_E2_R | 0.907 |
| TESK2_P252_R | 0.906 |
| NOS2A_P288_R | 0.905 |
| KLK10_P268_R | 0.905 |
| ETV1_P235_F | 0.905 |
| TNFRSF1B_P167_F | 0.905 |
| SLIT2_P208_F | 0.905 |
| IFNGR2_P377_R | 0.904 |
| PLA2G2A_P528_F | 0.904 |
| FLT3_E326_R | 0.904 |
| LIF_P383_R | 0.904 |
| SIN3B_P607_F | 0.904 |
| MAF_E77_R | 0.904 |
| MCAM_P265_R | 0.904 |
| ALK_P28_F | 0.904 |
| ZNF264_P397_F | 0.904 |
| PDGFRB_P273_F | 0.903 |
| CSF1R_P73_F | 0.903 |
| PTCH2_E173_F | 0.902 |
| GLI2_P295_F | 0.901 |
| RARA_P1076_R | 0.900 |

SUPPLEMENTAL TABLE 12
CpG loci which contribute most strongly to Random Forests
classification of normal versus tumor bladder samples.

| GENE_CpG | Percent Increase in MSE |
|---|---|
| HPSE_P29_F | 14.92 |
| INSR_E97_F | 14.39 |
| MLH3_P25_F | 14.34 |
| TRAF4_P372_F | 14.25 |
| NPR2_P1093_F | 14.16 |
| MLF1_P97_F | 14.12 |
| KRAS_P651_F | 14.11 |
| VAMP8_E7_F | 14.04 |
| PPARD_P846_F | 13.97 |
| MCM2_P241_R | 13.79 |
| LAMB1_E144_R | 13.74 |
| COL6A1_P425_F | 13.73 |
| SERPINB5_P19_R | 13.73 |
| TK1_P62_R | 13.72 |
| EPHB4_E476_R | 13.65 |
| RARRES1_P57_R | 13.64 |
| HOXA9_P303_F | 13.62 |
| ABCG2_P178_R | 13.55 |
| TJP2_P518_F | 13.51 |
| IGSF4C_E65_F | 13.43 |
| MLH3_E72_F | 13.38 |
| COPG2_P298_F | 13.17 |
| DST_P262_R | 13.04 |
| MCM2_P260_F | 12.98 |
| IGF2R_P396_R | 12.96 |
| HPSE_P93_F | 12.90 |
| ABL2_P459_R | 12.81 |
| NTRK2_P395_R | 12.73 |
| ENC1_P484_R | 12.56 |
| CASP8_E474_F | 12.51 |
| MUC1_E18_R | 11.00 |
| IGF1R_P325_R | 10.95 |
| NOTCH3_P198_R | 10.75 |
| PTHR1_P258_F | 10.60 |
| PI3_P274_R | 10.37 |
| TRIM29_P261_F | 10.32 |
| ERCC6_P698_R | 10.31 |
| EMR3_P39_R | 10.31 |
| DHCR24_P406_R | 10.29 |
| KCNQ1_E349_R | 10.28 |
| CEACAM1_P44_R | 10.22 |
| ITGB4_E144_F | 10.11 |
| EPHA3_P106_R | 10.00 |
| CDKN1B_P1161_F | 9.96 |
| STK11_P295_R | 9.94 |
| NOS3_P38_F | 9.79 |
| EIF2AK2_E103_R | 9.69 |
| VAMP8_P114_F | 9.58 |
| PTPRH_E173_F | 9.49 |
| SFN_P248_F | 9.47 |
| CTNNA1_P382_R | 9.45 |
| SOX1_P1018_R | 9.43 |
| PCDH1_E22_F | 9.35 |
| CDH3_P87_R | 9.27 |
| NBL1_P24_F | 9.18 |
| CEACAM1_E57_R | 9.15 |
| TRIM29_E189_F | 9.11 |
| APOC1_P406_R | 9.08 |
| SFTPA1_E340_R | 8.99 |
| NBL1_E205_R | 8.97 |
| PTPN6_P282_R | 8.91 |
| APP_E8_F | 8.83 |
| ICAM1_P119_R | 8.63 |
| HLA-DOB_E432_R | 8.62 |
| FGFR2_P460_R | 8.42 |
| FER_E119_F | 8.37 |
| RASA1_E107_F | 8.06 |
| EMR3_E61_F | 7.93 |
| IL1B_P829_F | 7.93 |
| PTK6_E50_F | 7.90 |
| NID1_P677_F | 7.89 |
| ID1_P880_F | 7.88 |
| MMP7_E59_F | 7.69 |
| TFAP2C_P765_F | 7.57 |
| PTCH_E42_F | 7.13 |
| ACVR1C_P115_R | 7.10 |
| SHB_P691_R | 7.09 |
| CASP10_P186_F | 7.07 |
| GNMT_E126_F | 7.03 |
| TNFRSF10A_P91_F | 6.76 |
| HDAC1_P414_R | 6.54 |
| ETV1_P235_F | 6.42 |
| INHA_P1144_R | 6.40 |
| TRIM29_P135_F | 6.35 |
| S100A2_P1186_F | 6.25 |
| IGFBP1_P12_R | 6.23 |
| PENK_P447_R | 6.15 |
| TUBB3_P364_F | 6.12 |
| IFNGR1_P307_F | 5.98 |
| BAX_E281_R | 5.90 |
| MATK_P190_R | 5.78 |
| DDR1_P332_R | 5.72 |
| TJP2_P330_R | 5.71 |
| IL1RN_E42_F | 5.69 |
| SMARCA3_P109_R | 5.66 |
| WNT2B_P1195_F | 5.60 |
| PLXDC1_E71_F | 5.47 |
| DDB2_P407_F | 5.42 |
| CTSH_P238_F | 5.27 |
| AIM2_E208_F | 5.24 |
| INHA_P1189_F | 5.15 |
| TGFB2_P632_F | 5.11 |
| HS3ST2_E145_R | 5.03 |
| RYK_P493_F | 5.02 |

SUPPLEMENTAL TABLE 13
Locus by locus analysis of CpGs with significantly differential
methylation between normal bladder tissue and bladder tumor tissues.

| | Regression | | |
|---|---|---|---|
| GENE_CpG | Coefficient* | P-value | Q-Value |
| ABCG2_P178_R | −0.90 | 0.000000 | 0.000000 |
| ABL2_P459_R | −1.30 | 0.000000 | 0.000000 |
| ACVR1C_P115_R | −1.37 | 0.000000 | 0.000000 |
| CASP10_P186_F | −1.74 | 0.000000 | 0.000000 |
| CASP8_E474_F | −2.13 | 0.000000 | 0.000000 |
| CEACAM1_E57_R | −1.76 | 0.000000 | 0.000000 |
| COL6A1_P425_F | −1.23 | 0.000000 | 0.000000 |
| CTNNA1_P382_R | −0.91 | 0.000000 | 0.000000 |
| CTSH_P238_F | −1.39 | 0.000000 | 0.000000 |
| DHCR24_P406_R | −1.51 | 0.000000 | 0.000000 |
| DST_P262_R | −0.79 | 0.000000 | 0.000000 |
| EIF2AK2_E103_R | −0.92 | 0.000000 | 0.000000 |
| ENC1_P484_R | −0.78 | 0.000000 | 0.000000 |
| EPHB2_E297_F | −0.95 | 0.000000 | 0.000000 |
| EPHB4_E476_R | −2.41 | 0.000000 | 0.000000 |
| FER_E119_F | −1.67 | 0.000000 | 0.000000 |
| FGFR2_P460_R | −1.72 | 0.000000 | 0.000000 |
| GNMT_E126_F | −0.97 | 0.000000 | 0.000000 |
| HPSE_P29_F | −1.94 | 0.000000 | 0.000000 |
| HPSE_P93_F | −1.02 | 0.000000 | 0.000000 |
| ICA1_P61_F | −0.84 | 0.000000 | 0.000000 |
| ICAM1_P119_R | −1.42 | 0.000000 | 0.000000 |
| IGF1R_P325_R | −0.78 | 0.000000 | 0.000000 |
| IGF2R_P396_R | −1.60 | 0.000000 | 0.000000 |
| INHA_P1144_R | −1.07 | 0.000000 | 0.000000 |
| INSR_E97_F | −0.92 | 0.000000 | 0.000000 |
| ITGB4_E144_F | −1.07 | 0.000000 | 0.000000 |
| KCNQ1_E349_R | −1.01 | 0.000000 | 0.000000 |
| LAMB1_E144_R | −1.44 | 0.000000 | 0.000000 |
| MCM2_P241_R | −1.09 | 0.000000 | 0.000000 |
| MCM2_P260_F | −1.42 | 0.000000 | 0.000000 |
| MLF1_P97_F | −2.24 | 0.000000 | 0.000000 |
| MLH3_P25_F | −1.81 | 0.000000 | 0.000000 |
| MMP7_E59_F | −1.83 | 0.000000 | 0.000000 |
| NPR2_P1093_F | 1.50 | 0.000000 | 0.000000 |
| PCDH1_E22_F | −0.76 | 0.000000 | 0.000000 |
| PPARD_P846_F | −2.03 | 0.000000 | 0.000000 |
| PTCH_E42_F | −0.81 | 0.000000 | 0.000000 |
| RASA1_E107_F | −0.88 | 0.000000 | 0.000000 |
| TFAP2C_P765_F | −1.16 | 0.000000 | 0.000000 |
| TGFB2_P632_F | −0.80 | 0.000000 | 0.000000 |
| TJP2_P518_F | 3.38 | 0.000000 | 0.000000 |
| TK1_P62_R | −1.34 | 0.000000 | 0.000000 |
| TNFRSF10A_P91_F | −1.59 | 0.000000 | 0.000000 |
| TRAF4_P372_F | −1.64 | 0.000000 | 0.000000 |
| VAMP8_P114_F | −2.24 | 0.000000 | 0.000000 |
| WNT2B_P1195_F | −1.00 | 0.000000 | 0.000000 |
| ID1_P880_F | −1.29 | 0.000000 | 0.000000 |
| IL1B_P829_F | 1.21 | 0.000000 | 0.000000 |
| ITGA2_E120_F | −1.13 | 0.000000 | 0.000000 |
| AHR_P166_R | −1.16 | 0.000000 | 0.000000 |
| PDGFA_P841_R | −0.79 | 0.000000 | 0.000000 |
| STK11_P295_R | −1.55 | 0.000000 | 0.000000 |
| PTK6_E50_F | −1.97 | 0.000000 | 0.000000 |
| SFN_P248_F | −1.43 | 0.000000 | 0.000000 |
| PLXDC1_E71_F | −1.01 | 0.000000 | 0.000000 |
| FGFR2_P266_R | −1.01 | 0.000000 | 0.000000 |
| HDAC1_P414_R | −2.14 | 0.000000 | 0.000000 |
| IGSF4C_E65_F | −1.94 | 0.000000 | 0.000000 |
| DSP_P36_F | −1.26 | 0.000000 | 0.000000 |
| MGMT_P272_R | −1.12 | 0.000000 | 0.000000 |
| ERCC6_P698_R | −1.58 | 0.000000 | 0.000000 |
| TNFRSF10A_P171_F | −1.39 | 0.000000 | 0.000000 |
| MAP3K1_P7_F | −1.16 | 0.000000 | 0.000000 |
| MUC1_E18_R | −2.14 | 0.000000 | 0.000000 |
| CD9_E14_R | −0.78 | 0.000000 | 0.000000 |
| FER_P581_F | 1.82 | 0.000000 | 0.000000 |
| CEACAM1_P44_R | −1.83 | 0.000000 | 0.000000 |
| KRAS_P651_F | −0.73 | 0.000000 | 0.000000 |
| MYCN_E77_R | −0.77 | 0.000000 | 0.000000 |
| BCAM_P205_F | −1.03 | 0.000000 | 0.000000 |
| APP_E8_F | −0.87 | 0.000000 | 0.000000 |
| EPS8_E231_F | −0.92 | 0.000000 | 0.000000 |
| SHB_P691_R | −1.41 | 0.000000 | 0.000000 |
| CPA4_P961_R | 0.87 | 0.000000 | 0.000000 |
| INHA_P1189_F | −0.94 | 0.000000 | 0.000000 |
| NBL1_P24_F | −2.22 | 0.000000 | 0.000000 |
| TYRO3_P501_F | −1.09 | 0.000000 | 0.000000 |
| CAPG_E228_F | −1.71 | 0.000000 | 0.000000 |
| PTPRH_E173_F | −1.76 | 0.000000 | 0.000000 |
| TNFSF10_E53_F | −1.30 | 0.000000 | 0.000000 |
| JAG1_P66_F | −0.82 | 0.000000 | 0.000000 |
| DDR1_E23_R | −1.12 | 0.000000 | 0.000000 |
| PHLDA2_P622_F | −1.38 | 0.000000 | 0.000000 |
| CPNE1_P138_F | −1.16 | 0.000000 | 0.000000 |
| NOTCH3_P198_R | −1.70 | 0.000000 | 0.000000 |
| PCGF4_P760_R | −1.21 | 0.000000 | 0.000000 |
| WRN_E57_F | −0.97 | 0.000000 | 0.000000 |
| RIPK3_P124_F | −1.82 | 0.000000 | 0.000000 |
| VAMP8_E7_F | −1.51 | 0.000000 | 0.000000 |
| SHB_P473_R | −0.68 | 0.000000 | 0.000000 |
| BCL3_E71_F | −1.07 | 0.000000 | 0.000000 |
| RARRES1_P57_R | −1.62 | 0.000000 | 0.000000 |
| GAS1_P754_R | −0.58 | 0.000000 | 0.000000 |
| PRKAR1A_P337_R | −0.86 | 0.000000 | 0.000000 |
| SYK_E372_F | −0.73 | 0.000000 | 0.000000 |
| COPG2_P298_F | 1.43 | 0.000000 | 0.000000 |
| WNT2B_P1185_R | −1.12 | 0.000000 | 0.000000 |
| PTHR1_P258_F | −1.79 | 0.000000 | 0.000000 |
| EMR3_E61_F | −1.79 | 0.000000 | 0.000000 |
| IGFBP1_P12_R | −2.16 | 0.000000 | 0.000000 |
| CCND1_P343_R | −1.26 | 0.000000 | 0.000000 |
| CASP6_P230_R | −1.22 | 0.000000 | 0.000000 |
| PAX6_E129_F | −1.06 | 0.000000 | 0.000000 |
| MATK_P190_R | −1.82 | 0.000000 | 0.000000 |
| PHLDA2_E159_R | −0.70 | 0.000000 | 0.000000 |
| CDH3_E100_R | −0.80 | 0.000000 | 0.000000 |
| APP_P179_R | −0.83 | 0.000000 | 0.000001 |
| EPHA3_P106_R | 2.65 | 0.000000 | 0.000001 |
| PKD2_P287_R | −0.77 | 0.000000 | 0.000001 |
| SPDEF_E116_R | −1.64 | 0.000000 | 0.000001 |
| EFNB3_P442_R | −0.80 | 0.000000 | 0.000001 |
| RIPK4_E166_F | −1.04 | 0.000000 | 0.000001 |
| BAX_E281_R | −1.40 | 0.000000 | 0.000001 |
| AXL_E61_F | −1.08 | 0.000000 | 0.000001 |
| HBII-13_P991_R | 0.77 | 0.000000 | 0.000001 |
| RHOH_P121_F | 1.14 | 0.000000 | 0.000001 |
| PTGS1_E80_F | −0.86 | 0.000000 | 0.000001 |
| FGFR3_E297_R | −0.49 | 0.000000 | 0.000002 |
| CDH1_P45_F | −1.09 | 0.000000 | 0.000002 |
| MMP14_P208_R | −1.33 | 0.000000 | 0.000002 |
| GSTM1_P363_F | 1.01 | 0.000001 | 0.000003 |
| CDKN1A_E101_F | −0.63 | 0.000001 | 0.000003 |
| MMP9_P237_R | −0.77 | 0.000001 | 0.000003 |
| MYCN_P464_R | −0.49 | 0.000001 | 0.000003 |
| SEMA3F_E333_R | −1.14 | 0.000001 | 0.000004 |
| SEMA3F_P692_R | −0.70 | 0.000001 | 0.000004 |
| DDB2_P407_F | −1.01 | 0.000001 | 0.000004 |
| TJP2_P330_R | 2.96 | 0.000001 | 0.000005 |
| S100A2_P1186_F | −2.47 | 0.000001 | 0.000005 |
| PTPN6_P282_R | −2.32 | 0.000001 | 0.000006 |
| IL8_P83_F | −2.01 | 0.000001 | 0.000006 |
| DST_E31_F | −0.75 | 0.000001 | 0.000006 |
| NOS3_P38_F | −2.57 | 0.000002 | 0.000007 |
| DDR1_P332_R | −1.89 | 0.000002 | 0.000007 |
| EMR3_P39_R | −1.82 | 0.000002 | 0.000007 |
| MLF1_E243_F | 2.13 | 0.000002 | 0.000007 |
| TUBB3_E91_F | −1.56 | 0.000002 | 0.000007 |
| JAG2_E54_F | −0.54 | 0.000002 | 0.000008 |
| EDN1_P39_R | −0.36 | 0.000002 | 0.000008 |
| KLK10_P268_R | −0.88 | 0.000002 | 0.000008 |
| SPDEF_P6_R | −1.45 | 0.000002 | 0.000009 |
| ACVR1B_E497_R | −0.75 | 0.000002 | 0.000009 |
| HDAC5_E298_F | −0.83 | 0.000002 | 0.000009 |
| COL4A3_P545_F | −0.61 | 0.000003 | 0.000013 |
| TIAM1_P117_F | −0.95 | 0.000003 | 0.000013 |
| BMPR1A_P956_F | −0.73 | 0.000003 | 0.000013 |
| BMPR2_E435_F | 0.76 | 0.000003 | 0.000014 |
| INSR_P1063_R | −1.28 | 0.000004 | 0.000015 |
| GSTM1_P266_F | 1.56 | 0.000004 | 0.000015 |
| TRIM29_P261_F | −3.08 | 0.000004 | 0.000015 |
| MYLK_E132_R | −1.53 | 0.000004 | 0.000017 |
| IL1RN_E42_F | −2.32 | 0.000004 | 0.000017 |
| BCAM_E100_R | −0.47 | 0.000005 | 0.000018 |
| B3GALT5_P330_F | 0.55 | 0.000006 | 0.000021 |
| EPHA2_P340_R | −1.23 | 0.000006 | 0.000021 |
| TYK2_P494_F | −1.42 | 0.000006 | 0.000021 |
| PDGFB_E25_R | −0.89 | 0.000006 | 0.000023 |
| IPF1_P750_F | 2.03 | 0.000007 | 0.000025 |
| HBEGF_P32_R | −0.66 | 0.000007 | 0.000025 |
| HLA-DPA1_P205_R | −1.38 | 0.000007 | 0.000026 |
| WNT5A_E43_F | −0.63 | 0.000008 | 0.000028 |
| ER_seq_a1_S60_F | −1.04 | 0.000009 | 0.000031 |
| IL12A_E287_R | −0.53 | 0.000010 | 0.000034 |
| AIM2_E208_F | −1.91 | 0.000010 | 0.000035 |
| CRK_P721_F | −1.09 | 0.000010 | 0.000036 |
| CDH3_P87_R | 1.14 | 0.000010 | 0.000037 |
| FN1_P229_R | 0.93 | 0.000011 | 0.000037 |
| TRIM29_E189_F | −2.23 | 0.000013 | 0.000044 |
| TFDP1_P543_R | 0.74 | 0.000013 | 0.000045 |
| CCR5_P630_R | −1.21 | 0.000013 | 0.000046 |
| ITGB1_P451_F | −0.93 | 0.000016 | 0.000053 |
| MTA1_P478_F | −0.78 | 0.000017 | 0.000056 |
| NPR2_P618_F | 2.41 | 0.000017 | 0.000056 |
| THY1_P20_R | −1.23 | 0.000018 | 0.000058 |
| VAMP8_P241_F | −1.48 | 0.000018 | 0.000060 |
| SMARCA4_P362_R | −0.47 | 0.000019 | 0.000064 |
| GNMT_P197_F | −0.71 | 0.000020 | 0.000065 |
| EPHB2_P165_R | −0.96 | 0.000020 | 0.000066 |
| CDKN2B_seq_50_S294_F | 2.21 | 0.000021 | 0.000067 |
| TNFRSF10B_E198_R | −0.67 | 0.000021 | 0.000067 |
| ITGB4_P517_F | −0.82 | 0.000021 | 0.000067 |
| MMP10_E136_R | −1.52 | 0.000021 | 0.000068 |
| ACTG2_P346_F | 1.21 | 0.000022 | 0.000068 |
| CSF3_P309_R | −1.81 | 0.000024 | 0.000077 |
| EGR4_E70_F | −0.88 | 0.000028 | 0.000087 |
| EPHB6_E342_F | −1.06 | 0.000029 | 0.000089 |
| IL8_E118_R | −1.02 | 0.000029 | 0.000089 |
| ACVR2B_E27_R | −0.63 | 0.000031 | 0.000094 |
| PYCARD_P150_F | 1.20 | 0.000032 | 0.000097 |
| AREG_E25_F | −0.45 | 0.000032 | 0.000099 |
| IGFBP3_E65_R | 1.07 | 0.000039 | 0.000119 |
| IL18BP_E285_F | 0.65 | 0.000041 | 0.000124 |
| FANCF_P13_F | −0.57 | 0.000042 | 0.000128 |
| TJP1_P326_R | −0.80 | 0.000044 | 0.000133 |
| TFF2_P178_F | −2.25 | 0.000047 | 0.000139 |
| IFNG_E293_F | −1.65 | 0.000047 | 0.000140 |
| SRC_E100_R | −1.98 | 0.000050 | 0.000146 |
| EPHA1_P119_R | −0.82 | 0.000050 | 0.000148 |
| NCL_P840_R | −0.84 | 0.000053 | 0.000154 |
| NBL1_E205_R | −2.06 | 0.000053 | 0.000155 |
| EPM2A_P64_R | −0.55 | 0.000054 | 0.000155 |
| CTTN_E29_R | −0.84 | 0.000054 | 0.000155 |
| IFNGR1_P307_F | 0.81 | 0.000058 | 0.000164 |
| VAV1_E9_F | −1.90 | 0.000058 | 0.000164 |
| BMP3_P56_R | −0.45 | 0.000061 | 0.000171 |
| PTPN6_E171_R | −1.50 | 0.000061 | 0.000171 |
| EGF_E339_F | 1.30 | 0.000070 | 0.000196 |
| SKI_E465_R | −0.41 | 0.000071 | 0.000196 |
| CLDN4_P1120_R | −1.87 | 0.000071 | 0.000196 |
| RARB_P60_F | −1.17 | 0.000083 | 0.000228 |
| IGF2AS_P203_F | 1.90 | 0.000086 | 0.000237 |
| PSIP1_P163_R | −0.88 | 0.000086 | 0.000237 |
| APOC1_P406_R | −1.15 | 0.000087 | 0.000237 |
| GAS1_E22_F | −0.62 | 0.000091 | 0.000247 |
| CXCL9_E268_R | −2.11 | 0.000094 | 0.000254 |
| MCC_P196_R | 0.69 | 0.000097 | 0.000260 |
| MBD2_P233_F | −1.12 | 0.000101 | 0.000270 |
| HLA-DOB_E432_R | −1.49 | 0.000101 | 0.000270 |
| TAL1_P594_F | 2.69 | 0.000102 | 0.000271 |
| PENK_P447_R | 2.83 | 0.000110 | 0.000289 |
| CYP1B1_E83_R | 1.93 | 0.000111 | 0.000291 |
| DAPK1_P345_R | −0.86 | 0.000112 | 0.000293 |
| EVI2A_E420_F | 0.90 | 0.000115 | 0.000300 |
| PSCA_E359_F | −1.42 | 0.000120 | 0.000311 |
| RYK_P493_F | 2.41 | 0.000121 | 0.000314 |
| ABCA1_E120_R | −0.60 | 0.000132 | 0.000339 |
| FRK_P36_F | −1.61 | 0.000133 | 0.000342 |
| NTRK2_P395_R | 2.87 | 0.000146 | 0.000370 |
| CTSH_E157_R | 0.80 | 0.000146 | 0.000370 |
| PTK7_E317_F | −1.33 | 0.000155 | 0.000391 |
| p16_seq_47_S85_F | −1.06 | 0.000161 | 0.000405 |
| MME_P388_F | 2.63 | 0.000165 | 0.000413 |
| FZD9_P15_R | −0.99 | 0.000176 | 0.000439 |
| THBS2_P605_R | −1.58 | 0.000177 | 0.000440 |
| EXT1_E197_F | −0.71 | 0.000193 | 0.000477 |
| IL1RN_P93_R | −1.45 | 0.000197 | 0.000486 |
| SNCG_P98_R | −1.13 | 0.000205 | 0.000503 |
| FRK_P258_F | −1.68 | 0.000206 | 0.000503 |
| KIAA1804_P689_R | −0.92 | 0.000212 | 0.000517 |
| TRIM29_P135_F | −2.16 | 0.000216 | 0.000522 |
| HIC-1_seq_48_S103_R | 1.58 | 0.000222 | 0.000537 |
| CDKN1C_P6_R | −0.71 | 0.000240 | 0.000576 |
| CPA4_E20_F | −1.23 | 0.000268 | 0.000638 |
| IGFBP1_E48_R | −1.49 | 0.000268 | 0.000638 |
| CASP10_E139_F | −1.25 | 0.000275 | 0.000652 |
| PDE1B_E141_F | −0.73 | 0.000293 | 0.000693 |
| LIG3_P622_R | −1.38 | 0.000299 | 0.000704 |
| SLC14A1_E295_F | −2.08 | 0.000312 | 0.000732 |
| JAK3_P1075_R | −1.56 | 0.000314 | 0.000733 |
| PLAU_P11_F | −0.95 | 0.000326 | 0.000759 |
| MYBL2_P354_F | −1.30 | 0.000331 | 0.000767 |
| FLI20712_P984_R | −1.47 | 0.000338 | 0.000778 |
| DLC1_P695_F | −1.26 | 0.000339 | 0.000778 |
| CTSD_P726_F | −1.08 | 0.000360 | 0.000825 |
| TFAP2C_E260_F | 2.63 | 0.000375 | 0.000855 |
| CARD15_P302_R | −1.21 | 0.000378 | 0.000859 |
| EPHA2_P203_F | −1.23 | 0.000386 | 0.000873 |
| SNCG_P53_F | −1.41 | 0.000397 | 0.000894 |
| ERBB3_E331_F | −0.78 | 0.000403 | 0.000904 |
| BMP3_E147_F | −0.78 | 0.000413 | 0.000924 |
| SERPINB5_P19_R | −3.04 | 0.000418 | 0.000931 |
| HOXA9_P1141_R | 1.54 | 0.000426 | 0.000946 |
| BCR_P422_F | −1.46 | 0.000447 | 0.000988 |
| DAB2IP_E18_R | −0.58 | 0.000473 | 0.001041 |
| BCR_P346_F | −1.32 | 0.000476 | 0.001044 |
| DSP_P440_R | −0.87 | 0.000495 | 0.001082 |
| TSC2_E140_F | −1.08 | 0.000503 | 0.001096 |
| SPP1_P647_F | −1.71 | 0.000519 | 0.001127 |
| TFF1_P180_R | −1.47 | 0.000525 | 0.001135 |
| TUSC3_P85_R | −0.94 | 0.000536 | 0.001155 |
| SFN_E118_F | −2.05 | 0.000564 | 0.001211 |
| TRIP6_P1090_F | −1.78 | 0.000569 | 0.001217 |
| RIPK4_P172_F | −0.63 | 0.000610 | 0.001299 |
| GPX1_E46_R | −0.60 | 0.000614 | 0.001304 |
| FGFR3_P1152_R | −1.43 | 0.000630 | 0.001332 |
| NOS2A_E117_R | −2.07 | 0.000636 | 0.001340 |
| IGF1_P933_F | −1.12 | 0.000677 | 0.001421 |
| CTLA4_P1128_F | −1.08 | 0.000690 | 0.001443 |
| RIPK3_P24_F | −1.36 | 0.000718 | 0.001495 |
| EPHB3_P569_R | −0.69 | 0.000720 | 0.001495 |
| ERCC1_P440_R | −0.60 | 0.000763 | 0.001581 |
| DLK1_E227_R | 2.80 | 0.000795 | 0.001639 |
| MAF_E77_R | −0.67 | 0.000811 | 0.001667 |
| BMP2_P1201_F | −0.94 | 0.000829 | 0.001698 |
| P2RX7_P597_F | −2.74 | 0.000855 | 0.001746 |
| P2RX7_E323_R | −0.71 | 0.000873 | 0.001776 |
| RBP1_P426_R | 1.92 | 0.000878 | 0.001779 |
| NID1_P677_F | −2.46 | 0.000902 | 0.001822 |
| MYB_P673_R | −0.65 | 0.000909 | 0.001826 |
| LRRK1_P39_F | −0.56 | 0.000910 | 0.001826 |
| EVI1_E47_R | −0.74 | 0.000923 | 0.001845 |
| PADI4_P1158_R | −1.15 | 0.000944 | 0.001881 |
| MAPK10_E26_F | −1.52 | 0.000955 | 0.001897 |
| TMPRSS4_E83_F | −2.48 | 0.001014 | 0.002006 |
| TIMP2_E394_R | −0.35 | 0.001061 | 0.002087 |
| EPHA1_E46_R | −0.72 | 0.001062 | 0.002087 |
| HDAC7A_P344_F | 0.45 | 0.001069 | 0.002094 |
| S100A12_P1221_R | 0.58 | 0.001093 | 0.002135 |
| PI3_E107_F | −2.33 | 0.001124 | 0.002187 |
| LAT_E46_F | 0.87 | 0.001137 | 0.002204 |
| RIPK1_P744_R | 0.79 | 0.001154 | 0.002231 |
| DAPK1_E46_R | −0.87 | 0.001166 | 0.002246 |
| CDH17_P376_F | −2.39 | 0.001187 | 0.002279 |
| ERBB4_P255_F | −0.44 | 0.001275 | 0.002434 |
| EGF_P413_F | −1.74 | 0.001276 | 0.002434 |
| ACVR2B_P676_F | −0.60 | 0.001323 | 0.002516 |
| S100A2_E36_R | −0.79 | 0.001482 | 0.002809 |
| NOS2A_P288_R | −1.17 | 0.001503 | 0.002840 |
| WNT5A_P655_F | 2.57 | 0.001508 | 0.002840 |
| MLH3_E72_F | 1.90 | 0.001530 | 0.002867 |
| MST1R_E42_R | −1.70 | 0.001532 | 0.002867 |
| BMP4_P199_R | −1.27 | 0.001546 | 0.002883 |
| PRSS8_E134_R | −1.67 | 0.001635 | 0.003040 |
| MCAM_P265_R | −0.68 | 0.001653 | 0.003064 |
| PDGFRB_P273_F | −1.02 | 0.001720 | 0.003178 |
| APBA2_P305_R | −1.74 | 0.001741 | 0.003206 |
| PI3_P274_R | −2.12 | 0.001774 | 0.003256 |
| YES1_P600_F | 1.50 | 0.001847 | 0.003381 |
| PSCA_P135_F | −1.26 | 0.001854 | 0.003382 |
| PTPRH_P255_F | −2.10 | 0.001878 | 0.003415 |
| PPARG_E178_R | −0.32 | 0.001977 | 0.003576 |
| ABCA1_P45_F | −0.62 | 0.001979 | 0.003576 |
| ZIM2_E110_F | 0.74 | 0.002078 | 0.003744 |
| CAV2_E33_R | −0.44 | 0.002103 | 0.003778 |
| EPO_P162_R | −1.15 | 0.002134 | 0.003821 |
| CSF1R_P73_F | −1.03 | 0.002147 | 0.003833 |
| ZP3_P220_F | −1.39 | 0.002237 | 0.003981 |
| SNCG_E119_F | −1.16 | 0.002290 | 0.004063 |
| IHH_P529_F | −0.49 | 0.002300 | 0.004070 |
| IFNGR2_P377_R | 1.32 | 0.002326 | 0.004101 |
| MMP9_P189_F | −1.03 | 0.002334 | 0.004101 |
| CDH1_P52_R | −0.68 | 0.002339 | 0.004101 |
| KLF5_E190_R | −0.66 | 0.002414 | 0.004219 |
| GATA6_P21_R | −1.00 | 0.002540 | 0.004426 |
| SEMA3C_E49_R | −0.68 | 0.002578 | 0.004479 |
| PENK_E26_F | 1.59 | 0.002614 | 0.004528 |
| COL1A1_P5_F | 1.18 | 0.002716 | 0.004691 |
| PTCH2_E173_F | −0.84 | 0.002895 | 0.004986 |
| CREBBP_P712_R | −1.64 | 0.002981 | 0.005119 |
| SRC_P164_F | −1.74 | 0.003173 | 0.005432 |
| HOXC6_P585_R | 1.50 | 0.003214 | 0.005486 |
| LIF_P383_R | −0.95 | 0.003225 | 0.005489 |
| FOLR1_E368_R | 0.48 | 0.003252 | 0.005509 |
| IRF5_E101_F | 0.80 | 0.003255 | 0.005509 |
| HLA-DOA_P191_R | −1.02 | 0.003311 | 0.005587 |
| ATP10A_P147_F | 1.87 | 0.003442 | 0.005790 |
| COL18A1_P494_R | −1.07 | 0.003487 | 0.005850 |
| SOX1_P1018_R | 3.40 | 0.003538 | 0.005918 |
| SPI1_P929_F | −1.00 | 0.003630 | 0.006054 |
| TWIST1_P355_R | 2.19 | 0.003648 | 0.006067 |
| MXI1_P75_R | −0.72 | 0.003694 | 0.006113 |
| PLAUR_E123_F | −0.32 | 0.003697 | 0.006113 |
| CCKAR_E79_F | −1.96 | 0.003736 | 0.006161 |
| ETS1_P559_R | −0.36 | 0.003785 | 0.006224 |
| NNAT_P544_R | 0.81 | 0.003837 | 0.006293 |
| SMAD2_P848_R | −0.70 | 0.004038 | 0.006603 |
| SOX17_P287_R | 1.42 | 0.004059 | 0.006619 |
| KRT13_P341_R | −2.14 | 0.004079 | 0.006634 |
| HS3ST2_E145_R | 2.68 | 0.004175 | 0.006771 |
| GABRA5_P1016_F | −2.11 | 0.004192 | 0.006779 |
| CDKN1B_P1161_F | 2.85 | 0.004289 | 0.006888 |
| TNFRSF1B_P167_F | −0.96 | 0.004294 | 0.006888 |
| ZNF264_P397_F | 1.00 | 0.004294 | 0.006888 |
| UGT1A1_P315_R | −1.63 | 0.004343 | 0.006946 |
| TK1_E47_F | 0.54 | 0.004497 | 0.007174 |
| ETV6_E430_F | 0.80 | 0.004590 | 0.007301 |
| WNT10B_P823_R | −1.23 | 0.004614 | 0.007320 |
| CASP6_P201_F | −0.72 | 0.004915 | 0.007756 |
| HLA-DPB1_E2_R | −1.17 | 0.004920 | 0.007756 |
| PLA2G2A_P528_F | −1.12 | 0.004929 | 0.007756 |
| HOXA9_E252_R | 3.16 | 0.004956 | 0.007778 |
| GNG7_E310_R | 0.58 | 0.004986 | 0.007803 |
| PITX2_P183_R | 1.55 | 0.005098 | 0.007958 |
| IRF5_P123_F | −0.38 | 0.005189 | 0.008078 |
| PLAUR_P82_F | −0.53 | 0.005291 | 0.008214 |
| THBS1_E207_R | 0.62 | 0.005335 | 0.008262 |
| EDN1_E50_R | 0.85 | 0.005405 | 0.008347 |
| JAK2_P772_R | −0.79 | 0.005564 | 0.008570 |
| CDH17_E31_F | −2.09 | 0.005812 | 0.008929 |
| ITK_P114_F | −1.58 | 0.005867 | 0.008983 |
| LY6G6E_P45_R | −1.30 | 0.005878 | 0.008983 |
| TGFA_P642_R | −0.54 | 0.006026 | 0.009185 |
| RARA_P1076_R | −1.26 | 0.006143 | 0.009339 |
| PKD2_P336_R | −0.49 | 0.006180 | 0.009372 |
| SMAD2_P708_R | −0.30 | 0.006199 | 0.009375 |
| KLF5_P13_F | −0.62 | 0.006385 | 0.009632 |
| GLI2_P295_F | −1.20 | 0.006417 | 0.009636 |
| GABRA5_P862_R | −1.71 | 0.006421 | 0.009636 |
| NID1_P714_R | −1.95 | 0.006747 | 0.010093 |
| SPP1_E140_R | −0.95 | 0.006760 | 0.010093 |
| AATK_E63_R | −2.65 | 0.006785 | 0.010105 |
| MGMT_P281_F | −0.40 | 0.007025 | 0.010435 |
| GPR116_E328_R | −1.77 | 0.007152 | 0.010587 |
| EPHA5_P66_F | 1.00 | 0.007166 | 0.010587 |
| CTNNA1_P185_R | −0.42 | 0.007181 | 0.010587 |
| TRPM5_P721_F | −1.11 | 0.007361 | 0.010824 |
| CDK10_P199_R | −0.73 | 0.007450 | 0.010928 |
| ICA1_P72_R | −0.46 | 0.007610 | 0.011113 |
| ESR1_P151_R | 1.67 | 0.007648 | 0.011113 |
| FGFR4_P610_F | −1.22 | 0.007656 | 0.011113 |
| CD34_P339_R | 0.74 | 0.007666 | 0.011113 |
| CD9_P504_F | 1.80 | 0.007672 | 0.011113 |
| IL12B_P1453_F | −1.07 | 0.007831 | 0.011316 |
| ZAP70_P220_R | −0.92 | 0.007872 | 0.011347 |
| AIM2_P624_F | −1.60 | 0.008154 | 0.011724 |
| DCC_E53_R | 1.21 | 0.008226 | 0.011800 |
| LIG4_P194_F | −0.41 | 0.008322 | 0.011908 |
| TFF2_P557_R | −1.79 | 0.008410 | 0.012000 |
| LCN2_P86_R | −1.38 | 0.008428 | 0.012000 |
| TESK2_P252_R | 1.70 | 0.008595 | 0.012194 |
| MLLT6_P957_F | −0.60 | 0.008606 | 0.012194 |
| SFTPA1_E340_R | −3.13 | 0.008634 | 0.012205 |
| IHH_P246_R | −0.54 | 0.008983 | 0.012668 |
| LCN2_P141_R | −1.41 | 0.009336 | 0.013133 |
| TNFRSF10B_P108_R | −0.57 | 0.009494 | 0.013324 |
| FES_E34_R | −0.96 | 0.009543 | 0.013359 |
| CD34_P780_R | −0.91 | 0.009868 | 0.013781 |
| SLC22A18_P472_R | 0.61 | 0.010237 | 0.014263 |
| HOXA9_P303_F | 3.60 | 0.010269 | 0.014273 |
| DNAJC15_P65_F | 0.57 | 0.010630 | 0.014740 |
| JAG2_P264_F | −0.40 | 0.010668 | 0.014757 |
| CASP10_P334_F | −0.74 | 0.011116 | 0.015341 |
| ELL_P693_F | −1.04 | 0.011261 | 0.015505 |
| PITX2_E24_R | 1.71 | 0.011459 | 0.015704 |
| DSG1_P159_R | −1.16 | 0.011460 | 0.015704 |
| DUSP4_P925_R | 1.12 | 0.011505 | 0.015729 |
| HOXC6_P456_R | 1.65 | 0.011556 | 0.015762 |
| PTGS2_P524_R | 1.12 | 0.011628 | 0.015823 |
| PDE1B_P263_R | 1.68 | 0.012706 | 0.017250 |
| DDB2_P613_R | 1.02 | 0.013101 | 0.017745 |
| PTHLH_P15_R | −1.16 | 0.013273 | 0.017936 |
| NEU1_P745_F | 2.24 | 0.013342 | 0.017988 |
| SOX17_P303_F | 1.67 | 0.013592 | 0.018283 |
| FGF1_E5_F | −1.15 | 0.013716 | 0.018407 |
| GLI3_E148_R | 0.49 | 0.014037 | 0.018795 |
| PLAGL1_P334_F | 0.61 | 0.014308 | 0.019048 |
| NAT2_P11_F | 0.75 | 0.014320 | 0.019048 |
| ALK_P28_F | −0.96 | 0.014326 | 0.019048 |
| SIN3B_P607_F | 0.69 | 0.014356 | 0.019048 |
| NPY_P295_F | 2.01 | 0.014576 | 0.019295 |
| IL2_P607_R | −1.22 | 0.014664 | 0.019369 |
| TERT_P360_R | 1.79 | 0.014931 | 0.019676 |
| ALPL_P433_F | 0.95 | 0.015004 | 0.019727 |
| CSF2_E248_R | −1.67 | 0.015178 | 0.019912 |
| CCNA1_E7_F | 2.64 | 0.015347 | 0.020088 |
| SRC_P297_F | −1.52 | 0.015743 | 0.020542 |
| RARRES1_P426_R | −0.92 | 0.015764 | 0.020542 |
| HOXA11_P698_F | 1.66 | 0.015881 | 0.020649 |
| TCF7L2_P193_R | 0.94 | 0.016138 | 0.020936 |
| OGG1_E400_F | −1.01 | 0.016210 | 0.020974 |
| KRT5_P308_F | −1.23 | 0.016239 | 0.020974 |
| CHFR_P501_F | −0.62 | 0.016392 | 0.021124 |
| NQO1_E74_R | 1.40 | 0.016475 | 0.021184 |
| WNT8B_P216_R | 0.39 | 0.016764 | 0.021510 |
| HSD17B12_E145_R | −0.39 | 0.016998 | 0.021761 |
| LIF_E208_F | −0.26 | 0.017342 | 0.022154 |
| TMEFF2_P210_R | 1.43 | 0.017680 | 0.022536 |
| OSM_P34_F | −1.20 | 0.017742 | 0.022566 |
| TMEFF2_P152_R | 1.66 | 0.018033 | 0.022886 |
| SOX1_P294_F | 2.16 | 0.018308 | 0.023185 |
| ESR2_P162_F | −0.63 | 0.018932 | 0.023923 |
| GSTM2_P453_R | 0.88 | 0.019014 | 0.023975 |
| JAK3_P156_R | 1.32 | 0.019289 | 0.024269 |
| MYOD1_E156_F | 2.46 | 0.019334 | 0.024274 |
| FLT3_E326_R | 2.17 | 0.019570 | 0.024517 |
| CD34_E20_R | −0.52 | 0.019759 | 0.024701 |
| ABCC5_P444_F | −0.46 | 0.019937 | 0.024870 |
| TRPM5_P979_F | −1.62 | 0.020010 | 0.024907 |
| BSG_P211_R | −0.76 | 0.020209 | 0.025102 |
| TAL1_P817_F | 0.78 | 0.020559 | 0.025483 |
| FGFR1_E317_F | −0.37 | 0.021156 | 0.026166 |
| H19_P1411_R | −1.21 | 0.021369 | 0.026374 |
| NOTCH3_E403_F | 1.87 | 0.021510 | 0.026492 |
| APBA2_P227_F | −1.92 | 0.021681 | 0.026617 |
| DCC_P471_R | 1.86 | 0.021703 | 0.026617 |
| GLI2_E90_F | −1.58 | 0.021883 | 0.026782 |
| CDH11_P354_R | 1.12 | 0.022092 | 0.026981 |
| HDAC11_P556_F | −0.49 | 0.022411 | 0.027314 |
| DES_P1006_R | −0.79 | 0.023085 | 0.028061 |
| PTHLH_E251_F | −0.84 | 0.023120 | 0.028061 |
| BDNF_P259_R | 1.25 | 0.023219 | 0.028123 |
| SLIT2_P208_F | 2.19 | 0.023277 | 0.028134 |
| VAV2_P1182_F | 0.36 | 0.023363 | 0.028180 |
| HTR1B_P107_F | −1.13 | 0.023509 | 0.028267 |
| CSF2_P605_F | −1.46 | 0.023532 | 0.028267 |
| NOTCH2_P312_R | −0.35 | 0.023764 | 0.028451 |
| ACVR1C_P363_F | −0.91 | 0.023809 | 0.028451 |
| ESR1_E298_R | −0.72 | 0.023864 | 0.028451 |
| FGF1_P357_R | −0.99 | 0.023880 | 0.028451 |
| ITPR2_P804_F | 0.71 | 0.023951 | 0.028477 |
| SEMA3A_P658_R | −0.66 | 0.024125 | 0.028626 |
| EPHA8_P456_R | −1.05 | 0.024815 | 0.029385 |
| HCK_P858_F | 1.22 | 0.024869 | 0.029390 |
| DLL1_P832_F | 1.33 | 0.024954 | 0.029430 |
| BMP6_P163_F | −0.75 | 0.025012 | 0.029439 |
| EPS8_P437_F | −0.48 | 0.025183 | 0.029580 |
| CCNA1_P216_F | 2.03 | 0.025372 | 0.029743 |
| ERCC1_P354_F | −0.40 | 0.025473 | 0.029802 |
| LEFTY2_P561_F | 0.65 | 0.025606 | 0.029897 |
| PWCR1_P357_F | −0.60 | 0.026077 | 0.030387 |
| MST1R_P87_R | −1.05 | 0.026820 | 0.031190 |
| TGFBR3_E188_R | −0.47 | 0.026917 | 0.031241 |
| CSF1R_E26_F | −1.34 | 0.027384 | 0.031720 |
| CSK_P740_R | −0.64 | 0.028023 | 0.032392 |
| FOSL2_E384_R | −0.95 | 0.028076 | 0.032392 |
| MEG3_E91_F | 0.68 | 0.028144 | 0.032407 |
| GFAP_P1214_F | 0.63 | 0.028629 | 0.032866 |
| PADI4_E24_F | −1.24 | 0.028656 | 0.032866 |
| SERPINA5_P156_F | −0.76 | 0.028730 | 0.032887 |
| HLA-DRA_P77_R | −0.90 | 0.028803 | 0.032905 |
| NGFB_E353_F | −0.72 | 0.028982 | 0.033045 |
| UBA52_P293_R | 1.86 | 0.029060 | 0.033071 |
| ABCG2_P310_R | −0.36 | 0.029338 | 0.033321 |
| ETV1_P235_F | 2.29 | 0.029498 | 0.033438 |
| WNT10B_P993_F | −0.89 | 0.029716 | 0.033620 |
| SPARC_P195_F | 1.01 | 0.030936 | 0.034933 |
| SEMA3C_P642_F | −1.09 | 0.031939 | 0.035995 |
| TFRC_P414_R | 1.19 | 0.032087 | 0.036093 |
| DIO3_E230_R | 0.77 | 0.032778 | 0.036737 |
| AOC3_P890_R | −0.80 | 0.032832 | 0.036737 |
| TMEFF1_P234_F | 0.85 | 0.032848 | 0.036737 |
| MMP19_E274_R | −0.96 | 0.033497 | 0.037391 |
| EPHB1_P503_F | 1.08 | 0.033597 | 0.037403 |
| KIAA0125_E29_F | −1.06 | 0.033636 | 0.037403 |
| PTPNS1_P301_R | −0.44 | 0.033720 | 0.037425 |
| CYP2E1_P416_F | −2.11 | 0.033809 | 0.037452 |
| DNAJC15_E26_R | 1.12 | 0.033947 | 0.037535 |
| TWIST1_P44_R | 2.12 | 0.035115 | 0.038752 |
| ROR1_P6_F | 0.76 | 0.035599 | 0.039212 |
| ERBB4_P541_F | −0.42 | 0.035854 | 0.039297 |
| GRB7_P160_R | −0.69 | 0.035953 | 0.039297 |
| DNMT1_P100_R | 0.86 | 0.035965 | 0.039297 |
| ST6GAL1_P528_F | 2.02 | 0.035969 | 0.039297 |
| FVT1_P225_F | −0.55 | 0.036013 | 0.039297 |
| CCL3_P543_R | −0.95 | 0.036372 | 0.039615 |
| CSPG2_P82_R | 1.40 | 0.037499 | 0.040767 |
| KRT5_E196_R | −2.00 | 0.038665 | 0.041956 |
| SFTPA1_P421_F | −0.92 | 0.038848 | 0.042076 |
| CHFR_P635_R | −0.23 | 0.039059 | 0.042185 |
| TCF4_P317_F | 1.49 | 0.039093 | 0.042185 |
| EYA4_E277_F | 1.40 | 0.039614 | 0.042668 |
| LAMC1_P808_F | 1.07 | 0.039977 | 0.042981 |
| NEFL_P209_R | 1.51 | 0.040064 | 0.042994 |
| EDNRB_P709_R | −1.99 | 0.040169 | 0.043028 |
| SH3BP2_E18_F | −0.70 | 0.040523 | 0.043327 |
| SYK_P584_F | −0.66 | 0.040905 | 0.043657 |
| GP1BB_P278_R | −1.03 | 0.041121 | 0.043806 |
| MC2R_E455_F | −1.90 | 0.041831 | 0.044482 |
| B3GALT5_E246_R | −0.92 | 0.042345 | 0.044947 |
| SPI1_E205_F | 0.40 | 0.042446 | 0.044972 |
| ERN1_P809_R | −1.03 | 0.043701 | 0.046218 |
| ZIM3_P718_R | −1.41 | 0.044043 | 0.046495 |
| HDAC9_P137_R | 1.11 | 0.044490 | 0.046882 |
| NOTCH4_E4_F | −0.93 | 0.045992 | 0.048378 |
| HOXA5_P1324_F | 0.91 | 0.046268 | 0.048580 |
| EPHB1_E202_R | −0.66 | 0.046952 | 0.049190 |
| TEK_E75_F | −0.90 | 0.047017 | 0.049190 |
| RARRES1_E235_F | −0.77 | 0.047130 | 0.049220 |
| DUSP4_E61_F | −0.39 | 0.047370 | 0.049382 |
| MCM6_E136_F | −0.44 | 0.047758 | 0.049698 |
| DSG1_E292_F | −0.56 | 0.047869 | 0.049725 |
| IAPP_E280_F | −1.32 | 0.048108 | 0.049885 |

*Positive coefficient indicates higher methylation in bladder tumors relative to normal bladder tissues

SUPPLEMENTAL TABLE 14
Comparing methylation of CpG loci between normal
bladder tissue and bladder tumors, those loci with a
q-value < 1 × 10⁻⁶ (n = 107), an AUC of ≧0.98, and a
percent change to the RF MSE ≧5% were compared and 65
loci were identified to overlap between these 3 approaches.
GENE_CpG

| | |
|---|---|
| ABCG2_P178_R | MLH3_P25_F |
| ABL2_P459_R | MMP7_E59_F |
| ACVR1C_P115_R | MUC1_E18_R |
| APP_E8_F | NBL1_P24_F |
| CASP8_E474_F | NOTCH3_P198_R |
| CEACAM1_E57_R | NPR2_P1093_F |
| CEACAM1_P44_R | PCDH1_E22_F |
| COL6A1_P425_F | PLXDC1_E71_F |
| COPG2_P298_F | PPARD_P846_F |
| CTNNA1_P382_R | PTHR1_P258_F |
| DHCR24_P406_R | PTK6_E50_F |
| DST_P262_R | PTPRH_E173_F |
| EIF2AK2_E103_R | RARRES1_P57_R |
| EMR3_E61_F | RASA1_E107_F |
| ENC1_P484_R | SFN_P248_F |
| EPHB4_E476_R | SHB_P691_R |
| ERCC6_P698_R | STK11_P295_R |
| FER_E119_F | TFAP2C_P765_F |
| FGFR2_P460_R | TGFB2_P632_F |
| GNMT_E126_F | TJP2_P518_F |
| HDAC1_P414_R | TK1_P62_R |
| HPSE_P29_F | TNFRSF10A_P91_F |
| HPSE_P93_F | TRAF4_P372_F |
| ICAM1_P119_R | VAMP8_E7_F |
| ID1_P880_F | VAMP8_P114_F |
| IGF1R_P325_R | |
| IGF2R_P396_R | |
| IGFBP1_P12_R | |
| IGSF4C_E65_F | |
| IL1B_P829_F | |
| INHA_P1144_R | |
| INSR_E97_F | |
| ITGB4_E144_F | |
| KCNQ1_E349_R | |
| KRAS_P651_F | |
| LAMB1_E144_R | |
| MATK_P190_R | |
| MCM2_P241_R | |
| MCM2_P260_F | |
| MLF1_P97_F | |

SUPPLEMENTAL TABLE 15
Locus by locus analysis of CpG loci with differential methylation
in invasive bladder tumors relative to non-invasive
tumors from tumor series 1 and tumor series 2.

| Series 1 | | | | Series 2 | | | |
|---|---|---|---|---|---|---|---|
| | Regression | | | | Regression | | |
| GENE_CpG | coefficient* | P-value | Q-value | GENE_CpG | coefficient* | P-value | Q-value |
| SLC14A1_E295_F | 1.34 | 0 | 0 | GP1BB_P278_R | 1.39 | 0 | 0 |
| RARA_P1076_R | 1.42 | 0 | 1.00E−06 | SLIT2_E111_R | 1.14 | 0 | 0 |
| EGF_P413_F | 1.09 | 0 | 1.00E−06 | FGF3_E198_R | 1.55 | 0 | 0 |
| KRT13_P341_R | 1.21 | 0 | 1.00E−06 | STAT5A_P704_R | 1.15 | 0 | 0 |
| CSF1R_P73_F | 0.92 | 0 | 1.00E−06 | CDH11_E102_R | 1.57 | 0 | 0 |
| FGFR4_P610_F | 0.89 | 0 | 2.00E−06 | KRT13_P341_R | 1.02 | 0 | 0 |
| UGT1A1_P315_R | 1.04 | 0 | 3.00E−06 | FGF1_P357_R | 0.92 | 0 | 0 |
| STAT5A_P704_R | 1.22 | 0 | 4.00E−06 | SLIT2_P208_F | 1.38 | 0 | 0 |
| MAP3K1_P7_F | 0.52 | 0 | 5.00E−06 | EYA4_E277_F | 1.30 | 0 | 0 |
| IRF5_P123_F | 0.35 | 0 | 6.00E−06 | RASSF1_E116_F | 1.63 | 0 | 0 |
| RIPK1_P868_F | 0.83 | 0 | 6.00E−06 | HOXB2_P488_R | 1.22 | 0 | 0 |
| CSF1R_E26_F | 1.01 | 0 | 7.00E−06 | CSF3_P309_R | 0.92 | 0 | 0 |
| TEK_E75_F | 1.09 | 0 | 7.00E−06 | CDH13_E102_F | 1.29 | 0 | 0 |
| FGF1_P357_R | 1.00 | 0 | 7.00E−06 | HPN_P374_R | 1.03 | 0 | 0 |
| TRPM5_P979_F | 1.20 | 0 | 7.00E−06 | TNFRSF10C_P7_F | 1.04 | 0 | 0 |
| SNCG_E119_F | 1.05 | 0 | 1.00E−05 | TERT_P360_R | 0.92 | 0 | 0 |
| AATK_E63_R | 1.25 | 1.00E−06 | 1.80E−05 | HS3ST2_P171_F | 1.25 | 0 | 0 |
| SLC14A1_P369_R | 1.15 | 1.00E−06 | 1.90E−05 | SOX1_P294_F | 1.20 | 0 | 0 |
| FGF1_E5_F | 0.91 | 1.00E−06 | 2.40E−05 | TPEF_seq_44_S36_F | 1.13 | 0 | 0 |
| CSF2_P605_F | 1.07 | 1.00E−06 | 2.50E−05 | NTSR1_P318_F | 1.21 | 0 | 0 |
| HPN_P374_R | 1.10 | 1.00E−06 | 3.00E−05 | DES_E228_R | 1.02 | 0 | 0 |
| CSF3_P309_R | 1.09 | 1.00E−06 | 3.40E−05 | NOTCH4_E4_F | 1.06 | 0 | 0 |
| TMPRSS4_E83_F | 0.99 | 2.00E−06 | 5.20E−05 | FGF3_P171_R | 1.29 | 0 | 0 |
| AIM2_E208_F | 0.60 | 3.00E−06 | 6.60E−05 | GDF10_P95_R | 1.19 | 0 | 0 |
| AATK_P519_R | 1.07 | 3.00E−06 | 6.80E−05 | VIM_P343_R | 1.26 | 0 | 0 |
| CDH17_P376_F | 0.95 | 4.00E−06 | 7.30E−05 | MST1R_E42_R | 1.01 | 0 | 0 |
| MMP7_E59_F | 0.62 | 4.00E−06 | 8.00E−05 | GAS7_P622_R | 1.17 | 0 | 0 |
| THBS2_P605_R | 0.87 | 4.00E−06 | 8.00E−05 | VAV1_E9_F | 1.08 | 0 | 0 |
| KLK10_P268_R | 0.47 | 6.00E−06 | 0.000113 | RASSF1_P244_F | 1.53 | 0 | 0 |
| TFF2_P178_F | 0.96 | 9.00E−06 | 0.000163 | TNFRSF10C_E109_F | 1.06 | 0 | 0 |
| CLDN4_P1120_R | 0.82 | 9.00E−06 | 0.000164 | AGTR1_P41_F | 1.30 | 0 | 0 |
| JAG2_P264_F | 0.35 | 1.10E−05 | 0.000183 | IRAK3_P13_F | 1.44 | 0 | 0 |
| MMP19_E274_R | 0.75 | 1.20E−05 | 0.000198 | TEK_E75_F | 0.96 | 0 | 0 |
| KRT13_P676_F | 1.13 | 1.30E−05 | 0.000214 | RIPK1_P868_F | 1.16 | 0 | 0 |
| MDR1_seq_42_S300_R | 1.76 | 1.60E−05 | 0.000218 | CDH13_P88_F | 1.06 | 0 | 0 |
| NOS2A_P288_R | 0.76 | 1.60E−05 | 0.000218 | THY1_P149_R | 0.92 | 0 | 0 |
| CLK1_P538_F | 0.63 | 1.60E−05 | 0.000218 | CHGA_E52_F | 1.00 | 0 | 0 |
| ER_seq_a1_S60_F | 0.64 | 1.60E−05 | 0.000218 | FRZB_E186_R | 1.26 | 0 | 0 |
| KRT5_P308_F | 0.81 | 1.60E−05 | 0.000218 | AGTR1_P154_F | 1.10 | 0 | 0 |
| CPA4_E20_F | 0.80 | 1.60E−05 | 0.000218 | EYA4_P794_F | 1.11 | 0 | 0 |
| SLC14A1_E295_F | 1.34 | 0 | 0 | GP1BB_P278_R | 1.39 | 0 | 0 |
| RARA_P1076_R | 1.42 | 0 | 1.00E−06 | SLIT2_E111_R | 1.14 | 0 | 0 |
| EGF_P413_F | 1.09 | 0 | 1.00E−06 | FGF3_E198_R | 1.55 | 0 | 0 |
| KRT13_P341_R | 1.21 | 0 | 1.00E−06 | STAT5A_P704_R | 1.15 | 0 | 0 |
| CSF1R_P73_F | 0.92 | 0 | 1.00E−06 | CDH11_E102_R | 1.57 | 0 | 0 |
| FGFR4_P610_F | 0.89 | 0 | 2.00E−06 | KRT13_P341_R | 1.02 | 0 | 0 |
| UGT1A1_P315_R | 1.04 | 0 | 3.00E−06 | FGF1_P357_R | 0.92 | 0 | 0 |
| STAT5A_P704_R | 1.22 | 0 | 4.00E−06 | SLIT2_P208_F | 1.38 | 0 | 0 |
| MAP3K1_P7_F | 0.52 | 0 | 5.00E−06 | EYA4_E277_F | 1.30 | 0 | 0 |
| IRF5_P123_F | 0.35 | 0 | 6.00E−06 | RASSF1_E116_F | 1.63 | 0 | 0 |
| RIPK1_P868_F | 0.83 | 0 | 6.00E−06 | HOXB2_P488_R | 1.22 | 0 | 0 |
| CSF1R_E26_F | 1.01 | 0 | 7.00E−06 | CSF3_P309_R | 0.92 | 0 | 0 |
| TEK_E75_F | 1.09 | 0 | 7.00E−06 | CDH13_E102_F | 1.29 | 0 | 0 |
| FGF1_P357_R | 1.00 | 0 | 7.00E−06 | HPN_P374_R | 1.03 | 0 | 0 |
| TRPM5_P979_F | 1.20 | 0 | 7.00E−06 | TNFRSF10C_P7_F | 1.04 | 0 | 0 |
| SNCG_E119_F | 1.05 | 0 | 1.00E−05 | TERT_P360_R | 0.92 | 0 | 0 |
| AATK_E63_R | 1.25 | 1.00E−06 | 1.80E−05 | HS3ST2_P171_F | 1.25 | 0 | 0 |
| SLC14A1_P369_R | 1.15 | 1.00E−06 | 1.90E−05 | SOX1_P294_F | 1.20 | 0 | 0 |
| FGF1_E5_F | 0.91 | 1.00E−06 | 2.40E−05 | TPEF_seq_44_S36_F | 1.13 | 0 | 0 |
| CSF2_P605_F | 1.07 | 1.00E−06 | 2.50E−05 | NTSR1_P318_F | 1.21 | 0 | 0 |
| HPN_P374_R | 1.10 | 1.00E−06 | 3.00E−05 | DES_E228_R | 1.02 | 0 | 0 |
| CSF3_P309_R | 1.09 | 1.00E−06 | 3.40E−05 | NOTCH4_E4_F | 1.06 | 0 | 0 |
| TMPRSS4_E83_F | 0.99 | 2.00E−06 | 5.20E−05 | FGF3_P171_R | 1.29 | 0 | 0 |
| AIM2_E208_F | 0.60 | 3.00E−06 | 6.60E−05 | GDF10_P95_R | 1.19 | 0 | 0 |
| AATK_P519_R | 1.07 | 3.00E−06 | 6.80E−05 | VIM_P343_R | 1.26 | 0 | 0 |
| CDH17_P376_F | 0.95 | 4.00E−06 | 7.30E−05 | MST1R_E42_R | 1.01 | 0 | 0 |
| MMP7_E59_F | 0.62 | 4.00E−06 | 8.00E−05 | GAS7_P622_R | 1.17 | 0 | 0 |
| THBS2_P605_R | 0.87 | 4.00E−06 | 8.00E−05 | VAV1_E9_F | 1.08 | 0 | 0 |
| KLK10_P268_R | 0.47 | 6.00E−06 | 0.000113 | RASSF1_P244_F | 1.53 | 0 | 0 |
| TFF2_P178_F | 0.96 | 9.00E−06 | 0.000163 | TNFRSF10C_E109_F | 1.06 | 0 | 0 |
| CLDN4_P1120_R | 0.82 | 9.00E−06 | 0.000164 | AGTR1_P41_F | 1.30 | 0 | 0 |
| JAG2_P264_F | 0.35 | 1.10E−05 | 0.000183 | IRAK3_P13_F | 1.44 | 0 | 0 |
| MMP19_E274_R | 0.75 | 1.20E−05 | 0.000198 | TEK_E75_F | 0.96 | 0 | 0 |
| KRT13_P676_F | 1.13 | 1.30E−05 | 0.000214 | RIPK1_P868_F | 1.16 | 0 | 0 |
| MDR1_seq_42_S300_R | 1.76 | 1.60E−05 | 0.000218 | CDH13_P88_F | 1.06 | 0 | 0 |
| NOS2A_P288_R | 0.76 | 1.60E−05 | 0.000218 | THY1_P149_R | 0.92 | 0 | 0 |
| CLK1_P538_F | 0.63 | 1.60E−05 | 0.000218 | CHGA_E52_F | 1.00 | 0 | 0 |
| ER_seq_a1_S60_F | 0.64 | 1.60E−05 | 0.000218 | FRZB_E186_R | 1.26 | 0 | 0 |
| KRT5_P308_F | 0.81 | 1.60E−05 | 0.000218 | AGTR1_P154_F | 1.10 | 0 | 0 |
| CPA4_E20_F | 0.80 | 1.60E−05 | 0.000218 | EYA4_P794_F | 1.11 | 0 | 0 |
| P2RX7_P597_F | 0.97 | 1.80E−05 | 0.00024 | NPY_E31_R | 1.05 | 0 | 0 |
| IRF7_E236_R | 1.00 | 2.10E−05 | 0.000268 | CDH11_P203_R | 1.27 | 0 | 0 |
| DUSP4_E61_F | 0.42 | 2.20E−05 | 0.000274 | HHIP_E94_F | 1.11 | 0 | 0 |
| SFTPA1_E340_R | 0.96 | 2.20E−05 | 0.000274 | GALR1_E52_F | 1.19 | 0 | 0 |
| HPN_P823_F | 0.98 | 2.50E−05 | 0.000284 | SFRP1_P157_F | 1.25 | 0 | 0 |
| HOXB2_P99_F | 1.30 | 2.50E−05 | 0.000284 | NPY_P295_F | 1.21 | 0 | 0 |
| TRIM29_E189_F | 0.76 | 2.50E−05 | 0.000284 | TMEFF2_E94_R | 1.09 | 0 | 0 |
| ACVR1C_P115_R | 0.41 | 2.50E−05 | 0.000284 | SFRP1_E398_R | 1.56 | 0 | 0 |
| CXCL9_E268_R | 0.80 | 2.60E−05 | 0.000284 | HOXB2_P99_F | 1.09 | 0 | 0 |
| HOXA5_E187_F | 1.17 | 2.90E−05 | 0.000306 | RARA_P1076_R | 0.84 | 0 | 0 |
| JAK3_P1075_R | 0.74 | 2.90E−05 | 0.000306 | DBC1_E204_F | 1.07 | 0 | 0 |
| FRZB_E186_R | 1.16 | 3.20E−05 | 0.000327 | PADI4_P1158_R | 0.79 | 0 | 0 |
| TUSC3_E29_R | 0.89 | 3.20E−05 | 0.000327 | NRG1_P558_R | 1.18 | 0 | 0 |
| PSCA_P135_F | 0.76 | 3.30E−05 | 0.000329 | PYCARD_P150_F | 0.90 | 0 | 0 |
| TFF1_P180_R | 0.76 | 3.50E−05 | 0.000342 | SLC5A8_E60_R | 0.96 | 0 | 0 |
| TRIM29_P135_F | 0.70 | 3.80E−05 | 0.000365 | MOS_E60_R | 1.09 | 0 | 0 |
| NBL1_P24_F | 0.76 | 3.90E−05 | 0.000372 | TERT_E20_F | 1.03 | 0 | 0 |
| RARA_P176_R | 0.90 | 4.10E−05 | 0.000386 | EYA4_P508_F | 1.02 | 0 | 0 |
| UGT1A1_E11_F | 1.17 | 4.30E−05 | 0.000394 | S100A4_E315_F | 0.92 | 0 | 0 |
| TSC2_E140_F | 0.80 | 4.90E−05 | 0.000446 | EPHA5_E158_R | 1.07 | 0 | 0 |
| CDH17_E31_F | 0.91 | 5.20E−05 | 0.000459 | TAL1_E122_F | 1.11 | 0 | 0 |
| SERPINB5_P19_R | 0.86 | 5.30E−05 | 0.000459 | SMO_E57_F | 1.29 | 0 | 0 |
| MBD2_P233_F | 0.55 | 5.70E−05 | 0.000487 | ISL1_E87_R | 1.09 | 0 | 0 |
| BMP2_P1201_F | 0.71 | 5.80E−05 | 0.000493 | LY6G6E_P45_R | 0.82 | 0 | 0 |
| SIN3B_P607_F | −0.67 | 5.90E−05 | 0.000493 | PALM2-AKAP2_P183_R | 0.88 | 0 | 0 |
| LY6G6E_P45_R | 0.88 | 6.20E−05 | 0.000506 | IRAK3_E130_F | 1.28 | 0 | 0 |
| CSF2_E248_R | 0.81 | 6.40E−05 | 0.000506 | TPEF_seq_44_S88_R | 0.97 | 0 | 0 |
| USP29_P282_R | −0.34 | 6.40E−05 | 0.000506 | MST1R_P392_F | 1.04 | 0 | 0 |
| SYK_P584_F | 0.57 | 6.50E−05 | 0.000506 | ETV1_P235_F | 1.01 | 0 | 0 |
| GPR116_E328_R | 0.75 | 7.00E−05 | 0.000539 | FLI1_P620_R | 0.97 | 0 | 1.00E−06 |
| SRC_P164_F | 0.72 | 7.30E−05 | 0.000559 | FGF1_E5_F | 0.80 | 0 | 1.00E−06 |
| FRK_P258_F | 0.80 | 7.80E−05 | 0.000579 | NTSR1_E109_F | 1.28 | 0 | 1.00E−06 |
| PTPN6_P282_R | 0.66 | 7.80E−05 | 0.000579 | HS3ST2_E145_R | 0.93 | 0 | 1.00E−06 |
| DDIT3_P1313_R | 1.07 | 8.10E−05 | 0.000594 | DIO3_P90_F | 0.65 | 0 | 1.00E−06 |
| SRC_E100_R | 0.83 | 8.60E−05 | 0.000622 | HTR1B_P222_F | 1.24 | 0 | 1.00E−06 |
| CALCA_P171_F | 0.69 | 9.00E−05 | 0.000637 | AATK_E63_R | 0.86 | 0 | 1.00E−06 |
| PTHR1_P258_F | 0.57 | 9.30E−05 | 0.000654 | GALR1_P80_F | 1.07 | 0 | 1.00E−06 |
| PCDH1_E22_F | 0.15 | 9.50E−05 | 0.00066 | TMEFF2_P152_R | 0.93 | 0 | 1.00E−06 |
| SPDEF_E116_R | 0.74 | 9.60E−05 | 0.00066 | STAT5A_E42_F | 0.89 | 0 | 1.00E−06 |
| NOS2A_E117_R | 0.73 | 1.00E−04 | 0.000675 | ISL1_P379_F | 1.00 | 0 | 1.00E−06 |
| MUC1_E18_R | 0.55 | 0.000105 | 0.000702 | IRAK3_P185_F | 1.05 | 0 | 1.00E−06 |
| ALOX12_E85_R | 1.04 | 0.000114 | 0.00075 | DLK1_E227_R | 1.07 | 0 | 1.00E−06 |
| TRIM29_P261_F | 0.92 | 0.000117 | 0.000764 | CSPG2_P82_R | 0.79 | 0 | 1.00E−06 |
| FRK_P36_F | 0.84 | 0.00012 | 0.000775 | FGFR4_P610_F | 0.74 | 0 | 1.00E−06 |
| NRG1_P558_R | 1.44 | 0.000126 | 0.000803 | POMC_P400_R | 1.07 | 0 | 1.00E−06 |
| HOXA5_P479_F | 0.72 | 0.000128 | 0.000804 | FLT4_E206_F | 0.93 | 0 | 1.00E−06 |
| ACVR1_P983_F | 0.80 | 0.000131 | 0.000813 | FLI1_E29_F | 0.90 | 0 | 1.00E−06 |
| HS3ST2_P171_F | 1.20 | 0.000143 | 0.000879 | THY1_P20_R | 0.67 | 0 | 1.00E−06 |
| IGFBP1_P12_R | 0.85 | 0.000145 | 0.000881 | SEPT9_P374_F | 0.90 | 0 | 1.00E−06 |
| ESR1_E298_R | 0.70 | 0.000147 | 0.000882 | EGF_P413_F | 0.71 | 0 | 1.00E−06 |
| SNCG_P53_F | 0.85 | 0.000149 | 0.000884 | CDH11_P354_R | 0.89 | 0 | 1.00E−06 |
| IGFBP1_E48_R | 0.72 | 0.000153 | 9.00E−04 | PDGFRB_P343_F | 1.19 | 0 | 1.00E−06 |
| TGFB3_E58_R | 0.84 | 0.000171 | 0.000994 | NOS2A_P288_R | 0.72 | 0 | 2.00E−06 |
| IGSF4_P86_R | 1.08 | 0.000177 | 0.001019 | MST1R_P87_R | 0.83 | 0 | 2.00E−06 |
| RHOH_P121_F | −0.55 | 0.000192 | 0.001091 | PENK_E26_F | 0.80 | 0 | 2.00E−06 |
| ACVR1_E328_R | 1.10 | 0.000201 | 0.001127 | FES_P223_R | 1.09 | 0 | 2.00E−06 |
| IL1RN_E42_F | 0.72 | 0.000202 | 0.001127 | HS3ST2_P546_F | 0.84 | 0 | 2.00E−06 |
| HLA-DOB_E432_R | 0.50 | 0.000208 | 0.001149 | DCC_P471_R | 0.92 | 0 | 2.00E−06 |
| BCR_P346_F | 0.80 | 0.000228 | 0.001246 | FRZB_P406_F | 1.31 | 0 | 2.00E−06 |
| GABRG3_P75_F | −0.81 | 0.000231 | 0.001252 | IGF2_P1036_R | 0.81 | 0 | 2.00E−06 |
| SEPT5_P464_R | 0.81 | 0.00024 | 0.001283 | MMP2_P197_F | 0.75 | 0 | 2.00E−06 |
| IGF1R_P325_R | 0.17 | 0.000248 | 0.001302 | CSF2_P605_F | 0.88 | 0 | 2.00E−06 |
| DAPK1_E46_R | 0.61 | 0.000248 | 0.001302 | WT1_E32_F | 1.11 | 0 | 2.00E−06 |
| NBL1_E205_R | 0.71 | 0.00026 | 0.001346 | BCR_P422_F | 0.80 | 0 | 2.00E−06 |
| PSCA_E359_F | 0.75 | 0.000262 | 0.001346 | IGFBP1_P12_R | 0.87 | 1.00E−06 | 3.00E−06 |
| PTPRO_P371_F | 0.96 | 0.000264 | 0.001346 | MT1A_P49_R | 1.27 | 1.00E−06 | 3.00E−06 |
| VAV1_P317_F | 0.71 | 0.00027 | 0.001362 | FABP3_P598_F | 0.69 | 1.00E−06 | 3.00E−06 |
| CHI3L2_E10_F | −0.64 | 0.000278 | 0.001393 | PRKCDBP_E206_F | 1.08 | 1.00E−06 | 3.00E−06 |
| CSPG2_P82_R | 0.94 | 0.000295 | 0.00145 | JAK3_E64_F | 0.92 | 1.00E−06 | 3.00E−06 |
| MOS_E60_R | 1.10 | 0.000295 | 0.00145 | UGT1A1_E11_F | 0.92 | 1.00E−06 | 3.00E−06 |
| MMP10_E136_R | 0.69 | 0.000303 | 0.001478 | TBX1_P520_F | 0.70 | 1.00E−06 | 3.00E−06 |
| EYA4_E277_F | 1.04 | 0.000316 | 0.001524 | IPF1_P750_F | 1.07 | 1.00E−06 | 4.00E−06 |
| NOTCH4_E4_F | 0.94 | 0.000322 | 0.001541 | KRT13_P676_F | 0.95 | 1.00E−06 | 4.00E−06 |
| WNT8B_P216_R | −0.31 | 0.000331 | 0.001556 | CD9_P504_F | 0.67 | 1.00E−06 | 4.00E−06 |
| AATK_P709_R | 0.80 | 0.000331 | 0.001556 | FLT1_P615_R | 1.05 | 1.00E−06 | 5.00E−06 |
| SFN_E118_F | 0.67 | 0.000336 | 0.001564 | HCK_P46_R | 1.00 | 1.00E−06 | 5.00E−06 |
| PLAT_P80_F | 0.77 | 0.00034 | 0.001569 | PTPRG_P476_F | 1.20 | 1.00E−06 | 5.00E−06 |
| VAMP8_P241_F | 0.56 | 0.000357 | 0.001635 | OPCML_E219_R | 1.06 | 1.00E−06 | 5.00E−06 |
| CEACAM1_P44_R | 0.50 | 0.000372 | 0.001691 | SLC5A5_E60_F | 0.73 | 1.00E−06 | 5.00E−06 |
| NEFL_P209_R | 0.97 | 0.000378 | 0.001704 | CSF3R_P8_F | 0.77 | 1.00E−06 | 5.00E−06 |
| COL18A1_P365_R | 0.71 | 0.000384 | 0.001716 | ASCL2_E76_R | 0.92 | 1.00E−06 | 5.00E−06 |
| SEPT5_P441_F | 0.86 | 0.000387 | 0.001716 | BMP4_P199_R | 0.70 | 1.00E−06 | 5.00E−06 |
| GJB2_P931_R | 0.94 | 0.00039 | 0.001716 | OPCML_P71_F | 0.70 | 1.00E−06 | 5.00E−06 |
| GUCY2D_E419_R | 1.24 | 0.00041 | 0.001786 | SPP1_E140_R | 0.66 | 1.00E−06 | 5.00E−06 |
| TERT_P360_R | 0.82 | 0.000423 | 0.001822 | ACVR1_E328_R | 0.85 | 1.00E−06 | 5.00E−06 |
| ZIM2_P22_F | 0.58 | 0.000425 | 0.001822 | MT1A_E13_R | 0.83 | 1.00E−06 | 5.00E−06 |
| PRSS8_E134_R | 0.64 | 0.000441 | 0.001879 | COL1A2_P48_R | 1.07 | 1.00E−06 | 5.00E−06 |
| NOS3_P38_F | 0.65 | 0.000448 | 0.001882 | WNT10B_P993_F | 0.90 | 1.00E−06 | 6.00E−06 |
| BCR_P422_F | 0.81 | 0.000451 | 0.001882 | VAV1_P317_F | 0.74 | 1.00E−06 | 6.00E−06 |
| PLAT_E158_F | 0.73 | 0.000453 | 0.001882 | CD9_P585_R | 0.72 | 2.00E−06 | 6.00E−06 |
| MAPK10_E26_F | 0.93 | 0.00046 | 0.001897 | WNT2_P217_F | 0.99 | 2.00E−06 | 6.00E−06 |
| HS3ST2_P546_F | 0.82 | 0.000478 | 0.00196 | SOX1_P1018_R | 0.79 | 2.00E−06 | 7.00E−06 |
| TRPM5_P721_F | 0.64 | 0.000483 | 0.001962 | IGFBP2_P306_F | 1.15 | 2.00E−06 | 7.00E−06 |
| DLL1_P832_F | 0.76 | 0.000489 | 0.001974 | CLK1_P538_F | 0.65 | 2.00E−06 | 7.00E−06 |
| CFTR_P372_R | 0.91 | 5.00E−04 | 0.002003 | FGF8_P473_F | 0.95 | 2.00E−06 | 8.00E−06 |
| FGFR3_E297_R | 0.19 | 0.000513 | 0.002041 | HTR1B_E232_R | 0.80 | 2.00E−06 | 8.00E−06 |
| NPR2_P1093_F | −0.28 | 0.000535 | 0.002111 | ALOX12_P223_R | 0.83 | 2.00E−06 | 8.00E−06 |
| USP29_P205_R | −0.45 | 0.000552 | 0.002163 | APBA2_P305_R | 0.67 | 2.00E−06 | 9.00E−06 |
| GABRA5_E44_R | −0.62 | 0.000557 | 0.002166 | TRPM5_P979_F | 0.77 | 2.00E−06 | 9.00E−06 |
| HOXB2_P488_R | 1.04 | 0.000565 | 0.002183 | RBP1_E158_F | 0.90 | 3.00E−06 | 9.00E−06 |
| CSPG2_E38_F | 1.07 | 0.00058 | 0.002214 | EPHA2_P340_R | 0.79 | 3.00E−06 | 9.00E−06 |
| S100A2_P1186_F | 0.72 | 0.000584 | 0.002214 | MYOD1_E156_F | 0.86 | 3.00E−06 | 9.00E−06 |
| VIM_P811_R | 1.35 | 0.000585 | 0.002214 | BCR_P346_F | 0.72 | 3.00E−06 | 1.00E−05 |
| IL1RN_P93_R | 0.70 | 0.000599 | 0.002248 | ALOX12_E85_R | 0.81 | 3.00E−06 | 1.00E−05 |
| BMP4_P199_R | 0.73 | 0.000605 | 0.00225 | FES_E34_R | 0.99 | 3.00E−06 | 1.10E−05 |
| LAT_E46_F | −0.52 | 0.000607 | 0.00225 | EPHA5_P66_F | 0.82 | 3.00E−06 | 1.10E−05 |
| IL12A_E287_R | 0.24 | 0.000612 | 0.00225 | NRG1_E74_F | 0.92 | 3.00E−06 | 1.10E−05 |
| HFE_E273_R | 1.46 | 0.000635 | 0.002314 | NTRK3_P752_F | 0.88 | 3.00E−06 | 1.10E−05 |
| AOC3_P890_R | 0.72 | 0.000638 | 0.002314 | ERG_E28_F | 0.79 | 3.00E−06 | 1.20E−05 |
| S100A4_E315_F | 0.76 | 0.000645 | 0.002326 | PLAT_E158_F | 0.67 | 4.00E−06 | 1.20E−05 |
| SERPINA5_P156_F | 0.65 | 0.000669 | 0.002396 | RARA_P176_R | 0.77 | 4.00E−06 | 1.30E−05 |
| CHI3L2_P226_F | −0.61 | 0.00068 | 0.002419 | MMP2_E21_R | 0.92 | 4.00E−06 | 1.30E−05 |
| IGSF4_P454_F | 1.09 | 0.000715 | 0.002528 | CCND2_P887_F | 1.13 | 4.00E−06 | 1.30E−05 |
| EVI2A_P94_R | −1.06 | 0.000721 | 0.002532 | MYH11_P236_R | 1.09 | 4.00E−06 | 1.40E−05 |
| TJP2_P330_R | −0.77 | 0.00077 | 0.002686 | NPY_P91_F | 0.84 | 4.00E−06 | 1.40E−05 |
| SPI1_P48_F | 0.74 | 0.000776 | 0.002689 | ETV1_P515_F | 0.84 | 4.00E−06 | 1.40E−05 |
| KRT5_E196_R | 0.95 | 0.000803 | 0.002729 | GUCY2D_E419_R | 1.03 | 5.00E−06 | 1.50E−05 |
| SYK_E372_F | 0.27 | 0.000803 | 0.002729 | GSTM2_P109_R | 0.88 | 5.00E−06 | 1.50E−05 |
| MFAP4_P10_R | 0.53 | 0.000803 | 0.002729 | WNT10B_P823_R | 0.71 | 5.00E−06 | 1.60E−05 |
| GLI2_P295_F | 0.57 | 0.000808 | 0.002729 | CCND2_P898_R | 1.07 | 5.00E−06 | 1.60E−05 |
| LIG3_P622_R | 0.62 | 0.000818 | 0.002747 | MDR1_seq_42_S300_R | 1.03 | 5.00E−06 | 1.80E−05 |
| FASTK_P598_R | 0.51 | 0.000849 | 0.002834 | GAS7_E148_F | 1.19 | 6.00E−06 | 1.90E−05 |
| FLJ20712_P984_R | 0.63 | 0.000876 | 0.002877 | ADCYAP1_P398_F | 0.89 | 6.00E−06 | 2.00E−05 |
| TAL1_E122_F | 1.09 | 0.00088 | 0.002877 | KRT5_E196_R | 0.81 | 7.00E−06 | 2.10E−05 |
| EPHA2_P340_R | 0.63 | 0.000883 | 0.002877 | RASGRF1_E16_F | 1.17 | 8.00E−06 | 2.30E−05 |
| HDAC1_P414_R | 0.64 | 0.000883 | 0.002877 | IGFBP7_P297_F | 0.72 | 8.00E−06 | 2.30E−05 |
| CD82_P557_R | 0.67 | 0.000898 | 0.002898 | SLC14A1_E295_F | 0.66 | 8.00E−06 | 2.50E−05 |
| TRIP6_P1090_F | 0.79 | 0.000901 | 0.002898 | TWIST1_E117_R | 0.99 | 8.00E−06 | 2.50E−05 |
| EYA4_P794_F | 0.96 | 0.000912 | 0.002918 | VIM_P811_R | 0.95 | 9.00E−06 | 2.70E−05 |
| PTK6_E50_F | 0.57 | 0.000943 | 0.003 | AATK_P519_R | 0.73 | 9.00E−06 | 2.90E−05 |
| APBA2_P305_R | 0.62 | 0.000975 | 0.003083 | GPR116_E328_R | 0.63 | 1.00E−05 | 3.00E−05 |
| NOTCH3_P198_R | 0.59 | 0.001 | 0.003143 | ASCL2_P360_F | 1.17 | 1.00E−05 | 3.10E−05 |
| TGFB2_E226_R | 1.00 | 0.001012 | 0.003163 | FGF2_P229_F | 0.77 | 1.10E−05 | 3.10E−05 |
| SH3BP2_E18_F | 0.65 | 0.001021 | 0.003163 | EPO_E244_R | 1.06 | 1.10E−05 | 3.20E−05 |
| ZIM3_E203_F | −0.71 | 0.001024 | 0.003163 | NID1_P714_R | 0.67 | 1.10E−05 | 3.30E−05 |
| FANCA_P1006_R | −0.49 | 0.001071 | 0.003289 | DIO3_P674_F | 1.01 | 1.10E−05 | 3.30E−05 |
| ABCG2_P178_R | 0.23 | 0.001103 | 0.003368 | ACVR1_P983_F | 0.72 | 1.10E−05 | 3.30E−05 |
| MMP9_P189_F | 0.54 | 0.001125 | 0.003416 | TFF2_P557_R | 0.64 | 1.10E−05 | 3.30E−05 |
| EPHA8_P456_R | 0.64 | 0.001161 | 0.003487 | DCC_E53_R | 0.77 | 1.20E−05 | 3.60E−05 |
| MAS1_P657_R | −0.45 | 0.001166 | 0.003487 | DDR2_P743_R | 0.66 | 1.30E−05 | 3.60E−05 |
| NID1_P714_R | 0.68 | 0.001167 | 0.003487 | MMP19_E274_R | 0.64 | 1.30E−05 | 3.70E−05 |
| KCNK4_E3_F | 0.67 | 0.001203 | 0.003574 | TP73_P945_F | 0.81 | 1.40E−05 | 4.00E−05 |
| CARD15_P302_R | 0.77 | 0.00121 | 0.003574 | NTRK2_P10_F | 0.77 | 1.40E−05 | 4.10E−05 |
| TNFRSF10C_P7_F | 1.08 | 0.001222 | 0.00359 | ISL1_P554_F | 0.81 | 1.50E−05 | 4.10E−05 |
| MCM2_P260_F | −0.37 | 0.001257 | 0.003662 | NGFB_E353_F | 0.64 | 1.50E−05 | 4.10E−05 |
| RUNX3_P247_F | −0.65 | 0.00126 | 0.003662 | TGFB2_E226_R | 0.86 | 1.50E−05 | 4.20E−05 |
| PADI4_E24_F | 0.68 | 0.001363 | 0.003942 | TWIST1_P44_R | 0.74 | 1.50E−05 | 4.30E−05 |
| SPP1_E140_R | 0.62 | 0.001378 | 0.003963 | ERN1_P809_R | 0.75 | 1.60E−05 | 4.40E−05 |
| ENC1_P484_R | 0.13 | 0.001435 | 0.004106 | MFAP4_P10_R | 0.60 | 1.60E−05 | 4.40E−05 |
| P2RX7_P119_R | 0.55 | 0.001483 | 0.004221 | HTR1B_P107_F | 0.65 | 1.60E−05 | 4.40E−05 |
| CD1A_P414_R | −0.60 | 0.00153 | 0.004331 | JAK3_P1075_R | 0.56 | 1.70E−05 | 4.60E−05 |
| CREBBP_P712_R | 0.63 | 0.00154 | 0.004337 | PADI4_E24_F | 0.66 | 1.80E−05 | 4.80E−05 |
| DBC1_E204_F | 0.94 | 0.001559 | 0.004367 | CFTR_P372_R | 0.79 | 1.80E−05 | 4.90E−05 |
| AXL_P223_R | 0.76 | 0.00159 | 0.004403 | GSTM2_E153_F | 0.89 | 1.90E−05 | 5.00E−05 |
| IRF7_P277_R | 1.23 | 0.001594 | 0.004403 | FGF12_E61_R | 0.68 | 1.90E−05 | 5.10E−05 |
| TRIP6_P1274_R | 0.65 | 0.001596 | 0.004403 | ADCYAP1_P455_R | 0.83 | 1.90E−05 | 5.10E−05 |
| CALCA_P75_F | 1.00 | 0.001622 | 0.004452 | ZIM2_E110_F | 0.67 | 2.00E−05 | 5.30E−05 |
| DNAJC15_P65_F | −0.40 | 0.001669 | 0.004559 | P2RX7_P597_F | 0.63 | 2.10E−05 | 5.40E−05 |
| GSTM2_P109_R | 1.01 | 0.001702 | 0.004625 | FHIT_P93_R | 0.73 | 2.10E−05 | 5.40E−05 |
| B3GALT5_P330_F | −0.23 | 0.001783 | 0.004821 | MFAP4_P197_F | 0.66 | 2.20E−05 | 5.60E−05 |
| TNFSF8_E258_R | −0.57 | 0.00183 | 0.004922 | CALCA_E174_R | 0.85 | 2.30E−05 | 5.80E−05 |
| GP1BB_P278_R | 0.92 | 0.001852 | 0.004957 | ABO_P312_F | 0.90 | 2.30E−05 | 5.80E−05 |
| EPHX1_P22_F | 0.75 | 0.001879 | 0.005004 | SLC14A1_P369_R | 0.67 | 2.30E−05 | 5.80E−05 |
| CD34_P780_R | 0.52 | 0.001999 | 0.005271 | CSF1R_P73_F | 0.55 | 2.40E−05 | 6.10E−05 |
| FLI1_P620_R | 1.15 | 0.002008 | 0.005271 | TMPRSS4_E83_F | 0.62 | 2.40E−05 | 6.10E−05 |
| CDK10_P199_R | 0.48 | 0.002008 | 0.005271 | FGF5_E16_F | 0.76 | 2.50E−05 | 6.20E−05 |
| EPHA2_P203_F | 0.59 | 0.002061 | 0.005382 | SCGB3A1_E55_R | 0.87 | 2.70E−05 | 6.70E−05 |
| RARB_E114_F | 1.10 | 0.00207 | 0.005382 | DBC1_P351_R | 0.91 | 2.80E−05 | 7.00E−05 |
| RET_seq_53_S374_F | 1.38 | 0.002145 | 0.005528 | HPN_P823_F | 0.67 | 3.00E−05 | 7.40E−05 |
| FGFR1_E317_F | 0.26 | 0.002147 | 0.005528 | PROK2_P390_F | 1.13 | 3.10E−05 | 7.60E−05 |
| NID1_P677_F | 0.65 | 0.002322 | 0.005914 | HOXA5_E187_F | 0.81 | 3.20E−05 | 7.80E−05 |
| NTSR1_P318_F | 1.03 | 0.002322 | 0.005914 | IGF2AS_E4_F | 0.59 | 3.30E−05 | 8.00E−05 |
| PPARD_P846_F | 0.23 | 0.00233 | 0.005914 | CSPG2_E38_F | 0.79 | 3.40E−05 | 8.20E−05 |
| TYRO3_P501_F | 0.33 | 0.002348 | 0.005933 | PDGFB_P719_F | 0.64 | 3.40E−05 | 8.20E−05 |
| LIF_E208_F | 0.18 | 0.002518 | 0.006332 | KRT5_P308_F | 0.56 | 3.50E−05 | 8.50E−05 |
| OGG1_E400_F | 0.82 | 0.002721 | 0.006793 | GDF10_E39_F | 0.51 | 3.90E−05 | 9.20E−05 |
| DDR1_P332_R | 0.67 | 0.002726 | 0.006793 | EPHA8_P456_R | 0.67 | 3.90E−05 | 9.20E−05 |
| FZD9_P15_R | 0.52 | 0.002813 | 0.006977 | P2RX7_P119_R | 0.60 | 3.90E−05 | 9.30E−05 |
| OPCML_E219_R | 0.94 | 0.002874 | 0.00707 | CALCA_P75_F | 0.83 | 4.00E−05 | 9.30E−05 |
| GAS7_P622_R | 0.78 | 0.002877 | 0.00707 | HHIP_P307_R | 0.67 | 4.00E−05 | 9.40E−05 |
| LTB4R_P163_F | −0.31 | 0.002994 | 0.007325 | MYOD1_P50_F | 0.68 | 4.00E−05 | 9.40E−05 |
| XRCC2_P1077_F | 0.78 | 0.003061 | 0.007456 | CPA4_E20_F | 0.56 | 4.10E−05 | 9.60E−05 |
| IRAK3_P13_F | 1.15 | 0.003093 | 0.007499 | SOX17_P287_R | 0.77 | 4.70E−05 | 0.000107 |
| ACVR1C_P363_F | 0.74 | 0.003161 | 0.007603 | IRF7_E236_R | 0.77 | 4.70E−05 | 0.000107 |
| DHCR24_P652_R | −0.50 | 0.003164 | 0.007603 | USP29_E274_F | −0.66 | 4.70E−05 | 0.000108 |
| PADI4_P1158_R | 0.55 | 0.003183 | 0.007615 | DLC1_P88_R | −0.67 | 4.80E−05 | 0.00011 |
| NTSR1_E109_F | 1.16 | 0.003202 | 0.007627 | GFI1_P45_R | 0.89 | 4.90E−05 | 0.000111 |
| SLC5A8_E60_R | 0.76 | 0.003305 | 0.007838 | FGF12_P210_R | 0.91 | 4.90E−05 | 0.000111 |
| RASSF1_E116_F | 1.41 | 0.003345 | 0.007897 | AHR_E103_F | 0.55 | 5.00E−05 | 0.000113 |
| IGSF4C_P533_R | 0.31 | 0.003408 | 0.007973 | FLT1_E444_F | 1.12 | 5.10E−05 | 0.000113 |
| IL3_P556_F | −0.30 | 0.003418 | 0.007973 | S100A2_E36_R | 0.51 | 5.10E−05 | 0.000114 |
| THBS1_E207_R | 0.25 | 0.003421 | 0.007973 | PLXDC2_E337_F | 1.19 | 5.20E−05 | 0.000116 |
| SMO_E57_F | 1.45 | 0.003478 | 0.00804 | IFNGR2_E164_F | 0.40 | 5.30E−05 | 0.000118 |
| PTPRH_P255_F | 0.68 | 0.00348 | 0.00804 | MMP9_P189_F | 0.51 | 5.40E−05 | 0.000118 |
| SEMA3B_P110_R | 0.37 | 0.003504 | 0.00804 | RBP1_P150_F | 0.91 | 6.00E−05 | 0.000132 |
| DST_E31_F | 0.29 | 0.003509 | 0.00804 | HOXA5_P1324_F | 0.59 | 6.10E−05 | 0.000134 |
| NPR2_P618_F | −0.57 | 0.003548 | 0.008094 | TBX1_P885_R | 0.83 | 6.50E−05 | 0.000142 |
| SRC_P297_F | 0.55 | 0.003612 | 0.008206 | PENK_P447_R | 0.74 | 6.60E−05 | 0.000144 |
| RIPK4_E166_F | 0.41 | 0.003629 | 0.00821 | UGT1A1_P315_R | 0.58 | 6.90E−05 | 0.00015 |
| SOX1_P294_F | 0.86 | 0.003691 | 0.008316 | COMT_E401_F | 0.68 | 7.00E−05 | 0.000151 |
| FGF3_P171_R | 0.95 | 0.003789 | 0.008501 | CD34_P780_R | 0.50 | 7.80E−05 | 0.000167 |
| GUCY2D_P48_R | 0.60 | 0.003852 | 0.008606 | PALM2-AKAP2_P420_R | 0.72 | 7.90E−05 | 0.000168 |
| ALOX12_P223_R | 0.74 | 0.003947 | 0.008781 | GJB2_P791_R | 0.97 | 8.00E−05 | 0.000169 |
| CASP10_P186_F | 0.41 | 0.003998 | 0.008859 | KDR_P445_R | 0.88 | 8.10E−05 | 0.000171 |
| HS3ST2_E145_R | 0.80 | 0.004033 | 0.0089 | KCNK4_P171_R | 0.55 | 8.10E−05 | 0.000171 |
| HRASLS_P353_R | 0.50 | 0.004141 | 0.009101 | TMPRSS4_P552_F | 0.71 | 8.50E−05 | 0.000177 |
| ITGB4_E144_F | 0.15 | 0.00417 | 0.009128 | TUBB3_E91_F | 0.59 | 8.80E−05 | 0.000184 |
| FGF3_E198_R | 1.08 | 0.004212 | 0.009183 | PLA2G2A_P528_F | 0.50 | 8.80E−05 | 0.000184 |
| TUBB3_E91_F | 0.70 | 0.004288 | 0.009297 | TNF_P158_F | 0.66 | 8.90E−05 | 0.000185 |
| NRG1_E74_F | 0.90 | 0.004325 | 0.009297 | PDGFRB_P273_F | 0.56 | 9.10E−05 | 0.000187 |
| SNCG_P98_R | 0.45 | 0.004329 | 0.009297 | MEG3_E91_F | 0.60 | 9.10E−05 | 0.000187 |
| ZIM2_E110_F | 0.40 | 0.004333 | 0.009297 | GLI2_P295_F | 0.60 | 9.40E−05 | 0.000193 |
| JAK3_E64_F | 0.98 | 0.004648 | 0.009932 | POMC_E254_F | 0.64 | 9.50E−05 | 0.000194 |
| TNFRSF10C_E109_F | 0.92 | 0.004696 | 0.009937 | FLT3_P302_F | 0.98 | 9.70E−05 | 0.000198 |
| DES_P1006_R | 0.43 | 0.004698 | 0.009937 | IL18BP_P51_R | 0.51 | 0.000105 | 0.000213 |
| FGF2_P229_F | 0.80 | 0.004705 | 0.009937 | RARB_E114_F | 0.84 | 0.000107 | 0.000215 |
| CAPG_E228_F | 0.42 | 0.00487 | 0.01021 | SLC5A8_P38_R | 0.77 | 0.000112 | 0.000226 |
| MYCN_E77_R | 0.21 | 0.004885 | 0.01021 | IGFBP2_P353_R | 0.61 | 0.000117 | 0.000234 |
| NOTCH1_P1198_F | 0.50 | 0.004895 | 0.01021 | TNFRSF1A_P678_F | 0.53 | 0.000124 | 0.000246 |
| EVI2A_E420_F | −0.44 | 0.00491 | 0.01021 | PTPRO_E56_F | 1.04 | 0.000124 | 0.000246 |
| HLA-DOA_P191_R | 0.44 | 0.005032 | 0.010388 | PYCARD_P393_F | 0.52 | 0.00013 | 0.000256 |
| GALR1_E52_F | 0.88 | 0.005034 | 0.010388 | TRIM29_P261_F | 0.59 | 0.000131 | 0.000258 |
| VIM_P343_R | 1.02 | 0.005107 | 0.0105 | SEZ6L_P249_F | 0.86 | 0.000134 | 0.000263 |
| TNFRSF1A_P678_F | 0.53 | 0.00523 | 0.010712 | PLAT_P80_F | 0.69 | 0.000141 | 0.000275 |
| TPEF_seq_44_S88_R | 0.84 | 0.00531 | 0.010833 | ADAMTS12_E52_R | 0.68 | 0.000141 | 0.000275 |
| NEU1_P745_F | −0.78 | 0.005491 | 0.01114 | CSF2_E248_R | 0.59 | 0.000144 | 0.00028 |
| ETV6_E430_F | 0.28 | 0.005501 | 0.01114 | IRF7_P277_R | 0.95 | 0.000155 | 0.000299 |
| POMC_P53_F | 1.26 | 0.005539 | 0.011174 | GUCY2D_P48_R | 0.53 | 0.00017 | 0.000327 |
| CDH13_E102_F | 0.98 | 0.005561 | 0.011177 | NBL1_P24_F | 0.60 | 0.000178 | 0.00034 |
| SLIT2_E111_R | 0.73 | 0.005597 | 0.011207 | HLA-F_E402_F | 1.02 | 0.00018 | 0.000343 |
| MST1R_E42_R | 0.77 | 0.005629 | 0.011231 | ALK_E183_R | 0.52 | 0.00018 | 0.000343 |
| MLH3_P25_F | 0.29 | 0.005687 | 0.011279 | NEFL_P209_R | 0.69 | 0.000182 | 0.000345 |
| WNT10B_P823_R | 0.64 | 0.005697 | 0.011279 | ADCYAP1_E163_R | 0.79 | 0.000185 | 0.00035 |
| HIC2_P498_F | 0.65 | 0.005716 | 0.011279 | TRIP6_P1090_F | 0.57 | 0.000192 | 0.000361 |
| SHH_E328_F | 0.48 | 0.005914 | 0.011628 | SLC22A3_E122_R | 0.66 | 0.000206 | 0.000387 |
| IGF2AS_E4_F | 0.48 | 0.00609 | 0.01193 | MAPK10_E26_F | 0.66 | 0.000207 | 0.000388 |
| ASCL2_E76_R | 0.53 | 0.006115 | 0.011936 | ST6GAL1_P164_R | 0.71 | 0.000215 | 4.00E−04 |
| IGFBP3_P1035_F | −1.23 | 0.006172 | 0.012004 | PTPRO_P371_F | 0.63 | 0.000216 | 4.00E−04 |
| CASP10_P334_F | 0.46 | 0.006233 | 0.012018 | EPHA7_E6_F | 0.87 | 0.000223 | 0.000412 |
| ERG_E28_F | 0.71 | 0.006241 | 0.012018 | KCNK4_E3_F | 0.54 | 0.000224 | 0.000412 |
| POMC_P400_R | 0.97 | 0.006251 | 0.012018 | ABO_E110_F | 0.76 | 0.000225 | 0.000412 |
| SFTPC_E13_F | 0.43 | 0.006268 | 0.012018 | TYRO3_P501_F | 0.30 | 0.000225 | 0.000412 |
| SPI1_P929_F | 0.37 | 0.006441 | 0.012305 | APC_P14_F | 0.68 | 0.000231 | 0.000421 |
| MET_E333_F | 0.71 | 0.006491 | 0.012358 | CSF1_P339_F | 0.72 | 0.000241 | 0.000437 |
| LMO1_E265_R | 0.63 | 0.00661 | 0.01254 | HLF_E192_F | 0.74 | 0.000242 | 0.000438 |
| CCND1_P343_R | 0.45 | 0.006714 | 0.012693 | PDE1B_E141_F | 0.55 | 0.000254 | 0.000458 |
| CTGF_E156_F | 0.51 | 0.006824 | 0.012855 | SMO_P455_R | 0.71 | 0.000261 | 0.000469 |
| THY1_P149_R | 0.76 | 0.007039 | 0.013197 | SEMA3C_P642_F | −0.72 | 0.000263 | 0.000471 |
| CCL3_E53_R | −0.52 | 0.007054 | 0.013197 | MATK_P64_F | 0.67 | 0.000266 | 0.000475 |
| TFF2_P557_R | 0.52 | 0.007133 | 0.013298 | DAB2IP_E18_R | 0.59 | 0.000286 | 0.000508 |
| COL1A2_P48_R | 0.98 | 0.007212 | 0.013319 | FLT1_P302_F | 0.74 | 0.000292 | 0.000517 |
| TMPRSS4_P552_F | 0.59 | 0.007217 | 0.013319 | MYH11_P22_F | 0.72 | 0.000296 | 0.000523 |
| CALCA_E174_R | 0.80 | 0.007218 | 0.013319 | SYK_P584_F | 0.48 | 0.000297 | 0.000523 |
| ABCC5_P444_F | 0.30 | 0.00728 | 0.013388 | SFTPA1_E340_R | 0.63 | 0.000309 | 0.00054 |
| MST1R_P87_R | 0.69 | 0.007334 | 0.013418 | MMP9_P237_R | 0.65 | 0.000309 | 0.00054 |
| FRZB_P406_F | 1.13 | 0.007346 | 0.013418 | AXL_P223_R | 0.58 | 0.000322 | 0.00056 |
| TK1_P62_R | 0.11 | 0.007378 | 0.013432 | DHCR24_P652_R | −0.45 | 0.000326 | 0.000566 |
| AFF3_P808_F | −0.50 | 0.007428 | 0.013477 | GABRG3_P75_F | −0.56 | 0.00033 | 0.000572 |
| PLXDC1_P236_F | 0.49 | 0.00753 | 0.013616 | AATK_P709_R | 0.62 | 0.000335 | 0.000577 |
| NPY_E31_R | 0.71 | 0.00756 | 0.013625 | KLK10_P268_R | 0.50 | 0.000337 | 0.000579 |
| DDR2_P743_R | 0.56 | 0.007795 | 0.014003 | IL1RN_P93_R | 0.55 | 0.000367 | 0.000629 |
| CHD2_P667_F | −0.41 | 0.007831 | 0.014008 | TMEFF1_P626_R | 0.44 | 0.000371 | 0.000633 |
| ERCC6_P698_R | 0.31 | 0.00785 | 0.014008 | PTHR1_P258_F | 0.45 | 0.000385 | 0.000656 |
| TP73_P496_F | 0.81 | 0.007926 | 0.014084 | NTRK3_E131_F | 0.88 | 0.000393 | 0.000667 |
| NPY_P295_F | 0.80 | 0.007945 | 0.014084 | EPHA2_P203_F | 0.53 | 0.000398 | 0.000673 |
| GSTM2_E153_F | 0.87 | 0.008072 | 0.014263 | FAS_P322_R | 0.53 | 0.00041 | 0.00069 |
| CTSD_P726_F | 0.37 | 0.008135 | 0.014289 | PDGFRB_E195_R | 0.79 | 0.000421 | 0.000707 |
| MC2R_P1025_F | −0.46 | 0.00814 | 0.014289 | CSF1R_E26_F | 0.56 | 0.000445 | 0.000744 |
| GRB10_E85_R | 0.65 | 0.008269 | 0.014468 | MATK_P190_R | 0.59 | 0.000453 | 0.000756 |
| MMP19_P306_F | 0.47 | 0.008308 | 0.01449 | FLT4_P180_R | 0.87 | 0.000459 | 0.000763 |
| ERBB4_P541_F | 0.30 | 0.008526 | 0.014782 | DAB2IP_P9_F | 0.63 | 0.000462 | 0.000765 |
| HLA-DQA2_P282_R | −0.47 | 0.00853 | 0.014782 | FGFR3_E297_R | 0.35 | 0.000463 | 0.000765 |
| EPHB2_E297_F | 0.16 | 0.00868 | 0.014971 | OAT_P465_F | 0.60 | 0.000489 | 0.000805 |
| PPARG_E178_R | 0.14 | 0.00872 | 0.014971 | TAL1_P594_F | 0.63 | 0.000497 | 0.000816 |
| DAPK1_P345_R | 0.39 | 0.008722 | 0.014971 | FGF5_P238_R | 0.66 | 0.000509 | 0.000834 |
| ITK_E166_R | −0.58 | 0.009097 | 0.015564 | COL1A2_E299_F | 0.59 | 0.000513 | 0.000835 |
| HIC-1_seq_48_S103_R | −0.83 | 0.009187 | 0.015648 | CYP1B1_E83_R | 0.73 | 0.000514 | 0.000835 |
| RIPK3_P124_F | 0.47 | 0.009219 | 0.015648 | SOX17_P303_F | 0.54 | 0.000515 | 0.000835 |
| DNMT3B_P352_R | 0.46 | 0.009232 | 0.015648 | TFPI2_P9_F | 0.85 | 0.000526 | 0.00085 |
| PYCARD_P150_F | 0.40 | 0.009323 | 0.015746 | ZIM2_P22_F | 0.56 | 0.000531 | 0.000854 |
| CEACAM1_E57_R | 0.27 | 0.009348 | 0.015746 | NGFB_P13_F | 0.55 | 0.000532 | 0.000854 |
| BMPR2_E435_F | −0.15 | 0.009388 | 0.015763 | ALPL_P433_F | 0.46 | 0.000563 | 0.000901 |
| TMEFF2_P152_R | 0.67 | 0.009456 | 0.015828 | DNAJC15_E26_R | 0.50 | 0.000565 | 0.000903 |
| TJP2_P518_F | −0.63 | 0.009504 | 0.015859 | PTPRG_E40_R | 0.66 | 0.000576 | 0.000917 |
| IGF1R_E186_R | 0.14 | 0.009681 | 0.016105 | SPARC_E50_R | 0.49 | 6.00E−04 | 0.000953 |
| GSTM2_P453_R | 0.52 | 0.010076 | 0.016712 | RARB_P60_F | 0.57 | 0.000606 | 0.000959 |
| CRK_P721_F | 0.38 | 0.010547 | 0.017439 | TGFB1_P833_R | 0.68 | 0.000632 | 0.000997 |
| SEZ6L_P249_F | 1.26 | 0.010599 | 0.017471 | ER_seq_a1_S60_F | 0.54 | 0.000647 | 0.001017 |
| SEZ6L_P299_F | 1.03 | 0.01072 | 0.017584 | ESR1_E298_R | 0.59 | 0.000649 | 0.001018 |
| EPO_P162_R | 0.57 | 0.010732 | 0.017584 | PAX6_P1121_F | 0.58 | 0.000672 | 0.00105 |
| TP73_P945_F | 0.70 | 0.010906 | 0.017732 | GJB2_P931_R | 0.56 | 0.000694 | 0.001078 |
| MYCN_P464_R | 0.15 | 0.010912 | 0.017732 | BMP6_P163_F | 0.41 | 0.000694 | 0.001078 |
| ZMYND10_E77_R | 0.82 | 0.010921 | 0.017732 | THBS2_P605_R | 0.46 | 0.000714 | 0.001106 |
| SPDEF_P6_R | 0.47 | 0.011096 | 0.017963 | SNCG_E119_F | 0.60 | 0.000743 | 0.001146 |
| IL1B_P582_R | 0.42 | 0.011184 | 0.018051 | FGF8_E183_F | 0.45 | 0.000784 | 0.001207 |
| TGFA_P642_R | 0.29 | 0.01128 | 0.018152 | ERBB4_P541_F | 0.71 | 0.000789 | 0.001211 |
| AGTR1_P154_F | 0.97 | 0.011348 | 0.018206 | TRPM5_P721_F | 0.51 | 0.00083 | 0.001269 |
| ZIM3_P718_R | −0.52 | 0.011472 | 0.01835 | CRIP1_P874_R | 0.55 | 0.000832 | 0.001269 |
| EPHA1_P119_R | 0.34 | 0.011569 | 0.018451 | ST6GAL1_P528_F | 0.66 | 0.000843 | 0.001282 |
| MMP3_P16_R | −0.63 | 0.011975 | 0.018993 | HOXA5_P479_F | 0.58 | 0.000949 | 0.001439 |
| MKRN3_P108_F | −0.51 | 0.012043 | 0.018993 | DLC1_E276_F | −0.56 | 0.000965 | 0.00146 |
| IGFBP2_P353_R | 0.65 | 0.012048 | 0.018993 | CASP6_P230_R | 0.13 | 0.000981 | 0.001479 |
| IGFBP6_E47_F | 0.25 | 0.012049 | 0.018993 | PLAU_P176_R | 0.63 | 0.001004 | 0.001509 |
| OAT_P465_F | 0.79 | 0.01212 | 0.01905 | GRB10_P496_R | 0.49 | 0.001013 | 0.001519 |
| SNRPN_P230_R | −0.29 | 0.012181 | 0.019089 | GABRB3_E42_F | 0.71 | 0.001039 | 0.001554 |
| IRAK3_P185_F | 0.86 | 0.012261 | 0.019159 | ADAMTS12_P250_R | 0.80 | 0.001045 | 0.001555 |
| KCNQ1_P546_R | 0.32 | 0.012354 | 0.019249 | CDK6_P291_R | 0.73 | 0.001046 | 0.001555 |
| ZNFN1A1_P179_F | −0.61 | 0.012828 | 0.01993 | F2R_P88_F | 0.67 | 0.001067 | 0.001581 |
| PHLDA2_P622_F | 0.40 | 0.012907 | 0.019996 | GP1BB_E23_F | 0.77 | 0.001108 | 0.001637 |
| RASSF1_P244_F | 1.17 | 0.013027 | 0.020091 | SERPINE1_P519_F | 0.51 | 0.001171 | 0.001725 |
| EDN1_E50_R | 0.26 | 0.013057 | 0.020091 | IGFBP7_P371_F | 0.74 | 0.00123 | 0.001806 |
| SEMA3A_P658_R | 0.40 | 0.01312 | 0.020091 | TSP50_P137_F | 0.58 | 0.001233 | 0.001806 |
| MYOD1_E156_F | 0.74 | 0.013135 | 0.020091 | CCKBR_P480_F | 0.69 | 0.001238 | 0.001809 |
| WNT1_E157_F | 0.51 | 0.013155 | 0.020091 | TIMP3_seq_7_S38_F | 0.79 | 0.001286 | 0.001873 |
| EFNB3_P442_R | 0.24 | 0.013228 | 0.020146 | RET_seq_53_S374_F | 0.69 | 0.00129 | 0.001874 |
| GLI3_E148_R | −0.29 | 0.013362 | 0.020294 | CDKN1C_P626_F | 0.72 | 0.001368 | 0.001982 |
| PROK2_E0_F | 0.34 | 0.013429 | 0.020338 | S100A4_P194_R | 0.55 | 0.001423 | 0.002056 |
| ERCC1_P440_R | 0.26 | 0.01364 | 0.020601 | GPX3_E178_F | 0.48 | 0.001445 | 0.002081 |
| SLC22A18_P472_R | −0.35 | 0.013803 | 0.020789 | BDNF_E19_R | 0.54 | 0.001477 | 0.002121 |
| BCAM_P205_F | 0.24 | 0.013845 | 0.020793 | NID1_P677_F | 0.48 | 0.001484 | 0.002126 |
| MGMT_P281_F | 0.21 | 0.013994 | 0.020959 | ALK_P28_F | 0.58 | 0.001564 | 0.002235 |
| TSP50_P137_F | 0.72 | 0.01416 | 0.021149 | TIMP2_P267_F | 0.62 | 0.001581 | 0.002252 |
| S100A2_E36_R | 0.34 | 0.014233 | 0.0212 | MKRN3_E144_F | −0.63 | 0.001654 | 0.00235 |
| HIC2_P528_R | 0.60 | 0.014667 | 0.021786 | KIT_P405_F | 0.64 | 0.001667 | 0.002356 |
| MATK_P64_F | 0.62 | 0.014749 | 0.021848 | SERPINA5_P156_F | 0.47 | 0.001667 | 0.002356 |
| IGFBP3_P423_R | −0.89 | 0.015111 | 0.022323 | PTPNS1_P301_R | 0.26 | 0.001675 | 0.00236 |
| EPO_E244_R | 0.92 | 0.015167 | 0.022344 | PSCA_E359_F | 0.38 | 0.0017 | 0.002389 |
| ZAP70_P220_R | 0.37 | 0.015505 | 0.022781 | FGFR1_E317_F | 0.37 | 0.001829 | 0.002562 |
| CTNNA1_P382_R | 0.16 | 0.015835 | 0.023202 | SEMA3B_E96_F | 0.41 | 0.001857 | 0.002595 |
| GLI3_P453_R | 0.67 | 0.015961 | 0.023324 | PTPRH_E173_F | 0.39 | 0.001905 | 0.002655 |
| NPY_P91_F | 0.73 | 0.016488 | 0.023972 | PYCARD_E87_F | 0.70 | 0.00213 | 0.002961 |
| WNT2_P217_F | 0.73 | 0.016494 | 0.023972 | SEZ6L_P299_F | 0.69 | 0.002141 | 0.002967 |
| IRAK3_E130_F | 0.94 | 0.01675 | 0.024232 | PLXDC1_P236_F | 0.59 | 0.002195 | 0.003033 |
| EVI1_E47_R | 0.34 | 0.016762 | 0.024232 | KDR_E79_F | 0.72 | 0.002203 | 0.003033 |
| TNFRSF10D_P70_F | 0.81 | 0.016837 | 0.024276 | CCNA1_E7_F | 0.61 | 0.002205 | 0.003033 |
| RBL2_P250_R | 0.65 | 0.017001 | 0.024414 | GABRB3_P92_F | 0.37 | 0.00225 | 0.003086 |
| RARRES1_E235_F | 0.57 | 0.017066 | 0.024414 | TDGF1_E53_R | 0.45 | 0.002303 | 0.003151 |
| KCNQ1_E349_R | 0.19 | 0.017069 | 0.024414 | PDGFRA_P1429_F | 0.56 | 0.002313 | 0.003156 |
| TNFRSF10D_E27_F | 0.88 | 0.017209 | 0.02455 | TNFRSF10D_E27_F | 0.67 | 0.002323 | 0.00316 |
| TERT_E20_F | 0.55 | 0.017478 | 0.024867 | CD40_E58_R | 0.61 | 0.002373 | 0.003216 |
| CCKBR_P480_F | 0.88 | 0.01756 | 0.024919 | ERCC1_P354_F | 0.36 | 0.002376 | 0.003216 |
| EIF2AK2_P313_F | 0.75 | 0.017937 | 0.025388 | LOX_P313_R | 0.52 | 0.002384 | 0.003218 |
| PWCR1_P811_F | −0.34 | 0.018089 | 0.025536 | PTHLH_P757_F | 0.47 | 0.002587 | 0.003483 |
| MMP2_P197_F | 0.60 | 0.018265 | 0.025718 | PTHLH_E251_F | 0.42 | 0.002617 | 0.003515 |
| NR2F6_E375_R | 0.22 | 0.018646 | 0.026125 | ASCL1_E24_F | 0.68 | 0.002661 | 0.003565 |
| PROK2_P390_F | 1.04 | 0.018651 | 0.026125 | ESR2_P162_F | 0.47 | 0.00268 | 0.003581 |
| LMO2_E148_F | −0.37 | 0.018754 | 0.026201 | ETV6_E430_F | 0.34 | 0.002703 | 0.003602 |
| PWCR1_E81_R | −0.35 | 0.018978 | 0.026445 | AIM2_P624_F | 0.47 | 0.00274 | 0.003642 |
| SLC5A8_P38_R | 0.69 | 0.01934 | 0.026881 | MAPK12_P416_F | 0.65 | 0.002839 | 0.003764 |
| PKD2_P287_R | 0.22 | 0.019444 | 0.026956 | TJP1_P390_F | 0.26 | 0.002896 | 0.00383 |
| NCL_P840_R | 0.32 | 0.019571 | 0.027063 | TCF4_P175_R | 0.61 | 0.002905 | 0.003831 |
| SEMA3C_P642_F | −0.69 | 0.019762 | 0.027257 | TGFB2_P632_F | 0.53 | 0.002937 | 0.003864 |
| HLA-DPA1_P205_R | 0.39 | 0.019914 | 0.027397 | HHIP_P578_R | 0.42 | 0.003045 | 0.003996 |
| PLA2G2A_P528_F | 0.39 | 0.020022 | 0.027476 | FN1_E469_F | 0.56 | 0.003075 | 0.004025 |
| ADCYAP1_P455_R | 0.74 | 0.020101 | 0.027514 | NKX3-1_P871_R | 0.59 | 0.003119 | 0.004073 |
| FLT3_P302_F | 0.95 | 0.020613 | 0.028143 | RIPK3_P124_F | 0.45 | 0.003205 | 0.004174 |
| MFAP4_P197_F | 0.46 | 0.021039 | 0.028585 | GLI3_P453_R | 0.49 | 0.003248 | 0.004219 |
| GRB7_P160_R | 0.44 | 0.021042 | 0.028585 | GSTP1_E322_R | 0.55 | 0.003389 | 0.004392 |
| SPP1_P647_F | 0.42 | 0.021458 | 0.029077 | CFTR_P115_F | 0.63 | 0.003481 | 0.004499 |
| HIC1_P565_R | 0.36 | 0.021589 | 0.029181 | IGF2AS_P203_F | 0.54 | 0.003498 | 0.00451 |
| BAX_E281_R | 0.28 | 0.021791 | 0.029381 | MMP7_E59_F | 0.35 | 0.003553 | 0.004569 |
| RBP1_E158_F | 0.86 | 0.021932 | 0.029497 | BDNF_P259_R | 0.49 | 0.003576 | 0.004587 |
| FES_E34_R | 0.59 | 0.022293 | 0.029908 | SIN3B_P607_F | −0.54 | 0.00372 | 0.004761 |
| THPO_E483_F | 0.53 | 0.022367 | 0.029933 | COL18A1_P494_R | 0.54 | 0.00378 | 0.004826 |
| MCM2_P241_R | 0.12 | 0.022646 | 0.030233 | SIN3B_P514_R | −0.49 | 0.0038 | 0.004839 |
| PDGFA_P841_R | 0.13 | 0.022757 | 0.030302 | EPO_P162_R | 0.45 | 0.0041 | 0.005208 |
| ERBB4_P255_F | 0.18 | 0.022811 | 0.030302 | IL6_P213_R | 0.57 | 0.00411 | 0.005208 |
| GP1BB_E23_F | 0.95 | 0.022968 | 0.030436 | SPI1_P48_F | 0.48 | 0.004143 | 0.005237 |
| H19_P1411_R | −0.44 | 0.023139 | 0.030588 | PAX6_E129_F | 0.54 | 0.004195 | 0.005288 |
| ICA1_P72_R | 0.21 | 0.023645 | 0.031181 | MEG3_P235_F | 0.52 | 0.004204 | 0.005288 |
| RIPK3_P24_F | 0.60 | 0.023783 | 0.031287 | PAX6_P50_R | 0.74 | 0.004227 | 0.005304 |
| SLC22A3_E122_R | 0.75 | 0.023878 | 0.031335 | CCKBR_P361_R | 0.35 | 0.004309 | 0.005394 |
| LRRK1_P39_F | −0.15 | 0.024169 | 0.031588 | LCN2_P141_R | 0.43 | 0.004335 | 0.005413 |
| OPCML_P71_F | 0.47 | 0.024187 | 0.031588 | HCK_P858_F | 0.53 | 0.004364 | 0.005432 |
| RARRES1_P426_R | 0.50 | 0.024386 | 0.031699 | PLA2G2A_E268_F | 0.42 | 0.004379 | 0.005432 |
| CDC25B_E83_F | 1.15 | 0.02439 | 0.031699 | HLA-DOB_E432_R | 0.43 | 0.004382 | 0.005432 |
| DIO3_P674_F | 0.83 | 0.024504 | 0.031772 | COL1A1_P5_F | 0.43 | 0.004482 | 0.005543 |
| IGF1_E394_F | 0.51 | 0.024884 | 0.032187 | DAPK1_E46_R | 0.48 | 0.004527 | 0.005585 |
| COL1A1_P5_F | 0.39 | 0.025346 | 0.032705 | SLC22A3_P634_F | 0.44 | 0.00464 | 0.005711 |
| LIF_P383_R | 0.41 | 0.025406 | 0.032705 | GABRA5_E44_R | −0.41 | 0.004665 | 0.005728 |
| TMEFF2_P210_R | 0.51 | 0.025546 | 0.032808 | EPHA8_P256_F | 0.42 | 0.004698 | 0.005755 |
| ERBB3_E331_F | 0.30 | 0.026136 | 0.033486 | PTCH2_P37_F | 0.47 | 0.004735 | 0.005787 |
| HBII-13_P991_R | −0.22 | 0.026361 | 0.033621 | SEMA3A_P658_R | 0.41 | 0.004786 | 0.005835 |
| GDF10_E39_F | 0.32 | 0.026366 | 0.033621 | RARA_E128_R | 0.58 | 0.004928 | 0.005994 |
| APC_E117_R | 0.66 | 0.026452 | 0.033651 | AKT1_P310_R | 0.43 | 0.00508 | 0.006165 |
| CRIP1_P874_R | 0.54 | 0.026665 | 0.033843 | EPHX1_P22_F | 0.53 | 0.005127 | 0.006206 |
| PPARG_P693_F | 0.47 | 0.027004 | 0.034192 | SLC22A3_P528_F | 0.48 | 0.00518 | 0.006256 |
| CEBPA_P1163_R | 0.71 | 0.027096 | 0.034229 | IGFBP6_E47_F | 0.31 | 0.005329 | 0.006421 |
| THY1_P20_R | 0.42 | 0.027397 | 0.034528 | TIAM1_P188_R | 0.77 | 0.005387 | 0.006476 |
| IHH_E186_F | 0.77 | 0.027529 | 0.034537 | RAP1A_P285_R | 0.32 | 0.005402 | 0.006479 |
| EYA4_P508_F | 0.64 | 0.027532 | 0.034537 | DLL1_P832_F | 0.44 | 0.00549 | 0.006568 |
| MAD2L1_E93_F | −0.35 | 0.027652 | 0.034608 | IGFBP6_P328_R | 0.46 | 0.005651 | 0.006746 |
| ESR1_P151_R | −0.60 | 0.027742 | 0.03464 | IGSF4_P86_R | 0.50 | 0.00572 | 0.006813 |
| SMO_P455_R | 0.69 | 0.028217 | 0.035152 | PTPN6_P282_R | 0.40 | 0.00584 | 0.006939 |
| HTR1B_P222_F | 0.84 | 0.028532 | 0.035463 | HRASLS_P353_R | 0.42 | 0.005883 | 0.006974 |
| MYH11_P236_R | 0.90 | 0.028843 | 0.035768 | PGR_P456_R | −0.48 | 0.005954 | 0.007043 |
| CD9_P504_F | 0.48 | 0.029576 | 0.036593 | POMC_P53_F | 0.69 | 0.006015 | 0.007098 |
| BMP6_P163_F | 0.46 | 0.029756 | 0.036731 | DST_E31_F | 0.19 | 0.006063 | 0.007139 |
| MT1A_P49_R | 1.08 | 0.03012 | 0.037096 | MT1A_P600_F | 0.45 | 0.006136 | 0.007208 |
| WT1_E32_F | 0.77 | 0.030345 | 0.037288 | CALCA_P171_F | 0.41 | 0.006216 | 0.007286 |
| NEFL_E23_R | 0.56 | 0.030443 | 0.037307 | MOS_P746_F | −0.43 | 0.006544 | 0.007653 |
| PITX2_E24_R | −0.64 | 0.030499 | 0.037307 | FGFR3_P1152_R | 0.44 | 0.006586 | 0.007684 |
| CDKN1C_P6_R | 0.26 | 0.030577 | 0.037318 | NTRK3_P636_R | 0.45 | 0.006624 | 0.007707 |
| GFI1_P208_R | 0.51 | 0.03071 | 0.037397 | APC_P280_R | 0.68 | 0.006641 | 0.007707 |
| UGT1A7_P751_R | −0.21 | 0.030838 | 0.037467 | FGFR1_P204_F | 0.52 | 0.00665 | 0.007707 |
| CDH11_P203_R | 0.78 | 0.030907 | 0.037468 | APBA2_P227_F | 0.51 | 0.006719 | 0.007769 |
| SFRP1_E398_R | 0.87 | 0.031601 | 0.038223 | AIM2_E208_F | 0.35 | 0.006779 | 0.007821 |
| HHIP_E94_F | 0.68 | 0.032125 | 0.03877 | ITK_E166_R | −0.51 | 0.006934 | 0.007982 |
| KRAS_P651_F | 0.15 | 0.032252 | 0.038777 | WNT5A_E43_F | 0.36 | 0.006957 | 0.00799 |
| APBA2_P227_F | 0.52 | 0.032335 | 0.038777 | TMEFF2_P210_R | 0.47 | 0.0072 | 0.008252 |
| IL2_P607_R | 0.42 | 0.032412 | 0.038777 | ATP10A_P524_R | −0.45 | 0.007285 | 0.008314 |
| IGF2AS_P203_F | 0.55 | 0.032418 | 0.038777 | DDR1_P332_R | 0.45 | 0.007298 | 0.008314 |
| TWIST1_P44_R | 0.57 | 0.032571 | 0.038866 | NGFR_P355_F | 0.33 | 0.007303 | 0.008314 |
| PXN_P308_F | 0.37 | 0.032688 | 0.038866 | FLT3_E326_R | 0.44 | 0.007345 | 0.008344 |
| SOX1_P1018_R | 0.53 | 0.032708 | 0.038866 | HIC1_P565_R | 0.43 | 0.007472 | 0.008469 |
| MMP14_P208_R | 0.40 | 0.033065 | 0.039204 | DAB2_P468_F | 0.60 | 0.007537 | 0.008519 |
| SOX17_P303_F | 0.58 | 0.033301 | 0.039398 | CCL3_E53_R | −0.35 | 0.007549 | 0.008519 |
| PTPRH_E173_F | 0.30 | 0.03371 | 0.039795 | CDKN1A_E101_F | 0.23 | 0.007647 | 0.008609 |
| WNT10B_P993_F | 0.57 | 0.033831 | 0.039812 | RET_seq_54_S260_F | 0.68 | 0.007662 | 0.008609 |
| APC_P14_F | 0.72 | 0.033872 | 0.039812 | TFF1_P180_R | 0.37 | 0.007776 | 0.008717 |
| FGFR3_P1152_R | 0.56 | 0.034258 | 0.040179 | CTSH_E157_R | 0.38 | 0.007798 | 0.008724 |
| MATK_P190_R | 0.51 | 0.035204 | 0.041199 | PODXL_P1341_R | 0.52 | 0.008171 | 0.009121 |
| PTCH_E42_F | 0.10 | 0.035801 | 0.041769 | NOS2A_E117_R | 0.37 | 0.008444 | 0.009405 |
| TMEFF2_E94_R | 0.55 | 0.035846 | 0.041769 | HBII-52_E142_F | −0.38 | 0.008909 | 0.009902 |
| F2R_P88_F | 0.59 | 0.036384 | 0.042305 | ALPL_P278_F | 0.62 | 0.009035 | 0.01002 |
| FGF7_P44_F | 0.37 | 0.036622 | 0.04249 | GSTM2_P453_R | 0.42 | 0.009119 | 0.010091 |
| IGF2R_P396_R | 0.18 | 0.036818 | 0.042626 | TWIST1_P355_R | 0.42 | 0.009166 | 0.010122 |
| IGFBP2_P306_F | 0.88 | 0.036939 | 0.042627 | ASCL1_P747_F | 0.44 | 0.009228 | 0.010169 |
| EGF_E339_F | −0.50 | 0.036976 | 0.042627 | NTRK1_E74_F | −0.57 | 0.009314 | 0.010242 |
| PLAGL1_E68_R | −0.31 | 0.03719 | 0.042782 | SRC_P164_F | 0.34 | 0.00965 | 0.010582 |
| TNFRSF10A_P91_F | 0.29 | 0.037318 | 0.042838 | IGF1R_P325_R | 0.25 | 0.009682 | 0.010582 |
| VAV1_E9_F | 0.65 | 0.038001 | 0.043529 | EVI1_E47_R | 0.61 | 0.009701 | 0.010582 |
| CD9_P585_R | 0.56 | 0.038414 | 0.043878 | KCNQ1_P546_R | 0.31 | 0.009706 | 0.010582 |
| WRN_P969_F | 0.58 | 0.038488 | 0.043878 | CHGA_P243_F | 0.34 | 0.01015 | 0.011043 |
| WNT5A_P655_F | −0.36 | 0.038548 | 0.043878 | DSP_P440_R | 0.32 | 0.010375 | 0.011264 |
| MMP9_E88_R | 0.51 | 0.038723 | 0.043944 | IL1A_E113_R | 0.66 | 0.010474 | 0.011348 |
| TM7SF3_P1068_R | −0.74 | 0.038769 | 0.043944 | SNURF_E256_R | −0.38 | 0.010502 | 0.011354 |
| CDC258_P11_R | 0.78 | 0.039064 | 0.044186 | ZMYND10_E77_R | 0.65 | 0.010572 | 0.011406 |
| CTLA4_E176_R | −0.38 | 0.039978 | 0.045072 | SERPINB5_P19_R | 0.36 | 0.0108 | 0.011627 |
| CFTR_P115_F | 0.69 | 0.040014 | 0.045072 | AOC3_P890_R | 0.37 | 0.010938 | 0.011752 |
| EXT1_E197_F | 0.24 | 0.040223 | 0.045199 | SEPT5_P464_R | 0.39 | 0.010967 | 0.011758 |
| SNRPN_seq_18_S99_F | −0.25 | 0.040294 | 0.045199 | DES_P1006_R | 0.37 | 0.011013 | 0.011783 |
| GABRB3_P92_F | 0.46 | 0.041102 | 0.046009 | BMP2_E48_R | 0.50 | 0.01106 | 0.011809 |
| ASCL2_P360_F | 0.58 | 0.041234 | 0.046062 | SNCG_P53_F | 0.44 | 0.011246 | 0.011983 |
| PLXDC2_E337_F | 0.95 | 0.041511 | 0.046137 | SGCE_E149_F | 0.59 | 0.011283 | 0.011997 |
| PDGFB_P719_F | 0.46 | 0.041514 | 0.046137 | TFF2_P178_F | 0.36 | 0.011496 | 0.012199 |
| ADAMTS12_P250_R | 1.20 | 0.041557 | 0.046137 | MBD2_P233_F | 0.35 | 0.011773 | 0.012467 |
| HTR1B_E232_R | 0.58 | 0.041957 | 0.046486 | ZAP70_P220_R | 0.36 | 0.01189 | 0.012565 |
| TNK1_P41_R | 0.42 | 0.042059 | 0.046503 | COL4A3_E205_R | 0.38 | 0.011971 | 0.012624 |
| COL1A2_E299_F | 0.60 | 0.042566 | 0.046845 | TGFB3_E58_R | 0.35 | 0.012335 | 0.012982 |
| ONECUT2_P315_R | 0.87 | 0.042612 | 0.046845 | TFPI2_P152_R | 0.53 | 0.012701 | 0.01334 |
| MEG3_E91_F | 0.34 | 0.042628 | 0.046845 | IL17RB_E164_R | 0.55 | 0.012728 | 0.013341 |
| MAPK12_E165_R | 0.20 | 0.043194 | 0.047325 | MCAM_P265_R | 0.42 | 0.012858 | 0.01345 |
| MT1A_E13_R | 0.61 | 0.043243 | 0.047325 | MMP19_P306_F | 0.35 | 0.012896 | 0.013463 |
| TMEFF1_P626_R | 0.28 | 0.043328 | 0.047325 | PLXDC1_E71_F | 0.42 | 0.013035 | 0.01358 |
| HCK_P858_F | 0.52 | 0.043582 | 0.047507 | TSC2_E140_F | 0.47 | 0.013406 | 0.013938 |
| LCN2_P86_R | 0.44 | 0.043815 | 0.047609 | RARRES1_P426_R | 0.40 | 0.013514 | 0.014022 |
| DES_E228_R | 0.56 | 0.043851 | 0.047609 | PURA_P928_R | 0.51 | 0.014275 | 0.014768 |
| TIE1_E66_R | −0.42 | 0.044149 | 0.047836 | MLH3_P25_F | 0.29 | 0.01429 | 0.014768 |
| PITX2_P183_R | −0.42 | 0.044283 | 0.047885 | TIAM1_P117_F | 0.64 | 0.014342 | 0.014793 |
| FAT_P279_R | 0.44 | 0.044548 | 0.048075 | MAGEL2_E166_R | −0.47 | 0.015131 | 0.015575 |
| AKT1_P310_R | 0.18 | 0.044891 | 0.048349 | NDN_P1110_F | −0.47 | 0.015296 | 0.015714 |
| GNG7_E310_R | −0.26 | 0.045222 | 0.048609 | S100A4_P887_R | 0.49 | 0.015586 | 0.01598 |
| CARD15_P665_F | −0.41 | 0.045446 | 0.048753 | APC_E117_R | 0.34 | 0.015811 | 0.016178 |
| GRB7_E71_R | 0.43 | 0.045752 | 0.048984 | MET_E333_F | 0.40 | 0.015994 | 0.01632 |
| RARB_P60_F | 0.40 | 0.046354 | 0.049347 | HLA-DOA_P191_R | 0.38 | 0.016013 | 0.01632 |
| CEBPA_P706_F | −0.24 | 0.046354 | 0.049347 | LCN2_P86_R | 0.37 | 0.016247 | 0.016526 |
| CDH11_E102_R | 0.70 | 0.046365 | 0.049347 | PTK6_E50_F | 0.36 | 0.016441 | 0.016691 |
| BMP3_P56_R | 0.13 | 0.046531 | 0.049426 | RIPK3_P24_F | 0.44 | 0.016749 | 0.016962 |
| GFI1_P45_R | 0.82 | 0.046749 | 0.049561 | NOS3_P38_F | 0.32 | 0.016775 | 0.016962 |
| FLT1_P615_R | 0.67 | 0.046863 | 0.049584 | GFI1_E136_F | 0.51 | 0.016934 | 0.01709 |
| EGF_P242_R | 0.32 | 0.047075 | 0.049711 | IGF2_P36_R | 0.52 | 0.017 | 0.017123 |
| ALPL_P433_F | 0.38 | 0.047181 | 0.049726 | CLDN4_P1120_R | 0.33 | 0.017211 | 0.017302 |
| | | | | ITGA6_P718_R | 0.55 | 0.017366 | 0.017378 |
| | | | | CD2_P68_F | 0.34 | 0.017374 | 0.017378 |
| | | | | TAL1_P817_F | 0.45 | 0.017388 | 0.017378 |
| | | | | GRB10_P260_F | 0.57 | 0.017592 | 0.017548 |
| | | | | WNT1_P79_R | 0.39 | 0.017754 | 0.017659 |
| | | | | FANCA_P1006_R | −0.42 | 0.017797 | 0.017659 |
| | | | | CD1A_P6_F | −0.42 | 0.017807 | 0.017659 |
| | | | | APOA1_P261_F | 0.42 | 0.019333 | 0.019136 |
| | | | | P2RX7_E323_R | 0.37 | 0.019514 | 0.019278 |
| | | | | LRP2_E20_F | 0.43 | 0.019788 | 0.019512 |
| | | | | NOTCH1_P1198_F | 0.43 | 0.020345 | 0.020023 |
| | | | | THPO_E483_F | 0.48 | 0.020479 | 0.020116 |
| | | | | MYB_P673_R | 0.15 | 0.020619 | 0.020216 |
| | | | | PSCA_P135_F | 0.30 | 0.020871 | 0.020424 |
| | | | | RAB32_E314_R | 0.43 | 0.021052 | 0.020532 |
| | | | | RET_P717_F | 0.39 | 0.021075 | 0.020532 |
| | | | | HDAC9_E38_F | 0.44 | 0.021101 | 0.020532 |
| | | | | GSTP1_P74_F | 0.34 | 0.021269 | 0.020656 |
| | | | | ERBB4_P255_F | 0.46 | 0.021378 | 0.020723 |
| | | | | MMP14_P208_R | 0.37 | 0.022152 | 0.021433 |
| | | | | CDH17_P376_F | 0.36 | 0.022424 | 0.021645 |
| | | | | RIPK1_P744_R | 0.48 | 0.022455 | 0.021645 |
| | | | | EDNRB_P148_R | −0.39 | 0.023332 | 0.022448 |
| | | | | KIAA0125_E29_F | −0.37 | 0.02359 | 0.022654 |
| | | | | CYP1B1_P212_F | 0.34 | 0.023764 | 0.022779 |
| | | | | PKD2_P336_R | 0.24 | 0.023998 | 0.02296 |
| | | | | LMO1_E265_R | 0.40 | 0.02422 | 0.02313 |
| | | | | HIC2_P498_F | 0.53 | 0.024392 | 0.023252 |
| | | | | TRIP6_P1274_R | 0.35 | 0.024487 | 0.023299 |
| | | | | ACTG2_E98_R | 0.38 | 0.024735 | 0.023491 |
| | | | | IL1RN_E42_F | 0.31 | 0.025149 | 0.02383 |
| | | | | EDNRB_P709_R | −0.36 | 0.025184 | 0.02383 |
| | | | | FAS_P65_F | 0.30 | 0.025349 | 0.023942 |
| | | | | SPP1_P647_F | 0.30 | 0.025466 | 0.023998 |
| | | | | FGFR2_P266_R | 0.28 | 0.025501 | 0.023998 |
| | | | | PLXDC2_P914_R | 0.31 | 0.02571 | 0.024151 |
| | | | | WRN_E57_F | 0.20 | 0.026518 | 0.024864 |
| | | | | SMARCB1_P220_R | 0.30 | 0.026584 | 0.024881 |
| | | | | TCF4_P317_F | 0.40 | 0.026843 | 0.025078 |
| | | | | PLAU_P11_F | 0.39 | 0.027113 | 0.025284 |
| | | | | TRIM29_P135_F | 0.29 | 0.027206 | 0.025325 |
| | | | | FASTK_P598_R | 0.28 | 0.027519 | 0.02557 |
| | | | | SRC_E100_R | 0.30 | 0.027952 | 0.025906 |
| | | | | EPHA7_P205_R | 0.36 | 0.027981 | 0.025906 |
| | | | | CD40_P372_R | 0.42 | 0.028514 | 0.026352 |
| | | | | BMP2_P1201_F | 0.40 | 0.02902 | 0.026772 |
| | | | | MLLT4_P1400_F | 0.57 | 0.029128 | 0.026783 |
| | | | | DDIT3_P1313_R | 0.37 | 0.029135 | 0.026783 |
| | | | | MMP10_E136_R | 0.31 | 0.029563 | 0.027127 |
| | | | | PPAT_E170_R | 0.28 | 0.029693 | 0.027166 |
| | | | | APOC2_P377_F | 0.36 | 0.029711 | 0.027166 |
| | | | | HSPA2_P162_R | 0.40 | 0.029905 | 0.027271 |
| | | | | SEMA3B_P110_R | 0.33 | 0.02993 | 0.027271 |
| | | | | H19_P1411_R | −0.32 | 0.03002 | 0.027304 |
| | | | | IL18BP_E285_F | 0.36 | 0.030172 | 0.027394 |
| | | | | KRAS_P651_F | 0.21 | 0.030346 | 0.027503 |
| | | | | CHFR_P635_R | 0.37 | 0.0307 | 0.027775 |
| | | | | MAD2L1_E93_F | −0.31 | 0.030937 | 0.027941 |
| | | | | NBL1_E205_R | 0.31 | 0.031204 | 0.028133 |
| | | | | RBL2_P250_R | 0.31 | 0.031259 | 0.028133 |
| | | | | NGFR_E328_F | 0.41 | 0.031792 | 0.028563 |
| | | | | CDH17_E31_F | 0.32 | 0.032266 | 0.028938 |
| | | | | MAPK4_E273_R | −0.32 | 0.032516 | 0.029112 |
| | | | | SRC_P297_F | 0.37 | 0.032824 | 0.029337 |
| | | | | EFNA1_P7_F | 0.29 | 0.033925 | 0.030268 |
| | | | | TRIM29_E189_F | 0.31 | 0.034625 | 0.030807 |
| | | | | MC2R_P1025_F | −0.33 | 0.034649 | 0.030807 |
| | | | | LTB4R_E64_R | 0.31 | 0.034813 | 0.030901 |
| | | | | SPARC_P195_F | 0.31 | 0.034945 | 0.030964 |
| | | | | FHIT_E19_R | 0.21 | 0.035016 | 0.030974 |
| | | | | MSH2_P1008_F | 0.35 | 0.035525 | 0.031318 |
| | | | | TNFRSF10D_P70_F | 0.41 | 0.035527 | 0.031318 |
| | | | | GFI1_P208_R | 0.33 | 0.035754 | 0.031465 |
| | | | | SKI_E465_R | 0.18 | 0.036254 | 0.03185 |
| | | | | BCL2L2_P280_F | 0.36 | 0.036443 | 0.031962 |
| | | | | TUSC3_E29_R | 0.42 | 0.036625 | 0.032067 |
| | | | | ELK3_P514_F | 0.35 | 0.036858 | 0.032216 |
| | | | | RAD50_P191_F | 0.34 | 0.038143 | 0.033283 |
| | | | | KIT_P367_R | 0.40 | 0.038299 | 0.033297 |
| | | | | LIG3_P622_R | 0.28 | 0.038325 | 0.033297 |
| | | | | CD1A_P414_R | −0.52 | 0.038352 | 0.033297 |
| | | | | HDAC1_P414_R | 0.27 | 0.038713 | 0.033553 |
| | | | | UGT1A1_P564_R | 0.49 | 0.038802 | 0.033574 |
| | | | | CPNE1_P138_F | −0.42 | 0.039415 | 0.034048 |
| | | | | PI3_E107_F | −0.36 | 0.039628 | 0.034174 |
| | | | | ITGB4_P517_F | 0.28 | 0.040147 | 0.034564 |
| | | | | CXCL9_E268_R | 0.28 | 0.041398 | 0.035582 |
| | | | | ABCG2_P178_R | 0.26 | 0.041605 | 0.0357 |
| | | | | IGFBP5_P9_R | 0.40 | 0.043521 | 0.037282 |
| | | | | DIO3_E230_R | 0.38 | 0.043665 | 0.037343 |
| | | | | EPHB3_P569_R | 0.35 | 0.043968 | 0.03754 |
| | | | | GABRA5_P862_R | −0.30 | 0.044296 | 0.037718 |
| | | | | PTPRH_P255_F | 0.33 | 0.044322 | 0.037718 |
| | | | | HSD17B12_P97_F | 0.30 | 0.044955 | 0.038193 |
| | | | | GNAS_E58_F | 0.37 | 0.045037 | 0.0382 |
| | | | | AGXT_P180_F | −0.34 | 0.045119 | 0.038206 |
| | | | | WT1_P853_F | 0.41 | 0.045554 | 0.038512 |
| | | | | CARD15_P302_R | 0.40 | 0.046531 | 0.039273 |
| | | | | AFP_P824_F | −0.36 | 0.046897 | 0.039518 |
| | | | | HGF_P1293_R | −0.36 | 0.047957 | 0.040345 |
| | | | | PRSS8_E134_R | 0.25 | 0.048379 | 0.040634 |
| | | | | MUC1_E18_R | 0.26 | 0.048492 | 0.040662 |
| | | | | ERCC3_P1210_R | 0.51 | 0.049264 | 0.041243 |
| | | | | PROM1_P44_R | 0.36 | 0.049789 | 0.041615 |
| | | | | OSM_P34_F | 0.29 | 0.050276 | 0.041954 |
| | | | | FRK_P258_F | 0.30 | 0.051037 | 0.04252 |
| | | | | ONECUT2_P315_R | 0.44 | 0.051642 | 0.042954 |
| | | | | TSP50_E21_R | 0.37 | 0.051777 | 0.042997 |
| | | | | VAMP8_P241_F | 0.27 | 0.052199 | 0.043212 |
| | | | | DIRAS3_P745_F | 0.37 | 0.052203 | 0.043212 |
| | | | | NEU1_P745_F | −0.35 | 0.052365 | 0.043276 |
| | | | | COL4A3_P545_F | 0.33 | 0.053026 | 0.043753 |
| | | | | ETS1_P559_R | 0.44 | 0.053437 | 0.044022 |
| | | | | MC2R_E455_F | −0.39 | 0.054357 | 0.044708 |
| | | | | CDC25B_E83_F | 0.53 | 0.054498 | 0.044753 |
| | | | | OGG1_E400_F | 0.32 | 0.054712 | 0.044857 |
| | | | | GATA6_P726_F | 0.52 | 0.054832 | 0.044884 |
| | | | | DDB2_P407_F | −0.41 | 0.055252 | 0.045156 |
| | | | | TUSC3_P85_R | 0.33 | 0.05584 | 0.045565 |
| | | | | ZIM3_P718_R | −0.35 | 0.056332 | 0.045894 |
| | | | | TNFRSF1B_P167_F | 0.40 | 0.057055 | 0.046364 |
| | | | | MMP14_P13_F | 0.26 | 0.05709 | 0.046364 |
| | | | | MMP3_P16_R | −0.32 | 0.057598 | 0.046704 |
| | | | | IGSF4_P454_F | 0.54 | 0.057718 | 0.046727 |
| | | | | CEACAM1_P44_R | 0.27 | 0.057857 | 0.046767 |
| | | | | HTR2A_P853_F | 0.40 | 0.058333 | 0.047077 |
| | | | | HLA-DPB1_P540_F | 0.37 | 0.058588 | 0.04716 |
| | | | | PTHLH_P15_R | 0.31 | 0.05863 | 0.04716 |
| | | | | GPX1_E46_R | 0.30 | 0.05871 | 0.04716 |
| | | | | TFPI2_E141_F | 0.44 | 0.058926 | 0.04726 |
| | | | | GSTM1_P363_F | 0.46 | 0.060177 | 0.048188 |
| | | | | PCDH1_E22_F | 0.12 | 0.060543 | 0.048406 |
| | | | | IGFBP5_E144_F | 0.31 | 0.062064 | 0.049546 |
| | | | | NNAT_P544_R | 0.42 | 0.062614 | 0.049907 |

*Positive coefficient indicates increased methylation in invasive tumors

SUPPLEMENTAL TABLE 16
Rank order of CpGs most differentially methylated between RPMM class 4
(with significantly higher prevalence of invasive bladder tumors) and other RPMM classes.

| Series 1 | | Series 2 | |
|---|---|---|---|
| GENE_CpG | AUC for Class 4 vs other | GENE_CpG | AUC for Class 4 vs other |
| CASP10_P186_F | 0.877 | NPY_E31_R | 0.917 |
| THBS2_P605_R | 0.865 | HS3ST2_E145_R | 0.917 |
| KRT13_P341_R | 0.861 | NPY_P295_F | 0.915 |
| CXCL9_E268_R | 0.859 | MYOD1_E156_F | 0.907 |
| SMO_P455_R | 0.854 | SOX1_P294_F | 0.894 |
| TGFB3_E58_R | 0.850 | HS3ST2_P171_F | 0.892 |
| PRSS8_E134_R | 0.849 | SLIT2_E111_R | 0.875 |
| SERPINB5_P19_R | 0.846 | TMEFF2_P152_R | 0.874 |
| TJP1_P326_R | 0.841 | FGF2_P229_F | 0.873 |
| KRT5_P308_F | 0.841 | EYA4_E277_F | 0.870 |
| FGFR4_P610_F | 0.838 | SOX1_P1018_R | 0.868 |
| FGF1_P357_R | 0.836 | DLK1_E227_R | 0.866 |
| FGF1_E5_F | 0.836 | IRAK3_P185_F | 0.863 |
| TRIM29_P135_F | 0.834 | TMEFF2_E94_R | 0.860 |
| MYCN_P464_R | 0.833 | RBP1_E158_F | 0.855 |
| NOS3_P38_F | 0.831 | CDH11_P354_R | 0.849 |
| MAP3K1_P7_F | 0.830 | FGF3_E198_R | 0.844 |
| NBL1_E205_R | 0.830 | CDH11_P203_R | 0.841 |
| SLC14A1_E295_F | 0.829 | SLC5A8_E60_R | 0.837 |
| EFNB3_P442_R | 0.828 | FGF3_P171_R | 0.835 |
| RIPK1_P868_F | 0.826 | PYCARD_P150_F | 0.834 |
| TMPRSS4_E83_F | 0.826 | VIM_P811_R | 0.831 |
| FRK_P36_F | 0.822 | GALR1_P80_F | 0.831 |
| IRF5_P123_F | 0.822 | MOS_E60_R | 0.827 |
| TRIM29_E189_F | 0.816 | HS3ST2_P546_F | 0.825 |
| CSF2_E248_R | 0.815 | CDH13_P88_F | 0.825 |
| BMP4_P199_R | 0.814 | GALR1_E52_F | 0.824 |
| MST1R_E42_R | 0.814 | NTSR1_E109_F | 0.823 |
| VAMP8_P241_F | 0.811 | IRAK3_P13_F | 0.822 |
| ACVR1_E328_R | 0.810 | NPY_P91_F | 0.821 |
| NID1_P714_R | 0.810 | SOX17_P287_R | 0.819 |
| SPDEF_P6_R | 0.809 | SMO_E57_F | 0.819 |
| MMP7_E59_F | 0.808 | TP73_P945_F | 0.818 |
| UGT1A1_P315_R | 0.808 | EPHA5_E158_R | 0.815 |
| KRT5_E196_R | 0.807 | CDH11_E102_R | 0.813 |
| SFN_E118_F | 0.807 | FLT4_E206_F | 0.812 |
| CSF1R_P73_F | 0.804 | AGTR1_P154_F | 0.811 |
| FRK_P258_F | 0.804 | CSPG2_P82_R | 0.808 |
| ACVR1C_P115_R | 0.803 | TERT_P360_R | 0.807 |
| AOC3_P890_R | 0.803 | GDF10_P95_R | 0.807 |
| PCDH1_E22_F | 0.803 | TPEF_seq_44_S88_R | 0.806 |
| ACVR1_P983_F | 0.800 | ZIM2_P22_F | 0.805 |
| IRF7_E236_R | 0.800 | TPEF_seq_44_S36_F | 0.804 |
| TRPM5_P979_F | 0.800 | AGTR1_P41_F | 0.803 |
| FANCF_P13_F | 0.798 | KDR_P445_R | 0.803 |
| CREBBP_P712_R | 0.798 | FGF8_P473_F | 0.803 |
| STAT5A_P704_R | 0.797 | CDH13_E102_F | 0.802 |
| CSF2_P605_F | 0.796 | PENK_E26_F | 0.799 |
| IGF2R_P396_R | 0.795 | IRAK3_E130_F | 0.796 |
| IRAK3_P13_F | 0.792 | WNT2_P217_F | 0.795 |
| LIG3_P622_R | 0.792 | HTR1B_E232_R | 0.794 |
| SRC_P297_F | 0.792 | TAL1_P594_F | 0.794 |
| PAX6_E129_F | 0.791 | MDR1_seq_42_S300_R | 0.794 |
| CDH17_P376_F | 0.790 | RASSF1_P244_F | 0.792 |
| IRAK3_P185_F | 0.790 | GAS7_E148_F | 0.791 |
| MBD2_P233_F | 0.790 | IPF1_P750_F | 0.790 |
| CDH17_E31_F | 0.789 | DBC1_E204_F | 0.790 |
| SRC_P164_F | 0.789 | CD9_P585_R | 0.789 |
| EGF_P413_F | 0.788 | CFTR_P372_R | 0.788 |
| EDN1_E50_R | 0.787 | CFTR_P115_F | 0.788 |
| CEACAM1_P44_R | 0.786 | CCND2_P887_F | 0.788 |
| HLA-DOA_P191_R | 0.785 | HLF_E192_F | 0.785 |
| IL1RN_E42_F | 0.783 | NTSR1_P318_F | 0.784 |
| IRAK3_E130_F | 0.781 | ADCYAP1_P455_R | 0.783 |
| RARA_P176_R | 0.781 | DCC_P471_R | 0.782 |
| KRT13_P676_F | 0.780 | STAT5A_P704_R | 0.781 |
| FGF2_P229_F | 0.779 | CCNA1_E7_F | 0.780 |
| PI3_P274_R | 0.776 | DES_E228_R | 0.780 |
| GRB10_E85_R | 0.775 | ADAMTS12_E52_R | 0.780 |
| NOS2A_E117_R | 0.774 | MYOD1_P50_F | 0.780 |
| HDAC1_P414_R | 0.772 | RIPK1_P868_F | 0.779 |
| S100A2_P1186_F | 0.772 | DBC1_P351_R | 0.778 |
| LMO1_E265_R | 0.771 | RBP1_P150_F | 0.777 |
| CD9_P585_R | 0.771 | HHIP_E94_F | 0.776 |
| CHFR_P635_R | 0.771 | RBP1_P426_R | 0.776 |
| SNCG_P53_F | 0.769 | CHGA_E52_F | 0.772 |
| IL1RN_P93_R | 0.767 | PLXDC2_E337_F | 0.772 |
| SNCG_E119_F | 0.766 | VIM_P343_R | 0.771 |
| SHH_E328_F | 0.765 | FLI1_E29_F | 0.771 |
| MCM2_P241_R | 0.765 | SFRP1_E398_R | 0.771 |
| ERBB4_P541_F | 0.765 | TERT_E20_F | 0.771 |
| NOTCH1_P1198_F | 0.763 | SLIT2_P208_F | 0.770 |
| GAS7_P622_R | 0.762 | PENK_P447_R | 0.770 |
| LCN2_P141_R | 0.761 | HOXB2_P488_R | 0.769 |
| AATK_E63_R | 0.761 | SMO_P455_R | 0.769 |
| TGFB2_E226_R | 0.760 | EYA4_P794_F | 0.768 |
| DLL1_P832_F | 0.759 | EYA4_P508_F | 0.767 |
| PTPN6_P282_R | 0.759 | DIO3_P674_F | 0.767 |
| TRIM29_P261_F | 0.758 | NEFL_P209_R | 0.766 |
| E2F5_P516_R | 0.758 | KDR_E79_F | 0.766 |
| ALOX12_E85_R | 0.757 | CALCA_E174_R | 0.765 |
| SNCG_P98_R | 0.757 | FRZB_E186_R | 0.765 |
| CLDN4_P1120_R | 0.757 | MT1A_P600_F | 0.764 |
| SYK_E372_F | 0.756 | FLT3_E326_R | 0.764 |
| HOXB2_P99_F | 0.755 | IGF2_P1036_R | 0.763 |
| MFAP4_P197_F | 0.754 | CCND2_P898_R | 0.763 |
| IGFBP1_E48_R | 0.754 | SFRP1_P157_F | 0.763 |
| CSF1R_E26_F | 0.754 | RASSF1_E116_F | 0.762 |
| TMPRSS4_P552_F | 0.753 | SPI1_P48_F | 0.762 |
| IL2_P607_R | 0.752 | ISL1_P379_F | 0.762 |
| FRZB_E186_R | 0.751 | ADCYAP1_P398_F | 0.762 |
| MMP14_P13_F | 0.751 | PTPRG_P476_F | 0.762 |
| CRK_P721_F | 0.751 | HTR1B_P107_F | 0.761 |
| AFF3_P808_F | 0.749 | IGFBP2_P306_F | 0.761 |
| MMP14_P208_R | 0.749 | IGF2AS_P203_F | 0.761 |
| RASSF1_E116_F | 0.748 | HCK_P46_R | 0.760 |
| IGFBP6_E47_F | 0.747 | FLT4_P180_R | 0.760 |
| LCN2_P86_R | 0.746 | TBX1_P520_F | 0.759 |
| ALOX12_P223_R | 0.745 | EPHA5_P66_F | 0.759 |
| GSTM2_P453_R | 0.743 | HOXB2_P99_F | 0.759 |
| CD40_P372_R | 0.743 | KRT13_P676_F | 0.759 |
| MAS1_P657_R | 0.742 | FLT3_P302_F | 0.759 |
| FASTK_P598_R | 0.742 | GPX3_E178_F | 0.758 |
| MMP3_P16_R | 0.742 | KIT_P405_F | 0.757 |
| P2RX7_P597_F | 0.742 | ST6GAL1_P528_F | 0.756 |
| PTPRH_E173_F | 0.741 | DIO3_E230_R | 0.754 |
| VAV1_P317_F | 0.741 | CD9_P504_F | 0.754 |
| SFTPA1_E340_R | 0.741 | CALCA_P75_F | 0.754 |
| EPHX1_P22_F | 0.740 | TGFB2_E226_R | 0.753 |
| GABRA5_E44_R | 0.739 | COL18A1_P494_R | 0.752 |
| KCNK4_P171_R | 0.739 | CYP1B1_E83_R | 0.752 |
| XRCC2_P1077_F | 0.739 | HTR1B_P222_F | 0.751 |
| ABCG2_P178_R | 0.738 | PTPRG_E40_R | 0.750 |
| GSTM2_E153_F | 0.738 | TSP50_E21_R | 0.749 |
| ACVR1C_P363_F | 0.738 | FLT1_P615_R | 0.749 |
| AIM2_E208_F | 0.737 | OAT_P465_F | 0.749 |
| NTSR1_P318_F | 0.737 | ISL1_E87_R | 0.747 |
| S100A2_E36_R | 0.737 | TWIST1_P44_R | 0.747 |
| IGF2AS_P203_F | 0.737 | COL1A2_E299_F | 0.746 |
| PSCA_P135_F | 0.737 | ASCL2_P360_F | 0.746 |
| MEG3_E91_F | 0.737 | MT1A_E13_R | 0.745 |
| PPARG_P693_F | 0.736 | ASCL1_E24_F | 0.745 |
| TNFRSF1A_P678_F | 0.736 | NTRK3_P752_F | 0.744 |
| TRIP6_P1090_F | 0.736 | GABRB3_E42_F | 0.744 |
| MUC1_E18_R | 0.736 | NRG1_E74_F | 0.744 |
| MYB_P673_R | 0.735 | KRT13_P341_R | 0.743 |
| EMR3_P39_R | 0.735 | FLI1_P620_R | 0.743 |
| SHB_P691_R | 0.735 | PROK2_P390_F | 0.741 |
| TNFRSF10A_P91_F | 0.734 | ASCL2_E76_R | 0.741 |
| SLIT2_P208_F | 0.734 | GAS7_P622_R | 0.740 |
| SRC_E100_R | 0.734 | ZIM2_E110_F | 0.740 |
| JAG2_P264_F | 0.734 | ERG_E28_F | 0.740 |
| RIPK4_E166_F | 0.733 | FRZB_P406_F | 0.739 |
| MLH3_P25_F | 0.733 | OPCML_E219_R | 0.739 |
| SLC14A1_P369_R | 0.733 | GP1BB_P278_R | 0.739 |
| IGF1R_P325_R | 0.733 | ADAMTS12_P250_R | 0.739 |
| CCL3_E53_R | 0.733 | TAL1_E122_F | 0.738 |
| MMP19_E274_R | 0.733 | RAN_P581_R | 0.738 |
| UGT1A1_E11_F | 0.733 | IFNGR2_E164_F | 0.737 |
| JUNB_P1149_R | 0.733 | IGFBP7_P297_F | 0.737 |
| CASP8_E474_F | 0.731 | BDNF_E19_R | 0.735 |
| SPI1_P929_F | 0.731 | NGFR_P355_F | 0.734 |
| IGFBP6_P328_R | 0.731 | GSTM2_P109_R | 0.734 |
| FGFR1_E317_F | 0.730 | PODXL_P1341_R | 0.734 |
| JAK3_P1075_R | 0.730 | GSTM2_P453_R | 0.734 |
| SYK_P584_F | 0.729 | TAL1_P817_F | 0.734 |
| PDGFRB_P273_F | 0.729 | IGF2AS_E4_F | 0.733 |
| ER_seq_a1_S60_F | 0.729 | POMC_P400_R | 0.732 |
| GLI2_P295_F | 0.728 | AATK_P519_R | 0.732 |
| TFF2_P178_F | 0.728 | PALM2-AKAP2_P420_R | 0.731 |
| GABRG3_P75_F | 0.727 | MLLT4_P1400_F | 0.730 |
| MMP9_P189_F | 0.726 | ISL1_P554_F | 0.730 |
| MST1R_P87_R | 0.726 | KIT_P367_R | 0.730 |
| FGF6_E294_F | 0.726 | MYH11_P236_R | 0.729 |
| ZNFN1A1_P179_F | 0.726 | NTRK3_E131_F | 0.729 |
| GJB2_P931_R | 0.726 | HIC2_P498_F | 0.729 |
| PWCR1_E81_R | 0.725 | TIMP3_seq_7_S38_F | 0.729 |
| CPA4_E20_F | 0.725 | WT1_E32_F | 0.728 |
| NPY_P295_F | 0.725 | CCKBR_P480_F | 0.727 |
| NID1_P677_F | 0.724 | ETV1_P235_F | 0.727 |
| MMP3_P55_F | 0.723 | RET_seq_54_S260_F | 0.726 |
| CDK10_P199_R | 0.723 | KRT5_P308_F | 0.726 |
| DDR2_P743_R | 0.722 | GUCY2D_E419_R | 0.725 |
| CARD15_P302_R | 0.722 | HLA-F_E402_F | 0.725 |
| ATP10A_P147_F | 0.722 | HLA-DOA_P191_R | 0.724 |
| NOS2A_P288_R | 0.721 | THY1_P149_R | 0.724 |
| FES_P223_R | 0.721 | MMP2_P197_F | 0.724 |
| CEACAM1_E57_R | 0.721 | ALOX12_P223_R | 0.723 |
| DNMT3B_P352_R | 0.721 | RASGRF1_E16_F | 0.723 |
| PTK2B_P673_R | 0.721 | PRKCDBP_E206_F | 0.723 |
| CD9_P504_F | 0.721 | MYH11_P22_F | 0.722 |
| ZAP70_P220_R | 0.721 | ALPL_P278_F | 0.722 |
| MAPK14_P327_R | 0.720 | DCC_E53_R | 0.722 |
| TERT_P360_R | 0.719 | EPO_E244_R | 0.722 |
| TRIP6_P1274_R | 0.718 | RIPK3_P124_F | 0.721 |
| MAF_P826_R | 0.718 | CALCA_P171_F | 0.721 |
| TGFA_P642_R | 0.718 | HPN_P823_F | 0.721 |
| SFTPC_E13_F | 0.718 | POMC_P53_F | 0.721 |
| ID1_P659_R | 0.717 | FGFR1_P204_F | 0.720 |
| WNT8B_P216_R | 0.716 | THY1_P20_R | 0.720 |
| HBII-52_P563_F | 0.716 | FGF1_P357_R | 0.719 |
| TFF1_P180_R | 0.716 | GSTM2_E153_F | 0.718 |
| P2RX7_E323_R | 0.716 | GJB2_P931_R | 0.717 |
| SNRPN_P230_R | 0.716 | CD40_E58_R | 0.717 |
| TEK_E75_F | 0.716 | CSPG2_E38_F | 0.717 |
| PLAT_P80_F | 0.715 | PYCARD_P393_F | 0.716 |
| RIPK3_P124_F | 0.715 | GJB2_P791_R | 0.716 |
| DHCR24_P406_R | 0.715 | GSTP1_P74_F | 0.716 |
| NPY_E31_R | 0.714 | ACVR1_E328_R | 0.715 |
| ESR1_E298_R | 0.713 | TBX1_P885_R | 0.715 |
| IL12A_E287_R | 0.713 | SLC5A8_P38_R | 0.715 |
| ENC1_P484_R | 0.713 | F2R_P839_F | 0.713 |
| TSC2_E140_F | 0.712 | ALPL_P433_F | 0.713 |
| IL1B_P582_R | 0.712 | CD44_E26_F | 0.713 |
| ITGB4_E144_F | 0.712 | KRT5_E196_R | 0.713 |
| FAS_P322_R | 0.711 | TFPI2_P9_F | 0.713 |
| RAD50_P191_F | 0.710 | HPN_P374_R | 0.713 |
| RARRES1_E235_F | 0.710 | VAV1_P317_F | 0.713 |
| TMEFF1_P626_R | 0.709 | PDGFB_P719_F | 0.713 |
| TNK1_P41_R | 0.708 | SOX17_P303_F | 0.712 |
| GSTM2_P109_R | 0.708 | IGFBP2_P353_R | 0.711 |
| TYRO3_P501_F | 0.708 | AATK_P709_R | 0.710 |
| BAX_E281_R | 0.707 | IL18BP_P51_R | 0.710 |
| IL3_P556_F | 0.707 | IGF2_P36_R | 0.710 |
| HOXB2_P488_R | 0.707 | TNFRSF10C_P7_F | 0.710 |
| BCL2L2_P280_F | 0.707 | JAK3_E64_F | 0.709 |
| PADI4_E24_F | 0.706 | HHIP_P307_R | 0.709 |
| CAPG_E228_F | 0.706 | GSTM1_P363_F | 0.709 |
| SPI1_P48_F | 0.706 | ACVR1_P983_F | 0.709 |
| VAMP8_P114_F | 0.705 | PDGFRB_P273_F | 0.709 |
| HCK_P858_F | 0.705 | RIPK1_P744_R | 0.709 |
| FGFR2_P266_R | 0.705 | ITGA6_P718_R | 0.708 |
| GPR116_E328_R | 0.705 | DIO3_P90_F | 0.708 |
| SEMA3B_P110_R | 0.703 | NRG1_P558_R | 0.708 |
| SFN_P248_F | 0.702 | NGFR_E328_F | 0.708 |
| NEFL_P209_R | 0.701 | MFAP4_P197_F | 0.708 |
| VAMP8_E7_F | 0.701 | COL1A1_P5_F | 0.708 |
| RARRES1_P426_R | 0.701 | MMP2_E21_R | 0.708 |
| NR2F6_E375_R | 0.700 | COL1A2_P48_R | 0.707 |
| EMR3_E61_F | 0.700 | RET_seq_53_S374_F | 0.707 |
| B3GALT5_P330_F | 0.700 | NTRK2_P10_F | 0.706 |
| PTPRO_E56_F | 0.700 | CCNA1_P216_F | 0.706 |
| ITK_E166_R | 0.700 | FZD9_P175_F | 0.706 |
| EVI1_E47_R | 0.700 | PDGFRB_P343_F | 0.705 |
| BCL6_P248_R | 0.699 | ST6GAL1_P164_R | 0.704 |
| MDS1_E45_F | 0.699 | SEZ6L_P249_F | 0.704 |
| MC2R_P1025_F | 0.699 | NPR2_P618_F | 0.703 |
| MCC_P196_R | 0.699 | GFI1_P45_R | 0.703 |
| BLK_P668_R | 0.698 | GSTP1_E322_R | 0.703 |
| CSF1_P339_F | 0.698 | PDGFRA_P1429_F | 0.702 |
| DAPK1_E46_R | 0.698 | VAV1_E9_F | 0.702 |
| LY6G6E_P45_R | 0.698 | ALK_E183_R | 0.702 |
| MPL_P657_F | 0.697 | F2R_P88_F | 0.701 |
| HLA-DQA2_E93_F | 0.697 | SLC22A3_P528_F | 0.701 |
| CA5P10_P334_F | 0.697 | EPHA7_E6_F | 0.701 |
| ETV6_E430_F | 0.696 | MEG3_P235_F | 0.700 |
| PTPN6_E171_R | 0.696 | DLL1_P832_F | 0.699 |
| ERG_E28_F | 0.696 | NTRK3_P636_R | 0.699 |
| HLA-DPA1_P205_R | 0.696 | TEK_E75_F | 0.699 |
| DLC1_E276_F | 0.695 | HIC-1_seq_48_S103_R | 0.698 |
| IGF1R_E186_R | 0.695 | SPARC_E50_R | 0.698 |
| CD1A_P414_R | 0.695 | IL1B_P582_R | 0.698 |
| EPHB3_E0_F | 0.694 | IGSF4_P86_R | 0.698 |
| DDR1_P332_R | 0.694 | NOTCH4_E4_F | 0.698 |
| PDGFB_P719_F | 0.694 | CD40_P372_R | 0.697 |
| CSF3_P309_R | 0.694 | LEFTY2_P719_F | 0.697 |
| HRASLS_P353_R | 0.694 | GRB10_P496_R | 0.697 |
| LRP2_E20_F | 0.693 | PALM2-AKAP2_P183_R | 0.697 |
| HOXA9_P1141_R | 0.693 | TWIST1_E117_R | 0.697 |
| MYLK_P469_R | 0.693 | CYP1B1_P212_F | 0.697 |
| CYP1A1_P382_F | 0.693 | KLK10_P268_R | 0.697 |
| GP1BB_P278_R | 0.693 | ASCL1_P747_F | 0.696 |
| ERBB4_P255_F | 0.693 | FABP3_P598_F | 0.696 |
| ITPR3_P1112_F | 0.692 | MPL_P62_F | 0.696 |
| RHOH_P121_F | 0.692 | TMEFF2_P210_R | 0.696 |
| HS3ST2_E145_R | 0.692 | HIC2_P528_R | 0.696 |
| TBX1_P520_F | 0.692 | GDF10_E39_F | 0.695 |
| RET_P717_F | 0.692 | LMO1_E265_R | 0.695 |
| IRF7_P277_R | 0.691 | CSF3_P309_R | 0.695 |
| NDN_E131_R | 0.691 | JAK3_P156_R | 0.694 |
| EPHA1_E46_R | 0.691 | SCGB3A1_E55_R | 0.693 |
| INHA_P1144_R | 0.691 | IL18BP_E285_F | 0.693 |
| RASSF1_P244_F | 0.691 | DIRAS3_P745_F | 0.693 |
| TFF2_P557_R | 0.690 | SLC5A5_E60_F | 0.693 |
| HOXA5_P479_F | 0.690 | PCDH1_E22_F | 0.693 |
| ZIM3_E203_F | 0.690 | NTRK2_P395_R | 0.692 |
| GRB7_P160_R | 0.690 | PDGFRA_E125_F | 0.692 |
| OAT_P465_F | 0.689 | TNFRSF10C_E109_F | 0.692 |
| DAPK1_P10_F | 0.689 | DIRAS3_E55_R | 0.692 |
| PADI4_P1158_R | 0.689 | PRDM2_P1340_R | 0.692 |
| IPF1_P750_F | 0.689 | CSF1R_E26_F | 0.692 |
| TGFBI_P31_R | 0.689 | RET_P717_F | 0.692 |
| GRB10_P260_F | 0.688 | COL18A1_P365_R | 0.691 |
| RIPK3_P24_F | 0.688 | ALOX12_E85_R | 0.691 |
| PTCH2_E173_F | 0.688 | TJP2_P518_F | 0.691 |
| HLA-DOB_E432_R | 0.687 | FLT1_E444_F | 0.691 |
| BCR_P346_F | 0.687 | EGF_P242_R | 0.691 |
| PLA2G2A_P528_F | 0.687 | EPHA7_P205_R | 0.691 |
| MCAM_P169_R | 0.687 | TSP50_P137_F | 0.691 |
| EPHA2_P203_F | 0.686 | IL17RB_E164_R | 0.690 |
| TYRO3_P366_F | 0.686 | TCF4_P317_F | 0.689 |
| CLK1_P538_F | 0.686 | FGF1_E5_F | 0.689 |
| FHIT_E19_R | 0.685 | FGF8_E183_F | 0.688 |
| HFE_E273_R | 0.685 | PDE1B_E141_F | 0.688 |
| ABCB4_P51_F | 0.684 | NGFB_P13_F | 0.688 |
| SMARCB1_P220_R | 0.684 | EGF_P413_F | 0.687 |
| MMP10_E136_R | 0.684 | LRRC32_P865_R | 0.687 |
| CDKN1A_P242_F | 0.684 | ACTG2_E98_R | 0.686 |
| VIM_P811_R | 0.683 | CSF3R_P8_F | 0.685 |
| CTNNA1_P382_R | 0.683 | TRPM5_P979_F | 0.684 |
| DUSP4_E61_F | 0.683 | SOD3_P225_F | 0.684 |
| GRB7_E71_R | 0.683 | ZNF215_P71_R | 0.684 |
| IGFBP2_P353_R | 0.682 | ETV1_P515_F | 0.684 |
| IAPP_E280_F | 0.682 | ABO_E110_F | 0.684 |
| DSC2_E90_F | 0.682 | EPO_P162_R | 0.684 |
| TCF7L2_E411_F | 0.681 | TNF_P1084_F | 0.683 |
| SPP1_P647_F | 0.681 | APOA1_P75_F | 0.683 |
| LIF_E208_F | 0.681 | DSC2_P407_R | 0.683 |
| PTPRH_P255_F | 0.681 | NGFB_E353_F | 0.683 |
| MYCN_E77_R | 0.680 | PTCH2_P37_F | 0.683 |
| SPP1_E140_R | 0.680 | MFAP4_P10_R | 0.683 |
| APOA1_P261_F | 0.680 | S100A4_P194_R | 0.683 |
| CDH13_P88_F | 0.680 | FGFR1_E317_F | 0.683 |
| LRRK1_P39_F | 0.680 | MEG3_E91_F | 0.682 |
| USP29_P282_R | 0.679 | SLC22A3_P634_F | 0.682 |
| GPX3_E178_F | 0.679 | FLT1_P302_F | 0.681 |
| TNFRSF10C_E109_F | 0.679 | IGSF4_P454_F | 0.681 |
| GNAS_P86_F | 0.679 | GLI3_P453_R | 0.681 |
| FES_E34_R | 0.678 | STAT5A_E42_F | 0.680 |
| MMP1_P460_F | 0.678 | LMO2_P794_R | 0.680 |
| p16_seq_47_S188_R | 0.678 | GSTM1_P266_F | 0.680 |
| TFDP1_P543_R | 0.677 | MMP19_E274_R | 0.679 |
| CPA4_P961_R | 0.677 | DSG1_E292_F | 0.679 |
| ZP3_P220_F | 0.677 | DNAJC15_E26_R | 0.679 |
| HIC1_P565_R | 0.677 | FGF5_E16_F | 0.679 |
| ITGA6_P718_R | 0.677 | TJP2_P330_R | 0.679 |
| SEMA3F_E333_R | 0.676 | MATK_P190_R | 0.679 |
| MMP8_E89_R | 0.676 | HOXA5_P1324_F | 0.678 |
| EGFR_P260_R | 0.676 | CSF2_P605_F | 0.678 |
| TNFRSF10C_P7_F | 0.675 | GABRB3_P92_F | 0.678 |
| P2RX7_P119_R | 0.675 | LRRC32_E157_F | 0.678 |
| TDG_E129_F | 0.675 | WNT10B_P993_F | 0.677 |
| PYCARD_E87_F | 0.674 | BDNF_P259_R | 0.677 |
| GALR1_E52_F | 0.674 | MST1R_P392_F | 0.676 |
| PTCH_E42_F | 0.674 | KCNK4_P171_R | 0.676 |
| TMEFF2_P152_R | 0.674 | LRRK1_P39_F | 0.676 |
| HBII-52_P659_F | 0.674 | EPHA3_P106_R | 0.675 |
| SLC22A2_E271_R | 0.673 | HOXA5_P479_F | 0.674 |
| RARA_E128_R | 0.673 | RARB_E114_F | 0.674 |
| FAS_P65_F | 0.673 | PLA2G2A_E268_F | 0.674 |
| PYCARD_P150_F | 0.672 | CTNNB1_P757_F | 0.674 |
| DLC1_P88_R | 0.672 | PLG_E406_F | 0.674 |
| F2R_P88_F | 0.672 | HCK_P858_F | 0.673 |
| MOS_E60_R | 0.672 | WT1_P853_F | 0.672 |
| MAPK10_E26_F | 0.671 | GP1BB_E23_F | 0.672 |
| PLAT_E158_F | 0.671 | THBS2_P605_R | 0.672 |
| RIPK4_P172_F | 0.671 | GFI1_E136_F | 0.671 |
| TGFB1_P833_R | 0.670 | SHH_P104_R | 0.671 |
| PPAT_E170_R | 0.670 | EVI2A_P94_R | 0.671 |
| NBL1_P24_F | 0.670 | FGF7_P610_F | 0.671 |
| HLA-DPB1_P540_F | 0.669 | DCC_P177_F | 0.670 |
| CD44_E26_F | 0.669 | PDE1B_P263_R | 0.670 |
| GLI2_E90_F | 0.669 | IGFBP7_P371_F | 0.670 |
| IGFBP5_P9_R | 0.668 | DDR2_P743_R | 0.669 |
| EPHX1_E152_F | 0.668 | MSH2_P1008_F | 0.669 |
| PXN_P308_F | 0.668 | PTHR1_E36_R | 0.669 |
| ATP10A_P524_R | 0.668 | MCAM_P265_R | 0.669 |
| IGFBP3_E65_R | 0.667 | DDR2_E331_F | 0.668 |
| CTGF_E156_F | 0.667 | SERPINE1_E189_R | 0.668 |
| CDK10_E74_F | 0.667 | ERN1_P809_R | 0.667 |
| GAS1_P754_R | 0.667 | ABO_P312_F | 0.667 |
| TGFBR3_P429_F | 0.667 | COMT_E401_F | 0.667 |
| LIMK1_P709_R | 0.666 | BMP6_P163_F | 0.667 |
| TMEFF1_P234_F | 0.666 | MMP2_P303_R | 0.667 |
| TJP1_P390_F | 0.666 | CHD2_P667_F | 0.666 |
| BLK_P14_F | 0.666 | SEZ6L_P299_F | 0.666 |
| ABCC2_E16_R | 0.666 | TWIST1_P355_R | 0.665 |
| APBA1_E99_R | 0.666 | WNT1_P79_R | 0.665 |
| NKX3-1_P871_R | 0.665 | EVI2A_E420_F | 0.664 |
| CSPG2_P82_R | 0.665 | IL1A_E113_R | 0.664 |
| THPO_E483_F | 0.665 | HOXA5_E187_F | 0.664 |
| SMO_E57_F | 0.665 | XPC_P226_R | 0.664 |
| MUSK_P308_F | 0.664 | FES_P223_R | 0.664 |
| TMEFF2_P210_R | 0.664 | TGFB2_P632_F | 0.664 |
| STAT5A_E42_F | 0.664 | TNFRSF1A_P678_F | 0.663 |
| IL6_E168_F | 0.664 | SEMA3C_P642_F | 0.662 |
| TJP2_P330_R | 0.663 | FOLR1_E368_R | 0.662 |
| TNFSF10_P2_R | 0.663 | FES_E34_R | 0.662 |
| CTSD_P726_F | 0.663 | NPR2_P1093_F | 0.662 |
| EDN1_P39_R | 0.662 | IL10_P85_F | 0.661 |
| GATA6_P21_R | 0.661 | FZD9_E458_F | 0.661 |
| DST_E31_F | 0.661 | MLF1_E243_F | 0.661 |
| EYA4_E277_F | 0.661 | CSF2_E248_R | 0.661 |
| HSD17B12_P97_F | 0.660 | CDC25B_P11_R | 0.661 |
| PLAUR_E123_F | 0.660 | TIE1_E66_R | 0.661 |
| TERT_E20_F | 0.660 | S100A4_P887_R | 0.660 |
| SPI1_E205_F | 0.659 | TGFB1_P833_R | 0.660 |
| PGF_E33_F | 0.659 | CCKBR_P361_R | 0.660 |
| IGF2AS_E4_F | 0.659 | EPHX1_P22_F | 0.659 |
| ZIM3_P718_R | 0.659 | MME_E29_F | 0.659 |
| NPR2_P1093_F | 0.659 | S100A4_E315_F | 0.659 |
| RUNX3_P247_F | 0.659 | TFPI2_P152_R | 0.658 |
| PSCA_E359_F | 0.659 | SOD3_P460_R | 0.658 |
| GRB10_P496_R | 0.659 | GRB10_P260_F | 0.658 |
| HBII-52_E142_F | 0.658 | RAB32_E314_R | 0.657 |
| CPNE1_P138_F | 0.658 | TCF4_P175_R | 0.657 |
| MMP19_P306_F | 0.658 | TNFRSF10D_P70_F | 0.657 |
| HS3ST2_P171_F | 0.658 | HDAC9_E38_F | 0.656 |
| ERCC6_P698_R | 0.658 | MME_P388_F | 0.655 |
| RARA_P1076_R | 0.658 | CDC25B_E83_F | 0.655 |
| SEPT9_P58_R | 0.657 | CD44_P87_F | 0.654 |
| GPX1_P194_F | 0.657 | FHIT_E19_R | 0.654 |
| SERPINE1_P519_F | 0.657 | ETS1_P559_R | 0.654 |
| IGF1_E394_F | 0.657 | ALK_P28_F | 0.654 |
| GLI3_P453_R | 0.656 | HLA-DOA_P594_F | 0.654 |
| ITK_P114_F | 0.656 | ZNF264_P397_F | 0.653 |
| EPHA1_P119_R | 0.656 | P2RX7_P119_R | 0.653 |
| BCR_P422_F | 0.656 | PLXDC1_P236_F | 0.653 |
| DSP_P36_F | 0.656 | ACTG2_P346_F | 0.653 |
| TUSC3_E29_R | 0.656 | CSF1_P339_F | 0.653 |
| IGFBP1_P12_R | 0.655 | LTB4R_E64_R | 0.653 |
| SH3BP2_E18_F | 0.655 | PTHLH_E251_F | 0.653 |
| PITX2_P183_R | 0.655 | COL4A3_E205_R | 0.653 |
| BRCA1_P835_R | 0.655 | PLAGL1_P236_R | 0.652 |
| OGG1_E400_F | 0.655 | FGF7_P44_F | 0.652 |
| PKD2_P287_R | 0.655 | ASCL2_P609_R | 0.652 |
| CD44_P87_F | 0.654 | LRP2_E20_F | 0.652 |
| HPN_P823_F | 0.654 | JAK3_P1075_R | 0.652 |
| PWCR1_P811_F | 0.653 | TMEFF1_P626_R | 0.652 |
| KCNQ1_P546_R | 0.653 | UGT1A1_P564_R | 0.651 |
| EPHA2_P340_R | 0.653 | RUNX3_P393_R | 0.651 |
| PLG_P370_F | 0.653 | SPP1_E140_R | 0.651 |
| HOXA9_E252_R | 0.652 | CD86_P3_F | 0.651 |
| EGF_P242_R | 0.652 | NID1_P714_R | 0.650 |
| KLK10_P268_R | 0.652 | HOXC6_P585_R | 0.650 |
| RUNX3_E27_R | 0.652 | TMPRSS4_P552_F | 0.650 |
| CCNA1_E7_F | 0.652 | RARA_P176_R | 0.650 |
| MST1R_P392_F | 0.651 | HBII-52_P659_F | 0.650 |
| DCN_P1320_R | 0.651 | MYBL2_P211_F | 0.649 |
| CYP1B1_E83_R | 0.651 | OPCML_P71_F | 0.649 |
| NEO1_P1067_F | 0.651 | PTPNS1_P301_R | 0.649 |
| HLA-DRA_P132_R | 0.650 | EPHA3_E156_R | 0.649 |
| PTK6_E50_F | 0.650 | GSTP1_seq_38_S153_R | 0.648 |
| VIM_P343_R | 0.650 | TIAM1_P188_R | 0.648 |
| RIPK1_P744_R | 0.649 | ERCC3_P1210_R | 0.648 |
| CCND1_E280_R | 0.649 | BLK_P14_F | 0.648 |
| SPDEF_E116_R | 0.649 | TFPI2_E141_F | 0.648 |
| PHLDA2_P622_F | 0.649 | SLC14A1_P369_R | 0.647 |
| NEU1_P745_F | 0.649 | INS_P804_R | 0.647 |
| SLC22A3_P528_F | 0.649 | ATP10A_P147_F | 0.647 |
| PTPRF_E178_R | 0.649 | TNFRSF10D_E27_F | 0.647 |
| USP29_E274_F | 0.648 | PPAT_E170_R | 0.647 |
| TGFBR3_E188_R | 0.648 | TRIM29_P261_F | 0.646 |
| EXT1_E197_F | 0.647 | DST_E31_F | 0.646 |
| MFAP4_P10_R | 0.647 | CDKN1C_P626_F | 0.646 |
| HLA-DPA1_P28_R | 0.647 | MST1R_P87_R | 0.646 |
| IL1A_E113_R | 0.647 | MT1A_P49_R | 0.646 |
| TNFSF8_E258_R | 0.647 | HRASLS_P353_R | 0.646 |
| ITGA2_E120_F | 0.646 | SLC22A3_E122_R | 0.645 |
| HPSE_P93_F | 0.646 | TNFRSF1B_E5_F | 0.645 |
| AATK_P519_R | 0.646 | SLC14A1_E295_F | 0.645 |
| PI3_P1394_R | 0.646 | TDGF1_E53_R | 0.645 |
| EPHB2_P165_R | 0.646 | IGFBP5_P9_R | 0.645 |
| CD82_P557_R | 0.645 | THPO_E483_F | 0.644 |
| DAB2IP_E18_R | 0.645 | PTCH_E42_F | 0.644 |
| HIF1A_P488_F | 0.645 | SYK_P584_F | 0.644 |
| HLA-DPA1_E35_R | 0.645 | EPHX1_E152_F | 0.643 |
| MKRN3_P108_F | 0.645 | GATA6_P21_R | 0.643 |
| H19_P541_F | 0.644 | APOA1_P261_F | 0.643 |
| BMP2_E48_R | 0.644 | LTA_P214_R | 0.643 |
| DKFZP564O0823_E4 | 0.644 | CTGF_E156_F | 0.642 |
| APBA2_P305_R | 0.644 | RARA_P1076_R | 0.642 |
| PTHR1_P258_F | 0.643 | MLH1_P381_F | 0.642 |
| PDGFRA_P1429_F | 0.643 | IFNGR2_P377_R | 0.641 |
| XRCC1_P681_R | 0.643 | MMP7_P613_F | 0.641 |
| ACVR1B_P572_R | 0.643 | TFAP2C_P765_F | 0.641 |
| COL1A1_P5_F | 0.643 | GPR116_E328_R | 0.641 |
| MGMT_P281_F | 0.643 | HLA-DOB_E432_R | 0.641 |
| ASCL2_P609_R | 0.642 | DAB2IP_E18_R | 0.641 |
| LYN_E353_F | 0.642 | SEPT9_P374_F | 0.641 |
| HOXA5_P1324_F | 0.642 | PTHR1_P170_R | 0.641 |
| ABCC5_P444_F | 0.642 | SHH_E328_F | 0.640 |
| CCND1_P343_R | 0.642 | TIAM1_P117_F | 0.640 |
| HPN_P374_R | 0.641 | HSD17B12_E145_R | 0.640 |
| PAX6_P1121_F | 0.641 | LTB4R_P163_F | 0.639 |
| UGT1A7_P751_R | 0.641 | EPHB6_E342_F | 0.639 |
| KLF5_E190_R | 0.641 | TNC_P57_F | 0.639 |
| PARP1_P610_R | 0.641 | GRB10_E85_R | 0.639 |
| CHGA_P243_F | 0.640 | CD2_P68_F | 0.639 |
| NFKB1_P336_R | 0.640 | PAX6_P1121_F | 0.639 |
| SLC22A18_P472_R | 0.640 | TUSC3_E29_R | 0.638 |
| DSG1_P159_R | 0.640 | GPR116_P850_F | 0.638 |
| HOXA5_E187_F | 0.639 | IL6_P213_R | 0.638 |
| GPX1_E46_R | 0.639 | PLXDC2_P914_R | 0.637 |
| MAP2K6_P297_R | 0.639 | MLH3_P25_F | 0.637 |
| MC2R_E455_F | 0.639 | TIMP2_P267_F | 0.637 |
| IRF5_E101_F | 0.639 | RAD50_P191_F | 0.637 |
| RAD54B_P227_F | 0.639 | GML_E144_F | 0.636 |
| COL1A2_E299_F | 0.639 | PDGFA_P841_R | 0.636 |
| NKX3-1_P146_F | 0.638 | SGCE_P250_R | 0.636 |
| SEMA3A_P658_R | 0.638 | FGFR4_P610_F | 0.636 |
| KRAS_P651_F | 0.638 | BMP2_P1201_F | 0.636 |
| HBII-13_P991_R | 0.638 | IL10_P348_F | 0.636 |
| DST_P262_R | 0.638 | WNT10B_P823_R | 0.636 |
| ASB4_P52_R | 0.638 | BMP3_E147_F | 0.635 |
| CD34_P339_R | 0.638 | ABCB4_P51_F | 0.635 |
| AGXT_E115_R | 0.637 | ACTG2_P455_R | 0.635 |
| CCNC_P132_R | 0.637 | RAP1A_P285_R | 0.635 |
| TCF4_P317_F | 0.637 | SEMA3A_P658_R | 0.635 |
| ZMYND10_P329_F | 0.637 | MMP19_P306_F | 0.634 |
| CAV1_P169_F | 0.637 | MAS1_P657_R | 0.634 |
| GNMT_E126_F | 0.637 | SFTPB_P689_R | 0.634 |
| EPS8_P437_F | 0.637 | HLA-DPB1_P450_F | 0.634 |
| CDH13_E102_F | 0.636 | LOX_P313_R | 0.633 |
| CALCA_P171_F | 0.636 | KRAS_E82_F | 0.633 |
| ZIM3_P451_R | 0.636 | NOTCH3_E403_F | 0.633 |
| CDKN1C_P6_R | 0.636 | POMC_E254_F | 0.633 |
| BMP6_P398_F | 0.635 | SFTPA1_E340_R | 0.633 |
| GATA6_P726_F | 0.635 | AKT1_P310_R | 0.633 |
| TFPI2_P152_R | 0.635 | BMPR1A_E88_F | 0.632 |
| SNRPN_seq_18_S99_F | 0.635 | COL4A3_P545_F | 0.632 |
| ZMYND10_E77_R | 0.634 | CSF1R_P73_F | 0.632 |
| BMPR1A_P956_F | 0.634 | BMP4_P199_R | 0.631 |
| BMP2_P1201_F | 0.634 | CHFR_P635_R | 0.631 |
| ICA1_P72_R | 0.634 | GUCY2D_P48_R | 0.631 |
| DIO3_E230_R | 0.633 | ERBB4_P541_F | 0.631 |
| MAP3K8_P1036_F | 0.633 | HSD17B12_P97_F | 0.631 |
| TNFRSF10D_E27_F | 0.633 | CD34_E20_R | 0.631 |
| TAL1_P594_F | 0.633 | MMP9_P189_F | 0.630 |
| NPR2_P618_F | 0.633 | PMP22_P1254_F | 0.630 |
| CD34_P780_R | 0.633 | TNFRSF10C_P612_R | 0.630 |
| IFNGR1_P307_F | 0.632 | TP73_P496_F | 0.630 |
| WNT2B_P1195_F | 0.632 | SLC22A18_P472_R | 0.629 |
| TP73_P945_F | 0.632 | THBS1_E207_R | 0.629 |
| GNMT_P197_F | 0.632 | MSH3_P13_R | 0.629 |
| TGFB2_P632_F | 0.631 | AATK_E63_R | 0.629 |
| ASB4_E89_F | 0.631 | MST1R_E42_R | 0.629 |
| MMP1_P397_R | 0.631 | EPHA8_P456_R | 0.629 |
| CYP2E1_E53_R | 0.631 | TP73_E155_F | 0.629 |
| CD2_P68_F | 0.630 | ROR2_E112_F | 0.629 |
| DBC1_E204_F | 0.630 | RHOH_P121_F | 0.628 |
| CSF3R_P8_F | 0.630 | COL1A1_P117_R | 0.628 |
| MEST_E150_F | 0.630 | ZAP70_P220_R | 0.628 |
| ETS2_P684_F | 0.629 | CEBPA_P1163_R | 0.628 |
| HLA-DQA2_P282_R | 0.629 | UGT1A7_P751_R | 0.628 |
| SKI_E465_R | 0.629 | NFKB1_P496_F | 0.628 |
| CDH11_P354_R | 0.629 | FZD9_P15_R | 0.627 |
| SMAD2_P848_R | 0.629 | PURA_P928_R | 0.627 |
| ERBB3_E331_F | 0.629 | DMP1_E194_F | 0.627 |
| COL4A3_P545_F | 0.629 | EPHB1_P503_F | 0.627 |
| PLXDC1_P236_F | 0.628 | FHIT_P93_R | 0.627 |
| PTGS2_P524_R | 0.628 | PI3_E107_F | 0.627 |
| NOTCH3_P198_R | 0.628 | PLXDC1_E71_F | 0.627 |
| TDGF1_P428_R | 0.628 | GFI1_P208_R | 0.627 |
| IFNG_E293_F | 0.628 | FASTK_P598_R | 0.627 |
| IL10_P348_F | 0.628 | HLA-DOB_P357_R | 0.627 |
| BMPR2_E435_F | 0.628 | NAT2_P11_F | 0.626 |
| RAN_P581_R | 0.628 | ESR1_E298_R | 0.626 |
| NEFL_E23_R | 0.627 | EPHA8_P256_F | 0.625 |
| MAPK9_P1175_F | 0.627 | PADI4_E24_F | 0.625 |
| MT1A_P600_F | 0.627 | THPO_P585_R | 0.625 |
| TNFRSF10A_P171_F | 0.627 | SGCE_E149_F | 0.625 |
| INHA_P1189_F | 0.626 | CLK1_P538_F | 0.625 |
| USP29_P205_R | 0.626 | IFNG_P459_R | 0.625 |
| PYCARD_P393_F | 0.626 | WNT1_E157_F | 0.625 |
| FAT_P973_R | 0.626 | IRF5_E101_F | 0.624 |
| HLA-F_E402_F | 0.626 | S100A2_E36_R | 0.624 |
| FHIT_P93_R | 0.626 | PTGS1_E80_F | 0.624 |
| SNURF_P2_R | 0.625 | DNMT2_P199_F | 0.624 |
| IGFBP7_P297_F | 0.625 | CSF3_E242_R | 0.624 |
| TK1_P62_R | 0.625 | BCR_P346_F | 0.623 |
| PTGS1_E80_F | 0.625 | PLA2G2A_P528_F | 0.623 |
| HLF_E192_F | 0.625 | EPS8_P437_F | 0.623 |
| MAP3K9_E17_R | 0.625 | BSG_P211_R | 0.622 |
| ARHGDIB_P148_R | 0.625 | NOS2A_P288_R | 0.622 |
| HIC1_E151_F | 0.625 | GNG7_P903_F | 0.622 |
| PTPNS1_E433_R | 0.625 | P2RX7_P597_F | 0.622 |
| COL1A2_P48_R | 0.625 | IMPACT_P234_R | 0.622 |
| MEST_P62_R | 0.624 | RASGRF1_P768_F | 0.622 |
| CSK_P740_R | 0.624 | CCL3_P543_R | 0.622 |
| RHOH_P953_R | 0.624 | PTHLH_P757_F | 0.621 |
| NCL_P1102_F | 0.623 | RIPK3_P24_F | 0.621 |
| GABRG3_E123_R | 0.623 | ELK3_P514_F | 0.621 |
| KIAA1804_P689_R | 0.623 | GNG7_E310_R | 0.621 |
| CD34_E20_R | 0.623 | MYB_P673_R | 0.621 |
| HSPA2_P162_R | 0.623 | RUNX3_P247_F | 0.620 |
| MET_E333_F | 0.621 | ITGB4_E144_F | 0.620 |
| BCAM_P205_F | 0.621 | PDGFRB_E195_R | 0.620 |
| THBS1_E207_R | 0.621 | PTGS2_P524_R | 0.620 |
| SFTPD_E169_F | 0.621 | TNFSF8_P184_F | 0.620 |
| HLA-DOB_P357_R | 0.621 | THBS2_E129_F | 0.620 |
| AXL_P223_R | 0.621 | USP29_P282_R | 0.620 |
| RUNX1T1_E145_R | 0.620 | MAPK10_E26_F | 0.619 |
| ZNF215_P71_R | 0.620 | NKX3-1_P871_R | 0.619 |
| JAG2_E54_F | 0.620 | ZIM3_P451_R | 0.618 |
| SOX17_P303_F | 0.620 | SNURF_P2_R | 0.618 |
| MLH1_P381_F | 0.620 | MPL_P657_F | 0.618 |
| HOXC6_P456_R | 0.619 | APC_E117_R | 0.618 |
| GP1BB_E23_F | 0.619 | APC_P14_F | 0.618 |
| PKD2_P336_R | 0.619 | ER_seq_a1_S60_F | 0.618 |
| MYOD1_E156_F | 0.619 | PLAT_E158_F | 0.618 |
| LOX_P313_R | 0.619 | SPARC_P195_F | 0.617 |
| NTSR1_E109_F | 0.618 | EPHX1_P1358_R | 0.617 |
| CTNNA1_P185_R | 0.618 | CDKN1A_E101_F | 0.617 |
| ROR2_P317_R | 0.618 | DAPK1_P345_R | 0.617 |
| KCNK4_E3_F | 0.618 | PMP22_P975_F | 0.617 |
| WNT5A_E43_F | 0.618 | FABP3_E113_F | 0.617 |
| TSG101_P257_R | 0.618 | DAB2IP_P9_F | 0.617 |
| GFI1_P45_R | 0.618 | APBA2_P305_R | 0.617 |
| NCL_P840_R | 0.618 | PPARD_P846_F | 0.616 |
| AKT1_P310_R | 0.618 | SPI1_E205_F | 0.616 |
| FGFR3_E297_R | 0.618 | TUBB3_P721_R | 0.616 |
| NOTCH2_P312_R | 0.617 | PYCARD_E87_F | 0.616 |
| LMO2_E148_F | 0.617 | FAS_P322_R | 0.616 |
| PROM1_P44_R | 0.617 | SMARCA3_P109_R | 0.615 |
| TRPM5_P721_F | 0.617 | BCAM_E100_R | 0.615 |
| APC_E117_R | 0.617 | HSPA2_P162_R | 0.615 |
| GNAS_E58_F | 0.616 | PTCH2_P568_R | 0.615 |
| NOTCH4_P938_F | 0.616 | MC2R_E455_F | 0.615 |
| TSP50_E21_R | 0.616 | SNCG_P98_R | 0.614 |
| PGF_P320_F | 0.616 | TFF2_P557_R | 0.614 |
| MCC_E23_R | 0.616 | B3GALT5_P330_F | 0.614 |
| TJP2_P518_F | 0.616 | UGT1A1_E11_F | 0.614 |
| BSG_P211_R | 0.616 | ARHGAP9_P518_R | 0.614 |
| TNF_P1084_F | 0.615 | WNT8B_P216_R | 0.614 |
| PTEN_P438_F | 0.615 | AOC3_P890_R | 0.613 |
| MYH11_P236_R | 0.615 | HHIP_P578_R | 0.613 |
| DAB2_P468_F | 0.615 | ABCA1_E120_R | 0.613 |
| SIN3B_P607_F | 0.615 | PLAGL1_E68_R | 0.613 |
| ITPR2_P804_F | 0.615 | ABCB4_P892_F | 0.613 |
| ICA1_P61_F | 0.615 | PTPRO_P371_F | 0.613 |
| TGFBI_P173_F | 0.615 | FN1_E469_F | 0.613 |
| PLA2G2A_E268_F | 0.615 | PAX6_E129_F | 0.613 |
| MT1A_P49_R | 0.615 | EGF_E339_F | 0.612 |
| RASGRF1_P768_F | 0.615 | OSM_P34_F | 0.612 |
| E2F3_P840_R | 0.614 | GATA6_P726_F | 0.612 |
| NQO1_P345_R | 0.614 | HDAC9_P137_R | 0.612 |
| MLH3_E72_F | 0.614 | MAPK12_E165_R | 0.612 |
| TUBB3_P364_F | 0.614 | IGF2_E134_R | 0.612 |
| GDF10_E39_F | 0.614 | BMP4_P123_R | 0.611 |
| TNFRSF10D_P70_F | 0.614 | IL3_P556_F | 0.611 |
| HDAC5_E298_F | 0.614 | NCL_P1102_F | 0.611 |
| MEST_P4_F | 0.614 | CD34_P339_R | 0.611 |
| LEF7Y2_P719_F | 0.614 | CCNC_P132_R | 0.611 |
| SFTPB_P689_R | 0.613 | LY6G6E_P45_R | 0.611 |
| TUBB3_E91_F | 0.613 | OSM_P188_F | 0.611 |
| FER_P581_F | 0.613 | TMPRSS4_E83_F | 0.611 |
| DHCR24_P652_R | 0.613 | SLC22A18_P216_R | 0.611 |
| ABCB4_P892_F | 0.612 | IGSF4C_P533_R | 0.611 |
| PTK2_P735_R | 0.612 | TFDP1_P543_R | 0.610 |
| LTB4R_P163_F | 0.612 | MOS_P27_R | 0.610 |
| GSTP1_P74_F | 0.612 | EPHB1_E202_R | 0.609 |
| HLA-DOA_P594_F | 0.612 | RARA_E128_R | 0.609 |
| CHD2_P451_F | 0.611 | IGF1R_E186_R | 0.609 |
| THBS2_E129_F | 0.610 | LAMB1_E144_R | 0.609 |
| GFI1_P208_R | 0.610 | TNF_P158_F | 0.609 |
| FYN_P352_R | 0.610 | GLI3_E148_R | 0.609 |
| FGF7_P610_F | 0.610 | PRKCDBP_P352_R | 0.609 |
| ISL1_P379_F | 0.610 | CPA4_P961_R | 0.609 |
| ABCA1_P45_F | 0.610 | GPATC3_P410_R | 0.608 |
| BMPR1A_E88_F | 0.609 | UGT1A1_P315_R | 0.608 |
| HTR1B_E232_R | 0.609 | MXI1_P1269_F | 0.608 |
| TWIST1_P355_R | 0.609 | ERBB4_P255_F | 0.608 |
| BMP3_P56_R | 0.609 | FGF5_P238_R | 0.608 |
| NGFB_E353_F | 0.609 | EPHB2_P165_R | 0.608 |
| ABO_P312_F | 0.609 | GLI2_P295_F | 0.608 |
| MPO_P883_R | 0.609 | SKI_E465_R | 0.608 |
| FABP3_P598_F | 0.609 | HLA-DPA1_P28_R | 0.607 |
| HS3ST2_P546_F | 0.608 | DES_P1006_R | 0.607 |
| ODC1_P424_F | 0.608 | GABRG3_P75_F | 0.607 |
| MCAM_P265_R | 0.608 | NEO1_P1067_F | 0.607 |
| MXI1_P1269_F | 0.608 | PROM1_P44_R | 0.607 |
| ETV1_P235_F | 0.608 | ETS2_P684_F | 0.606 |
| PTHR1_E36_R | 0.608 | MCAM_P169_R | 0.606 |
| DCC_P177_F | 0.607 | SMARCB1_P220_R | 0.606 |
| PTHR1_P170_R | 0.607 | MAPK9_P1175_F | 0.606 |
| WNT2B_P1185_R | 0.607 | TNFSF8_E258_R | 0.606 |
| IGSF4C_P533_R | 0.607 | GNAS_P86_F | 0.606 |
| IFNGR2_P377_R | 0.607 | MYLK_P469_R | 0.606 |
| SERPINE1_E189_R | 0.607 | FANCE_P356_R | 0.606 |
| SEMA3C_P642_F | 0.607 | HDAC7A_P344_F | 0.606 |
| CAV2_E33_R | 0.607 | CTSL_P81_F | 0.606 |
| MDR1_seq_42_S30C | 0.606 | CHGA_P243_F | 0.605 |
| MUC1_P191_F | 0.606 | IL12A_E287_R | 0.605 |
| WNT1_E157_F | 0.606 | BCL3_P1038_R | 0.605 |
| PCDH1_P264_F | 0.605 | ZNF215_P129_R | 0.605 |
| DNMT2_P199_F | 0.605 | APOC2_P377_F | 0.605 |
| DAPK1_P345_R | 0.605 | MLLT3_E93_R | 0.604 |
| ETS1_P559_R | 0.605 | CRIP1_P874_R | 0.604 |
| EVI2A_E420_F | 0.605 | PTPRO_E56_F | 0.604 |
| EFNB3_E17_R | 0.604 | EFNB3_P442_R | 0.603 |
| TNFSF8_P184_F | 0.604 | LCK_E28_F | 0.603 |
| B3GALT5_E246_R | 0.604 | SNURF_P78_F | 0.603 |
| ERCC1_P440_R | 0.604 | NNAT_P544_R | 0.603 |
| ABCG2_P310_R | 0.604 | KCNK4_E3_F | 0.603 |
| DAB2_P35_F | 0.604 | DLC1_P695_F | 0.603 |
| CTSL_P264_R | 0.603 | LYN_P241_F | 0.603 |
| LRRC32_P865_R | 0.603 | HLA-DPA1_E35_R | 0.602 |
| ADAMTS12_E52_R | 0.603 | AIM2_P624_F | 0.602 |
| BCL3_P1038_R | 0.603 | GFAP_P1214_F | 0.602 |
| TUSC3_P85_R | 0.602 | XRCC2_P1077_F | 0.602 |
| CSPG2_E38_F | 0.602 | DDB2_P407_F | 0.602 |
| PTPNS1_P301_R | 0.602 | PECAM1_P135_F | 0.601 |
| FGF6_P139_R | 0.602 | SOX2_P546_F | 0.601 |
| SNURF_P78_F | 0.602 | ETS1_E253_R | 0.601 |
| CDH1_P52_R | 0.602 | SERPINB2_P939_F | 0.601 |
| LRRC32_E157_F | 0.602 | SNRPN_E14_F | 0.601 |
| SNRPN_E14_F | 0.602 | LRRK1_P834_F | 0.601 |
| TIMP2_E394_R | 0.602 | TGFBR3_P429_F | 0.601 |
| POMC_P400_R | 0.602 | FGF12_E61_R | 0.601 |
| SGCE_E149_F | 0.602 | EVI1_E47_R | 0.601 |
| BCAM_E100_R | 0.601 | CHI3L2_E10_F | 0.601 |
| SFRP1_P157_F | 0.601 | MAS1_P469_R | 0.600 |
| RRAS_P100_R | 0.601 | IRF7_E236_R | 0.600 |
| FZD9_E458_F | 0.601 | IGFBP6_E47_F | 0.600 |
| IPF1_P234_F | 0.601 | ADCYAP1_E163_R | 0.600 |
| FLT4_P180_R | 0.601 | ZMYND10_E77_R | 0.600 |
| PTPRO_P371_F | 0.601 | CTNNA1_P382_R | 0.599 |
| IMPACT_P186_F | 0.601 | SEMA3B_E96_F | 0.599 |
| MATK_P64_F | 0.600 | CD34_P780_R | 0.599 |
| IFNG_P188_F | 0.600 | PADI4_P1158_R | 0.599 |
| TFPI2_E141_F | 0.600 | SEMA3F_P692_R | 0.599 |
| MMP9_E88_R | 0.600 | LTA_E28_R | 0.599 |
| CHD2_P667_F | 0.600 | DHCR24_P652_R | 0.599 |
| HOXC6_P585_R | 0.600 | KIAA0125_E29_F | 0.599 |
| SMAD4_P474_R | 0.600 | PAX6_P50_R | 0.599 |
| IL16_P93_R | 0.600 | TNFRSF1B_P167_F | 0.598 |
| MYBL2_P211_F | 0.600 | MMP14_P13_F | 0.598 |
| KCNQ1_E349_R | 0.600 | NOTCH2_P312_R | 0.598 |
| VAV2_P1182_F | 0.599 | LMO2_E148_F | 0.598 |
| HIC-1_seq_48_S103_R | 0.599 | IGFBP1_P12_R | 0.598 |
| FGF9_P862_R | 0.599 | VEGFB_P658_F | 0.597 |
| EGR4_E70_F | 0.599 | MATK_P64_F | 0.597 |
| TNFRSF1B_P167_F | 0.599 | DKFZP564O0823_E45_F | 0.597 |
| MAPK4_E273_R | 0.599 | ICAM1_P119_R | 0.597 |
| WT1_E32_F | 0.598 | CASP6_P201_F | 0.597 |
| CD40_E58_R | 0.598 | XRCC1_P681_R | 0.597 |
| IL6_P611_F | 0.598 | IRF7_P277_R | 0.597 |
| EPHX1_P1358_R | 0.597 | HOXA9_P1141_R | 0.597 |
| GAS7_E148_F | 0.597 | ABCB4_E429_F | 0.597 |
| COL18A1_P494_R | 0.597 | IL2_P607_R | 0.597 |
| DLC1_P695_F | 0.597 | CDKN1A_P242_F | 0.597 |
| FLI20712_P984_R | 0.597 | EDN1_E50_R | 0.597 |
| GSTP1_E322_R | 0.597 | ABCG2_P178_R | 0.596 |
| TMEM63A_E63_F | 0.597 | USP29_P205_R | 0.596 |
| LMTK2_P1034_F | 0.596 | RAB32_P493_R | 0.596 |
| MMP2_P303_R | 0.596 | MYBL2_P354_F | 0.596 |
| NOTCH1_E452_R | 0.596 | TYRO3_P501_F | 0.596 |
| TFAP2C_E260_F | 0.596 | CTSD_P726_F | 0.596 |
| RIPK2_E123_F | 0.595 | CHD2_P451_F | 0.595 |
| LIF_P383_R | 0.595 | BCR_P422_F | 0.595 |
| EPS8_E231_F | 0.595 | MOS_P746_F | 0.595 |
| NTRK3_P636_R | 0.595 | IFNG_E293_F | 0.595 |
| DNAJC15_E26_R | 0.594 | TNFSF10_P2_R | 0.595 |
| DIRAS3_P745_F | 0.594 | C4B_P191_F | 0.594 |
| ETS2_P835_F | 0.594 | YES1_P216_F | 0.594 |
| GNG7_E310_R | 0.594 | DAB2_P468_F | 0.594 |
| FGF5_E16_F | 0.594 | CRIP1_P274_F | 0.594 |
| EPHA5_P66_F | 0.594 | FGF9_P862_R | 0.594 |
| ACVR2B_E27_R | 0.594 | NOTCH1_P1198_F | 0.594 |
| IGFBP2_P306_F | 0.594 | MAP3K8_P1036_F | 0.593 |
| ADAMTS12_P250_R | 0.594 | SNRPN_seq_18_S99_{—} | 0.593 |
| EFNA1_P591_R | 0.594 | PECAM1_E32_R | 0.593 |
| COPG2_P298_F | 0.594 | HOXC6_P456_R | 0.593 |
| WNT8B_E487_F | 0.594 | ZIM3_E203_F | 0.593 |
| MKRN3_E144_F | 0.593 | FGFR3_E297_R | 0.593 |
| OPCML_E219_R | 0.593 | CDH3_P87_R | 0.593 |
| MATK_P190_R | 0.593 | IFNG_P188_F | 0.592 |
| EPHB6_E342_F | 0.593 | MKRN3_E144_F | 0.592 |
| TIMP3_P1114_R | 0.593 | CCNE1_P683_F | 0.592 |
| MMP2_E21_R | 0.593 | SH3BP2_E18_F | 0.592 |
| PLSCR3_P751_R | 0.592 | CASP6_P230_R | 0.592 |
| SEMA3B_E96_F | 0.592 | NDN_E131_R | 0.592 |
| TSP50_P137_F | 0.592 | DNMT3B_P352_R | 0.592 |
| ZNF215_P129_R | 0.592 | CPA4_P1265_R | 0.591 |
| DMP1_E194_F | 0.592 | PITX2_E24_R | 0.591 |
| MOS_P27_R | 0.592 | AIM2_E208_F | 0.591 |
| ALPL_P433_F | 0.592 | NDN_P1110_F | 0.590 |
| CPA4_P1265_R | 0.591 | MYCN_E77_R | 0.590 |
| TIMP2_P267_F | 0.591 | p16_seq_47_S188_R | 0.590 |
| EIF2AK2_P313_F | 0.591 | EPHA1_P119_R | 0.590 |
| RBP1_P426_R | 0.591 | MGMT_P281_F | 0.590 |
| ALK_E183_R | 0.590 | ABCA1_P45_F | 0.589 |
| PLAU_P11_F | 0.590 | VAMP8_P114_F | 0.589 |
| TIAM1_P188_R | 0.590 | PEG3_E496_F | 0.589 |
| GJB2_P791_R | 0.590 | PGR_P790_F | 0.589 |
| IL18BP_P51_R | 0.590 | PKD2_P336_R | 0.589 |
| EPHB2_E297_F | 0.590 | GLI2_E90_F | 0.589 |
| EPHA8_P456_R | 0.589 | RARB_P60_F | 0.589 |
| EPHB4_E476_R | 0.589 | PLG_P370_F | 0.589 |
| HTR1B_P222_F | 0.589 | WNT5A_E43_F | 0.588 |
| FGF12_E61_R | 0.588 | PLAGL1_P334_F | 0.588 |
| BCL2L2_E172_F | 0.587 | WEE1_P924_R | 0.588 |
| IHH_P529_F | 0.587 | IL13_E75_R | 0.588 |
| MLLT4_P1400_F | 0.587 | TUBB3_E91_F | 0.588 |
| SLC22A18_P216_R | 0.587 | MMP9_E88_R | 0.587 |
| CSTB_E410_F | 0.587 | MPO_E302_R | 0.587 |
| SEPT5_P464_R | 0.587 | SMAD2_P708_R | 0.587 |
| DLL1_P386_F | 0.587 | RHOH_P953_R | 0.587 |
| SH3BP2_P771_R | 0.586 | CCND1_P343_R | 0.587 |
| SMARCA3_P109_R | 0.586 | TUBB3_P364_F | 0.587 |
| NOTCH3_E403_F | 0.586 | WRN_P969_F | 0.587 |
| FABP3_E113_F | 0.586 | TDGF1_P428_R | 0.587 |
| PPARD_P846_F | 0.585 | TGFB3_E58_R | 0.587 |
| CSF1_P217_F | 0.585 | MMP9_P237_R | 0.587 |
| GLI3_E148_R | 0.585 | GABRA5_P862_R | 0.587 |
| SIN3B_P514_R | 0.585 | CTTN_E29_R | 0.587 |
| CHI3L2_E10_F | 0.585 | HOXB13_E21_F | 0.587 |
| XPC_P226_R | 0.585 | WRN_E57_F | 0.587 |
| ERN1_P809_R | 0.585 | EIF2AK2_E103_R | 0.587 |
| AATK_P709_R | 0.584 | PTHLH_P15_R | 0.586 |
| CDK2_P330_R | 0.584 | LAT_E46_F | 0.586 |
| MSH3_E3_F | 0.583 | LIF_P383_R | 0.586 |
| IL12B_P1453_F | 0.583 | NQO1_P345_R | 0.586 |
| MSH2_P1008_F | 0.583 | SRC_P164_F | 0.586 |
| TIMP3_P690_R | 0.583 | NKX3-1_P146_F | 0.586 |
| APC_P14_F | 0.583 | INHA_P1144_R | 0.586 |
| GABRB3_P92_F | 0.583 | PIK3R1_P307_F | 0.586 |
| IL13_E75_R | 0.582 | SERPINE1_P519_F | 0.586 |
| ITGB4_P517_F | 0.582 | ITPR2_P804_F | 0.585 |
| PEG3_E496_F | 0.582 | SNRPN_seq_12_S127_F | 0.585 |
| SOX17_P287_R | 0.582 | KRAS_P651_F | 0.585 |
| RBP1_E158_F | 0.582 | PTPN6_E171_R | 0.585 |
| DDR2_E331_F | 0.581 | CD1A_P414_R | 0.585 |
| FOSL2_E384_R | 0.581 | TUSC3_P85_R | 0.585 |
| EFNA1_P7_F | 0.581 | MCC_E23_R | 0.585 |
| NFKB1_P496_F | 0.580 | LYN_E353_F | 0.584 |
| TSG101_P139_R | 0.580 | GNAS_E58_F | 0.584 |
| PLXDC2_E337_F | 0.580 | ERCC6_P698_R | 0.584 |
| ICAM1_P119_R | 0.580 | MAGEL2_E166_R | 0.583 |
| LYN_P241_F | 0.580 | HLA-DOB_P1114_R | 0.583 |
| MCM2_P260_F | 0.580 | HPSE_P29_F | 0.583 |
| NRAS_P103_R | 0.580 | MMP8_E89_R | 0.583 |
| FVT1_P225_F | 0.580 | MAP3K9_E17_R | 0.582 |
| ROR1_P6_F | 0.580 | ACVR2B_E27_R | 0.582 |
| TBX1_P885_R | 0.579 | FGF12_P210_R | 0.582 |
| CCND3_P435_F | 0.579 | JAG2_E54_F | 0.582 |
| DIO3_P674_F | 0.579 | SERPINA5_P156_F | 0.582 |
| EYA4_P508_F | 0.579 | TNK1_P221_F | 0.582 |
| EPHB3_P569_R | 0.579 | TGFBI_P31_R | 0.581 |
| TP73_E155_F | 0.579 | TK1_E47_F | 0.581 |
| TGFA_P558_F | 0.578 | TEK_P526_F | 0.581 |
| PLXDC1_E71_F | 0.578 | IGF1_P933_F | 0.581 |
| CASP3_P420_R | 0.578 | IL11_P11_R | 0.581 |
| PLAUR_P82_F | 0.578 | ACVR1C_P363_F | 0.580 |
| IGFBP7_P371_F | 0.578 | PRSS1_E45_R | 0.580 |
| ARNT_P238_R | 0.577 | LIMK1_P709_R | 0.580 |
| MOS_P746_F | 0.577 | GABRA5_P1016_F | 0.580 |
| ABO_E110_F | 0.577 | ESR1_P151_R | 0.580 |
| SEZ6L_P249_F | 0.577 | GPX1_P194_F | 0.580 |
| SLIT2_E111_R | 0.577 | HBII-52_E142_F | 0.580 |
| CTNNB1_P757_F | 0.577 | IAPP_E280_F | 0.580 |
| TEK_P526_F | 0.577 | LCN2_P141_R | 0.580 |
| SEPT9_P374_F | 0.577 | EPHB4_P313_R | 0.580 |
| SNRPN_seq_12_S12 | 0.577 | TSG101_P139_R | 0.580 |
| COL1A2_P407_R | 0.576 | PKD2_P287_R | 0.580 |
| NQO1_E74_R | 0.576 | IL4_P262_R | 0.579 |
| RAP1A_P285_R | 0.576 | PGF_E33_F | 0.579 |
| PRDM2_P1340_R | 0.576 | HOXA11_P92_R | 0.579 |
| MMP2_P197_F | 0.576 | APOC1_P406_R | 0.579 |
| ACTG2_P455_R | 0.576 | SFTPC_E13_F | 0.579 |
| MSH3_P13_R | 0.576 | NFKB1_P336_R | 0.579 |
| PTPRG_E40_R | 0.576 | TRIP6_P1090_F | 0.579 |
| IHH_P246_R | 0.576 | ZP3_E90_F | 0.579 |
| CRIP1_P274_F | 0.576 | CASP2_P192_F | 0.578 |
| LAMC1_E466_R | 0.576 | PARP1_P610_R | 0.578 |
| TMEFF2_E94_R | 0.575 | SHB_P473_R | 0.577 |
| CTSL_P81_F | 0.575 | CCR5_P630_R | 0.577 |
| ADCYAP1_P398_F | 0.575 | EPHA2_P340_R | 0.577 |
| JAK2_P772_R | 0.575 | MYLK_E132_R | 0.577 |
| RAB32_P493_R | 0.575 | SNCG_E119_F | 0.577 |
| TCF7L2_P193_R | 0.575 | IGF1_E394_F | 0.577 |
| S100A4_P194_R | 0.575 | APP_P179_R | 0.576 |
| FLT3_E326_R | 0.574 | PHLDA2_E159_R | 0.576 |
| AHR_P166_R | 0.574 | IFNGR1_P307_F | 0.576 |
| AIM2_P624_F | 0.574 | TGFA_P558_F | 0.575 |
| FGFR2_P460_R | 0.574 | BCL2L2_E172_F | 0.575 |
| DDIT3_P1313_R | 0.573 | INSR_E97_F | 0.575 |
| FANCE_P356_R | 0.573 | TJP1_P390_F | 0.575 |
| SEMA3F_P692_R | 0.573 | ENC1_P484_R | 0.575 |
| BDNF_P259_R | 0.573 | LIF_E208_F | 0.575 |
| BMP4_P123_R | 0.573 | MSH3_E3_F | 0.575 |
| GAS1_E22_F | 0.573 | MTA1_P478_F | 0.575 |
| FGF3_P171_R | 0.572 | SEMA3B_P110_R | 0.575 |
| WNT5A_P655_F | 0.572 | MBD2_P233_F | 0.574 |
| AREG_P217_R | 0.572 | PTPN6_P282_R | 0.574 |
| CDC25B_P11_R | 0.572 | EDNRB_P709_R | 0.574 |
| GML_P281_R | 0.572 | HGF_P1293_R | 0.574 |
| DLK1_E227_R | 0.572 | IGFBP1_E48_R | 0.574 |
| FLT1_P615_R | 0.572 | ARHGAP9_P260_F | 0.574 |
| EPHB6_P827_R | 0.571 | IGFBP3_E65_R | 0.573 |
| TFPI2_P9_F | 0.571 | MLF1_P97_F | 0.573 |
| IL8_E118_R | 0.571 | HLA-DPA1_P205_R | 0.573 |
| TIE1_E66_R | 0.570 | FGR_P39_F | 0.573 |
| KLF5_P13_F | 0.570 | ELL_P693_F | 0.573 |
| UNG_P170_F | 0.570 | SFTPA1_P421_F | 0.573 |
| RBP1_P150_F | 0.570 | WNT2B_P1185_R | 0.572 |
| CREB1_P819_F | 0.570 | ACVR1B_E497_R | 0.572 |
| IL12B_E25_F | 0.570 | APC_P280_R | 0.572 |
| IL8_P83_F | 0.570 | EMR3_P39_R | 0.572 |
| SFRP1_E398_R | 0.570 | EGR4_E70_F | 0.571 |
| TYK2_P494_F | 0.570 | DLC1_E276_F | 0.571 |
| CD81_P272_R | 0.570 | TRPM5_E87_F | 0.571 |
| ZNF264_P397_F | 0.570 | LAMC1_E466_R | 0.571 |
| SCGB3A1_E55_R | 0.570 | NRAS_P103_R | 0.571 |
| MLLT6_P957_F | 0.570 | DST_P262_R | 0.571 |
| HOXA11_P698_F | 0.569 | SHB_P691_R | 0.570 |
| SLC22A3_E122_R | 0.569 | ACVR1C_P115_R | 0.570 |
| CDK6_E256_F | 0.569 | LEFTY2_P561_F | 0.570 |
| UGT1A1_P564_R | 0.569 | IL6_E168_F | 0.570 |
| CCND2_P887_F | 0.569 | EPHB3_P569_R | 0.570 |
| CD81_P211_F | 0.569 | TRIP6_E33_F | 0.570 |
| TCF4_P175_R | 0.569 | LMTK2_P1034_F | 0.570 |
| FLT1_P302_F | 0.569 | PITX2_P183_R | 0.570 |
| UBA52_P293_R | 0.569 | GNMT_E126_F | 0.569 |
| FANCA_P1006_R | 0.569 | KCNQ1_P546_R | 0.569 |
| PRKAR1A_P337_R | 0.569 | TK1_P62_R | 0.569 |
| RBL2_P250_R | 0.569 | PCGF4_P760_R | 0.568 |
| AFF3_P122_F | 0.569 | ICAM1_E242_F | 0.568 |
| GSTM1_P363_F | 0.569 | MYCN_P464_R | 0.567 |
| EDNRB_P709_R | 0.568 | EPHA2_P203_F | 0.567 |
| SMARCA3_E20_F | 0.568 | EXT1_E197_F | 0.567 |
| INS_P248_F | 0.568 | TGFA_P642_R | 0.567 |
| PECAM1_P135_F | 0.568 | RASA1_E107_F | 0.567 |
| CDH3_E100_R | 0.568 | SFTPD_E169_F | 0.567 |
| PITX2_E24_R | 0.568 | CDH1_P52_R | 0.567 |
| FER_E119_F | 0.568 | ARNT_P238_R | 0.566 |
| PTGS1_P2_F | 0.568 | CAV1_P169_F | 0.566 |
| CDKN2B_E220_F | 0.568 | IGFBP6_P328_R | 0.566 |
| FGF8_P473_F | 0.567 | IL17RB_P788_R | 0.565 |
| APOC1_P406_R | 0.567 | PTCH2_E173_F | 0.565 |
| SLC5A8_E60_R | 0.566 | GABRG3_E123_R | 0.565 |
| EPHA7_E6_F | 0.566 | PTEN_P438_F | 0.565 |
| PADI4_P1011_R | 0.566 | CDKN2B_seq_50_S294_F | 0.565 |
| EPHB1_E202_R | 0.566 | INSR_P1063_R | 0.565 |
| p16_seq_47_S85_F | 0.566 | PSCA_E359_F | 0.564 |
| CEBPA_P1163_R | 0.566 | SH3BP2_P771_R | 0.564 |
| LMO2_P794_R | 0.565 | PLAU_P11_F | 0.564 |
| PSIP1_P163_R | 0.565 | IGFBP5_E144_F | 0.564 |
| IL1B_P829_F | 0.565 | PLSCR3_P751_R | 0.564 |
| IL12B_P392_R | 0.565 | MMP14_P208_R | 0.564 |
| MAGEL2_P170_R | 0.565 | CTNNA1_P185_R | 0.564 |
| EVI2A_P94_R | 0.565 | HBII-13_P991_R | 0.563 |
| ALPL_P278_F | 0.565 | PWCR1_E81_R | 0.563 |
| TFRC_P414_R | 0.564 | BMP6_P398_F | 0.563 |
| HHIP_E94_F | 0.564 | COL1A2_P407_R | 0.563 |
| ZNF264_E48_R | 0.564 | TFAP2C_E260_F | 0.563 |
| NTRK2_P395_R | 0.564 | KRT1_P798_R | 0.563 |
| PMP22_P975_F | 0.564 | CYP1A1_P382_F | 0.563 |
| EYA4_P794_F | 0.564 | LOX_P71_F | 0.562 |
| IGF2_P1036_R | 0.564 | DMP1_P134_F | 0.562 |
| NAT2_P11_F | 0.563 | P2RX7_E323_R | 0.562 |
| CDC25B_E83_F | 0.563 | CTLA4_P1128_F | 0.562 |
| MAPK12_P416_F | 0.563 | DLC1_P88_R | 0.562 |
| DSP_P440_R | 0.563 | C4B_E171_F | 0.562 |
| TNFRSF10C_P612_R | 0.563 | RHOC_P536_F | 0.562 |
| GNG7_P903_F | 0.563 | CARD15_P665_F | 0.561 |
| TNK1_P221_F | 0.563 | IGF1R_P325_R | 0.561 |
| VEGFB_P658_F | 0.562 | TGFBR3_E188_R | 0.561 |
| CHGA_E52_F | 0.562 | FGF6_P139_R | 0.561 |
| APBA2_P227_F | 0.562 | EFNA1_P591_R | 0.561 |
| ISL1_P554_F | 0.562 | CHI3L2_P226_F | 0.561 |
| PRKCDBP_P352_R | 0.562 | JAK2_P772_R | 0.561 |
| MMP9_P237_R | 0.561 | MLH3_E72_F | 0.560 |
| PALM2-AKAP2_P183 | 0.561 | HOXB13_P17_R | 0.560 |
| AXL_E61_F | 0.561 | CDKN1B_P1161_F | 0.560 |
| SGCE_P250_R | 0.561 | DNAJC15_P65_F | 0.560 |
| TIAM1_P117_F | 0.561 | MMP7_E59_F | 0.560 |
| PPARG_E178_R | 0.561 | VAV2_P1182_F | 0.560 |
| CTLA4_P1128_F | 0.561 | IPF1_P234_F | 0.560 |
| TFAP2C_P765_F | 0.561 | ONECUT2_P315_R | 0.560 |
| SERPINA5_P156_F | 0.561 | IL1RN_P93_R | 0.559 |
| FRZB_P406_F | 0.561 | IGFBP3_P423_R | 0.559 |
| SOX1_P1018_R | 0.560 | CSTB_E410_F | 0.559 |
| IGF2_P36_R | 0.560 | JUNB_P1149_R | 0.559 |
| PENK_P447_R | 0.559 | WNT8B_E487_F | 0.559 |
| EPM2A_P113_F | 0.559 | MCM2_P241_R | 0.559 |
| RAB32_E314_R | 0.559 | RUNX1T1_E145_R | 0.559 |
| DNAJC15_P65_F | 0.559 | MAPK4_E273_R | 0.558 |
| FGF7_P44_F | 0.559 | EIF2AK2_P313_F | 0.558 |
| EGR4_P479_F | 0.559 | FYN_P352_R | 0.558 |
| WEE1_P924_R | 0.559 | CDK6_P291_R | 0.558 |
| ACTG2_E98_R | 0.559 | MAP2K6_P297_R | 0.558 |
| CDH3_P87_R | 0.559 | FOSL2_E384_R | 0.558 |
| AREG_E25_F | 0.558 | IL1RN_E42_F | 0.558 |
| IFNG_P459_R | 0.558 | BLK_P668_R | 0.557 |
| SEMA3C_E49_R | 0.558 | IL16_P93_R | 0.557 |
| HDAC11_P556_F | 0.558 | p16_seq_47_S85_F | 0.557 |
| C4B_E171_F | 0.558 | PRSS1_P1249_R | 0.557 |
| EPHA7_P205_R | 0.558 | DDIT3_P1313_R | 0.556 |
| LCK_E28_F | 0.558 | TM7SF3_P1068_R | 0.556 |
| TNFRSF10B_P108_R | 0.558 | FLI20712_P984_R | 0.556 |
| OPCML_P71_F | 0.558 | TFF1_P180_R | 0.556 |
| MYH11_P22_F | 0.558 | MAGEL2_P170_R | 0.556 |
| PRSS1_E45_R | 0.558 | CDK6_E256_F | 0.556 |
| HIC2_P528_R | 0.558 | ID1_P880_F | 0.556 |
| THY1_P149_R | 0.558 | SLC22A2_P109_F | 0.556 |
| CEBPA_P706_F | 0.557 | ITGB4_P517_F | 0.556 |
| ABCC2_P88_F | 0.557 | SPI1_P929_F | 0.556 |
| ITPR3_E86_R | 0.557 | AREG_P217_R | 0.555 |
| NOTCH4_E4_F | 0.557 | CASP10_E139_F | 0.555 |
| IL17RB_P788_R | 0.557 | H19_P541_F | 0.555 |
| GFAP_P1214_F | 0.557 | CSF3R_P472_F | 0.555 |
| IGF2_E134_R | 0.557 | CD9_E14_R | 0.555 |
| HOXA9_P303_F | 0.557 | CAPG_E228_F | 0.555 |
| ASB4_P391_F | 0.557 | HOXA9_E252_R | 0.555 |
| PRKCDBP_E206_F | 0.556 | MAP3K1_P7_F | 0.555 |
| PEG10_P978_R | 0.556 | CDK10_P199_R | 0.555 |
| DCC_P471_R | 0.556 | NEU1_P745_F | 0.554 |
| SOX1_P294_F | 0.556 | CPA4_E20_F | 0.554 |
| AGTR1_P154_F | 0.556 | MAF_P826_R | 0.554 |
| NGFR_E328_F | 0.556 | PTPRF_E178_R | 0.554 |
| PENK_E26_F | 0.556 | PLAT_P80_F | 0.554 |
| CCKBR_P361_R | 0.555 | CPNE1_P138_F | 0.554 |
| CDH11_P203_R | 0.555 | TESK2_P252_R | 0.554 |
| ERBB2_P59_R | 0.555 | HPSE_P93_F | 0.554 |
| ITGB1_P451_F | 0.555 | ROR2_P317_R | 0.554 |
| MALT1_P406_R | 0.555 | S100A12_P1221_R | 0.554 |
| IGSF4_P86_R | 0.555 | YES1_P600_F | 0.554 |
| KIT_P405_F | 0.555 | ID1_P659_R | 0.554 |
| IL18BP_E285_F | 0.555 | PI3_P274_R | 0.553 |
| WRN_E57_F | 0.555 | TCF7L2_E411_F | 0.553 |
| FGF5_P238_R | 0.554 | ZP3_P220_F | 0.553 |
| IFNGR2_E164_F | 0.554 | FANCF_P13_F | 0.553 |
| SOX2_P546_F | 0.554 | LCN2_P86_R | 0.552 |
| CFTR_P372_R | 0.554 | PTK6_E50_F | 0.552 |
| COL6A1_P425_F | 0.554 | HOXA11_P698_F | 0.552 |
| LMO1_P169_F | 0.554 | ARHGDIB_P148_R | 0.552 |
| SMARCA3_P17_R | 0.553 | TNC_P198_F | 0.552 |
| IGSF4_P454_F | 0.553 | FRK_P258_F | 0.552 |
| GML_E144_F | 0.553 | CDH17_P532_F | 0.551 |
| RAF1_P330_F | 0.553 | MUC1_P191_F | 0.551 |
| HIC2_P498_F | 0.553 | IL8_E118_R | 0.551 |
| SHH_P104_R | 0.553 | EGFR_P260_R | 0.551 |
| ARHGAP9_P260_F | 0.553 | LAMC1_P808_F | 0.551 |
| TNFRSF1B_E5_F | 0.553 | TYRO3_P366_F | 0.551 |
| FLT3_P302_F | 0.553 | EPHB4_E476_R | 0.550 |
| EDNRB_P148_R | 0.553 | MEST_E150_F | 0.550 |
| CD1A_P6_F | 0.553 | FER_P581_F | 0.550 |
| NFKB2_P709_R | 0.552 | NRAS_P12_R | 0.550 |
| PRSS1_P1249_R | 0.552 | AGXT_P180_F | 0.550 |
| CDKN2B_seq_50_S2 | 0.552 | EFNA1_P7_F | 0.549 |
| POMC_P53_F | 0.552 | HIC1_E151_F | 0.549 |
| ZNFN1A1_E102_F | 0.552 | SRC_P297_F | 0.549 |
| EPHA3_P106_R | 0.552 | ASB4_P52_R | 0.549 |
| SLC22A3_P634_F | 0.552 | FGFR2_P266_R | 0.549 |
| CCKAR_P270_F | 0.551 | IL1B_P829_F | 0.548 |
| ASCL2_E76_R | 0.551 | ICA1_P72_R | 0.548 |
| ETS1_E253_R | 0.551 | FGFR2_P460_R | 0.548 |
| MMP7_P613_F | 0.550 | CREB1_P819_F | 0.548 |
| PDGFA_P841_R | 0.550 | ZIM3_P718_R | 0.548 |
| GADD45A_P737_R | 0.550 | SMARCA4_P362_R | 0.547 |
| RASA1_E107_F | 0.550 | TES_P182_F | 0.547 |
| NNAT_P544_R | 0.550 | ESR2_P162_F | 0.547 |
| ERCC3_P1210_R | 0.549 | DCN_P1320_R | 0.547 |
| HGF_E102_R | 0.549 | TEK_P479_R | 0.547 |
| FZD9_P15_R | 0.549 | CHFR_P501_F | 0.546 |
| EVI1_P30_R | 0.549 | DAPK1_E46_R | 0.546 |
| PTK7_E317_F | 0.548 | CASP3_P420_R | 0.546 |
| CTLA4_E176_R | 0.548 | FGFR3_P1152_R | 0.546 |
| PCGF4_P92_R | 0.548 | PSCA_P135_F | 0.546 |
| TDGF1_E53_R | 0.548 | APBA2_P227_F | 0.546 |
| RET_seq_53_S374_F | 0.548 | ESR2_E66_F | 0.546 |
| S100A4_E315_F | 0.548 | ASB4_E89_F | 0.545 |
| EIF2AK2_E103_R | 0.548 | MMP1_P397_R | 0.545 |
| MT1A_E13_R | 0.547 | MC2R_P1025_F | 0.545 |
| ERCC1_P354_F | 0.547 | NOTCH4_P938_F | 0.545 |
| GALR1_P80_F | 0.547 | RRAS_P100_R | 0.545 |
| GSTM1_P266_F | 0.547 | GFAP_P56_R | 0.545 |
| BMPR2_P1271_F | 0.547 | SEMA3C_E49_R | 0.545 |
| EPHB4_P313_R | 0.547 | CEACAM1_P44_R | 0.545 |
| GDF10_P95_R | 0.547 | MLLT6_P957_F | 0.544 |
| OSM_P188_F | 0.547 | CAV1_P130_R | 0.544 |
| HDAC9_E38_F | 0.547 | MALT1_P406_R | 0.544 |
| CD9_E14_R | 0.546 | HTR2A_P853_F | 0.544 |
| CTGF_P693_R | 0.546 | SERPINA5_E69_F | 0.544 |
| SEZ6L_P299_F | 0.546 | TSC2_E140_F | 0.544 |
| EGF_E339_F | 0.546 | BMP3_P56_R | 0.544 |
| APP_E8_F | 0.545 | PTK7_E317_F | 0.544 |
| MPL_P62_F | 0.545 | JAG1_P66_F | 0.544 |
| PALM2-AKAP2_P42C | 0.545 | NES_P239_R | 0.544 |
| PDGFA_P78_F | 0.545 | GADD45A_P737_R | 0.544 |
| SOD3_P460_R | 0.545 | PLAU_P176_R | 0.544 |
| PAX6_P50_R | 0.544 | CDK10_E74_F | 0.544 |
| SMAD2_P708_R | 0.544 | RARRES1_E235_F | 0.543 |
| CASP2_P192_F | 0.544 | CDH17_P376_F | 0.543 |
| PGR_P790_F | 0.544 | TRPM5_P721_F | 0.543 |
| FAT_P279_R | 0.544 | MCM6_E136_F | 0.543 |
| ZP3_E90_F | 0.544 | CSK_P740_R | 0.543 |
| YES1_P216_F | 0.543 | MMP3_P55_F | 0.543 |
| EPHA8_P256_F | 0.543 | WNT5A_P655_F | 0.542 |
| DES_E228_R | 0.543 | EPHB6_P827_R | 0.542 |
| WT1_P853_F | 0.543 | CDH17_E31_F | 0.542 |
| HDAC9_P137_R | 0.543 | CAV2_E33_R | 0.542 |
| WNT10B_P993_F | 0.543 | BRCA1_P835_R | 0.542 |
| KLK11_P103_R | 0.542 | PHLDA2_P622_F | 0.542 |
| COMT_E401_F | 0.542 | EPM2A_P64_R | 0.542 |
| THBS1_P500_F | 0.542 | ERCC1_P440_R | 0.541 |
| DIRAS3_E55_R | 0.542 | SRC_E100_R | 0.541 |
| MYCL1_P502_R | 0.542 | SMARCA3_E20_F | 0.541 |
| RUNX1T1_P103_F | 0.542 | CTSH_E157_R | 0.541 |
| PDE1B_E141_F | 0.542 | ETS2_P835_F | 0.541 |
| PURA_P928_R | 0.542 | CYP2E1_E53_R | 0.541 |
| BDNF_E19_R | 0.542 | RARRES1_P57_R | 0.541 |
| MAPK12_E165_R | 0.541 | PDGFA_P78_F | 0.541 |
| ONECUT2_E96_F | 0.541 | TRIM29_P135_F | 0.540 |
| ID1_P880_F | 0.541 | TMEM63A_E63_F | 0.540 |
| TAL1_P817_F | 0.541 | TES_E172_F | 0.540 |
| ACVR2B_P676_F | 0.541 | FANCG_E207_R | 0.540 |
| CFTR_P115_F | 0.541 | MMP10_E136_R | 0.539 |
| CCL3_P543_R | 0.541 | KIAA1804_P689_R | 0.539 |
| COL6A1_P283_F | 0.541 | PEG10_P978_R | 0.539 |
| FLT4_E206_F | 0.541 | ABCG2_P310_R | 0.539 |
| AGXT_P180_F | 0.541 | CLDN4_P1120_R | 0.539 |
| MAGEL2_E166_R | 0.541 | MXI1_P75_R | 0.539 |
| HHIP_P307_R | 0.540 | TNFRSF10B_E198_R | 0.539 |
| CD86_P3_F | 0.540 | CDKN2A_E121_R | 0.539 |
| TRPM5_E87_F | 0.540 | CD82_P557_R | 0.538 |
| IL17RB_E164_R | 0.540 | CTSH_P238_F | 0.538 |
| TES_E172_F | 0.540 | HFE_E273_R | 0.538 |
| KIT_P367_R | 0.540 | AFP_P824_F | 0.538 |
| ISL1_E87_R | 0.540 | PTPNS1_E433_R | 0.538 |
| APOC2_P377_F | 0.540 | TSG101_P257_R | 0.538 |
| HGF_P1293_R | 0.540 | TYK2_P494_F | 0.537 |
| TNC_P198_F | 0.540 | CYP2E1_P416_F | 0.537 |
| CYP1B1_P212_F | 0.539 | AXL_P223_R | 0.537 |
| ST6GAL1_P164_R | 0.539 | PTPRH_E173_F | 0.537 |
| MAD2L1_E93_F | 0.539 | FVT1_P225_F | 0.537 |
| NTRK1_E74_F | 0.539 | SERPINB5_P19_R | 0.537 |
| MME_E29_F | 0.539 | PWCR1_P811_F | 0.537 |
| PTPRG_P476_F | 0.538 | ZMYND10_P329_F | 0.537 |
| MYBL2_P354_F | 0.538 | IHH_P529_F | 0.537 |
| LTB4R_E64_R | 0.538 | B3GALT5_E246_R | 0.537 |
| JAG1_P66_F | 0.538 | PGF_P320_F | 0.536 |
| IL4_P262_R | 0.538 | ITGA6_P298_R | 0.536 |
| HOXB13_E21_F | 0.538 | ACVR1B_P572_R | 0.536 |
| FGF8_E183_F | 0.538 | IL12B_P392_R | 0.536 |
| HPSE_P29_F | 0.538 | GJB2_E43_F | 0.536 |
| MME_P388_F | 0.538 | GRB7_E71_R | 0.535 |
| LAT_E46_F | 0.537 | GML_P281_R | 0.535 |
| LIG4_P194_F | 0.537 | JAG2_P264_F | 0.535 |
| HSD17B12_E145_R | 0.537 | GNMT_P197_F | 0.535 |
| KRAS_E82_F | 0.537 | CASP10_P186_F | 0.535 |
| LEFTY2_P561_F | 0.537 | NOS2A_E117_R | 0.534 |
| DIO3_P90_F | 0.537 | KLK11_P1290_F | 0.534 |
| TNF_P158_F | 0.537 | DDB2_P613_R | 0.534 |
| RHOC_P536_F | 0.537 | SYK_E372_F | 0.534 |
| TNFSF10_E53_F | 0.537 | DAB2_P35_F | 0.534 |
| THPO_P585_R | 0.536 | MCC_P196_R | 0.534 |
| TPEF_seq_44_S36_F | 0.536 | HLA-DRA_P132_R | 0.534 |
| PTCH2_P37_F | 0.536 | AFF3_P808_F | 0.534 |
| BMP3_E147_F | 0.536 | SEPT9_P58_R | 0.534 |
| APBA1_P644_F | 0.536 | PRSS8_E134_R | 0.534 |
| YES1_P600_F | 0.535 | KLK11_P103_R | 0.533 |
| TM7SF3_P1068_R | 0.535 | PI3_P1394_R | 0.533 |
| COL18A1_P365_R | 0.535 | ITGA2_P26_R | 0.533 |
| ICAM1_E242_F | 0.535 | BMPR2_E435_F | 0.533 |
| BCL2A1_P1127_R | 0.534 | RUNX3_E27_R | 0.533 |
| RARRES1_P57_R | 0.534 | GPX1_E46_R | 0.533 |
| GUCY2D_E419_R | 0.534 | GAS1_E22_F | 0.533 |
| TUBB3_P721_R | 0.534 | SPDEF_P6_R | 0.533 |
| EMR3_P1297_R | 0.534 | IL12B_E25_F | 0.533 |
| HTR2A_P853_F | 0.534 | MMP3_P16_R | 0.532 |
| GJB2_E43_F | 0.534 | CTSL_P264_R | 0.532 |
| ASCL2_P360_F | 0.533 | SMARCA3_P17_R | 0.532 |
| FLI1_E29_F | 0.533 | APBA1_P644_F | 0.532 |
| SERPINB2_P939_F | 0.533 | BCL2L2_P280_F | 0.532 |
| TESK2_P252_R | 0.533 | IGF2R_P396_R | 0.532 |
| FN1_E469_F | 0.533 | ERCC1_P354_F | 0.532 |
| ELK3_P514_F | 0.532 | ABL1_P53_F | 0.532 |
| CALCA_E174_R | 0.532 | HLA-DPB1_E2_R | 0.532 |
| FOLR1_E368_R | 0.532 | BIRC5_E89_F | 0.531 |
| POMC_E254_F | 0.532 | MAPK12_P416_F | 0.531 |
| PHLDA2_E159_R | 0.532 | CTLA4_E176_R | 0.531 |
| CDKN1C_P626_F | 0.532 | MEST_P4_F | 0.531 |
| PODXL_P1341_R | 0.532 | HLA-DQA2_P282_R | 0.531 |
| AFP_P824_F | 0.531 | FAS_P65_F | 0.531 |
| CRIP1_P874_R | 0.531 | FGF9_P1404_F | 0.531 |
| TNC_P57_F | 0.531 | PSIP1_P163_R | 0.531 |
| ROR2_E112_F | 0.531 | TNFRSF10A_P91_F | 0.531 |
| CTTN_E29_R | 0.531 | NBL1_E205_R | 0.531 |
| MTA1_P478_F | 0.531 | RBL2_P250_R | 0.531 |
| TWIST1_P44_R | 0.531 | SFN_P248_F | 0.530 |
| PLAGL1_E68_R | 0.531 | MET_E333_F | 0.530 |
| PLAGL1_P334_F | 0.531 | BCL3_E71_F | 0.530 |
| NTRK2_P10_F | 0.531 | DDR1_E23_R | 0.530 |
| NTRK3_P752_F | 0.531 | EDNRB_P148_R | 0.530 |
| NRAS_P12_R | 0.531 | PCDH1_P264_F | 0.530 |
| EGFR_E295_R | 0.531 | ATP10A_P524_R | 0.530 |
| RASGRF1_E16_F | 0.531 | ICAM1_P386_R | 0.530 |
| FGF12_P210_R | 0.530 | ITK_P114_F | 0.530 |
| ERBB3_P870_R | 0.530 | BAX_E281_R | 0.529 |
| CDKN1A_E101_F | 0.530 | DAPK1_P10_F | 0.529 |
| HRASLS_E72_R | 0.530 | SNRPN_P230_R | 0.529 |
| CASP10_E139_F | 0.530 | EPHA1_E46_R | 0.529 |
| SPARC_P195_F | 0.530 | COL6A1_P283_F | 0.529 |
| EPO_E244_R | 0.530 | SEMA3A_P343_F | 0.529 |
| TP73_P496_F | 0.530 | NOTCH3_P198_R | 0.529 |
| HLA-DPB1_E2_R | 0.529 | EMR3_E61_F | 0.529 |
| HOXA11_P92_R | 0.529 | S100A2_P1186_F | 0.529 |
| KRT1_P798_R | 0.529 | INHA_P1189_F | 0.529 |
| PTHLH_E251_F | 0.529 | SPP1_P647_F | 0.529 |
| GABRB3_E42_F | 0.529 | PTHR1_P258_F | 0.528 |
| CASP6_P201_F | 0.528 | VAV2_E58_F | 0.528 |
| PDGFB_E25_R | 0.528 | DLL1_P386_F | 0.528 |
| CCNE1_P683_F | 0.528 | DNMT1_P100_R | 0.528 |
| HLA-DOB_P1114_R | 0.528 | HOXA9_P303_F | 0.528 |
| PLXDC2_P914_R | 0.528 | TRIP6_P1274_R | 0.528 |
| PTGS2_P308_F | 0.528 | PPARG_P693_F | 0.528 |
| DDB2_P613_R | 0.528 | HDAC5_E298_F | 0.528 |
| CCKBR_P480_F | 0.528 | VAMP8_P241_F | 0.527 |
| SEPT5_P441_F | 0.528 | DUSP4_E61_F | 0.527 |
| JAK3_P156_R | 0.528 | IL12B_P1453_F | 0.527 |
| PWCR1_P357_F | 0.528 | DSC2_E90_F | 0.527 |
| MXI1_P75_R | 0.528 | CCKAR_P270_F | 0.527 |
| PECAM1_E32_R | 0.527 | KLF5_P13_F | 0.526 |
| BCL3_E71_F | 0.527 | FANCA_P1006_R | 0.526 |
| SLC5A5_E60_F | 0.527 | CD81_P272_R | 0.526 |
| MPO_E302_R | 0.527 | CARD15_P302_R | 0.526 |
| PTHLH_P15_R | 0.526 | RARRES1_P426_R | 0.525 |
| IL11_P11_R | 0.526 | ITGB1_P451_F | 0.525 |
| HDAC7A_P344_F | 0.526 | CDH1_P45_F | 0.525 |
| VAV1_E9_F | 0.526 | ACVR2B_P676_F | 0.525 |
| ETV1_P515_F | 0.526 | SLC22A2_E271_R | 0.525 |
| PPP2R1B_P268_R | 0.526 | ERBB3_E331_F | 0.525 |
| BMP6_P163_F | 0.526 | BMPR2_P1271_F | 0.525 |
| STK11_P295_R | 0.526 | SPDEF_E116_R | 0.525 |
| IGFBP3_P423_R | 0.525 | TNFSF10_E53_F | 0.525 |
| ICAM1_P386_R | 0.525 | DHCR24_P406_R | 0.525 |
| CTSH_E157_R | 0.525 | PPP2R1B_P268_R | 0.524 |
| HHIP_P578_R | 0.525 | HIC1_P565_R | 0.524 |
| PDGFRB_E195_R | 0.525 | SIN3B_P607_F | 0.524 |
| TRIP6_E33_F | 0.524 | MAD2L1_E93_F | 0.524 |
| PCGF4_P760_R | 0.524 | FRK_P36_F | 0.524 |
| S100A4_P887_R | 0.524 | PGR_P456_R | 0.524 |
| RUNX3_P393_R | 0.524 | MKRN3_P108_F | 0.524 |
| ARHGAP9_P518_R | 0.524 | IHH_E186_F | 0.524 |
| KLK11_P1290_F | 0.524 | WNT2B_P1195_F | 0.524 |
| DNMT1_P100_R | 0.523 | RUNX1T1_P103_F | 0.524 |
| SHB_P473_R | 0.523 | TNFRSF10B_P108_R | 0.523 |
| MLF1_P97_F | 0.523 | EDN1_P39_R | 0.523 |
| ASCL1_E24_F | 0.523 | CXCL9_E268_R | 0.523 |
| DMP1_P134_F | 0.523 | PLAUR_E123_F | 0.523 |
| FLT1_E444_F | 0.523 | TMEFF1_P234_F | 0.523 |
| ESR1_P151_R | 0.523 | CREBBP_P712_R | 0.523 |
| MAP3K1_E81_F | 0.523 | TRAF4_P372_F | 0.523 |
| ST6GAL1_P528_F | 0.523 | BMP2_E48_R | 0.523 |
| EPHA3_E156_R | 0.523 | IGSF4C_E65_F | 0.522 |
| FGR_P39_F | 0.523 | EGFR_E295_R | 0.522 |
| SEMA3A_P343_F | 0.523 | AHR_E103_F | 0.522 |
| CAV1_P130_R | 0.523 | EFNB3_E17_R | 0.522 |
| KDR_E79_F | 0.522 | CDKN1C_P6_R | 0.522 |
| WNT10B_P823_R | 0.522 | DUSP4_P925_R | 0.522 |
| CDK6_P291_R | 0.522 | PXN_P308_F | 0.522 |
| GPR116_P850_F | 0.522 | AXL_E61_F | 0.521 |
| CDKN1B_P1161_F | 0.521 | MUSK_P308_F | 0.521 |
| ONECUT2_P315_R | 0.521 | MAPK14_P327_R | 0.521 |
| PLAGL1_P236_R | 0.521 | LMO1_P169_F | 0.521 |
| GSTP1_seq_38_S15$$ | 0.521 | NBL1_P24_F | 0.521 |
| MCM6_E136_F | 0.521 | KCNQ1_E349_R | 0.521 |
| PLAU_P176_R | 0.521 | BCAM_P205_F | 0.521 |
| ELL_P693_F | 0.521 | NID1_P677_F | 0.521 |
| ADCYAP1_E163_R | 0.520 | TJP1_P326_R | 0.521 |
| CDKN2A_E121_R | 0.520 | ERBB3_P870_R | 0.521 |
| PDGFRA_E125_F | 0.520 | FZD7_E296_F | 0.520 |
| TK1_E47_F | 0.520 | ONECUT2_E96_F | 0.520 |
| KDR_P445_R | 0.520 | HRASLS_E72_R | 0.520 |
| S100A12_P1221_R | 0.520 | CD81_P211_F | 0.520 |
| GABRA5_P1016_F | 0.520 | HOXA11_E35_F | 0.520 |
| FGF9_P1404_F | 0.520 | ETV6_E430_F | 0.520 |
| ESR2_E66_F | 0.520 | CASP8_E474_F | 0.520 |
| CCND2_P898_R | 0.519 | PTGS2_P308_F | 0.520 |
| WRN_P969_F | 0.519 | FER_E119_F | 0.520 |
| ITGA6_P298_R | 0.519 | MMP1_P460_F | 0.520 |
| EPHA5_E158_R | 0.519 | HTR2A_E10_R | 0.520 |
| SLC22A2_P109_F | 0.519 | TNFRSF10A_P171_F | 0.519 |
| MYOD1_P50_F | 0.519 | CCL3_E53_R | 0.519 |
| BIRC5_E89_F | 0.519 | ASB4_P391_F | 0.519 |
| NGFR_P355_F | 0.519 | ITGA2_E120_F | 0.519 |
| IGFBP5_E144_F | 0.519 | DDR1_P332_R | 0.519 |
| NRG1_E74_F | 0.519 | PROK2_E0_F | 0.519 |
| ASCL1_P747_F | 0.519 | NTRK1_E74_F | 0.519 |
| ACTG2_P346_F | 0.518 | TIMP2_E394_R | 0.518 |
| LTA_E28_R | 0.518 | TIMP3_P1114_R | 0.518 |
| SFTPA1_P421_F | 0.518 | SMAD4_P474_R | 0.518 |
| GABRA5_P862_R | 0.518 | EPHB3_E0_F | 0.518 |
| IMPACT_P234_R | 0.518 | HIF1A_P488_F | 0.518 |
| TPEF_seq_44_S88_R | 0.518 | CASP10_P334_F | 0.518 |
| CASP6_P230_R | 0.517 | CEACAM1_E57_R | 0.518 |
| TNFRSF10B_E198_R | 0.517 | RYK_P493_F | 0.518 |
| RYK_P493_F | 0.517 | ROR1_P6_F | 0.518 |
| HBII-13_E48_F | 0.517 | PTK2B_P673_R | 0.518 |
| CCKAR_E79_F | 0.517 | NEFL_E23_R | 0.517 |
| COL1A1_P117_R | 0.517 | EMR3_P1297_R | 0.517 |
| CCR5_P630_R | 0.517 | PPARG_E178_R | 0.517 |
| APOA1_P75_F | 0.517 | CCND1_E280_R | 0.517 |
| VAV2_E58_F | 0.516 | STK11_P295_R | 0.517 |
| HTR2A_E10_R | 0.516 | HDAC1_P414_R | 0.517 |
| WNT2_P217_F | 0.516 | E2F3_P840_R | 0.517 |
| PLG_E406_F | 0.516 | TRIM29_E189_F | 0.516 |
| NDN_P1110_F | 0.516 | CRK_P721_F | 0.516 |
| DCC_E53_R | 0.516 | RAD54B_P227_F | 0.516 |
| PROK2_P390_F | 0.516 | LIG3_P622_R | 0.516 |
| LTA_P214_R | 0.516 | CCKAR_E79_F | 0.516 |
| DAB2IP_P9_F | 0.516 | BCL2A1_P1127_R | 0.516 |
| RET_seq_54_S260_F | 0.516 | ABCC5_P444_F | 0.516 |
| TIMP3_seq_7_S38_F | 0.516 | PWCR1_P357_F | 0.516 |
| FN1_P229_R | 0.515 | SEMA3F_E333_R | 0.515 |
| DSC2_P407_R | 0.515 | THBS1_P500_F | 0.515 |
| WNT1_P79_R | 0.515 | ABCC2_P88_F | 0.515 |
| H19_P1411_R | 0.515 | MAP3K1_E81_F | 0.515 |
| TEK_P479_R | 0.515 | ITPR3_E86_R | 0.515 |
| TAL1_E122_F | 0.515 | NR2F6_E375_R | 0.515 |
| SPARC_E50_R | 0.515 | MYCL1_P502_R | 0.514 |
| TRAF4_P372_F | 0.515 | USP29_E274_F | 0.514 |
| LOX_P71_F | 0.515 | MAF_E77_R | 0.514 |
| PI3_E107_F | 0.515 | CSF1_P217_F | 0.514 |
| FGFR1_P204_F | 0.514 | OGG1_E400_F | 0.514 |
| DDB2_P407_F | 0.514 | PLAUR_P82_F | 0.514 |
| GUCY2D_P48_R | 0.514 | E2F5_P516_R | 0.514 |
| IGSF4C_E65_F | 0.514 | EPM2A_P113_F | 0.514 |
| PTHLH_P757_F | 0.514 | CDKN2B_E220_F | 0.514 |
| ABL2_P459_R | 0.513 | SIN3B_P514_R | 0.514 |
| AHR_E103_F | 0.513 | EPS8_E231_F | 0.513 |
| ALK_P28_F | 0.513 | IHH_P246_R | 0.513 |
| APP_P179_R | 0.513 | RIPK4_P172_F | 0.513 |
| EPHB1_P503_F | 0.513 | GABRA5_E44_R | 0.513 |
| HTR1B_P107_F | 0.513 | TMEFF1_E180_R | 0.513 |
| PGR_P456_R | 0.513 | ZNFN1A1_E102_F | 0.512 |
| MAS1_P469_R | 0.513 | PCGF4_P92_R | 0.512 |
| CALCA_P75_F | 0.513 | CDH3_E100_R | 0.512 |
| ZIM2_E110_F | 0.513 | PGR_E183_R | 0.512 |
| PDGFRB_P343_F | 0.513 | AFF3_P122_F | 0.512 |
| HOXA11_E35_F | 0.513 | HBII-13_E48_F | 0.512 |
| DES_P1006_R | 0.513 | HBEGF_P32_R | 0.512 |
| DDR1_E23_R | 0.512 | MAP2K6_E297_F | 0.512 |
| MLF1_E243_F | 0.512 | TNK1_P41_R | 0.511 |
| CHI3L2_P226_F | 0.512 | RIPK4_E166_F | 0.511 |
| ABL1_P53_F | 0.512 | ABCC2_E16_R | 0.511 |
| MAP2K6_E297_F | 0.512 | HLA-DQA2_E93_F | 0.511 |
| ESR2_P162_F | 0.512 | SEPT5_P464_R | 0.510 |
| JAK3_E64_F | 0.512 | C20orf47_P225_R | 0.510 |
| OSM_P34_F | 0.512 | ZNFN1A1_P179_F | 0.510 |
| APC_P280_R | 0.511 | TDG_E129_F | 0.510 |
| CYP2E1_P416_F | 0.511 | TFRC_P414_R | 0.510 |
| CARD15_P665_F | 0.511 | SMAD2_P848_R | 0.510 |
| NTRK3_E131_F | 0.511 | IGFBP3_P1035_F | 0.510 |
| EPO_P162_R | 0.511 | TIMP3_P690_R | 0.510 |
| FGFR3_P1152_R | 0.511 | ZNF264_E48_R | 0.510 |
| ABCB4_E429_F | 0.511 | MPO_P883_R | 0.510 |
| MYLK_E132_R | 0.511 | COPG2_P298_F | 0.510 |
| KIAA0125_E29_F | 0.511 | RAF1_P330_F | 0.510 |
| CTSH_P238_F | 0.510 | TFF2_P178_F | 0.510 |
| SNURF_E256_R | 0.510 | HGF_E102_R | 0.510 |
| LAMC1_P808_F | 0.510 | BCL6_P248_R | 0.509 |
| PMP22_P1254_F | 0.510 | DSG1_P159_R | 0.509 |
| HLA-DRA_P77_R | 0.510 | PADI4_P1011_R | 0.509 |
| TWIST1_E117_R | 0.510 | FASTK_P257_F | 0.509 |
| FZD9_P175_F | 0.510 | INS_P248_F | 0.509 |
| IGF1_P933_F | 0.509 | HBII-52_P563_F | 0.509 |
| PROK2_E0_F | 0.509 | VAMP8_E7_F | 0.509 |
| CCNA1_P216_F | 0.509 | NFKB2_P709_R | 0.509 |
| SLC5A8_P38_R | 0.509 | TGFBI_P173_F | 0.509 |
| PGR_E183_R | 0.509 | DSP_P440_R | 0.509 |
| INSR_P1063_R | 0.509 | APBA1_E99_R | 0.509 |
| CDH1_P45_F | 0.508 | MUC1_E18_R | 0.509 |
| MAF_E77_R | 0.508 | NOS3_P38_F | 0.509 |
| CHFR_P501_F | 0.508 | SNCG_P53_F | 0.508 |
| EPM2A_P64_R | 0.508 | LIG4_P194_F | 0.508 |
| NRG1_P558_R | 0.508 | NQO1_E74_R | 0.508 |
| ABCA1_E120_R | 0.508 | BMPR1A_P956_F | 0.508 |
| NPY_P91_F | 0.508 | UNG_P170_F | 0.508 |
| RARB_P60_F | 0.508 | SEPT5_P441_F | 0.508 |
| DUSP4_P925_R | 0.508 | IRF5_P123_F | 0.508 |
| F2R_P839_F | 0.507 | IMPACT_P186_F | 0.508 |
| FANCG_E207_R | 0.507 | MGMT_P272_R | 0.507 |
| LRRK1_P834_F | 0.507 | NOTCH1_E452_R | 0.507 |
| GFAP_P56_R | 0.507 | H19_P1411_R | 0.507 |
| SOD3_P225_F | 0.507 | SFN_E118_F | 0.507 |
| GFI1_E136_F | 0.507 | PTPRH_P255_F | 0.507 |
| FLI1_P620_R | 0.507 | UBA52_P293_R | 0.507 |
| AGTR1_P41_F | 0.507 | GRB7_P160_R | 0.507 |
| ZIM2_P22_F | 0.507 | COL6A1_P425_F | 0.507 |
| C20orf47_P225_R | 0.506 | IL8_P83_F | 0.507 |
| PTCH2_P568_R | 0.506 | FN1_P229_R | 0.507 |
| HCK_P46_R | 0.506 | AGXT_E115_R | 0.506 |
| CSF3R_P472_F | 0.506 | GAS1_P754_R | 0.506 |
| LAMB1_E144_R | 0.506 | CCND3_P435_F | 0.506 |
| THY1_P20_R | 0.506 | PRKAR1A_P337_R | 0.506 |
| MEG3_P235_F | 0.505 | MCM2_P260_F | 0.506 |
| COL4A3_E205_R | 0.505 | AREG_E25_F | 0.505 |
| ACVR1B_E497_R | 0.505 | NCL_P840_R | 0.505 |
| FZD7_E296_F | 0.505 | MDS1_E45_F | 0.505 |
| RARB_E114_F | 0.505 | EVI1_P30_R | 0.505 |
| C4B_P191_F | 0.505 | PTGS1_P2_F | 0.505 |
| IGFBP3_P1035_F | 0.504 | DSP_P36_F | 0.504 |
| CSF3_E242_R | 0.504 | FGF6_E294_F | 0.504 |
| MLLT3_E93_R | 0.504 | HLA-DRA_P77_R | 0.504 |
| CDH11_E102_R | 0.504 | CDK2_P330_R | 0.503 |
| TES_P182_F | 0.504 | FAT_P973_R | 0.503 |
| IHH_E186_F | 0.504 | ITPR3_P1112_F | 0.503 |
| CDH17_P532_F | 0.504 | AHR_P166_R | 0.502 |
| IL6_P213_R | 0.504 | RIPK2_E123_F | 0.502 |
| TMEFF1_E180_R | 0.504 | ABL2_P459_R | 0.502 |
| ITGA2_P26_R | 0.502 | ODC1_P424_F | 0.502 |
| DSG1_E292_F | 0.502 | EPHB2_E297_F | 0.502 |
| HOXB13_P17_R | 0.502 | PTK2_P735_R | 0.502 |
| FASTK_P257_F | 0.502 | KLF5_E190_R | 0.502 |
| NES_P239_R | 0.502 | IL6_P611_F | 0.502 |
| PIK3R1_P307_F | 0.502 | FAT_P279_R | 0.502 |
| IL10_P85_F | 0.502 | ERBB2_P59_R | 0.502 |
| ADCYAP1_P455_R | 0.502 | MEST_P62_R | 0.502 |
| DBC1_P351_R | 0.502 | APP_E8_F | 0.502 |
| NGFB_P13_F | 0.501 | TCF7L2_P193_R | 0.502 |
| FGF3_E198_R | 0.501 | CD1A_P6_F | 0.501 |
| PDE1B_P263_R | 0.501 | PDGFB_E25_R | 0.501 |
| SMARCA4_P362_R | 0.501 | CTGF_P693_R | 0.501 |
| MGMT_P272_R | 0.501 | CEBPA_P706_F | 0.501 |
| SERPINA5_E69_F | 0.500 | SNURF_E256_R | 0.501 |
| HBEGF_P32_R | 0.500 | ITK_E166_R | 0.501 |
| INS_P804_R | 0.500 | HDAC11_P556_F | 0.501 |
| INSR_E97_F | 0.500 | ICA1_P61_F | 0.500 |
| GPATC3_P410_R | 0.500 | EGR4_P479_F | 0.500 |

SUPPLEMENTAL TABLE 17
Rank ordered list of most critical CpG loci for differentiating invasive bladder tumors
from non invasive bladder tumors by Random Forests classification in both tumor series.

| Series 1 | | Series 2 | |
|---|---|---|---|
| GENE_CpG | Percent Increase in MSE | GENE_CpG | Percent Increase in MSE |
| SLC14A1_E295_F | 20.08 | STAT5A_P704_R | 26.77 |
| EGF_P413_F | 17.21 | KRT13_P341_R | 23.93 |
| RARA_P1076_R | 16.33 | CDH11_E102_R | 23.60 |
| JAG2_P264_F | 16.04 | GP1BB_P278_R | 23.24 |
| STAT5A_P704_R | 15.28 | RASSF1_E116_F | 22.35 |
| FRZB_E186_R | 15.22 | HOXB2_P488_R | 22.06 |
| SIN3B_P607_F | 14.43 | SLIT2_E111_R | 21.35 |
| HS3ST2_P171_F | 14.19 | FGF3_E198_R | 20.72 |
| TEK_E75_F | 14.18 | SEPT9_P374_F | 20.45 |
| MDR1_seq_42_S300_R | 13.89 | HS3ST2_P171_F | 20.21 |
| SLC14A1_P369_R | 13.57 | RIPK1_P868_F | 20.19 |
| RIPK1_P868_F | 13.05 | HPN_P374_R | 19.92 |
| UGT1A1_P315_R | 12.98 | FLT1_E444_F | 19.69 |
| CSF1R_P73_F | 12.75 | TPEF_seq_44_S36_F | 19.00 |
| AATK_E63_R | 12.64 | TERT_P360_R | 18.01 |
| MAD2L1_E93_F | 12.51 | FGF1_P357_R | 17.81 |
| AATK_P519_R | 12.43 | TERT_E20_F | 17.76 |
| CSF1R_E26_F | 12.37 | GAS7_P622_R | 17.49 |
| FGF1_P357_R | 12.27 | SLIT2_P208_F | 17.33 |
| GABRG3_P75_F | 12.25 | DIO3_P90_F | 17.14 |
| ZIM2_P22_F | 12.16 | CDH11_P203_R | 17.02 |
| RARA_P176_R | 11.83 | NOTCH4_E4_F | 16.91 |
| IRF5_P123_F | 11.39 | OPCML_E219_R | 16.80 |
| SPP1_E140_R | 11.35 | RARA_P1076_R | 16.62 |
| TAL1_E122_F | 11.26 | CSPG2_P82_R | 16.23 |
| KRT13_P341_R | 11.23 | CHGA_E52_F | 16.13 |
| THBS2_P605_R | 11.09 | VIM_P343_R | 15.96 |
| HPN_P374_R | 11.01 | FLT4_E206_F | 15.73 |
| MMP3_P16_R | 10.90 | MST1R_E42_R | 15.71 |
| FGFR4_P610_F | 10.57 | CSF3_P309_R | 15.56 |
| CHI3L2_P226_F | 10.53 | FGF3_P171_R | 15.50 |
| KLK10_P268_R | 10.29 | SFRP1_E398_R | 15.49 |
| IGSF4_P454_F | 10.19 | EPHA5_E158_R | 15.31 |
| CSF2_P605_F | 10.10 | FGF1_E5_F | 15.19 |
| CALCA_P75_F | 9.99 | EYA4_E277_F | 15.00 |
| USP29_P282_R | 9.59 | RASSF1_P244_F | 14.98 |
| HS3ST2_P546_F | 9.59 | IRAK3_P13_F | 14.90 |
| DDIT3_P1313_R | 9.52 | HHIP_E94_F | 14.86 |
| TRPM5_P979_F | 9.20 | IGFBP7_P297_F | 14.85 |
| SNCG_E119_F | 8.94 | GDF10_P95_R | 14.43 |
| TIMP3_seq_7_S38_F | 8.74 | NPY_E31_R | 14.32 |
| EPHA1_P119_R | 8.73 | CDH13_E102_F | 14.27 |
| FRZB_P406_F | 8.66 | DES_E228_R | 14.22 |
| MAP3K1_P7_F | 8.53 | IRF7_E236_R | 14.03 |
| CSF3_P309_R | 8.45 | PROK2_P390_F | 13.99 |
| EPM2A_P64_R | 8.34 | SFRP1_P157_F | 13.76 |
| HOXB2_P488_R | 8.32 | THY1_P149_R | 13.71 |
| UGT1A1_E11_F | 8.19 | TNFRSF10C_P7_F | 13.67 |
| PLAGL1_P334_F | 8.08 | NGFB_E353_F | 13.56 |
| MMP7_E59_F | 8.06 | AGTR1_P41_F | 13.32 |
| IGFBP3_P1035_F | 7.92 | SPP1_E140_R | 13.18 |
| TMPRSS4_E83_F | 7.83 | EYA4_P508_F | 13.18 |
| EPHA2_P340_R | 7.75 | GUCY2D_E419_R | 13.09 |
| GPR116_E328_R | 7.68 | PALM2-AKAP2_P183_R | 13.08 |
| SMO_E57_F | 7.66 | LY6G6E_P45_R | 13.04 |
| NRG1_P558_R | 7.62 | PADI4_P1158_R | 12.63 |
| HIC-1_seq_48_S103_R | 7.57 | ACVR1_P983_F | 12.33 |
| ITK_E166_R | 7.55 | HTR1B_P222_F | 12.09 |
| TUSC3_E29_R | 7.50 | NTSR1_P318_F | 12.00 |
| PTPRO_P371_F | 7.45 | VAV1_E9_F | 11.93 |
| GP1BB_E23_F | 7.35 | MST1R_P392_F | 11.87 |
| AFF3_P808_F | 7.33 | ADCYAP1_E163_R | 11.86 |
| SPI1_P929_F | 7.30 | MYH11_P236_R | 11.74 |
| RARB_E114_F | 7.29 | CD9_P504_F | 11.65 |
| BMP2_P1201_F | 7.28 | SOX1_P294_F | 11.64 |
| SNCG_P53_F | 7.27 | APBA2_P305_R | 11.56 |
| IGFBP2_P306_F | 7.20 | MMP2_P197_F | 11.46 |
| COL18A1_P365_R | 7.11 | SMO_E57_F | 11.43 |
| CSPG2_E38_F | 7.11 | CDH13_P88_F | 11.21 |
| HOXA5_P479_F | 6.91 | FRZB_P406_F | 11.16 |
| EVI2A_P94_R | 6.89 | STAT5A_E42_F | 10.99 |
| TJP2_P518_F | 6.82 | SIN3B_P607_F | 10.94 |
| FASTK_P598_R | 6.79 | HRASLS_P353_R | 10.80 |
| MAS1_P657_R | 6.79 | ETV1_P235_F | 10.73 |
| FGF1_E5_F | 6.78 | UGT1A1_E11_F | 10.70 |
| KRT13_P676_F | 6.65 | TEK_E75_F | 10.65 |
| NPR2_P1093_F | 6.60 | NTSR1_E109_F | 10.64 |
| ERG_E28_F | 6.57 | FGF12_E61_R | 10.60 |
| HOXB2_P99_F | 6.53 | NTRK3_P752_F | 10.52 |
| DUSP4_E61_F | 6.47 | FRZB_E186_R | 10.52 |
| NID1_P714_R | 6.45 | SLC5A8_E60_R | 10.41 |
| USP29_P205_R | 6.43 | PPARG_P693_F | 10.38 |
| VIM_P811_R | 6.42 | PTPRG_P476_F | 10.09 |
| PSCA_P135_F | 6.40 | GSTM2_P109_R | 10.05 |
| AIM2_E208_F | 6.36 | EPO_E244_R | 10.04 |
| ALOX12_E85_R | 6.35 | FGFR4_P610_F | 10.04 |
| DMP1_P134_F | 6.29 | SLC5A5_E60_F | 10.02 |
| WNT8B_P216_R | 6.20 | PYCARD_P150_F | 9.99 |
| ZIM3_E203_F | 6.20 | FABP3_P598_F | 9.92 |
| RARRES1_E235_F | 6.14 | ACVR1_E328_R | 9.92 |
| SEZ6L_P299_F | 6.11 | KRT13_P676_F | 9.88 |
| CSPG2_P82_R | 6.11 | POMC_P400_R | 9.76 |
| MUC1_E18_R | 6.09 | USP29_E274_F | 9.73 |
| OGG1_E400_F | 6.09 | ISL1_E87_R | 9.65 |
| POMC_E254_F | 6.09 | THY1_P20_R | 9.65 |
| ASCL2_E76_R | 6.03 | TMPRSS4_P552_F | 9.58 |
| RARA_E128_R | 6.02 | IRF7_P277_R | 9.55 |
| SPI1_P48_F | 5.97 | BMP4_P199_R | 9.52 |
| DHCR24_P652_R | 5.95 | S100A4_E315_F | 9.48 |
| PLAT_P80_F | 5.94 | FGF8_P473_F | 9.48 |
| PCDH1_E22_F | 5.89 | SLC14A1_E295_F | 9.47 |
| ER_seq_a1_S60_F | 5.89 | SRC_P297_F | 9.37 |
| GP1BB_P278_R | 5.88 | ASCL2_E76_R | 9.30 |
| DNMT3B_P352_R | 5.83 | DBC1_E204_F | 9.29 |
| GUCY2D_E419_R | 5.82 | NRG1_P558_R | 9.20 |
| HLA-DOB_E432_R | 5.80 | NID1_P714_R | 9.07 |
| MFAP4_P10_R | 5.80 | EYA4_P794_F | 9.05 |
| SH3BP2_E18_F | 5.79 | GALR1_P80_F | 9.02 |
| HIC2_P498_F | 5.75 | TRIP6_P1274_R | 8.99 |
| SYK_P584_F | 5.74 | MT1A_P49_R | 8.88 |
| TNFRSF10C_P7_F | 5.69 | AGTR1_P154_F | 8.75 |
| TFF2_P178_F | 5.68 | MST1R_P87_R | 8.73 |
| IGFBP1_P12_R | 5.67 | FLI1_E29_F | 8.67 |
| IRF7_E236_R | 5.67 | AATK_E63_R | 8.66 |
| HFE_E273_R | 5.65 | EGF_P413_F | 8.58 |
| CDH17_P376_F | 5.62 | NTRK2_P10_F | 8.55 |
| CCKAR_E79_F | 5.59 | ASCL2_P360_F | 8.53 |
| ACTG2_P455_R | 5.58 | TIMP2_P267_F | 8.44 |
| AATK_P709_R | 5.53 | CCKBR_P480_F | 8.37 |
| TGFB3_E58_R | 5.47 | SCGB3A1_E55_R | 8.33 |
| HPN_P823_F | 5.46 | ALOX12_E85_R | 8.25 |
| DLL1_P832_F | 5.45 | TNFRSF10C_E109_F | 8.20 |
| MOS_E60_R | 5.42 | HPN_P823_F | 8.19 |
| TNFSF8_E258_R | 5.39 | GABRG3_P75_F | 8.13 |
| THBS1_E207_R | 5.35 | TGFB2_P632_F | 8.02 |
| EPHB2_P165_R | 5.32 | APC_P280_R | 8.00 |
| CFTR_P115_F | 5.29 | IGFBP2_P306_F | 8.00 |
| CDH17_E31_F | 5.28 | TAL1_E122_F | 7.96 |
| PLAGL1_E68_R | 5.20 | TRIP6_P1090_F | 7.94 |
| MMP19_E274_R | 5.19 | GALR1_E52_F | 7.93 |
| CDKN1B_P1161_F | 5.17 | TFF2_P557_R | 7.89 |
| SPDEF_E116_R | 5.17 | MEG3_E91_F | 7.84 |
| ERCC1_P440_R | 5.15 | IGFBP1_P12_R | 7.83 |
| TSC2_E140_F | 5.14 | IRAK3_E130_F | 7.77 |
| CHI3L2_E10_F | 5.13 | FLI1_P620_R | 7.75 |
| UGT1A7_P751_R | 5.11 | EPHA7_E6_F | 7.74 |
| FRK_P258_F | 5.10 | MFAP4_P197_F | 7.70 |
| FLJ20712_P984_R | 5.09 | SPI1_P48_F | 7.65 |
| JAK3_P1075_R | 5.06 | GFI1_P45_R | 7.65 |
| KCNQ1_P546_R | 5.02 | DCC_P471_R | 7.55 |
| ACVR1C_P115_R | 5.01 | RARA_P176_R | 7.54 |
| BMP4_P199_R | 5.01 | TGFB2_E226_R | 7.52 |
| CYP2E1_E53_R | 5.00 | ISL1_P379_F | 7.48 |
| | | ZMYND10_E77_R | 7.45 |
| | | OPCML_P71_F | 7.45 |
| | | PLXDC2_E337_F | 7.44 |
| | | HOXB2_P99_F | 7.41 |
| | | WNT2_P217_F | 7.39 |
| | | IGF1R_P325_R | 7.39 |
| | | ERBB4_P541_F | 7.32 |
| | | EGF_E339_F | 7.22 |
| | | GSTM2_E153_F | 7.21 |
| | | GAS7_E148_F | 7.17 |
| | | FGF5_E16_F | 7.11 |
| | | TMEFF2_E94_R | 7.11 |
| | | PENK_E26_F | 7.09 |
| | | NOS2A_P288_R | 7.08 |
| | | MKRN3_E144_F | 7.08 |
| | | CSF1R_E26_F | 7.07 |
| | | EPHA2_P340_R | 7.05 |
| | | CD1A_P414_R | 7.01 |
| | | CSF2_P605_F | 6.96 |
| | | TRPM5_P979_F | 6.95 |
| | | MMP9_P189_F | 6.89 |
| | | CCND2_P898_R | 6.85 |
| | | DIO3_P674_F | 6.77 |
| | | WT1_E32_F | 6.77 |
| | | CCND2_P887_F | 6.77 |
| | | CLK1_P538_F | 6.76 |
| | | SGCE_E149_F | 6.66 |
| | | CFTR_P372_R | 6.60 |
| | | FGF5_P238_R | 6.53 |
| | | ZIM3_E203_F | 6.51 |
| | | APC_P14_F | 6.50 |
| | | ABO_P312_F | 6.48 |
| | | TPEF_seq_44_S88_R | 6.47 |
| | | BCR_P422_F | 6.46 |
| | | PAX6_E129_F | 6.46 |
| | | MMP1_P460_F | 6.36 |
| | | HS3ST2_P546_F | 6.35 |
| | | PDE1B_E141_F | 6.29 |
| | | TNFRSF1A_P678_F | 6.23 |
| | | FLT1_P615_R | 6.17 |
| | | HOXA5_E187_F | 6.16 |
| | | HTR1B_E232_R | 6.15 |
| | | ABCB4_E429_F | 6.13 |
| | | IRAK3_P185_F | 6.07 |
| | | MMP9_P237_R | 6.06 |
| | | THBS2_P605_R | 6.05 |
| | | PTHR1_P258_F | 5.98 |
| | | DLK1_E227_R | 5.95 |
| | | GJB2_P791_R | 5.95 |
| | | XRCC1_P681_R | 5.94 |
| | | UGT1A1_P315_R | 5.89 |
| | | JAK3_E64_F | 5.86 |
| | | JAK3_P1075_R | 5.84 |
| | | CALCA_P75_F | 5.80 |
| | | TBX1_P520_F | 5.79 |
| | | TIMP3_seq_7_S38_F | 5.78 |
| | | PRKCDBP_E206_F | 5.77 |
| | | ALOX12_P223_R | 5.72 |
| | | NID1_P677_F | 5.68 |
| | | HBII-52_P659_F | 5.61 |
| | | FGF12_P210_R | 5.60 |
| | | TMPRSS4_E83_F | 5.58 |
| | | TWIST1_E117_R | 5.56 |
| | | MOS_E60_R | 5.55 |
| | | ITK_E166_R | 5.51 |
| | | MT1A_E13_R | 5.50 |
| | | PGR_P456_R | 5.50 |
| | | HHIP_P578_R | 5.48 |
| | | FHIT_P93_R | 5.47 |
| | | GPR116_E328_R | 5.43 |
| | | PLAT_P80_F | 5.41 |
| | | BLK_P668_R | 5.36 |
| | | COL1A2_P48_R | 5.35 |
| | | ETV1_P515_F | 5.35 |
| | | AATK_P709_R | 5.34 |
| | | COMT_E401_F | 5.29 |
| | | NFKB1_P496_F | 5.25 |
| | | FGF2_P229_F | 5.25 |
| | | CDH17_E31_F | 5.23 |
| | | MYOD1_P50_F | 5.20 |
| | | IL18BP_P51_R | 5.18 |
| | | IGF2AS_E4_F | 5.17 |
| | | DCC_E53_R | 5.15 |
| | | SRC_P164_F | 5.15 |
| | | GABRA5_E44_R | 5.11 |
| | | CD34_P780_R | 5.10 |
| | | HS3ST2_E145_R | 5.06 |
| | | PENK_P447_R | 5.02 |

SUPPLEMENTAL TABLE 18
Differential methylation at CpG loci in lung tumor samples
versus non tumor lung samples.

| | Regression | | | |
|---|---|---|---|---|
| GENE_CpG | coefficient* | P-value | Q-value | Rank |
| CASP8_E474_F | −0.93 | 0 | 0 | 1 |
| COMT_E401_F | −0.74 | 0 | 0 | 2 |
| DLC1_P695_F | −1.21 | 0 | 0 | 3 |
| DLK1_E227_R | 1.75 | 0 | 0 | 4 |
| EMR3_P39_R | −1.24 | 0 | 0 | 5 |
| EYA4_P794_F | 1.12 | 0 | 0 | 6 |
| HCK_P858_F | 1.30 | 0 | 0 | 7 |
| HDAC1_P414_R | −0.93 | 0 | 0 | 8 |
| HOXA11_P698_F | 1.60 | 0 | 0 | 9 |
| HOXA5_P1324_F | 1.09 | 0 | 0 | 10 |
| HOXA9_E252_R | 2.39 | 0 | 0 | 11 |
| HOXA9_P1141_R | 2.06 | 0 | 0 | 12 |
| HOXA9_P303_F | 1.27 | 0 | 0 | 13 |
| HTR1B_P222_F | 1.99 | 0 | 0 | 14 |
| ID1_P880_F | −0.56 | 0 | 0 | 15 |
| IPF1_P750_F | 1.28 | 0 | 0 | 16 |
| IRF5_E101_F | 1.18 | 0 | 0 | 17 |
| MOS_E60_R | 1.74 | 0 | 0 | 18 |
| MUC1_P191_F | −1.01 | 0 | 0 | 19 |
| MYOD1_E156_F | 1.91 | 0 | 0 | 20 |
| PTPN6_E171_R | −1.65 | 0 | 0 | 21 |
| PTPRH_E173_F | −1.10 | 0 | 0 | 22 |
| SFN_P248_F | −0.98 | 0 | 0 | 23 |
| SOX17_P287_R | 1.17 | 0 | 0 | 24 |
| SOX17_P303_F | 1.46 | 0 | 0 | 25 |
| TAL1_P594_F | 1.81 | 0 | 0 | 26 |
| HS3ST2_E145_R | 1.53 | 0 | 0 | 27 |
| PTPN6_P282_R | −1.22 | 0 | 0 | 28 |
| RARRES1_P57_R | −0.59 | 0 | 0 | 29 |
| MUC1_E18_R | −0.80 | 0 | 0 | 30 |
| TMPRSS4_E83_F | −1.35 | 0 | 0 | 31 |
| TERT_P360_R | 1.62 | 0 | 0 | 32 |
| PRSS1_P1249_R | −0.84 | 0 | 0 | 33 |
| HTR1B_E232_R | 1.16 | 0 | 0 | 34 |
| TNFSF10_P2_R | −1.00 | 0 | 0 | 35 |
| ERBB2_P59_R | 1.04 | 0 | 0 | 36 |
| PLA2G2A_P528_F | −1.01 | 0 | 0 | 37 |
| NOS3_P38_F | −1.02 | 0 | 0 | 38 |
| DIO3_E230_R | 0.62 | 0 | 0 | 39 |
| TPEF_seq_44_S88_R | 1.52 | 0 | 0 | 40 |
| GABRA5_P862_R | −1.30 | 0 | 0 | 41 |
| NID1_P677_F | −1.43 | 0 | 0 | 42 |
| MPL_P657_F | −0.60 | 0 | 0 | 43 |
| NPY_P295_F | 1.59 | 0 | 0 | 44 |
| SOX1_P1018_R | 1.85 | 0 | 0 | 45 |
| ITK_P114_F | −1.11 | 0 | 0 | 46 |
| FRZB_E186_R | 1.39 | 0 | 0 | 47 |
| ADCYAP1_P398_F | 1.46 | 0 | 0 | 48 |
| WT1_P853_F | 1.55 | 0 | 0 | 49 |
| STAT5A_E42_F | 1.02 | 0 | 0 | 50 |
| SPP1_P647_F | −0.94 | 0 | 0 | 51 |
| MDR1_seq_42_S300_R | 2.13 | 0 | 0 | 52 |
| SPARC_P195_F | 0.93 | 0 | 0 | 53 |
| SOX1_P294_F | 1.27 | 0 | 0 | 54 |
| DDR1_P332_R | −1.03 | 0 | 0 | 55 |
| SERPINB5_P19_R | −1.49 | 0 | 0 | 56 |
| NID1_P714_R | −0.94 | 0 | 0 | 57 |
| PYCARD_P150_F | 0.82 | 0 | 0 | 58 |
| IL16_P93_R | −0.79 | 0 | 0 | 59 |
| BCL3_E71_F | −0.34 | 0 | 0 | 60 |
| CARD15_P302_R | −0.77 | 0 | 0 | 61 |
| APBA1_P644_F | 0.30 | 0 | 0 | 62 |
| NEFL_P209_R | 1.12 | 0 | 0 | 63 |
| VAMP8_P114_F | −0.71 | 0 | 0 | 64 |
| IGF2AS_P203_F | 0.87 | 0 | 0 | 65 |
| HOXA11_E35_F | 1.23 | 0 | 0 | 66 |
| PITX2_E24_R | 1.05 | 0 | 0 | 67 |
| TRIM29_P135_F | −0.91 | 0 | 0 | 68 |
| EMR3_E61_F | −0.86 | 0 | 0 | 69 |
| RARA_P1076_R | 0.92 | 0 | 0 | 70 |
| HS3ST2_P171_F | 0.92 | 0 | 0 | 71 |
| GABRG3_P75_F | −0.88 | 0 | 0 | 72 |
| AFF3_P122_F | −1.17 | 0 | 0 | 73 |
| CDH13_E102_F | 1.38 | 0 | 0 | 74 |
| DCC_P471_R | 1.15 | 0 | 0 | 75 |
| MEST_P4_F | −0.90 | 0 | 0 | 76 |
| CCNE1_P683_F | −0.32 | 0 | 0 | 77 |
| PI3_P1394_R | −0.87 | 0 | 0 | 78 |
| DCC_E53_R | 0.81 | 0 | 0 | 79 |
| MOS_P27_R | 0.99 | 0 | 0 | 80 |
| CLDN4_P1120_R | −0.78 | 0 | 0 | 81 |
| PRSS1_E45_R | −0.75 | 0 | 0 | 82 |
| IFNG_E293_F | −0.77 | 0 | 0 | 83 |
| CCR5_P630_R | −0.48 | 0 | 0 | 84 |
| WT1_E32_F | 1.78 | 0 | 0 | 85 |
| CCL3_E53_R | −0.79 | 0 | 0 | 86 |
| GFI1_P45_R | 1.00 | 0 | 0 | 87 |
| NOS2A_E117_R | −0.95 | 0 | 0 | 88 |
| DBC1_P351_R | 1.38 | 0 | 0 | 89 |
| SLIT2_P208_F | 1.10 | 0 | 0 | 90 |
| CHD2_P451_F | −0.63 | 0 | 0 | 91 |
| FGF2_P229_F | 1.05 | 0 | 0 | 92 |
| RUNX3_E27_R | −0.78 | 0 | 0 | 93 |
| BAX_E281_R | −0.63 | 0 | 0 | 94 |
| PENK_P447_R | 1.11 | 0 | 0 | 95 |
| PDGFRA_E125_F | 0.76 | 0 | 0 | 96 |
| ATP10A_P524_R | −0.67 | 0 | 0 | 97 |
| GML_P281_R | −1.23 | 0 | 0 | 98 |
| PTK7_E317_F | −0.46 | 0 | 0 | 99 |
| PI3_P274_R | −1.03 | 0 | 0 | 100 |
| CALCA_E174_R | 1.02 | 0 | 0 | 101 |
| GABRA5_P1016_F | −1.20 | 0 | 0 | 102 |
| USP29_E274_F | −1.24 | 0 | 0 | 103 |
| GALR1_E52_F | 1.07 | 0 | 0 | 104 |
| DCC_P177_F | 1.04 | 0 | 0 | 105 |
| CPA4_E20_F | −0.67 | 0 | 0 | 106 |
| VAV1_P317_F | −0.82 | 0 | 0 | 107 |
| AIM2_P624_F | −0.96 | 0 | 0 | 108 |
| ETS2_P835_F | −0.49 | 0 | 0 | 109 |
| PENK_E26_F | 0.50 | 0 | 0 | 110 |
| PLG_E406_F | −0.63 | 0 | 0 | 111 |
| FLT3_E326_R | 1.43 | 0 | 0 | 112 |
| THY1_P149_R | 1.15 | 0 | 0 | 113 |
| NBL1_P24_F | −0.77 | 0 | 0 | 114 |
| GABRG3_E123_R | −1.03 | 0 | 0 | 115 |
| CD2_P68_F | −0.89 | 0 | 0 | 116 |
| RARB_E114_F | 1.68 | 0 | 0 | 117 |
| NOTCH4_P938_F | −0.86 | 0 | 0 | 118 |
| EMR3_P1297_R | −0.98 | 0 | 0 | 119 |
| NEO1_P1067_F | −0.64 | 0 | 0 | 120 |
| ZMYND10_P329_F | −0.68 | 0 | 0 | 121 |
| FGFR2_P460_R | −0.39 | 0 | 0 | 122 |
| MME_P388_F | 1.09 | 0 | 0 | 123 |
| TNF_P158_F | −0.75 | 0 | 0 | 124 |
| MMP2_P303_R | 1.22 | 0 | 0 | 125 |
| S100A2_P1186_F | −0.87 | 0 | 0 | 126 |
| TRIM29_E189_F | −0.87 | 0 | 0 | 127 |
| HLA-DOB_E432_R | −0.77 | 0 | 0 | 128 |
| CXCL9_E268_R | −0.78 | 0 | 0 | 129 |
| SNURF_P78_F | −0.71 | 0 | 0 | 130 |
| FOSL2_E384_R | −0.69 | 0 | 0 | 131 |
| AGTR1_P154_F | 1.41 | 0 | 0 | 132 |
| PAX6_P50_R | 1.42 | 0 | 0 | 133 |
| APOC1_P406_R | −0.59 | 0 | 0 | 134 |
| PODXL_P1341_R | 1.17 | 0 | 0 | 135 |
| HBII-52_E142_F | −0.63 | 0 | 0 | 136 |
| IL1RN_E42_F | −0.81 | 0 | 0 | 137 |
| GSTM1_P266_F | 0.77 | 0 | 0 | 138 |
| NTSR1_P318_F | 1.30 | 0 | 0 | 139 |
| ADCYAP1_P455_R | 1.05 | 0 | 0 | 140 |
| SFN_E118_F | −0.97 | 0 | 0 | 141 |
| NPR2_P618_F | 0.81 | 0 | 0 | 142 |
| ASCL2_E76_R | 1.09 | 0 | 0 | 143 |
| DIO3_P674_F | 1.03 | 0 | 0 | 144 |
| TRIM29_P261_F | −1.30 | 0 | 0 | 145 |
| SLC14A1_E295_F | −0.72 | 0 | 0 | 146 |
| SNURF_E256_R | −0.55 | 0 | 0 | 147 |
| HBII-52_P563_F | −0.81 | 0 | 0 | 148 |
| CDH13_P88_F | 0.82 | 0 | 0 | 149 |
| CYP1B1_P212_F | −0.31 | 0 | 0 | 150 |
| TAL1_E122_F | 1.38 | 0 | 0 | 151 |
| CHGA_E52_F | 1.08 | 0 | 0 | 152 |
| TMPRSS4_P552_F | −0.57 | 0 | 0 | 153 |
| AIM2_E208_F | −0.63 | 0 | 0 | 154 |
| CYP2E1_P416_F | −1.11 | 0 | 0 | 155 |
| EYA4_E277_F | 1.10 | 0 | 0 | 156 |
| PGR_P790_F | −0.62 | 0 | 0 | 157 |
| PROM1_P44_R | −0.74 | 0 | 0 | 158 |
| JAK3_E64_F | 1.00 | 0 | 0 | 159 |
| MT1A_E13_R | 1.08 | 0 | 0 | 160 |
| ZIM3_P718_R | −1.08 | 0 | 0 | 161 |
| PDGFRA_P1429_F | 1.62 | 0 | 0 | 162 |
| GAS7_E148_F | 1.16 | 0 | 0 | 163 |
| LTA_P214_R | −0.59 | 0 | 0 | 164 |
| AGXT_P180_F | −0.86 | 0 | 0 | 165 |
| GAS7_P622_R | 0.93 | 0 | 0 | 166 |
| IL12B_P1453_F | −0.47 | 0 | 0 | 167 |
| NEFL_E23_R | 0.94 | 0 | 0 | 168 |
| APOC2_P377_F | −0.45 | 0 | 0 | 169 |
| OSM_P34_F | −0.72 | 0 | 0 | 170 |
| GFI1_E136_F | 1.07 | 0 | 0 | 171 |
| LCN2_P141_R | −0.88 | 0 | 0 | 172 |
| JAK3_P156_R | 0.95 | 0 | 0 | 173 |
| DSG1_P159_R | −0.79 | 0 | 0 | 174 |
| HOXC6_P456_R | 0.99 | 0 | 0 | 175 |
| MMP7_E59_F | −0.50 | 0 | 0 | 176 |
| CREBBP_P712_R | −0.74 | 0 | 0 | 177 |
| AGTR1_P41_F | 1.63 | 0 | 0 | 178 |
| AATK_E63_R | −1.09 | 0 | 0 | 179 |
| SFTPC_E13_F | −0.46 | 0 | 0 | 180 |
| FGF6_E294_F | −0.50 | 0 | 0 | 181 |
| SNRPN_seq_12_S127_F | −0.51 | 0 | 0 | 182 |
| ADCYAP1_E163_R | 0.99 | 0 | 0 | 183 |
| GNG7_P903_F | −0.52 | 0 | 0 | 184 |
| MYOD1_P50_F | 0.79 | 0 | 0 | 185 |
| WEE1_P924_R | −0.76 | 0 | 0 | 186 |
| P2RX7_P119_R | 0.88 | 0 | 0 | 187 |
| SFTPA1_P421_F | −0.60 | 0 | 0 | 188 |
| CTLA4_P1128_F | −0.59 | 0 | 0 | 189 |
| MCM2_P260_F | −0.36 | 0 | 0 | 190 |
| LCN2_P86_R | −0.74 | 0 | 0 | 191 |
| NTRK3_P752_F | 1.35 | 0 | 0 | 192 |
| PWCR1_E81_R | −1.03 | 0 | 0 | 193 |
| BLK_P14_F | −0.60 | 0 | 0 | 194 |
| TMEFF2_P152_R | 0.83 | 0 | 0 | 195 |
| GRB10_P496_R | 0.65 | 0 | 0 | 196 |
| IGFBP3_P423_R | 1.23 | 0 | 0 | 197 |
| ST6GAL1_P528_F | 1.19 | 0 | 0 | 198 |
| APBA2_P305_R | −0.66 | 0 | 0 | 199 |
| TWIST1_E117_R | 1.73 | 0 | 0 | 200 |
| PTPRO_P371_F | 0.66 | 0 | 0 | 201 |
| CALCA_P75_F | 0.96 | 0 | 0 | 202 |
| CSF1R_E26_F | −0.99 | 0 | 0 | 203 |
| TRIP6_E33_F | −0.55 | 0 | 0 | 204 |
| MC2R_E455_F | −1.29 | 0 | 0 | 205 |
| FGF3_P171_R | 1.29 | 0 | 0 | 206 |
| HOXB2_P99_F | 0.51 | 0 | 0 | 207 |
| WNT8B_E487_F | −0.54 | 0 | 0 | 208 |
| PTK6_E50_F | −0.59 | 0 | 0 | 209 |
| PTHR1_E36_R | −0.49 | 0 | 0 | 210 |
| VAV1_E9_F | −0.77 | 0 | 0 | 211 |
| IL2_P607_R | −0.66 | 0 | 0 | 212 |
| ASCL2_P360_F | 1.07 | 0 | 0 | 213 |
| MFAP4_P10_R | 0.51 | 0 | 0 | 214 |
| ITK_E166_R | −0.94 | 0 | 0 | 215 |
| IFNG_P459_R | −0.63 | 0 | 0 | 216 |
| NTRK2_P395_R | 1.56 | 0 | 0 | 217 |
| GNG7_E310_R | −0.41 | 0 | 0 | 218 |
| NTRK3_P636_R | 1.04 | 0 | 0 | 219 |
| PTPRH_P255_F | −0.90 | 0 | 0 | 220 |
| PGR_P456_R | −0.79 | 0 | 1.00E−06 | 221 |
| HTR2A_P853_F | 1.11 | 0 | 1.00E−06 | 222 |
| DBC1_E204_F | 0.69 | 0 | 1.00E−06 | 223 |
| PLA2G2A_E268_F | −0.64 | 0 | 1.00E−06 | 224 |
| PROK2_P390_F | 1.80 | 0 | 1.00E−06 | 225 |
| DES_E228_R | 0.75 | 1.00E−06 | 1.00E−06 | 226 |
| TNF_P1084_F | −0.44 | 1.00E−06 | 1.00E−06 | 227 |
| SFTPB_P689_R | −0.46 | 1.00E−06 | 1.00E−06 | 228 |
| TWIST1_P355_R | 0.77 | 1.00E−06 | 1.00E−06 | 229 |
| ATP10A_P147_F | 0.83 | 1.00E−06 | 1.00E−06 | 230 |
| DHCR24_P652_R | −0.35 | 1.00E−06 | 1.00E−06 | 231 |
| BDNF_P259_R | 0.62 | 1.00E−06 | 1.00E−06 | 232 |
| BRCA1_P835_R | −0.63 | 1.00E−06 | 1.00E−06 | 233 |
| EDNRB_P709_R | −1.21 | 1.00E−06 | 1.00E−06 | 234 |
| EPS8_E231_F | −0.23 | 1.00E−06 | 1.00E−06 | 235 |
| TRAF4_P372_F | −0.32 | 1.00E−06 | 1.00E−06 | 236 |
| MT1A_P49_R | 1.79 | 1.00E−06 | 1.00E−06 | 237 |
| NDN_P1110_F | −0.69 | 1.00E−06 | 1.00E−06 | 238 |
| AOC3_P890_R | −0.50 | 1.00E−06 | 1.00E−06 | 239 |
| PWCR1_P357_F | −0.60 | 1.00E−06 | 1.00E−06 | 240 |
| KLK11_P103_R | −0.59 | 1.00E−06 | 1.00E−06 | 241 |
| NTRK3_E131_F | 1.73 | 1.00E−06 | 1.00E−06 | 242 |
| PI3_E107_F | −0.97 | 1.00E−06 | 1.00E−06 | 243 |
| SFRP1_E398_R | 1.33 | 1.00E−06 | 1.00E−06 | 244 |
| SFTPA1_E340_R | −0.81 | 1.00E−06 | 1.00E−06 | 245 |
| CCND2_P898_R | 1.34 | 1.00E−06 | 1.00E−06 | 246 |
| MKRN3_E144_F | −1.18 | 1.00E−06 | 1.00E−06 | 247 |
| GDF10_P95_R | 0.63 | 1.00E−06 | 1.00E−06 | 248 |
| CD1A_P6_F | −0.91 | 1.00E−06 | 2.00E−06 | 249 |
| TJP2_P330_R | 1.16 | 1.00E−06 | 2.00E−06 | 250 |
| TPEF_seq_44_S36_F | 0.81 | 1.00E−06 | 2.00E−06 | 251 |
| PWCR1_P811_F | −0.78 | 1.00E−06 | 2.00E−06 | 252 |
| TWIST1_P44_R | 1.32 | 2.00E−06 | 2.00E−06 | 253 |
| ESR1_P151_R | 0.87 | 2.00E−06 | 2.00E−06 | 254 |
| GLI2_P295_F | −0.61 | 2.00E−06 | 2.00E−06 | 255 |
| EPHB1_E202_R | −0.36 | 2.00E−06 | 2.00E−06 | 256 |
| CCL3_P543_R | −0.75 | 2.00E−06 | 2.00E−06 | 257 |
| GABRB3_P92_F | 0.48 | 2.00E−06 | 2.00E−06 | 258 |
| BLK_P668_R | −0.58 | 2.00E−06 | 2.00E−06 | 259 |
| GABRB3_E42_F | 0.84 | 2.00E−06 | 2.00E−06 | 260 |
| ITGB4_P517_F | −0.31 | 2.00E−06 | 2.00E−06 | 261 |
| SPARC_E50_R | 0.41 | 2.00E−06 | 2.00E−06 | 262 |
| EPO_E244_R | 1.04 | 2.00E−06 | 2.00E−06 | 263 |
| NPY_P91_F | 0.94 | 2.00E−06 | 2.00E−06 | 264 |
| TFF2_P557_R | −0.53 | 2.00E−06 | 2.00E−06 | 265 |
| MAS1_P469_R | −0.54 | 2.00E−06 | 2.00E−06 | 266 |
| GDF10_E39_F | 0.29 | 2.00E−06 | 3.00E−06 | 267 |
| IHH_E186_F | 0.95 | 2.00E−06 | 3.00E−06 | 268 |
| CCND2_P887_F | 1.50 | 2.00E−06 | 3.00E−06 | 269 |
| PAX6_E129_F | 0.88 | 2.00E−06 | 3.00E−06 | 270 |
| CD1A_P414_R | −0.71 | 3.00E−06 | 3.00E−06 | 271 |
| IL1RN_P93_R | −0.53 | 3.00E−06 | 3.00E−06 | 272 |
| IL12B_E25_F | −0.69 | 3.00E−06 | 3.00E−06 | 273 |
| TNFSF10_E53_F | −0.55 | 3.00E−06 | 3.00E−06 | 274 |
| MAPK4_E273_R | −0.58 | 3.00E−06 | 3.00E−06 | 275 |
| LEFTY2_P561_F | 0.44 | 3.00E−06 | 3.00E−06 | 276 |
| EGF_P413_F | −0.73 | 3.00E−06 | 3.00E−06 | 277 |
| APC_E117_R | 0.67 | 3.00E−06 | 3.00E−06 | 278 |
| OSM_P188_F | −0.85 | 3.00E−06 | 4.00E−06 | 279 |
| CSF1R_P73_F | −0.40 | 3.00E−06 | 4.00E−06 | 280 |
| LCK_E28_F | −0.39 | 3.00E−06 | 4.00E−06 | 281 |
| MEST_P62_R | −0.64 | 4.00E−06 | 4.00E−06 | 282 |
| PRSS8_E134_R | −0.65 | 4.00E−06 | 4.00E−06 | 283 |
| FRZB_P406_F | 1.33 | 4.00E−06 | 4.00E−06 | 284 |
| ISL1_P379_F | 0.87 | 4.00E−06 | 4.00E−06 | 285 |
| HS3ST2_P546_F | 0.41 | 4.00E−06 | 4.00E−06 | 286 |
| IL18BP_P51_R | 0.55 | 4.00E−06 | 4.00E−06 | 287 |
| MEST_E150_F | −0.66 | 4.00E−06 | 5.00E−06 | 288 |
| TNFRSF10C_P612_R | −0.34 | 5.00E−06 | 5.00E−06 | 289 |
| INS_P248_F | −0.65 | 5.00E−06 | 5.00E−06 | 290 |
| SFRP1_P157_F | 1.01 | 5.00E−06 | 5.00E−06 | 291 |
| KRT5_E196_R | −0.90 | 6.00E−06 | 6.00E−06 | 292 |
| CALCA_P171_F | 0.46 | 6.00E−06 | 6.00E−06 | 293 |
| TRPM5_E87_F | −0.74 | 6.00E−06 | 6.00E−06 | 294 |
| HLA-DQA2_E93_F | −0.39 | 6.00E−06 | 6.00E−06 | 295 |
| RUNX3_P247_F | −0.59 | 6.00E−06 | 6.00E−06 | 296 |
| RASSF1_P244_F | 1.61 | 6.00E−06 | 6.00E−06 | 297 |
| AGXT_E115_R | −0.83 | 6.00E−06 | 6.00E−06 | 298 |
| EPHA5_E158_R | 0.96 | 6.00E−06 | 6.00E−06 | 299 |
| MYB_P673_R | −0.20 | 7.00E−06 | 7.00E−06 | 300 |
| AFP_P824_F | −0.54 | 7.00E−06 | 7.00E−06 | 301 |
| RHOH_P953_R | −0.47 | 7.00E−06 | 7.00E−06 | 302 |
| MBD2_P233_F | −0.40 | 7.00E−06 | 7.00E−06 | 303 |
| ZNFN1A1_E102_F | −0.53 | 7.00E−06 | 7.00E−06 | 304 |
| HOXA11_P92_R | 0.93 | 8.00E−06 | 8.00E−06 | 305 |
| TDGF1_P428_R | −0.37 | 8.00E−06 | 8.00E−06 | 306 |
| PADI4_E24_F | −0.70 | 8.00E−06 | 8.00E−06 | 307 |
| DSP_P36_F | −0.32 | 9.00E−06 | 9.00E−06 | 308 |
| ALK_P28_F | −0.57 | 9.00E−06 | 9.00E−06 | 309 |
| NBL1_E205_R | −0.59 | 9.00E−06 | 9.00E−06 | 310 |
| FGF3_E198_R | 1.33 | 9.00E−06 | 9.00E−06 | 311 |
| OPCML_E219_R | 0.91 | 9.00E−06 | 9.00E−06 | 312 |
| MKRN3_P108_F | −0.75 | 1.00E−05 | 9.00E−06 | 313 |
| FLT4_P180_R | 0.96 | 1.00E−05 | 9.00E−06 | 314 |
| GALR1_P80_F | 0.65 | 1.00E−05 | 1.00E−05 | 315 |
| FGF8_P473_F | 0.79 | 1.00E−05 | 1.00E−05 | 316 |
| HTR1B_P107_F | 0.33 | 1.10E−05 | 1.00E−05 | 317 |
| DSC2_P407_R | −0.64 | 1.10E−05 | 1.00E−05 | 318 |
| PMP22_P975_F | −0.65 | 1.10E−05 | 1.00E−05 | 319 |
| B3GALT5_E246_R | −0.53 | 1.10E−05 | 1.00E−05 | 320 |
| ZIM2_P22_F | 0.38 | 1.10E−05 | 1.00E−05 | 321 |
| FGFR4_P610_F | −0.47 | 1.10E−05 | 1.00E−05 | 322 |
| CDKN1C_P626_F | 0.62 | 1.20E−05 | 1.10E−05 | 323 |
| HIC2_P498_F | 1.01 | 1.20E−05 | 1.10E−05 | 324 |
| RASSF1_E116_F | 1.40 | 1.20E−05 | 1.10E−05 | 325 |
| TDGF1_E53_R | −0.41 | 1.20E−05 | 1.20E−05 | 326 |
| MMP8_E89_R | −0.80 | 1.30E−05 | 1.20E−05 | 327 |
| TBX1_P885_R | 0.87 | 1.30E−05 | 1.20E−05 | 328 |
| HPSE_P29_F | −0.25 | 1.30E−05 | 1.20E−05 | 329 |
| MYH11_P22_F | 1.11 | 1.30E−05 | 1.20E−05 | 330 |
| KDR_P445_R | 1.13 | 1.40E−05 | 1.30E−05 | 331 |
| DSG1_E292_F | −0.39 | 1.50E−05 | 1.30E−05 | 332 |
| HOXB13_P17_R | 0.69 | 1.50E−05 | 1.40E−05 | 333 |
| TNFSF8_E258_R | −0.60 | 1.60E−05 | 1.40E−05 | 334 |
| SPDEF_E116_R | −0.47 | 1.60E−05 | 1.40E−05 | 335 |
| ABCB4_E429_F | −0.40 | 1.70E−05 | 1.50E−05 | 336 |
| FLI1_E29_F | 0.64 | 1.70E−05 | 1.50E−05 | 337 |
| EDNRB_P148_R | −0.75 | 1.70E−05 | 1.60E−05 | 338 |
| HLA-DOB_P357_R | −0.32 | 1.80E−05 | 1.60E−05 | 339 |
| HSPA2_P162_R | −0.48 | 1.90E−05 | 1.70E−05 | 340 |
| ZIM3_P451_R | −0.69 | 1.90E−05 | 1.70E−05 | 341 |
| EGF_E339_F | −0.69 | 1.90E−05 | 1.70E−05 | 342 |
| PDGFRB_E195_R | 0.65 | 2.00E−05 | 1.70E−05 | 343 |
| MMP1_P460_F | −0.57 | 2.00E−05 | 1.70E−05 | 344 |
| ABCB4_P51_F | −0.46 | 2.00E−05 | 1.70E−05 | 345 |
| TCF4_P317_F | 0.82 | 2.00E−05 | 1.80E−05 | 346 |
| NCL_P1102_F | −0.72 | 2.10E−05 | 1.80E−05 | 347 |
| MAS1_P657_R | −0.47 | 2.20E−05 | 1.90E−05 | 348 |
| SMO_P455_R | 1.00 | 2.20E−05 | 1.90E−05 | 349 |
| GFAP_P56_R | −0.44 | 2.30E−05 | 2.00E−05 | 350 |
| TDG_E129_F | −0.53 | 2.60E−05 | 2.20E−05 | 351 |
| MMP1_P397_R | −0.47 | 2.70E−05 | 2.30E−05 | 352 |
| CFTR_P372_R | 0.51 | 2.70E−05 | 2.30E−05 | 353 |
| GUCY2D_E419_R | 1.13 | 2.70E−05 | 2.30E−05 | 354 |
| PTHR1_P258_F | −0.40 | 2.80E−05 | 2.30E−05 | 355 |
| MMP2_P197_F | 0.78 | 2.80E−05 | 2.30E−05 | 356 |
| TFDP1_P543_R | −0.29 | 2.80E−05 | 2.40E−05 | 357 |
| IFNG_P188_F | −0.64 | 2.90E−05 | 2.50E−05 | 358 |
| CDK10_P199_R | −0.35 | 2.90E−05 | 2.50E−05 | 359 |
| FES_P223_R | 0.86 | 3.00E−05 | 2.50E−05 | 360 |
| TES_P182_F | −0.33 | 3.00E−05 | 2.50E−05 | 361 |
| EYA4_P508_F | 0.51 | 3.00E−05 | 2.50E−05 | 362 |
| IGFBP2_P306_F | 0.92 | 3.00E−05 | 2.50E−05 | 363 |
| AFF3_P808_F | −0.84 | 3.00E−05 | 2.50E−05 | 364 |
| MLH3_P25_F | −0.22 | 3.00E−05 | 2.50E−05 | 365 |
| FRK_P258_F | −0.57 | 3.10E−05 | 2.60E−05 | 366 |
| WNT2_P217_F | 0.78 | 3.20E−05 | 2.60E−05 | 367 |
| RIPK3_P124_F | −0.48 | 3.20E−05 | 2.60E−05 | 368 |
| NGFR_P355_F | 0.51 | 3.20E−05 | 2.60E−05 | 369 |
| SRC_P164_F | −0.43 | 3.50E−05 | 2.80E−05 | 370 |
| PRDM2_P1340_R | −0.42 | 3.70E−05 | 3.00E−05 | 371 |
| p16_seq_47_S188_R | 1.53 | 3.80E−05 | 3.10E−05 | 372 |
| KIAA0125_E29_F | −0.60 | 3.90E−05 | 3.10E−05 | 373 |
| IL8_P83_F | −0.60 | 4.10E−05 | 3.30E−05 | 374 |
| ZNF215_P129_R | 0.71 | 4.60E−05 | 3.70E−05 | 375 |
| H19_P1411_R | −0.57 | 4.70E−05 | 3.70E−05 | 376 |
| RAN_P581_R | −0.48 | 4.80E−05 | 3.80E−05 | 377 |
| IL10_P85_F | −0.61 | 5.00E−05 | 4.00E−05 | 378 |
| MYH11_P236_R | 1.12 | 5.10E−05 | 4.10E−05 | 379 |
| NOS2A_P288_R | −0.49 | 5.40E−05 | 4.30E−05 | 380 |
| SERPINA5_E69_F | −0.42 | 5.50E−05 | 4.30E−05 | 381 |
| TAL1_P817_F | 0.51 | 5.60E−05 | 4.40E−05 | 382 |
| RUNX3_P393_R | −0.50 | 5.60E−05 | 4.40E−05 | 383 |
| THBS2_E129_F | 0.91 | 5.80E−05 | 4.50E−05 | 384 |
| E2F5_P516_R | −0.44 | 5.80E−05 | 4.60E−05 | 385 |
| GPATC3_P410_R | −0.57 | 6.00E−05 | 4.60E−05 | 386 |
| PEG3_E496_F | 0.30 | 6.00E−05 | 4.60E−05 | 387 |
| SNRPN_seq_18_S99_F | −0.33 | 6.10E−05 | 4.80E−05 | 388 |
| FGFR1_P204_F | 0.62 | 6.20E−05 | 4.80E−05 | 389 |
| TERT_E20_F | 0.71 | 6.40E−05 | 4.90E−05 | 390 |
| GATA6_P726_F | 0.83 | 6.60E−05 | 5.10E−05 | 391 |
| GADD45A_P737_R | −0.36 | 6.70E−05 | 5.10E−05 | 392 |
| ZIM2_E110_F | 0.28 | 6.80E−05 | 5.20E−05 | 393 |
| NRG1_P558_R | 0.51 | 7.30E−05 | 5.50E−05 | 394 |
| HOXA5_E187_F | 0.57 | 7.30E−05 | 5.50E−05 | 395 |
| IAPP_E280_F | −0.50 | 7.30E−05 | 5.50E−05 | 396 |
| SPP1_E140_R | −0.44 | 7.80E−05 | 5.90E−05 | 397 |
| CDH1_P52_R | 0.33 | 7.80E−05 | 5.90E−05 | 398 |
| GLI2_E90_F | −0.73 | 7.90E−05 | 6.00E−05 | 399 |
| ABCC2_P88_F | −0.70 | 8.00E−05 | 6.00E−05 | 400 |
| MAGEL2_P170_R | −0.62 | 8.10E−05 | 6.10E−05 | 401 |
| PGR_E183_R | −0.52 | 8.30E−05 | 6.20E−05 | 402 |
| SNRPN_P230_R | −0.41 | 8.30E−05 | 6.20E−05 | 403 |
| DDR1_E23_R | −0.29 | 8.30E−05 | 6.20E−05 | 404 |
| MAGEL2_E166_R | −0.71 | 8.40E−05 | 6.30E−05 | 405 |
| USP29_P205_R | −0.36 | 8.60E−05 | 6.30E−05 | 406 |
| RIPK2_E123_F | −0.19 | 8.60E−05 | 6.40E−05 | 407 |
| USP29_P282_R | −0.31 | 8.80E−05 | 6.50E−05 | 408 |
| SEPT5_P441_F | 0.53 | 9.50E−05 | 7.00E−05 | 409 |
| DDB2_P407_F | −0.22 | 0.000104 | 7.60E−05 | 410 |
| ISL1_P554_F | 0.66 | 0.000106 | 7.70E−05 | 411 |
| SPI1_E205_F | −0.29 | 0.000108 | 7.90E−05 | 412 |
| COL1A2_E299_F | 1.12 | 0.000109 | 7.90E−05 | 413 |
| EVI2A_P94_R | −0.69 | 0.000109 | 7.90E−05 | 414 |
| DES_P1006_R | −0.42 | 0.000109 | 7.90E−05 | 415 |
| TGFB2_E226_R | 0.68 | 0.000109 | 7.90E−05 | 416 |
| CDH11_P203_R | 0.71 | 0.000115 | 8.30E−05 | 417 |
| BDNF_E19_R | 0.50 | 0.000115 | 8.30E−05 | 418 |
| FGF9_P1404_F | −0.19 | 0.000117 | 8.40E−05 | 419 |
| PTHLH_P15_R | −0.51 | 0.000124 | 8.90E−05 | 420 |
| BCL2A1_P1127_R | −0.61 | 0.000125 | 9.00E−05 | 421 |
| DNMT1_P100_R | −0.26 | 0.000126 | 9.00E−05 | 422 |
| DNAJC15_E26_R | 0.48 | 0.000132 | 9.40E−05 | 423 |
| MALT1_P406_R | −0.27 | 0.000135 | 9.60E−05 | 424 |
| FGR_P39_F | −0.51 | 0.000137 | 9.70E−05 | 425 |
| HBII-52_P659_F | −0.69 | 0.000142 | 1.00E−04 | 426 |
| EPM2A_P113_F | −0.30 | 0.000147 | 0.000103 | 427 |
| PPARG_P693_F | −0.39 | 0.000151 | 0.000106 | 428 |
| ETS2_P684_F | −0.28 | 0.000151 | 0.000106 | 429 |
| ZP3_P220_F | −0.48 | 0.000152 | 0.000106 | 430 |
| NTRK2_P10_F | 1.18 | 0.000153 | 0.000107 | 431 |
| FGF12_P210_R | 0.98 | 0.000154 | 0.000107 | 432 |
| MUSK_P308_F | −0.41 | 0.000157 | 0.000109 | 433 |
| HOXB2_P488_R | 0.54 | 0.000163 | 0.000113 | 434 |
| IRAK3_P185_F | 0.42 | 0.000164 | 0.000113 | 435 |
| COL1A2_P48_R | 1.05 | 0.00017 | 0.000117 | 436 |
| ELL_P693_F | −0.38 | 0.000171 | 0.000118 | 437 |
| MFAP4_P197_F | 0.52 | 0.000174 | 0.000119 | 438 |
| SIN3B_P514_R | −0.51 | 0.000193 | 0.000132 | 439 |
| APC_P280_R | 0.91 | 0.000193 | 0.000132 | 440 |
| SEZ6L_P249_F | 0.92 | 0.000201 | 0.000137 | 441 |
| LMO2_E148_F | −0.74 | 0.000204 | 0.000139 | 442 |
| LTA_E28_R | −0.66 | 0.000208 | 0.000141 | 443 |
| MAPK10_E26_F | −0.63 | 0.000208 | 0.000141 | 444 |
| SPDEF_P6_R | −0.37 | 0.00023 | 0.000155 | 445 |
| FGFR2_P266_R | −0.22 | 0.00024 | 0.000161 | 446 |
| MMP9_P189_F | −0.48 | 0.00024 | 0.000161 | 447 |
| KRT13_P676_F | 0.37 | 0.000241 | 0.000162 | 448 |
| IL12B_P392_R | −0.69 | 0.000249 | 0.000167 | 449 |
| TRPM5_P979_F | −0.55 | 0.000253 | 0.000169 | 450 |
| GJB2_P931_R | 0.49 | 0.000257 | 0.000171 | 451 |
| MYLK_E132_R | −0.26 | 0.000263 | 0.000175 | 452 |
| ARHGAP9_P260_F | −0.50 | 0.000265 | 0.000176 | 453 |
| MMP9_E88_R | −0.48 | 0.000287 | 0.00019 | 454 |
| HOXC6_P585_R | 0.47 | 0.000288 | 0.00019 | 455 |
| PXN_P308_F | 0.26 | 0.000296 | 0.000195 | 456 |
| IMPACT_P186_F | 0.25 | 0.000327 | 0.000215 | 457 |
| TFF1_P180_R | −0.48 | 0.000328 | 0.000215 | 458 |
| COL1A2_P407_R | 0.36 | 0.000329 | 0.000216 | 459 |
| ZIM3_E203_F | −0.50 | 0.000332 | 0.000217 | 460 |
| THPO_E483_F | −0.59 | 0.000333 | 0.000217 | 461 |
| TMEFF2_E94_R | 0.74 | 0.000333 | 0.000217 | 462 |
| ZNF264_P397_F | 0.34 | 0.00034 | 0.000221 | 463 |
| CSF3R_P8_F | 0.50 | 0.000346 | 0.000224 | 464 |
| SLC22A3_E122_R | 0.66 | 0.000369 | 0.000239 | 465 |
| TESK2_P252_R | 0.21 | 0.000375 | 0.000242 | 466 |
| SCGB3A1_E55_R | 0.61 | 0.000377 | 0.000243 | 467 |
| THBS1_P500_F | −0.21 | 0.000403 | 0.000259 | 468 |
| RET_seq_53_S374_F | 0.89 | 0.000411 | 0.000263 | 469 |
| IL18BP_E285_F | 0.31 | 0.000412 | 0.000263 | 470 |
| MMP3_P16_R | −0.69 | 0.000425 | 0.000271 | 471 |
| IRAK3_P13_F | 1.29 | 0.000426 | 0.000271 | 472 |
| PLAGL1_P334_F | −0.34 | 0.000432 | 0.000275 | 473 |
| FLT3_P302_F | 0.80 | 0.000443 | 0.00028 | 474 |
| CCKAR_P270_F | −0.48 | 0.000443 | 0.00028 | 475 |
| SMAD2_P848_R | −0.24 | 0.000448 | 0.000283 | 476 |
| HHIP_P578_R | 0.40 | 0.000451 | 0.000284 | 477 |
| MPO_E302_R | −0.34 | 0.000463 | 0.000291 | 478 |
| FANCA_P1006_R | −0.64 | 0.000492 | 0.000309 | 479 |
| MAP3K1_P7_F | −0.26 | 0.000493 | 0.000309 | 480 |
| LMO2_P794_R | −0.61 | 0.000516 | 0.000322 | 481 |
| TNFRSF1B_E5_F | 0.42 | 0.00052 | 0.000325 | 482 |
| PADI4_P1011_R | −0.37 | 0.000521 | 0.000325 | 483 |
| TRIP6_P1090_F | −0.50 | 0.000524 | 0.000325 | 484 |
| CCKBR_P480_F | 0.88 | 0.000524 | 0.000325 | 485 |
| SMO_E57_F | 0.75 | 0.000528 | 0.000327 | 486 |
| DNAJC15_P65_F | −0.55 | 0.000537 | 0.000332 | 487 |
| IGF2_P36_R | 0.37 | 0.00055 | 0.000339 | 488 |
| SERPINB2_P939_F | −0.53 | 0.000558 | 0.000343 | 489 |
| IRAK3_E130_F | 1.07 | 0.000593 | 0.000364 | 490 |
| LIF_P383_R | −0.30 | 0.000606 | 0.000371 | 491 |
| ABCB4_P892_F | −0.62 | 0.000612 | 0.000374 | 492 |
| SPI1_P48_F | −0.68 | 0.000621 | 0.000379 | 493 |
| WNT10B_P823_R | 0.51 | 0.000626 | 0.000381 | 494 |
| SOD3_P225_F | −0.35 | 0.000631 | 0.000383 | 495 |
| ACVR1_P983_F | −0.46 | 0.000633 | 0.000384 | 496 |
| RAD54B_P227_F | −0.25 | 0.000634 | 0.000384 | 497 |
| ZNFN1A1_P179_F | −0.56 | 0.000648 | 0.000391 | 498 |
| PLG_P370_F | −0.30 | 0.00065 | 0.000391 | 499 |
| HTR2A_E10_R | −0.48 | 0.00065 | 0.000391 | 500 |
| HLA-DPB1_P540_F | −0.47 | 0.000654 | 0.000393 | 501 |
| TMEFF2_P210_R | 0.42 | 0.000659 | 0.000395 | 502 |
| TUSC3_E29_R | 0.42 | 0.000684 | 0.000409 | 503 |
| CCND1_E280_R | −0.19 | 0.000685 | 0.000409 | 504 |
| SEZ6L_P299_F | 0.74 | 0.00072 | 0.000429 | 505 |
| HCK_P46_R | 0.67 | 0.000769 | 0.000457 | 506 |
| THBS1_E207_R | 0.29 | 0.000776 | 0.00046 | 507 |
| HDAC11_P556_F | 0.12 | 0.00079 | 0.000467 | 508 |
| TIMP3_P1114_R | −0.40 | 0.000798 | 0.000471 | 509 |
| DSC2_E90_F | −0.36 | 0.000813 | 0.000479 | 510 |
| ABCC2_E16_R | −0.54 | 0.000819 | 0.000482 | 511 |
| ACVR1C_P115_R | −0.21 | 0.000881 | 0.000517 | 512 |
| TES_E172_F | −0.28 | 0.000901 | 0.000528 | 513 |
| CFTR_P115_F | 0.79 | 0.00091 | 0.000532 | 514 |
| IL13_E75_R | −0.37 | 0.000912 | 0.000532 | 515 |
| PROK2_E0_F | 0.42 | 0.000918 | 0.000535 | 516 |
| PTCH2_E173_F | −0.25 | 0.000946 | 0.00055 | 517 |
| S100A12_P1221_R | −0.38 | 0.000967 | 0.000561 | 518 |
| VAMP8_P241_F | −0.35 | 0.000978 | 0.000566 | 519 |
| KLK11_P1290_F | −0.37 | 0.000992 | 0.000574 | 520 |
| SHB_P691_R | −0.27 | 0.001004 | 0.000579 | 521 |
| PCDH1_E22_F | 0.11 | 0.001009 | 0.000581 | 522 |
| DLC1_P88_R | −0.35 | 0.001019 | 0.000586 | 523 |
| PARP1_P610_R | −0.37 | 0.001025 | 0.000589 | 524 |
| FGF12_E61_R | 0.60 | 0.001056 | 0.000605 | 525 |
| CTLA4_E176_R | −0.39 | 0.001072 | 0.000612 | 526 |
| FGF7_P44_F | −0.50 | 0.001073 | 0.000612 | 527 |
| IGF1R_E186_R | 0.42 | 0.001076 | 0.000612 | 528 |
| POMC_P53_F | 0.91 | 0.001077 | 0.000612 | 529 |
| MMP10_E136_R | −0.36 | 0.001116 | 0.000633 | 530 |
| ARHGAP9_P518_R | −0.36 | 0.001123 | 0.000636 | 531 |
| FGF1_E5_F | −0.39 | 0.001146 | 0.000648 | 532 |
| DAB2_P468_F | 1.17 | 0.001156 | 0.000652 | 533 |
| BMP2_E48_R | 0.49 | 0.00116 | 0.000653 | 534 |
| CTSD_P726_F | −0.32 | 0.001165 | 0.000655 | 535 |
| HBII-13_E48_F | −0.41 | 0.001194 | 0.000669 | 536 |
| MLLT3_E93_R | 0.12 | 0.001195 | 0.000669 | 537 |
| TNFRSF10C_P7_F | 0.60 | 0.001232 | 0.000688 | 538 |
| LYN_E353_F | −0.24 | 0.00124 | 0.000692 | 539 |
| CRIP1_P874_R | 0.46 | 0.001252 | 0.000697 | 540 |
| RAD50_P191_F | −0.37 | 0.001311 | 0.000729 | 541 |
| ACTG2_P455_R | −0.27 | 0.001317 | 0.000731 | 542 |
| PALM2-AKAP2_P420_R | 0.39 | 0.001331 | 0.000737 | 543 |
| FGF1_P357_R | −0.42 | 0.001387 | 0.000767 | 544 |
| MSH3_E3_F | −0.46 | 0.001397 | 0.000771 | 545 |
| EPHA5_P66_F | 0.31 | 0.0014 | 0.000771 | 546 |
| JAG1_P66_F | −0.22 | 0.001423 | 0.000782 | 547 |
| TP73_P945_F | 0.49 | 0.001448 | 0.000795 | 548 |
| CEACAM1_P44_R | −0.35 | 0.001472 | 0.000806 | 549 |
| HLA-DRA_P77_R | −0.36 | 0.001485 | 0.000812 | 550 |
| PRKCDBP_E206_F | 0.98 | 0.001528 | 0.000832 | 551 |
| ERCC6_P698_R | −0.17 | 0.001528 | 0.000832 | 552 |
| GABRA5_E44_R | −0.30 | 0.001536 | 0.000835 | 553 |
| TMEFF1_P626_R | −0.24 | 0.00154 | 0.000836 | 554 |
| WNT1_P79_R | 0.48 | 0.001545 | 0.000837 | 555 |
| GPX1_P194_F | 0.49 | 0.001559 | 0.000842 | 556 |
| UGT1A7_P751_R | −0.28 | 0.00156 | 0.000842 | 557 |
| NOTCH1_E452_R | 0.21 | 0.001562 | 0.000842 | 558 |
| PITX2_P183_R | 0.33 | 0.001596 | 0.000859 | 559 |
| EGF_P242_R | −0.40 | 0.001637 | 0.000879 | 560 |
| MCM6_E136_F | −0.21 | 0.001663 | 0.000891 | 561 |
| CHD2_P667_F | −0.30 | 0.001683 | 0.000901 | 562 |
| NKX3-1_P871_R | −0.49 | 0.001712 | 0.000914 | 563 |
| FGF5_E16_F | 0.56 | 0.001725 | 0.00092 | 564 |
| DAB2_P35_F | 0.89 | 0.001735 | 0.000923 | 565 |
| CPA4_P1265_R | −0.19 | 0.001751 | 0.00093 | 566 |
| ERCC1_P354_F | 0.13 | 0.001779 | 0.000943 | 567 |
| WNT8B_P216_R | −0.24 | 0.001878 | 0.000994 | 568 |
| MMP2_E21_R | 0.55 | 0.001883 | 0.000995 | 569 |
| EPHA3_P106_R | 0.56 | 0.001901 | 0.001003 | 570 |
| AATK_P709_R | −0.40 | 0.001933 | 0.001018 | 571 |
| SEMA3C_P642_F | −0.32 | 0.002005 | 0.001054 | 572 |
| PHLDA2_E159_R | 0.14 | 0.002031 | 0.001066 | 573 |
| MAF_P826_R | 0.81 | 0.002046 | 0.001072 | 574 |
| PYCARD_E87_F | 1.08 | 0.002076 | 0.001086 | 575 |
| CYP2E1_E53_R | −0.44 | 0.002098 | 0.001095 | 576 |
| ABCG2_P310_R | 1.31 | 0.002107 | 0.001098 | 577 |
| WNT10B_P993_F | 0.40 | 0.002119 | 0.001101 | 578 |
| LAT_E46_F | −0.37 | 0.00212 | 0.001101 | 579 |
| ASCL2_P609_R | 0.39 | 0.002186 | 0.001133 | 580 |
| JAK3_P1075_R | −0.38 | 0.002218 | 0.001147 | 581 |
| IGSF4C_E65_F | −0.22 | 0.00222 | 0.001147 | 582 |
| TNFRSF10D_P70_F | 0.68 | 0.002236 | 0.001154 | 583 |
| SHH_E328_F | 0.34 | 0.002257 | 0.001162 | 584 |
| KRAS_E82_F | −0.22 | 0.002278 | 0.00117 | 585 |
| ZNF215_P71_R | 0.29 | 0.00228 | 0.00117 | 586 |
| IGF2_P1036_R | 0.25 | 0.00235 | 0.001204 | 587 |
| EGR4_E70_F | −0.18 | 0.00237 | 0.001212 | 588 |
| B3GALT5_P330_F | −0.27 | 0.002378 | 0.001214 | 589 |
| FLI1_P620_R | 0.48 | 0.002432 | 0.00124 | 590 |
| SLC22A2_E271_R | −0.62 | 0.002446 | 0.001245 | 591 |
| HGF_P1293_R | −0.65 | 0.002471 | 0.001255 | 592 |
| TM7SF3_P1068_R | −0.53 | 0.002522 | 0.001279 | 593 |
| CCKBR_P361_R | 0.34 | 0.002563 | 0.001297 | 594 |
| EPHB1_P503_F | 0.54 | 0.002588 | 0.001308 | 595 |
| PDGFA_P78_F | −0.17 | 0.002603 | 0.001312 | 596 |
| HIC2_P528_R | 0.44 | 0.002605 | 0.001312 | 597 |
| ETV1_P235_F | 0.59 | 0.002627 | 0.001321 | 598 |
| NPY_E31_R | 0.30 | 0.002638 | 0.001324 | 599 |
| MAPK12_P416_F | 0.53 | 0.002649 | 0.001327 | 600 |
| EVI2A_E420_F | −0.35 | 0.002652 | 0.001327 | 601 |
| GSTM2_E153_F | 0.57 | 0.00276 | 0.001378 | 602 |
| TNFRSF10C_E109_F | 0.74 | 0.002793 | 0.001393 | 603 |
| CREB1_P819_F | −0.40 | 0.0028 | 0.001394 | 604 |
| LIG3_P622_R | −0.34 | 0.002914 | 0.001449 | 605 |
| EPHB4_E476_R | −0.23 | 0.002948 | 0.001462 | 606 |
| SLC5A8_P38_R | 0.36 | 0.002951 | 0.001462 | 607 |
| MMP19_P306_F | −0.40 | 0.002972 | 0.00147 | 608 |
| FASTK_P257_F | −0.22 | 0.002998 | 0.00148 | 609 |
| FES_E34_R | 0.45 | 0.003052 | 0.001505 | 610 |
| ALPL_P433_F | 0.30 | 0.003132 | 0.001541 | 611 |
| RET_P717_F | 0.29 | 0.003244 | 0.001594 | 612 |
| MAP3K1_E81_F | −0.29 | 0.003287 | 0.001612 | 613 |
| LYN_P241_F | 0.23 | 0.003391 | 0.001661 | 614 |
| EPS8_P437_F | −0.21 | 0.003414 | 0.00167 | 615 |
| S100A2_E36_R | −0.34 | 0.003438 | 0.001678 | 616 |
| RASGRF1_E16_F | 0.47 | 0.003459 | 0.001686 | 617 |
| DAPK1_P345_R | 0.36 | 0.003534 | 0.00172 | 618 |
| RIPK3_P24_F | −0.38 | 0.003628 | 0.001762 | 619 |
| NES_P239_R | 0.40 | 0.003855 | 0.00187 | 620 |
| PAX6_P1121_F | 0.62 | 0.00389 | 0.001884 | 621 |
| COL4A3_E205_R | 0.42 | 0.003961 | 0.001915 | 622 |
| CCNA1_E7_F | 0.73 | 0.003977 | 0.00192 | 623 |
| EPHA1_E46_R | −0.49 | 0.004013 | 0.001934 | 624 |
| APBA2_P227_F | −0.44 | 0.004082 | 0.001964 | 625 |
| FGF7_P610_F | −0.25 | 0.004143 | 0.00199 | 626 |
| POMC_E254_F | 0.26 | 0.004156 | 0.00199 | 627 |
| CD9_P585_R | −0.37 | 0.004156 | 0.00199 | 628 |
| RHOH_P121_F | −0.47 | 0.004166 | 0.001992 | 629 |
| CDC25B_P11_R | 1.14 | 0.004195 | 0.002002 | 630 |
| ZP3_E90_F | 0.76 | 0.004202 | 0.002003 | 631 |
| IL3_P556_F | −0.23 | 0.004233 | 0.002014 | 632 |
| MCC_P196_R | 0.14 | 0.004247 | 0.002017 | 633 |
| NCL_P840_R | −0.19 | 0.004299 | 0.002039 | 634 |
| PSCA_P135_F | −0.28 | 0.004314 | 0.002043 | 635 |
| RBP1_E158_F | 0.93 | 0.004376 | 0.002069 | 636 |
| FABP3_E113_F | 0.45 | 0.004423 | 0.002088 | 637 |
| DIO3_P90_F | 0.18 | 0.00445 | 0.002097 | 638 |
| ADAMTS12_P250_R | 0.74 | 0.004465 | 0.002101 | 639 |
| UGT1A1_P315_R | −0.29 | 0.004533 | 0.002128 | 640 |
| TFF2_P178_F | −0.36 | 0.004536 | 0.002128 | 641 |
| HDAC9_E38_F | 0.54 | 0.004567 | 0.002139 | 642 |
| ALOX12_E85_R | −0.46 | 0.004585 | 0.002144 | 643 |
| ASCL1_P747_F | 0.28 | 0.004643 | 0.002168 | 644 |
| UGT1A1_E11_F | −0.45 | 0.004771 | 0.002224 | 645 |
| TYK2_P494_F | −0.28 | 0.004867 | 0.002265 | 646 |
| C4B_P191_F | −0.36 | 0.004898 | 0.002274 | 647 |
| EFNB3_E17_R | 0.13 | 0.0049 | 0.002274 | 648 |
| HLA-DOB_P1114_R | −0.29 | 0.004911 | 0.002275 | 649 |
| NRG1_E74_F | 0.24 | 0.004932 | 0.002282 | 650 |
| CDH17_P532_F | −0.26 | 0.004941 | 0.002282 | 651 |
| CDKN2B_E220_F | 0.14 | 0.005065 | 0.002334 | 652 |
| PTPRO_E56_F | 0.92 | 0.005069 | 0.002334 | 653 |
| CHFR_P635_R | 0.40 | 0.005146 | 0.002366 | 654 |
| TGFBR3_P429_F | 0.39 | 0.005172 | 0.002372 | 655 |
| TUBB3_P364_F | 0.11 | 0.005175 | 0.002372 | 656 |
| CD40_E58_R | 0.62 | 0.005263 | 0.002409 | 657 |
| FLT1_E444_F | 0.58 | 0.005304 | 0.002424 | 658 |
| CRIP1_P274_F | −0.22 | 0.005319 | 0.002427 | 659 |
| EPHB3_E0_F | −0.33 | 0.005381 | 0.002452 | 660 |
| THY1_P20_R | −0.16 | 0.005698 | 0.002592 | 661 |
| SNURF_P2_R | −0.21 | 0.005729 | 0.002602 | 662 |
| IL4_P262_R | −0.23 | 0.005811 | 0.002636 | 663 |
| PMP22_P1254_F | −0.23 | 0.005954 | 0.002697 | 664 |
| TIMP3_seq_7_S38_F | 0.54 | 0.006101 | 0.002755 | 665 |
| GSTM2_P109_R | 0.58 | 0.006102 | 0.002755 | 666 |
| PTCH2_P568_R | 0.24 | 0.006579 | 0.002963 | 667 |
| HOXA5_P479_F | 0.33 | 0.006581 | 0.002963 | 668 |
| MAPK9_P1175_F | −0.39 | 0.006629 | 0.00298 | 669 |
| KDR_E79_F | 0.49 | 0.006779 | 0.003043 | 670 |
| RET_seq_54_S260_F | 0.62 | 0.006835 | 0.003063 | 671 |
| PECAM1_E32_R | 0.33 | 0.006848 | 0.003065 | 672 |
| PDGFRB_P343_F | 0.68 | 0.006889 | 0.003077 | 673 |
| NOTCH1_P1198_F | 0.23 | 0.006897 | 0.003077 | 674 |
| CDH17_E31_F | −0.47 | 0.00697 | 0.003105 | 675 |
| ELK3_P514_F | 0.42 | 0.007191 | 0.003199 | 676 |
| FGF6_P139_R | −0.42 | 0.007281 | 0.003234 | 677 |
| ROR1_P6_F | 0.28 | 0.007355 | 0.003262 | 678 |
| GNAS_P86_F | −0.26 | 0.007434 | 0.003292 | 679 |
| EPHB2_P165_R | −0.28 | 0.007461 | 0.003299 | 680 |
| RAP1A_P285_R | −0.22 | 0.007518 | 0.00332 | 681 |
| EPHA8_P456_R | −0.32 | 0.00754 | 0.003324 | 682 |
| CTSL_P81_F | 0.52 | 0.007574 | 0.003335 | 683 |
| KIT_P405_F | 0.47 | 0.00764 | 0.003359 | 684 |
| STAT5A_P704_R | −0.42 | 0.00765 | 0.003359 | 685 |
| OPCML_P71_F | 0.28 | 0.00774 | 0.003393 | 686 |
| TRPM5_P721_F | −0.35 | 0.007892 | 0.003454 | 687 |
| GLI3_E148_R | −0.35 | 0.008373 | 0.00366 | 688 |
| IL1A_E113_R | −0.24 | 0.008414 | 0.003672 | 689 |
| CD40_P372_R | 0.48 | 0.008466 | 0.00369 | 690 |
| SERPINE1_P519_F | 0.34 | 0.008532 | 0.003713 | 691 |
| TGFB1_P833_R | −0.43 | 0.008552 | 0.003716 | 692 |
| KRT5_P308_F | −0.27 | 0.008597 | 0.00373 | 693 |
| SPI1_P929_F | −0.30 | 0.008724 | 0.00378 | 694 |
| PURA_P928_R | 0.67 | 0.008889 | 0.003846 | 695 |
| HLA-F_E402_F | 1.19 | 0.00896 | 0.003871 | 696 |
| NGFR_E328_F | 0.40 | 0.009003 | 0.003884 | 697 |
| ABO_P312_F | 0.33 | 0.009046 | 0.003897 | 698 |
| ITGA6_P718_R | −0.40 | 0.009142 | 0.003933 | 699 |
| LRRK1_P39_F | −0.19 | 0.009165 | 0.003937 | 700 |
| INSR_P1063_R | 0.34 | 0.009426 | 0.004044 | 701 |
| BMP6_P163_F | 0.54 | 0.009492 | 0.004066 | 702 |
| SLC22A2_P109_F | −0.28 | 0.009558 | 0.004089 | 703 |
| DIRAS3_E55_R | −0.35 | 0.009641 | 0.004118 | 704 |
| MGMT_P272_R | 0.26 | 0.00967 | 0.004125 | 705 |
| NTSR1_E109_F | 0.45 | 0.009851 | 0.004196 | 706 |
| ASB4_P391_F | −0.37 | 0.009935 | 0.004226 | 707 |
| TNFRSF10D_E27_F | 0.72 | 0.009953 | 0.004227 | 708 |
| IGF2_E134_R | 0.41 | 0.010033 | 0.004255 | 709 |
| MATK_P64_F | 0.34 | 0.010174 | 0.004309 | 710 |
| TFAP2C_P765_F | 0.64 | 0.010193 | 0.004311 | 711 |
| IRF7_P277_R | 0.73 | 0.010334 | 0.004365 | 712 |
| FGF5_P238_R | 0.67 | 0.010528 | 0.00444 | 713 |
| ASCL1_E24_F | 0.46 | 0.010576 | 0.004452 | 714 |
| GNAS_E58_F | −0.37 | 0.010586 | 0.004452 | 715 |
| COL18A1_P365_R | 0.35 | 0.010763 | 0.004511 | 716 |
| TNFRSF10A_P171_F | −0.28 | 0.010766 | 0.004511 | 717 |
| LRRC32_E157_F | −0.27 | 0.01077 | 0.004511 | 718 |
| HFE_E273_R | 1.06 | 0.010942 | 0.004577 | 719 |
| LEFTY2_P719_F | 0.26 | 0.010967 | 0.00458 | 720 |
| HGF_E102_R | 0.42 | 0.011004 | 0.00459 | 721 |
| MMP3_P55_F | −0.26 | 0.011125 | 0.004634 | 722 |
| APBA1_E99_R | 0.34 | 0.011459 | 0.004766 | 723 |
| HLA-DRA_P132_R | 0.36 | 0.011485 | 0.00477 | 724 |
| FGF8_E183_F | 0.31 | 0.011633 | 0.004814 | 725 |
| RBP1_P150_F | 0.78 | 0.011637 | 0.004814 | 726 |
| APP_E8_F | 0.14 | 0.011639 | 0.004814 | 727 |
| H19_P541_F | −0.39 | 0.011927 | 0.004927 | 728 |
| ID1_P659_R | 0.22 | 0.01199 | 0.004946 | 729 |
| TJP2_P518_F | 0.43 | 0.01203 | 0.004955 | 730 |
| SMAD2_P708_R | 0.11 | 0.01206 | 0.004961 | 731 |
| IL1B_P582_R | −0.32 | 0.01223 | 0.005024 | 732 |
| IGSF4_P86_R | 0.28 | 0.012321 | 0.005055 | 733 |
| TBX1_P520_F | −0.27 | 0.012576 | 0.005146 | 734 |
| CDH17_P376_F | −0.42 | 0.012593 | 0.005146 | 735 |
| TNFSF8_P184_F | −0.29 | 0.012595 | 0.005146 | 736 |
| FER_E119_F | −0.23 | 0.012708 | 0.005185 | 737 |
| PLXDC2_E337_F | 0.43 | 0.012842 | 0.005233 | 738 |
| NGFB_E353_F | 0.28 | 0.012983 | 0.005281 | 739 |
| DCN_P1320_R | −0.56 | 0.012995 | 0.005281 | 740 |
| EFNA1_P7_F | 0.12 | 0.013116 | 0.005323 | 741 |
| DMP1_P134_F | −0.29 | 0.0133 | 0.00539 | 742 |
| ALOX12_P223_R | −0.38 | 0.013537 | 0.005479 | 743 |
| MSH3_P13_R | −0.24 | 0.013577 | 0.005488 | 744 |
| SEPT5_P464_R | 0.30 | 0.013657 | 0.005513 | 745 |
| PDGFB_P719_F | −0.29 | 0.013738 | 0.005538 | 746 |
| MGMT_P281_F | 0.67 | 0.01379 | 0.005551 | 747 |
| CCNA1_P216_F | 0.39 | 0.014115 | 0.005675 | 748 |
| IGFBP3_P1035_F | 0.77 | 0.014227 | 0.005712 | 749 |
| MMP19_E274_R | −0.28 | 0.014371 | 0.005758 | 750 |
| EPHA1_P119_R | 0.13 | 0.014381 | 0.005758 | 751 |
| MPL_P62_F | −0.34 | 0.014737 | 0.005893 | 752 |
| PEG10_P978_R | 0.28 | 0.014966 | 0.005969 | 753 |
| GPR116_E328_R | −0.42 | 0.014966 | 0.005969 | 754 |
| TSP50_P137_F | 0.36 | 0.01502 | 0.005982 | 755 |
| CSPG2_E38_F | 0.29 | 0.015051 | 0.005987 | 756 |
| JUNB_P1149_R | 0.11 | 0.015405 | 0.006119 | 757 |
| CARD15_P665_F | −0.30 | 0.016222 | 0.006436 | 758 |
| FLT1_P615_R | 0.41 | 0.016324 | 0.006467 | 759 |
| RARRES1_E235_F | 0.70 | 0.016438 | 0.006504 | 760 |
| PLSCR3_P751_R | −0.18 | 0.016796 | 0.00663 | 761 |
| IL6_P611_F | −0.46 | 0.0168 | 0.00663 | 762 |
| COL6A1_P425_F | −0.14 | 0.016957 | 0.006683 | 763 |
| MEG3_E91_F | 0.22 | 0.017248 | 0.006789 | 764 |
| GRB7_P160_R | −0.22 | 0.017413 | 0.006845 | 765 |
| PYCARD_P393_F | 0.22 | 0.017478 | 0.006862 | 766 |
| MME_E29_F | 0.44 | 0.017956 | 0.00704 | 767 |
| CDH11_P354_R | 0.27 | 0.01803 | 0.00706 | 768 |
| GJB2_P791_R | 0.33 | 0.018132 | 0.00709 | 769 |
| MAPK12_E165_R | 0.46 | 0.01821 | 0.007112 | 770 |
| GAS1_P754_R | 0.60 | 0.018243 | 0.007115 | 771 |
| DHCR24_P406_R | −0.14 | 0.018445 | 0.007185 | 772 |
| PGF_P320_F | 0.27 | 0.018997 | 0.00739 | 773 |
| ITGB1_P451_F | −0.11 | 0.019078 | 0.007412 | 774 |
| GPX1_E46_R | 0.29 | 0.019196 | 0.00743 | 775 |
| APC_P14_F | 0.44 | 0.019199 | 0.00743 | 776 |
| IL17RB_P788_R | 0.71 | 0.019199 | 0.00743 | 777 |
| CSPG2_P82_R | 0.41 | 0.019233 | 0.007434 | 778 |
| CDH11_E102_R | 0.35 | 0.019527 | 0.007538 | 779 |
| LRRC32_P865_R | 0.39 | 0.019566 | 0.007543 | 780 |
| GFAP_P1214_F | −0.17 | 0.019767 | 0.007611 | 781 |
| GAS1_E22_F | 0.55 | 0.019803 | 0.007615 | 782 |
| IGFBP5_P9_R | 0.34 | 0.020162 | 0.007743 | 783 |
| LY6G6E_P45_R | −0.37 | 0.020225 | 0.007758 | 784 |
| TFPI2_P9_F | 0.54 | 0.020363 | 0.0078 | 785 |
| DLL1_P386_F | 0.90 | 0.020488 | 0.007838 | 786 |
| YES1_P216_F | −0.19 | 0.020681 | 0.007902 | 787 |
| KIT_P367_R | 0.48 | 0.021303 | 0.008129 | 788 |
| BMPR2_E435_F | 0.12 | 0.021477 | 0.008183 | 789 |
| BMP3_P56_R | 0.15 | 0.021499 | 0.008183 | 790 |
| IHH_P246_R | 0.24 | 0.021722 | 0.008258 | 791 |
| KCNK4_E3_F | 0.28 | 0.021772 | 0.008267 | 792 |
| MXI1_P1269_F | −0.27 | 0.021846 | 0.008284 | 793 |
| GLI3_P453_R | 0.21 | 0.022357 | 0.008467 | 794 |
| DAB2IP_P9_F | 0.38 | 0.022711 | 0.008591 | 795 |
| MAF_E77_R | −0.16 | 0.022809 | 0.008617 | 796 |
| FER_P581_F | −0.28 | 0.023416 | 0.00883 | 797 |
| ITGA6_P298_R | −0.18 | 0.023432 | 0.00883 | 798 |
| TFAP2C_E260_F | 0.26 | 0.023919 | 0.009002 | 799 |
| SLC5A8_E60_R | 0.24 | 0.024027 | 0.009031 | 800 |
| SLC22A3_P528_F | 0.23 | 0.024829 | 0.009321 | 801 |
| PTHR1_P170_R | −0.15 | 0.024961 | 0.009359 | 802 |
| HBII-13_P991_R | −0.21 | 0.025018 | 0.009366 | 803 |
| KRAS_P651_F | 0.14 | 0.025041 | 0.009366 | 804 |
| FZD9_E458_F | 0.32 | 0.025087 | 0.009371 | 805 |
| FRK_P36_F | −0.29 | 0.025376 | 0.009468 | 806 |
| IMPACT_P234_R | 0.24 | 0.025558 | 0.009524 | 807 |
| ZMYND10_E77_R | −0.31 | 0.025804 | 0.009603 | 808 |
| PLAGL1_E68_R | −0.22 | 0.026242 | 0.009754 | 809 |
| SYK_P584_F | −0.25 | 0.026623 | 0.009884 | 810 |
| TMEM63A_E63_F | 0.18 | 0.02669 | 0.009896 | 811 |
| PDE1B_P263_R | 0.47 | 0.02699 | 0.009995 | 812 |
| FLT1_P302_F | 0.27 | 0.027166 | 0.010022 | 813 |
| PTCH2_P37_F | 0.51 | 0.027182 | 0.010022 | 814 |
| EPHB6_E342_F | 0.32 | 0.027183 | 0.010022 | 815 |
| ESR1_E298_R | 0.49 | 0.027196 | 0.010022 | 816 |
| ST6GAL1_P164_R | −0.25 | 0.027515 | 0.010116 | 817 |
| FGF9_P862_R | 0.11 | 0.027524 | 0.010116 | 818 |
| F2R_P88_F | 0.35 | 0.027551 | 0.010116 | 819 |
| AATK_P519_R | −0.33 | 0.027672 | 0.010148 | 820 |
| DDR2_E331_F | 0.17 | 0.027976 | 0.010247 | 821 |
| LTB4R_E64_R | 0.28 | 0.028847 | 0.010553 | 822 |
| HHIP_E94_F | 0.24 | 0.029291 | 0.010703 | 823 |
| TIAM1_P188_R | 0.54 | 0.029756 | 0.010847 | 824 |
| EPM2A_P64_R | 0.08 | 0.029759 | 0.010847 | 825 |
| PTPNS1_P301_R | 0.31 | 0.029805 | 0.010851 | 826 |
| CSF2_E248_R | −0.27 | 0.030167 | 0.010963 | 827 |
| RAB32_E314_R | 0.46 | 0.030185 | 0.010963 | 828 |
| CEBPA_P1163_R | 0.33 | 0.030256 | 0.010975 | 829 |
| MYCN_E77_R | 0.41 | 0.030598 | 0.011086 | 830 |
| KLF5_E190_R | −0.11 | 0.030846 | 0.011162 | 831 |
| ERCC3_P1210_R | −0.33 | 0.031377 | 0.011341 | 832 |
| LIF_E208_F | 0.55 | 0.031721 | 0.011451 | 833 |
| TNFRSF10A_P91_F | −0.20 | 0.032152 | 0.011593 | 834 |
| CDKN1B_P1161_F | 0.51 | 0.032854 | 0.011832 | 835 |
| EGFR_E295_R | 0.17 | 0.033261 | 0.011964 | 836 |
| PDGFB_E25_R | −0.17 | 0.033456 | 0.01202 | 837 |
| BMP6_P398_F | 0.65 | 0.033816 | 0.012135 | 838 |
| EPHA7_E6_F | 0.31 | 0.03448 | 0.012358 | 839 |
| CCND3_P435_F | 0.13 | 0.03455 | 0.012368 | 840 |
| ETV1_P515_F | 0.30 | 0.034623 | 0.01238 | 841 |
| WRN_P969_F | −0.35 | 0.034847 | 0.012445 | 842 |
| TIAM1_P117_F | 0.43 | 0.035069 | 0.01251 | 843 |
| CYP1A1_P382_F | 0.17 | 0.035318 | 0.012584 | 844 |
| INS_P804_R | −0.51 | 0.036383 | 0.012948 | 845 |
| SRC_E100_R | −0.24 | 0.037053 | 0.013171 | 846 |
| EPHA7_P205_R | 0.26 | 0.037751 | 0.013403 | 847 |
| CD81_P211_F | 0.27 | 0.037917 | 0.013446 | 848 |
| PLXDC1_P236_F | 0.32 | 0.037961 | 0.013446 | 849 |
| EFNB3_P442_R | −0.16 | 0.038741 | 0.013706 | 850 |
| SLC22A18_P472_R | 0.12 | 0.039068 | 0.013805 | 851 |
| C20orf47_P225_R | 0.12 | 0.040231 | 0.0142 | 852 |
| PHLDA2_P622_F | −0.20 | 0.040279 | 0.0142 | 853 |
| CSF3R_P472_F | −0.29 | 0.040329 | 0.014201 | 854 |
| CSF3_E242_R | 0.25 | 0.040378 | 0.014201 | 855 |
| HLA-DPA1_P205_R | −0.22 | 0.040677 | 0.01429 | 856 |
| IGFBP3_E65_R | 0.46 | 0.040912 | 0.014356 | 857 |
| ERBB4_P541_F | 0.43 | 0.041104 | 0.014406 | 858 |
| ACTG2_E98_R | −0.24 | 0.041329 | 0.014468 | 859 |
| RUNX1T1_E145_R | 0.30 | 0.041509 | 0.014514 | 860 |
| ETS1_E253_R | −0.14 | 0.04156 | 0.014515 | 861 |
| DLC1_E276_F | −0.27 | 0.041994 | 0.01465 | 862 |
| ER_seq_a1_S60_F | 0.24 | 0.042411 | 0.014778 | 863 |
| CD44_E26_F | 0.85 | 0.042593 | 0.014825 | 864 |
| HLA-DPB1_E2_R | −0.16 | 0.042985 | 0.014931 | 865 |
| ABO_E110_F | 0.21 | 0.043 | 0.014931 | 866 |
| TSG101_P257_R | −0.13 | 0.043755 | 0.015176 | 867 |
| NQO1_P345_R | 0.27 | 0.043821 | 0.015181 | 868 |
| IGFBP7_P371_F | 0.69 | 0.04404 | 0.01524 | 869 |
| IGFBP2_P353_R | 0.28 | 0.044259 | 0.015298 | 870 |
| PADI4_P1158_R | −0.25 | 0.044789 | 0.015463 | 871 |
| BMPR1A_E88_F | −0.16 | 0.046339 | 0.015971 | 872 |
| TYRO3_P501_F | 0.15 | 0.046366 | 0.015971 | 873 |
| HPN_P374_R | 0.23 | 0.046459 | 0.015985 | 874 |
| LRP2_E20_F | 0.40 | 0.04715 | 0.016204 | 875 |
| GP1BB_P278_R | 0.28 | 0.047311 | 0.016241 | 876 |
| ACTG2_P346_F | −0.16 | 0.047758 | 0.016376 | 877 |
| CD44_P87_F | 0.47 | 0.047887 | 0.016401 | 878 |
| IL10_P348_F | −0.27 | 0.049343 | 0.016881 | 879 |
| SLIT2_E111_R | 0.16 | 0.049937 | 0.017065 | 880 |
| MLH3_E72_F | 0.13 | 0.050128 | 0.01711 | 881 |
| MOS_P746_F | −0.26 | 0.051713 | 0.017613 | 882 |
| VIM_P343_R | 0.46 | 0.051719 | 0.017613 | 883 |
| CD34_P339_R | 0.21 | 0.052572 | 0.017884 | 884 |
| CSTB_E410_F | −0.14 | 0.052839 | 0.017937 | 885 |
| TUSC3_P85_R | 0.16 | 0.052849 | 0.017937 | 886 |
| FGFR3_E297_R | 0.12 | 0.053802 | 0.01824 | 887 |
| SRC_P297_F | −0.25 | 0.053887 | 0.018248 | 888 |
| IL6_E168_F | 0.28 | 0.054222 | 0.018341 | 889 |
| RIPK4_P172_F | −0.11 | 0.056409 | 0.01906 | 890 |
| CTNNA1_P382_R | 0.13 | 0.056718 | 0.019136 | 891 |
| ABCA1_E120_R | 0.22 | 0.056822 | 0.019136 | 892 |
| ACVR1_E328_R | 0.27 | 0.056826 | 0.019136 | 893 |
| ONECUT2_E96_F | 0.26 | 0.057195 | 0.019239 | 894 |
| PTPNS1_E433_R | 0.38 | 0.057328 | 0.019262 | 895 |
| ERG_E28_F | −0.31 | 0.057511 | 0.019302 | 896 |
| IGF1R_P325_R | 0.08 | 0.058264 | 0.019533 | 897 |
| WNT1_E157_F | 0.34 | 0.058579 | 0.019616 | 898 |
| SGCE_P250_R | −0.21 | 0.05903 | 0.019745 | 899 |
| CTNNA1_P185_R | 0.17 | 0.059125 | 0.019755 | 900 |
| KRT1_P798_R | −0.19 | 0.060224 | 0.0201 | 901 |
| GSTP1_E322_R | 0.27 | 0.060339 | 0.020116 | 902 |
| KCNQ1_P546_R | 0.21 | 0.060618 | 0.020187 | 903 |
| UGT1A1_P564_R | −0.16 | 0.060695 | 0.02019 | 904 |
| CPA4_P961_R | −0.13 | 0.061916 | 0.020573 | 905 |
| HIC-1_seq_48_S103_R | −0.33 | 0.062661 | 0.020777 | 906 |
| SGCE_E149_F | 0.16 | 0.062667 | 0.020777 | 907 |
| VAV2_E58_F | −0.18 | 0.063375 | 0.020989 | 908 |
| BCAM_P205_F | 0.15 | 0.063716 | 0.021078 | 909 |
| SHH_P104_R | 0.30 | 0.063784 | 0.021078 | 910 |
| SYK_E372_F | 0.07 | 0.064822 | 0.021397 | 911 |
| ERN1_P809_R | 0.23 | 0.065469 | 0.021587 | 912 |
| TMEFF1_E180_R | 0.19 | 0.065863 | 0.021693 | 913 |
| RASA1_E107_F | 0.09 | 0.06609 | 0.02174 | 914 |
| ITGB4_E144_F | −0.12 | 0.066221 | 0.02174 | 915 |
| ERBB4_P255_F | 0.39 | 0.066246 | 0.02174 | 916 |
| LOX_P71_F | 0.44 | 0.066293 | 0.02174 | 917 |
| P2RX7_E323_R | 0.26 | 0.066466 | 0.021773 | 918 |
| MATK_P190_R | −0.18 | 0.06684 | 0.021858 | 919 |
| IGFBP6_E47_F | −0.12 | 0.066873 | 0.021858 | 920 |
| RBP1_P426_R | 0.25 | 0.067661 | 0.022092 | 921 |
| FABP3_P598_F | 0.20 | 0.06858 | 0.022368 | 922 |
| TJP1_P390_F | 0.48 | 0.070619 | 0.023008 | 923 |
| CLK1_P538_F | −0.16 | 0.070996 | 0.023105 | 924 |
| TIMP2_P267_F | 0.22 | 0.071478 | 0.023237 | 925 |
| TEK_E75_F | 0.21 | 0.071771 | 0.023307 | 926 |
| ABL2_P459_R | −0.16 | 0.072325 | 0.023462 | 927 |
| IL11_P11_R | 0.14 | 0.072837 | 0.023593 | 928 |
| DAPK1_P10_F | 0.13 | 0.072887 | 0.023593 | 929 |
| EFNA1_P591_R | 0.12 | 0.073568 | 0.023788 | 930 |
| AHR_E103_F | 0.09 | 0.073991 | 0.023899 | 931 |
| SEPT9_P374_F | 0.27 | 0.074589 | 0.024066 | 932 |
| PTCH_E42_F | 0.17 | 0.075611 | 0.02437 | 933 |
| EDN1_P39_R | 0.10 | 0.076622 | 0.024645 | 934 |
| FAT_P973_R | 0.22 | 0.076627 | 0.024645 | 935 |
| TFPI2_P152_R | 0.29 | 0.077732 | 0.024973 | 936 |
| PALM2-AKAP2_P183_R | 0.15 | 0.078432 | 0.025171 | 937 |
| TGFB3_E58_R | −0.28 | 0.078814 | 0.025255 | 938 |
| SMARCA3_E20_F | 0.46 | 0.078939 | 0.025255 | 939 |
| ODC1_P424_F | 0.14 | 0.078945 | 0.025255 | 940 |
| ABCA1_P45_F | 0.47 | 0.079213 | 0.025314 | 941 |
| TUBB3_E91_F | −0.28 | 0.0794 | 0.025347 | 942 |
| PTEN_P438_F | 0.08 | 0.080186 | 0.025552 | 943 |
| RAB32_P493_R | 0.26 | 0.080213 | 0.025552 | 944 |
| MST1R_P392_F | 0.45 | 0.080998 | 0.025775 | 945 |
| RIPK4_E166_F | −0.15 | 0.08146 | 0.025895 | 946 |
| EPHB4_P313_R | −0.13 | 0.081968 | 0.026028 | 947 |
| EXT1_E197_F | −0.10 | 0.082187 | 0.02607 | 948 |
| GNMT_E126_F | 0.31 | 0.082695 | 0.026204 | 949 |
| PPARG_E178_R | 0.23 | 0.083055 | 0.02629 | 950 |
| CSF1_P339_F | 0.24 | 0.083599 | 0.026435 | 951 |
| SEMA3F_E333_R | 0.16 | 0.084934 | 0.026829 | 952 |
| EPHB3_P569_R | 0.20 | 0.085173 | 0.026852 | 953 |
| KRT13_P341_R | −0.27 | 0.085186 | 0.026852 | 954 |
| IHH_P529_F | 0.25 | 0.085396 | 0.02689 | 955 |
| ABCC5_P444_F | 0.11 | 0.085858 | 0.027007 | 956 |
| EPHA3_E156_R | 0.30 | 0.086535 | 0.027192 | 957 |
| NDN_E131_R | −0.15 | 0.087025 | 0.027317 | 958 |
| CD9_E14_R | 0.10 | 0.087289 | 0.027371 | 959 |
| HDAC5_E298_F | −0.09 | 0.08769 | 0.027468 | 960 |
| S100A4_E315_F | 0.26 | 0.088241 | 0.027612 | 961 |
| IL1B_P829_F | −0.12 | 0.089268 | 0.027905 | 962 |
| XRCC1_P681_R | −0.23 | 0.089429 | 0.027926 | 963 |
| ITGA2_E120_F | 0.12 | 0.089645 | 0.027964 | 964 |
| ITPR3_E86_R | 0.15 | 0.089821 | 0.02799 | 965 |
| CAPG_E228_F | −0.23 | 0.09029 | 0.028107 | 966 |
| IGFBP1_P12_R | −0.22 | 0.091504 | 0.028455 | 967 |
| TFPI2_E141_F | 0.24 | 0.093309 | 0.028987 | 968 |
| ALK_E183_R | 0.15 | 0.094123 | 0.029189 | 969 |
| VIM_P811_R | 0.31 | 0.094153 | 0.029189 | 970 |
| RARRES1_P426_R | −0.23 | 0.094519 | 0.029272 | 971 |
| FHIT_E19_R | 0.08 | 0.095136 | 0.029433 | 972 |
| GSTP1_P74_F | 0.08 | 0.095569 | 0.029537 | 973 |
| MYCN_P464_R | 0.28 | 0.097073 | 0.02997 | 974 |
| RIPK1_P744_R | 0.25 | 0.097683 | 0.030128 | 975 |
| PLAGL1_P236_R | −0.15 | 0.098099 | 0.030225 | 976 |
| COPG2_P298_F | 0.19 | 0.101133 | 0.031128 | 977 |
| DLL1_P832_F | 0.25 | 0.101686 | 0.031266 | 978 |
| XPC_P226_R | −0.10 | 0.103449 | 0.031776 | 979 |
| TCF4_P175_R | 0.33 | 0.103637 | 0.031779 | 980 |
| IGSF4_P454_F | 0.23 | 0.103671 | 0.031779 | 981 |
| PTK2B_P673_R | 0.08 | 0.10409 | 0.031875 | 982 |
| RARB_P60_F | 0.17 | 0.104839 | 0.032072 | 983 |
| MAPK14_P327_R | −0.17 | 0.105591 | 0.032269 | 984 |
| LIMK1_P709_R | −0.25 | 0.106276 | 0.032445 | 985 |
| PPAT_E170_R | 0.15 | 0.106942 | 0.032615 | 986 |
| SKI_E465_R | −0.11 | 0.107431 | 0.032731 | 987 |
| CHFR_P501_F | 0.25 | 0.10805 | 0.032887 | 988 |
| FANCE_P356_R | 0.23 | 0.108593 | 0.033018 | 989 |
| COL1A1_P5_F | 0.23 | 0.109189 | 0.033147 | 990 |
| CDKN1A_E101_F | −0.09 | 0.109337 | 0.033147 | 991 |
| MDS1_E45_F | −0.09 | 0.109347 | 0.033147 | 992 |
| YES1_P600_F | 0.07 | 0.111985 | 0.033913 | 993 |
| ESR2_E66_F | 0.36 | 0.112398 | 0.034004 | 994 |
| ENC1_P484_R | 0.34 | 0.112592 | 0.034028 | 995 |
| NKX3-1_P146_F | 0.22 | 0.113082 | 0.034142 | 996 |
| CSF1_P217_F | 0.20 | 0.113384 | 0.034199 | 997 |
| PGF_E33_F | 0.17 | 0.114019 | 0.034322 | 998 |
| ROR2_E112_F | 0.20 | 0.114022 | 0.034322 | 999 |
| ALPL_P278_F | 0.55 | 0.11513 | 0.034621 | 1000 |
| PTGS1_E80_F | 0.21 | 0.116052 | 0.034864 | 1001 |
| FN1_E469_F | 0.33 | 0.119483 | 0.035858 | 1002 |
| BMP2_P1201_F | 0.12 | 0.11981 | 0.035921 | 1003 |
| MMP7_P613_F | −0.11 | 0.119935 | 0.035922 | 1004 |
| SMAD4_P474_R | 0.10 | 0.122181 | 0.036559 | 1005 |
| SEMA3B_E96_F | 0.15 | 0.123084 | 0.036792 | 1006 |
| CAV1_P169_F | 0.16 | 0.12378 | 0.036964 | 1007 |
| HPN_P823_F | −0.24 | 0.1241 | 0.037023 | 1008 |
| PTHLH_P757_F | −0.15 | 0.126525 | 0.037708 | 1009 |
| FASTK_P598_R | −0.15 | 0.126934 | 0.037793 | 1010 |
| NOTCH2_P312_R | −0.06 | 0.127748 | 0.037998 | 1011 |
| CTSL_P264_R | 0.18 | 0.128332 | 0.038134 | 1012 |
| TMEFF1_P234_F | 0.18 | 0.128788 | 0.038231 | 1013 |
| GRB10_P260_F | 0.33 | 0.129244 | 0.038329 | 1014 |
| TGFB2_P632_F | 0.43 | 0.129863 | 0.038474 | 1015 |
| CDKN2A_E121_R | −0.08 | 0.13051 | 0.038628 | 1016 |
| TRIP6_P1274_R | −0.18 | 0.13467 | 0.03982 | 1017 |
| IGFBP7_P297_F | 0.12 | 0.135037 | 0.039889 | 1018 |
| MMP14_P13_F | 0.22 | 0.13621 | 0.040196 | 1019 |
| CDK10_E74_F | −0.07 | 0.137131 | 0.040429 | 1020 |
| GSTM2_P453_R | 0.17 | 0.137926 | 0.040623 | 1021 |
| MLLT6_P957_F | −0.12 | 0.138546 | 0.040766 | 1022 |
| HSD17B12_P97_F | 0.32 | 0.142271 | 0.041821 | 1023 |
| IFNGR1_P307_F | 0.10 | 0.143345 | 0.042095 | 1024 |
| MSH2_P1008_F | −0.15 | 0.144064 | 0.042265 | 1025 |
| PLXDC2_P914_R | 0.21 | 0.146471 | 0.04293 | 1026 |
| GPR116_P850_F | 0.14 | 0.146906 | 0.043015 | 1027 |
| GATA6_P21_R | −0.12 | 0.148147 | 0.043336 | 1028 |
| CTGF_P693_R | 0.21 | 0.150328 | 0.043932 | 1029 |
| CTGF_E156_F | 0.32 | 0.151585 | 0.044256 | 1030 |
| HLA-DQA2_P282_R | −0.13 | 0.152543 | 0.044492 | 1031 |
| MEG3_P235_F | −0.16 | 0.15506 | 0.045183 | 1032 |
| CDH3_P87_R | 0.31 | 0.158055 | 0.046004 | 1033 |
| SEMA3A_P343_F | 0.21 | 0.158184 | 0.046004 | 1034 |
| RHOC_P536_F | 0.12 | 0.160801 | 0.04672 | 1035 |
| MYBL2_P211_F | 0.37 | 0.162641 | 0.047209 | 1036 |
| TFRC_P414_R | 0.24 | 0.163839 | 0.047489 | 1037 |
| JAK2_P772_R | 0.10 | 0.163922 | 0.047489 | 1038 |
| COL4A3_P545_F | 0.15 | 0.164976 | 0.047748 | 1039 |
| PCDH1_P264_F | −0.22 | 0.16556 | 0.047871 | 1040 |
| PTGS2_P308_F | −0.16 | 0.166178 | 0.048004 | 1041 |
| TNK1_P221_F | −0.14 | 0.16788 | 0.048449 | 1042 |
| NEU1_P745_F | 0.30 | 0.168238 | 0.048506 | 1043 |
| NRAS_P12_R | 0.35 | 0.169916 | 0.048943 | 1044 |
| BMP4_P123_R | 0.18 | 0.171445 | 0.049336 | 1045 |
| BCL3_P1038_R | 0.05 | 0.171826 | 0.049398 | 1046 |
| LAMC1_P808_F | −0.05 | 0.173697 | 0.049888 | 1047 |

*Positive coefficient indicates increased methylation in tumors relative to normal

SUPPLEMENTAL TABLE 19
CpG methylation locus-by-locus analysis of infant blood
samples from healthy newborn infants compared to newborn
infant bloods from individuals who went on to develop
childhood leukemia

| | Regres- | | | |
|---|---|---|---|---|
| | sion | | | |
| | co- | | | |
| GENE_CpG | efficient* | P-value | Q-value | Rank |
| MCAM_P265_R | −0.34 | 0.0E+00 | 3.9E−04 | 1 |
| MCM2_P241_R | −0.34 | 2.0E−06 | 7.6E−04 | 2 |
| MYB_P673_R | −0.25 | 5.6E−05 | 0.02 | 3 |
| HOXA11_P92_R | −0.30 | 4.5E−04 | 0.10 | 4 |
| COPG2_P298_F | −0.57 | 0.001 | 0.10 | 5 |
| APBA1_E99_R | −0.47 | 0.001 | 0.10 | 6 |
| BMP4_P123_R | −0.21 | 0.001 | 0.10 | 7 |
| RARA_P176_R | −0.30 | 0.001 | 0.10 | 8 |
| MST1R_P392_F | −0.34 | 0.001 | 0.10 | 9 |
| MST1R_P87_R | −0.19 | 0.001 | 0.10 | 10 |
| GNMT_P197_F | −0.14 | 0.001 | 0.10 | 11 |
| FGF9_P1404_F | −0.15 | 0.001 | 0.10 | 12 |
| FGF9_P862_R | −0.11 | 0.001 | 0.10 | 13 |
| HIC2_P528_R | −0.21 | 0.002 | 0.10 | 14 |
| ROR1_P6_F | −0.28 | 0.002 | 0.11 | 15 |
| DUSP4_P925_R | −0.25 | 0.002 | 0.11 | 16 |
| LAT_E46_F | −0.27 | 0.002 | 0.12 | 17 |
| CASP3_P420_R | −0.30 | 0.002 | 0.12 | 18 |
| MYCN_E77_R | −0.18 | 0.002 | 0.12 | 19 |
| p16_seq_47_S85_F | −0.21 | 0.003 | 0.12 | 20 |
| SIN3B_P607_F | −0.23 | 0.003 | 0.12 | 21 |
| ITGA6_P298_R | −0.20 | 0.003 | 0.13 | 22 |
| MAP3K1_E81_F | −0.39 | 0.003 | 0.13 | 23 |
| IGFBP5_E144_F | −0.26 | 0.004 | 0.14 | 24 |
| LTB4R_E64_R | −0.23 | 0.004 | 0.14 | 25 |
| TFPI2_E141_F | −0.34 | 0.004 | 0.14 | 26 |
| INHA_P1189_F | −0.18 | 0.004 | 0.15 | 27 |
| TGFA_P558_F | −0.26 | 0.004 | 0.15 | 28 |
| PPARD_P846_F | −0.34 | 0.005 | 0.15 | 29 |
| TES_P182_F | −0.29 | 0.005 | 0.15 | 30 |
| PTPRG_E40_R | −0.33 | 0.005 | 0.15 | 31 |
| MAF_P826_R | −0.57 | 0.005 | 0.15 | 32 |
| FAS_P65_F | −0.25 | 0.006 | 0.15 | 33 |
| RRAS_P100_R | −0.49 | 0.006 | 0.15 | 34 |
| EPHA3_E156_R | −0.29 | 0.006 | 0.15 | 35 |
| EPHA5_E158_R | −0.17 | 0.006 | 0.15 | 36 |
| MPL_P657_F | −0.24 | 0.006 | 0.15 | 37 |
| EYA4_P794_F | −0.24 | 0.006 | 0.15 | 38 |
| DST_E31_F | −0.21 | 0.006 | 0.15 | 39 |
| TMEFF2_P210_R | −0.42 | 0.006 | 0.15 | 40 |
| MLH3_E72_F | −0.36 | 0.007 | 0.16 | 41 |
| SMARCA4_P362_R | −0.32 | 0.008 | 0.18 | 42 |
| DIO3_P90_F | −0.20 | 0.008 | 0.18 | 43 |
| OPCML_P71_F | −0.19 | 0.008 | 0.18 | 44 |
| FN1_P229_R | −0.27 | 0.009 | 0.18 | 45 |
| PDE1B_E141_F | −0.15 | 0.009 | 0.18 | 46 |
| ADAMTS12_E52_R | −0.20 | 0.010 | 0.19 | 47 |
| ZMYND10_E77_R | −0.39 | 0.010 | 0.20 | 48 |
| TNFSF10_E53_F | −0.28 | 0.010 | 0.20 | 49 |
| IGF1_E394_F | −0.18 | 0.011 | 0.20 | 50 |
| EPHA8_P256_F | −0.19 | 0.011 | 0.20 | 51 |
| EPHB1_E202_R | −0.13 | 0.011 | 0.20 | 52 |
| EVI2A_E420_F | −0.21 | 0.011 | 0.20 | 53 |
| WNT2B_P1195_F | −0.21 | 0.011 | 0.20 | 54 |
| EPHB6_P827_R | −0.09 | 0.012 | 0.20 | 55 |
| EIF2AK2_E103_R | −0.20 | 0.013 | 0.22 | 56 |
| DHCR24_P652_R | −0.09 | 0.013 | 0.22 | 57 |
| BMP6_P163_F | −0.25 | 0.013 | 0.22 | 58 |
| EVI2A_P94_R | −0.31 | 0.014 | 0.22 | 59 |
| RAD54B_P227_F | −0.16 | 0.014 | 0.22 | 60 |
| RIPK4_P172_F | −0.14 | 0.014 | 0.22 | 61 |
| DCC_P471_R | −0.24 | 0.015 | 0.23 | 62 |
| SNURF_P2_R | 0.15 | 0.015 | 0.23 | 63 |
| SEMA3C_E49_R | −0.24 | 0.015 | 0.23 | 64 |
| ELK3_P514_F | −0.39 | 0.016 | 0.23 | 65 |
| MAF_E77_R | −0.33 | 0.017 | 0.24 | 66 |
| FGFR2_P460_R | −0.16 | 0.017 | 0.24 | 67 |
| FLT4_E206_F | −0.11 | 0.017 | 0.24 | 68 |
| FLT4_P180_R | −0.17 | 0.018 | 0.24 | 69 |
| CCL3_E53_R | −0.17 | 0.019 | 0.26 | 70 |
| RUNX1T1_E145_R | −0.17 | 0.020 | 0.26 | 71 |
| TDGF1_E53_R | −0.13 | 0.020 | 0.26 | 72 |
| TSC2_E140_F | −0.16 | 0.020 | 0.26 | 73 |
| HIF1A_P488_F | −0.32 | 0.021 | 0.26 | 74 |
| CD34_E20_R | −0.14 | 0.021 | 0.26 | 75 |
| AREG_P217_R | −0.15 | 0.021 | 0.26 | 76 |
| FVT1_P225_F | −0.13 | 0.022 | 0.26 | 77 |
| IFNGR2_E164_F | 0.19 | 0.022 | 0.26 | 78 |
| RARRES1_P426_R | −0.27 | 0.022 | 0.26 | 79 |
| PGF_P320_F | −0.19 | 0.022 | 0.26 | 80 |
| BLK_P668_R | −0.19 | 0.022 | 0.26 | 81 |
| PTHLH_P757_F | −0.18 | 0.022 | 0.26 | 82 |
| NNAT_P544_R | −0.14 | 0.023 | 0.27 | 83 |
| CSPG2_P82_R | −0.23 | 0.023 | 0.27 | 84 |
| APOC2_P377_F | −0.18 | 0.024 | 0.27 | 85 |
| TNFRSF1B_E5_F | −0.20 | 0.024 | 0.27 | 86 |
| FOSL2_E384_R | −0.21 | 0.025 | 0.27 | 87 |
| NTRK2_P395_R | −0.30 | 0.025 | 0.27 | 88 |
| F2R_P839_F | −0.15 | 0.025 | 0.27 | 89 |
| DUSP4_E61_F | −0.16 | 0.026 | 0.27 | 90 |
| FZD9_E458_F | −0.17 | 0.026 | 0.27 | 91 |
| ABL2_P459_R | −0.20 | 0.026 | 0.27 | 92 |
| ID1_P880_F | −0.17 | 0.026 | 0.27 | 93 |
| MAPK12_E165_R | −0.14 | 0.027 | 0.27 | 94 |
| TJP1_P326_R | −0.24 | 0.028 | 0.27 | 95 |
| CDH1_P52_R | −0.24 | 0.028 | 0.27 | 96 |
| FABP3_E113_F | −0.18 | 0.028 | 0.27 | 97 |
| PALM2-AKAP2_P420_R | −0.19 | 0.028 | 0.27 | 98 |
| MMP10_E136_R | −0.15 | 0.029 | 0.27 | 99 |
| TNFRSF1B_P167_F | −0.25 | 0.029 | 0.27 | 100 |
| WEE1_P924_R | −0.14 | 0.029 | 0.27 | 101 |
| PTK6_E50_F | −0.15 | 0.030 | 0.27 | 102 |
| IPF1_P234_F | −0.22 | 0.030 | 0.27 | 103 |
| TIMP2_P267_F | −0.17 | 0.030 | 0.27 | 104 |
| EDN1_P39_R | −0.16 | 0.031 | 0.28 | 105 |
| ONECUT2_E96_F | −0.20 | 0.031 | 0.28 | 106 |
| EPHA7_E6_F | −0.18 | 0.031 | 0.28 | 107 |
| CCND1_E280_R | −0.17 | 0.032 | 0.28 | 108 |
| ADCYAP1_E163_R | −0.48 | 0.033 | 0.28 | 109 |
| XPC_P226_R | −0.10 | 0.033 | 0.28 | 110 |
| ISL1_P379_F | −0.17 | 0.033 | 0.29 | 111 |
| PDGFB_P719_F | −0.14 | 0.034 | 0.29 | 112 |
| EPHA7_P205_R | −0.15 | 0.035 | 0.29 | 113 |
| BMP3_P56_R | −0.28 | 0.035 | 0.29 | 114 |
| KCNK4_E3_F | −0.12 | 0.036 | 0.30 | 115 |
| PENK_E26_F | −0.08 | 0.037 | 0.30 | 116 |
| RYK_P493_F | −0.31 | 0.038 | 0.30 | 117 |
| COL6A1_P283_F | −0.21 | 0.038 | 0.30 | 118 |
| GSTM2_P453_R | −0.15 | 0.039 | 0.30 | 119 |
| GPX1_E46_R | −0.25 | 0.039 | 0.30 | 120 |
| CCNA1_P216_F | −0.34 | 0.040 | 0.30 | 121 |
| SEMA3B_E96_F | −0.13 | 0.040 | 0.30 | 122 |
| MYLK_P469_R | −0.13 | 0.040 | 0.30 | 123 |
| HPSE_P93_F | −0.16 | 0.041 | 0.30 | 124 |
| CAV1_P169_F | −0.16 | 0.041 | 0.30 | 125 |
| ESR1_P151_R | −0.31 | 0.042 | 0.30 | 126 |
| TMEFF2_P152_R | −0.15 | 0.042 | 0.30 | 127 |
| WNT1_P79_R | −0.13 | 0.042 | 0.30 | 128 |
| NPY_E31_R | −0.15 | 0.042 | 0.30 | 129 |
| GSTM2_P109_R | −0.24 | 0.042 | 0.30 | 130 |
| HOXB13_E21_F | −0.14 | 0.043 | 0.30 | 131 |
| ERBB3_E331_F | −0.22 | 0.043 | 0.30 | 132 |
| CFTR_P115_F | −0.25 | 0.043 | 0.30 | 133 |
| IL12B_P392_R | −0.26 | 0.043 | 0.30 | 134 |
| S100A4_P887_R | −0.14 | 0.043 | 0.30 | 135 |
| IL6_E168_F | −0.16 | 0.044 | 0.30 | 136 |
| MUC1_P191_F | −0.22 | 0.044 | 0.30 | 137 |
| CASP8_E474_F | −0.11 | 0.044 | 0.30 | 138 |
| COL4A3_E205_R | −0.13 | 0.045 | 0.30 | 139 |
| VAMP8_P114_F | −0.21 | 0.045 | 0.30 | 140 |
| ACVR1C_P115_R | −0.11 | 0.045 | 0.30 | 141 |
| IGFBP7_P297_F | −0.12 | 0.045 | 0.30 | 142 |
| PAX6_P1121_F | −0.15 | 0.045 | 0.30 | 143 |
| HIC1_E151_F | −0.24 | 0.046 | 0.30 | 144 |
| MAPK4_E273_R | −0.12 | 0.046 | 0.30 | 145 |
| HDAC9_P137_R | −0.19 | 0.046 | 0.30 | 146 |
| PHLDA2_P622_F | −0.17 | 0.047 | 0.30 | 147 |
| CDK6_E256_F | −0.15 | 0.047 | 0.30 | 148 |
| MYOD1_E156_F | −0.20 | 0.047 | 0.30 | 149 |
| HIC-1_seq_48_S103 | −0.29 | 0.047 | 0.30 | 150 |
| CRIP1_P274_F | −0.13 | 0.048 | 0.30 | 151 |
| TFDP1_P543_R | −0.13 | 0.048 | 0.30 | 152 |
| JUNB_P1149_R | −0.11 | 0.048 | 0.30 | 153 |
| TFAP2C_P765_F | 0.25 | 0.049 | 0.30 | 154 |
| EFNB3_E17_R | −0.12 | 0.049 | 0.30 | 155 |
| PLXDC1_E71_F | −0.15 | 0.049 | 0.30 | 156 |
| WNT2_P217_F | −0.16 | 0.049 | 0.30 | 157 |
| IGFBP3_P1035_F | −0.21 | 0.050 | 0.30 | 158 |
| TMEM63A_E63_F | −0.27 | 0.050 | 0.30 | 159 |
| OPCML_E219_R | −0.19 | 0.051 | 0.30 | 160 |
| HLA-DRA_P132_R | −0.21 | 0.051 | 0.30 | 161 |
| IGFBP3_E65_R | −0.10 | 0.051 | 0.30 | 162 |
| FER_E119_F | −0.18 | 0.051 | 0.30 | 163 |
| SLC14A1_P369_R | −0.10 | 0.051 | 0.30 | 164 |
| PLAGL1_E68_R | 0.18 | 0.052 | 0.30 | 165 |
| VIM_P811_R | −0.26 | 0.053 | 0.30 | 166 |
| USP29_E274_F | −0.12 | 0.053 | 0.30 | 167 |
| TJP2_P330_R | −0.17 | 0.053 | 0.30 | 168 |
| MET_E333_F | −0.25 | 0.054 | 0.30 | 169 |
| TIMP2_E394_R | −0.19 | 0.054 | 0.30 | 170 |
| ADCYAP1_P398_F | −0.20 | 0.054 | 0.30 | 171 |
| NEU1_P745_F | −0.25 | 0.055 | 0.31 | 172 |
| TPEF_seq_44_S88_R | −0.17 | 0.055 | 0.31 | 173 |
| FHIT_E19_R | −0.18 | 0.056 | 0.31 | 174 |
| MEST_E150_F | −0.21 | 0.056 | 0.31 | 175 |
| AOC3_P890_R | −0.14 | 0.057 | 0.31 | 176 |
| GATA6_P21_R | −0.12 | 0.058 | 0.32 | 177 |
| FRZB_P406_F | −0.24 | 0.059 | 0.32 | 178 |
| ETV1_P515_F | −0.16 | 0.059 | 0.32 | 179 |
| KCNQ1_P546_R | −0.24 | 0.059 | 0.32 | 180 |
| CCND3_P435_F | −0.12 | 0.060 | 0.32 | 181 |
| PLXDC1_P236_F | −0.15 | 0.060 | 0.32 | 182 |
| KLK10_P268_R | −0.19 | 0.061 | 0.32 | 183 |
| HLA-DRA_P77_R | −0.25 | 0.062 | 0.32 | 184 |
| TGFBR3_P429_F | −0.29 | 0.062 | 0.32 | 185 |
| CTNNB1_P757_F | −0.20 | 0.062 | 0.32 | 186 |
| PLAGL1_P236_R | 0.13 | 0.062 | 0.32 | 187 |
| TP73_E155_F | −0.14 | 0.062 | 0.32 | 188 |
| RAB32_E314_R | −0.19 | 0.063 | 0.32 | 189 |
| CDKN2B_seq_50_S294_{—} | 0.34 | 0.064 | 0.32 | 190 |
| SOX1_P1018_R | −0.21 | 0.065 | 0.32 | 191 |
| FGFR3_P1152_R | −0.16 | 0.065 | 0.32 | 192 |
| CHD2_P667_F | −0.14 | 0.065 | 0.32 | 193 |
| NDN_E131_R | −0.08 | 0.066 | 0.32 | 194 |
| CASP6_P230_R | −0.18 | 0.067 | 0.32 | 195 |
| GP1BB_E23_F | −0.14 | 0.067 | 0.32 | 196 |
| PADI4_P1011_R | −0.09 | 0.067 | 0.32 | 197 |
| SNURF_E256_R | −0.10 | 0.067 | 0.32 | 198 |
| COMT_E401_F | −0.12 | 0.069 | 0.33 | 199 |
| IGSF4_P86_R | −0.28 | 0.069 | 0.33 | 200 |
| PSCA_P135_F | −0.09 | 0.069 | 0.33 | 201 |
| GPX1_P194_F | −0.19 | 0.069 | 0.33 | 202 |
| CD44_E26_F | −0.14 | 0.070 | 0.33 | 203 |
| PLAUR_P82_F | −0.39 | 0.070 | 0.33 | 204 |
| SOX2_P546_F | −0.19 | 0.072 | 0.34 | 205 |
| NTRK3_P636_R | −0.33 | 0.072 | 0.34 | 206 |
| MT1A_E13_R | −0.18 | 0.073 | 0.34 | 207 |
| RIPKl_P868_F | −0.14 | 0.073 | 0.34 | 208 |
| SMARCA3_P17_R | −0.23 | 0.073 | 0.34 | 209 |
| ERBB3_P870_R | −0.22 | 0.074 | 0.34 | 210 |
| IL13_E75_R | −0.17 | 0.075 | 0.34 | 211 |
| USP29_P282_R | −0.15 | 0.075 | 0.34 | 212 |
| SEPT5_P464_R | 0.11 | 0.075 | 0.34 | 213 |
| ABCB4_E429_F | −0.16 | 0.078 | 0.34 | 214 |
| SFN_E118_F | −0.12 | 0.078 | 0.34 | 215 |
| CCR5_P630_R | −0.11 | 0.078 | 0.34 | 216 |
| PIK3R1_P307_F | −0.12 | 0.078 | 0.34 | 217 |
| EPO_P162_R | −0.11 | 0.079 | 0.35 | 218 |
| MAPK9_P1175_F | −0.14 | 0.080 | 0.35 | 219 |
| IGFBP1_E48_R | −0.16 | 0.080 | 0.35 | 220 |
| EDNRB_P148_R | −0.16 | 0.080 | 0.35 | 221 |
| NKX3-1_P871_R | −0.16 | 0.080 | 0.35 | 222 |
| DDR2_P743_R | −0.14 | 0.081 | 0.35 | 223 |
| PTCH_E42_F | −0.09 | 0.081 | 0.35 | 224 |
| ASCL1_E24_F | −0.21 | 0.082 | 0.35 | 225 |
| INS_P804_R | −0.19 | 0.082 | 0.35 | 226 |
| RAD50_P191_F | −0.12 | 0.082 | 0.35 | 227 |
| ITGB4_P517_F | −0.12 | 0.082 | 0.35 | 228 |
| PRKCDBP_E206_F | −0.18 | 0.083 | 0.35 | 229 |
| IL1RN_E42_F | −0.20 | 0.084 | 0.35 | 230 |
| ATP10A_P147_F | −0.19 | 0.084 | 0.35 | 231 |
| ZNF264_E48_R | −0.29 | 0.085 | 0.35 | 232 |
| TWIST1_P44_R | −0.23 | 0.085 | 0.35 | 233 |
| TNFRSF10B_P108_R | −0.18 | 0.085 | 0.35 | 234 |
| CDKN1C_P626_F | −0.15 | 0.086 | 0.35 | 235 |
| CCKAR_P270_F | −0.14 | 0.086 | 0.35 | 236 |
| RASGRF1_E16_F | −0.14 | 0.086 | 0.35 | 237 |
| PWCR1_E81_R | −0.15 | 0.087 | 0.35 | 238 |
| ER_seq_a1_S60_F | −0.17 | 0.087 | 0.35 | 239 |
| CASP10_E139_F | −0.16 | 0.088 | 0.35 | 240 |
| TSG101_P139_R | −0.19 | 0.088 | 0.35 | 241 |
| FOLR1_E368_R | −0.20 | 0.089 | 0.35 | 242 |
| TNFRSF10B_E198_R | −0.14 | 0.089 | 0.35 | 243 |
| IRF5_E101_F | −0.24 | 0.091 | 0.35 | 244 |
| CDH17_E31_F | −0.14 | 0.091 | 0.35 | 245 |
| APOA1_P261_F | −0.12 | 0.091 | 0.35 | 246 |
| GABRB3_E42_F | −0.15 | 0.091 | 0.35 | 247 |
| BSG_P211_R | −0.28 | 0.092 | 0.35 | 248 |
| IRAK3_P13_F | −0.16 | 0.092 | 0.35 | 249 |
| RUNX3_E27_R | −0.15 | 0.093 | 0.36 | 250 |
| EPHX1_P1358_R | −0.08 | 0.093 | 0.36 | 251 |
| HLF_E192_F | −0.16 | 0.094 | 0.36 | 252 |
| IGFBP3_P423_R | −0.18 | 0.095 | 0.36 | 253 |
| BCL6_P248_R | −0.24 | 0.095 | 0.36 | 254 |
| ACVR2B_E27_R | −0.17 | 0.095 | 0.36 | 255 |
| TNK1_P221_F | −0.13 | 0.096 | 0.36 | 256 |
| SHB_P691_R | −0.17 | 0.097 | 0.36 | 257 |
| TRIP6_P1090_F | −0.21 | 0.098 | 0.36 | 258 |
| KRT13_P676_F | −0.12 | 0.098 | 0.36 | 259 |
| MLH3_P25_F | −0.09 | 0.098 | 0.36 | 260 |
| PTCH2_P37_F | −0.14 | 0.099 | 0.36 | 261 |
| TSP50_P137_F | −0.29 | 0.099 | 0.36 | 262 |
| EFNA1_P7_F | −0.17 | 0.099 | 0.36 | 263 |
| SFRP1_E398_R | −0.27 | 0.099 | 0.36 | 264 |
| MUC1_E18_R | 0.14 | 0.099 | 0.36 | 265 |
| DBC1_E204_F | −0.18 | 0.100 | 0.36 | 266 |
| NTRK2_P10_F | −0.19 | 0.100 | 0.36 | 267 |
| ACVR1_E328_R | −0.12 | 0.100 | 0.36 | 268 |
| TWIST1_E117_R | 0.32 | 0.100 | 0.36 | 269 |
| ABCC2_P88_F | −0.17 | 0.101 | 0.36 | 270 |
| DAB2IP_E18_R | −0.12 | 0.102 | 0.36 | 271 |
| GSTP1_E322_R | 0.25 | 0.102 | 0.36 | 272 |
| ITK_E166_R | −0.15 | 0.102 | 0.36 | 273 |
| NGFR_P355_F | −0.13 | 0.103 | 0.36 | 274 |
| GABRB3_P92_F | −0.08 | 0.103 | 0.36 | 275 |
| CEBPA_P706_F | −0.18 | 0.103 | 0.36 | 276 |
| DBC1_P351_R | −0.20 | 0.104 | 0.36 | 277 |
| LIG4_P194_F | −0.22 | 0.105 | 0.36 | 278 |
| CTNNA1_P382_R | −0.14 | 0.106 | 0.36 | 279 |
| POMC_E254_F | −0.13 | 0.106 | 0.36 | 280 |
| SMARCA3_P109_R | −0.21 | 0.107 | 0.36 | 281 |
| HLA-DPB1_E2_R | −0.14 | 0.107 | 0.36 | 282 |
| H19_P1411_R | −0.09 | 0.109 | 0.36 | 283 |
| TMEFF1_P626_R | −0.11 | 0.109 | 0.36 | 284 |
| CHI3L2_P226_F | −0.08 | 0.110 | 0.36 | 285 |
| MXI1_P75_R | −0.22 | 0.110 | 0.36 | 286 |
| GABRA5_P862_R | −0.12 | 0.110 | 0.36 | 287 |
| MGMT_P281_F | −0.14 | 0.110 | 0.36 | 288 |
| ITK_P114_F | −0.15 | 0.110 | 0.36 | 289 |
| MYOD1_P50_F | −0.15 | 0.111 | 0.36 | 290 |
| RBP1_E158_F | −0.13 | 0.112 | 0.36 | 291 |
| PAX6_E129_F | −0.14 | 0.112 | 0.36 | 292 |
| BMP3_E147_F | −0.12 | 0.112 | 0.36 | 293 |
| ETS1_E253_R | −0.12 | 0.112 | 0.36 | 294 |
| TSP50_E21_R | −0.14 | 0.113 | 0.36 | 295 |
| MCC_E23_R | −0.12 | 0.113 | 0.36 | 296 |
| AFF3_P122_F | −0.20 | 0.113 | 0.36 | 297 |
| TGFB1_P833_R | −0.13 | 0.114 | 0.36 | 298 |
| IL11_P11_R | −0.16 | 0.114 | 0.36 | 299 |
| INSR_E97_F | −0.14 | 0.114 | 0.36 | 300 |
| CRK_P721_F | −0.17 | 0.114 | 0.36 | 301 |
| MAP2K6_E297_F | −0.30 | 0.116 | 0.37 | 302 |
| SPARC_P195_F | −0.20 | 0.116 | 0.37 | 303 |
| HHIP_P578_R | −0.22 | 0.117 | 0.37 | 304 |
| MYLK_E132_R | −0.07 | 0.117 | 0.37 | 305 |
| PTPRH_E173_F | −0.09 | 0.118 | 0.37 | 306 |
| FGF5_P238_R | −0.20 | 0.118 | 0.37 | 307 |
| IGFBP6_E47_F | −0.09 | 0.119 | 0.37 | 308 |
| KRT1_P798_R | −0.10 | 0.119 | 0.37 | 309 |
| EGF_P242_R | −0.08 | 0.119 | 0.37 | 310 |
| RHOH_P953_R | −0.13 | 0.119 | 0.37 | 311 |
| GNG7_E310_R | −0.18 | 0.119 | 0.37 | 312 |
| CD81_P211_F | −0.16 | 0.120 | 0.37 | 313 |
| DSC2_P407_R | −0.17 | 0.121 | 0.37 | 314 |
| APP_E8_F | −0.17 | 0.122 | 0.37 | 315 |
| DIO3-E230_R | −0.09 | 0.122 | 0.37 | 316 |
| CTLA4_E176_R | −0.11 | 0.124 | 0.37 | 317 |
| LRRC32_E157_F | −0.18 | 0.125 | 0.37 | 318 |
| BMPR1A_E88_F | 0.14 | 0.125 | 0.37 | 319 |
| JAG2_P264_F | −0.16 | 0.125 | 0.37 | 320 |
| DNAJC15_P65_F | −0.14 | 0.126 | 0.37 | 321 |
| FGFR1_P204_F | −0.19 | 0.126 | 0.37 | 322 |
| PKD2-P336_R | −0.09 | 0.127 | 0.37 | 323 |
| GDF10_E39_F | −0.08 | 0.127 | 0.37 | 324 |
| PRSS1_P1249_R | −0.14 | 0.128 | 0.37 | 325 |
| GLI2_P295_F | −0.09 | 0.128 | 0.37 | 326 |
| HLA-F_E402_F | −0.23 | 0.129 | 0.37 | 327 |
| EPO_E244_R | −0.34 | 0.129 | 0.37 | 328 |
| DDIT3_P1313_R | −0.11 | 0.129 | 0.37 | 329 |
| IL8_E118_R | 0.18 | 0.130 | 0.37 | 330 |
| ABCG2_P178_R | −0.09 | 0.130 | 0.37 | 331 |
| NID1_P714_R | −0.12 | 0.130 | 0.37 | 332 |
| IFNG_E293_F | −0.12 | 0.131 | 0.38 | 333 |
| GNG7_P903_F | −0.11 | 0.132 | 0.38 | 334 |
| MEG3_P235_F | −0.07 | 0.132 | 0.38 | 335 |
| MMP1_P397_R | −0.17 | 0.132 | 0.38 | 336 |
| CD40_P372_R | −0.17 | 0.133 | 0.38 | 337 |
| CSK_P740_R | 0.20 | 0.133 | 0.38 | 338 |
| DIRAS3_P745_F | −0.10 | 0.134 | 0.38 | 339 |
| PXN_P308_F | −0.13 | 0.134 | 0.38 | 340 |
| FLT1_P302_F | −0.22 | 0.135 | 0.38 | 341 |
| PITX2_P183_R | 0.16 | 0.136 | 0.38 | 342 |
| ERG_E28_F | −0.13 | 0.136 | 0.38 | 343 |
| NOTCH4_P938_F | −0.09 | 0.137 | 0.38 | 344 |
| PKD2_P287_R | −0.16 | 0.137 | 0.38 | 345 |
| PHLDA2_E159_R | −0.10 | 0.138 | 0.38 | 346 |
| HRASLS_P353_R | 0.14 | 0.138 | 0.38 | 347 |
| FABP3_P598_F | −0.10 | 0.139 | 0.38 | 348 |
| KIAA1804_P689_R | 0.17 | 0.140 | 0.38 | 349 |
| SFTPA1_E340_R | −0.18 | 0.141 | 0.38 | 350 |
| CHD2_P451_F | −0.12 | 0.141 | 0.38 | 351 |
| CD40_E58_R | −0.16 | 0.141 | 0.38 | 352 |
| SLC14A1_E295_F | −0.08 | 0.142 | 0.38 | 353 |
| EPS8_E231_F | 0.13 | 0.142 | 0.38 | 354 |
| ZIM3_E203_F | −0.17 | 0.143 | 0.38 | 355 |
| APOA1_P75_F | 0.44 | 0.143 | 0.38 | 356 |
| XRCC1_P681_R | −0.13 | 0.144 | 0.38 | 357 |
| ROR2_E112_F | −0.13 | 0.144 | 0.38 | 358 |
| KLF5_P13_F | 0.13 | 0.144 | 0.38 | 359 |
| YES1_P216_F | −0.19 | 0.146 | 0.39 | 360 |
| PTPN6_E171_R | 0.24 | 0.147 | 0.39 | 361 |
| OAT_P465_F | −0.11 | 0.147 | 0.39 | 362 |
| MAS1_P469_R | −0.09 | 0.148 | 0.39 | 363 |
| ALK_E183_R | −0.07 | 0.148 | 0.39 | 364 |
| IGF2AS_P203_F | 0.18 | 0.149 | 0.39 | 365 |
| PLAT_E158_F | −0.18 | 0.150 | 0.39 | 366 |
| EFNB3_P442_R | −0.13 | 0.150 | 0.39 | 367 |
| KIAA0125_E29_F | −0.10 | 0.151 | 0.39 | 368 |
| DDR1_P332_R | −0.22 | 0.151 | 0.39 | 369 |
| CSF2_E248_R | −0.10 | 0.152 | 0.39 | 370 |
| FLJ20712_P984_R | −0.15 | 0.152 | 0.39 | 371 |
| EMR3_P39_R | −0.19 | 0.153 | 0.39 | 372 |
| MAPK14_P327_R | −0.18 | 0.154 | 0.39 | 373 |
| ACTG2_P455_R | −0.13 | 0.155 | 0.39 | 374 |
| SMARCA3_E20_F | 0.19 | 0.155 | 0.39 | 375 |
| CDKN1B_P1161_F | −0.11 | 0.155 | 0.39 | 376 |
| KRT5_P308_F | −0.09 | 0.157 | 0.40 | 377 |
| ABCA1_P45_F | −0.21 | 0.157 | 0.40 | 378 |
| LMO1_E265_R | −0.16 | 0.157 | 0.40 | 379 |
| INSR_P1063_R | −0.25 | 0.158 | 0.40 | 380 |
| CDH11_P354_R | −0.11 | 0.158 | 0.40 | 381 |
| CYP1B1_E83_R | −0.19 | 0.159 | 0.40 | 382 |
| PCGF4_P760_R | −0.12 | 0.159 | 0.40 | 383 |
| F2R_P88_F | −0.20 | 0.159 | 0.40 | 384 |
| TRPM5_E87_F | −0.11 | 0.161 | 0.40 | 385 |
| TAL1_P817_F | −0.14 | 0.161 | 0.40 | 386 |
| FANCE_P356_R | −0.11 | 0.161 | 0.40 | 387 |
| DCC_P177_F | −0.19 | 0.162 | 0.40 | 388 |
| DES_E228_R | −0.11 | 0.163 | 0.40 | 389 |
| NOTCH3_E403_F | −0.19 | 0.164 | 0.40 | 390 |
| NCL_P1102_F | −0.10 | 0.164 | 0.40 | 391 |
| PEG10_P978_R | −0.11 | 0.165 | 0.40 | 392 |
| MPO_P883_R | −0.11 | 0.165 | 0.40 | 393 |
| IGFBP6_P328_R | −0.13 | 0.165 | 0.40 | 394 |
| ERCC1_P354_F | 0.21 | 0.166 | 0.40 | 395 |
| IL18BP_E285_F | −0.08 | 0.169 | 0.41 | 396 |
| CTLA4_P1128_F | −0.07 | 0.170 | 0.41 | 397 |
| PTCH2_P568_R | −0.10 | 0.170 | 0.41 | 398 |
| TMPRSS4_E83_F | −0.10 | 0.170 | 0.41 | 399 |
| FGF8_P473_F | −0.11 | 0.170 | 0.41 | 400 |
| SLC22A18_P472_R | −0.08 | 0.173 | 0.41 | 401 |
| FLT3_P302_F | −0.14 | 0.174 | 0.41 | 402 |
| CD81_P272_R | −0.11 | 0.174 | 0.41 | 403 |
| HOXA11_E35_F | −0.13 | 0.175 | 0.41 | 404 |
| CCND1_P343_R | 0.21 | 0.175 | 0.41 | 405 |
| E2F5_P516_R | −0.13 | 0.175 | 0.41 | 406 |
| RAP1A_P285_R | −0.08 | 0.176 | 0.41 | 407 |
| EMR3_P1297_R | −0.12 | 0.176 | 0.41 | 408 |
| STK11_P295_R | −0.18 | 0.177 | 0.41 | 409 |
| TNFRSF10C_P7_F | −0.10 | 0.177 | 0.41 | 410 |
| PENK_P447_R | −0.18 | 0.178 | 0.41 | 411 |
| IL16_P93_R | −0.08 | 0.178 | 0.41 | 412 |
| BLK_P14_F | −0.16 | 0.178 | 0.41 | 413 |
| RUNX3_P393_R | −0.13 | 0.180 | 0.41 | 414 |
| FGFR3_E297_R | −0.11 | 0.180 | 0.41 | 415 |
| IGFBP1_P12_R | −0.15 | 0.180 | 0.41 | 416 |
| B3GALT5_P330_F | −0.08 | 0.181 | 0.41 | 417 |
| CSPG2_E38_F | −0.11 | 0.181 | 0.41 | 418 |
| ZNFN1A1_E102_F | −0.09 | 0.181 | 0.41 | 419 |
| COL4A3_P545_F | −0.11 | 0.182 | 0.41 | 420 |
| AKT1_P310_R | −0.10 | 0.182 | 0.41 | 421 |
| COL18A1_P494_R | −0.10 | 0.183 | 0.41 | 422 |
| RET_seq_54_S260_F | −0.12 | 0.184 | 0.41 | 423 |
| AIM2_E208_F | −0.13 | 0.185 | 0.41 | 424 |
| FGF1_E5_F | −0.08 | 0.186 | 0.41 | 425 |
| FGF7_P44_F | −0.10 | 0.186 | 0.41 | 426 |
| FZD7_E296_F | 0.13 | 0.187 | 0.41 | 427 |
| SEMA3F_E333_R | −0.12 | 0.187 | 0.41 | 428 |
| SIN3B_P514_R | −0.14 | 0.188 | 0.41 | 429 |
| HBII-52_E142_F | 0.20 | 0.188 | 0.41 | 430 |
| CAPG_E228_F | −0.21 | 0.188 | 0.41 | 431 |
| PALM2-AKAP2_P183 | −0.11 | 0.188 | 0.41 | 432 |
| CDH13_E102_F | −0.19 | 0.189 | 0.41 | 433 |
| CTSD_P726_F | −0.10 | 0.189 | 0.41 | 434 |
| S100A2_E36_R | −0.10 | 0.189 | 0.41 | 435 |
| SEMA3B_P110_R | −0.11 | 0.190 | 0.41 | 436 |
| SRC_E100_R | −0.08 | 0.190 | 0.41 | 437 |
| FRK_P36_F | −0.11 | 0.190 | 0.41 | 438 |
| KDR_P445_R | −0.16 | 0.191 | 0.42 | 439 |
| RIPK2_E123_F | −0.10 | 0.194 | 0.42 | 440 |
| DDR1_E23_R | −0.12 | 0.194 | 0.42 | 441 |
| EVI1_P30_R | −0.15 | 0.195 | 0.42 | 442 |
| GRB10_E85_R | −0.12 | 0.195 | 0.42 | 443 |
| HBEGF_P32_R | −0.20 | 0.195 | 0.42 | 444 |
| NES_P239_R | 0.15 | 0.195 | 0.42 | 445 |
| HOXA9_P303_F | −0.16 | 0.196 | 0.42 | 446 |
| CDKN1C_P6_R | −0.10 | 0.196 | 0.42 | 447 |
| CTTN_E29_R | 0.26 | 0.197 | 0.42 | 448 |
| AGXT_P180_F | 0.12 | 0.197 | 0.42 | 449 |
| JAK3_P156_R | −0.15 | 0.198 | 0.42 | 450 |
| TYRO3_P501_F | −0.16 | 0.198 | 0.42 | 451 |
| ZNFN1A1_P179_F | −0.14 | 0.198 | 0.42 | 452 |
| MT1A_P49_R | −0.16 | 0.201 | 0.42 | 453 |
| GAS1_E22_F | −0.13 | 0.202 | 0.42 | 454 |
| HIC2_P498_F | −0.10 | 0.203 | 0.42 | 455 |
| GLI2_E90_F | −0.15 | 0.203 | 0.42 | 456 |
| P2RX7_P597_F | −0.11 | 0.204 | 0.42 | 457 |
| PGR_P790_F | −0.09 | 0.204 | 0.42 | 458 |
| CD1A_P414_R | −0.17 | 0.204 | 0.43 | 459 |
| ODC1_P424_F | −0.18 | 0.205 | 0.43 | 460 |
| PGF_E33_F | −0.12 | 0.207 | 0.43 | 461 |
| VAV1_E9_F | −0.10 | 0.207 | 0.43 | 462 |
| KDR_E79_F | −0.13 | 0.207 | 0.43 | 463 |
| ASB4_P52_R | −0.16 | 0.208 | 0.43 | 464 |
| IGF1R_E186_R | −0.13 | 0.208 | 0.43 | 465 |
| PWCR1_P357_F | 0.06 | 0.208 | 0.43 | 466 |
| PTEN_P438_F | −0.16 | 0.210 | 0.43 | 467 |
| XRCC2_P1077_F | −0.12 | 0.210 | 0.43 | 468 |
| APBA2_P305_R | −0.09 | 0.211 | 0.43 | 469 |
| DSC2_E90_F | −0.12 | 0.211 | 0.43 | 470 |
| IAPP_E280_F | −0.11 | 0.212 | 0.43 | 471 |
| FANCG_E207_R | −0.18 | 0.212 | 0.43 | 472 |
| NOS2A_P288_R | −0.09 | 0.214 | 0.43 | 473 |
| INHA_P1144_R | −0.08 | 0.215 | 0.43 | 474 |
| EPHA1_E46_R | −0.23 | 0.215 | 0.43 | 475 |
| CCND2_P887_F | −0.15 | 0.216 | 0.43 | 476 |
| SPI1_E205_F | −0.14 | 0.217 | 0.43 | 477 |
| PTHR1_E36_R | −0.12 | 0.217 | 0.43 | 478 |
| GPR116_E328_R | −0.14 | 0.217 | 0.43 | 479 |
| BMPR1A_P956_F | −0.16 | 0.218 | 0.43 | 480 |
| NFKB2_P709_R | −0.17 | 0.219 | 0.43 | 481 |
| ID1_P659_R | 0.16 | 0.219 | 0.43 | 482 |
| H19_P541_F | −0.35 | 0.220 | 0.43 | 483 |
| PDGFRB_P273_F | 0.09 | 0.220 | 0.43 | 484 |
| ZP3_E90_F | 0.15 | 0.220 | 0.43 | 485 |
| PLAGL1_P334_F | 0.07 | 0.220 | 0.43 | 486 |
| TFF2_P557_R | −0.12 | 0.220 | 0.43 | 487 |
| UGT1A1_P315_R | −0.08 | 0.220 | 0.43 | 488 |
| PTK7_E317_F | −0.06 | 0.221 | 0.43 | 489 |
| S100A2_P1186_F | −0.08 | 0.221 | 0.43 | 490 |
| MBD2_P233_F | −0.07 | 0.222 | 0.43 | 491 |
| IL12A_E287_R | −0.08 | 0.224 | 0.43 | 492 |
| DSP_P36_F | −0.09 | 0.225 | 0.43 | 493 |
| SOX1_P294_F | −0.10 | 0.226 | 0.43 | 494 |
| SLC22A2_P109_F | −0.07 | 0.226 | 0.43 | 495 |
| UGT1A1_P564_R | −0.07 | 0.227 | 0.43 | 496 |
| COL1A1_P117_R | −0.09 | 0.227 | 0.43 | 497 |
| LRRK1_P39_F | −0.10 | 0.227 | 0.43 | 498 |
| HLA-DOB_E432_R | −0.08 | 0.228 | 0.43 | 499 |
| DNMT1_P100_R | −0.17 | 0.228 | 0.43 | 500 |
| NQO1_P345_R | 0.12 | 0.228 | 0.43 | 501 |
| HLA-DOB_P1114_R | −0.11 | 0.230 | 0.43 | 502 |
| LEFTY2_P719_F | −0.10 | 0.230 | 0.43 | 503 |
| HLA-DOB_P357_R | −0.13 | 0.230 | 0.43 | 504 |
| PTGS2_P308_F | −0.20 | 0.230 | 0.43 | 505 |
| GABRA5_P1016_F | −0.08 | 0.230 | 0.43 | 506 |
| HHIP_E94_F | −0.13 | 0.230 | 0.43 | 507 |
| MALT1_P406_R | −0.17 | 0.231 | 0.43 | 508 |
| ABCB4_P51_F | −0.11 | 0.233 | 0.43 | 509 |
| LCK_E28_F | −0.07 | 0.234 | 0.43 | 510 |
| IL1RN_P93_R | −0.08 | 0.234 | 0.43 | 511 |
| CXCL9_E268_R | −0.10 | 0.234 | 0.43 | 512 |
| DSP_P440_R | −0.23 | 0.234 | 0.43 | 513 |
| TIMP3_P1114_R | −0.12 | 0.234 | 0.43 | 514 |
| IMPACT_P186_F | −0.22 | 0.234 | 0.43 | 515 |
| IHH_P246_R | −0.08 | 0.234 | 0.43 | 516 |
| CARD15_P302_R | 0.16 | 0.234 | 0.43 | 517 |
| SLC5A8_P38_R | −0.10 | 0.234 | 0.43 | 518 |
| CPA4_E20_F | −0.10 | 0.235 | 0.43 | 519 |
| DIO3_P674_F | 0.14 | 0.235 | 0.43 | 520 |
| IFNGR1_P307_F | −0.13 | 0.235 | 0.43 | 521 |
| EIF2AK2_P313_F | −0.25 | 0.235 | 0.43 | 522 |
| ERBB4_P541_F | −0.13 | 0.236 | 0.43 | 523 |
| E2F3_P840_R | −0.12 | 0.237 | 0.43 | 524 |
| TIMP3_P690_R | −0.10 | 0.238 | 0.43 | 525 |
| SLC22A2_E271_R | −0.10 | 0.238 | 0.43 | 526 |
| CDKN1A_P242_F | 0.20 | 0.239 | 0.43 | 527 |
| CSTB_E410_F | 0.12 | 0.240 | 0.43 | 528 |
| GUCY2D_P48_R | −0.09 | 0.240 | 0.43 | 529 |
| JAK3_E64_F | −0.10 | 0.241 | 0.43 | 530 |
| EXT1_E197_F | −0.12 | 0.242 | 0.43 | 531 |
| VAV2_P1182_F | 0.21 | 0.242 | 0.43 | 532 |
| HRA5LS_E72_R | −0.15 | 0.243 | 0.44 | 533 |
| DAPK1_P345_R | −0.20 | 0.244 | 0.44 | 534 |
| JAG2_E54_F | −0.09 | 0.245 | 0.44 | 535 |
| HCK_P46_R | −0.12 | 0.245 | 0.44 | 536 |
| TNFRSF10D_E27_F | 0.16 | 0.246 | 0.44 | 537 |
| MSH3_E3_F | −0.33 | 0.246 | 0.44 | 538 |
| TSG101_P257_R | −0.12 | 0.248 | 0.44 | 539 |
| LIG3_P622_R | −0.06 | 0.248 | 0.44 | 540 |
| MSH3_P13_R | −0.21 | 0.248 | 0.44 | 541 |
| SERPINB5_P19_R | −0.11 | 0.249 | 0.44 | 542 |
| SMO_P455_R | −0.11 | 0.250 | 0.44 | 543 |
| DLL1_P386_F | 0.23 | 0.254 | 0.45 | 544 |
| CDC25B_E83_F | −0.14 | 0.255 | 0.45 | 545 |
| FRK_P258_F | −0.13 | 0.255 | 0.45 | 546 |
| WNT8B_P216_R | −0.12 | 0.256 | 0.45 | 547 |
| CD1A_P6_F | −0.07 | 0.258 | 0.45 | 548 |
| SPI1_P929_F | −0.06 | 0.260 | 0.45 | 549 |
| GAS1_P754_R | −0.14 | 0.260 | 0.45 | 550 |
| DSG1_P159_R | −0.09 | 0.261 | 0.45 | 551 |
| PMP22_P1254_F | −0.09 | 0.261 | 0.45 | 552 |
| CASP10_P186_F | −0.11 | 0.261 | 0.45 | 553 |
| AXL_E61_F | −0.11 | 0.262 | 0.45 | 554 |
| S100A12_P1221_R | −0.04 | 0.264 | 0.45 | 555 |
| SGCE_E149_F | −0.12 | 0.267 | 0.46 | 556 |
| EPHA3_P106_R | −0.16 | 0.268 | 0.46 | 557 |
| CTSL_P81_F | 0.11 | 0.268 | 0.46 | 558 |
| CSF1_P217_F | −0.18 | 0.269 | 0.46 | 559 |
| RET_P717_F | −0.11 | 0.269 | 0.46 | 560 |
| FYN_P352_R | −0.10 | 0.270 | 0.46 | 561 |
| OSM_P34_F | −0.09 | 0.272 | 0.46 | 562 |
| BIRC5_E89_F | 0.45 | 0.272 | 0.46 | 563 |
| IL2_P607_R | −0.09 | 0.272 | 0.46 | 564 |
| UNG_P170_F | 0.15 | 0.273 | 0.46 | 565 |
| MYH11_P236_R | −0.21 | 0.273 | 0.46 | 566 |
| DIRAS3_E55_R | −0.08 | 0.273 | 0.46 | 567 |
| RIPK1_P744_R | −0.11 | 0.274 | 0.46 | 568 |
| CDH17_P532_F | −0.09 | 0.274 | 0.46 | 569 |
| CDK2_P330_R | 0.14 | 0.275 | 0.46 | 570 |
| WNT5A_E43_F | −0.09 | 0.276 | 0.46 | 571 |
| NOTCH3_P198_R | −0.09 | 0.277 | 0.46 | 572 |
| MTA1_P478_F | −0.12 | 0.277 | 0.46 | 573 |
| VAV2_E58_F | 0.09 | 0.277 | 0.46 | 574 |
| FAT_P973_R | −0.15 | 0.278 | 0.46 | 575 |
| GPX3_E178_F | −0.05 | 0.278 | 0.46 | 576 |
| HTR1B_E232_R | −0.08 | 0.280 | 0.46 | 577 |
| GNMT_E126_F | 0.13 | 0.282 | 0.46 | 578 |
| DNMT3B_P352_R | −0.08 | 0.282 | 0.46 | 579 |
| CAV1_P130_R | −0.09 | 0.282 | 0.47 | 580 |
| SMAD2_P708_R | −0.07 | 0.284 | 0.47 | 581 |
| KCNQ1_E349_R | −0.10 | 0.284 | 0.47 | 582 |
| C20orf47_P225_R | −0.10 | 0.285 | 0.47 | 583 |
| KLK11_P103_R | −0.07 | 0.285 | 0.47 | 584 |
| PYCARD_E87_F | −0.10 | 0.286 | 0.47 | 585 |
| HPN_P374_R | −0.16 | 0.286 | 0.47 | 586 |
| ACTG2_E98_R | −0.13 | 0.287 | 0.47 | 587 |
| HLA-DPB1_P540_F | −0.08 | 0.287 | 0.47 | 588 |
| TDG_E129_F | −0.10 | 0.288 | 0.47 | 589 |
| DCN_P1320_R | −0.10 | 0.289 | 0.47 | 590 |
| CRIP1_P874_R | −0.10 | 0.292 | 0.47 | 591 |
| NOS3_P38_F | −0.05 | 0.293 | 0.47 | 592 |
| GALR1_E52_F | −0.11 | 0.295 | 0.47 | 593 |
| DSG1_E292_F | −0.05 | 0.295 | 0.47 | 594 |
| EVI1_E47_R | −0.16 | 0.296 | 0.47 | 595 |
| SNCG_E119_F | −0.09 | 0.296 | 0.47 | 596 |
| EPS8_P437_F | −0.11 | 0.297 | 0.47 | 597 |
| HOXC6_P585_R | 0.08 | 0.299 | 0.47 | 598 |
| IGF2R_P396_R | −0.06 | 0.300 | 0.47 | 599 |
| ITPR3_P1112_F | −0.14 | 0.300 | 0.47 | 600 |
| SEMA3A_P658_R | −0.11 | 0.301 | 0.47 | 601 |
| FGF6_E294_F | −0.08 | 0.302 | 0.47 | 602 |
| MMP1_P460_F | −0.08 | 0.302 | 0.47 | 603 |
| TIAM1_P117_F | −0.15 | 0.302 | 0.47 | 604 |
| GFAP_P1214_F | −0.05 | 0.302 | 0.47 | 605 |
| SERPINB2_P939_F | −0.11 | 0.302 | 0.47 | 606 |
| P2RX7_P119_R | −0.11 | 0.303 | 0.47 | 607 |
| SNCG_P53_F | −0.12 | 0.303 | 0.47 | 608 |
| IL3_P556_F | −0.09 | 0.303 | 0.47 | 609 |
| MPO_E302_R | 0.07 | 0.303 | 0.47 | 610 |
| TBX1_P885_R | −0.09 | 0.304 | 0.47 | 611 |
| EFNA1_P591_R | −0.18 | 0.304 | 0.47 | 612 |
| FGF12_P210_R | −0.12 | 0.304 | 0.47 | 613 |
| FZD9_P15_R | −0.18 | 0.305 | 0.47 | 614 |
| CDC25B_P11_R | −0.11 | 0.305 | 0.47 | 615 |
| ADAMTS12_P250_R | −0.12 | 0.306 | 0.47 | 616 |
| IL12B_P1453_F | −0.06 | 0.306 | 0.47 | 617 |
| IGFBP2_P353_R | −0.10 | 0.307 | 0.47 | 618 |
| HBII-52_P659_F | −0.08 | 0.307 | 0.47 | 619 |
| CDH11_E102_R | −0.11 | 0.307 | 0.47 | 620 |
| CDH3_P87_R | −0.18 | 0.307 | 0.47 | 621 |
| NID1_P677_F | −0.09 | 0.308 | 0.47 | 622 |
| P2RX7_E323_R | −0.09 | 0.309 | 0.47 | 623 |
| PYCARD_P150_F | −0.08 | 0.309 | 0.47 | 624 |
| IGF2AS_E4_F | −0.05 | 0.309 | 0.47 | 625 |
| TNFRSF10A_P91_F | −0.11 | 0.310 | 0.47 | 626 |
| KIT_P405_F | −0.07 | 0.310 | 0.47 | 627 |
| WNT5A_P655_F | −0.15 | 0.311 | 0.47 | 628 |
| MMP14_P13_F | 0.09 | 0.311 | 0.47 | 629 |
| TMEFF1_P234_F | −0.12 | 0.312 | 0.47 | 630 |
| DAPK1_P10_F | −0.09 | 0.312 | 0.47 | 631 |
| GSTP1_P74_F | 0.08 | 0.314 | 0.47 | 632 |
| TNFSF10_P2_R | −0.17 | 0.314 | 0.47 | 633 |
| SKI_E465_R | −0.09 | 0.314 | 0.47 | 634 |
| TUBB3_P364_F | −0.12 | 0.315 | 0.47 | 635 |
| LY6G6E_P45_R | −0.08 | 0.316 | 0.47 | 636 |
| ENC1_P484_R | −0.06 | 0.316 | 0.47 | 637 |
| TIE1_E66_R | 0.12 | 0.316 | 0.47 | 638 |
| CCNA1_E7_F | −0.22 | 0.317 | 0.47 | 639 |
| GABRG3_E123_R | −0.07 | 0.317 | 0.47 | 640 |
| PI3_P1394_R | −0.05 | 0.317 | 0.47 | 641 |
| ARHGDIB_P148_R | −0.07 | 0.318 | 0.47 | 642 |
| SERPINA5_E69_F | −0.07 | 0.318 | 0.47 | 643 |
| FASTK_P598_R | −0.05 | 0.318 | 0.47 | 644 |
| TNC_P198_F | −0.12 | 0.319 | 0.47 | 645 |
| BCAM_P205_F | −0.10 | 0.320 | 0.47 | 646 |
| WNT10B_P993_F | −0.11 | 0.320 | 0.47 | 647 |
| MLF1_E243_F | −0.05 | 0.320 | 0.47 | 648 |
| ETS2_P684_F | −0.12 | 0.320 | 0.47 | 649 |
| ALOX12_E85_R | 0.20 | 0.320 | 0.47 | 650 |
| FGR_P39_F | −0.09 | 0.324 | 0.47 | 651 |
| BCAM_E100_R | −0.07 | 0.324 | 0.47 | 652 |
| GJB2_P791_R | −0.08 | 0.325 | 0.47 | 653 |
| ELL_P693_F | −0.10 | 0.325 | 0.47 | 654 |
| THY1_P149_R | −0.09 | 0.326 | 0.47 | 655 |
| GPR116_P850_F | −0.09 | 0.326 | 0.47 | 656 |
| RIPK3_P124_F | −0.12 | 0.326 | 0.47 | 657 |
| HLA-DOA_P594_F | −0.07 | 0.326 | 0.47 | 658 |
| PDE1B_P263_R | −0.08 | 0.326 | 0.47 | 659 |
| NEO1_P1067_F | −0.16 | 0.327 | 0.47 | 660 |
| DDR2_E331_F | −0.09 | 0.329 | 0.47 | 661 |
| ACTG2_P346_F | −0.06 | 0.330 | 0.47 | 662 |
| CLDN4_P1120_R | −0.05 | 0.330 | 0.47 | 663 |
| RARA_E128_R | −0.09 | 0.331 | 0.47 | 664 |
| TRPM5_P721_F | −0.09 | 0.331 | 0.47 | 665 |
| CD9_P504_F | −0.11 | 0.331 | 0.47 | 666 |
| NDN_P1110_F | −0.09 | 0.332 | 0.47 | 667 |
| PLG_E406_F | −0.09 | 0.332 | 0.47 | 668 |
| CTGF_P693_R | −0.11 | 0.332 | 0.47 | 669 |
| NTSR1_E109_F | 0.13 | 0.332 | 0.47 | 670 |
| CD9_P585_R | −0.07 | 0.333 | 0.47 | 671 |
| TP73_P945_F | −0.07 | 0.334 | 0.47 | 672 |
| MMP2_P197_F | −0.08 | 0.335 | 0.47 | 673 |
| ITGA6_P718_R | −0.07 | 0.336 | 0.47 | 674 |
| ASB4_E89_F | −0.08 | 0.337 | 0.47 | 675 |
| ASCL1_P747_F | −0.06 | 0.337 | 0.47 | 676 |
| CREB1_P819_F | −0.19 | 0.337 | 0.47 | 677 |
| POMC_P400_R | −0.20 | 0.337 | 0.47 | 678 |
| NGFB_E353_F | −0.08 | 0.339 | 0.48 | 679 |
| ACVR1_P983_F | −0.06 | 0.339 | 0.48 | 680 |
| EPHB3_P569_R | 0.10 | 0.339 | 0.48 | 681 |
| HOXB2_P99_F | 0.07 | 0.339 | 0.48 | 682 |
| TNFRSF10C_P612_R | −0.44 | 0.340 | 0.48 | 683 |
| ARNT_P238_R | −0.13 | 0.340 | 0.48 | 684 |
| KRT5_E196_R | −0.07 | 0.341 | 0.48 | 685 |
| MOS_P746_F | −0.10 | 0.341 | 0.48 | 686 |
| SEPT9_P58_R | −0.07 | 0.343 | 0.48 | 687 |
| HLA-DQA2_E93_F | −0.05 | 0.343 | 0.48 | 688 |
| AFP_P824_F | −0.08 | 0.343 | 0.48 | 689 |
| ACVR1B_P572_R | −0.10 | 0.343 | 0.48 | 690 |
| JAG1_P66_F | −0.07 | 0.344 | 0.48 | 691 |
| PWCR1_P811_F | −0.06 | 0.345 | 0.48 | 692 |
| NBL1_P24_F | −0.08 | 0.346 | 0.48 | 693 |
| RARRES1_P57_R | −0.03 | 0.346 | 0.48 | 694 |
| CPA4_P1265_R | −0.10 | 0.349 | 0.48 | 695 |
| MMP9_E88_R | −0.06 | 0.350 | 0.48 | 696 |
| ERCC3_P1210_R | 0.09 | 0.351 | 0.48 | 697 |
| GSTM1_P363_F | 0.18 | 0.351 | 0.48 | 698 |
| RARB_P60_F | −0.08 | 0.354 | 0.48 | 699 |
| PMP22_P975_F | −0.08 | 0.354 | 0.48 | 700 |
| DNAJC15_E26_R | −0.08 | 0.354 | 0.48 | 701 |
| TUBB3_P721_R | 0.10 | 0.355 | 0.48 | 702 |
| FANCA_P1006_R | −0.08 | 0.356 | 0.48 | 703 |
| KLK11_P1290_F | −0.06 | 0.358 | 0.49 | 704 |
| NRG1_P558_R | 0.11 | 0.359 | 0.49 | 705 |
| CTSL_P264_R | −0.06 | 0.359 | 0.49 | 706 |
| SNCG_P98_R | −0.05 | 0.359 | 0.49 | 707 |
| CDH1_P45_F | −0.09 | 0.360 | 0.49 | 708 |
| TRIM29_P261_F | −0.08 | 0.360 | 0.49 | 709 |
| IGFBP7_P371_F | 0.10 | 0.361 | 0.49 | 710 |
| LIMK1_P709_R | −0.07 | 0.361 | 0.49 | 711 |
| NOTCH2_P312_R | −0.06 | 0.363 | 0.49 | 712 |
| APBA2_P227_F | −0.07 | 0.364 | 0.49 | 713 |
| LYN_P241_F | −0.07 | 0.364 | 0.49 | 714 |
| NTRK1_E74_F | 0.42 | 0.365 | 0.49 | 715 |
| UBA52_P293_R | −0.16 | 0.366 | 0.49 | 716 |
| UGT1A7_P751_R | −0.08 | 0.366 | 0.49 | 717 |
| HS3ST2_P171_F | −0.07 | 0.366 | 0.49 | 718 |
| HTR2A_P853_F | −0.11 | 0.367 | 0.49 | 719 |
| SFN_P248_F | −0.11 | 0.368 | 0.49 | 720 |
| BCL2L2_E172_F | 0.19 | 0.370 | 0.49 | 721 |
| LMO2_P794_R | 0.14 | 0.370 | 0.49 | 722 |
| PTPNS1_P301_R | −0.07 | 0.371 | 0.49 | 723 |
| IRF7_P277_R | −0.09 | 0.372 | 0.49 | 724 |
| GFAP_P56_R | −0.06 | 0.372 | 0.49 | 725 |
| FASTK_P257_F | 0.08 | 0.373 | 0.49 | 726 |
| ALK_P28_F | −0.06 | 0.373 | 0.49 | 727 |
| SPP1_P647_F | −0.09 | 0.373 | 0.49 | 728 |
| NCL_P840_R | −0.10 | 0.373 | 0.49 | 729 |
| RBP1_P426_R | −0.08 | 0.375 | 0.49 | 730 |
| EPHB6_E342_F | 0.09 | 0.376 | 0.49 | 731 |
| CHI3L2_E10_F | −0.05 | 0.376 | 0.49 | 732 |
| EPHB4_E476_R | −0.07 | 0.377 | 0.49 | 733 |
| KLF5_E190_R | −0.06 | 0.378 | 0.49 | 734 |
| PLA2G2A_P528_F | −0.05 | 0.378 | 0.49 | 735 |
| LRRC32_P865_R | −0.09 | 0.378 | 0.49 | 736 |
| MGMT_P272_R | −0.09 | 0.379 | 0.49 | 737 |
| COL6A1_P425_F | −0.04 | 0.379 | 0.49 | 738 |
| PRSS8_E134_R | −0.08 | 0.382 | 0.49 | 739 |
| PTPRO_E56_F | 0.07 | 0.383 | 0.49 | 740 |
| GFI1_E136_F | 0.11 | 0.384 | 0.49 | 741 |
| CDH3_E100_R | −0.07 | 0.384 | 0.49 | 742 |
| DLL1_P832_F | −0.13 | 0.384 | 0.49 | 743 |
| SLC22A3_E122_R | −0.15 | 0.387 | 0.49 | 744 |
| GALR1_P80_F | −0.08 | 0.387 | 0.49 | 745 |
| HOXC6_P456_R | −0.08 | 0.387 | 0.49 | 746 |
| SMAD2_P848_R | −0.08 | 0.388 | 0.49 | 747 |
| HOXB13_P17_R | −0.07 | 0.388 | 0.49 | 748 |
| HOXB2_P488_R | −0.05 | 0.389 | 0.49 | 749 |
| MMP2_E21_R | −0.10 | 0.389 | 0.49 | 750 |
| NGFR_E328_F | −0.09 | 0.389 | 0.49 | 751 |
| GP1BB_P278_R | 0.08 | 0.390 | 0.49 | 752 |
| MAP3K9_E17_R | −0.12 | 0.390 | 0.49 | 753 |
| DDB2_P407_F | −0.07 | 0.390 | 0.49 | 754 |
| RARRES1_E235_F | −0.05 | 0.391 | 0.49 | 755 |
| WNT10B_P823_R | −0.09 | 0.391 | 0.49 | 756 |
| MATK_P64_F | −0.09 | 0.391 | 0.49 | 757 |
| TDGF1_P428_R | −0.08 | 0.391 | 0.49 | 758 |
| HCK_P858_F | −0.12 | 0.392 | 0.49 | 759 |
| AGXT_E115_R | −0.08 | 0.393 | 0.49 | 760 |
| BAX_E281_R | −0.05 | 0.393 | 0.49 | 761 |
| GSTM2_E153_F | −0.08 | 0.394 | 0.49 | 762 |
| ITGA2_E120_F | −0.07 | 0.394 | 0.49 | 763 |
| IL18BP_P51_R | −0.09 | 0.395 | 0.49 | 764 |
| RARB_E114_F | −0.07 | 0.395 | 0.49 | 765 |
| GAS7_P622_R | −0.10 | 0.395 | 0.49 | 766 |
| AHR_E103_F | 0.07 | 0.396 | 0.49 | 767 |
| EDNRB_P709_R | −0.08 | 0.396 | 0.49 | 768 |
| IMPACT_P234_R | 0.15 | 0.397 | 0.49 | 769 |
| FAT_P279_R | −0.08 | 0.397 | 0.49 | 770 |
| PGR_P456_R | −0.07 | 0.397 | 0.49 | 771 |
| PTGS2_P524_R | −0.10 | 0.399 | 0.49 | 772 |
| EPHA2_P203_F | 0.08 | 0.400 | 0.49 | 773 |
| KRAS_P651_F | −0.04 | 0.401 | 0.49 | 774 |
| DAPK1_E46_R | 0.08 | 0.402 | 0.49 | 775 |
| MKRN3_P108_F | −0.09 | 0.402 | 0.49 | 776 |
| PITX2_E24_R | 0.12 | 0.403 | 0.49 | 777 |
| CD86_P3_F | −0.09 | 0.403 | 0.49 | 778 |
| PLSCR3_P751_R | −0.06 | 0.403 | 0.49 | 779 |
| LAMC1_P808_F | −0.07 | 0.404 | 0.49 | 780 |
| PRKAR1A_P337_R | −0.13 | 0.404 | 0.49 | 781 |
| SFTPA1_P421_F | −0.09 | 0.405 | 0.49 | 782 |
| GDF10_P95_R | −0.05 | 0.406 | 0.50 | 783 |
| TGFBR3_E188_R | −0.09 | 0.409 | 0.50 | 784 |
| HGF_P1293_R | −0.07 | 0.409 | 0.50 | 785 |
| PDGFRA_E125_F | −0.09 | 0.409 | 0.50 | 786 |
| PLAUR_E123_F | 0.06 | 0.410 | 0.50 | 787 |
| NRAS_P103_R | −0.14 | 0.412 | 0.50 | 788 |
| MOS_P27_R | 0.13 | 0.413 | 0.50 | 789 |
| RBP1_P150_F | −0.12 | 0.414 | 0.50 | 790 |
| PRDM2_P1340_R | −0.07 | 0.414 | 0.50 | 791 |
| CD34_P780_R | −0.07 | 0.415 | 0.50 | 792 |
| PTCH2_E173_F | −0.04 | 0.416 | 0.50 | 793 |
| CSF1_P339_F | −0.09 | 0.417 | 0.50 | 794 |
| TGFB3_E58_R | −0.06 | 0.417 | 0.50 | 795 |
| TCF7L2_E411_F | −0.10 | 0.418 | 0.50 | 796 |
| CYP1B1_P212_F | −0.04 | 0.418 | 0.50 | 797 |
| KRAS_E82_F | 0.08 | 0.418 | 0.50 | 798 |
| PTPRF_E178_R | 0.11 | 0.419 | 0.50 | 799 |
| SNRPN_P230_R | −0.06 | 0.419 | 0.50 | 800 |
| CHFR_P501_F | −0.11 | 0.419 | 0.50 | 801 |
| ASB4_P391_F | −0.07 | 0.420 | 0.50 | 802 |
| DLC1_E276_F | −0.08 | 0.421 | 0.50 | 803 |
| KIT_P367_R | −0.09 | 0.421 | 0.50 | 804 |
| CDKN2A_E121_R | −0.07 | 0.422 | 0.50 | 805 |
| BMPR2_P1271_F | −0.11 | 0.422 | 0.50 | 806 |
| MYBL2_P211_F | −0.12 | 0.423 | 0.50 | 807 |
| CEACAM1_P44_R | −0.06 | 0.423 | 0.50 | 808 |
| PLAU_P11_F | −0.08 | 0.424 | 0.50 | 809 |
| TJP1_P390_F | −0.06 | 0.424 | 0.50 | 810 |
| TPEF_seq_44_S36_F | −0.05 | 0.425 | 0.50 | 811 |
| MAGEL2_E166_R | −0.08 | 0.425 | 0.50 | 812 |
| OGG1_E400_F | 0.07 | 0.427 | 0.50 | 813 |
| ITPR3_E86_R | −0.15 | 0.428 | 0.50 | 814 |
| TGFA_P642_R | −0.11 | 0.428 | 0.50 | 815 |
| EGFR_E295_R | −0.08 | 0.428 | 0.50 | 816 |
| ERN1_P809_R | 0.05 | 0.429 | 0.50 | 817 |
| IL12B_E25_F | −0.05 | 0.429 | 0.50 | 818 |
| HLA-DPA1_P28_R | 0.08 | 0.430 | 0.50 | 819 |
| IGF2_P1036_R | 0.06 | 0.431 | 0.50 | 820 |
| HOXA11_P698_F | −0.15 | 0.431 | 0.50 | 821 |
| WNT2B_P1185_R | −0.11 | 0.432 | 0.50 | 822 |
| KCNK4_P171_R | −0.09 | 0.432 | 0.50 | 823 |
| GRB7_E71_R | −0.07 | 0.433 | 0.50 | 824 |
| GFI1_P45_R | −0.08 | 0.434 | 0.50 | 825 |
| HDAC7A_P344_F | −0.06 | 0.434 | 0.50 | 826 |
| EPHA5_P66_F | −0.07 | 0.434 | 0.50 | 827 |
| AIM2_P624_F | −0.09 | 0.434 | 0.50 | 828 |
| MMP9_P237_R | −0.09 | 0.434 | 0.50 | 829 |
| MYCN_P464_R | −0.05 | 0.435 | 0.50 | 830 |
| MXI1_P1269_F | −0.07 | 0.435 | 0.50 | 831 |
| TEK_P479_R | −0.05 | 0.436 | 0.50 | 832 |
| DMP1_E194_F | −0.05 | 0.436 | 0.50 | 833 |
| PLAT_P80_F | −0.09 | 0.439 | 0.50 | 834 |
| CFTR_P372_R | 0.07 | 0.440 | 0.50 | 835 |
| CCL3_P543_R | −0.07 | 0.440 | 0.50 | 836 |
| HHIP_P307_R | −0.05 | 0.441 | 0.50 | 837 |
| SHH_E328_F | −0.07 | 0.443 | 0.51 | 838 |
| TUSC3_P85_R | 0.08 | 0.444 | 0.51 | 839 |
| DAB2_P35_F | −0.07 | 0.445 | 0.51 | 840 |
| TESK2_P252_R | −0.06 | 0.445 | 0.51 | 841 |
| PLXDC2_P914_R | −0.08 | 0.445 | 0.51 | 842 |
| MMP14_P208_R | −0.07 | 0.446 | 0.51 | 843 |
| PDGFRB_E195_R | −0.06 | 0.446 | 0.51 | 844 |
| FZD9_P175_F | −0.05 | 0.447 | 0.51 | 845 |
| IHH_P529_F | −0.09 | 0.449 | 0.51 | 846 |
| SOX17_P287_R | −0.07 | 0.450 | 0.51 | 847 |
| MCM6_E136_F | −0.09 | 0.450 | 0.51 | 848 |
| CHGA_P243_F | −0.08 | 0.451 | 0.51 | 849 |
| ESR1_E298_R | −0.10 | 0.453 | 0.51 | 850 |
| SRC_P297_F | −0.09 | 0.454 | 0.51 | 851 |
| MMP2_P303_R | −0.07 | 0.455 | 0.51 | 852 |
| TNFSF8_P184_F | −0.08 | 0.455 | 0.51 | 853 |
| CSF3R_P8_F | −0.06 | 0.456 | 0.51 | 854 |
| CD2_P68_F | −0.08 | 0.458 | 0.51 | 855 |
| CDK10_P199_R | −0.06 | 0.458 | 0.51 | 856 |
| GRB10_P260_F | −0.09 | 0.462 | 0.52 | 857 |
| ZNF264_P397_F | −0.10 | 0.465 | 0.52 | 858 |
| BCR_P422_F | −0.05 | 0.466 | 0.52 | 859 |
| JAK3_P1075_R | −0.05 | 0.467 | 0.52 | 860 |
| PDGFA_P78_F | −0.05 | 0.468 | 0.52 | 861 |
| SOD3_P225_F | −0.07 | 0.469 | 0.52 | 862 |
| HLA-DPA1_E35_R | 0.06 | 0.469 | 0.52 | 863 |
| MAP3K8_P1036_F | 0.07 | 0.473 | 0.52 | 864 |
| HTR1B_P107_F | −0.04 | 0.473 | 0.52 | 865 |
| GNAS_E58_F | 0.08 | 0.474 | 0.52 | 866 |
| NOTCH1_P1198_F | 0.11 | 0.474 | 0.52 | 867 |
| C4B_E171_F | −0.05 | 0.474 | 0.52 | 868 |
| SLC22A3_P634_F | −0.07 | 0.475 | 0.52 | 869 |
| GABRA5_E44_R | −0.06 | 0.477 | 0.52 | 870 |
| PTPRH_P255_F | −0.05 | 0.478 | 0.52 | 871 |
| SPARC_E50_R | −0.03 | 0.479 | 0.52 | 872 |
| DNMT2_P199_F | −0.04 | 0.480 | 0.52 | 873 |
| SMAD4_P474_R | −0.08 | 0.480 | 0.52 | 874 |
| PPAT_E170_R | 0.06 | 0.480 | 0.52 | 875 |
| SLC22A18_P216_R | 0.07 | 0.480 | 0.52 | 876 |
| SRC_P164_F | −0.04 | 0.481 | 0.52 | 877 |
| MMP19_E274_R | −0.04 | 0.482 | 0.52 | 878 |
| IGSF4C_P533_R | 0.07 | 0.482 | 0.52 | 879 |
| SNURF_P78_F | 0.05 | 0.483 | 0.52 | 880 |
| GATA6_P726_F | −0.07 | 0.485 | 0.52 | 881 |
| ASCL2_E76_R | −0.06 | 0.486 | 0.52 | 882 |
| AFF3_P808_F | −0.06 | 0.486 | 0.52 | 883 |
| SERPINE1_E189_R | −0.05 | 0.489 | 0.52 | 884 |
| UGT1A1_E11_F | −0.06 | 0.489 | 0.52 | 885 |
| PLA2G2A_E268_F | −0.05 | 0.489 | 0.52 | 886 |
| IL1B_P582_R | −0.04 | 0.489 | 0.52 | 887 |
| CDKN1A_E101_F | 0.06 | 0.490 | 0.52 | 888 |
| HBII-13_E48_F | −0.07 | 0.490 | 0.52 | 889 |
| MOS_E60_R | 0.10 | 0.491 | 0.52 | 890 |
| RUNX3_P247_F | −0.07 | 0.491 | 0.52 | 891 |
| HBII-13_P991_R | 0.05 | 0.491 | 0.52 | 892 |
| SHB_P473_R | 0.06 | 0.491 | 0.52 | 893 |
| TRIM29_P135_F | −0.04 | 0.491 | 0.52 | 894 |
| MSH2_P1008_F | 0.05 | 0.492 | 0.53 | 895 |
| ZMYND10_P329_F | −0.07 | 0.493 | 0.53 | 896 |
| SH3BP2_E18_F | −0.08 | 0.494 | 0.53 | 897 |
| ERCC6_P698_R | −0.05 | 0.495 | 0.53 | 898 |
| ALOX12_P223_R | 0.15 | 0.496 | 0.53 | 899 |
| C4B_P191_F | −0.08 | 0.497 | 0.53 | 900 |
| TFPI2_P152_R | −0.06 | 0.498 | 0.53 | 901 |
| TNF_P158_F | −0.13 | 0.498 | 0.53 | 902 |
| GJB2_E43_F | 0.13 | 0.501 | 0.53 | 903 |
| SLC22A3_P528_F | −0.06 | 0.501 | 0.53 | 904 |
| BMP4_P199_R | 0.07 | 0.501 | 0.53 | 905 |
| TUBB3_E91_F | −0.17 | 0.503 | 0.53 | 906 |
| ITGB1_P451_F | −0.05 | 0.503 | 0.53 | 907 |
| LOX_P313_R | −0.08 | 0.504 | 0.53 | 908 |
| SLIT2_E111_R | −0.04 | 0.504 | 0.53 | 909 |
| AATK_E63_R | −0.06 | 0.504 | 0.53 | 910 |
| APOC1_P406_R | −0.02 | 0.507 | 0.53 | 911 |
| TES_E172_F | −0.07 | 0.508 | 0.53 | 912 |
| CALCA_P171_F | −0.04 | 0.511 | 0.53 | 913 |
| FGFR2_P266_R | −0.06 | 0.511 | 0.53 | 914 |
| NEFL_E23_R | 0.12 | 0.511 | 0.53 | 915 |
| CCNE1_P683_F | −0.03 | 0.512 | 0.53 | 916 |
| CYP2E1_E53_R | −0.06 | 0.515 | 0.54 | 917 |
| AATK_P709_R | 0.08 | 0.516 | 0.54 | 918 |
| ISL1_P554_F | −0.10 | 0.516 | 0.54 | 919 |
| IL1A_E113_R | −0.06 | 0.516 | 0.54 | 920 |
| SOD3_P460_R | −0.05 | 0.517 | 0.54 | 921 |
| DHCR24_P406_R | −0.08 | 0.517 | 0.54 | 922 |
| CPA4_P961_R | 0.03 | 0.518 | 0.54 | 923 |
| MME_E29_F | −0.11 | 0.519 | 0.54 | 924 |
| CASP10_P334_F | −0.08 | 0.519 | 0.54 | 925 |
| USP29_P205_R | −0.03 | 0.522 | 0.54 | 926 |
| TP73_P496_F | 0.07 | 0.523 | 0.54 | 927 |
| IL6_P213_R | −0.08 | 0.523 | 0.54 | 928 |
| GNAS_P86_F | −0.04 | 0.523 | 0.54 | 929 |
| PYCARD_P393_F | 0.04 | 0.524 | 0.54 | 930 |
| NRAS_P12_R | −0.11 | 0.525 | 0.54 | 931 |
| ABL1_P53_F | −0.10 | 0.526 | 0.54 | 932 |
| FN1_E469_F | −0.07 | 0.526 | 0.54 | 933 |
| TYK2_P494_F | −0.07 | 0.527 | 0.54 | 934 |
| S100A4_P194_R | −0.05 | 0.527 | 0.54 | 935 |
| ST6GAL1_P528_F | 0.12 | 0.529 | 0.54 | 936 |
| DST_P262_R | −0.07 | 0.532 | 0.54 | 937 |
| AGTR1_P41_F | 0.10 | 0.532 | 0.54 | 938 |
| LAMC1_E466_R | −0.08 | 0.532 | 0.54 | 939 |
| EYA4_E277_F | −0.10 | 0.532 | 0.54 | 940 |
| HOXA9_E252_R | 0.07 | 0.532 | 0.54 | 941 |
| GADD45A_P737_R | 0.05 | 0.533 | 0.54 | 942 |
| ONECUT2_P315_R | −0.10 | 0.535 | 0.54 | 943 |
| MLLT3_E93_R | −0.04 | 0.535 | 0.54 | 944 |
| SEZ6L_P299_F | −0.09 | 0.536 | 0.54 | 945 |
| NFKB1_P336_R | 0.19 | 0.537 | 0.54 | 946 |
| HLA-DQA2_P282_R | −0.06 | 0.538 | 0.54 | 947 |
| PTHR1_P170_R | −0.05 | 0.541 | 0.55 | 948 |
| JAK2_P772_R | −0.08 | 0.542 | 0.55 | 949 |
| CYP2E1_P416_F | −0.06 | 0.543 | 0.55 | 950 |
| HOXA5_P479_F | −0.05 | 0.545 | 0.55 | 951 |
| FLT3_E326_R | 0.09 | 0.546 | 0.55 | 952 |
| ABO_E110_F | −0.05 | 0.547 | 0.55 | 953 |
| THY1_P20_R | −0.03 | 0.547 | 0.55 | 954 |
| SNRPN_seq_18_S99_F | 0.03 | 0.553 | 0.55 | 955 |
| WNT8B_E487_F | −0.04 | 0.553 | 0.55 | 956 |
| GLI3_P453_R | 0.07 | 0.555 | 0.55 | 957 |
| WT1_E32_F | 0.07 | 0.555 | 0.55 | 958 |
| IL10_P348_F | 0.08 | 0.556 | 0.55 | 959 |
| RAF1_P330_F | −0.06 | 0.557 | 0.55 | 960 |
| PAX6_P50_R | −0.05 | 0.559 | 0.56 | 961 |
| NTSR1_P318_F | −0.06 | 0.560 | 0.56 | 962 |
| PCDH1_P264_F | −0.12 | 0.562 | 0.56 | 963 |
| FRZB_E186_R | −0.05 | 0.562 | 0.56 | 964 |
| ETS1_P559_R | −0.06 | 0.564 | 0.56 | 965 |
| MEST_P62_R | −0.08 | 0.564 | 0.56 | 966 |
| STAT5A_E42_F | −0.04 | 0.566 | 0.56 | 967 |
| TFF2_P178_F | −0.03 | 0.570 | 0.56 | 968 |
| TRPM5_P979_F | −0.03 | 0.572 | 0.56 | 969 |
| ZIM3_P451_R | −0.05 | 0.572 | 0.56 | 970 |
| LRP2_E20_F | −0.03 | 0.573 | 0.56 | 971 |
| NBL1_E205_R | −0.05 | 0.573 | 0.56 | 972 |
| BDNF_P259_R | −0.05 | 0.575 | 0.56 | 973 |
| EPM2A_P113_F | −0.07 | 0.576 | 0.56 | 974 |
| LAMB1_E144_R | −0.03 | 0.577 | 0.57 | 975 |
| LTA_P214_R | −0.05 | 0.578 | 0.57 | 976 |
| NEFL_P209_R | −0.07 | 0.579 | 0.57 | 977 |
| MAPK10_E26_F | −0.03 | 0.579 | 0.57 | 978 |
| ARHGAP9_P518_R | −0.04 | 0.581 | 0.57 | 979 |
| ROR2_P317_R | 0.06 | 0.582 | 0.57 | 980 |
| ABCB4_P892_F | −0.20 | 0.583 | 0.57 | 981 |
| PDGFRA_P1429_F | −0.09 | 0.583 | 0.57 | 982 |
| IRF7_E236_R | −0.04 | 0.584 | 0.57 | 983 |
| p16_seq_47_S188_R | −0.06 | 0.585 | 0.57 | 984 |
| ABCC2_E16_R | 0.16 | 0.585 | 0.57 | 985 |
| ICAM1_P119_R | −0.07 | 0.586 | 0.57 | 986 |
| DAB2IP_P9_F | −0.08 | 0.586 | 0.57 | 987 |
| HGF_E102_R | −0.07 | 0.587 | 0.57 | 988 |
| COL1A2_E299_F | −0.05 | 0.587 | 0.57 | 989 |
| GML_E144_F | 0.19 | 0.587 | 0.57 | 990 |
| LOX_P71_F | −0.07 | 0.588 | 0.57 | 991 |
| HLA-DOA_P191_R | −0.07 | 0.590 | 0.57 | 992 |
| MAP2K6_P297_R | 0.04 | 0.592 | 0.57 | 993 |
| IL8_P83_F | −0.06 | 0.593 | 0.57 | 994 |
| TGFB2_E226_R | −0.07 | 0.595 | 0.57 | 995 |
| COL1A2_P407_R | 0.04 | 0.596 | 0.57 | 996 |
| TCF7L2_P193_R | 0.08 | 0.596 | 0.57 | 997 |
| NR2F6_E375_R | −0.03 | 0.597 | 0.57 | 998 |
| GSTP1_seq_38_S153 | −0.05 | 0.597 | 0.57 | 999 |
| ZNF215_P71_R | 0.04 | 0.597 | 0.57 | 1000 |
| PTK2B_P673_R | 0.06 | 0.598 | 0.57 | 1001 |
| FES_E34_R | 0.04 | 0.598 | 0.57 | 1002 |
| LYN_E353_F | 0.07 | 0.599 | 0.57 | 1003 |
| TCF4_P175_R | 0.11 | 0.601 | 0.57 | 1004 |
| YES1_P600_F | −0.08 | 0.603 | 0.57 | 1005 |
| TRIM29_E189_F | −0.03 | 0.604 | 0.57 | 1006 |
| THBS1_E207_R | 0.05 | 0.604 | 0.57 | 1007 |
| NPY_P295_F | −0.06 | 0.607 | 0.57 | 1008 |
| GRB10_P496_R | −0.06 | 0.607 | 0.57 | 1009 |
| PI3_E107_F | −0.12 | 0.608 | 0.57 | 1010 |
| NGFB_P13_F | −0.03 | 0.608 | 0.57 | 1011 |
| TYRO3_P366_F | −0.06 | 0.609 | 0.57 | 1012 |
| CSF2_P605_F | −0.03 | 0.609 | 0.57 | 1013 |
| PLG_P370_F | −0.02 | 0.613 | 0.58 | 1014 |
| TIAM1_P188_R | 0.07 | 0.613 | 0.58 | 1015 |
| IHH_E186_F | 0.07 | 0.614 | 0.58 | 1016 |
| IGFBP5_P9_R | 0.06 | 0.615 | 0.58 | 1017 |
| SFTPD_E169_F | −0.03 | 0.617 | 0.58 | 1018 |
| DAB2_P468_F | −0.07 | 0.617 | 0.58 | 1019 |
| MMP8_E89_R | 0.05 | 0.617 | 0.58 | 1020 |
| CAV2_E33_R | 0.08 | 0.619 | 0.58 | 1021 |
| RAN_P581_R | −0.04 | 0.622 | 0.58 | 1022 |
| SEPT5_P441_F | −0.04 | 0.625 | 0.58 | 1023 |
| TUSC3_E29_R | −0.07 | 0.627 | 0.58 | 1024 |
| BMP6_P398_F | −0.03 | 0.627 | 0.58 | 1025 |
| TGFBI_P31_R | 0.05 | 0.627 | 0.58 | 1026 |
| MYCL1_P502_R | −0.06 | 0.629 | 0.58 | 1027 |
| RIPK3_P24_F | −0.08 | 0.629 | 0.58 | 1028 |
| TM7SF3_P1068_R | 0.05 | 0.630 | 0.58 | 1029 |
| ITGA2_P26_R | 0.07 | 0.630 | 0.58 | 1030 |
| CARD15_P665_F | −0.05 | 0.630 | 0.58 | 1031 |
| ACVR2B_P676_F | −0.06 | 0.630 | 0.58 | 1032 |
| PECAM1_P135_F | −0.06 | 0.631 | 0.58 | 1033 |
| PLXDC2_E337_F | 0.07 | 0.631 | 0.58 | 1034 |
| RASGRF1_P768_F | −0.08 | 0.632 | 0.58 | 1035 |
| EPHB4_P313_R | −0.07 | 0.633 | 0.58 | 1036 |
| ERCC1_P440_R | −0.05 | 0.634 | 0.58 | 1037 |
| HS3ST2_E145_R | 0.05 | 0.635 | 0.58 | 1038 |
| EPHX1_P22_F | −0.03 | 0.635 | 0.58 | 1039 |
| MFAP4_P197_F | −0.06 | 0.635 | 0.58 | 1040 |
| PTGS1_E80_F | −0.03 | 0.637 | 0.58 | 1041 |
| THPO_E483_F | 0.03 | 0.637 | 0.58 | 1042 |
| CCKAR_E79_F | −0.04 | 0.638 | 0.58 | 1043 |
| FANCF_P13_F | −0.07 | 0.638 | 0.58 | 1044 |
| THBS2_E129_F | 0.07 | 0.639 | 0.58 | 1045 |
| GLI3_E148_R | 0.03 | 0.639 | 0.58 | 1046 |
| SFTPC_E13_F | 0.04 | 0.640 | 0.58 | 1047 |
| TFRC_P414_R | 0.05 | 0.641 | 0.58 | 1048 |
| SNRPN_E14_F | −0.02 | 0.642 | 0.58 | 1049 |
| FES_P223_R | −0.05 | 0.643 | 0.58 | 1050 |
| PTGS1_P2_F | −0.04 | 0.643 | 0.58 | 1051 |
| CDH13_P88_F | −0.06 | 0.644 | 0.58 | 1052 |
| PPARG_P693_F | −0.05 | 0.644 | 0.58 | 1053 |
| PPARG_E178_R | 0.05 | 0.644 | 0.58 | 1054 |
| TNFRSF1A_P678_F | −0.04 | 0.644 | 0.58 | 1055 |
| DCC_E53_R | 0.05 | 0.646 | 0.58 | 1056 |
| ADCYAP1_P455_R | −0.04 | 0.647 | 0.58 | 1057 |
| HPN_P823_F | −0.06 | 0.649 | 0.59 | 1058 |
| MLLT6_P957_F | −0.04 | 0.650 | 0.59 | 1059 |
| TMPRSS4_P552_F | −0.04 | 0.652 | 0.59 | 1060 |
| CASP6_P201_F | −0.04 | 0.652 | 0.59 | 1061 |
| FGF6_P139_R | −0.04 | 0.653 | 0.59 | 1062 |
| IL6_P611_F | −0.05 | 0.653 | 0.59 | 1063 |
| NOTCH1_E452_R | −0.08 | 0.654 | 0.59 | 1064 |
| AATK_P519_R | 0.03 | 0.655 | 0.59 | 1065 |
| ESR2_E66_F | −0.07 | 0.658 | 0.59 | 1066 |
| IGSF4C_E65_F | −0.03 | 0.660 | 0.59 | 1067 |
| APBA1_P644_F | −0.05 | 0.660 | 0.59 | 1068 |
| HTR1B_P222_F | −0.06 | 0.661 | 0.59 | 1069 |
| GPATC3_P410_R | −0.04 | 0.661 | 0.59 | 1070 |
| IGF2_P36_R | −0.08 | 0.662 | 0.59 | 1071 |
| CHFR_P635_R | −0.02 | 0.662 | 0.59 | 1072 |
| HDAC5_E298_F | −0.02 | 0.663 | 0.59 | 1073 |
| IGF1R_P325_R | −0.04 | 0.663 | 0.59 | 1074 |
| GSTM1_P266_F | 0.12 | 0.664 | 0.59 | 1075 |
| PSIP1_P163_R | −0.05 | 0.664 | 0.59 | 1076 |
| PTPRG_P476_F | −0.05 | 0.664 | 0.59 | 1077 |
| BCL3_E71_F | −0.02 | 0.665 | 0.59 | 1078 |
| MLF1_P97_F | −0.04 | 0.666 | 0.59 | 1079 |
| EPHB2_P165_R | 0.09 | 0.666 | 0.59 | 1080 |
| TFF1_P180_R | −0.02 | 0.667 | 0.59 | 1081 |
| RARA_P1076_R | −0.05 | 0.668 | 0.59 | 1082 |
| WRN_E57_F | −0.06 | 0.668 | 0.59 | 1083 |
| POMC_P53_F | −0.04 | 0.669 | 0.59 | 1084 |
| NPY_P91_F | −0.04 | 0.670 | 0.59 | 1085 |
| TIMP3_seq_7_S38_F | −0.04 | 0.671 | 0.59 | 1086 |
| SPI1_P48_F | −0.05 | 0.671 | 0.59 | 1087 |
| FGF7_P610_F | −0.03 | 0.671 | 0.59 | 1088 |
| CSF3_P309_R | −0.04 | 0.672 | 0.59 | 1089 |
| MST1R_E42_R | −0.03 | 0.672 | 0.59 | 1090 |
| TERT_E20_F | 0.03 | 0.673 | 0.59 | 1091 |
| HOXA9_P1141_R | −0.04 | 0.674 | 0.59 | 1092 |
| MFAP4_P10_R | −0.02 | 0.674 | 0.59 | 1093 |
| PTPRO_P371_F | 0.04 | 0.676 | 0.59 | 1094 |
| EYA4_P508_F | −0.06 | 0.677 | 0.59 | 1095 |
| MAPK12_P416_F | −0.06 | 0.678 | 0.59 | 1096 |
| PDGFB_E25_R | 0.04 | 0.679 | 0.59 | 1097 |
| ALPL_P433_F | −0.03 | 0.679 | 0.59 | 1098 |
| APC_P280_R | −0.05 | 0.681 | 0.59 | 1099 |
| EPM2A_P64_R | 0.05 | 0.681 | 0.59 | 1100 |
| PLAU_P176_R | 0.09 | 0.683 | 0.59 | 1101 |
| EPHA1_P119_R | 0.04 | 0.683 | 0.59 | 1102 |
| SYK_P584_F | 0.04 | 0.684 | 0.59 | 1103 |
| EPHX1_E152_F | −0.02 | 0.684 | 0.59 | 1104 |
| LMO1_P169_F | −0.08 | 0.684 | 0.59 | 1105 |
| BRCA1_P835_R | −0.05 | 0.684 | 0.59 | 1106 |
| ARHGAP9_P260_F | −0.03 | 0.684 | 0.59 | 1107 |
| BMPR2_E435_F | −0.06 | 0.686 | 0.59 | 1108 |
| TGFBI_P173_F | −0.04 | 0.686 | 0.59 | 1109 |
| CCKBR_P480_F | 0.03 | 0.686 | 0.59 | 1110 |
| EPHA2_P340_R | 0.04 | 0.687 | 0.59 | 1111 |
| FLT1_P615_R | −0.05 | 0.688 | 0.59 | 1112 |
| SNRPN_seq_12_S12$$ | −0.02 | 0.688 | 0.59 | 1113 |
| BDNF_E19_R | −0.04 | 0.689 | 0.59 | 1114 |
| TWIST1_P355_R | −0.05 | 0.689 | 0.59 | 1115 |
| GML_P281_R | −0.03 | 0.691 | 0.59 | 1116 |
| APC_E117_R | 0.02 | 0.692 | 0.59 | 1117 |
| HTR2A_E10_R | −0.02 | 0.693 | 0.59 | 1118 |
| MC2R_E455_F | −0.03 | 0.693 | 0.59 | 1119 |
| SLIT2_P208_F | −0.05 | 0.693 | 0.59 | 1120 |
| IRF5_P123_F | −0.02 | 0.695 | 0.59 | 1121 |
| CPNE1_P138_F | 0.04 | 0.696 | 0.59 | 1122 |
| RHOC_P536_F | −0.05 | 0.698 | 0.59 | 1123 |
| HDAC9_E38_F | −0.05 | 0.698 | 0.59 | 1124 |
| MYH11_P22_F | −0.06 | 0.701 | 0.60 | 1125 |
| CCND2_P898_R | −0.07 | 0.701 | 0.60 | 1126 |
| MMP19_P306_F | −0.03 | 0.702 | 0.60 | 1127 |
| RASSF1_P244_F | −0.03 | 0.703 | 0.60 | 1128 |
| THBS1_P500_F | −0.03 | 0.703 | 0.60 | 1129 |
| CTGF_E156_F | −0.04 | 0.704 | 0.60 | 1130 |
| IRAK3_E130_F | −0.03 | 0.705 | 0.60 | 1131 |
| TJP2_P518_F | −0.03 | 0.706 | 0.60 | 1132 |
| BCL3_P1038_R | −0.03 | 0.709 | 0.60 | 1133 |
| PI3_P274_R | −0.03 | 0.709 | 0.60 | 1134 |
| TNFRSF10A_P171_F | −0.06 | 0.709 | 0.60 | 1135 |
| PCDH1_E22_F | −0.02 | 0.712 | 0.60 | 1136 |
| PRSS1_E45_R | −0.02 | 0.712 | 0.60 | 1137 |
| MAS1_P657_R | −0.03 | 0.712 | 0.60 | 1138 |
| GFI1_P208_R | 0.05 | 0.713 | 0.60 | 1139 |
| FGF2_P229_F | 0.05 | 0.716 | 0.60 | 1140 |
| NQO1_E74_R | −0.04 | 0.716 | 0.60 | 1141 |
| DMP1_P134_F | −0.02 | 0.718 | 0.60 | 1142 |
| SFRP1_P157_F | −0.04 | 0.719 | 0.60 | 1143 |
| HSPA2_P162_R | 0.02 | 0.720 | 0.60 | 1144 |
| ZIM2_P22_F | −0.02 | 0.720 | 0.60 | 1145 |
| CALCA_E174_R | −0.04 | 0.722 | 0.60 | 1146 |
| HS3ST2_P546_F | −0.02 | 0.722 | 0.60 | 1147 |
| ESR2_P162_F | −0.04 | 0.724 | 0.60 | 1148 |
| KRT13_P341_R | 0.03 | 0.725 | 0.60 | 1149 |
| FGF3_P171_R | 0.05 | 0.727 | 0.60 | 1150 |
| TGFB2_P632_F | 0.02 | 0.729 | 0.61 | 1151 |
| MCM2_P260_F | 0.02 | 0.730 | 0.61 | 1152 |
| LIF_E208_F | 0.02 | 0.732 | 0.61 | 1153 |
| PCGF4_P92_R | −0.06 | 0.733 | 0.61 | 1154 |
| SEMA3C_P642_F | 0.06 | 0.735 | 0.61 | 1155 |
| ICAM1_P386_R | 0.06 | 0.737 | 0.61 | 1156 |
| MAP3K1_P7_F | 0.03 | 0.737 | 0.61 | 1157 |
| VIM_P343_R | −0.05 | 0.737 | 0.61 | 1158 |
| NTRK3_P752_F | 0.04 | 0.738 | 0.61 | 1159 |
| CTNNA1_P185_R | 0.04 | 0.739 | 0.61 | 1160 |
| NRG1_E74_F | −0.05 | 0.739 | 0.61 | 1161 |
| MMP7_P613_F | 0.02 | 0.739 | 0.61 | 1162 |
| SOX17_P303_F | −0.02 | 0.739 | 0.61 | 1163 |
| PEG3_E496_F | 0.02 | 0.741 | 0.61 | 1164 |
| CTSH_P238_F | 0.04 | 0.743 | 0.61 | 1165 |
| DKFZP564O0823_E4$$ | −0.04 | 0.743 | 0.61 | 1166 |
| HDAC11_P556_F | 0.02 | 0.744 | 0.61 | 1167 |
| PGR_E183_R | −0.02 | 0.746 | 0.61 | 1168 |
| ZNF215_P129_R | −0.04 | 0.749 | 0.61 | 1169 |
| LCN2_P86_R | 0.03 | 0.750 | 0.61 | 1170 |
| ABCC5_P444_F | 0.03 | 0.751 | 0.61 | 1171 |
| ABCA1_E120_R | −0.02 | 0.751 | 0.61 | 1172 |
| RBL2_P250_R | −0.03 | 0.753 | 0.61 | 1173 |
| SPDEF_P6_R | 0.03 | 0.753 | 0.61 | 1174 |
| TEK_E75_F | −0.03 | 0.753 | 0.61 | 1175 |
| PTPNS1_E433_R | −0.04 | 0.755 | 0.61 | 1176 |
| LIF_P383_R | −0.03 | 0.756 | 0.61 | 1177 |
| IL17RB_E164_R | −0.05 | 0.757 | 0.61 | 1178 |
| ABO_P312_F | 0.03 | 0.757 | 0.61 | 1179 |
| GAS7_E148_F | −0.03 | 0.758 | 0.61 | 1180 |
| RHOH_P121_F | −0.04 | 0.759 | 0.61 | 1181 |
| HSD17B12_E145_R | −0.02 | 0.759 | 0.61 | 1182 |
| COL18A1_P365_R | −0.03 | 0.760 | 0.61 | 1183 |
| IFNG_P459_R | −0.02 | 0.762 | 0.61 | 1184 |
| SERPINA5_P156_F | −0.03 | 0.763 | 0.61 | 1185 |
| CSF1R_P73_F | 0.02 | 0.763 | 0.61 | 1186 |
| FLI1_E29_F | −0.02 | 0.764 | 0.61 | 1187 |
| CDH17_P376_F | 0.02 | 0.764 | 0.61 | 1188 |
| ETS2_P835_F | 0.03 | 0.764 | 0.61 | 1189 |
| TERT_P360_R | −0.02 | 0.767 | 0.61 | 1190 |
| COL1A2_P48_R | −0.03 | 0.767 | 0.61 | 1191 |
| COL1A1_P5_F | 0.04 | 0.767 | 0.61 | 1192 |
| MEST_P4_F | −0.06 | 0.768 | 0.61 | 1193 |
| FGFR4_P610_F | −0.02 | 0.768 | 0.61 | 1194 |
| TFAP2C_E260_F | −0.03 | 0.769 | 0.61 | 1195 |
| DLC1_P88_R | −0.03 | 0.771 | 0.62 | 1196 |
| SLC5A8_E60_R | 0.03 | 0.772 | 0.62 | 1197 |
| LCN2_P141_R | 0.03 | 0.774 | 0.62 | 1198 |
| ITPR2_P804_F | 0.04 | 0.775 | 0.62 | 1199 |
| LRRK1_P834_F | −0.02 | 0.775 | 0.62 | 1200 |
| EGR4_E70_F | −0.02 | 0.776 | 0.62 | 1201 |
| RIPK4_E166_F | −0.02 | 0.778 | 0.62 | 1202 |
| EGF_P413_F | 0.02 | 0.779 | 0.62 | 1203 |
| MCC_P196_R | −0.04 | 0.780 | 0.62 | 1204 |
| ZIM3_P718_R | −0.03 | 0.780 | 0.62 | 1205 |
| PODXL_P1341_R | −0.02 | 0.782 | 0.62 | 1206 |
| CD82_P557_R | 0.04 | 0.783 | 0.62 | 1207 |
| WT1_P853_F | −0.05 | 0.783 | 0.62 | 1208 |
| HOXA5_E187_F | 0.03 | 0.783 | 0.62 | 1209 |
| TAL1_E122_F | −0.04 | 0.784 | 0.62 | 1210 |
| CDK6_P291_R | −0.03 | 0.785 | 0.62 | 1211 |
| TNFSF8_E258_R | 0.05 | 0.785 | 0.62 | 1212 |
| SEMA3A_P343_F | 0.03 | 0.787 | 0.62 | 1213 |
| MAGEL2_P170_R | −0.02 | 0.788 | 0.62 | 1214 |
| FGF8_E183_F | 0.02 | 0.789 | 0.62 | 1215 |
| TNFRSF10D_P70_F | 0.02 | 0.789 | 0.62 | 1216 |
| EPHB3_E0_F | −0.03 | 0.791 | 0.62 | 1217 |
| IL17RB_P788_R | 0.05 | 0.791 | 0.62 | 1218 |
| TRAF4_P372_F | −0.02 | 0.791 | 0.62 | 1219 |
| CTSH_E157_R | −0.03 | 0.792 | 0.62 | 1220 |
| IGF1_P933_F | −0.01 | 0.797 | 0.62 | 1221 |
| SPP1_E140_R | 0.02 | 0.797 | 0.62 | 1222 |
| FGF1_P357_R | −0.02 | 0.798 | 0.62 | 1223 |
| WRN_P969_F | −0.02 | 0.800 | 0.62 | 1224 |
| EGFR_P260_R | −0.03 | 0.802 | 0.63 | 1225 |
| CD44_P87_F | −0.02 | 0.802 | 0.63 | 1226 |
| FGF5_E16_F | 0.03 | 0.807 | 0.63 | 1227 |
| VAMP8_P241_F | 0.02 | 0.808 | 0.63 | 1228 |
| DLC1_P695_F | −0.02 | 0.808 | 0.63 | 1229 |
| CHGA_E52_F | −0.02 | 0.809 | 0.63 | 1230 |
| ERBB4_P255_F | 0.04 | 0.809 | 0.63 | 1231 |
| AXL_P223_R | 0.03 | 0.810 | 0.63 | 1232 |
| NTRK3_E131_F | −0.02 | 0.810 | 0.63 | 1233 |
| PROK2_E0_F | −0.02 | 0.810 | 0.63 | 1234 |
| HDAC1_P414_R | 0.02 | 0.811 | 0.63 | 1235 |
| IRAK3_P185_F | 0.02 | 0.811 | 0.63 | 1236 |
| TNC_P57_F | 0.03 | 0.816 | 0.63 | 1237 |
| ISL1_E87_R | −0.02 | 0.818 | 0.63 | 1238 |
| RAB32_P493_R | −0.02 | 0.819 | 0.63 | 1239 |
| TAL1_P594_F | 0.03 | 0.819 | 0.63 | 1240 |
| CEACAM1_E57_R | 0.02 | 0.819 | 0.63 | 1241 |
| SMO_E57_F | 0.03 | 0.819 | 0.63 | 1242 |
| NOS2A_E117_R | −0.01 | 0.823 | 0.63 | 1243 |
| LEFTY2_P561_F | −0.02 | 0.823 | 0.63 | 1244 |
| EGR4_P479_F | 0.03 | 0.823 | 0.63 | 1245 |
| GB2_P931_R | 0.02 | 0.825 | 0.63 | 1246 |
| MLH1_P381_F | 0.02 | 0.826 | 0.63 | 1247 |
| INS_P248_F | 0.02 | 0.828 | 0.63 | 1248 |
| IFNGR2_P377_R | −0.02 | 0.829 | 0.63 | 1249 |
| VAMP8_E7_F | 0.02 | 0.831 | 0.63 | 1250 |
| PROK2_P390_F | 0.02 | 0.832 | 0.63 | 1251 |
| IL1B_P829_F | 0.02 | 0.832 | 0.63 | 1252 |
| TNFRSF10C_E109_F | −0.03 | 0.833 | 0.63 | 1253 |
| TCF4_P317_F | −0.03 | 0.834 | 0.64 | 1254 |
| MMP9_P189_F | −0.02 | 0.835 | 0.64 | 1255 |
| ATP10A_P524_R | 0.02 | 0.837 | 0.64 | 1256 |
| NFKB1_P496_F | −0.02 | 0.838 | 0.64 | 1257 |
| PDGFRB_P343_F | −0.02 | 0.838 | 0.64 | 1258 |
| FGF12_E61_R | −0.02 | 0.839 | 0.64 | 1259 |
| ITGB4_E144_F | −0.02 | 0.840 | 0.64 | 1260 |
| PROM1_P44_R | 0.02 | 0.841 | 0.64 | 1261 |
| ICA1_P72_R | −0.02 | 0.844 | 0.64 | 1262 |
| EPHB2_E297_F | −0.02 | 0.846 | 0.64 | 1263 |
| SLC5A5_E60_F | −0.02 | 0.847 | 0.64 | 1264 |
| SERPINE1_P519_F | −0.02 | 0.848 | 0.64 | 1265 |
| DLK1_E227_R | 0.02 | 0.849 | 0.64 | 1266 |
| MATK_P190_R | −0.01 | 0.850 | 0.64 | 1267 |
| PTHR1_P258_F | 0.01 | 0.851 | 0.64 | 1268 |
| SMARCB1_P220_R | −0.02 | 0.852 | 0.64 | 1269 |
| BCL2L2_P280_F | −0.03 | 0.855 | 0.64 | 1270 |
| ST6GAL1_P164_R | 0.03 | 0.855 | 0.64 | 1271 |
| HBII-52_P563_F | 0.01 | 0.857 | 0.64 | 1272 |
| PTHLH_P15_R | 0.02 | 0.863 | 0.65 | 1273 |
| OSM_P188_F | 0.02 | 0.864 | 0.65 | 1274 |
| CDKN2B_E220_F | 0.02 | 0.864 | 0.65 | 1275 |
| CD9_E14_R | −0.02 | 0.865 | 0.65 | 1276 |
| TFPI2_P9_F | 0.03 | 0.865 | 0.65 | 1277 |
| PTPN6_P282_R | −0.03 | 0.866 | 0.65 | 1278 |
| IGF2_E134_R | −0.03 | 0.866 | 0.65 | 1279 |
| ETV1_P235_F | −0.03 | 0.867 | 0.65 | 1280 |
| ASCL2_P609_R | 0.01 | 0.869 | 0.65 | 1281 |
| ABCG2_P310_R | 0.02 | 0.869 | 0.65 | 1282 |
| MT1A_P600_F | 0.01 | 0.870 | 0.65 | 1283 |
| ZIM2_E110_F | −0.01 | 0.870 | 0.65 | 1284 |
| ZAP70_P220_R | −0.01 | 0.871 | 0.65 | 1285 |
| SFTPB_P689_R | 0.01 | 0.871 | 0.65 | 1286 |
| RUNX1T1_P103_F | −0.02 | 0.871 | 0.65 | 1287 |
| CEBPA_P1163_R | −0.01 | 0.873 | 0.65 | 1288 |
| DES_P1006_R | 0.01 | 0.874 | 0.65 | 1289 |
| HOXA5_P1324_F | 0.02 | 0.875 | 0.65 | 1290 |
| LTA_E28_R | 0.02 | 0.876 | 0.65 | 1291 |
| HFE_E273_R | −0.02 | 0.877 | 0.65 | 1292 |
| BMP2_P1201_F | −0.03 | 0.877 | 0.65 | 1293 |
| CCKBR_P361_R | −0.01 | 0.878 | 0.65 | 1294 |
| SH3BP2_P771_R | −0.02 | 0.878 | 0.65 | 1295 |
| NOTCH4_E4_F | −0.02 | 0.879 | 0.65 | 1296 |
| PADI4_E24_F | 0.02 | 0.882 | 0.65 | 1297 |
| PECAM1_E32_R | −0.02 | 0.882 | 0.65 | 1298 |
| MDR1_seq_42_S300 | −0.02 | 0.886 | 0.65 | 1299 |
| SGCE_P250_R | 0.01 | 0.890 | 0.65 | 1300 |
| ZP3_P220_F | −0.01 | 0.890 | 0.65 | 1301 |
| THBS2_P605_R | −0.02 | 0.892 | 0.65 | 1302 |
| S100A4_E315_F | −0.01 | 0.892 | 0.65 | 1303 |
| NPR2_P1093_F | −0.01 | 0.893 | 0.65 | 1304 |
| FLT1_E444_F | −0.02 | 0.893 | 0.65 | 1305 |
| FAS_P322_R | −0.02 | 0.893 | 0.65 | 1306 |
| PADI4_P1158_R | 0.01 | 0.894 | 0.65 | 1307 |
| AHR_P166_R | 0.03 | 0.896 | 0.65 | 1308 |
| NPR2_P618_F | −0.01 | 0.897 | 0.65 | 1309 |
| GUCY2D_E419_R | 0.02 | 0.897 | 0.65 | 1310 |
| APC_P14_F | −0.01 | 0.899 | 0.66 | 1311 |
| MMP3_P16_R | −0.01 | 0.900 | 0.66 | 1312 |
| MKRN3_E144_F | 0.01 | 0.901 | 0.66 | 1313 |
| IL4_P262_R | 0.01 | 0.902 | 0.66 | 1314 |
| PDGFA_P841_R | 0.01 | 0.903 | 0.66 | 1315 |
| PPP2R1B_P268_R | −0.01 | 0.903 | 0.66 | 1316 |
| WNT1_E157_F | −0.02 | 0.904 | 0.66 | 1317 |
| GABRG3_P75_F | 0.01 | 0.906 | 0.66 | 1318 |
| FLI1_P620_R | −0.02 | 0.906 | 0.66 | 1319 |
| FGFR1_E317_F | 0.01 | 0.908 | 0.66 | 1320 |
| TMEFF2_E94_R | −0.01 | 0.909 | 0.66 | 1321 |
| MUSK_P308_F | −0.01 | 0.911 | 0.66 | 1322 |
| MPL_P62_F | 0.01 | 0.914 | 0.66 | 1323 |
| RASSF1_E116_F | 0.01 | 0.914 | 0.66 | 1324 |
| CD34_P339_R | −0.01 | 0.916 | 0.66 | 1325 |
| CSF1R_E26_F | −0.01 | 0.917 | 0.66 | 1326 |
| BCR_P346_F | 0.01 | 0.918 | 0.66 | 1327 |
| CYP1A1_P382_F | 0.02 | 0.919 | 0.66 | 1328 |
| AREG_E25_F | 0.01 | 0.919 | 0.66 | 1329 |
| PTHLH_E251_F | 0.01 | 0.921 | 0.66 | 1330 |
| SPDEF_E116_R | 0.01 | 0.921 | 0.66 | 1331 |
| ACVR1B_E497_R | −0.02 | 0.921 | 0.66 | 1332 |
| HSD17B12_P97_F | −0.01 | 0.922 | 0.66 | 1333 |
| ICAM1_E242_F | −0.01 | 0.922 | 0.66 | 1334 |
| FER_P581_F | −0.01 | 0.922 | 0.66 | 1335 |
| LTB4R_P163_F | 0.01 | 0.927 | 0.66 | 1336 |
| APP_P179_R | 0.01 | 0.927 | 0.66 | 1337 |
| TNF_P1084_F | −0.01 | 0.928 | 0.66 | 1338 |
| GRB7_P160_R | −0.01 | 0.928 | 0.66 | 1339 |
| MMP3_P55_F | 0.00 | 0.928 | 0.66 | 1340 |
| PARP1_P610_R | −0.01 | 0.929 | 0.66 | 1341 |
| TK1_P62_R | 0.01 | 0.931 | 0.66 | 1342 |
| EPHB1_P503_F | 0.01 | 0.932 | 0.66 | 1343 |
| ASCL2_P360_F | −0.01 | 0.932 | 0.66 | 1344 |
| ALPL_P278_F | 0.01 | 0.933 | 0.66 | 1345 |
| SEZ6L_P249_F | −0.01 | 0.939 | 0.67 | 1346 |
| IGSF4_P454_F | 0.01 | 0.940 | 0.67 | 1347 |
| MLLT4_P1400_F | −0.01 | 0.940 | 0.67 | 1348 |
| NKX3-1_P146_F | 0.01 | 0.942 | 0.67 | 1349 |
| CASP2_P192_F | 0.01 | 0.942 | 0.67 | 1350 |
| IGFBP2_P306_F | 0.01 | 0.943 | 0.67 | 1351 |
| IPF1_P750_F | −0.01 | 0.943 | 0.67 | 1352 |
| RASA1_E107_F | 0.01 | 0.945 | 0.67 | 1353 |
| PRKCDBP_P352_R | −0.01 | 0.945 | 0.67 | 1354 |
| FGF3_E198_R | −0.01 | 0.946 | 0.67 | 1355 |
| MDS1_E45_F | 0.01 | 0.948 | 0.67 | 1356 |
| CDK10_E74_F | 0.00 | 0.949 | 0.67 | 1357 |
| THPO_P585_R | 0.00 | 0.951 | 0.67 | 1358 |
| MMP7_E59_F | 0.01 | 0.951 | 0.67 | 1359 |
| IFNG_P188_F | 0.00 | 0.951 | 0.67 | 1360 |
| HPSE_P29_F | 0.00 | 0.952 | 0.67 | 1361 |
| PSCA_E359_F | 0.01 | 0.953 | 0.67 | 1362 |
| AGTR1_P154_F | −0.01 | 0.953 | 0.67 | 1363 |
| PURA_P928_R | 0.02 | 0.954 | 0.67 | 1364 |
| PTK2_P735_R | −0.01 | 0.956 | 0.67 | 1365 |
| MEG3_E91_F | 0.00 | 0.956 | 0.67 | 1366 |
| SYK_E372_F | 0.00 | 0.956 | 0.67 | 1367 |
| EGF_E339_F | 0.00 | 0.957 | 0.67 | 1368 |
| SEPT9_P374_F | −0.01 | 0.957 | 0.67 | 1369 |
| TBX1_P520_F | 0.01 | 0.958 | 0.67 | 1370 |
| HIC1_P565_R | 0.01 | 0.958 | 0.67 | 1371 |
| CLK1_P538_F | 0.00 | 0.958 | 0.67 | 1372 |
| EDN1_E50_R | 0.01 | 0.959 | 0.67 | 1373 |
| CSF3R_P472_F | 0.01 | 0.960 | 0.67 | 1374 |
| TNK1_P41_R | −0.01 | 0.961 | 0.67 | 1375 |
| MC2R_P1025_F | 0.00 | 0.961 | 0.67 | 1376 |
| SHH_P104_R | 0.00 | 0.961 | 0.67 | 1377 |
| IL10_P85_F | 0.01 | 0.961 | 0.67 | 1378 |
| STAT5A_P704_R | 0.01 | 0.962 | 0.67 | 1379 |
| CSF3_E242_R | 0.00 | 0.963 | 0.67 | 1380 |
| DDB2_P613_R | 0.01 | 0.963 | 0.67 | 1381 |
| MCAM_P169_R | −0.01 | 0.964 | 0.67 | 1382 |
| TEK_P526_F | 0.00 | 0.966 | 0.67 | 1383 |
| TRIP6_P1274_R | 0.00 | 0.966 | 0.67 | 1384 |
| EMR3_E61_F | 0.00 | 0.966 | 0.67 | 1385 |
| MME_P388_F | −0.01 | 0.968 | 0.67 | 1386 |
| CCNC_P132_R | 0.00 | 0.969 | 0.67 | 1387 |
| MYBL2_P354_F | 0.00 | 0.970 | 0.67 | 1388 |
| TMEFF1_E180_R | 0.00 | 0.974 | 0.67 | 1389 |
| FHIT_P93_R | −0.01 | 0.975 | 0.67 | 1390 |
| ERBB2_P59_R | 0.00 | 0.975 | 0.67 | 1391 |
| ETV6_E430_F | −0.01 | 0.976 | 0.67 | 1392 |
| RET_seq_53_S374_F | 0.00 | 0.977 | 0.67 | 1393 |
| VEGFB_P658_F | 0.00 | 0.977 | 0.67 | 1394 |
| CALCA_P75_F | 0.00 | 0.980 | 0.67 | 1395 |
| NAT2_P11_F | 0.00 | 0.981 | 0.67 | 1396 |
| SCGB3A1_E55_R | 0.00 | 0.982 | 0.67 | 1397 |
| BMP2_E48_R | 0.00 | 0.983 | 0.67 | 1398 |
| CREBBP_P712_R | 0.00 | 0.984 | 0.67 | 1399 |
| BCL2A1_P1127_R | 0.00 | 0.984 | 0.67 | 1400 |
| ACVR1C_P363_F | 0.00 | 0.985 | 0.67 | 1401 |
| CDH11_P203_R | 0.00 | 0.986 | 0.67 | 1402 |
| LMO2_E148_F | 0.00 | 0.987 | 0.67 | 1403 |
| B3GALT5_E246_R | 0.00 | 0.987 | 0.67 | 1404 |
| HLA-DPA1_P205_R | 0.00 | 0.989 | 0.67 | 1405 |
| SEMA3F_P692_R | 0.00 | 0.990 | 0.67 | 1406 |
| EPHA8_P456_R | 0.00 | 0.990 | 0.67 | 1407 |
| TRIP6_E33_F | 0.00 | 0.991 | 0.67 | 1408 |
| LMTK2_P1034_F | 0.00 | 0.993 | 0.67 | 1409 |
| MAD2L1_E93_F | 0.00 | 0.998 | 0.68 | 1410 |
| ICA1_P61_F | 0.00 | 0.999 | 0.68 | 1411 |
| TK1_E47_F | 0.00 | 0.999 | 0.68 | 1412 |
| VAV1_P317_F | 0.00 | 1.000 | 0.68 | 1413 |

*Negative regression coefficient indicates reduced methylation in infant bloods from case

1. A method for the diagnosis or prognosis of cancer in a subject comprising
(a) obtaining DNA methylation data from DNA of a subject's cells wherein said cells are suspected of being cancerous (Subject DNA methylation data);
(b) comparing said Subject DNA methylation data to a library of Tumor Control DNA methylation data and a library of Normal Control DNA methylation data (each representing same tissue of origin);
(c) fitting by mixture modeling P(Y,C) Subject DNA methylation data to said Tumor and Normal Control DNA methylation data using recursively partitioned mixture modeling (RPMM) in conjunction with an empirical Bayes procedure generating a posterior probability distribution P(C|y*) of methylation class membership for Subject DNA y*, said Subject DNA methylation data's identity with Normal Control being indicated by posterior probability of membership P(C=k|y*) at least 90% in a class k comprised of at least 95% Normal Control samples [P(control|C=k)>95%];
(d) establishing a metric-based criterion for comparison by computing mean methylation average beta values μⱼ at each CpG locus j from said Normal Control DNA methylation samples data yᵢⱼ and fitting the distribution of squared weighted Euclidean distances dᵢ²=Σ{(yᵢⱼ−μⱼ)²/[μⱼ(1−μⱼ)]} to a gamma distribution G, and where said Subject DNA methylation data's squared weighted Euclidean distance d*²=Σ{(yⱼ*−μⱼ)²/[μⱼ(1−μⱼ)]} is less than the 95% quantile of G it is indicated with at least 95% certainty that the subject's sample is Normal and if the subject's squared weighted Euclidian distance d*² is greater than the 95% quantile of G it is indicated with at least 95% certainty that the subject's sample is a cancer.

2. The method of claim 1 wherein the subject's sample is determined to be cancer further comprising determining said subject's prognosis by applying steps (c)/(d) above to said Tumor Control DNA methylation sample data only said methylation data was derived having distribution of class membership greater than about 90%.

3. The method of claim 1 for the diagnosis or prognosis of malignant pleural mesothelioma.

4. The method of claim 1 for the diagnosis or prognosis of lung adenocarcinoma.

5. The method of claim 1 for the differential diagnosis of cancer type.

6. The method of claim 5 for differential diagnosis of malignant pleural mesothelioma, lung adenocarcinoma, and normal lung tissue.

7. The method of claim 1 for the diagnosis or prognosis of head and neck squamous cell carcinoma.

8. The method of claim 1 for determining the risk of a newborn infant developing leukemia.

9. The method of claim 7 further wherein said risk is determined as to leukemia subtype or prognosis.

10. The method of claim 1 wherein said diagnosis or prognosis is determining the epigenetic signature of differentiated blood cells.
